(19) United States
(12) Patent Application Publication
(10) Pub. No.: US 2026/0218687 A1
(43) Pub. Date: Jul. 30, 2026

(54) SYSTEMS AND METHODS FOR POWER GENERATION OR DIRECT AIR CAPTURE

(71) Applicant: INNOVATOR ENERGY LLC, Houston, TX (US)

(72) Inventor: Ethan NOVEK, Houston, TX (US)

(21) Appl. No.: 19/439,983

(22) Filed: Jan. 5, 2026

Related U.S. Application Data
(60) Provisional application No. 63/741,481, filed on Jan. 3, 2025.
(60) Provisional application No. 63/785,267, filed on Apr. 8, 2025.
(60) Provisional application No. 63/950,570, filed on Dec. 30, 2025.

(51) Int. Cl. F03G 7/04

(52) U.S. Cl. CPC F03G 7/04

(57) ABSTRACT

In one embodiment a process is described that includes transferring heat from a fluid to air. At least a portion of the air is moving from a first elevation to a second elevation through an air conduit. The first elevation is lower than the second elevation. The airflow is adjusted using an airflow control element.

### CROSS-REFERENCE TO RELATED APPLICATIONS

The present application claims priority to U.S. Provisional Application No. 63/741,481 filed Jan. 3, 2025 entitled “Systems and Methods for Power Generation from Freezing Water”; U.S. Provisional Patent Application No. 63/785,267 filed Apr. 8, 2025 entitled “Freezing Water Power Generation Systems and Methods”; and U.S. Provisional Patent Application No. 63/950,570 filed Dec. 30, 2025 Entitled “Freezing Water Power Generation and Valuable Product Production Systems and Methods”.

### FIELD OF INVENTION

The present application pertains to systems and methods for direct air capture and/or power generation.

### BACKGROUND AND SUMMARY

Thermal power generation systems may convert thermal energy into electrical or mechanical power through various mechanisms. Some thermal power generation approaches may utilize temperature differentials between heat sources and heat sinks to drive thermodynamic cycles or to create fluid movement that can be harnessed for power generation. The efficiency and practicality of thermal power generation may depend on factors including the magnitude of available temperature differentials, the availability of heat sources and heat sinks, and the capital and operating costs of the power generation equipment.

Updraft tower systems, sometimes referred to as solar updraft towers or solar chimneys, may generate power by heating air at the base of a tall tower structure, causing the heated air to rise through the tower due to buoyancy effects. As the heated air rises, the kinetic energy of the moving air may be captured by air turbines positioned within or near the tower. Conventional updraft tower systems may rely on solar radiation to heat air, which may require large solar collector areas and may result in intermittent power generation that varies with solar availability.

In cold climate regions, including sub-Arctic and Arctic environments, ambient air temperatures may be substantially below the freezing point of water for extended periods. Bodies of water in these regions, including lakes, rivers, and oceans, may remain in liquid form beneath surface ice due to the thermal properties of water and the insulating effect of ice cover. The temperature differential between liquid water at or near the freezing point and cold ambient air may represent a potential thermal energy resource.

Water undergoes a phase transition from liquid to solid at the freezing point, releasing latent heat of fusion during the freezing process. The latent heat of fusion of water may be approximately 334 kilojoules per kilogram, which represents a substantial quantity of thermal energy that may be released when water freezes. In cold climate regions where ambient air temperatures are well below the freezing point of water, the temperature differential between liquid water and cold air may provide conditions suitable for heat transfer from water to air.

Carbon dioxide capture from ambient air, sometimes referred to as direct air capture, may involve contacting air with absorbent or adsorbent materials that selectively bind carbon dioxide molecules. The captured carbon dioxide may subsequently be released from the capture materials through regeneration processes that may require thermal or electrical energy input. Moving air through carbon dioxide capture systems may require energy for fans or blowers in some configurations.

The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Some embodiments may include a process, a system, an apparatus, or any combination thereof, which may be configured to convert thermal energy associated with a temperature difference between one fluid and a one gas stream, such as air, into kinetic energy of moving gas, such as air, and/or into electrical power, or mechanical power, or absorber or adsorber contacting airflow, or absorber or adsorber contacting mass flow, or stored thermal energy, or stored potential energy, or any combination thereof. In some embodiments, a process may comprise transferring heat from a fluid to air such that a portion of air may increase in temperature relative to air outside an airflow conduit, and the warmed air may have a lower density than surrounding colder air. In some embodiments, the density difference may induce buoyancy-driven airflow through the airflow conduit, such that a portion of air may move from a first elevation to a second elevation via the airflow conduit. In some embodiments, airflow magnitude, direction, pressure, velocity, temperature, humidity, composition, or any combination thereof may be adjusted using at least one airflow control element, at least one flow control element, or any combination thereof coupled to the airflow conduit.

Some embodiments may include a system comprising an airflow conduit having an air inlet at a first elevation and an air outlet at a second elevation. In some embodiments, the first elevation may be lower than the second elevation. In some embodiments, the system may comprise a thermal exchange zone configured to transfer heat from a fluid to air and to generate upward airflow within the airflow conduit. In some embodiments, the system may further comprise at least one flow control element configured to adjust the airflow through the airflow conduit.

In some embodiments, heat transfer and airflow generation may utilize sensible heat, latent heat, or any combination thereof. In some embodiments, transferring heat from the fluid to air may comprise direct-contact heat exchange, indirect heat exchange, or any combination thereof. In some embodiments, direct-contact heat exchange may comprise contacting air with the fluid in a thermal exchange zone. In some embodiments, the thermal exchange zone for direct-contact heat exchange may comprise one or more or any combination of the following: a water pool, or a basin, or a reservoir, or a channel, or a flume, or a tray, or a tray column, or a spray chamber, or a spray tower, or a spray manifold, or a nozzle array, or a mister, or an atomizer, or a droplet generator, or a bubble diffuser, or a venturi injector, or a jet, or a fountain, or a cascade, or a weir, or a waterfall, or a packed bed, or structured packing, or random packing, or a falling-film surface, or a rotating contactor, or a membrane contactor, or any combination thereof. In some embodiments, the thermal exchange zone may be configured to increase air temperature relative to air outside the airflow conduit, thereby increasing buoyancy-driven airflow through the airflow conduit.

In some embodiments, indirect heat exchange may comprise transferring heat through at least one solid wall separating air and the fluid. In some embodiments, indirect heat exchange equipment may comprise one or more or any combination of the following: a shell-and-tube heat exchanger, or a plate heat exchanger, or a spiral heat exchanger, or a finned-tube heat exchanger, or a microchannel heat exchanger, or a coil, or a heat pipe, or an air-to-liquid radiator, or any combination thereof. In some embodiments, indirect heat exchange equipment may be configured to manage fouling, scaling, biofouling, ice accumulation, corrosion, or any combination thereof through material selection, coatings, cleaning cycles, flow modulation, filtration, chemical treatment, or any combination thereof.

In some embodiments, transferring heat from the fluid to air may comprise a phase change of at least a portion of the fluid. In some embodiments, the phase change may include one or more or any combination of the following: freezing of water or another liquid, or crystallization of dissolved salts, or precipitation of dissolved minerals, or condensation of water vapor, or deposition of water vapor, or melting of ice in a recirculating loop, or any combination thereof. In some embodiments, heat released during freezing, crystallization, precipitation, condensation, or deposition may increase the effective heat transfer from the fluid to air relative to sensible-heat operation, and the increased heat transfer may increase buoyancy-driven airflow. In some embodiments, operation may be configured to promote partial freezing, substantial freezing, or cycling between freezing and melting, and control of freezing fraction may be performed through fluid flow control, air flow control, droplet size control, residence time control, mixing, or any combination thereof.

In some embodiments, the fluid may comprise a liquid, a gas, a solid-liquid mixture, a liquid-gas mixture, or any combination thereof. In some embodiments, the fluid may comprise one or more or any combination of the following: water, or seawater, or brackish water, or freshwater, or river water, or lake water, or pond water, or stream water, or groundwater, or subterranean water, or industrial wastewater, or process water, or heated effluent, or cooling water, or data-center cooling water, or power-plant cooling water, or geothermal fluid, or produced water, or mining water, or agricultural water, or aquaculture water, or brine, or saltwater, or a fertilizer solution, or a urea-containing solution, or an antifreeze solution, or a glycol solution, or an ethylene glycol solution, or a propylene glycol solution, or an ammonia-containing solution, or a hydrocarbon liquid, or an oil, or a molten salt, or an ionic liquid, or a refrigerant, or carbon dioxide, or a phase change material, or a eutectic mixture, or a slurry, or an emulsion, or a nanofluid, or any combination thereof. In some embodiments, selection of fluid composition may be responsive to environmental temperature, desired freezing point depression, heat transfer coefficient targets, viscosity targets, corrosion constraints, environmental constraints, availability of the fluid, or any combination thereof.

In some embodiments, the fluid may be obtained from a fluid source that may comprise one or more or any combination of the following: an ocean, or a sea, or a lake, or a river, or an estuary, or a bay, or a lagoon, or a pond, or a stream, or a reservoir, or a cooling pond, or a tank, or a canal, or a subterranean aquifer, or a well, or an industrial process stream, or any combination thereof. In some embodiments, the fluid may be transported to the thermal exchange zone through at least one conduit, pipeline, channel, pump, valve, filter, heat exchanger, or any combination thereof, and the fluid may be recirculated, treated, monitored, blended, concentrated, diluted, degassed, or any combination thereof.

In some embodiments, the airflow conduit may comprise one or more or any combination of the following: an updraft tower, or a chimney, or a stack, or a duct, or a shaft, or a tunnel, or a pipe, or a conduit integrated into a building, or a conduit integrated into terrain, or any combination thereof. In some embodiments, the airflow conduit may be oriented vertically, may be angled relative to vertical, may be oriented along a slope, may be curved, may include a plurality of segments, or may include any combination thereof. In some embodiments, an angled or sloped airflow conduit may be supported by a hillside, a mountainside, a cliffside, a berm, an embankment, or any combination thereof. In some embodiments, an airflow conduit may be excavated into a geographic feature, constructed through a geographic feature, constructed on a surface of a geographic feature, or any combination thereof.

In some embodiments, the airflow conduit may have a cross-section that may comprise a circular cross-section, a polygonal cross-section, an elliptical cross-section, or any combination thereof. In some embodiments, cross-sectional area may be constant, increasing, decreasing, or varying along the length of the airflow conduit, and variation may be configured to manage velocity, pressure drop, turbine loading, flow separation, or any combination thereof. In some embodiments, the airflow conduit may comprise internal flow-conditioning structures configured to manage turbulence, swirl, flow separation, icing, pressure recovery, noise, vibration, or any combination thereof, and internal structures may include one or more or any combination of the following: baffles, or swirlers, or guide vanes, or flow straighteners, or screens, or diffusers, or nozzles, or turning vanes, or louvers, or vanes, or any combination thereof.

In some embodiments, the airflow conduit may be modular or prefabricated. In some embodiments, modular configurations may include one or more or any combination of the following: vertical modules that may be stacked to form height, or circumferential modules that may be assembled to form circumference, or functional modules that may include inlet modules, outlet modules, thermal exchange modules, turbine modules, flow control modules, access modules, instrumentation modules, or any combination thereof. In some embodiments, the airflow conduit may comprise a rigid structure, a flexible structure, a fixed structure, a movable structure, a temporary structure, a permanent structure, or any combination thereof. In some embodiments, a movable or flexible structure may comprise a collapsible structure configured to fold, telescope, lower, deflate, or otherwise change configuration responsive to weather conditions, wind loading, icing conditions, maintenance operations, transport constraints, or any combination thereof.

In some embodiments, the airflow conduit may be constructed from one or more or any combination of the following: metal, or plastic, or composite, or concrete, or ice, or an ice composite, or any combination thereof. In some embodiments, metal materials may include one or more or any combination of the following: steel, or stainless steel, or aluminum, or copper, or titanium, or alloys thereof, or any combination thereof. In some embodiments, construction may include corrugated panels, lattice structures, trusses, cables, guy wires, shells, liners, sleeves, coatings, insulation, or any combination thereof. In some embodiments, ice-based construction may comprise ice, ice reinforced with fibers, ice reinforced with particulate fillers, ice mixed with brine, ice mixed with salt crystals, ice mixed with organic fibers, ice mixed with polymer fibers, or any combination thereof.

In some embodiments, adjusting airflow may comprise adjusting airflow at the air inlet, adjusting airflow at the air outlet, adjusting airflow within the airflow conduit, or any combination thereof. In some embodiments, an airflow control element may be positioned at or near the air inlet, positioned at or near the air outlet, positioned within the airflow conduit, positioned within the thermal exchange zone, positioned upstream of a turbine, positioned downstream of a turbine, or positioned at any combination of such locations. In some embodiments, an airflow control element may comprise one or more or any combination of the following: fins, or panels, or blades, or air foils, or mesh, or valves, or doors, or flexible materials, or solid materials, or liquid, or flaps, or rigid materials, or semi-rigid materials, or shutters, or dampers, or louvers, or vanes.

In some embodiments, a flow control element of a system may be configured to adjust airflow through the airflow conduit. In some embodiments, at least one flow control element may be positioned at the air inlet, positioned at the air outlet, positioned within the airflow conduit, or positioned at any combination of such locations. In some embodiments, flow control elements may comprise shutters, dampers, louvers, vanes, doors, valves, or any combination thereof, and flow control elements may be configured for discrete positioning, staged positioning, continuously variable positioning, or any combination thereof.

In some embodiments, flow control elements may be configured for wind-assisted operation. In some embodiments, a windward inlet may be opened and a leeward inlet may be closed to promote inflow aligned with a prevailing wind direction, and a windward outlet may be opened and a leeward outlet may be closed to promote outflow aligned with prevailing wind direction. In some embodiments, inlet control, outlet control, or any combination thereof may be responsive to one or more or any combination of the following: wind direction, or wind velocity, or changes in wind direction, or gusts, or turbulence intensity, or atmospheric stability, or any combination thereof. In some embodiments, flow control elements may be configured to reduce backdraft, reduce recirculation, reduce short-circuiting between inlets and outlets, reduce ice accumulation in selected regions, protect turbines, or any combination thereof.

In some embodiments, adjusting airflow using an airflow control element or a flow control element may be responsive to one or more or any combination of the following: wind properties, or wind direction, or wind velocity, or changes in wind direction, or air temperature, or air humidity, or air composition, or fluid temperature, or system conditions, or operating conditions, or operating state, or presence, or absence of blockages, or predicted weather, or weather, or measured weather, or past conditions, or current conditions, or future conditions, or predictive modeling, or measurements, or current measurements, or power demand, or fluid availability, or power cost, or economic considerations, or practical considerations, or operational constraints, or system demands, or downstream demand, or product produced, or system optimizations.

In some embodiments, airflow adjustment may be performed manually, automatically, remotely, passively, actively, or any combination thereof. In some embodiments, passive control may include aerodynamic self-alignment, gravity-biased elements, spring-biased elements, pressure-responsive elements, buoyancy-responsive elements, or any combination thereof. In some embodiments, active control may include sensors, actuators, controllers, communication links, or any combination thereof. In some embodiments, sensors may include one or more or any combination of the following: temperature sensors, or humidity sensors, or pressure sensors, or flow sensors, or wind sensors, or ice detection sensors, or cameras, or thermal imaging sensors, or any combination thereof. In some embodiments, control architectures may include local controllers, distributed controllers, a master control system, or any combination thereof, and control algorithms may include rule-based control, model-based control, optimization control, machine-learning control, or any combination thereof.

In some embodiments, control systems may integrate high-resolution temperature mapping of a thermal exchange zone, a water pool, structured media, a heat exchanger surface, turbine regions, or any combination thereof. In some embodiments, high-resolution temperature mapping may comprise one or more or any combination of the following: thermal imaging cameras, or temperature sensor arrays, or distributed temperature sensing, or any combination thereof. In some embodiments, temperature mapping data may be used to adjust water distribution, droplet size, water flow rate, brine concentration, defrost timing, airflow control element position, turbine operating point, or any combination thereof.

In some embodiments, the system may further comprise a power generation unit fluidly coupled to the airflow conduit and configured to convert at least a portion of kinetic energy associated with airflow into electrical power, mechanical power, or any combination thereof. In some embodiments, the power generation unit may comprise at least one turbine positioned to receive airflow within the airflow conduit, at the air inlet, at the air outlet, or at another location fluidly coupled to the airflow conduit. In some embodiments, a turbine may be coupled to an electrical generator, an alternator, a gearbox, a direct-drive system, or any combination thereof. In some embodiments, electrical output may be conditioned using power electronics, and electrical output may be exported to a grid, supplied to an on-site load, stored in an energy storage system, or any combination thereof.

In some embodiments, a turbine may comprise one or more or any combination of the following: a Wells turbine, or an impulse turbine, or a radial turbine, or a mixed-flow turbine, or a cross-flow turbine, or an axial-flow turbine, or a Savonius turbine, or a Darrieus turbine, or a Gorlov turbine, or a ducted turbine, or any combination thereof. In some embodiments, a turbine may be configured for unidirectional airflow or bidirectional airflow, and turbine selection may be responsive to expected airflow direction variability, expected airflow velocity range, expected pressure ratio, expected icing conditions, maintenance constraints, or any combination thereof. In some embodiments, a turbine may include variable-pitch blades, fixed-pitch blades, active stall control, passive stall control, or any combination thereof.

In some embodiments, a power generation unit may comprise a plurality of turbines arranged in series, arranged in parallel, arranged in stages, arranged in cascades, or arranged in any combination thereof. In some embodiments, the airflow conduit may comprise a nozzle, a diffuser, a contraction, an expansion, or any combination thereof positioned to condition airflow upstream of a turbine or downstream of a turbine. In some embodiments, guide vanes, turning vanes, flow straighteners, or any combination thereof may be positioned to reduce swirl, to improve turbine inflow, or to manage load distribution on blades.

In some embodiments, mechanical power output from a turbine may be transmitted through one or more or any combination of the following: shafts, or gears, or belts, or chains, or couplings, or hydraulic couplings, or any combination thereof. In some embodiments, mechanical power may be used to drive one or more or any combination of the following: a pump, or a compressor, or a fan, or a blower, or a desalination unit, or a direct air capture regeneration unit, or an electrolyzer balance-of-plant component, or any combination thereof.

In some embodiments, the thermal exchange zone may be positioned at or near the air inlet at the first elevation, positioned within an interior region of the airflow conduit, positioned below a turbine, positioned above a turbine, positioned in a plurality of locations along the airflow conduit, or positioned in any combination of such locations. In some embodiments, the thermal exchange zone may comprise at least one water pool, at least one basin, at least one spray chamber, at least one packed section, at least one heat exchanger, or any combination thereof positioned to transfer heat from the fluid to air.

In some embodiments, a water pool or basin may receive fluid via an intake system and may discharge fluid via an outlet system. In some embodiments, intake systems may include one or more or any combination of the following: intake pipes, or intake channels, or screened intakes, or filtration systems, or pumps, or valves, or any combination thereof. In some embodiments, outlet systems may include one or more or any combination of the following: outflow pipes, or outflow channels, or weirs, or sluices, or gates, or pumps, or valves, or any combination thereof. In some embodiments, a water pool may be configured to promote circulation using jets, propellers, mixers, air injection, or any combination thereof, and circulation may be configured to manage ice formation patterns, to transport ice toward a collection zone, or to manage temperature uniformity.

In some embodiments, fluid distribution in a thermal exchange zone may comprise one or more or any combination of the following: spray nozzles configured to form droplets of selected size, or misters configured to form fine droplets, or atomizers configured to form aerosols, or perforated plates, or drip emitters, or weirs, or film distributors, or rotating sprayers, or oscillating sprayers, or any combination thereof. In some embodiments, droplet size, spray angle, droplet residence time, and distribution uniformity may be adjusted to manage heat transfer rate, freezing fraction, drift losses, icing on structures, or any combination thereof.

In some embodiments, a thermal exchange zone may comprise structured media or packing configured to increase water-air contact area. In some embodiments, structured media or packing may comprise one or more or any combination of the following: structured packing, or random packing, or corrugated sheets, or honeycomb structures, or lattice structures, or mesh structures, or foam structures, or any combination thereof. In some embodiments, structured media may be arranged in a plurality of sections, and sections may be configured for removal, replacement, cleaning, defrost, inspection, or any combination thereof.

In some embodiments, ice management within the thermal exchange zone, the airflow conduit, an airflow control element, a flow control element, a turbine region, or any combination thereof may include one or more or any combination of the following: providing structured media configured for removal or replacement, or configuring structured media in multiple sections that may be isolated for maintenance, or applying ice-phobic coatings, or applying hydrophobic coatings, or applying anti-icing agents to at least one surface, or adding freezing-point-depressant compounds to the fluid, or providing localized heating elements, or circulating warmer fluid through heat tracing loops, or flushing with warmer fluid, or providing warm-air injection, or providing steam injection, or providing intermittent wetting, or providing intermittent drying, or providing airflow bypass paths, or providing vibration systems, or providing ultrasonic transducers, or providing mechanical scraping systems, or providing rakes, or providing brushes, or providing wipers, or providing backflushing of packing, or providing flow reversal, or providing tilting or rotating media modules, or providing drainage channels and meltwater collection basins, or providing insulation and heat tracing on conduits, or providing sheltered enclosures around selected components, or any combination thereof. In some embodiments, ice detection and ice control may be performed responsive to one or more or any combination of the following: sensor inputs, or thermal imaging data, or pressure drop data, or airflow velocity data, or turbine power data, or droplet drift data, or visual inspection data, or any combination thereof.

In some embodiments, production of freshwater, brine, salt, minerals, or any combination thereof may be performed through freeze desalination, fractional freezing, crystallization, or any combination thereof. In some embodiments, a freeze-desalination unit may be fluidly coupled to the airflow conduit, and heat released during freezing may be transferred to air within the airflow conduit to contribute to buoyancy-driven airflow. In some embodiments, freeze desalination may comprise freezing saline water to produce ice and concentrated brine, separating ice from brine, washing ice to reduce salinity, melting ice to produce freshwater, concentrating brine to precipitate salt crystals, or any combination thereof.

In some embodiments, separating ice from brine may include one or more or any combination of the following: gravity separation, or flotation, or filtration, or screening, or centrifugation, or hydrocyclone separation, or belt separation, or screw separation, or any combination thereof. In some embodiments, washing ice may include countercurrent washing, spray washing, wash columns, immersion washing, or any combination thereof. In some embodiments, brine concentration and salt recovery may include staged freezing, staged crystallization, evaporation, membrane concentration, electrodialysis, or any combination thereof. In some embodiments, mineral recovery may include precipitation of selected salts, adsorption, ion exchange, solvent extraction, electrochemical separation, or any combination thereof.

In some embodiments, the fluid transferred through the thermal exchange zone may comprise a brine selected to control freezing point, to control ice morphology, to support production of ice-brine mixtures configured for enhanced cooling capacity, or any combination thereof. In some embodiments, brine or salt products may be directed to industrial uses, water treatment uses, de-icing uses, chemical feedstock uses, or any combination thereof, and freshwater products may be directed to drinking water, irrigation, industrial processes, or any combination thereof.

In some embodiments, a process may further comprise transferring a material comprising the fluid after transferring heat from the fluid to air to a deposit location at a third elevation. In some embodiments, the third elevation may be lower than the first elevation, and transferring to the deposit location may be configured to use gravitational potential energy to support transport of liquids, solids, or solid-liquid mixtures. In some embodiments, the material transferred to the deposit location may comprise cooled water, ice, a solid-liquid mixture, brine, salt crystals, precipitated minerals, or any combination thereof.

In some embodiments, transferring the material to the deposit location may comprise one or more or any combination of the following: transporting liquid through a pipeline, or a channel, or a flume, or a penstock, or any combination thereof; transporting solids through a conveyor system, or a chute, or a slide, or a rail system, or a cable system, or a bucket system, or any combination thereof; transporting solid-liquid mixtures through a pump, or an auger, or a screw conveyor, or a pneumatic transport system, or a gravity chute, or any combination thereof; transporting multi-phase mixtures through a pipeline configured for multi-phase flow, or through a channel configured for multi-phase flow, or any combination thereof.

In some embodiments, the process may further comprise recovering energy from transferring the material to the deposit location using an energy recovery device. In some embodiments, the energy recovery device may be configured to recover at least a portion of gravitational potential energy of the material, to recover pressure energy, or to recover any combination thereof. In some embodiments, the energy recovery device may comprise one or more or any combination of the following: a turbine, or a pump operated as a turbine, or a hydroelectric generator, or an Archimedes screw, or a mechanical exchanger, or a pressure exchanger, or a pulley system, or a conveyor belt system, or any combination thereof.

In some embodiments, recovered energy may be used to generate electrical power, to generate mechanical power, to drive a pump that may transfer fluid from a fluid source to the thermal exchange zone, to charge an energy storage system, or any combination thereof. In some embodiments, a pulley system may comprise counterweights configured to balance at least a portion of lifted fluid weight, and a conveyor belt system may comprise counterweights or regenerative drives configured to recover energy from downward transport. In some embodiments, energy recovery equipment may be configured for reversible operation to support energy storage through raising fluid to a higher elevation responsive to availability of electrical power and releasing fluid to recover energy responsive to power demand.

In some embodiments, the system may comprise at least one direct air capture contactor fluidly coupled to the airflow conduit and configured to capture carbon dioxide from airflow moving through the airflow conduit. In some embodiments, the direct air capture contactor may be positioned downstream of the thermal exchange zone, upstream of a turbine, downstream of a turbine, or at any combination of such positions, and placement may be selected responsive to temperature, humidity, droplet content, icing constraints, pressure drop constraints, or any combination thereof. In some embodiments, the direct air capture contactor may comprise a packed bed, a structured packing contactor, a spray tower, a tray column, a membrane contactor, a rotating contactor, or any combination thereof.

In some embodiments, the direct air capture contactor may include at least one absorbent, at least one adsorbent, or any combination thereof. In some embodiments, at least one absorbent may comprise one or more or any combination of the following: an amine solution, or an aqueous hydroxide solution, or a carbonate solution, or a bicarbonate solution, or an amino acid salt solution, or an ionic liquid, or any combination thereof. In some embodiments, at least one adsorbent may comprise one or more or any combination of the following: an amine-functionalized sorbent, or an alkali metal carbonate, or an alkali metal hydroxide on a support, or activated carbon, or a zeolite, or a metal-organic framework, or a polymeric sorbent, or any combination thereof. In some embodiments, at least one sorbent may be supported on structured media, porous pellets, fibers, foams, monoliths, membranes, or any combination thereof.

In some embodiments, captured carbon dioxide may be processed through regeneration to produce a concentrated carbon dioxide stream. In some embodiments, regeneration may include one or more or any combination of the following: thermal regeneration using low-grade heat, or steam stripping, or vacuum regeneration, or pressure swing, or temperature swing, or humidity swing, or electrochemical regeneration, or calcination, or any combination thereof. In some embodiments, electrical power or mechanical power generated by the system may be used to power regeneration equipment, blowers, pumps, vacuum pumps, compressors, or any combination thereof.

In some embodiments, captured carbon dioxide may be used for downstream utilization, storage, or any combination thereof. In some embodiments, downstream utilization may include one or more or any combination of the following: producing synthetic fuels, or producing chemicals, or producing building materials, or producing carbonates, or producing urea, or producing polymers, or mineralizing carbon dioxide, or any combination thereof. In some embodiments, synthetic fuel production may include generating hydrogen via electrolysis using at least one electrolyzer comprising an alkaline electrolyzer, a proton-exchange-membrane electrolyzer, an anion-exchange-membrane electrolyzer, a solid-oxide electrolyzer, or any combination thereof, and combining hydrogen with captured carbon dioxide or nitrogen to produce one or more fuels or fuel precursors. In some embodiments, fuels or fuel precursors may include one or more or any combination of the following: hydrogen, or ammonia, or methanol, or Fischer-Tropsch hydrocarbons, or synthetic gasoline, or diesel, or jet fuel, or dimethyl ether, or liquefied natural gas, or any combination thereof.

In some embodiments, implementations may be deployed on land, onshore, offshore, or any combination thereof. In some embodiments, deployment sites may be selected responsive to availability of a temperature difference between a fluid source and ambient air, availability of a height difference between the first elevation and the second elevation, wind resource, access to water, access to electrical interconnection, access to product transport infrastructure, or any combination thereof.

In some embodiments, a system may comprise an offshore structure that may support an airflow conduit, a thermal exchange zone, or any combination thereof. In some embodiments, an offshore structure may comprise one or more or any combination of the following: a ship-shaped structure, or a floating structure, or a gravity-based structure, or a piling-based structure, or a pre-fabricated structure, or any combination thereof. In some embodiments, a ship-shaped structure may comprise a purpose-built vessel, a retrofitted vessel, a barge, a decommissioned vessel, or any combination thereof. In some embodiments, a piling-based structure may comprise a platform supported by piles, a jacket structure, a monopile structure, or any combination thereof, and a gravity-based structure may comprise a caisson, a gravity base, a ballasted structure, or any combination thereof.

In some embodiments, an airflow conduit may be integrated into existing infrastructure, and existing infrastructure may comprise one or more or any combination of the following: industrial stacks, or building shafts, or mine shafts, or tunnels, or bridge structures, or offshore platforms, or vessels, or any combination thereof. In some embodiments, modular or prefabricated construction may enable transport by road, rail, ship, or any combination thereof, and assembly may be performed using cranes, jacking systems, slip-forming, climbing formwork, inflatable erection, or any combination thereof.

In some embodiments, buoyancy-driven airflow, wind-assisted airflow, or any combination thereof may be harnessed for applications in addition to, or instead of, electrical power generation. In some embodiments, harnessing airflow or harnessing products of heat transfer may include one or more or any combination of the following: producing ice, or producing freshwater, or producing concentrated brine, or producing salt crystals, or extracting minerals, or providing ventilation air, or providing process air circulation, or supporting drying operations, or supporting dehumidification operations, or supporting cooling operations, or supporting refrigeration operations, or supporting thermal storage, or supporting thermal management of industrial equipment, or supporting aquaculture operations, or supporting water treatment, or supporting wastewater treatment, or supporting brine management, or supporting carbon dioxide capture, or supporting synthetic fuel production, or any combination thereof.

In some embodiments, ice or ice-brine mixtures produced through heat transfer may be used for one or more or any combination of the following: thermal energy storage, or cold-chain logistics, or cooling of facilities, or cooling of industrial processes, or cooling of data centers, or cooling of mining operations, or cooling of shipping containers, or any combination thereof. In some embodiments, ice or ice-brine mixtures may be deployed to enhance surface reflectivity, to enhance albedo of a surface, to slow melt of sea ice, to thicken sea ice, to strengthen ice roads, to support temporary infrastructure, to support wildfire prevention, to support wildfire suppression, or any combination thereof. In some embodiments, ice may be formed into blocks, pellets, granules, slurries, composites, or any combination thereof to facilitate handling and transport.

In some embodiments, a plurality of outputs may be co-produced, and co-produced outputs may comprise electrical power, mechanical power, freshwater, brine, salt crystals, minerals, ice, captured carbon dioxide, synthetic fuels, or any combination thereof.

In some embodiments, control of airflow, water flow, brine concentration, turbine operating point, direct air capture operating point, or any combination thereof may be configured to optimize a selected objective function comprising power output, product output, product value, reliability, maintenance intervals, or any combination thereof.

In some embodiments, an apparatus may comprise means for transferring heat from a fluid to air in a thermal exchange zone, means for inducing airflow through an airflow conduit between a first elevation and a second elevation, means for adjusting airflow using at least one airflow control element or at least one flow control element, means for converting kinetic energy of airflow into electrical power or mechanical power using a power generation unit, means for recovering gravitational potential energy or pressure energy from transferring a material to a lower elevation using an energy recovery device, means for producing ice, freshwater, brine, salt crystals, or minerals through freezing, crystallization, or any combination thereof, means for capturing carbon dioxide from airflow using at least one direct air capture contactor comprising at least one absorbent or adsorbent, and means for monitoring or controlling at least one operating parameter using sensors, controllers, actuators, or any combination thereof. In some embodiments, described features may be implemented alone or in any combination, and combinations may be selected responsive to site conditions, desired products, regulatory constraints, economic constraints, or any combination thereof.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts a schematic flow diagram illustrating transfer of materials between system components at different elevations, according to aspects of the present disclosure.

FIG. 2 depicts a schematic flow diagram illustrating transfer of materials between system components at different elevations, according to an embodiment.

FIG. 3 depicts a schematic diagram showing system components at substantially equal elevations, according to aspects of the present disclosure.

FIG. 4 depicts a schematic flow diagram illustrating transfer of fluid between system components with ascending elevations, according to an embodiment.

FIG. 5 depicts a schematic flow diagram illustrating transfer of fluid between system components at varying elevations, according to aspects of the present disclosure.

FIG. 6 depicts a schematic flow diagram illustrating transfer of materials between system components at different elevations, according to an embodiment.

FIG. 7 depicts a side elevation view of an updraft tower system configured for power generation, according to aspects of the present disclosure.

FIG. 8 depicts a top-down schematic view of a layout for water pools within a thermal power generation system, according to an embodiment.

FIG. 9 depicts a top-down schematic view of a layout for water pools within a thermal power generation system, according to aspects of the present disclosure.

FIG. 10 depicts a schematic view of cylindrical structures arranged in a linear array, according to an embodiment.

FIG. 11 depicts a top-down schematic view of circular elements arranged in a linear configuration, according to aspects of the present disclosure.

FIG. 12 depicts a cross-sectional schematic view of an updraft tower system with shutters and turbines, according to an embodiment.

FIG. 13 depicts a schematic cross-sectional view of an updraft tower system with a water pool, according to aspects of the present disclosure.

FIG. 14 depicts a cross-sectional schematic view of an updraft tower system with water sprayers and a water pool, according to an embodiment.

FIG. 15 depicts a schematic cross-sectional view of an updraft tower system with shutters and turbines, according to aspects of the present disclosure.

FIG. 16 depicts a cross-sectional side view of an updraft tower system with water pools positioned before turbines, according to an embodiment.

FIG. 17 depicts a schematic cross-sectional view of an updraft tower system with water pools and turbines, according to aspects of the present disclosure.

FIG. 18 depicts a cross-sectional side view of an updraft tower system with water sprayers and water pools, according to an embodiment.

FIG. 19 depicts a schematic cross-sectional view of an updraft tower system with water sprayers and basins, according to aspects of the present disclosure.

FIG. 20 depicts a cross-sectional side view of an updraft tower system with water sprayers and basins, according to an embodiment.

FIG. 21 depicts a cross-sectional side view of an updraft tower system with water sprayers and basins, according to aspects of the present disclosure.

FIG. 22 depicts a top-down schematic view of an updraft tower system with turbines and water pools, according to an embodiment.

FIG. 23 depicts a top-down schematic view of an updraft tower system with water pools and shutters, according to aspects of the present disclosure.

FIG. 24 depicts a horizontal cross-sectional view of an updraft tower system with water sprayers and turbines, according to an embodiment.

FIG. 25 depicts a cross-sectional side view of an updraft tower system with water sprayers, according to aspects of the present disclosure.

FIG. 26 depicts a top-down view of an updraft tower system with a turbine and water pools, according to an embodiment.

FIG. 27 depicts a top-down schematic view of an updraft tower system with water pools and a turbine, according to aspects of the present disclosure.

FIG. 28 depicts a cross-sectional side view of an updraft tower system with a turbine at the top, according to an embodiment.

FIG. 29 depicts a cross-sectional side view of an updraft tower system with water sprayers and water pools, according to aspects of the present disclosure.

FIG. 30 depicts a water pool system with submerged water jets, according to an embodiment.

FIG. 31 depicts a water distribution and spray system for air-water contacting, according to aspects of the present disclosure.

FIG. 32 depicts a water pool system with submerged water jets, according to an embodiment.

FIG. 33 depicts a top-down schematic view of a water distribution and collection system, according to aspects of the present disclosure.

FIG. 34 depicts a schematic diagram of a water pool system with submerged water jets, according to an embodiment.

FIG. 35 depicts a schematic side view of a thermal power generation system with water sprayers, according to aspects of the present disclosure.

FIG. 36 depicts a schematic top-down view of a water pool system with submerged water jets, according to an embodiment.

FIG. 37 depicts a schematic side view of a thermal power generation system with fluid distribution elements, according to aspects of the present disclosure.

FIG. 38 depicts a schematic cross-sectional view of a water pool system with submerged water jets, according to an embodiment.

FIG. 39 depicts a schematic cross-sectional view of a thermal power generation system with water sprayers, according to aspects of the present disclosure.

FIG. 40 depicts a schematic top-down view of a water pool system with water circulation, according to an embodiment.

FIG. 41 depicts a schematic top-down view of a water pool system with water circulation, according to aspects of the present disclosure.

FIG. 42 depicts a schematic cross-sectional view of a water pool system with ice removal devices, according to an embodiment.

FIG. 43 depicts a top-down schematic view of an ice removal system for a water pool, according to aspects of the present disclosure.

FIG. 44 depicts a schematic diagram of an ice removal and water circulation system, according to an embodiment.

FIG. 45 depicts a schematic top-down view of an ice removal system for a water basin, according to aspects of the present disclosure.

FIG. 46 depicts a top-down schematic view of a water pool with water circulation patterns, according to an embodiment.

FIG. 47 depicts a schematic top-down view of an updraft tower system with flow control elements, according to aspects of the present disclosure.

FIG. 48 depicts a top-down schematic view of a dual water pool ice removal system, according to an embodiment.

FIG. 49 depicts a top-down schematic view of a dual-basin ice removal system, according to aspects of the present disclosure.

FIG. 50 depicts a top-down schematic view of an updraft tower system with shutters and water-air contact zones, according to an embodiment.

FIG. 51 depicts a top-down schematic view of a circular structure with a turbine and air intake, according to aspects of the present disclosure.

FIG. 52 depicts a top-down schematic view of an updraft tower system with selective shutter configurations, according to an embodiment.

FIG. 53 depicts a top-down schematic view of an updraft tower system with flow control elements and wind direction, according to aspects of the present disclosure.

FIG. 54 depicts a top-down schematic view of an updraft tower system with shutters responding to wind direction, according to an embodiment.

FIG. 55 depicts a top-down schematic view of an updraft tower system with water-air contact zones and wind direction, according to aspects of the present disclosure.

FIG. 56 depicts a top-down schematic view of an updraft tower system with all shutters closed, according to an embodiment.

FIG. 57 depicts a top-down schematic view of an updraft tower system with a turbine and water-air contact zones, according to aspects of the present disclosure.

FIG. 58 depicts a top-down schematic view of an updraft tower system with multiple turbines and water-air contact zones, according to an embodiment.

FIG. 59 depicts a top-down schematic view of a circular structure with radially arranged elements and air intake, according to aspects of the present disclosure.

FIG. 60 depicts a top-down schematic view of an updraft tower system with multiple turbines and selective shutter configurations, according to an embodiment.

FIG. 61 depicts a top-down schematic view of an updraft tower system with adjustable shutters and wind direction, according to aspects of the present disclosure.

FIG. 62 depicts a top-down schematic view of an updraft tower system with multiple turbines and wind-responsive shutters, according to an embodiment.

FIG. 63 depicts a top-down schematic view of an updraft tower system with open shutters on a windward side, according to aspects of the present disclosure.

FIG. 64 depicts a top-down schematic view of an updraft tower system with multiple turbines and all shutters closed, according to an embodiment.

FIG. 65 depicts a top-down schematic view of an updraft tower system with a turbine and water-air contact zones, according to aspects of the present disclosure.

FIG. 66 depicts a cross-sectional side view of an updraft tower system with turbines and a water pool, according to an embodiment.

FIG. 67 depicts a schematic cross-sectional view of an updraft tower system with turbines and a water pool, according to aspects of the present disclosure.

FIG. 68 depicts a side view of an updraft tower system with selective shutter configurations, according to an embodiment.

FIG. 69 depicts a schematic cross-sectional view of an updraft tower system with turbines and a water pool, according to aspects of the present disclosure.

FIG. 70 depicts a cross-sectional side view of an updraft tower system with selective shutter configurations, according to an embodiment.

FIG. 71 depicts a schematic cross-sectional view of an updraft tower system with turbines and a water pool, according to aspects of the present disclosure.

FIG. 72 depicts a cross-sectional side view of an updraft tower system with all shutters closed, according to an embodiment.

FIG. 73 depicts a cross-sectional side view of an updraft tower system with turbines and water pools, according to aspects of the present disclosure.

FIG. 74 depicts a cross-sectional side view of an updraft tower system with turbines and water pools, according to an embodiment.

FIG. 75 depicts a schematic cross-sectional view of an updraft tower system with water sprayers and water basins, according to aspects of the present disclosure.

FIG. 76 depicts a side view of an updraft tower system with selective shutter configurations and water pools, according to an embodiment.

FIG. 77 depicts a cross-sectional side view of an updraft tower system with water sprayers and water basins, according to aspects of the present disclosure.

FIG. 78 depicts a cross-sectional side view of an updraft tower system with selective shutter configurations and water pools, according to an embodiment.

FIG. 79 depicts a cross-sectional side view of an updraft tower system with turbines and water basins, according to aspects of the present disclosure.

FIG. 80 depicts a cross-sectional side view of an updraft tower system with all shutters closed and water pools, according to an embodiment.

FIG. 81 depicts a cross-sectional side view of an updraft tower system with turbines and water pools, according to aspects of the present disclosure.

FIG. 82 depicts a cross-sectional schematic view of an updraft tower system with direct air capture collectors, according to an embodiment.

FIG. 83 depicts a schematic cross-sectional view of an updraft tower system with a water pool, according to aspects of the present disclosure.

FIG. 84 depicts a side view of a hillside embodiment of an updraft tower system, according to an embodiment.

FIG. 85 depicts a cross-sectional side view of a hillside embodiment of an air conduit system, according to aspects of the present disclosure.

FIG. 86 depicts a top-down schematic view of an updraft tower system with multiple turbines and all shutters open, according to an embodiment.

FIG. 87 depicts a top-down schematic view of a circular structure with radially arranged elements and air intake from multiple directions, according to aspects of the present disclosure.

FIG. 88 depicts a top-down schematic view of an updraft tower system with multiple turbines and selective shutter configurations responding to wind direction, according to an embodiment.

FIG. 89 depicts a top-down schematic view of an updraft tower system with flow control elements and wind direction, according to aspects of the present disclosure.

FIG. 90 depicts a top-down schematic view of an updraft tower system with multiple turbines and wind-responsive shutters, according to an embodiment.

FIG. 91 depicts a top-down schematic view of an updraft tower system with flow control elements and wind direction, according to aspects of the present disclosure.

FIG. 92 depicts a top-down schematic view of an updraft tower system with multiple turbines and all shutters closed, according to an embodiment.

FIG. 93 depicts a top-down schematic view of a circular structure with a turbine and water-air contact zones, according to aspects of the present disclosure.

FIG. 94 depicts a cross-sectional side view of an updraft tower system with direct air capture collectors and water sprayers, according to an embodiment.

FIG. 95 depicts a schematic cross-sectional view of an updraft tower system with water sprayers and a basin, according to aspects of the present disclosure.

FIG. 96 depicts a cross-sectional side view of an updraft tower system with direct air capture collectors and turbines, according to an embodiment.

FIG. 97 depicts a schematic cross-sectional view of an updraft tower system with water sprayers and flow control elements, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Temperature differences between liquids and gases may represent an energy resource that may be harnessed for power generation, thermal management, and various industrial applications. In some embodiments, liquids at temperatures different from surrounding gases may be present throughout natural systems, anthropogenic systems, or any combination thereof. Such temperature differences may exist in a wide variety of environments and may provide opportunities for energy capture, heat transfer, and related processes.

In some embodiments, bodies of water in cold climates may exhibit temperature differences relative to ambient air. For example, during winter months in northern latitudes, liquid water beneath ice cover may be at temperatures near or above the freezing point of water, while ambient air temperatures may be substantially colder. In some embodiments, the temperature difference between liquid water and cold ambient air may be greater than 10 degrees Kelvin, or greater than 15 degrees Kelvin, or greater than 20 degrees Kelvin, or greater than 25 degrees Kelvin, or greater than 30 degrees Kelvin, or greater than 35 degrees Kelvin, or greater than 40 degrees Kelvin, or greater than 45 degrees Kelvin, or greater than 50 degrees Kelvin, or greater than 55 degrees Kelvin, or greater than 60 degrees Kelvin, or any combination thereof. Bodies of water that may exhibit such temperature differences may include one or more or any combination of the following: oceans, or seas, or lakes, or rivers, or estuaries, or bays, or ponds, or streams, or aquifers, or subterranean water sources, or any combination thereof.

In some embodiments, even in cold climates where ice may form on the surface of bodies of water, liquid water may remain beneath the ice layer. Ice layers on bodies of water in cold climates may typically range from approximately 1 meter to approximately 3 meters in thickness, meaning that liquid water at temperatures near or above freezing may be in relatively close proximity to cold ambient air. Freshwater beneath ice cover may be at temperatures ranging from approximately 0 degrees Celsius to approximately 4 degrees Celsius. Seawater or ocean water beneath ice cover may be at temperatures warmer than approximately negative 3 degrees Celsius. Such proximity between relatively warm liquid water and cold ambient air may provide opportunities for heat transfer and energy capture.

In some embodiments, industrial processes may generate liquids at temperatures different from ambient air temperatures. Industrial facilities that may produce such temperature differences may include one or more or any combination of the following: power plants, or manufacturing facilities, or chemical processing plants, or refineries, or smelters, or foundries, or food processing facilities, or beverage production facilities, or pharmaceutical manufacturing facilities, or pulp and paper mills, or textile manufacturing facilities, or any combination thereof. Such industrial processes may generate waste heat in liquid form, cooling water at elevated temperatures, process fluids at various temperatures, or any combination thereof.

In some embodiments, power plants may produce liquids at temperatures different from ambient air. Power plants that may exhibit such temperature differences may include one or more or any combination of the following: thermal power plants, or nuclear power plants, or combined cycle power plants, or cogeneration facilities, or geothermal power plants, or solar thermal power plants, or biomass power plants, or waste-to-energy facilities, or any combination thereof. Cooling water discharged from power plants may be at elevated temperatures relative to ambient conditions, and such temperature differences may represent an energy resource.

In some embodiments, data centers may generate heat that may be transferred to liquids, creating temperature differences relative to ambient air. Data centers may employ liquid cooling systems, water cooling systems, or other thermal management systems that may produce liquids at temperatures different from ambient conditions. The heat generated by computing equipment, servers, storage systems, networking equipment, or any combination thereof may be transferred to cooling fluids, which may then exhibit temperature differences relative to surrounding air.

In some embodiments, geothermal systems may provide liquids at temperatures different from ambient air temperatures. Geothermal resources may include one or more or any combination of the following: geothermal brines, or geothermal fluids, or hot springs, or geysers, or geothermal wells, or enhanced geothermal systems, or ground source heat pump systems, or any combination thereof. Such geothermal resources may provide liquids at elevated temperatures that may differ from ambient air temperatures.

In some embodiments, various processing facilities may generate or utilize liquids at temperatures different from ambient air. Such processing facilities may include one or more or any combination of the following: mining operations, or mineral processing facilities, or desalination plants, or wastewater treatment facilities, or agricultural processing facilities, or aquaculture facilities, or fish processing facilities, or meat processing facilities, or dairy processing facilities, or any combination thereof. Liquids associated with such facilities may include process water, cooling water, heated effluents, brines, or any combination thereof.

In some embodiments, the temperature difference between a liquid and a gas may be harnessed through heat transfer processes. Heat may be transferred from a warmer fluid to a cooler gas, or from a warmer gas to a cooler fluid, depending on the relative temperatures of the fluid and gas. When heat is transferred from a liquid to air, the air may be warmed, and the density of the warmed air may decrease relative to cooler surrounding air. Such density differences may induce air movement, which may be harnessed for various purposes including power generation, air circulation, or other applications.

In some embodiments, the enthalpy of phase change may provide an energy resource. When a liquid freezes to form a solid, latent heat may be released. Water may have a high enthalpy of fusion, which may be approximately 333.55 kilojoules per kilogram. The release of latent heat during freezing may warm surrounding air, which may induce air movement due to density differences. Such air movement may be harnessed for power generation or other purposes. The combination of sensible heat transfer and latent heat release during phase change may provide a substantial energy resource in environments where temperature differences exist between liquids and gases.

In some embodiments, temperature differences between liquids and gases may be present in marine environments, coastal environments, or offshore environments. Such environments may include one or more or any combination of the following: open ocean areas, or coastal waters, or fjords, or inlets, or harbors, or ports, or offshore platforms, or ships, or floating structures, or any combination thereof. Temperature differences in such environments may vary seasonally, diurnally, or based on weather conditions, currents, or other factors.

In some embodiments, temperature differences between liquids and gases may be present in freshwater environments. Such environments may include one or more or any combination of the following: lakes, or rivers, or reservoirs, or ponds, or streams, or canals, or aqueducts, or water storage facilities, or any combination thereof. Temperature differences in freshwater environments may vary based on geographic location, season, depth, weather conditions, or other factors.

In some embodiments, anthropogenic activities may create or enhance temperature differences between liquids and gases. Such activities may include one or more or any combination of the following: industrial cooling, or power generation, or manufacturing, or processing, or heating, or refrigeration, or air conditioning, or any combination thereof. The waste heat or thermal byproducts of such activities may create opportunities for energy capture through heat transfer between liquids and gases.

In some embodiments, a process may comprise transferring heat from a fluid to air. Heat transfer from a fluid to air may occur through various mechanisms, and such heat transfer may involve sensible heat, latent heat, or any combination thereof. The fluid may comprise a liquid, or a solid-liquid mixture, or a phase change fluid, or any combination thereof. Heat transfer from a fluid to air may warm the air, may cool the fluid, may induce phase changes in the fluid, or any combination thereof.

In some embodiments, sensible heat transfer may occur when heat is transferred from a fluid to air without a phase change occurring in the fluid. Sensible heat transfer may be related to the specific heat capacity of the fluid, the temperature difference between the fluid and the air, and the mass of fluid involved in the heat transfer. Fluids may have various specific heat capacities, and water may have a relatively high specific heat capacity of approximately 4.18 kilojoules per kilogram per degree Kelvin. When a fluid at a first temperature contacts air at a second temperature that is lower than the first temperature, heat may be transferred from the fluid to the air, and the air may be warmed while the fluid may be cooled.

In some embodiments, latent heat transfer may occur when a phase change occurs in the fluid during heat transfer. Latent heat may be associated with phase transitions including one or more or any combination of the following: freezing, or melting, or crystallization, or dissolution, or condensation, or evaporation, or sublimation, or deposition, or any combination thereof. The enthalpy of fusion, which may also be referred to as the latent heat of freezing or the latent heat of melting, may represent the energy released when a liquid freezes to form a solid or the energy absorbed when a solid melts to form a liquid. Water may have an enthalpy of fusion of approximately 333.55 kilojoules per kilogram, which may represent a substantial energy release during freezing.

In some embodiments, the enthalpy of evaporation, which may also be referred to as the latent heat of vaporization, may represent the energy absorbed when a liquid evaporates to form a vapor or the energy released when a vapor condenses to form a liquid. Water may have an enthalpy of vaporization of approximately 2,260 kilojoules per kilogram at standard atmospheric pressure. Condensation of water vapor in air may release latent heat, which may contribute to warming of the air.

In some embodiments, heat transfer from a fluid to air may involve both sensible heat and latent heat. When a liquid at a temperature above its freezing point contacts air at a temperature below the freezing point of the liquid, sensible heat may first be transferred from the liquid to the air as the liquid cools toward its freezing point. Once the liquid reaches its freezing point, latent heat may be released as the liquid freezes to form a solid. The combination of sensible heat transfer and latent heat release may provide a greater total heat transfer than sensible heat transfer alone.

In some embodiments, crystallization may release heat during the formation of crystalline solids from solutions. When a solution becomes supersaturated, solutes may crystallize out of solution, and the crystallization process may release heat. Crystallization may occur in brines, salt solutions, or other solutions when temperature decreases or when solvent evaporates. The heat released during crystallization may contribute to warming of surrounding air.

In some embodiments, dissolution may absorb or release heat depending on the nature of the solute and solvent. Some dissolution processes may be exothermic and may release heat, while other dissolution processes may be endothermic and may absorb heat. The heat of dissolution may affect the temperature of the resulting solution and may influence heat transfer between the solution and surrounding air.

In some embodiments, transferring heat from a fluid to air may comprise contacting the fluid with the air. Direct contact heat exchange may involve physical contact between the fluid and the air, which may allow heat to be transferred directly from the fluid to the air without an intervening solid barrier. Direct contact heat exchange may be achieved through various methods including one or more or any combination of the following: spraying the fluid into the air, or passing air over a pool of fluid, or passing air through droplets of fluid, or bubbling air through the fluid, or creating a mist or aerosol of the fluid in the air, or any combination thereof.

In some embodiments, transferring heat from a liquid to air may comprise heat exchange between the fluid and the air. Heat exchange between a fluid and air may occur through direct contact, through indirect contact via a heat exchanger, or through any combination thereof. Heat exchange may transfer thermal energy from the fluid to the air, which may result in warming of the air and cooling of the fluid.

In some embodiments, indirect heat exchange may involve heat transfer through a solid barrier or heat exchanger surface. Indirect heat exchange may employ heat exchangers including one or more or any combination of the following: shell and tube heat exchangers, or plate heat exchangers, or finned tube heat exchangers, or air-cooled heat exchangers, or radiators, or coils, or any combination thereof. In indirect heat exchange, the fluid and the air may not come into direct physical contact, but heat may be transferred through the solid material of the heat exchanger.

In some embodiments, air at a first temperature may be contacted with the fluid to form air at a second temperature, wherein the second temperature may be warmer than the first temperature. When air at a cooler temperature contacts a fluid at a warmer temperature, heat may be transferred from the fluid to the air, and the air may be warmed. The temperature increase of the air may depend on factors including one or more or any combination of the following: the initial temperature difference between the fluid and the air, or the mass flow rate of the air, or the mass flow rate of the fluid, or the contact time between the fluid and the air, or the contact area between the fluid and the air, or the heat transfer coefficient, or whether phase change occurs, or any combination thereof.

In some embodiments, the air at the second temperature may be less dense than air at the first temperature. Air density may decrease as air temperature increases, and warmer air may be less dense than cooler air at the same pressure. The density difference between warmer air and cooler air may create buoyancy forces that may cause the warmer air to rise relative to the cooler air. Such buoyancy-driven air movement may be harnessed for various purposes including power generation, air circulation, or other applications.

In some embodiments, moving from a first elevation to a second elevation may be due to the lower density of the air at the second temperature than the air at the first temperature. When air is warmed through heat transfer from a fluid, the warmed air may become less dense than surrounding cooler air, and the warmed air may rise due to buoyancy forces. The rising of warmed air may create an upward airflow, which may be directed through an air conduit, a tower, a chimney, or other structure. The upward movement of warmed air may be sustained as long as heat continues to be transferred from the fluid to the air, maintaining the density difference that drives the buoyancy-induced flow.

In some embodiments, phase change fluids may be employed in heat transfer processes. Phase change fluids may undergo phase transitions at temperatures relevant to the heat transfer application, and the latent heat associated with such phase transitions may enhance heat transfer. Phase change fluids may include one or more or any combination of the following: water, or aqueous solutions, or brines, or refrigerants, or organic phase change materials, or inorganic phase change materials, or eutectic mixtures, or any combination thereof.

In some embodiments, solid-liquid mixtures may be employed in heat transfer processes. Solid-liquid mixtures may comprise ice-water mixtures, slurries, suspensions, or other combinations of solid and liquid phases. Heat transfer from solid-liquid mixtures to air may involve melting of the solid phase, which may absorb latent heat, or may involve cooling of the liquid phase, which may transfer sensible heat. The presence of solid particles in a liquid may affect the heat transfer characteristics of the mixture.

In some embodiments, heat transfer from a fluid to air may be enhanced through various techniques. Enhancement techniques may include one or more or any combination of the following: increasing the contact area between the fluid and the air, or increasing the turbulence of the fluid flow, or increasing the turbulence of the air flow, or using fins or extended surfaces, or using spray nozzles to create fine droplets, or using packing materials to increase surface area, or any combination thereof. Such enhancement techniques may increase the rate of heat transfer from the fluid to the air.

In some embodiments, the enthalpy of freezing water may represent a renewable energy resource that may be harnessed in sub-Arctic regions, Arctic regions, or other cold climate regions. Water may have a high enthalpy of fusion of approximately 333.55 kilojoules per kilogram, which may represent a substantial energy release when liquid water freezes to form ice. The freezing of one metric ton of water may release approximately 333.55 megajoules of thermal energy, which may be approximately 281 times more energy than the same mass of water passing through a hydroelectric power station with a 400-foot hydraulic head height. Such energy density may make the enthalpy of freezing water a substantial energy resource in regions where cold air temperatures may induce freezing of liquid water.

In some embodiments, liquid water in bodies of water may be within meters of air at temperatures substantially below the freezing point of water. In cold climates, ice layers on bodies of water may typically range from approximately 0.5 meters to approximately 3 meters in thickness. Even in the coldest climates, ice thickness may rarely exceed approximately 3 meters. Such ice thickness may mean that liquid water at temperatures near or above the freezing point of water may be in close proximity to cold ambient air at temperatures substantially below freezing. The proximity between relatively warm liquid water and cold ambient air may provide opportunities for heat transfer and energy capture through the enthalpy of freezing.

In some embodiments, the liquid may comprise water. Water may be employed as a heat transfer fluid due to the high specific heat capacity of water, the high enthalpy of fusion of water, the abundance of water in natural systems, or any combination thereof. Water may be obtained from various sources and may be employed in heat transfer processes that may harness the enthalpy of freezing.

In some embodiments, the liquid comprising water may be selected from freshwater, seawater, or brine. Freshwater may have a freezing point of approximately 0 degrees Celsius at standard atmospheric pressure. Seawater may have a freezing point that may be lower than the freezing point of freshwater due to the presence of dissolved salts, and seawater may have a freezing point of approximately negative 1.8 degrees Celsius to approximately negative 2 degrees Celsius depending on salinity. Brine may have a freezing point that may be lower than the freezing point of seawater, and the freezing point of brine may depend on the concentration and composition of dissolved salts. The selection of freshwater, seawater, or brine may depend on the availability of water sources, the desired freezing point, the intended application, or any combination thereof.

In some embodiments, inlet air may be at a temperature less than the freezing point of the water. When inlet air at a temperature below the freezing point of water contacts liquid water at a temperature at or above the freezing point of water, heat may be transferred from the water to the air. The heat transfer may include sensible heat transfer as the water cools, and may include latent heat transfer as at least a portion of the water freezes. The release of latent heat during freezing may warm the air, which may reduce the density of the air and may induce upward air movement due to buoyancy forces.

In some embodiments, the temperature difference between liquid water and cold ambient air may enable thermodynamic energy conversion. The Carnot efficiency may represent the theoretical maximum efficiency of a heat engine operating between a hot reservoir and a cold reservoir. The Carnot efficiency may be calculated as the temperature difference between the hot reservoir and the cold reservoir divided by the absolute temperature of the hot reservoir. In cold climates where liquid water may be at temperatures near the freezing point and ambient air may be at temperatures substantially below freezing, the temperature difference may provide a thermodynamic driving force for energy conversion.

In some embodiments, the temperature difference between liquid water at approximately 0 degrees Celsius (approximately 273 Kelvin) and cold ambient air may range from approximately 10 degrees Kelvin to approximately 60 degrees Kelvin or more. For a temperature difference of 20 degrees Kelvin between liquid water at 273 Kelvin and air at 253 Kelvin, the Carnot efficiency may be approximately 7.3 percent. For a temperature difference of 30 degrees Kelvin between liquid water at 273 Kelvin and air at 243 Kelvin, the Carnot efficiency may be approximately 11 percent. For a temperature difference of 40 degrees Kelvin between liquid water at 273 Kelvin and air at 233 Kelvin, the Carnot efficiency may be approximately 14.7 percent. For a temperature difference of 50 degrees Kelvin between liquid water at 273 Kelvin and air at 223 Kelvin, the Carnot efficiency may be approximately 18.3 percent. Such Carnot efficiencies may represent the theoretical maximum efficiency of energy conversion from the temperature difference between liquid water and cold air.

In some embodiments, the percentage of water that freezes during heat transfer from fluid to air may vary depending on operating conditions, system design, or other factors. The percentage of water that freezes during heat transfer may range from approximately 0 percent to approximately 100 percent. In some embodiments, greater than 0.01 percent of the liquid may phase change from a liquid to a solid during transferring heat from fluid to air. In some embodiments, greater than 0.1 percent of the liquid may phase change from a liquid to a solid during transferring heat from fluid to air. In some embodiments, greater than 0.5 percent of the liquid may phase change from a liquid to a solid during transferring heat from fluid to air. In some embodiments, greater than 1 percent of the liquid may phase change from a liquid to a solid during transferring heat from fluid to air. In some embodiments, greater than 5 percent of the liquid may phase change from a liquid to a solid during transferring heat from fluid to air. In some embodiments, greater than 10 percent of the liquid may phase change from a liquid to a solid during transferring heat from fluid to air. In some embodiments, greater than 15 percent of the liquid may phase change from a liquid to a solid during transferring heat from fluid to air. In some embodiments, greater than 20 percent of the liquid may phase change from a liquid to a solid during transferring heat from fluid to air. In some embodiments, greater than 25 percent of the liquid may phase change from a liquid to a solid during transferring heat from fluid to air. In some embodiments, greater than 30 percent of the liquid may phase change from a liquid to a solid during transferring heat from fluid to air. In some embodiments, greater than 35 percent of the liquid may phase change from a liquid to a solid during transferring heat from fluid to air. In some embodiments, greater than 50 percent of the liquid may phase change from a liquid to a solid during transferring heat from fluid to air. In some embodiments, greater than 75 percent of the liquid may phase change from a liquid to a solid during transferring heat from fluid to air. In some embodiments, greater than 90 percent of the liquid may phase change from a liquid to a solid during transferring heat from fluid to air.

In some embodiments, the combination of high energy density from the enthalpy of fusion of water, large temperature differences between liquid water and cold air in sub-Arctic and Arctic regions, close proximity between liquid water and cold air due to limited ice thickness, and abundance of liquid water in bodies of water in cold climates may provide opportunities for renewable energy generation. Such energy generation may harness the natural temperature difference between liquid water and cold air, may utilize the latent heat released during freezing of water, and may provide power generation without combustion of fossil fuels.

In some embodiments, a process may further comprise harnessing the airflow. Harnessing the airflow may comprise capturing, utilizing, converting, directing, or otherwise employing the airflow generated through heat transfer from a fluid to air for various purposes. The airflow generated through buoyancy-driven convection may represent a form of kinetic energy that may be converted to other forms of energy, may be employed to drive processes, or may be utilized for various applications.

In some embodiments, harnessing the airflow may comprise converting kinetic energy from the airflow into electrical power. The kinetic energy of moving air may be converted to electrical power through the use of air turbines, wind turbines, or other power generation devices. Air turbines may be positioned within an air conduit, at an inlet of an air conduit, at an outlet of an air conduit, or at other locations where airflow may be present. The rotation of turbine blades induced by the airflow may drive a generator, which may convert mechanical energy to electrical energy. The electrical power generated may be transmitted to an electrical grid, may be stored in energy storage systems, may be used to power on-site equipment, or may be employed for other purposes.

In some embodiments, harnessing the airflow may comprise converting kinetic energy from the airflow into mechanical power. Mechanical power may be derived from the airflow through the use of turbines, fans, rotors, or other mechanical devices that may be driven by the moving air. The mechanical power may be employed to drive pumps, compressors, conveyors, or other mechanical equipment. The mechanical power may be transmitted through shafts, gears, belts, chains, or other power transmission mechanisms.

In some embodiments, harnessing the airflow may comprise producing controlled airflow for various applications. Controlled airflow may be employed for ventilation, cooling, heating, drying, or other purposes. The airflow generated through buoyancy-driven convection may be directed through ducts, channels, conduits, or other flow paths to deliver air to desired locations. The controlled airflow may be employed in industrial processes, building ventilation systems, agricultural applications, or other contexts where directed air movement may be beneficial.

In some embodiments, harnessing the airflow may comprise storing energy. Energy storage may be achieved through various mechanisms including one or more or any combination of the following: pumped hydro storage, or compressed air energy storage, or thermal energy storage, or battery storage, or flywheel storage, or gravitational energy storage, or any combination thereof. Electrical power generated from the airflow may be stored in batteries, capacitors, or other electrical energy storage devices. Mechanical energy from the airflow may be stored in flywheels, compressed air systems, or other mechanical energy storage systems. Thermal energy associated with the heat transfer process may be stored in thermal storage media including ice, water, phase change materials, or other thermal storage materials.

In some embodiments, harnessing the airflow may comprise producing salts. When seawater, brine, or other saline solutions are employed as the fluid in heat transfer processes, the cooling and freezing of the saline solution may result in the precipitation or crystallization of salts. Salts that may be produced may include one or more or any combination of the following: sodium chloride, or magnesium chloride, or calcium chloride, or potassium chloride, or sodium sulfate, or magnesium sulfate, or calcium sulfate, or other mineral salts, or any combination thereof. The produced salts may be collected, processed, and employed for various purposes including road de-icing, chemical feedstocks, food processing, water treatment, or other applications.

In some embodiments, harnessing the airflow may comprise producing brine. When seawater or other saline solutions are employed as the fluid in heat transfer processes, the freezing of a portion of the water may result in the concentration of dissolved salts in the remaining liquid, producing a brine with a higher salt concentration than the original solution. The produced brine may be employed for various purposes including one or more or any combination of the following: de-icing applications, or chemical processing, or mineral extraction, or desalination processes, or any combination thereof.

In some embodiments, harnessing the airflow may comprise producing freshwater. When seawater, brackish water, or other saline solutions are employed as the fluid in heat transfer processes, the freezing of a portion of the water may produce ice that may have a lower salt content than the original solution. The ice produced through freeze desalination may be separated from the remaining brine, and the ice may be melted to produce freshwater or desalinated water. The freshwater produced may be employed for drinking water, irrigation, industrial processes, or other purposes.

In some embodiments, harnessing the airflow may comprise producing ice. The heat transfer from liquid water to cold air may result in the freezing of at least a portion of the water, producing ice. The ice produced may be employed for various purposes including one or more or any combination of the following: thermal storage, or water storage, or building materials, or ice roads, or sea ice enhancement, or freshwater storage, or cooling applications, or any combination thereof. The ice may be collected, stored, transported, or otherwise processed for the intended application.

In some embodiments, harnessing the airflow may comprise enhancing albedo. Albedo may refer to the reflectivity of a surface, and surfaces with higher albedo may reflect more solar radiation than surfaces with lower albedo. Ice and snow may have higher albedo than liquid water, land surfaces, or other materials. The production of ice through heat transfer processes may increase the albedo of surfaces where the ice is deposited, which may reduce solar heat absorption and may contribute to cooling effects. Enhanced albedo may be beneficial for climate management, reducing heat island effects, or other purposes.

In some embodiments, harnessing the airflow may comprise extracting minerals. When seawater, geothermal brines, mining water, or other mineral-laden solutions are employed as the fluid in heat transfer processes, the cooling, freezing, or concentration of the solution may result in the precipitation or crystallization of minerals. Minerals that may be extracted may include one or more or any combination of the following: lithium, or magnesium, or potassium, or calcium, or sodium, or rare earth elements, or other dissolved minerals, or any combination thereof. The extracted minerals may be collected, processed, and employed for various industrial applications.

In some embodiments, harnessing the airflow may comprise strengthening infrastructure. Ice produced through heat transfer processes may be employed to strengthen or reinforce infrastructure in cold climates. Ice may be employed to thicken or reinforce ice roads, which may extend the operational season of ice roads or may increase the load-bearing capacity of ice roads. Ice may be employed to reinforce foundations, structures, or other infrastructure elements in permafrost regions or other cold climate environments.

In some embodiments, harnessing the airflow may comprise increasing ice in cold climates. Ice produced through heat transfer processes may be deposited in bodies of water, on land surfaces, or in other locations to increase the total ice mass in cold climate regions. Increasing ice in cold climates may contribute to sea ice enhancement, glacier augmentation, snowpack enhancement, or other ice-related objectives. The increased ice may provide benefits including one or more or any combination of the following: enhanced albedo, or habitat preservation, or freshwater storage, or climate management, or any combination thereof.

In some embodiments, harnessing the airflow may comprise thickening or enhancing sea ice. Ice produced through heat transfer processes may be added to existing sea ice or may be deposited in areas where sea ice formation is desired. The addition of ice to sea ice may increase the thickness of the sea ice, may extend the duration of sea ice coverage, or may enhance the stability of sea ice. Enhanced sea ice may provide benefits for marine ecosystems, may increase albedo, or may provide other environmental benefits.

In some embodiments, harnessing the airflow may comprise freeze desalination. Freeze desalination may involve the freezing of saline water to produce ice with reduced salt content, followed by separation of the ice from the remaining brine, and melting of the ice to produce freshwater. The airflow generated through heat transfer from saline water to cold air may facilitate the freezing process, and the kinetic energy of the airflow may be harnessed to power separation equipment, pumps, or other components of the freeze desalination system.

In some embodiments, harnessing the airflow may comprise absorbing carbon dioxide from the air. The airflow generated through heat transfer processes may be directed through carbon dioxide absorber units, direct air capture contactors, or other carbon dioxide capture systems. The airflow may provide the air movement for contacting air with carbon dioxide absorbents or adsorbents, which may reduce or eliminate the energy consumption associated with fans or blowers in conventional direct air capture systems. The carbon dioxide captured from the air may be sequestered, utilized in industrial processes, or otherwise managed.

In some embodiments, harnessing the airflow may comprise powering carbon dioxide desorption. Electrical power generated from the airflow may be employed to power the regeneration of carbon dioxide absorbents or adsorbents. The regeneration process may involve heating, pressure reduction, electrochemical processes, or other mechanisms to release captured carbon dioxide from the absorbent or adsorbent material. The use of power generated from the airflow to power carbon dioxide desorption may reduce the carbon footprint of direct air capture processes.

In some embodiments, harnessing the airflow may comprise thermal storage. The ice produced through heat transfer processes may be stored as a form of thermal energy storage. The stored ice may represent a reservoir of cooling capacity that may be released when the ice melts. Thermal storage using ice may be employed for seasonal energy storage, peak load management, or other thermal management applications. The thermal storage capacity of ice may be related to the enthalpy of fusion of water, which may be approximately 333.55 kilojoules per kilogram.

In some embodiments, harnessing the airflow may comprise water storage. Ice produced through heat transfer processes may be stored as a form of water storage. The stored ice may represent a reservoir of freshwater that may be released when the ice melts. Water storage using ice may be employed for seasonal water storage, drought management, agricultural water supply, or other water management applications. The ice may be stored in natural or artificial containment structures, may be deposited on land surfaces, or may be stored in other configurations.

In some embodiments, harnessing the airflow may comprise wildfire prevention or suppression. Ice produced through heat transfer processes may be distributed or strategically placed on land to prevent wildfires, inhibit wildfires, or suppress wildfires. The ice may provide moisture to vegetation, may reduce fuel dryness, or may create firebreaks. The strategic placement of ice in fire-prone regions may reduce the risk of wildfire ignition or may slow the spread of wildfires.

In some embodiments, harnessing the airflow may comprise multiple simultaneous applications. A single system may harness the airflow for power generation while also producing ice for thermal storage, producing freshwater through freeze desalination, capturing carbon dioxide from the air, or achieving other objectives. The combination of multiple applications may enhance the overall value and efficiency of the system.

In some embodiments, heat transfer may occur from a first medium to a second medium, wherein the first medium may comprise a fluid and the second medium may comprise a gas. The first medium may comprise a liquid, or a solid, or a solid-liquid mixture, or a phase change fluid, or any combination thereof. The second medium may comprise air, or another gas, or a gas mixture, or any combination thereof. Heat transfer from the first medium to the second medium may result in a change in the temperature of the second medium, which may result in a change in the density of the second medium.

In some embodiments, when heat is transferred from a first medium at a higher temperature to a second medium at a lower temperature, the second medium may be warmed. The warming of the second medium may cause the density of the second medium to decrease. Gases may exhibit an inverse relationship between temperature and density at constant pressure, such that an increase in temperature may result in a decrease in density. The density decrease of the second medium after heat exchange may be proportional to the temperature increase of the second medium, and may be related to the ideal gas law or other equations of state for gases.

In some embodiments, the density decrease of the second medium may result in buoyancy relative to adjacent portions of the second medium that may have higher density. Buoyancy may arise from density differences between adjacent portions of a fluid, wherein lower density portions may experience an upward force relative to higher density portions. The buoyancy force may be related to the density difference between the warmed second medium and the surrounding cooler second medium, the volume of the warmed second medium, and the gravitational acceleration. The buoyancy force may cause the warmed second medium to rise relative to the cooler surrounding second medium.

In some embodiments, the buoyancy of the warmed second medium relative to the cooler surrounding second medium may induce movement of the second medium. The movement may be in an upward direction due to the lower density of the warmed second medium compared to the higher density of the cooler surrounding second medium. The upward movement of the warmed second medium may create a convective flow pattern, wherein warmed second medium rises and cooler second medium may flow in to replace the rising warmed second medium.

In some embodiments, systems may be configured to enable transformation of buoyancy into kinetic energy. The buoyancy-induced movement of the warmed second medium may represent potential energy that may be converted to kinetic energy as the warmed second medium moves. The kinetic energy of the moving second medium may be harnessed through various mechanisms including turbines, rotors, or other devices that may extract energy from the moving second medium.

In some embodiments, conduits with elevation differences may enable the transformation of buoyancy into kinetic energy. A conduit may comprise an enclosed or partially enclosed passage through which the second medium may flow. The conduit may have an inlet at a first elevation and an outlet at a second elevation, wherein the first elevation may be lower than the second elevation. The elevation difference between the inlet and the outlet may provide a vertical distance over which the buoyancy-induced flow may develop and accelerate.

In some embodiments, a process may comprise at least a portion of air moving from a first elevation to a second elevation through an air conduit, wherein the first elevation may be lower than the second elevation. The air may be warmed through heat transfer from a fluid, and the warmed air may have a lower density than cooler surrounding air. The density difference may create a buoyancy force that may cause the warmed air to rise through the air conduit from the first elevation to the second elevation. The rising air may develop kinetic energy as the air accelerates through the air conduit.

In some embodiments, the air conduit may comprise one or more air inlets and one or more air outlets, wherein at least a portion of the air inlets may be at a lower elevation than the air outlets. The air inlets may be positioned at or near the first elevation, and the air outlets may be positioned at or near the second elevation. Air may enter the air conduit through the one or more air inlets, may be warmed through heat transfer from a fluid, and may exit the air conduit through the one or more air outlets. The elevation difference between the air inlets and the air outlets may provide the vertical distance over which the buoyancy-induced flow may develop.

In some embodiments, the magnitude of the buoyancy force may be related to the density difference between the warmed air and the cooler surrounding air, and may be related to the height of the air conduit. A greater density difference may result in a greater buoyancy force, and a greater height of the air conduit may result in a greater total buoyancy-induced pressure difference between the inlet and the outlet. The buoyancy-induced pressure difference may drive airflow through the air conduit, and the airflow velocity may be related to the magnitude of the pressure difference.

In some embodiments, the kinetic energy of the airflow through the air conduit may be proportional to the square of the airflow velocity. The airflow velocity may be related to the buoyancy-induced pressure difference, which may be related to the density difference between the warmed air and the cooler surrounding air and the height of the air conduit. Systems with greater temperature differences between the fluid and the inlet air, or systems with taller air conduits, may develop greater airflow velocities and greater kinetic energy in the airflow.

In some embodiments, the transformation of buoyancy into kinetic energy may be enhanced through the design of the air conduit. The air conduit may be configured to minimize flow resistance, to provide smooth flow paths, to reduce turbulence losses, or to otherwise enhance the conversion of buoyancy-induced pressure difference into airflow kinetic energy. The cross-sectional area of the air conduit may be configured to achieve desired airflow velocities, and the shape of the air conduit may be configured to minimize pressure losses.

In some embodiments, the air conduit may comprise a substantially vertical orientation, wherein the air conduit may extend in a generally upward direction from the first elevation to the second elevation. The substantially vertical orientation may maximize the effective height of the air conduit for a given physical height, which may maximize the buoyancy-induced pressure difference. In some embodiments, the air conduit may comprise an inclined orientation, wherein the air conduit may extend at an angle relative to vertical from the first elevation to the second elevation. The inclined orientation may provide flexibility in the positioning of the air conduit relative to geographic features, structures, or other constraints.

In some embodiments, the air conduit may comprise multiple air inlets positioned at various locations around the base or lower portion of the air conduit. The multiple air inlets may allow air to enter the air conduit from multiple directions, which may increase the total airflow capacity of the system. The multiple air inlets may be positioned at approximately the same elevation, or may be positioned at different elevations within a range of elevations that may be lower than the elevation of the air outlets.

In some embodiments, the air conduit may comprise multiple air outlets positioned at various locations around the top or upper portion of the air conduit. The multiple air outlets may allow air to exit the air conduit in multiple directions, which may reduce flow resistance at the outlet and may enhance the total airflow capacity of the system. The multiple air outlets may be positioned at approximately the same elevation, or may be positioned at different elevations within a range of elevations that may be higher than the elevation of the air inlets.

In some embodiments, a system may comprise an airflow conduit having an air inlet at a first elevation and an air outlet at a second elevation, wherein the first elevation may be lower than the second elevation. The system may further comprise a thermal exchange zone configured to transfer heat from a fluid to air, generating an upward airflow within the airflow conduit. The upward airflow may be generated due to the buoyancy of the warmed air relative to the cooler surrounding air, and the upward airflow may represent kinetic energy that may be harnessed for various purposes.

In some embodiments, the elevation difference between the air inlet and the air outlet may range from approximately 1 meter to approximately 1000 meters or more. In some embodiments, the elevation difference may be greater than approximately 5 meters, or greater than approximately 10 meters, or greater than approximately 20 meters, or greater than approximately 50 meters, or greater than approximately 100 meters, or greater than approximately 200 meters, or greater than approximately 500 meters, or any combination thereof. Greater elevation differences may provide greater buoyancy-induced pressure differences, which may result in greater airflow velocities and greater kinetic energy in the airflow.

In some embodiments, the density change of the second medium after heat exchange may be sustained as long as heat continues to be transferred from the first medium to the second medium. Continuous heat transfer may maintain the temperature difference between the warmed second medium and the cooler surrounding second medium, which may maintain the density difference and the buoyancy-induced flow. The continuous operation of the heat transfer process may provide a sustained source of kinetic energy in the form of the moving second medium.

In some embodiments, the first medium may comprise water and the second medium may comprise air. Water may be employed as a heat transfer fluid due to the high specific heat capacity of water, the high enthalpy of fusion of water, the abundance of water in natural and anthropogenic systems, the non-toxic nature of water, or any combination thereof. Air may be employed as the second medium due to the ubiquity of air in atmospheric environments, the ability of air to undergo density changes in response to temperature changes, or any combination thereof. Heat transfer from water to air may occur through direct contact methods, indirect contact methods, or any combination thereof.

In some embodiments, direct contact heat transfer between water and air may involve physical contact between the water and the air without an intervening solid barrier. Direct contact heat transfer may be achieved through various methods including one or more or any combination of the following: spraying water into an air stream, or passing air over a pool of water, or passing air through water droplets, or creating a mist or aerosol of water in the air, or passing air through a water curtain, or passing air through a water film, or bubbling air through water, or any combination thereof. Direct contact heat transfer may provide high heat transfer rates due to the large surface area created when water is dispersed into droplets, films, or other configurations that maximize contact between the water and the air.

In some embodiments, water may be sprayed into an air stream to achieve direct contact heat transfer. Water sprayers, nozzles, atomizers, or other spray devices may be employed to disperse water into fine droplets that may be contacted with the air. The droplet size may range from approximately 10 micrometers to approximately 10 millimeters, or may be smaller than approximately 10 micrometers, or may be larger than approximately 10 millimeters. Smaller droplets may provide greater surface area per unit volume of water, which may enhance heat transfer rates. The spray pattern may be configured to distribute water droplets throughout the air stream, which may maximize contact between the water and the air.

In some embodiments, air may be passed over a pool of water to achieve direct contact heat transfer. The pool of water may be positioned within an air conduit, adjacent to an air conduit, or in another location where air may flow over the surface of the pool. Heat may be transferred from the water in the pool to the air flowing over the surface of the pool. The heat transfer rate may be related to the surface area of the pool, the temperature difference between the water and the air, the air velocity over the pool surface, or any combination thereof. Circulation of the water in the pool may enhance heat transfer by bringing warmer water to the surface where heat transfer to the air may occur.

In some embodiments, air may be passed through water droplets to achieve direct contact heat transfer. Water droplets may be suspended in the air stream, may fall through the air stream, or may be carried by the air stream. The contact between the air and the water droplets may allow heat to be transferred from the water to the air. The residence time of the water droplets in the air stream may affect the total heat transfer, and longer residence times may allow greater heat transfer per unit mass of water.

In some embodiments, a water curtain or water film may be employed to achieve direct contact heat transfer. A water curtain may comprise a sheet or curtain of water through which air may pass. A water film may comprise a thin layer of water flowing over a surface, and air may be passed over the water film. The water curtain or water film may provide a large surface area for heat transfer between the water and the air.

In some embodiments, indirect contact heat transfer between water and air may involve heat transfer through a solid barrier or heat exchanger surface. Indirect contact heat transfer may employ heat exchangers including one or more or any combination of the following: shell and tube heat exchangers, or plate heat exchangers, or finned tube heat exchangers, or air-cooled heat exchangers, or radiators, or coils, or extended surface heat exchangers, or compact heat exchangers, or any combination thereof. In indirect contact heat transfer, the water and the air may not come into direct physical contact, but heat may be transferred through the solid material of the heat exchanger from the water to the air.

In some embodiments, finned tube heat exchangers may be employed for indirect contact heat transfer between water and air. Finned tube heat exchangers may comprise tubes through which water may flow, with fins attached to the exterior of the tubes to increase the surface area for heat transfer to the air. Air may be passed over the finned tubes, and heat may be transferred from the water inside the tubes through the tube walls and fins to the air. The fins may increase the effective surface area for heat transfer, which may enhance the heat transfer rate.

In some embodiments, plate heat exchangers may be employed for indirect contact heat transfer between water and air. Plate heat exchangers may comprise a series of plates with channels for water flow and channels for air flow arranged in an alternating pattern. Heat may be transferred from the water through the plates to the air. Plate heat exchangers may provide high heat transfer rates in a compact configuration.

In some embodiments, sensible heat transfer may occur when heat is transferred from water to air without a phase change occurring in the water. Sensible heat transfer may occur when the water temperature remains above the freezing point of the water throughout the heat transfer process. The water may be cooled during sensible heat transfer, but the water may remain in the liquid phase. The amount of sensible heat transferred may be related to the specific heat capacity of water, the mass of water involved in the heat transfer, and the temperature change of the water.

In some embodiments, the specific heat capacity of water may be approximately 4.18 kilojoules per kilogram per degree Kelvin. The sensible heat transferred from water to air may be calculated as the product of the mass of water, the specific heat capacity of water, and the temperature change of the water. For example, cooling one kilogram of water by 10 degrees Kelvin may transfer approximately 41.8 kilojoules of sensible heat to the air.

In some embodiments, sensible heat transfer may be employed when the inlet air temperature is above the freezing point of the water, or when the water temperature is maintained above the freezing point through control of the heat transfer rate, water flow rate, or other operating parameters. Sensible heat transfer may be employed in applications where freezing of the water may be undesirable, or where the water may be recirculated without phase change.

In some embodiments, partial freezing of the water may occur during heat transfer from water to air. Partial freezing may occur when the inlet air temperature is below the freezing point of the water and the heat transfer rate is sufficient to cool at least a portion of the water to the freezing point and to remove the latent heat of fusion from at least a portion of the water. The percentage of water that freezes during heat transfer may range from greater than 0 percent to less than 100 percent.

In some embodiments, greater than 0 percent and less than or equal to 0.01 percent of the water may freeze during heat transfer from water to air. In some embodiments, greater than 0.01 percent and less than or equal to 0.1 percent of the water may freeze during heat transfer from water to air. In some embodiments, greater than 0.1 percent and less than or equal to 0.5 percent of the water may freeze during heat transfer from water to air. In some embodiments, greater than 0.5 percent and less than or equal to 1 percent of the water may freeze during heat transfer from water to air. In some embodiments, greater than 1 percent and less than or equal to 5 percent of the water may freeze during heat transfer from water to air. In some embodiments, greater than 5 percent and less than or equal to 10 percent of the water may freeze during heat transfer from water to air.

In some embodiments, greater than 10 percent and less than or equal to 15 percent of the water may freeze during heat transfer from water to air. In some embodiments, greater than 15 percent and less than or equal to 20 percent of the water may freeze during heat transfer from water to air. In some embodiments, greater than 20 percent and less than or equal to 25 percent of the water may freeze during heat transfer from water to air. In some embodiments, greater than 25 percent and less than or equal to 30 percent of the water may freeze during heat transfer from water to air. In some embodiments, greater than 30 percent and less than or equal to 35 percent of the water may freeze during heat transfer from water to air. In some embodiments, greater than 35 percent and less than or equal to 40 percent of the water may freeze during heat transfer from water to air.

In some embodiments, greater than 40 percent and less than or equal to 50 percent of the water may freeze during heat transfer from water to air. In some embodiments, greater than 50 percent and less than or equal to 60 percent of the water may freeze during heat transfer from water to air. In some embodiments, greater than 60 percent and less than or equal to 70 percent of the water may freeze during heat transfer from water to air. In some embodiments, greater than 70 percent and less than or equal to 75 percent of the water may freeze during heat transfer from water to air. In some embodiments, greater than 75 percent and less than or equal to 80 percent of the water may freeze during heat transfer from water to air. In some embodiments, greater than 80 percent and less than or equal to 90 percent of the water may freeze during heat transfer from water to air.

In some embodiments, greater than 90 percent and less than or equal to 95 percent of the water may freeze during heat transfer from water to air. In some embodiments, greater than 95 percent and less than or equal to 99 percent of the water may freeze during heat transfer from water to air. In some embodiments, greater than 99 percent and less than 100 percent of the water may freeze during heat transfer from water to air. In some embodiments, approximately 100 percent of the water may freeze during heat transfer from water to air.

In some embodiments, the percentage of water that freezes during heat transfer may be controlled through adjustment of operating parameters. Operating parameters that may affect the percentage of water that freezes may include one or more or any combination of the following: the inlet air temperature, or the water inlet temperature, or the water flow rate, or the air flow rate, or the contact time between the water and the air, or the contact area between the water and the air, or the heat transfer coefficient, or the water droplet size, or the spray pattern, or any combination thereof. Adjustment of such operating parameters may allow the percentage of water that freezes to be increased, decreased, or maintained at a desired level.

In some embodiments, latent heat transfer may occur when water freezes during heat transfer from water to air. The enthalpy of fusion of water, which may also be referred to as the latent heat of freezing or the latent heat of melting, may be approximately 333.55 kilojoules per kilogram. When water freezes, the enthalpy of fusion may be released as heat, which may be transferred to the surrounding air. The release of latent heat during freezing may warm the air, which may reduce the density of the air and may enhance the buoyancy-induced airflow.

In some embodiments, the total heat transferred from water to air may comprise sensible heat, latent heat, or any combination thereof. When water at a temperature above the freezing point contacts air at a temperature below the freezing point, sensible heat may first be transferred from the water to the air as the water cools toward the freezing point. Once the water reaches the freezing point, latent heat may be released as the water freezes. The combination of sensible heat transfer and latent heat transfer may provide a greater total heat transfer than sensible heat transfer alone.

In some embodiments, the ratio of latent heat to sensible heat in the total heat transfer may depend on the operating conditions. When a greater percentage of the water freezes, a greater proportion of the total heat transfer may be latent heat. When a smaller percentage of the water freezes, a greater proportion of the total heat transfer may be sensible heat. The enthalpy of fusion of water may be approximately 333.55 kilojoules per kilogram, while the sensible heat capacity of water may be approximately 4.18 kilojoules per kilogram per degree Kelvin. Freezing one kilogram of water may release approximately the same amount of heat as cooling approximately 80 kilograms of water by one degree Kelvin, or cooling one kilogram of water by approximately 80 degrees Kelvin.

In some embodiments, the latent heat released during freezing may provide a substantial contribution to the total heat transfer from water to air. The high enthalpy of fusion of water may make freezing-based heat transfer an efficient mechanism for transferring heat from water to air. The latent heat released during freezing may be transferred to the air at a constant temperature corresponding to the freezing point of the water, which may provide a stable heat source for warming the air.

In some embodiments, the freezing point of the water may depend on the composition of the water. Freshwater may have a freezing point of approximately 0 degrees Celsius at standard atmospheric pressure. Seawater may have a freezing point that may be lower than the freezing point of freshwater due to the presence of dissolved salts, and seawater may have a freezing point of approximately negative 1.8 degrees Celsius to approximately negative 2 degrees Celsius depending on salinity. Brine may have a freezing point that may be lower than the freezing point of seawater, and the freezing point of brine may depend on the concentration and composition of dissolved salts. The freezing point depression may be related to the molality of dissolved solutes in the water.

In some embodiments, the ice formed during freezing of water may have different characteristics depending on the freezing conditions. Ice formed from freshwater may be relatively pure and may have a density of approximately 917 kilograms per cubic meter. Ice formed from seawater or brine may contain some entrapped salt, and the salt content of the ice may depend on the freezing rate, the agitation of the water during freezing, or other factors. Slower freezing rates may produce ice with lower salt content, while faster freezing rates may produce ice with higher salt content.

In some embodiments, the ice formed during heat transfer from water to air may be in various forms. Ice forms may include one or more or any combination of the following: ice crystals, or ice flakes, or ice slurry, or ice particles, or ice chunks, or ice sheets, or frazil ice, or dendritic ice, or any combination thereof. The form of the ice may depend on the freezing conditions, the water composition, the agitation of the water during freezing, or other factors.

In some embodiments, the water may be at a temperature greater than the freezing point of the water prior to heat transfer. The water temperature prior to heat transfer may be greater than negative 10 degrees Celsius, or greater than negative 5 degrees Celsius, or greater than negative 2 degrees Celsius, or greater than 0 degrees Celsius, or greater than 2 degrees Celsius, or greater than 5 degrees Celsius, or greater than 7 degrees Celsius, or greater than 10 degrees Celsius, or greater than 15 degrees Celsius, or greater than 20 degrees Celsius, or any combination thereof. Water at temperatures above the freezing point may be in the liquid phase and may be available for heat transfer to air.

In some embodiments, the water may be obtained from various sources. Water sources may include one or more or any combination of the following: oceans, or seas, or lakes, or rivers, or estuaries, or bays, or ponds, or streams, or aquifers, or subterranean water sources, or tanks, or storage facilities, or containment ponds, or process water systems, or cooling water systems, or heating water systems, or wastewater systems, or produced water from oil and gas operations, or geothermal brines, or mining water, or desalination systems, or any combination thereof. The selection of water source may depend on the geographic location, the availability of water, the water quality, the intended application, or any combination thereof.

In some embodiments, the water may comprise freshwater, seawater, brackish water, brine, or any combination thereof. Freshwater may have a total dissolved solids content of less than approximately 1,000 milligrams per liter. Brackish water may have a total dissolved solids content of approximately 1,000 milligrams per liter to approximately 10,000 milligrams per liter. Seawater may have a total dissolved solids content of approximately 35,000 milligrams per liter. Brine may have a total dissolved solids content greater than approximately 35,000 milligrams per liter. The dissolved solids content of the water may affect the freezing point of the water, the properties of the ice formed during freezing, or other characteristics of the heat transfer process.

In some embodiments, the water may be recirculated through the heat transfer system. Water that has been cooled or partially frozen during heat transfer may be collected, and at least a portion of the water may be returned to the heat transfer zone for additional heat transfer. Recirculation may reduce the total water consumption of the system and may allow the water to be cooled or frozen in multiple passes through the heat transfer zone. Ice formed during heat transfer may be separated from the liquid water prior to recirculation, or the ice may be recirculated along with the liquid water as an ice-water slurry.

In some embodiments, the heat transfer from water to air may be enhanced through the use of additives. Additives may include one or more or any combination of the following: surfactants, or antifreeze compounds, or nucleating agents, or viscosity modifiers, or corrosion inhibitors, or biocides, or any combination thereof. Surfactants may reduce the surface tension of the water, which may enhance droplet formation and may increase the surface area for heat transfer. Nucleating agents may promote ice crystal formation, which may enhance the freezing process. The selection of additives may depend on the intended application, the water composition, environmental considerations, or other factors.

In some embodiments, air that contacts a fluid at a temperature higher than the temperature of the air may be warmed through heat transfer from the fluid to the air. The warming of the air may result in a temperature increase of the air, and the temperature increase may be related to the amount of heat transferred from the fluid to the air, the mass of air involved in the heat transfer, and the specific heat capacity of air. Air may have a specific heat capacity of approximately 1.005 kilojoules per kilogram per degree Kelvin at constant pressure. When heat is transferred from a fluid to air, the air temperature may increase, and the air at the increased temperature may be referred to as warmed air.

In some embodiments, the density of air may be inversely related to the temperature of the air at constant pressure. Air at a higher temperature may have a lower density than air at a lower temperature. The relationship between air density and air temperature may be described by the ideal gas law, which may state that the product of pressure and volume may be proportional to the product of the amount of gas and the absolute temperature. At constant pressure, an increase in air temperature may result in an increase in air volume, which may correspond to a decrease in air density. The density of air at standard atmospheric pressure may be approximately 1.225 kilograms per cubic meter at 15 degrees Celsius, and the density may decrease as the temperature increases.

In some embodiments, the density difference between warmed air and cooler surrounding air may create a buoyancy force. Buoyancy may arise from the difference in density between a parcel of fluid and the surrounding fluid. A parcel of air with lower density than the surrounding air may experience an upward buoyancy force, while a parcel of air with higher density than the surrounding air may experience a downward force. The magnitude of the buoyancy force may be related to the density difference between the air parcel and the surrounding air, the volume of the air parcel, and the gravitational acceleration.

In some embodiments, the buoyancy force acting on warmed air may cause the warmed air to rise relative to cooler surrounding air. The rising of warmed air due to buoyancy may be referred to as natural convection or free convection. Natural convection may occur when density differences caused by temperature differences induce fluid motion without the application of external mechanical forces such as fans or blowers. The rising of warmed air may create an upward airflow that may be sustained as long as the temperature difference between the warmed air and the surrounding air is maintained.

In some embodiments, the chimney effect, which may also be referred to as the stack effect or thermal buoyancy effect, may describe the movement of air through a vertical or inclined conduit due to density differences between air inside the conduit and air outside the conduit. The chimney effect may occur when air inside a conduit is warmer than air outside the conduit, resulting in lower density air inside the conduit compared to higher density air outside the conduit. The density difference may create a pressure difference that may drive airflow through the conduit, with air entering at a lower elevation and exiting at a higher elevation.

In some embodiments, the pressure difference driving the chimney effect may be related to the height of the conduit and the density difference between the air inside the conduit and the air outside the conduit. The pressure difference may be calculated as the product of the density difference, the gravitational acceleration, and the height of the conduit. A greater height of the conduit may result in a greater pressure difference, which may result in a greater airflow velocity through the conduit. A greater density difference between the air inside the conduit and the air outside the conduit may also result in a greater pressure difference and greater airflow velocity.

In some embodiments, the airflow velocity through a conduit due to the chimney effect may be related to the square root of the product of the height of the conduit, the gravitational acceleration, and the ratio of the temperature difference to the absolute temperature of the air. The airflow velocity may increase as the height of the conduit increases, as the temperature difference between the air inside the conduit and the air outside the conduit increases, or as both the height and the temperature difference increase. The airflow velocity may be affected by flow resistance within the conduit, including friction losses, entrance losses, exit losses, or losses due to obstructions or changes in cross-sectional area.

In some embodiments, the chimney effect may create a continuous airflow through a conduit when heat is continuously transferred to the air within the conduit. The continuous heat transfer may maintain the temperature difference between the air inside the conduit and the air outside the conduit, which may maintain the density difference and the pressure difference that drives the airflow. The continuous airflow may represent a sustained source of kinetic energy that may be harnessed for power generation or other purposes.

In some embodiments, the air conduit may comprise a tower. A tower may comprise a vertical or substantially vertical structure that may extend from a lower elevation to a higher elevation. The tower may provide an enclosed or partially enclosed passage through which air may flow from the lower elevation to the higher elevation. The tower may be configured to facilitate the chimney effect by providing a vertical distance over which the buoyancy-induced pressure difference may develop. Towers may be constructed from various materials and may have various cross-sectional shapes, heights, and configurations depending on the intended application.

In some embodiments, the air conduit may comprise a pipe. A pipe may comprise a tubular structure that may provide an enclosed passage for airflow. The pipe may be oriented vertically, inclined at an angle relative to vertical, or may have sections with different orientations. The pipe may extend from a lower elevation to a higher elevation, and the elevation difference may provide the vertical distance over which the chimney effect may develop. Pipes may be constructed from various materials including metals, plastics, composites, concrete, or other materials, and pipes may have various diameters and wall thicknesses depending on the intended application.

In some embodiments, the cross-sectional area of the air conduit may affect the airflow characteristics through the conduit. A larger cross-sectional area may allow a greater volumetric airflow rate at a given airflow velocity. A smaller cross-sectional area may result in a higher airflow velocity for a given volumetric airflow rate. The cross-sectional area may be selected based on the desired airflow rate, the desired airflow velocity, the available space, structural considerations, or other factors.

In some embodiments, the shape of the cross-section of the air conduit may be circular, rectangular, square, polygonal, elliptical, or may have other shapes. Circular cross-sections may provide lower flow resistance per unit cross-sectional area compared to other shapes. Rectangular or square cross-sections may be easier to construct in some applications and may facilitate the integration of components such as heat exchangers or turbines. The selection of cross-sectional shape may depend on construction considerations, flow characteristics, component integration, or other factors.

In some embodiments, the height of the air conduit may range from approximately 1 meter to approximately 1000 meters or more. In some embodiments, the height of the air conduit may be greater than approximately 5 meters, or greater than approximately 10 meters, or greater than approximately 20 meters, or greater than approximately 50 meters, or greater than approximately 100 meters, or greater than approximately 200 meters, or greater than approximately 500 meters. Greater heights may provide greater buoyancy-induced pressure differences, which may result in greater airflow velocities and greater kinetic energy in the airflow.

In some embodiments, the airflow velocity through the air conduit may range from approximately 0.1 meters per second to approximately 50 meters per second or more. The airflow velocity may depend on the height of the air conduit, the temperature difference between the air inside the conduit and the air outside the conduit, the flow resistance of the conduit, and other factors. Higher airflow velocities may provide greater kinetic energy per unit volume of air, which may enhance power generation from the airflow.

In some embodiments, the volumetric airflow rate through the air conduit may range from approximately 1 cubic meter per second to approximately 10,000 cubic meters per second or more. The volumetric airflow rate may depend on the cross-sectional area of the air conduit and the airflow velocity. Greater volumetric airflow rates may provide greater total kinetic energy in the airflow, which may enable greater power generation.

In some embodiments, the mass airflow rate through the air conduit may be calculated as the product of the volumetric airflow rate and the density of the air. The mass airflow rate may be relevant for calculating the total heat transfer rate from the fluid to the air, as the heat transfer rate may be related to the mass airflow rate, the specific heat capacity of air, and the temperature increase of the air.

In some embodiments, the kinetic energy of the airflow through the air conduit may be calculated as one-half times the mass airflow rate times the square of the airflow velocity. The kinetic energy of the airflow may represent the energy available for conversion to electrical or mechanical power through the use of turbines or other power generation devices. Greater airflow velocities may provide greater kinetic energy per unit mass of air, and greater mass airflow rates may provide greater total kinetic energy.

In some embodiments, the airflow through the air conduit may be characterized as laminar flow, turbulent flow, or transitional flow depending on the Reynolds number of the flow. The Reynolds number may be calculated as the product of the air density, the airflow velocity, and a characteristic length dimension divided by the dynamic viscosity of the air. Laminar flow may occur at lower Reynolds numbers and may be characterized by smooth, orderly flow patterns. Turbulent flow may occur at higher Reynolds numbers and may be characterized by chaotic, irregular flow patterns with eddies and vortices. Turbulent flow may provide enhanced mixing and heat transfer but may also result in greater flow resistance.

In some embodiments, the flow resistance of the air conduit may affect the airflow velocity and the power available for extraction from the airflow. Flow resistance may arise from friction between the air and the walls of the conduit, from entrance and exit losses, from changes in cross-sectional area, from obstructions within the conduit, or from other sources. Reducing flow resistance may increase the airflow velocity and may increase the power available for extraction. Flow resistance may be reduced through the use of smooth interior surfaces, gradual transitions in cross-sectional area, streamlined inlet and outlet configurations, or other design features.

In some embodiments, the continuous airflow through the air conduit may be maintained as long as heat continues to be transferred from the fluid to the air within the conduit. The continuous heat transfer may maintain the temperature difference between the air inside the conduit and the air outside the conduit, which may maintain the buoyancy-induced pressure difference that drives the airflow. The continuous airflow may provide a sustained source of kinetic energy for power generation or other applications.

In some embodiments, the airflow through the air conduit may vary over time in response to changes in operating conditions. Changes in the temperature of the fluid, changes in the temperature of the inlet air, changes in the flow rate of the fluid, changes in the flow rate of the air, or other changes may affect the airflow velocity and the airflow rate through the conduit. Control systems may be employed to adjust operating parameters to maintain desired airflow characteristics or to optimize power generation or other objectives.

In some embodiments, the air conduit may be configured to minimize heat loss from the air within the conduit to the surroundings. Heat loss from the air within the conduit may reduce the temperature of the air, which may reduce the density difference between the air inside the conduit and the air outside the conduit, and may reduce the buoyancy-induced pressure difference and airflow velocity. Insulation may be applied to the exterior of the air conduit to reduce heat loss. The air conduit may be constructed from materials with low thermal conductivity to reduce heat transfer through the walls of the conduit.

In some embodiments, the air conduit may be configured to take advantage of ambient wind conditions. Wind blowing across the outlet of the air conduit may create a low-pressure region that may enhance the airflow through the conduit. Wind blowing into the inlet of the air conduit may provide additional driving force for airflow through the conduit. The interaction between the chimney effect and ambient wind conditions may be managed through the use of flow control elements, inlet and outlet configurations, or other design features.

In some embodiments, an air conduit may comprise a self-supporting structure. A self-supporting structure may be configured to support the weight of the structure and any applied loads without external support from cables, guy wires, adjacent structures, or geographic features. Self-supporting structures may include one or more or any combination of the following: freestanding towers, or monopole structures, or lattice towers, or truss structures, or cantilevered structures, or any combination thereof. Self-supporting structures may be constructed from materials with sufficient strength and stiffness to resist gravitational loads, wind loads, seismic loads, thermal loads, or other applied loads without external support. The foundation of a self-supporting structure may be configured to transfer loads from the structure to the ground, and the foundation may comprise spread footings, mat foundations, pile foundations, drilled shafts, or other foundation types depending on soil conditions and structural requirements.

In some embodiments, an air conduit may comprise a guyed structure. A guyed structure may be configured to be supported at least in part by guy wires, cables, or other tensioned elements that may extend from the structure to anchor points on the ground or on adjacent structures. Guyed structures may be lighter in weight than self-supporting structures of comparable height because the guy wires may provide lateral stability that may otherwise require heavier structural members. Guy wires may be attached to the air conduit at one or more elevations along the height of the structure, and the guy wires may extend outward and downward to anchor points that may be positioned at various distances from the base of the structure. The anchor points may comprise ground anchors, deadman anchors, rock anchors, or other anchor types depending on soil and rock conditions. Guyed structures may be suitable for applications where the footprint of the guy wire anchor points may be accommodated and where the reduced structural weight may provide cost or construction advantages.

In some embodiments, an air conduit may be at least partially supported by a geographic feature. Geographic features that may provide support for an air conduit may include one or more or any combination of the following: hills, or mountains, or cliffs, or ridges, or valleys, or canyons, or escarpments, or bluffs, or mesas, or plateaus, or glaciers, or any combination thereof. The geographic feature may provide structural support by bearing a portion of the weight of the air conduit, by providing lateral stability, by serving as an anchor point for guy wires or other support elements, or by any combination thereof. An air conduit that is at least partially supported by a geographic feature may require less structural material than a freestanding structure of comparable height because the geographic feature may carry a portion of the structural loads.

In some embodiments, an air conduit may be built on a hillside, or a cliffside, or a mountainside. Building an air conduit on a hillside, cliffside, or mountainside may allow the air conduit to extend from a lower elevation at or near the base of the slope to a higher elevation at or near the top of the slope. The slope of the terrain may provide a natural elevation difference that may be utilized for the chimney effect. The air conduit may be positioned on the surface of the slope, may be partially embedded in the slope, or may be attached to the slope through anchors, foundations, or other connection elements. The orientation of the air conduit may follow the slope of the terrain, may be vertical, or may be at an intermediate angle between the slope angle and vertical.

In some embodiments, an air conduit may be at least partially built within a hillside, or a cliffside, or a mountainside. Building an air conduit at least partially within a hillside, cliffside, or mountainside may involve excavation of material from the geographic feature to create a cavity or passage through which air may flow. The excavated cavity may serve as the air conduit, with the surrounding rock, soil, or other material of the geographic feature providing structural support for the air conduit. The interior surfaces of the excavated cavity may be lined with concrete, metal, plastic, ice, ice composite, or other materials to provide a smooth flow surface, to prevent erosion, to provide structural reinforcement, or for other purposes. In some embodiments, an air conduit that is at least partially built within a hillside, cliffside, or mountainside may comprise a tunnel. The tunnel may extend from an inlet at a lower elevation to an outlet at a higher elevation, and the tunnel may provide an enclosed passage for airflow through the geographic feature.

In some embodiments, an air conduit may be partially excavated into a hillside or a mountain to create an internal cavity that may serve as an updraft chamber. The internal cavity may be formed through excavation methods including one or more or any combination of the following: drilling and blasting, or tunnel boring, or cut and cover construction, or mechanical excavation, or any combination thereof. The internal cavity may have a cross-sectional area and shape configured to accommodate the desired airflow rate and to facilitate the installation of heat exchange equipment, turbines, or other components. In some embodiments, ice or ice composite walls may be formed on interior surfaces of the internal cavity. The ice or ice composite walls may be formed by spraying water onto the interior surfaces in cold conditions, by circulating cold fluids through pipes embedded in the walls, or by other methods. The ice or ice composite walls may provide thermal insulation, may provide a smooth flow surface, or may provide structural reinforcement. In some embodiments, ventilation shafts may be provided for maintenance access to the internal cavity. The ventilation shafts may extend from the internal cavity to the exterior of the hillside or mountain, and the ventilation shafts may provide access for personnel, equipment, or materials for maintenance, inspection, or repair activities.

In some embodiments, curved or spiral tower designs may be selected based on the geometry of the geographic feature, the structural properties of the rock or earth, the desired airflow characteristics, and other design considerations. Curved designs may be suitable for geographic features with relatively uniform slopes, where the tower or air conduit may follow a smooth curve from the base to the top. Spiral designs may be suitable for geographic features with conical or cylindrical shapes, where the tower or air conduit may wrap around the feature in a helical path. In some embodiments, the curvature or spiral of the tower or air conduit may be optimized using computational modeling to minimize structural stresses, to maximize airflow efficiency, or to achieve other design objectives.

In some embodiments, protective barriers may be provided to safeguard equipment when constructing on slopes prone to rockslides or glacial calving. Protective barriers may be structures positioned upslope of equipment, air conduits, or other system components to intercept falling rocks, ice, debris, or other materials that may be dislodged from the slope. Protective barriers may comprise walls, berms, fences, nets, or other structures designed to absorb or deflect the energy of falling materials. In some embodiments, protective barriers may be constructed from concrete, steel, reinforced earth, gabions, or other materials capable of withstanding impact loads from falling materials.

In some embodiments, controlled avalanche paths may be created to safeguard equipment when constructing on slopes prone to rockslides or glacial calving. Controlled avalanche paths may be designated routes along which falling rocks, ice, snow, or debris may travel without impacting equipment or system components. The controlled avalanche paths may be created by positioning equipment and system components away from natural fall lines, by constructing diversion structures that redirect falling materials away from equipment, or by excavating channels or chutes that guide falling materials along predetermined paths. In some embodiments, controlled avalanche paths may be designed based on analysis of slope geometry, material properties, and historical patterns of rockslides, avalanches, or glacial calving events.

In some embodiments, real-time movement sensors may be employed to monitor slope stability and ice conditions. Real-time movement sensors may detect displacement, strain, tilt, vibration, or other indicators of movement in slopes, rock masses, glaciers, or ice formations. The real-time movement sensors may comprise inclinometers, extensometers, crack meters, accelerometers, GPS receivers, or other sensing devices capable of detecting movement. In some embodiments, the real-time movement sensors may be installed at locations on or within slopes, rock faces, glaciers, or ice formations where movement may occur, and the sensors may transmit data continuously or at regular intervals to monitoring systems.

In some embodiments, real-time movement sensors may trigger warnings if significant slope movement or ice fracturing is detected. Warnings may be generated when sensor readings exceed predetermined thresholds indicative of slope instability, rock movement, ice fracturing, or other hazardous conditions. The warnings may be transmitted to operators, control systems, or emergency response personnel, and the warnings may include information about the location, magnitude, and nature of the detected movement. In some embodiments, the warnings may be visual alerts, audible alarms, text messages, emails, or other notification methods that communicate the hazard to relevant personnel.

In some embodiments, real-time movement sensors may trigger automated shutdown of the system if significant slope movement or ice fracturing is detected. Automated shutdown may involve stopping water flow to thermal exchange zones, stopping power generation equipment, closing airflow control elements, or taking other actions to place the system in a safe state. The automated shutdown may be initiated by control systems that receive signals from the real-time movement sensors and execute shutdown sequences without requiring operator intervention. In some embodiments, automated shutdown may protect equipment from damage, may protect personnel from hazards, and may prevent the system from contributing to or exacerbating slope instability or ice fracturing.

In some embodiments, camouflage may be added to an ice composite to reduce glare or match surrounding rock formations for aesthetic integration. Camouflage may comprise pigments, dyes, coatings, or surface treatments that alter the color or appearance of the ice composite to blend with the surrounding environment. The camouflage may be applied to the exterior surfaces of an ice composite air conduit, and the camouflage may reduce the visual contrast between the air conduit and the surrounding rock, earth, snow, or ice. In some embodiments, camouflage may be desirable in locations where visual impact is a concern, such as in scenic areas, protected landscapes, or areas visible from populated locations.

In some embodiments, natural pigments may be added to an ice composite to reduce glare or match surrounding rock formations for aesthetic integration. Natural pigments may comprise earth pigments, mineral pigments, or organic pigments derived from natural sources. Natural pigments may include iron oxides, ochres, umbers, siennas, or other pigments that provide colors ranging from yellows and oranges to reds, browns, and blacks. In some embodiments, natural pigments may be mixed with water or with the water-reinforcement mixture used to form the ice composite, and the pigments may become distributed throughout the ice composite matrix. The pigmented ice composite may have a color that approximates the color of surrounding rock formations, reducing the visual prominence of the air conduit.

In some embodiments, the selection of camouflage or natural pigments may be based on the colors and textures of the surrounding environment. Rock formations may have colors ranging from light grays and tans to dark browns and blacks, depending on the mineral composition of the rock. Snow and ice may have colors ranging from white to blue-gray, depending on the density, age, and purity of the snow or ice. In some embodiments, the camouflage or natural pigments may be selected to match the predominant colors of the surrounding environment, and multiple colors or patterns may be used to simulate the natural variation in color and texture of the surrounding rock, earth, snow, or ice.

In some embodiments, camouflage or natural pigments may reduce glare from ice composite surfaces. Ice and snow surfaces may reflect sunlight and may produce glare that is visible from distant locations. The glare may increase the visual prominence of an ice composite air conduit and may be objectionable in scenic areas or may interfere with activities such as aviation or navigation. In some embodiments, camouflage or natural pigments may reduce the reflectivity of ice composite surfaces by absorbing a portion of incident light rather than reflecting the light. The reduced reflectivity may decrease glare and may make the ice composite air conduit less visually prominent.

In some embodiments, a process may comprise transferring a fluid from a fluid source at a third elevation to a thermal exchange zone at a first elevation, wherein the thermal exchange zone is at a higher elevation than the fluid source. The fluid source may be a body of water, a reservoir, a tank, or another source of fluid positioned at a third elevation that is lower than the first elevation where the thermal exchange zone is located. Transferring the fluid from the fluid source to the thermal exchange zone may involve pumping the fluid, lifting the fluid, or otherwise moving the fluid against gravity from the lower third elevation to the higher first elevation. In some embodiments, the energy required to transfer the fluid from the fluid source to the thermal exchange zone may be provided by pumps, which may be powered by electricity generated by the system, by electricity from external sources, or by other energy sources.

In some embodiments, the thermal exchange zone may be positioned at an elevated location relative to the fluid source to take advantage of geographic features, to facilitate gravity-driven flow of material after heat transfer, or to achieve other operational objectives. The elevation difference between the fluid source at the third elevation and the thermal exchange zone at the first elevation may range from a few meters to hundreds of meters or more, depending on the geographic features of the installation site and the design of the system. In some embodiments, the thermal exchange zone may be positioned on a hillside, a cliffside, a mountainside, or another elevated geographic feature, while the fluid source may be a lake, a river, an ocean, or another body of water at a lower elevation.

In some embodiments, a process may comprise transferring at least a portion of the material comprising the fluid after a thermal exchange zone to a deposit location at a lower elevation than the thermal exchange zone. The material comprising the fluid after the thermal exchange zone may include the fluid in a modified state resulting from heat transfer operations, and the material may be transferred from the thermal exchange zone at the first elevation to a deposit location at a lower elevation. The deposit location may be the fluid source from which the fluid was originally obtained, a location near the fluid source, or another location at an elevation lower than the thermal exchange zone. In some embodiments, the transfer of material from the thermal exchange zone to the deposit location may occur by gravity-driven flow, by mechanical conveyance, or by a combination of gravity-driven and mechanically assisted transfer.

In some embodiments, at least a portion of the material comprising the fluid after the thermal exchange zone may be transferred to the fluid source or a location near the fluid source, wherein the location comprising the fluid source or the location near the fluid source comprises a deposit location and the deposit location is at an elevation lower than the elevation of the thermal exchange zone. Returning the material to the fluid source or a location near the fluid source may complete a cycle where fluid is withdrawn from the fluid source, processed through the thermal exchange zone, and returned to the fluid source in a modified form. In some embodiments, returning the material to the fluid source may maintain the water balance of the fluid source, may return ice to a body of water to enhance ice coverage, or may return brine to a body of water for dilution and dispersal.

In some embodiments, a process may comprise harnessing at least a portion of the potential energy in the difference in elevation between the deposit location and the thermal exchange zone to generate power. The potential energy available for harnessing may be proportional to the mass of the material being transferred and the elevation difference between the thermal exchange zone and the deposit location. When material comprising the fluid after the thermal exchange zone is transferred from the higher elevation of the thermal exchange zone to the lower elevation of the deposit location, the potential energy of the material may be converted to kinetic energy as the material descends. In some embodiments, the kinetic energy of the descending material may be captured and converted to electrical or mechanical power using energy recovery devices positioned along the transfer path or at the deposit location.

In some embodiments, a process may comprise harnessing at least a portion of the potential energy in the difference in elevation between the thermal exchange zone and the deposit location to generate power. The potential energy may be calculated based on the mass of the material, the gravitational constant, and the elevation difference between the thermal exchange zone and the deposit location. For example, material with a mass of 1,000 kilograms descending through an elevation difference of 100 meters may have potential energy of approximately 981,000 joules available for conversion to other forms of energy. In some embodiments, a portion of the potential energy may be converted to electrical power, and the electrical power generated may offset a portion of the electrical power consumed to pump the fluid from the fluid source to the thermal exchange zone.

In some embodiments, an air conduit may be constructed on or within angled surfaces. Angled surfaces may include one or more or any combination of the following: mountainsides, or hillsides, or cliffsides, or glacier sides, or any combination thereof. The angled surfaces may have various slope angles, and the slope angle may affect the configuration of the air conduit, the structural support requirements, and the water flow management. In some embodiments, the angled terrain may have a slope angle ranging from approximately 5 degrees to approximately 15 degrees, which may be characterized as a gentle incline. Gentle inclines may allow the air conduit to be positioned on the surface of the terrain with relatively simple foundation and support requirements. In some embodiments, the angled terrain may have a slope angle ranging from approximately 15 degrees to approximately 30 degrees, which may be characterized as a moderate slope. Moderate slopes may require additional anchoring or foundation measures to secure the air conduit to the terrain. In some embodiments, the angled terrain may have a slope angle ranging from approximately 30 degrees to approximately 45 degrees, which may be characterized as a steep slope. Steep slopes may require more substantial structural support measures, and the air conduit may be partially embedded in the terrain or may be anchored to rock or other stable material. In some embodiments, the angled terrain may have a slope angle greater than approximately 60 degrees, which may be characterized as a near-vertical slope or a cliff face. Near-vertical slopes or cliff faces may require the air conduit to be attached to the rock face through anchors, brackets, or other attachment elements, or the air conduit may be built within the rock face through excavation.

In some embodiments, the angled terrain may provide structural support for the air conduit. The weight of the air conduit may be transferred to the terrain through foundations, anchors, or other load transfer elements. The terrain may resist lateral loads on the air conduit, such as wind loads, through the reaction of the terrain against the air conduit or through anchors embedded in the terrain. The use of angled terrain for structural support may reduce the amount of structural material required for the air conduit compared to a freestanding structure.

In some embodiments, the angled terrain may facilitate water flow management. Water used in heat transfer processes may flow downward along the angled terrain under the influence of gravity. The slope of the terrain may provide a natural drainage path for water, ice, or ice-water mixtures produced during heat transfer. Collection systems may be positioned at lower elevations on the terrain to collect water, ice, or other materials for recirculation, storage, or disposal.

In some embodiments, an air conduit may comprise a tube at an angle or slope. The angle or slope of the tube may be measured relative to horizontal, such that a vertical tube may have an angle of 90 degrees relative to horizontal, and a horizontal tube may have an angle of 0 degrees relative to horizontal. In some embodiments, the air conduit may comprise a tube at an angle or slope substantially comprising less than or equal to 90 degrees. In some embodiments, the air conduit may comprise a tube at an angle or slope substantially comprising less than or equal to 80 degrees. In some embodiments, the air conduit may comprise a tube at an angle or slope substantially comprising less than or equal to 70 degrees. In some embodiments, the air conduit may comprise a tube at an angle or slope substantially comprising less than or equal to 60 degrees. In some embodiments, the air conduit may comprise a tube at an angle or slope substantially comprising less than or equal to 50 degrees. In some embodiments, the air conduit may comprise a tube at an angle or slope substantially comprising less than or equal to 45 degrees. In some embodiments, the air conduit may comprise a tube at an angle or slope substantially comprising less than or equal to 30 degrees. In some embodiments, the air conduit may comprise a tube at an angle or slope substantially comprising less than or equal to 15 degrees. In some embodiments, the air conduit may comprise a tube at an angle or slope substantially comprising less than or equal to 10 degrees.

In some embodiments, the angle or slope of the air conduit may be selected based on the terrain, the desired elevation difference between the inlet and the outlet, structural considerations, or other factors. A more vertical orientation may provide a greater elevation difference for a given length of air conduit, which may result in a greater buoyancy-induced pressure difference. A less vertical orientation may allow the air conduit to follow the contour of sloped terrain, which may reduce construction costs or may allow the air conduit to be supported by the terrain. The angle or slope of the air conduit may be constant along the length of the air conduit, or the angle or slope may vary along the length of the air conduit.

In some embodiments, an air conduit at an angle less than 90 degrees relative to horizontal may have a greater total length than a vertical air conduit with the same elevation difference between the inlet and the outlet. The greater total length may result in greater flow resistance due to friction between the air and the walls of the conduit. The greater flow resistance may reduce the airflow velocity compared to a vertical conduit with the same elevation difference. The selection of the angle or slope of the air conduit may involve balancing the benefits of terrain support and reduced construction costs against the potential reduction in airflow velocity due to increased flow resistance.

In some embodiments, the air conduit may comprise multiple sections with different angles or slopes. A first section of the air conduit may be at a first angle, and a second section of the air conduit may be at a second angle that may be different from the first angle. The transitions between sections with different angles may be configured to minimize flow resistance and to provide smooth flow paths for the air. The use of multiple sections with different angles may allow the air conduit to follow complex terrain contours while maintaining a continuous flow path from the inlet to the outlet.

In some embodiments, a process may comprise adjusting the airflow using an airflow control element. An airflow control element may comprise any component, device, structure, or assembly configured to permit, restrict, modulate, regulate, adjust, redirect, direct, obstruct, prevent, facilitate, or any combination thereof the flow of air through an air conduit, at an inlet of an air conduit, at an outlet of an air conduit, or at other locations within a system. Airflow control elements may be employed to manage airflow characteristics, to optimize power generation, to respond to changing conditions, to harness wind energy, to prevent undesired airflow patterns, or for other purposes.

In some embodiments, an airflow control element may comprise fins. Fins may comprise planar or curved surfaces that may extend into the airflow path and may be configured to direct, deflect, or otherwise influence the direction or velocity of airflow. Fins may be fixed in position, or fins may be adjustable to allow the angle or orientation of the fins to be changed. Fins may be constructed from metals, plastics, composites, or other materials, and fins may have various shapes, sizes, and configurations depending on the intended application.

In some embodiments, an airflow control element may comprise panels. Panels may comprise flat or curved surfaces that may be positioned to block, redirect, or otherwise control airflow. Panels may be hinged, pivoting, sliding, or otherwise movable to allow the position or orientation of the panels to be adjusted. Panels may be solid or may have openings, perforations, or other features that may allow partial airflow through the panels. Panels may be constructed from rigid materials, semi-rigid materials, flexible materials, or any combination thereof.

In some embodiments, an airflow control element may comprise blades. Blades may comprise elongated members that may extend into the airflow path and may be configured to direct or deflect airflow. Blades may be arranged in arrays or banks, and the spacing between blades may affect the airflow characteristics. Blades may be fixed in position, or blades may be rotatable or pivotable to allow the angle of the blades to be adjusted. Blades may have airfoil cross-sections, flat cross-sections, curved cross-sections, or other cross-sectional shapes.

In some embodiments, an airflow control element may comprise airfoils. Airfoils may comprise members with cross-sectional shapes configured to produce aerodynamic effects when air flows over the airfoils. Airfoils may be employed to direct airflow, to reduce turbulence, to minimize pressure losses, or to achieve other aerodynamic objectives. Airfoils may be fixed in position, or airfoils may be adjustable to allow the angle of attack or orientation of the airfoils to be changed.

In some embodiments, an airflow control element may comprise mesh. Mesh may comprise a network of interconnected elements that may allow airflow to pass through while providing resistance to the airflow or while filtering particles from the airflow. Mesh may be constructed from wires, fibers, filaments, or other elements that may be woven, welded, bonded, or otherwise connected to form the network. The openness of the mesh, which may be characterized by the percentage of open area, may affect the airflow resistance and the filtering characteristics of the mesh. Mesh may be fixed in position, or mesh may be movable to allow the mesh to be positioned in or out of the airflow path.

In some embodiments, an airflow control element may comprise valves. Valves may comprise devices configured to control the flow of air by opening, closing, or partially obstructing a flow passage. Valves may include one or more or any combination of the following types: butterfly valves, or gate valves, or ball valves, or globe valves, or check valves, or plug valves, or diaphragm valves, or pinch valves, or any combination thereof. Valves may be operated manually, automatically, or through remote control, and valves may be configured to provide binary operation, staged operation, or continuously variable operation.

In some embodiments, an airflow control element may comprise doors. Doors may comprise movable barriers that may be opened or closed to allow or prevent airflow through an opening. Doors may be hinged, pivoting, sliding, rolling, or otherwise movable. Doors may be solid or may have openings, louvers, or other features that may allow partial airflow when the doors are in a closed position. Doors may be configured to seal against a frame or other structure when closed to prevent air leakage, or doors may be configured to allow some air leakage when closed.

In some embodiments, an airflow control element may comprise flexible materials. Flexible materials may comprise materials that may deform in response to airflow, pressure differences, or applied forces. Flexible materials may include one or more or any combination of the following: fabrics, or membranes, or films, or elastomers, or foils, or any combination thereof. Airflow control elements comprising flexible materials may be configured to open, close, or change shape in response to airflow conditions, which may provide passive control of airflow. Flexible materials may also be employed in actively controlled airflow control elements, where the flexible materials may be moved or deformed by actuators or other mechanisms.

In some embodiments, an airflow control element may comprise solid materials. Solid materials may comprise materials that may maintain a fixed shape under normal operating conditions. Solid materials may include one or more or any combination of the following: metals, or plastics, or composites, or ceramics, or concrete, or wood, or glass, or any combination thereof. Airflow control elements comprising solid materials may provide durable and stable control of airflow, and solid materials may be suitable for applications where the airflow control element may be exposed to high velocities, high temperatures, corrosive environments, or other demanding conditions.

In some embodiments, an airflow control element may comprise liquid. Liquid may be employed as an airflow control element by creating a liquid barrier, curtain, or film that may obstruct or redirect airflow. A liquid curtain may be created by allowing liquid to flow downward across an opening, and the liquid curtain may block or reduce airflow through the opening. The density and flow rate of the liquid may affect the degree to which the liquid curtain obstructs airflow. Liquid airflow control elements may provide the ability to rapidly establish or remove the airflow obstruction by starting or stopping the liquid flow.

In some embodiments, an airflow control element may comprise flaps. Flaps may comprise hinged or pivoting members that may be moved to open or close an airflow passage. Flaps may be configured to swing inward, outward, or in other directions depending on the hinge configuration and the intended operation. Flaps may be operated by actuators, by manual mechanisms, or by the pressure of the airflow itself. Flaps may be configured to provide binary operation, where the flaps are either fully open or fully closed, or flaps may be configured to provide continuously variable operation, where the flaps may be positioned at intermediate angles.

In some embodiments, an airflow control element may comprise rigid materials. Rigid materials may comprise materials that may resist deformation under applied loads. Rigid materials may provide structural stability and may maintain precise positioning of airflow control elements. Airflow control elements comprising rigid materials may be suitable for applications where precise control of airflow is desired, where the airflow control element may be subjected to high loads, or where dimensional stability is desired.

In some embodiments, an airflow control element may comprise semi-rigid materials. Semi-rigid materials may comprise materials that may exhibit some flexibility while also providing structural support. Semi-rigid materials may deform under applied loads but may return to an original shape when the loads are removed. Airflow control elements comprising semi-rigid materials may provide a combination of flexibility and structural stability, and semi-rigid materials may be suitable for applications where some deformation may be acceptable or desirable.

In some embodiments, an airflow control element may comprise shutters. Shutters may comprise assemblies of multiple movable members that may be opened or closed to control airflow through an opening. Shutters may include multiple slats, blades, or panels that may be connected by a common mechanism that may allow the multiple members to be opened or closed together. Shutters may be configured to provide binary operation, staged operation, or continuously variable operation. Shutters may be oriented horizontally, vertically, or at other angles depending on the configuration of the opening and the intended airflow control.

In some embodiments, an airflow control element may comprise dampers. Dampers may comprise devices configured to control airflow by partial, proportional, or complete obstruction or regulation of a flow passage. Dampers may be positioned within ducts, conduits, or other enclosed flow passages, or dampers may be positioned at inlets or outlets of such passages. Dampers may include one or more or any combination of the following types: single-blade dampers, or multi-blade dampers, or opposed-blade dampers, or parallel-blade dampers, or round dampers, or rectangular dampers, or any combination thereof. Dampers may be configured to provide binary operation, staged operation, or continuously variable operation.

In some embodiments, an airflow control element may comprise louvers. Louvers may comprise assemblies of multiple angled slats or blades that may allow airflow to pass through while providing protection from weather, debris, or direct sunlight. Louvers may be fixed in position, or louvers may be adjustable to allow the angle of the slats or blades to be changed. Adjustable louvers may be configured to increase or decrease the airflow through the louver assembly by changing the angle of the slats or blades. Louvers may be constructed from metals, plastics, or other materials, and louvers may be configured for exterior or interior applications.

In some embodiments, an airflow control element may comprise vanes. Vanes may comprise members positioned within an airflow path to direct or guide the airflow. Vanes may be fixed in position to provide consistent airflow direction, or vanes may be adjustable to allow the airflow direction to be changed. Vanes may be arranged in arrays or patterns to achieve desired airflow distributions. Vanes may have flat, curved, or airfoil cross-sections depending on the intended aerodynamic characteristics.

In some embodiments, an airflow control element may be passive. A passive airflow control element may operate without external power input and may respond to airflow conditions, pressure differences, or other environmental factors. Passive airflow control elements may include one or more or any combination of the following: check valves that may open or close in response to pressure differences, or flexible flaps that may deflect in response to airflow, or weighted dampers that may open or close in response to airflow velocity, or any combination thereof. Passive airflow control elements may provide automatic response to changing conditions without the need for sensors, controllers, or actuators.

In some embodiments, an airflow control element may be active. An active airflow control element may be operated by external power input and may be controlled by a control system, an operator, or other control mechanism. Active airflow control elements may include one or more or any combination of the following: motorized dampers, or pneumatically actuated valves, or hydraulically actuated shutters, or electrically actuated louvers, or any combination thereof. Active airflow control elements may provide precise control of airflow and may be configured to respond to control signals based on sensor inputs, operator commands, or programmed sequences.

In some embodiments, an airflow control element may be mechanically actuated. A mechanically actuated airflow control element may be operated by mechanical mechanisms including one or more or any combination of the following: linkages, or levers, or gears, or cams, or screws, or cables, or chains, or belts, or any combination thereof. Mechanical actuation may be powered by electric motors, pneumatic cylinders, hydraulic cylinders, manual operation, or other power sources. Mechanically actuated airflow control elements may provide reliable operation and may be suitable for applications where precise positioning of the airflow control element is desired.

In some embodiments, an airflow control element may be adjustable. An adjustable airflow control element may be configured to be moved, repositioned, or reconfigured to change the airflow characteristics. Adjustment of the airflow control element may include one or more or any combination of the following: changing the angle or orientation of the airflow control element, or changing the position of the airflow control element, or changing the degree of opening of the airflow control element, or changing the shape of the airflow control element, or any combination thereof. Adjustable airflow control elements may allow the airflow characteristics to be optimized for different operating conditions, different wind conditions, different power generation objectives, or other factors.

In some embodiments, a tower may include bypass or diversion channels, which may comprise air flow control elements. Bypass or diversion channels may direct excess airflow toward auxiliary turbines or storage areas when wind conditions or thermal gradients exceed the capacity of a single turbine stage. Bypass channels may allow the system to handle airflow volumes that exceed the capacity of the primary turbines without causing excessive backpressure or turbine overspeed. In some embodiments, auxiliary turbines positioned in bypass channels may capture additional power from excess airflow, increasing the total power output of the system.

In some embodiments, shutters or flow control elements may be arranged around a perimeter of a tower base. The arrangement of shutters or flow control elements around the perimeter may allow air to enter the tower from multiple directions, which may increase the total airflow capacity of the system and may allow the system to respond to wind from various directions. The shutters or flow control elements may be positioned at regular intervals around the perimeter, or the shutters or flow control elements may be positioned at irregular intervals depending on the configuration of the system and the surrounding environment.

In some embodiments, water-air contact zones may be positioned between the shutters and a central tower. The water-air contact zones may comprise regions where water may be contacted with air to transfer heat from the water to the air. The positioning of the water-air contact zones between the shutters and the central tower may allow air that passes through the shutters to contact the water-air contact zones before entering the central tower. The water-air contact zones may comprise pools, basins, spray zones, or other configurations where water and air may be brought into contact.

In some embodiments, air may pass through shutters and may contact multiple water-air zones before entering the tower. The configuration may allow air entering through a shutter on one side of the tower to flow through the water-air contact zone adjacent to that shutter and may also allow the air to flow through other water-air contact zones positioned around the tower before entering the central tower. The ability of air to contact multiple water-air zones may increase the total heat transfer from water to air, may increase the residence time of the air in contact with water, and may provide greater flexibility in the operation of the system.

In some embodiments, the configuration of shutters and water-air contact zones may enable wind harnessing while maintaining broad contact area. When wind is present, shutters on the windward side of the tower may be opened to allow wind to enter the system, and shutters on the leeward side of the tower may be closed to prevent air from exiting through the leeward shutters. The wind entering through the windward shutters may flow through the water-air contact zones and may exit through the top of the tower, which may enhance the airflow through the system and may increase power generation. The broad contact area provided by the multiple water-air contact zones may be maintained regardless of which shutters are open or closed, which may allow the system to harness wind energy while maintaining effective heat transfer from water to air.

In some embodiments, the water-air contact zones may be configured to allow air to flow freely between adjacent zones. The free flow of air between adjacent water-air contact zones may allow air entering through any shutter to contact water in multiple zones, which may maximize the heat transfer and may provide operational flexibility. The configuration may allow the system to operate effectively with various combinations of open and closed shutters, which may allow the system to respond to changing wind conditions while maintaining effective heat transfer.

In some embodiments, airflow control elements may be configured to withstand environmental loads. Environmental loads may include one or more or any combination of the following: wind loads, or thermal loads, or ice loads, or snow loads, or seismic loads, or any combination thereof. Airflow control elements may be constructed from materials and with configurations that may resist such environmental loads without damage or loss of function. Airflow control elements exposed to exterior conditions may be configured to resist corrosion, ultraviolet degradation, or other environmental effects.

In some embodiments, airflow control elements may be configured to operate in cold environments. Cold environment operation may involve temperatures below the freezing point of water, and airflow control elements may be configured to resist ice formation, to shed ice that may form, or to operate despite the presence of ice. Airflow control elements may be heated, may be treated with anti-icing coatings, or may be configured with geometries that may minimize ice accumulation. Airflow control elements may be constructed from materials that may maintain flexibility and function at low temperatures.

In some embodiments, airflow control elements may be configured for ease of maintenance. Maintenance considerations may include accessibility for inspection, ease of replacement of worn or damaged components, and availability of replacement parts. Airflow control elements may be configured with modular components that may be replaced without replacing the entire airflow control element. Airflow control elements may be positioned in locations that may be accessible for maintenance activities.

In some embodiments, an airflow control element may be located near an inlet of an air conduit. The inlet of the air conduit may comprise the opening or openings through which air enters the air conduit, and the inlet may be positioned at a lower elevation than the outlet of the air conduit. An airflow control element located near the inlet may be configured to control the amount of air entering the air conduit, the direction from which air enters the air conduit, the velocity of air entering the air conduit, or any combination thereof. The airflow control element may be positioned at the inlet opening, adjacent to the inlet opening, upstream of the inlet opening, or in other locations that may be considered near the inlet. In some embodiments, multiple airflow control elements may be located near the inlet, and the multiple airflow control elements may be positioned at different locations around the perimeter of the inlet, at different elevations near the inlet, or in other configurations.

In some embodiments, an airflow control element located near an inlet of an air conduit may be configured to selectively admit air from different directions. When wind is present, the airflow control element may be adjusted to open on the windward side of the inlet and to close on the leeward side of the inlet, which may allow wind to enhance the airflow through the air conduit. The airflow control element may be adjusted in response to changes in wind direction, wind velocity, or other wind characteristics. The airflow control element located near the inlet may comprise shutters, dampers, louvers, doors, panels, or other types of airflow control elements as described herein.

In some embodiments, an airflow control element located near an inlet of an air conduit may be configured to prevent backdraft. Backdraft may occur when external wind conditions or other factors cause air to flow in a reverse direction through the air conduit, with air exiting through the inlet rather than entering through the inlet. An airflow control element located near the inlet may be configured to close or partially close when backdraft conditions are detected or anticipated, which may prevent or reduce reverse airflow through the inlet. The airflow control element may be passive, such as a check valve or weighted flap that may close in response to reverse airflow, or the airflow control element may be active, such as a motorized damper that may be closed by a control system in response to sensor inputs indicating backdraft conditions.

In some embodiments, an airflow control element located near an inlet of an air conduit may be configured to filter or screen incoming air. The airflow control element may comprise mesh, screens, filters, or other elements that may remove debris, particles, insects, birds, or other materials from the incoming air. The filtering or screening function may protect downstream components such as heat exchangers, turbines, or other equipment from damage or fouling due to foreign materials in the airflow.

In some embodiments, an airflow control element may be located near an outlet of an air conduit. The outlet of the air conduit may comprise the opening or openings through which air exits the air conduit, and the outlet may be positioned at a higher elevation than the inlet of the air conduit. An airflow control element located near the outlet may be configured to control the amount of air exiting the air conduit, the direction in which air exits the air conduit, the velocity of air exiting the air conduit, or any combination thereof. The airflow control element may be positioned at the outlet opening, adjacent to the outlet opening, downstream of the outlet opening, or in other locations that may be considered near the outlet.

In some embodiments, an airflow control element located near an outlet of an air conduit may be configured to interact with external wind conditions. When wind is present, the airflow control element may be adjusted to close on the windward side of the outlet and to open on the leeward side of the outlet. Closing the airflow control element on the windward side of the outlet may prevent wind from entering the air conduit through the outlet and opposing the upward airflow within the air conduit. Opening the airflow control element on the leeward side of the outlet may allow the exiting air to take advantage of the low-pressure region that may exist on the leeward side of the outlet due to the wind, which may enhance the airflow through the air conduit.

In some embodiments, an airflow control element located near an outlet of an air conduit may be configured to direct the exiting airflow. The airflow control element may comprise vanes, deflectors, or other elements that may direct the exiting air in a desired direction. Directing the exiting airflow may reduce interference with nearby structures, may reduce noise, may enhance the interaction with wind conditions, or may achieve other objectives.

In some embodiments, an airflow control element located near an outlet of an air conduit may be configured to protect the interior of the air conduit from weather. The airflow control element may comprise covers, hoods, caps, or other elements that may prevent rain, snow, ice, or other precipitation from entering the air conduit through the outlet. The weather protection function may be combined with airflow control functions, such that the airflow control element may provide weather protection while also controlling the airflow characteristics at the outlet.

In some embodiments, an airflow control element may be located within an air conduit. An airflow control element located within the air conduit may be positioned at any location along the length of the air conduit between the inlet and the outlet. The airflow control element may be configured to control the airflow through the air conduit by restricting, redirecting, or otherwise modifying the airflow at the location of the airflow control element. In some embodiments, multiple airflow control elements may be located within the air conduit at different positions along the length of the air conduit.

In some embodiments, an airflow control element located within an air conduit may be configured to divide the airflow into multiple flow paths. The airflow control element may comprise partitions, baffles, or other elements that may separate the airflow into two or more streams that may flow through different portions of the air conduit cross-section. The division of the airflow may allow different portions of the airflow to be directed to different destinations, to be subjected to different treatments, or to be controlled independently.

In some embodiments, an airflow control element located within an air conduit may be configured to regulate the airflow velocity. The airflow control element may comprise dampers, valves, or other elements that may be adjusted to increase or decrease the flow resistance within the air conduit, which may affect the airflow velocity. Regulation of the airflow velocity may be employed to optimize power generation, to control heat transfer rates, to respond to changing conditions, or for other purposes.

In some embodiments, an airflow control element located within an air conduit may be configured to direct airflow toward or away from specific components within the air conduit. The airflow control element may comprise vanes, deflectors, or other elements that may direct the airflow toward heat exchangers, turbines, sensors, or other components. Directing the airflow toward specific components may enhance the performance of those components, may ensure adequate cooling or heating of those components, or may achieve other objectives.

In some embodiments, an airflow control element may comprise means of harnessing the airflow. The airflow control element may be configured to capture, utilize, convert, or otherwise employ the kinetic energy of the airflow for power generation, for driving processes, or for other purposes. In some embodiments, the airflow control element may comprise a turbine, a rotor, a fan, or other device that may be driven by the airflow and may convert the kinetic energy of the airflow into mechanical energy or electrical energy. The turbine, rotor, fan, or other device may be integrated with other airflow control functions, such that the device may both harness the airflow and control the airflow characteristics.

In some embodiments, harnessing the airflow may comprise using an airflow control element. The airflow control element may be employed to direct the airflow toward power generation equipment, to optimize the airflow velocity for power generation, to control the airflow to match power demand, or for other purposes related to harnessing the airflow. The airflow control element may be adjusted to maximize power generation under varying conditions, to balance power generation with other system objectives, or to achieve other goals related to harnessing the airflow.

In some embodiments, harnessing the airflow may further comprise using an airflow control element. In addition to other means of harnessing the airflow, such as turbines or other power generation equipment, an airflow control element may be employed to enhance the harnessing of the airflow. The airflow control element may be used in combination with turbines, generators, or other power generation equipment to optimize the overall performance of the system. The airflow control element may be adjusted to direct airflow to turbines, to control the airflow velocity through turbines, to prevent reverse flow through turbines, or for other purposes that may enhance the harnessing of the airflow.

In some embodiments, an airflow control element may comprise a fluid and air contactor. A fluid and air contactor may comprise a device, structure, or region where a fluid may be brought into contact with air for heat transfer. The fluid and air contactor may function as an airflow control element by affecting the airflow characteristics as the air passes through or over the contactor. The presence of fluid, the configuration of the contactor, the flow rate of the fluid, or other characteristics of the fluid and air contactor may influence the airflow velocity, the airflow direction, the airflow distribution, or other airflow characteristics. In some embodiments, the fluid and air contactor may comprise spray nozzles, pools, basins, films, curtains, or other configurations where fluid and air may be contacted.

In some embodiments, a fluid and air contactor functioning as an airflow control element may affect airflow through the resistance created by the fluid. When air passes through a spray of fluid droplets, through a fluid curtain, or over a fluid surface, the interaction between the air and the fluid may create resistance to the airflow. The resistance may affect the airflow velocity and may influence the distribution of airflow within the system. The resistance created by the fluid and air contactor may be varied by adjusting the fluid flow rate, the droplet size, the spray pattern, or other characteristics of the fluid and air contactor.

In some embodiments, at least an airflow control element may be located near a fluid and air contactor. The airflow control element may be positioned upstream of the fluid and air contactor, downstream of the fluid and air contactor, adjacent to the fluid and air contactor, or in other locations that may be considered near the fluid and air contactor. The airflow control element may be configured to control the airflow entering the fluid and air contactor, the airflow exiting the fluid and air contactor, or both. The airflow control element may be adjusted to optimize the heat transfer in the fluid and air contactor, to control the residence time of air in contact with the fluid, to direct airflow to specific portions of the fluid and air contactor, or for other purposes.

In some embodiments, an airflow control element located near a fluid and air contactor may be configured to distribute airflow across the fluid and air contactor. The airflow control element may comprise vanes, baffles, or other elements that may spread the airflow across the width or area of the fluid and air contactor, which may promote uniform heat transfer across the contactor. Uniform distribution of airflow may enhance the efficiency of heat transfer and may prevent localized areas of inadequate or excessive heat transfer.

In some embodiments, an airflow control element located near a fluid and air contactor may be configured to control the airflow velocity through the fluid and air contactor. The airflow velocity may affect the heat transfer rate, the residence time of air in contact with the fluid, the degree of freezing that may occur, or other characteristics of the heat transfer process. The airflow control element may be adjusted to increase or decrease the airflow velocity through the fluid and air contactor to achieve desired heat transfer characteristics.

In some embodiments, an airflow control element located near a fluid and air contactor may be configured to prevent or reduce carryover of fluid droplets. When air passes through a spray of fluid droplets or over a fluid surface, some fluid droplets may be entrained in the airflow and may be carried downstream. The airflow control element may comprise mist eliminators, demisters, baffles, or other elements that may capture entrained droplets and may prevent the droplets from being carried further downstream. Preventing carryover of fluid droplets may protect downstream equipment such as turbines from damage or fouling due to fluid contact.

In some embodiments, the positioning of airflow control elements relative to fluid and air contactors may be configured to optimize system performance. Airflow control elements may be positioned to ensure adequate airflow through the fluid and air contactors for effective heat transfer, to direct airflow to turbines or other power generation equipment after heat transfer, to prevent interference between multiple fluid and air contactors, or for other purposes. The configuration of airflow control elements and fluid and air contactors may be designed as an integrated system to achieve desired performance objectives.

In some embodiments, a system may comprise an airflow control element located near an inlet of an airflow conduit. The system may be configured such that the airflow control element may control the entry of air into the airflow conduit. The airflow control element may be adjustable to respond to changing conditions, may be configured to harness wind energy, may be configured to prevent backdraft, or may be configured for other purposes as described herein.

In some embodiments, a system may comprise an airflow control element located near an outlet of an airflow conduit. The system may be configured such that the airflow control element may control the exit of air from the airflow conduit. The airflow control element may be adjustable to interact with external wind conditions, may be configured to direct exiting airflow, may be configured to provide weather protection, or may be configured for other purposes as described herein.

In some embodiments, a system may comprise an airflow control element located within an airflow conduit. The system may be configured such that the airflow control element may control the airflow at a location between the inlet and the outlet of the airflow conduit. The airflow control element may be configured to divide airflow, to regulate airflow velocity, to direct airflow toward specific components, or for other purposes as described herein.

In some embodiments, a system may comprise an airflow control element that comprises means of harnessing the airflow. The system may be configured such that the airflow control element may capture, utilize, or convert the kinetic energy of the airflow. The airflow control element may comprise a turbine, a rotor, or other device that may be driven by the airflow and may generate mechanical or electrical power.

In some embodiments, a system may comprise at least an airflow control element located near a fluid and air contactor. The system may be configured such that the airflow control element may control the airflow entering, exiting, or passing through the fluid and air contactor. The airflow control element may be configured to optimize heat transfer, to distribute airflow, to control airflow velocity, to prevent carryover, or for other purposes as described herein.

In some embodiments, adjusting the airflow using an airflow control element may be in response to wind properties. Wind properties may include wind speed, wind direction, wind gustiness, wind turbulence intensity, wind shear, or other characteristics of ambient wind conditions. Sensors such as anemometers, wind vanes, ultrasonic wind sensors, or lidar systems may measure wind properties at or near an air conduit. In some embodiments, the airflow control element may be adjusted to capture wind energy when wind conditions are favorable, to protect the air conduit from wind damage when wind conditions are severe, or to compensate for wind effects on the natural buoyancy-driven airflow.

In some embodiments, adjusting the airflow using an airflow control element may be in response to wind direction. Wind direction may be measured by wind vanes, sonic anemometers, or other directional wind sensors. When wind direction changes, airflow control elements at air inlets and air outlets may be adjusted to maintain favorable airflow conditions. In some embodiments, airflow control elements on a windward side of an air conduit may be opened to allow wind to augment the natural buoyancy-driven airflow, while airflow control elements on a leeward side may be adjusted to prevent backflow or to facilitate air discharge.

In some embodiments, adjusting the airflow using an airflow control element may be in response to wind velocity. Wind velocity may be measured by cup anemometers, propeller anemometers, ultrasonic anemometers, or other wind speed sensors. Higher wind velocities may provide opportunities to augment power generation by capturing wind energy, while excessively high wind velocities may require protective measures such as closing airflow control elements or collapsing collapsible structures. In some embodiments, the airflow control element may be adjusted to optimize the balance between capturing wind energy and protecting the air conduit from wind-induced loads or damage.

In some embodiments, adjusting the airflow using an airflow control element may be in response to changes in wind direction. Changes in wind direction may occur gradually over time or may occur rapidly during weather fronts, storms, or other meteorological events. A control system may track wind direction over time and may detect changes in wind direction. In some embodiments, responsive to detected changes in wind direction, the control system may adjust airflow control elements to reorient the air conduit's wind-facing configuration, to close airflow control elements that were previously on the windward side and are now on the leeward side, or to open airflow control elements that were previously on the leeward side and are now on the windward side.

In some embodiments, adjusting the airflow using an airflow control element may be in response to air temperature. Air temperature may be measured by thermocouples, resistance temperature detectors, thermistors, or other temperature sensors positioned at air inlets, air outlets, within the air conduit, or at other locations. Air temperature may affect the density of air, the temperature difference between inlet air and the fluid, and the resulting buoyancy-driven airflow. In some embodiments, sensors may be placed at various heights along an air conduit, such as a tower, to monitor temperature at multiple elevations. The airflow control element may be adjusted to optimize airflow characteristics based at least in part on measured air temperatures. For example, when inlet air temperature is colder, the temperature difference between the inlet air and the fluid may be greater, which may result in stronger buoyancy-driven airflow, and the airflow control element may be adjusted to accommodate or take advantage of the increased airflow.

In some embodiments, adjusting the airflow using an airflow control element may be in response to air humidity. Air humidity may be measured by hygrometers, humidity sensors, dew point sensors, or other humidity measurement devices. Air humidity may affect heat transfer rates, ice formation rates, and the properties of ice or frost that may form within the air conduit. In some embodiments, the airflow control element may be adjusted to modulate airflow based at least in part on air humidity to optimize heat transfer, to control ice formation, or to prevent excessive frost accumulation on airflow control elements or other components.

In some embodiments, adjusting the airflow using an airflow control element may be in response to air composition. Air composition may include the concentration of gases such as oxygen, nitrogen, carbon dioxide, water vapor, or other atmospheric constituents. Air composition may also include the presence of particulates, aerosols, pollutants, or other airborne materials. Sensors such as gas analyzers, particulate monitors, or air quality sensors may measure air composition. In some embodiments, the airflow control element may be adjusted based at least in part on air composition to optimize carbon dioxide absorption when a CO₂ absorber unit is employed, to protect equipment from corrosive or abrasive airborne materials, or to maintain air quality within the air conduit.

In some embodiments, adjusting the airflow using an airflow control element may be in response to fluid temperature. Fluid temperature may be measured by temperature sensors positioned in fluid supply lines, in thermal exchange zones, in fluid storage tanks, or at other locations where fluid temperature is relevant. Fluid temperature may affect the amount of heat available for transfer to the air, the rate of heat transfer, and the extent of freezing that may occur. In some embodiments, the airflow control element may be adjusted to modulate airflow based at least in part on fluid temperature to optimize heat transfer rates, to control the extent of freezing, or to maintain desired operating conditions.

In some embodiments, adjusting the airflow using an airflow control element may be in response to system conditions. System conditions may include the operational status of components such as pumps, turbines, heat exchangers, control systems, or other equipment. System conditions may also include parameters such as pressures, flow rates, temperatures, power outputs, or other measurable quantities that characterize the state of the system. In some embodiments, the airflow control element may be adjusted based at least in part on system conditions to maintain stable operation, to respond to equipment malfunctions, or to optimize overall system performance.

In some embodiments, adjusting the airflow using an airflow control element may be in response to operating conditions. Operating conditions may include the current mode of operation, the load level, the power output, the production rate, or other parameters that describe how the system is being operated. Operating conditions may vary based on operator commands, automated control sequences, or external factors such as power demand or grid conditions. In some embodiments, the airflow control element may be adjusted to match airflow characteristics to the current operating conditions, such as by increasing airflow when higher power output is desired or by reducing airflow when lower power output is acceptable.

In some embodiments, adjusting the airflow using an airflow control element may be in response to operating state. Operating state may refer to discrete states such as startup, normal operation, shutdown, standby, maintenance mode, emergency mode, or other defined operational states. Each operating state may have associated airflow control element settings or adjustment protocols. In some embodiments, the airflow control element may be adjusted automatically when the operating state changes, such as by opening airflow control elements during startup to establish airflow or by closing airflow control elements during shutdown to stop airflow.

In some embodiments, adjusting the airflow using an airflow control element may be in response to presence or absence of blockages. Blockages may include ice accumulation, frost buildup, debris, equipment failures, or other obstructions that may impede airflow through the air conduit. Sensors such as pressure sensors, flow sensors, cameras, or ice detection sensors may detect the presence of blockages. In some embodiments, sensors may be placed at various heights along an air conduit to monitor ice thickness and to detect blockages at different elevations. The airflow control element may be adjusted to compensate for blockages, to redirect airflow around blockages, or to facilitate removal of blockages. For example, if a blockage is detected at one air inlet, airflow control elements at other air inlets may be opened to maintain total airflow through the air conduit.

In some embodiments, adjusting the airflow using an airflow control element may be in response to predicted weather. Predicted weather may be obtained from weather forecasting services, meteorological models, satellite data, radar data, or other sources of weather predictions. Predicted weather may include forecasts of temperature, wind, precipitation, storms, or other weather phenomena. In some embodiments, the airflow control element may be adjusted in anticipation of predicted weather conditions, such as by closing airflow control elements before a predicted storm arrives or by adjusting airflow control elements to prepare for predicted temperature changes.

In some embodiments, adjusting the airflow using an airflow control element may be in response to weather or measured weather. Weather may refer to current atmospheric conditions, and measured weather may refer to weather conditions that have been measured by sensors or weather stations. Measured weather data may include current temperature, wind speed, wind direction, humidity, barometric pressure, precipitation, or other meteorological parameters. In some embodiments, the airflow control element may be adjusted based at least in part on measured weather to respond to current conditions in real-time or near-real-time.

In some embodiments, adjusting the airflow using an airflow control element may be in response to past conditions, current conditions, or future conditions. Past conditions may include historical data on weather, system performance, power demand, or other parameters. Current conditions may include real-time measurements of environmental and system parameters. Future conditions may include predictions or forecasts of environmental and system parameters. In some embodiments, a control system may analyze past conditions to identify trends or patterns, may monitor current conditions to respond to immediate needs, and may anticipate future conditions to prepare for upcoming changes. The airflow control element may be adjusted based at least in part on any combination of past, current, and future conditions.

In some embodiments, adjusting the airflow using an airflow control element may be in response to predictive modeling. Predictive modeling may involve computational models that forecast future conditions, system behavior, or performance outcomes based on input data and mathematical relationships. Predictive models may forecast weather conditions, power demand, equipment degradation, ice formation rates, or other parameters relevant to system operation. In some embodiments, the airflow control element may be adjusted based at least in part on outputs from predictive models to optimize performance, to prevent problems before they occur, or to prepare for anticipated changes in conditions.

In some embodiments, adjusting the airflow using an airflow control element may be in response to measurements or current measurements. Measurements may be obtained from sensors positioned throughout the system, including sensors that measure temperature, pressure, flow rate, velocity, humidity, power output, structural parameters, or other quantities. Sensors may be placed at various heights along an air conduit to monitor airflow velocity at multiple elevations. In some embodiments, sensors may monitor structural integrity of ice when ice is used as a construction material for the air conduit. Current measurements may refer to the most recent sensor readings, which may be updated continuously or at regular intervals. The airflow control element may be adjusted based at least in part on current measurements to maintain desired operating conditions or to respond to detected changes in system state.

In some embodiments, adjusting the airflow using an airflow control element may be in response to power demand. Power demand may refer to the amount of electrical power requested or required by loads connected to the power generation system, by the electrical grid, or by other power consumers. Power demand may vary over time based on consumer behavior, industrial activity, weather conditions, or other factors. In some embodiments, the airflow control element may be adjusted to increase airflow and power generation when power demand is high, or to decrease airflow and power generation when power demand is low. Adjusting airflow in response to power demand may allow the system to match power output to power demand, which may improve grid stability or reduce energy waste.

In some embodiments, adjusting the airflow using an airflow control element may be in response to fluid availability. Fluid availability may refer to the quantity of fluid available for heat transfer operations, which may depend on water levels in lakes or reservoirs, flow rates in rivers, ice conditions, pumping capacity, or other factors. In some embodiments, the airflow control element may be adjusted to reduce airflow when fluid availability is limited, to prevent the system from operating beyond the available fluid supply. Conversely, when fluid availability is abundant, the airflow control element may be adjusted to increase airflow and maximize power generation or other outputs.

In some embodiments, adjusting the airflow using an airflow control element may be in response to power cost. Power cost may refer to the market price of electricity, which may vary over time based on supply and demand, fuel costs, grid conditions, or other factors. In some embodiments, the airflow control element may be adjusted to increase power generation when power prices are high, to maximize revenue from power sales. Conversely, when power prices are low, the airflow control element may be adjusted to reduce power generation or to shift operation to other activities such as ice production or carbon dioxide capture that may be more valuable under low power price conditions.

In some embodiments, adjusting the airflow using an airflow control element may be in response to economic considerations. Economic considerations may include power prices, operating costs, maintenance costs, equipment wear, labor costs, or other factors that affect the economic performance of the system. In some embodiments, a control system may optimize airflow control element settings to maximize economic value, which may involve balancing power generation against operating costs, scheduling maintenance during low-value periods, or adjusting operation to take advantage of favorable economic conditions.

In some embodiments, adjusting the airflow using an airflow control element may be in response to practical considerations. Practical considerations may include equipment limitations, personnel availability, access constraints, safety requirements, regulatory requirements, or other factors that may affect what operations are feasible or advisable. In some embodiments, the airflow control element may be adjusted to accommodate practical considerations, such as by reducing airflow during maintenance activities, by adjusting operation to comply with regulatory limits, or by modifying operation when personnel are not available for monitoring.

In some embodiments, adjusting the airflow using an airflow control element may be in response to operational constraints. Operational constraints may include limits on equipment capacity, limits on power output, limits on fluid flow rates, limits on temperatures, or other boundaries that define the allowable operating envelope. In some embodiments, the airflow control element may be adjusted to maintain operation within operational constraints, such as by reducing airflow when power output approaches a maximum limit or by adjusting airflow to prevent temperatures from exceeding allowable ranges.

In some embodiments, adjusting the airflow using an airflow control element may be in response to system demands. System demands may include requirements for power output, requirements for ice production, requirements for carbon dioxide capture, requirements for desalinated water production, or other outputs that the system is expected to provide. In some embodiments, the airflow control element may be adjusted to meet system demands, such as by increasing airflow to increase power output when more power is demanded or by adjusting airflow to optimize ice production when ice is the primary desired output.

In some embodiments, adjusting the airflow using an airflow control element may be in response to downstream demand. Downstream demand may refer to requirements from processes, equipment, or consumers that receive outputs from the system. Downstream demand may include electrical loads connected to the power generation system, water treatment facilities that receive desalinated water, carbon dioxide storage or utilization facilities that receive captured carbon dioxide, or other downstream consumers. In some embodiments, the airflow control element may be adjusted to match system output to downstream demand, which may improve efficiency and reduce waste.

In some embodiments, adjusting the airflow using an airflow control element may be in response to product produced. Product produced may refer to the outputs generated by the system, which may include electrical power, ice, desalinated water, brine, salt, captured carbon dioxide, or other products. In some embodiments, the airflow control element may be adjusted based at least in part on the quantity or quality of product produced, such as by adjusting airflow to maintain a target production rate or by adjusting airflow to improve product quality.

In some embodiments, adjusting the airflow using an airflow control element may be in response to system optimizations. System optimizations may involve adjusting system parameters to achieve improved performance according to one or more optimization objectives. Optimization objectives may include maximizing power output, maximizing efficiency, minimizing costs, minimizing emissions, maximizing product quality, or other goals. In some embodiments, a control system may execute optimization algorithms that determine airflow control element settings that achieve improved performance according to the optimization objectives. The airflow control element may be adjusted based at least in part on the outputs of the optimization algorithms.

In some embodiments, an automated control system may adjust water flow rates, air intake dampers, turbine blade angles, or other controllable parameters based at least in part on sensor measurements and control algorithms. Sensors may be placed at various heights along an air conduit to monitor temperature, airflow velocity, structural integrity of ice, ice thickness, or other parameters. The automated control system may receive sensor data, may process the sensor data using control algorithms, and may generate control signals to adjust airflow control elements and other controllable components. In some embodiments, the automated control system may adjust airflow control elements continuously or at regular intervals to maintain desired operating conditions and to respond to changing conditions.

In some embodiments, adjusting the airflow using an airflow control element may comprise at least partially opening an airflow control element on a windward side air inlet and at least partially closing an airflow control element on a leeward side air inlet. The windward side may be defined by the ambient wind direction, and the windward side may correspond to the side of an air conduit that faces into the oncoming wind. The leeward side may be defined by the ambient wind direction, and the leeward side may correspond to the side of an air conduit that faces away from the oncoming wind, opposite to the windward side. When ambient wind is present, the wind may create a positive pressure on the windward side of the air conduit and a negative pressure or reduced pressure on the leeward side of the air conduit.

In some embodiments, at least partially opening an airflow control element on a windward side air inlet may allow ambient wind to enter the air conduit and augment the buoyancy-driven airflow. The wind pressure on the windward side may push air into the air conduit through the opened airflow control element, adding to the natural upward airflow generated by heat transfer from the fluid to the air. At least partially closing an airflow control element on a leeward side air inlet may prevent air from exiting the air conduit through the leeward side inlet, which might otherwise occur due to the lower pressure on the leeward side. By opening the windward side inlet and closing the leeward side inlet, the system may capture wind energy to enhance airflow through the air conduit.

In some embodiments, an air conduit may comprise multiple air inlets positioned around the circumference of the air conduit at a first elevation. Each air inlet may be equipped with an airflow control element that may be independently adjusted. When wind direction changes, the designation of which air inlets are on the windward side and which are on the leeward side may change accordingly. A control system may receive wind direction data from wind sensors and may adjust the airflow control elements at the air inlets to open those on the current windward side and close those on the current leeward side. In some embodiments, the control system may continuously monitor wind direction and may adjust the airflow control elements in response to changes in wind direction.

In some embodiments, adjusting the airflow using an airflow control element may comprise at least partially closing an airflow control element on a windward side air outlet and at least partially opening an airflow control element on a leeward side air outlet. The windward side may be defined by the ambient wind direction, and the leeward side may be defined by the ambient wind direction. At the air outlet elevation, wind may create a positive pressure on the windward side that could oppose the discharge of warmed air from the air conduit. At least partially closing an airflow control element on a windward side air outlet may prevent wind from pushing against the exiting airflow and impeding the natural buoyancy-driven discharge of warmed air.

In some embodiments, at least partially opening an airflow control element on a leeward side air outlet may facilitate the discharge of warmed air from the air conduit. The reduced pressure on the leeward side may create a suction effect that draws warmed air out of the air conduit through the opened leeward side outlet. By closing the windward side outlet and opening the leeward side outlet, the system may reduce resistance to airflow discharge and may enhance the overall airflow velocity through the air conduit.

In some embodiments, an air conduit may comprise multiple air outlets positioned around the circumference of the air conduit at a second elevation. Each air outlet may be equipped with an airflow control element that may be independently adjusted. When wind direction changes, the designation of which air outlets are on the windward side and which are on the leeward side may change accordingly. A control system may receive wind direction data from wind sensors and may adjust the airflow control elements at the air outlets to close those on the current windward side and open those on the current leeward side. In some embodiments, the control system may continuously monitor wind direction and may adjust the airflow control elements in response to changes in wind direction.

In some embodiments, the coordinated adjustment of airflow control elements at both air inlets and air outlets may provide enhanced airflow augmentation from ambient wind. Opening windward side air inlets while closing leeward side air inlets may maximize wind capture at the inlet elevation. Closing windward side air outlets while opening leeward side air outlets may minimize wind resistance and maximize suction-assisted discharge at the outlet elevation. The combined effect of these adjustments may increase airflow velocity through the air conduit, which may increase the kinetic energy available for power generation or other applications.

In some embodiments, the windward and leeward sides may shift as ambient wind direction changes. Wind direction may change gradually over time due to diurnal patterns, seasonal patterns, or weather system movements. Wind direction may also change rapidly during weather fronts, storms, or turbulent conditions. A control system may track wind direction using wind vanes, sonic anemometers, or other directional wind sensors. In some embodiments, the control system may adjust airflow control elements at air inlets and air outlets in response to detected changes in wind direction to maintain the configuration of opened windward side inlets, closed leeward side inlets, closed windward side outlets, and opened leeward side outlets.

In some embodiments, the degree to which airflow control elements are opened or closed may be modulated based at least in part on wind velocity. At higher wind velocities, the pressure differential between windward and leeward sides may be greater, and the airflow control elements may be adjusted to take advantage of the increased wind energy. At lower wind velocities, the pressure differential may be smaller, and the airflow control elements may be adjusted to a different configuration. In some embodiments, when wind velocity is very low or calm, the airflow control elements at all air inlets may be opened and the airflow control elements at all air outlets may be opened to allow natural buoyancy-driven airflow without wind-based directional adjustments.

In some embodiments, the adjustment of airflow control elements based on windward and leeward positions may be performed automatically by a control system. The control system may receive wind direction and wind velocity data from sensors, may determine which air inlets and air outlets are on the windward side and which are on the leeward side, and may generate control signals to adjust the airflow control elements accordingly. In some embodiments, the control system may execute control algorithms that optimize the degree of opening or closing of each airflow control element based at least in part on wind conditions, temperature conditions, power demand, or other factors.

In some embodiments, the adjustment of airflow control elements based on windward and leeward positions may enhance power generation or power output. By capturing wind energy at the air inlets and reducing wind resistance at the air outlets, the airflow velocity through the air conduit may be increased. Increased airflow velocity may increase the kinetic energy of the airflow, which may increase the power output from an air turbine or other power generation unit. In some embodiments, the wind augmentation of airflow may allow the system to generate more power during windy conditions than would be possible from buoyancy-driven airflow alone.

In some embodiments, adjusting the airflow using an airflow control element may prevent airflow backdraft. Airflow backdraft may occur when ambient wind, pressure differentials, or other external forces cause air to flow in a direction opposite to the intended direction of airflow through an air conduit. In a system where warmed air is intended to rise from a first elevation to a second elevation through an air conduit, backdraft may occur when external wind pressure at an air outlet exceeds the internal pressure of the rising warmed air, causing air to flow downward into the air conduit through the outlet. Backdraft may also occur when wind creates a negative pressure at an air inlet that draws air out of the air conduit through the inlet rather than allowing air to enter. In some embodiments, an airflow control element may be adjusted to close or partially close air inlets or air outlets that are subject to conditions that would cause backdraft. For example, an airflow control element at a leeward side air inlet may be closed to prevent the negative pressure on the leeward side from drawing air out of the air conduit. Similarly, an airflow control element at a windward side air outlet may be closed to prevent wind pressure from forcing air back into the air conduit. By preventing backdraft, the airflow control element may maintain the intended direction of airflow through the air conduit, which may preserve the efficiency of heat transfer operations and power generation.

In some embodiments, adjusting the airflow using an airflow control element may enable power generation to be enhanced by windy conditions. Windy conditions may provide additional energy that may be captured to augment the buoyancy-driven airflow through an air conduit. When ambient wind is present, the wind may create pressure differentials around the air conduit that may be harnessed to increase airflow velocity and airflow volume. In some embodiments, an airflow control element may be adjusted to capture wind energy by opening air inlets on a windward side where wind pressure may push air into the air conduit, and by opening air outlets on a leeward side where reduced pressure may draw air out of the air conduit. The wind-induced pressure differential may add to the buoyancy-driven pressure differential, resulting in greater total driving force for airflow through the air conduit. The increased airflow may increase the kinetic energy available for conversion to electrical or mechanical power by a power generation unit such as an air turbine. In some embodiments, the enhancement of power generation by windy conditions may allow the system to produce more power during windy periods than would be possible from buoyancy-driven airflow alone.

In some embodiments, adjusting the airflow using an airflow control element may enhance airflow velocity. Airflow velocity may refer to the speed at which air moves through an air conduit, typically measured in meters per second or feet per minute. Higher airflow velocity may result in greater kinetic energy per unit volume of air, which may increase the power available for extraction by a power generation unit. In some embodiments, an airflow control element may be adjusted to reduce flow restrictions, to direct airflow more efficiently, or to capture wind energy, any of which may increase airflow velocity. For example, opening airflow control elements at air inlets may reduce the pressure drop across the inlet, allowing air to enter the air conduit more freely and at higher velocity. Adjusting airflow control elements to capture wind energy may add wind-driven flow to the buoyancy-driven flow, increasing the total airflow velocity. In some embodiments, airflow control elements within the air conduit may be adjusted to reduce turbulence or to streamline the flow path, which may reduce energy losses and maintain higher airflow velocity through the air conduit.

In some embodiments, adjusting the airflow using an airflow control element may enhance airflow kinetic energy. Airflow kinetic energy may refer to the energy possessed by moving air due to the motion of the air. Kinetic energy may be proportional to the mass of the moving air and to the square of the airflow velocity. Enhancing airflow kinetic energy may increase the amount of energy available for conversion to electrical or mechanical power by a power generation unit. In some embodiments, an airflow control element may be adjusted to increase airflow velocity, which may increase airflow kinetic energy due to the squared relationship between velocity and kinetic energy. An airflow control element may also be adjusted to increase the mass flow rate of air through the air conduit, which may increase the total kinetic energy of the airflow. In some embodiments, the combination of increased airflow velocity and increased mass flow rate may result in substantially enhanced airflow kinetic energy compared to operation without airflow control element adjustment.

In some embodiments, adjusting the airflow using an airflow control element may enhance airflow characteristics. Airflow characteristics may include properties such as velocity profile, turbulence intensity, flow uniformity, pressure distribution, temperature distribution, or other attributes that describe the nature of the airflow through an air conduit. In some embodiments, an airflow control element may be adjusted to modify one or more airflow characteristics to improve system performance. For example, an airflow control element may be adjusted to reduce turbulence intensity, which may reduce energy losses and improve the efficiency of power extraction by an air turbine. An airflow control element may be adjusted to create a more uniform velocity profile across the cross-section of the air conduit, which may improve the performance of downstream components such as thermal exchange zones or power generation units. In some embodiments, airflow control elements may be adjusted to direct airflow toward specific regions of the air conduit where heat transfer or power generation occurs, thereby enhancing the effectiveness of those operations.

In some embodiments, adjusting the airflow using an airflow control element may be in response to one or more conditions. Conditions that may trigger or influence adjustment of an airflow control element may include environmental conditions, operational conditions, system conditions, economic conditions, or any combination thereof. The adjustment of the airflow control element in response to conditions may be performed to optimize system performance, to protect system components, to maximize power generation, to respond to changing circumstances, or for other purposes.

In some embodiments, conditions that may influence adjustment of an airflow control element may be selected from one or more or any combination of the following: wind properties, or wind direction, or wind velocity, or changes in wind direction, or air temperature, or air humidity, or air composition, or fluid temperature, or system conditions, or operating conditions, or operating state, or presence or absence of blockages, or predicted weather, or weather, or measured weather, or past conditions, or current conditions, or future conditions, or predictive modeling, or measurements, or current measurements, or power demand, or fluid availability, or power cost, or economic considerations, or practical considerations, or operational constraints, or system demands, or downstream demand, or product produced, or system optimizations, or any combination thereof.

In some embodiments, wind properties may comprise conditions that may influence adjustment of an airflow control element. Wind properties may include one or more or any combination of the following: wind speed, or wind velocity, or wind direction, or wind gustiness, or wind turbulence, or wind shear, or wind steadiness, or wind variability, or any combination thereof. The airflow control element may be adjusted in response to wind properties to harness wind energy, to prevent adverse effects of wind on system operation, to optimize airflow through the system, or for other purposes. When wind properties indicate favorable conditions for wind harnessing, the airflow control element may be adjusted to open on the windward side and close on the leeward side to allow wind to enhance airflow through the system.

In some embodiments, wind direction may comprise a condition that may influence adjustment of an airflow control element. Wind direction may be measured, detected, or determined using wind vanes, anemometers, ultrasonic wind sensors, or other wind measurement devices. The airflow control element may be adjusted in response to wind direction to position open airflow control elements on the windward side of the system and closed airflow control elements on the leeward side of the system. Changes in wind direction may trigger corresponding adjustments to the airflow control element to maintain optimal positioning relative to the wind direction.

In some embodiments, wind velocity may comprise a condition that may influence adjustment of an airflow control element. Wind velocity may be measured using anemometers, pitot tubes, ultrasonic sensors, or other velocity measurement devices. The airflow control element may be adjusted in response to wind velocity to take advantage of higher wind velocities for enhanced airflow, to protect the system from excessive wind velocities, or to optimize the degree of opening of the airflow control element based on the wind velocity. At higher wind velocities, the airflow control element may be adjusted to a greater degree of opening on the windward side to capture more wind energy. At excessively high wind velocities, the airflow control element may be adjusted to a more closed position to protect system components from damage.

In some embodiments, changes in wind direction may comprise a condition that may influence adjustment of an airflow control element. Changes in wind direction may be detected through continuous monitoring of wind direction, through comparison of current wind direction to previous wind direction measurements, or through other methods. The airflow control element may be adjusted in response to changes in wind direction to reposition open and closed airflow control elements relative to the new wind direction. The adjustment may be performed continuously, periodically, or in response to detected changes exceeding a threshold magnitude.

In some embodiments, air temperature may comprise a condition that may influence adjustment of an airflow control element. Air temperature may be measured using thermometers, thermocouples, resistance temperature detectors, thermistors, or other temperature measurement devices. The airflow control element may be adjusted in response to air temperature to optimize heat transfer from fluid to air, to control the degree of freezing that may occur, to respond to changes in air density associated with temperature changes, or for other purposes. At lower air temperatures, the airflow control element may be adjusted to increase airflow to take advantage of the greater temperature difference between the fluid and the air. At higher air temperatures, the airflow control element may be adjusted to reduce airflow or to modify system operation.

In some embodiments, air humidity may comprise a condition that may influence adjustment of an airflow control element. Air humidity may be measured using hygrometers, humidity sensors, psychrometers, or other humidity measurement devices. The airflow control element may be adjusted in response to air humidity to account for the effects of humidity on heat transfer, on air density, on ice formation, or on other system characteristics. Higher humidity may affect the rate of evaporation from fluid surfaces, may affect the formation of frost or ice on system components, or may affect other aspects of system operation.

In some embodiments, air composition may comprise a condition that may influence adjustment of an airflow control element. Air composition may include the concentration of various gases, particulates, pollutants, or other constituents in the air. Air composition may be measured using gas analyzers, particulate sensors, air quality monitors, or other composition measurement devices. The airflow control element may be adjusted in response to air composition to optimize carbon dioxide capture, to respond to changes in air density associated with composition changes, to protect system components from corrosive or harmful constituents, or for other purposes.

In some embodiments, fluid temperature may comprise a condition that may influence adjustment of an airflow control element. Fluid temperature may be measured using thermometers, thermocouples, resistance temperature detectors, thermistors, or other temperature measurement devices positioned in contact with the fluid or in fluid flow paths. The airflow control element may be adjusted in response to fluid temperature to optimize heat transfer from the fluid to air, to control the degree of freezing that may occur, to respond to changes in the temperature difference between the fluid and the air, or for other purposes. At higher fluid temperatures, the airflow control element may be adjusted to increase airflow to take advantage of the greater heat available for transfer. At lower fluid temperatures, the airflow control element may be adjusted to reduce airflow or to modify system operation.

In some embodiments, system conditions may comprise conditions that may influence adjustment of an airflow control element. System conditions may include one or more or any combination of the following: equipment status, or component temperatures, or pressure levels, or flow rates, or power output, or efficiency metrics, or maintenance status, or alarm conditions, or any combination thereof. The airflow control element may be adjusted in response to system conditions to optimize overall system performance, to respond to equipment malfunctions or degraded performance, to coordinate with other system components, or for other purposes.

In some embodiments, operating conditions may comprise conditions that may influence adjustment of an airflow control element. Operating conditions may include one or more or any combination of the following: current operating mode, or production rate, or throughput, or capacity utilization, or startup status, or shutdown status, or standby status, or any combination thereof. The airflow control element may be adjusted in response to operating conditions to match airflow to the current operating mode, to facilitate transitions between operating modes, to optimize performance at the current operating point, or for other purposes.

In some embodiments, operating state may comprise a condition that may influence adjustment of an airflow control element. Operating state may include one or more or any combination of the following: running state, or idle state, or startup state, or shutdown state, or maintenance state, or emergency state, or any combination thereof. The airflow control element may be adjusted in response to operating state to provide appropriate airflow for the current state, to facilitate transitions between states, to protect system components during certain states, or for other purposes. During a shutdown state, the airflow control element may be adjusted to a closed position to prevent uncontrolled airflow through the system.

In some embodiments, presence or absence of blockages may comprise a condition that may influence adjustment of an airflow control element. Blockages may include one or more or any combination of the following: ice accumulation, or debris accumulation, or equipment obstructions, or fouling, or scaling, or any combination thereof. The presence or absence of blockages may be detected through pressure measurements, flow measurements, visual inspection, sensors, or other detection methods. The airflow control element may be adjusted in response to the presence of blockages to redirect airflow around blocked areas, to compensate for reduced flow capacity due to blockages, to facilitate clearing of blockages, or for other purposes. The airflow control element may be adjusted in response to the absence of blockages to return to normal operating positions after blockages have been cleared.

In some embodiments, predicted weather may comprise a condition that may influence adjustment of an airflow control element. Predicted weather may include weather forecasts, weather predictions, weather models, or other information about expected future weather conditions. Predicted weather information may be obtained from meteorological services, weather data providers, on-site weather prediction systems, or other sources. The airflow control element may be adjusted in response to predicted weather to prepare for expected changes in wind conditions, temperature conditions, precipitation, or other weather factors. Adjustment in response to predicted weather may allow the system to proactively position airflow control elements for expected conditions rather than reactively adjusting after conditions have changed.

In some embodiments, weather may comprise a condition that may influence adjustment of an airflow control element. Weather may include current weather conditions, recent weather conditions, or general weather patterns. Weather conditions may include one or more or any combination of the following: precipitation, or storms, or fog, or clouds, or clear conditions, or any combination thereof. The airflow control element may be adjusted in response to weather to optimize system operation under current weather conditions, to protect system components from adverse weather, to take advantage of favorable weather conditions, or for other purposes.

In some embodiments, measured weather may comprise a condition that may influence adjustment of an airflow control element. Measured weather may include weather conditions that have been measured or detected by sensors, instruments, or other measurement devices. Measured weather may include one or more or any combination of the following: measured temperature, or measured humidity, or measured wind speed, or measured wind direction, or measured precipitation, or measured barometric pressure, or any combination thereof. The airflow control element may be adjusted in response to measured weather to respond to actual conditions as detected by measurement devices.

In some embodiments, past conditions may comprise conditions that may influence adjustment of an airflow control element. Past conditions may include historical data, previous measurements, trends, patterns, or other information about conditions that have occurred in the past. Past conditions may be stored in databases, data logs, control system memory, or other data storage systems. The airflow control element may be adjusted in response to past conditions to apply lessons learned from previous operation, to recognize recurring patterns, to anticipate conditions based on historical trends, or for other purposes.

In some embodiments, current conditions may comprise conditions that may influence adjustment of an airflow control element. Current conditions may include real-time measurements, current sensor readings, present operating parameters, or other information about conditions at the present time. Current conditions may be obtained from sensors, instruments, control systems, or other sources of real-time information. The airflow control element may be adjusted in response to current conditions to respond to the actual present state of the system and environment.

In some embodiments, future conditions may comprise conditions that may influence adjustment of an airflow control element. Future conditions may include predicted conditions, forecasted conditions, anticipated conditions, or other information about expected conditions at future times. Future conditions may be derived from weather forecasts, predictive models, scheduled events, or other sources of information about expected future states. The airflow control element may be adjusted in response to future conditions to prepare for expected changes, to optimize performance over a future time horizon, to coordinate with scheduled activities, or for other purposes.

In some embodiments, adjusting the airflow using the airflow control element may be in response to predictive modeling. Predictive modeling may comprise the use of mathematical models, computational models, statistical models, machine learning models, or other modeling techniques to predict future conditions, future system states, future performance, or other future outcomes. Predictive modeling may use input data including one or more or any combination of the following: current measurements, or historical data, or weather forecasts, or system parameters, or external data sources, or any combination thereof. The output of predictive modeling may include predictions of future wind conditions, future temperature conditions, future power demand, future system performance, or other predicted outcomes.

In some embodiments, predictive modeling may be employed to anticipate changes in wind conditions. The predictive model may use current wind measurements, historical wind patterns, weather forecast data, or other inputs to predict future wind direction, wind velocity, or other wind characteristics. The airflow control element may be adjusted in response to the predicted wind conditions to position the airflow control element in anticipation of the predicted wind, which may allow the system to respond more quickly to changing wind conditions than reactive adjustment based on measured conditions alone.

In some embodiments, predictive modeling may be employed to optimize power generation over a future time horizon. The predictive model may predict future power demand, future electricity prices, future wind conditions, future temperature conditions, or other factors that may affect optimal power generation. The airflow control element may be adjusted in response to the predictive modeling output to maximize power generation during periods of high demand or high prices, to reduce power generation during periods of low demand or low prices, or to otherwise optimize power generation based on predicted future conditions.

In some embodiments, predictive modeling may be employed to anticipate maintenance needs or equipment degradation. The predictive model may use sensor data, historical performance data, equipment age, or other inputs to predict when maintenance may be needed or when equipment performance may degrade. The airflow control element may be adjusted in response to the predictive modeling output to compensate for predicted equipment degradation, to prepare for scheduled maintenance, or to optimize system operation in anticipation of maintenance activities.

In some embodiments, measurements may comprise conditions that may influence adjustment of an airflow control element. Measurements may include data obtained from sensors, instruments, meters, or other measurement devices. Measurements may include one or more or any combination of the following: temperature measurements, or pressure measurements, or flow measurements, or velocity measurements, or power measurements, or position measurements, or any combination thereof. The airflow control element may be adjusted in response to measurements to respond to measured conditions, to maintain measured parameters within desired ranges, to optimize performance based on measured data, or for other purposes.

In some embodiments, current measurements may comprise conditions that may influence adjustment of an airflow control element. Current measurements may include real-time data from sensors, instruments, or other measurement devices. Current measurements may be obtained continuously, periodically, or on demand. The airflow control element may be adjusted in response to current measurements to respond to the present state of the system and environment as indicated by the measurements.

In some embodiments, power demand may comprise a condition that may influence adjustment of an airflow control element. Power demand may include the current demand for electrical power, the anticipated demand for electrical power, the demand from connected loads, the demand from an electrical grid, or other measures of power demand. Power demand information may be obtained from load measurements, grid signals, demand forecasts, or other sources. The airflow control element may be adjusted in response to power demand to increase power generation when demand is high, to reduce power generation when demand is low, to match power generation to demand, or for other purposes.

In some embodiments, fluid availability may comprise a condition that may influence adjustment of an airflow control element. Fluid availability may include the availability of water, brine, or other fluids for use in heat transfer processes. Fluid availability may be affected by water source levels, pumping capacity, storage levels, water rights, or other factors. The airflow control element may be adjusted in response to fluid availability to match airflow to the available fluid flow rate, to reduce airflow when fluid availability is limited, to increase airflow when fluid availability is abundant, or for other purposes.

In some embodiments, power cost may comprise a condition that may influence adjustment of an airflow control element. Power cost may include the cost of electricity, the value of generated power, electricity market prices, time-of-use rates, or other measures of power cost or value. Power cost information may be obtained from utility rate schedules, electricity market data, grid signals, or other sources. The airflow control element may be adjusted in response to power cost to maximize power generation when power prices are high, to reduce power generation when power prices are low, to optimize the economic value of power generation, or for other purposes.

In some embodiments, economic considerations may comprise conditions that may influence adjustment of an airflow control element. Economic considerations may include one or more or any combination of the following: operating costs, or maintenance costs, or revenue, or profitability, or return on investment, or payback period, or net present value, or any combination thereof. The airflow control element may be adjusted in response to economic considerations to optimize the economic performance of the system, to minimize costs, to maximize revenue, to achieve economic targets, or for other purposes.

In some embodiments, practical considerations may comprise conditions that may influence adjustment of an airflow control element. Practical considerations may include one or more or any combination of the following: equipment limitations, or physical constraints, or safety requirements, or regulatory requirements, or environmental requirements, or any combination thereof. The airflow control element may be adjusted in response to practical considerations to operate within equipment limitations, to comply with safety requirements, to meet regulatory requirements, to satisfy environmental requirements, or for other purposes.

In some embodiments, operational constraints may comprise conditions that may influence adjustment of an airflow control element. Operational constraints may include one or more or any combination of the following: minimum operating levels, or maximum operating levels, or ramp rate limits, or startup constraints, or shutdown constraints, or any combination thereof. The airflow control element may be adjusted in response to operational constraints to operate within the constraints, to avoid violating constraints, to optimize performance subject to constraints, or for other purposes.

In some embodiments, system demands may comprise conditions that may influence adjustment of an airflow control element. System demands may include demands from other components of the system, demands from connected systems, demands from operators, or other demands on the system. The airflow control element may be adjusted in response to system demands to meet the demands, to coordinate with other system components, to balance competing demands, or for other purposes.

In some embodiments, downstream demand may comprise a condition that may influence adjustment of an airflow control element. Downstream demand may include demand for products, services, or outputs produced by the system. Downstream demand may include demand for electrical power, demand for ice, demand for freshwater, demand for captured carbon dioxide, or demand for other products or outputs. The airflow control element may be adjusted in response to downstream demand to match production to demand, to increase production when demand is high, to reduce production when demand is low, or for other purposes.

In some embodiments, product produced may comprise a condition that may influence adjustment of an airflow control element. Product produced may include the quantity, quality, or characteristics of products produced by the system. Products may include electrical power, ice, freshwater, brine, salt, captured carbon dioxide, or other products. The airflow control element may be adjusted in response to product produced to maintain product quality, to achieve production targets, to optimize the mix of products produced, or for other purposes.

In some embodiments, system optimizations may comprise conditions that may influence adjustment of an airflow control element. System optimizations may include optimization algorithms, optimization routines, optimization calculations, or other optimization processes that may determine optimal settings for system components. System optimizations may consider multiple factors including one or more or any combination of the following: power generation, or heat transfer, or ice production, or freshwater production, or carbon dioxide capture, or economic performance, or any combination thereof. The airflow control element may be adjusted in response to system optimizations to implement optimal settings determined by the optimization process.

In some embodiments, a system may include high-resolution temperature mapping. High-resolution temperature mapping may comprise the measurement of temperature at multiple locations throughout the system to create a detailed map or profile of temperature distribution. High-resolution temperature mapping may employ multiple digital temperature sensors, thermal imaging devices, infrared sensors, or other temperature measurement devices. The temperature sensors may be positioned throughout a tower height, across a pool surface, within fluid flow paths, within air flow paths, or at other locations within the system. The temperature measurements may be collected at high spatial resolution, with sensors positioned at close intervals to capture detailed temperature variations.

In some embodiments, high-resolution temperature mapping may employ multiple digital sensors. Digital sensors may comprise temperature sensors that may produce digital output signals, which may be transmitted to a control system for processing. Digital sensors may include one or more or any combination of the following: digital thermometers, or digital thermocouples, or digital resistance temperature detectors, or digital thermistors, or any combination thereof. The digital sensors may be connected to a data acquisition system, a control system, or other data collection equipment through wired connections, wireless connections, or any combination thereof.

In some embodiments, high-resolution temperature mapping may employ thermal imaging. Thermal imaging may comprise the use of infrared cameras, thermal cameras, or other imaging devices that may detect infrared radiation emitted by objects and may produce images representing the temperature distribution across a field of view. Thermal imaging may provide temperature measurements across a large area without requiring individual sensors at each measurement point. Thermal imaging may be employed to measure temperature distribution across a pool surface, across a tower structure, across heat exchange equipment, or across other system components.

In some embodiments, temperature measurements from high-resolution temperature mapping may be logged by a master control system. The master control system may comprise a computer, a programmable logic controller, a distributed control system, or other control equipment configured to receive, store, process, and act upon data from sensors and other data sources. The master control system may log temperature measurements in a database, a data historian, a data file, or other data storage system. The logged temperature data may be used for real-time control, for historical analysis, for trend monitoring, for predictive modeling, or for other purposes.

In some embodiments, data from high-resolution temperature mapping may be used to optimize pump speeds. Pump speeds may affect the flow rate of fluid through the system, which may affect heat transfer rates, freezing rates, and other system characteristics. The master control system may analyze temperature data from high-resolution temperature mapping to determine optimal pump speeds for current conditions. The master control system may adjust pump speeds to maintain desired temperature profiles, to optimize heat transfer, to control freezing rates, or for other purposes.

In some embodiments, data from high-resolution temperature mapping may be used to optimize water-air contacting. Water-air contacting may be affected by spray patterns, spray rates, pool levels, air flow rates, or other factors. The master control system may analyze temperature data from high-resolution temperature mapping to determine optimal settings for water-air contacting equipment. The master control system may adjust spray nozzle operation, pool circulation, air flow control elements, or other equipment to optimize water-air contacting based on the temperature data.

In some embodiments, data from high-resolution temperature mapping may be used to optimize turbine operation. Turbine operation may be affected by air flow velocity, air temperature, air density, or other factors. The master control system may analyze temperature data from high-resolution temperature mapping to determine optimal settings for turbine operation. The master control system may adjust turbine blade pitch, turbine speed, turbine loading, or other turbine parameters to optimize power generation based on the temperature data.

In some embodiments, data from high-resolution temperature mapping may be used to optimize shutters. Shutters may be adjusted to control airflow into, through, or out of the system. The master control system may analyze temperature data from high-resolution temperature mapping to determine optimal shutter positions for current conditions. The master control system may adjust shutter positions to optimize airflow distribution, to respond to temperature variations, to maximize heat transfer, to maximize power generation, or for other purposes. The optimization of shutters based on temperature data may allow the system to respond to spatial variations in temperature and to adjust airflow control elements accordingly.

In some embodiments, the master control system may integrate data from high-resolution temperature mapping with data from other sensors and data sources. Other sensors and data sources may include wind sensors, humidity sensors, pressure sensors, flow sensors, power meters, weather data services, grid signals, or other sources. The master control system may use the integrated data to perform comprehensive system optimization, considering multiple factors and their interactions. The airflow control element may be adjusted based on the comprehensive optimization performed by the master control system.

In some embodiments, adjusting the airflow using an airflow control element may be manual. Manual adjustment may comprise adjustment performed by a human operator through direct physical interaction with the airflow control element or through manual operation of controls that may actuate the airflow control element. Manual adjustment may involve one or more or any combination of the following: turning a handwheel, or moving a lever, or rotating a crank, or pushing or pulling a handle, or operating a manual valve, or repositioning a panel by hand, or any combination thereof. Manual adjustment may be performed by an operator located at the airflow control element, by an operator located at a local control station, or by an operator located at another location within the facility. Manual adjustment may be employed when automated control systems are unavailable, when manual override of automated systems is desired, during maintenance activities, during commissioning, during testing, or for other purposes.

In some embodiments, manual adjustment of an airflow control element may be performed through mechanical linkages. Mechanical linkages may connect a manual control device, such as a handwheel, lever, or crank, to the airflow control element. The mechanical linkages may comprise one or more or any combination of the following: rods, or cables, or chains, or gears, or pulleys, or levers, or cams, or any combination thereof. The mechanical linkages may transmit force or motion from the manual control device to the airflow control element to effect the adjustment. Mechanical linkages may provide direct mechanical connection between the operator and the airflow control element, which may allow the operator to feel the position and resistance of the airflow control element during adjustment.

In some embodiments, manual adjustment of an airflow control element may be performed through manual operation of powered actuators. An operator may manually activate a powered actuator, such as an electric motor, a pneumatic cylinder, or a hydraulic cylinder, to adjust the airflow control element. The manual activation may be performed through one or more or any combination of the following: pressing a button, or flipping a switch, or turning a selector, or operating a joystick, or any combination thereof. The powered actuator may move the airflow control element in response to the manual activation. Manual operation of powered actuators may allow an operator to adjust airflow control elements that may be too large, too heavy, or too remote for direct manual adjustment through mechanical linkages.

In some embodiments, manual adjustment of an airflow control element may provide backup capability when automated systems are unavailable. Automated control systems may become unavailable due to one or more or any combination of the following: power failures, or control system malfunctions, or sensor failures, or communication failures, or software errors, or any combination thereof. Manual adjustment capability may allow continued operation of the system when automated control is unavailable. Manual adjustment may be employed to place airflow control elements in safe positions during emergencies, to maintain minimum operation during control system outages, or to facilitate repairs to automated control systems.

In some embodiments, manual adjustment of an airflow control element may be employed during commissioning or testing. During commissioning, manual adjustment may be employed to verify the operation of airflow control elements, to calibrate position indicators, to set limit switches, or to perform other commissioning activities. During testing, manual adjustment may be employed to evaluate system performance at various airflow control element positions, to verify control system responses, or to perform other testing activities.

In some embodiments, adjusting the airflow using an airflow control element may be automated. Automated adjustment may comprise adjustment performed by a control system without direct human intervention for each adjustment action. Automated adjustment may be performed by one or more or any combination of the following: programmable logic controllers, or distributed control systems, or computer-based control systems, or microcontrollers, or dedicated controllers, or any combination thereof. The control system may receive input from sensors, may process the input according to control algorithms, and may generate output signals to actuators that may adjust the airflow control element. Automated adjustment may allow rapid response to changing conditions, may provide consistent and repeatable adjustments, may reduce operator workload, and may enable optimization of system performance.

In some embodiments, automated adjustment of an airflow control element may be performed in response to sensor inputs. Sensors may measure one or more or any combination of the following: wind direction, or wind velocity, or air temperature, or fluid temperature, or airflow velocity, or pressure, or power output, or any combination thereof. The control system may receive sensor inputs, may compare the sensor inputs to setpoints or targets, and may calculate adjustments to the airflow control element to achieve desired conditions. The control system may generate output signals to actuators that may adjust the airflow control element based on the calculated adjustments.

In some embodiments, automated adjustment of an airflow control element may be performed according to programmed sequences. Programmed sequences may comprise predetermined series of adjustments that may be executed by the control system in response to triggering events or conditions. Programmed sequences may be employed for one or more or any combination of the following: startup procedures, or shutdown procedures, or mode transitions, or emergency responses, or scheduled operations, or any combination thereof. The control system may execute programmed sequences automatically when triggering conditions are detected, which may provide consistent and reliable execution of complex adjustment procedures.

In some embodiments, automated adjustment of an airflow control element may employ feedback control. Feedback control may comprise control methods in which the control system may measure the actual state of the system, may compare the actual state to a desired state, and may adjust the airflow control element to reduce the difference between the actual state and the desired state. Feedback control methods may include one or more or any combination of the following: proportional control, or integral control, or derivative control, or proportional-integral control, or proportional-integral-derivative control, or model predictive control, or adaptive control, or any combination thereof. Feedback control may allow the control system to compensate for disturbances, to correct for errors, and to maintain desired conditions despite changing circumstances.

In some embodiments, automated adjustment of an airflow control element may employ feedforward control. Feedforward control may comprise control methods in which the control system may measure or predict disturbances and may adjust the airflow control element in anticipation of the effects of the disturbances. Feedforward control may be employed in combination with feedback control to provide improved response to disturbances. Feedforward control may be employed to respond to measured changes in wind conditions, to respond to predicted changes in weather, or to respond to other anticipated disturbances.

In some embodiments, automated adjustment of an airflow control element may employ optimization algorithms. Optimization algorithms may comprise computational methods that may search for optimal settings for the airflow control element based on one or more or any combination of the following: performance objectives, or constraints, or cost functions, or any combination thereof. Optimization algorithms may include one or more or any combination of the following: linear programming, or nonlinear programming, or dynamic programming, or genetic algorithms, or particle swarm optimization, or gradient descent methods, or any combination thereof. The control system may execute optimization algorithms to determine optimal positions for airflow control elements and may adjust the airflow control elements to the determined optimal positions.

In some embodiments, automated adjustment of an airflow control element may employ machine learning. Machine learning may comprise computational methods in which the control system may learn from data to improve control performance over time. Machine learning methods may include one or more or any combination of the following: supervised learning, or unsupervised learning, or reinforcement learning, or neural networks, or decision trees, or support vector machines, or any combination thereof. The control system may use machine learning to recognize patterns in sensor data, to predict system behavior, to optimize control strategies, or to adapt to changing conditions.

In some embodiments, adjusting the airflow using an airflow control element may be remotely operated. Remote operation may comprise adjustment performed by an operator located at a distance from the airflow control element. The distance may range from meters to kilometers or more. Remote operation may be performed through one or more or any combination of the following: wired communication links, or wireless communication links, or network connections, or satellite links, or any combination thereof. Remote operation may allow operators to adjust airflow control elements from a central control room, from an off-site location, from a mobile device, or from other remote locations.

In some embodiments, remote operation of an airflow control element may be performed through a supervisory control and data acquisition system. A supervisory control and data acquisition system may comprise a control system architecture that may include remote terminal units at field locations, a master station at a central location, and communication links connecting the remote terminal units to the master station. The remote terminal units may interface with sensors and actuators at the airflow control element, and the master station may provide operator interfaces for monitoring and control. An operator at the master station may issue commands to adjust the airflow control element, and the commands may be transmitted through the communication links to the remote terminal units, which may actuate the airflow control element.

In some embodiments, remote operation of an airflow control element may be performed through a distributed control system. A distributed control system may comprise a control system architecture that may include controllers distributed throughout the facility, operator workstations, and communication networks connecting the controllers and workstations. The distributed controllers may interface with sensors and actuators at the airflow control elements, and the operator workstations may provide operator interfaces for monitoring and control. An operator at a workstation may issue commands to adjust the airflow control element, and the commands may be transmitted through the communication network to the appropriate controller, which may actuate the airflow control element.

In some embodiments, remote operation of an airflow control element may be performed through internet-based systems. Internet-based systems may allow operators to access control systems through web browsers, mobile applications, or other internet-connected interfaces. Internet-based systems may employ one or more or any combination of the following: cloud computing platforms, or web servers, or application programming interfaces, or secure communication protocols, or any combination thereof. Remote operation through internet-based systems may allow operators to adjust airflow control elements from any location with internet connectivity.

In some embodiments, remote operation of an airflow control element may include security measures. Security measures may be employed to prevent unauthorized access to control systems and to protect against cyber threats. Security measures may include one or more or any combination of the following: authentication, or authorization, or encryption, or firewalls, or intrusion detection, or access logging, or any combination thereof. Security measures may ensure that remote operation commands are issued by authorized operators and may protect the integrity of control system communications.

In some embodiments, remote operation of an airflow control element may include verification and confirmation. Verification and confirmation may comprise procedures in which the control system may verify that a remote command has been received correctly and may confirm that the commanded adjustment has been executed. Verification may include one or more or any combination of the following: command acknowledgment, or position feedback, or status reporting, or alarm notification, or any combination thereof. Verification and confirmation may provide assurance to remote operators that their commands have been executed as intended.

In some embodiments, adjusting the airflow using an airflow control element may be reversible. Reversible adjustment may comprise adjustment that may be undone, reversed, or returned to a previous state. An airflow control element that has been adjusted from a first position to a second position may be adjusted back from the second position to the first position. Reversible adjustment may allow the airflow control element to be repositioned as conditions change, as operating requirements change, or as optimization objectives change. Reversible adjustment may be performed manually, automatically, or through remote operation.

In some embodiments, reversible adjustment of an airflow control element may be performed through bidirectional actuators. Bidirectional actuators may comprise actuators that may move the airflow control element in two directions, such as opening and closing, or rotating clockwise and counterclockwise. Bidirectional actuators may include one or more or any combination of the following: reversible electric motors, or double-acting pneumatic cylinders, or double-acting hydraulic cylinders, or bidirectional gear drives, or any combination thereof. Bidirectional actuators may allow the airflow control element to be adjusted in either direction as needed.

In some embodiments, reversible adjustment of an airflow control element may be performed through spring-return mechanisms. Spring-return mechanisms may comprise mechanisms in which a spring or other elastic element may return the airflow control element to a default position when actuating force is removed. Spring-return mechanisms may provide fail-safe operation in which the airflow control element may return to a safe position upon loss of power or loss of control signal. The default position may be a fully open position, a fully closed position, or an intermediate position depending on the configuration of the spring-return mechanism and the safety requirements of the application.

In some embodiments, reversible adjustment of an airflow control element may allow the airflow control element to be cycled between positions. Cycling may comprise repeated adjustment of the airflow control element between two or more positions. Cycling may be performed to respond to changing wind conditions, to respond to changing power demand, to perform testing, to prevent sticking or binding of the airflow control element, or for other purposes. The ability to cycle the airflow control element between positions may be enabled by reversible adjustment capability.

In some embodiments, reversible adjustment of an airflow control element may allow optimization of system performance over time. As conditions change, the optimal position of the airflow control element may change. Reversible adjustment may allow the airflow control element to be repositioned to track the changing optimal position. The control system may continuously or periodically evaluate the optimal position and may adjust the airflow control element accordingly. Reversible adjustment may allow the system to adapt to diurnal variations, seasonal variations, weather variations, or other changes in conditions.

In some embodiments, reversible adjustment of an airflow control element may be performed in principle but may or may not be reversed in practice. An airflow control element may be capable of reversible adjustment, but the adjustment may not be reversed during normal operation. For example, an airflow control element may be adjusted to a position for a particular operating mode and may remain in that position for an extended period without being reversed. The capability for reversible adjustment may provide flexibility for future adjustments even if the adjustment is not reversed in current operation. The decision to reverse an adjustment may depend on one or more or any combination of the following: changing conditions, or changing operating requirements, or maintenance activities, or optimization decisions, or any combination thereof.

In some embodiments, a system may comprise an airflow control element configured for manual adjustment. The system may include manual control devices, mechanical linkages, or manual actuator controls that may allow an operator to manually adjust the airflow control element. The system may be configured to allow manual adjustment as a primary control method, as a backup to automated control, or for specific purposes such as commissioning or testing.

In some embodiments, a system may comprise an airflow control element configured for automated adjustment. The system may include a control system, sensors, actuators, and communication links that may allow automated adjustment of the airflow control element. The control system may be configured to adjust the airflow control element in response to sensor inputs, according to programmed sequences, using feedback control, using feedforward control, using optimization algorithms, using machine learning, or using any combination thereof.

In some embodiments, a system may comprise an airflow control element configured for remote operation. The system may include communication links, remote terminal units, operator interfaces, and security measures that may allow remote operation of the airflow control element. The system may be configured to allow remote operation from a central control room, from an off-site location, from a mobile device, or from other remote locations.

In some embodiments, a system may comprise an airflow control element configured for reversible adjustment. The system may include bidirectional actuators, spring-return mechanisms, or other components that may allow the airflow control element to be adjusted in either direction. The system may be configured to allow the airflow control element to be repositioned as conditions change, to cycle between positions, or to track changing optimal positions.

In some embodiments, adjusting the airflow using an airflow control element may prevent airflow backdraft. Backdraft may comprise a condition in which air flows in a reverse direction through an air conduit, with air exiting through an inlet rather than entering through the inlet, or with air entering through an outlet rather than exiting through the outlet. Backdraft may occur when external wind conditions create pressure differences that may oppose the buoyancy-induced airflow within the air conduit. Backdraft may reduce power generation, may disrupt heat transfer processes, may cause operational problems, or may have other adverse effects on system performance. An airflow control element may be adjusted to prevent backdraft by closing or partially closing airflow control elements on sides of the system where external wind pressure may tend to cause reverse airflow, by opening airflow control elements on sides of the system where external wind pressure may tend to enhance forward airflow, or by any combination thereof.

In some embodiments, adjusting the airflow using an airflow control element may enable power generation to be enhanced by windy conditions. Windy conditions may comprise conditions in which ambient wind is present at velocities sufficient to affect airflow through the system. Wind may represent an energy resource that may be harnessed to supplement the buoyancy-induced airflow within the air conduit. When airflow control elements are adjusted to take advantage of wind, the total airflow through the air conduit may be increased beyond the airflow that would be achieved by buoyancy alone. The increased airflow may result in increased kinetic energy available for power generation, which may enhance power generation or power output. The enhancement of power generation by windy conditions may allow the system to produce more power during windy periods than during calm periods.

In some embodiments, adjusting the airflow using an airflow control element may comprise at least partially opening an airflow control element on a windward side air inlet and at least partially closing an airflow control element on a leeward side air inlet. The windward side may comprise the side of the system that faces into the wind, where wind pressure may be positive relative to ambient pressure. The leeward side may comprise the side of the system that faces away from the wind, where wind pressure may be negative relative to ambient pressure or may be lower than the pressure on the windward side. At least partially opening an airflow control element on the windward side air inlet may allow wind to enter the air conduit through the windward inlet, which may add to the buoyancy-induced airflow and may increase the total airflow through the air conduit. At least partially closing an airflow control element on the leeward side air inlet may prevent air from exiting the air conduit through the leeward inlet, which might otherwise occur due to the lower pressure on the leeward side. The combination of at least partially opening the windward side air inlet and at least partially closing the leeward side air inlet may direct wind energy into the air conduit and may enhance the airflow through the system.

In some embodiments, adjusting the airflow using an airflow control element may comprise at least partially closing an airflow control element on a windward side air outlet and at least partially opening an airflow control element on a leeward side air outlet. At least partially closing an airflow control element on the windward side air outlet may prevent wind from entering the air conduit through the windward outlet, which might otherwise oppose the upward airflow within the air conduit and might cause backdraft or reduced airflow. At least partially opening an airflow control element on the leeward side air outlet may allow air to exit the air conduit through the leeward outlet, where the lower pressure on the leeward side may create a suction effect that may enhance the airflow through the air conduit. The combination of at least partially closing the windward side air outlet and at least partially opening the leeward side air outlet may prevent wind from opposing the airflow at the outlet and may take advantage of the low-pressure region on the leeward side to enhance the airflow through the system.

In some embodiments, adjusting the airflow using an airflow control element may enable wind to enhance power generation or power output. The adjustment of airflow control elements to harness wind energy may increase the airflow velocity through the air conduit, may increase the mass flow rate of air through the air conduit, may increase the kinetic energy of the airflow, or may have any combination of such effects. The increased kinetic energy of the airflow may be converted to electrical or mechanical power through turbines or other power generation equipment positioned within the air conduit. The power generation or power output may be enhanced relative to the power generation or power output that would be achieved without the wind harnessing adjustments. The enhancement may be proportional to the wind velocity, may depend on the wind direction relative to the system orientation, may depend on the configuration of the airflow control elements, or may depend on any combination of such factors.

In some embodiments, adjusting the airflow using an airflow control element may enable wind to enhance airflow velocity through the air conduit. The airflow velocity through the air conduit may be increased when wind energy is harnessed through appropriate adjustment of airflow control elements. The wind may provide an additional driving force for airflow that may supplement the buoyancy-induced driving force. The combination of the buoyancy-induced driving force and the wind-induced driving force may result in a greater total driving force, which may result in a greater airflow velocity through the air conduit. The enhanced airflow velocity may increase the kinetic energy of the airflow, may increase the power available for extraction by turbines, may increase the heat transfer rate in fluid-air s, or may have other beneficial effects on system performance.

In some embodiments, the windward side may be defined by the ambient wind direction. The ambient wind direction may comprise the direction from which the wind is blowing at the location of the system. The ambient wind direction may be measured using wind vanes, anemometers, ultrasonic wind sensors, or other wind direction measurement devices. The windward side may be the side of the system that is oriented toward the direction from which the wind is blowing. As the ambient wind direction changes, the windward side may change correspondingly. An airflow control element that is on the windward side at one time may be on the leeward side at another time if the wind direction changes. The definition of the windward side by the ambient wind direction may allow the system to respond dynamically to changing wind conditions by adjusting which airflow control elements are opened and which are closed based on the current wind direction.

In some embodiments, the leeward side may be defined by the ambient wind direction. The leeward side may be the side of the system that is oriented away from the direction from which the wind is blowing, which may be opposite to the windward side. The leeward side may be the side of the system that is sheltered from the direct impact of the wind. The pressure on the leeward side may be lower than the pressure on the windward side due to the aerodynamic effects of wind flowing around the system. As the ambient wind direction changes, the leeward side may change correspondingly. The definition of the leeward side by the ambient wind direction may allow the system to identify which airflow control elements should be opened at outlets and closed at inlets to take advantage of the low-pressure region on the leeward side.

In some embodiments, a process may comprise adjusting the airflow using an airflow control element, wherein the adjusting comprises at least partially opening an airflow control element on a windward side air inlet and at least partially closing an airflow control element on a leeward side air inlet, and wherein the windward side is defined by the ambient wind direction. The process may further comprise determining the ambient wind direction through measurement or detection, identifying which airflow control elements are on the windward side based on the determined wind direction, and adjusting those airflow control elements to an at least partially open position. The process may further comprise identifying which airflow control elements are on the leeward side based on the determined wind direction, and adjusting those airflow control elements to an at least partially closed position. The process may be performed continuously, periodically, or in response to detected changes in wind direction.

In some embodiments, a process may comprise adjusting the airflow using an airflow control element, wherein the adjusting comprises at least partially closing an airflow control element on a windward side air outlet and at least partially opening an airflow control element on a leeward side air outlet, and wherein the windward side is defined by the ambient wind direction. The process may further comprise determining the ambient wind direction through measurement or detection, identifying which airflow control elements at the outlet are on the windward side based on the determined wind direction, and adjusting those airflow control elements to an at least partially closed position. The process may further comprise identifying which airflow control elements at the outlet are on the leeward side based on the determined wind direction, and adjusting those airflow control elements to an at least partially open position. The process may be performed continuously, periodically, or in response to detected changes in wind direction.

In some embodiments, a process may comprise adjusting the airflow using an airflow control element, wherein the adjusting comprises at least partially opening an airflow control element on a windward side air inlet and at least partially closing an airflow control element on a leeward side air inlet, and wherein the leeward side is defined by the ambient wind direction. The leeward side being defined by the ambient wind direction may mean that the leeward side is determined based on the current direction from which the wind is blowing, with the leeward side being opposite to the windward side. The process may comprise monitoring the ambient wind direction and adjusting the airflow control elements at the inlets based on the monitored wind direction to maintain the configuration of at least partially open airflow control elements on the windward side and at least partially closed airflow control elements on the leeward side.

In some embodiments, a process may comprise adjusting the airflow using an airflow control element, wherein the adjusting comprises at least partially closing an airflow control element on a windward side air outlet and at least partially opening an airflow control element on a leeward side air outlet, and wherein the leeward side is defined by the ambient wind direction. The process may comprise monitoring the ambient wind direction and adjusting the airflow control elements at the outlets based on the monitored wind direction to maintain the configuration of at least partially closed airflow control elements on the windward side and at least partially open airflow control elements on the leeward side.

In some embodiments, a system may comprise an airflow control element configured to prevent airflow backdraft. The system may include sensors for detecting conditions that may indicate backdraft or conditions that may lead to backdraft, and the system may include a control system configured to adjust the airflow control element in response to such conditions. The airflow control element may be adjusted to close or partially close when backdraft conditions are detected or anticipated, which may prevent or reduce reverse airflow through the system.

In some embodiments, a system may comprise an airflow control element configured to enable power generation to be enhanced by windy conditions. The system may include wind sensors for measuring wind direction and wind velocity, and the system may include a control system configured to adjust the airflow control element based on the measured wind conditions. The airflow control element may be adjusted to harness wind energy when wind is present, which may enhance the airflow through the system and may increase power generation.

In some embodiments, a system may comprise an airflow control element configured such that adjusting the airflow control element comprises at least partially opening an airflow control element on a windward side air inlet and at least partially closing an airflow control element on a leeward side air inlet. The system may include multiple airflow control elements positioned at air inlets around the perimeter of the system, and the system may include a control system configured to selectively open and close the airflow control elements based on the wind direction. The control system may determine which airflow control elements are on the windward side and which are on the leeward side based on wind direction measurements, and the control system may adjust the airflow control elements accordingly.

In some embodiments, a system may comprise an airflow control element configured such that adjusting the airflow control element comprises at least partially closing an airflow control element on a windward side air outlet and at least partially opening an airflow control element on a leeward side air outlet. The system may include multiple airflow control elements positioned at air outlets around the perimeter of the system, and the system may include a control system configured to selectively open and close the airflow control elements based on the wind direction. The control system may determine which airflow control elements are on the windward side and which are on the leeward side based on wind direction measurements, and the control system may adjust the airflow control elements accordingly.

In some embodiments, a system may comprise an airflow control element configured to enable wind to enhance system power generation or power output. The system may be configured to operate in a wind harnessing mode when wind is present and in a buoyancy-only mode when wind is absent or minimal. In the wind harnessing mode, the airflow control elements may be adjusted to take advantage of wind energy as described herein. In the buoyancy-only mode, the airflow control elements may be adjusted to allow airflow from all directions or may be adjusted to other configurations suitable for operation without wind harnessing.

In some embodiments, a system may comprise an airflow control element configured to enable wind to enhance airflow velocity through the air conduit. The system may include airflow velocity sensors positioned within the air conduit, and the system may include a control system configured to adjust the airflow control elements to maximize airflow velocity. The control system may adjust the airflow control elements based on wind direction and wind velocity measurements to achieve enhanced airflow velocity through the air conduit.

In some embodiments, a system may comprise an airflow control element wherein the windward side is defined by the ambient wind direction. The system may include wind direction sensors configured to measure the ambient wind direction, and the system may include a control system configured to determine which side of the system is the windward side based on the measured wind direction. The control system may update the determination of the windward side as the ambient wind direction changes, and the control system may adjust the airflow control elements based on the updated determination.

In some embodiments, a system may comprise an airflow control element wherein the leeward side is defined by the ambient wind direction. The system may include wind direction sensors configured to measure the ambient wind direction, and the system may include a control system configured to determine which side of the system is the leeward side based on the measured wind direction. The leeward side may be determined as the side opposite to the windward side. The control system may update the determination of the leeward side as the ambient wind direction changes, and the control system may adjust the airflow control elements based on the updated determination.

In some embodiments, the adjustment of airflow control elements for wind harnessing may be performed in combination with adjustment of airflow control elements at both inlets and outlets. At the inlets, airflow control elements on the windward side may be at least partially opened and airflow control elements on the leeward side may be at least partially closed. At the outlets, airflow control elements on the windward side may be at least partially closed and airflow control elements on the leeward side may be at least partially opened. The combined adjustment at both inlets and outlets may maximize the wind harnessing effect by allowing wind to enter through the windward inlet, preventing wind from opposing the airflow at the windward outlet, and taking advantage of the low-pressure region on the leeward side at the outlet.

In some embodiments, the degree of opening or closing of airflow control elements may be varied based on wind velocity. At higher wind velocities, the airflow control elements on the windward side inlet may be opened to a greater degree to capture more wind energy. At lower wind velocities, the airflow control elements may be adjusted to intermediate positions or may be adjusted to positions suitable for buoyancy-only operation. The control system may continuously or periodically adjust the degree of opening or closing of the airflow control elements based on measured wind velocity to optimize system performance under varying wind conditions.

In some embodiments, the response time for adjusting airflow control elements in response to changes in wind direction may be configured based on the characteristics of the wind at the system location. In locations where wind direction changes frequently, the control system may be configured to respond quickly to wind direction changes to maintain optimal positioning of the airflow control elements. In locations where wind direction is relatively stable, the control system may be configured to respond less frequently to reduce wear on the airflow control elements and actuators. The response time may be configurable based on site-specific conditions and operational preferences.

In some embodiments, the adjustment of airflow control elements for wind harnessing may be coordinated with other system operations. The adjustment of airflow control elements may be coordinated with the operation of turbines, with the operation of fluid-air s, with the operation of pumps, or with other system components. The coordination may ensure that the enhanced airflow resulting from wind harnessing is effectively utilized for power generation, heat transfer, or other system functions. The control system may manage the coordination of airflow control element adjustment with other system operations to optimize overall system performance.

In some embodiments, adjusting the airflow using an airflow control element may enhance airflow velocity. Airflow velocity may be enhanced through adjustment of airflow control elements by reducing flow resistance, by directing airflow along more efficient flow paths, by preventing flow disturbances, by harnessing external wind energy, or by any combination thereof. When airflow control elements are adjusted to reduce obstructions in the flow path, the airflow may encounter less resistance and may achieve higher velocities for a given buoyancy-induced pressure difference. When airflow control elements are adjusted to direct airflow along streamlined paths, energy losses due to turbulence, separation, or recirculation may be reduced, which may allow more of the available pressure difference to be converted to airflow velocity. The enhancement of airflow velocity through adjustment of airflow control elements may increase the kinetic energy of the airflow, may increase the power available for extraction by turbines, and may improve overall system performance.

In some embodiments, adjusting the airflow using an airflow control element may enhance airflow kinetic energy. Airflow kinetic energy may be proportional to the mass flow rate of air multiplied by the square of the airflow velocity. Enhancement of airflow kinetic energy may be achieved by increasing the airflow velocity, by increasing the mass flow rate of air, or by any combination thereof. Adjustment of airflow control elements may enhance airflow kinetic energy by reducing flow losses that would otherwise dissipate kinetic energy, by directing airflow to regions where kinetic energy may be more effectively captured by turbines, by harnessing wind energy to add kinetic energy to the airflow, or by any combination thereof. The enhancement of airflow kinetic energy through adjustment of airflow control elements may directly increase the power available for extraction by power generation equipment positioned within the air conduit.

In some embodiments, adjusting the airflow using an airflow control element may enhance airflow characteristics. Airflow characteristics may include one or more or any combination of the following: velocity profile, or velocity distribution, or flow direction, or flow uniformity, or turbulence intensity, or pressure distribution, or temperature distribution, or any combination thereof. Enhancement of airflow characteristics may comprise improving the airflow characteristics to achieve desired performance objectives. Adjustment of airflow control elements may enhance airflow characteristics by directing airflow to achieve more uniform velocity distributions, by reducing regions of flow separation or recirculation, by controlling turbulence levels, by aligning flow direction with turbine inlet requirements, or by any combination thereof. Enhanced airflow characteristics may improve the efficiency of power generation equipment, may improve heat transfer in fluid-air contactors, may reduce wear on system components, or may provide other benefits.

In some embodiments, adjusting the airflow using an airflow control element may enhance airflow conformity. Airflow conformity may comprise the degree to which the airflow conforms to desired flow patterns, flow directions, flow velocities, or other flow specifications. Enhancement of airflow conformity may comprise adjusting the airflow to more closely match desired specifications. Adjustment of airflow control elements may enhance airflow conformity by directing airflow along intended flow paths, by preventing deviations from intended flow patterns, by correcting for disturbances that may cause non-conforming flow, or by any combination thereof. Enhanced airflow conformity may improve the predictability of system performance, may improve the efficiency of power generation equipment that may be designed for specific inlet flow conditions, and may facilitate control and optimization of system operation.

In some embodiments, adjusting the airflow using an airflow control element may enhance airflow continuity. Airflow continuity may comprise the maintenance of consistent, uninterrupted airflow through the system over time. Enhancement of airflow continuity may comprise reducing variations, interruptions, or fluctuations in the airflow. Adjustment of airflow control elements may enhance airflow continuity by preventing backdraft conditions that may interrupt forward airflow, by compensating for variations in external wind conditions, by maintaining consistent flow resistance as conditions change, or by any combination thereof. Enhanced airflow continuity may provide more stable power generation, may reduce stress on system components due to flow fluctuations, and may improve the reliability of system operation.

In some embodiments, adjusting the airflow using an airflow control element may enhance power generation or power output. Power generation or power output may be enhanced through adjustment of airflow control elements by increasing the kinetic energy of the airflow available for extraction by turbines, by directing airflow more effectively to turbines, by reducing losses that would otherwise reduce the power available for extraction, by harnessing wind energy to supplement buoyancy-induced airflow, or by any combination thereof. The enhancement of power generation or power output through adjustment of airflow control elements may increase the total electrical or mechanical power produced by the system, may increase the efficiency of power generation, may increase the capacity factor of power generation equipment, or may provide any combination of such benefits.

In some embodiments, a system may comprise an airflow control element configured such that adjusting the airflow control element enhances airflow velocity. The system may include airflow control elements positioned and configured to reduce flow resistance when adjusted to open positions, to direct airflow along efficient flow paths, to prevent flow disturbances, or to achieve any combination of such effects. The system may include a control system configured to adjust the airflow control elements to positions that enhance airflow velocity based on current conditions.

In some embodiments, a system may comprise an airflow control element configured such that adjusting the airflow control element enhances airflow kinetic energy. The system may include airflow control elements positioned and configured to increase the kinetic energy of the airflow when adjusted. The system may include sensors for measuring airflow velocity or other parameters related to kinetic energy, and the system may include a control system configured to adjust the airflow control elements to maximize airflow kinetic energy.

In some embodiments, a system may comprise an airflow control element configured such that adjusting the airflow control element enhances airflow characteristics. The system may include airflow control elements positioned and configured to improve velocity distribution, to reduce turbulence, to align flow direction, or to achieve other improvements in airflow characteristics when adjusted. The system may include sensors for measuring airflow characteristics, and the system may include a control system configured to adjust the airflow control elements to achieve desired airflow characteristics.

In some embodiments, a system may comprise an airflow control element configured such that adjusting the airflow control element enhances airflow conformity. The system may include airflow control elements positioned and configured to direct airflow along intended flow paths and to prevent deviations from intended flow patterns. The system may include sensors for detecting non-conforming flow conditions, and the system may include a control system configured to adjust the airflow control elements to correct non-conforming flow and to maintain airflow conformity.

In some embodiments, a system may comprise an airflow control element configured such that adjusting the airflow control element enhances airflow continuity. The system may include airflow control elements positioned and configured to prevent interruptions in airflow, to compensate for variations in external conditions, and to maintain consistent airflow over time. The system may include sensors for detecting variations or interruptions in airflow, and the system may include a control system configured to adjust the airflow control elements to maintain airflow continuity.

In some embodiments, a system may comprise an airflow control element configured such that adjusting the airflow control element enhances system power generation or power output. The system may include airflow control elements positioned and configured to maximize the power available for extraction by turbines or other power generation equipment. The system may include power meters or other sensors for measuring power generation or power output, and the system may include a control system configured to adjust the airflow control elements to maximize power generation or power output.

In some embodiments, a tower or air conduit may include internal baffles. Internal baffles may comprise plates, panels, or other structures positioned within the interior of the tower or air conduit to influence airflow patterns. Internal baffles may be configured to redirect airflow, to promote mixing, to reduce flow separation, to distribute airflow across the cross-section of the tower, or to achieve any combination of such effects. Internal baffles may be fixed in position, or internal baffles may be adjustable to allow the configuration to be changed based on operating conditions. The positioning, size, shape, and orientation of internal baffles may be configured to achieve desired airflow characteristics within the tower or air conduit.

In some embodiments, a tower or air conduit may include swirlers. Swirlers may comprise structures configured to impart a rotational or swirling motion to the airflow within the tower or air conduit. Swirlers may include angled vanes, helical elements, tangential inlets, or other configurations that may cause the airflow to rotate about the axis of the tower or air conduit. The swirling motion imparted by swirlers may improve turbulence and mixing within the airflow, may enhance heat transfer between the air and fluids in fluid-air s, may improve the distribution of airflow across the cross-section of the tower, or may achieve any combination of such effects. Swirlers may be positioned at various locations within the tower or air conduit, including near inlets, near fluid-air s, or at other locations where enhanced mixing may be beneficial.

In some embodiments, a tower or air conduit may include guide vanes. Guide vanes may comprise vanes, blades, or other structures configured to direct or guide the airflow within the tower or air conduit. Guide vanes may be positioned to direct airflow toward specific regions, to align airflow with turbine inlets, to reduce flow separation at bends or transitions, to distribute airflow uniformly across the cross-section of the tower, or to achieve any combination of such effects. Guide vanes may be fixed in position, or guide vanes may be adjustable to allow the direction of airflow guidance to be changed based on operating conditions. The angle, spacing, and configuration of guide vanes may be selected to achieve desired airflow characteristics.

In some embodiments, internal baffles, swirlers, or guide vanes may improve turbulence and mixing within the tower or air conduit. Improved turbulence and mixing may enhance heat transfer between the airflow and fluids in fluid-air contactors by increasing the convective heat transfer coefficient. Improved turbulence and mixing may promote more uniform temperature distribution within the airflow, may prevent stratification of warmer and cooler air, and may ensure that all portions of the airflow participate effectively in heat transfer. The improvement of turbulence and mixing through internal baffles, swirlers, or guide vanes may enhance the overall efficiency of heat transfer from fluids to air within the system.

In some embodiments, a tower or air conduit may include segmented air injection at different heights. Segmented air injection may comprise the introduction of air into the tower or air conduit at multiple locations along the height of the tower or air conduit. Air may be injected through ports, nozzles, ducts, or other openings positioned at different elevations within the tower or air conduit. Segmented air injection may enhance convection near a water surface or other fluid-air contact region by providing additional airflow in regions where enhanced convection may be beneficial. Segmented air injection may allow the airflow rate and distribution to be controlled at different heights within the tower, which may allow optimization of heat transfer and airflow characteristics throughout the tower.

In some embodiments, segmented air injection at different heights may enhance convection near a water surface. A water surface may comprise the surface of a pool, basin, or other body of water within or adjacent to the tower or air conduit where heat transfer from water to air may occur. Enhanced convection near the water surface may increase the rate of heat transfer from the water to the air, may increase the rate of evaporation or freezing at the water surface, and may improve the overall efficiency of the heat transfer process. Segmented air injection may provide fresh, cooler air near the water surface, which may maintain a greater temperature difference between the air and the water and may sustain higher heat transfer rates.

In some embodiments, the combination of internal baffles, swirlers, guide vanes, and segmented air injection may be employed to optimize airflow characteristics within a tower or air conduit. The combination of such features may provide comprehensive control over airflow patterns, turbulence levels, mixing, and distribution within the tower or air conduit. The specific combination and configuration of such features may be selected based on the geometry of the tower, the locations of fluid-air s, the locations of turbines, the desired airflow characteristics, or any combination of such factors.

In some embodiments, methods for reducing airflow interference may be employed to enhance airflow characteristics. Airflow interference may comprise interactions between different portions of the airflow, between the airflow and system components, or between the airflow and external conditions that may degrade airflow characteristics. Methods for reducing airflow interference may include one or more or any combination of the following: streamlining system components to reduce flow disturbances, positioning components to minimize wake effects, using flow straighteners to reduce turbulence from upstream disturbances, using screens or grids to break up large-scale turbulent structures, adjusting airflow control elements to prevent cross-flows or recirculation, or any combination thereof. Reducing airflow interference may improve airflow velocity, airflow kinetic energy, airflow characteristics, airflow conformity, airflow continuity, and power generation or power output.

In some embodiments, methods for maintaining consistent flow may be employed to enhance airflow continuity. Maintaining consistent flow may comprise controlling the airflow to reduce variations over time, to prevent interruptions, and to provide stable airflow characteristics. Methods for maintaining consistent flow may include one or more or any combination of the following: using feedback control to adjust airflow control elements in response to detected variations, using feedforward control to anticipate and compensate for expected disturbances, using flow damping devices to reduce flow oscillations, using buffer volumes to smooth flow variations, adjusting airflow control elements to compensate for changes in external wind conditions, or any combination thereof. Maintaining consistent flow may improve the stability of power generation, may reduce stress on system components, and may improve the reliability of system operation.

In some embodiments, a process may comprise transferring heat from a fluid to air, wherein transferring heat from a fluid to air comprises transferring heat in a first thermal exchange zone and a second thermal exchange zone. The first thermal exchange zone and the second thermal exchange zone may be configured to transfer heat from different fluids to air, may be configured to produce different products, may be positioned at different locations within a system, or may have any combination of such characteristics. The use of multiple thermal exchange zones may allow the system to process multiple fluid streams, to achieve staged heat transfer, to produce multiple products, or to achieve other operational objectives.

In some embodiments, the first thermal exchange zone may comprise an air and fluid contactor. The air and fluid contactor of the first thermal exchange zone may be configured to bring air into contact with a fluid to facilitate heat transfer from the fluid to the air. The air and fluid contactor may comprise one or more or any combination of the following: spray systems, or pool systems, or basin systems, or film systems, or curtain systems, or packed bed systems, or tray systems, or any combination thereof. The configuration of the air and fluid contactor in the first thermal exchange zone may be selected based on the characteristics of the fluid to be contacted, the desired heat transfer rate, the desired products, or other factors.

In some embodiments, a fluid comprising a brine may be contacted with air in the first thermal exchange zone. Brine may comprise a solution of water and dissolved salts, wherein the concentration of dissolved salts may be greater than the concentration of dissolved salts in seawater. Brine may have a salt concentration greater than approximately 35,000 milligrams per liter, or greater than approximately 50,000 milligrams per liter, or greater than approximately 100,000 milligrams per liter, or greater than approximately 150,000 milligrams per liter, or greater than approximately 200,000 milligrams per liter, or any combination thereof. The dissolved salts in the brine may comprise one or more or any combination of the following: sodium chloride, or magnesium chloride, or calcium chloride, or potassium chloride, or sodium sulfate, or magnesium sulfate, or calcium sulfate, or other mineral salts, or any combination thereof.

In some embodiments, contacting a fluid comprising a brine with air in the first thermal exchange zone may produce a portion of a solid comprising ice. When brine is contacted with air at a temperature below the freezing point of the brine, heat may be transferred from the brine to the air, and at least a portion of the water in the brine may freeze to form ice. The ice formed from brine may have a lower salt content than the original brine because dissolved salts may be excluded from the ice crystal structure during freezing. The ice produced in the first thermal exchange zone may be separated from the remaining brine and may be employed for various purposes including freshwater production, thermal storage, water storage, or other applications.

In some embodiments, contacting a fluid comprising a brine with air in the first thermal exchange zone may produce a portion of a solid comprising a salt. When brine is cooled through contact with cold air, the solubility of certain salts in the brine may decrease, and salts may precipitate or crystallize out of solution. The precipitation or crystallization of salts may occur when the brine becomes supersaturated with respect to one or more salt species. Salts that may precipitate or crystallize from brine upon cooling may include one or more or any combination of the following: sodium chloride, or sodium sulfate decahydrate, or magnesium sulfate heptahydrate, or calcium sulfate dihydrate, or other salt hydrates, or anhydrous salts, or any combination thereof. The salt produced in the first thermal exchange zone may be separated from the remaining brine and may be employed for various purposes including chemical feedstocks, de-icing applications, food processing, or other applications.

In some embodiments, contacting a fluid comprising a brine with air in the first thermal exchange zone may produce a liquid comprising a brine. The brine produced in the first thermal exchange zone may have a different composition than the brine that entered the first thermal exchange zone. When ice is formed from the brine, the remaining liquid may have a higher salt concentration than the original brine because water has been removed as ice while salts remain in solution. When salts precipitate from the brine, the remaining liquid may have a lower concentration of the precipitated salt species. The brine produced in the first thermal exchange zone may be further processed, may be recirculated, may be discharged, or may be employed for other purposes.

In some embodiments, contacting a fluid comprising a brine with air in the first thermal exchange zone may produce any combination of a solid comprising ice, a solid comprising a salt, and a liquid comprising a brine. The relative amounts of ice, salt, and brine produced may depend on the composition of the incoming brine, the temperature of the air, the contact time between the brine and the air, the heat transfer rate, or other factors. The operating conditions of the first thermal exchange zone may be controlled to achieve desired proportions of ice, salt, and brine production.

In some embodiments, the second thermal exchange zone may comprise an air and fluid contactor. The air and fluid contactor of the second thermal exchange zone may be configured to bring air into contact with a fluid to facilitate heat transfer from the fluid to the air. The air and fluid contactor of the second thermal exchange zone may be similar in configuration to the air and fluid contactor of the first thermal exchange zone, or the air and fluid contactor of the second thermal exchange zone may have a different configuration. The configuration of the air and fluid contactor in the second thermal exchange zone may be selected based on the characteristics of the fluid to be contacted, the desired heat transfer rate, the desired products, or other factors.

In some embodiments, a fluid comprising water may be contacted with air in the second thermal exchange zone. Water may comprise freshwater, brackish water, seawater, or other water with varying concentrations of dissolved solids. The water contacted with air in the second thermal exchange zone may have a lower concentration of dissolved solids than the brine contacted with air in the first thermal exchange zone. The water may be obtained from various sources including one or more or any combination of the following: bodies of water, or water supply systems, or process water systems, or recirculated water systems, or any combination thereof.

In some embodiments, a fluid comprising freshwater may be contacted with air in the second thermal exchange zone. Freshwater may comprise water with a total dissolved solids content of less than approximately 1,000 milligrams per liter. Freshwater may be obtained from one or more or any combination of the following: lakes, or rivers, or streams, or aquifers, or reservoirs, or municipal water supplies, or any combination thereof. When freshwater is contacted with air at a temperature below the freezing point of freshwater, heat may be transferred from the freshwater to the air, and at least a portion of the freshwater may freeze to form ice. The ice formed from freshwater may be relatively pure and may be employed for freshwater storage, thermal storage, or other applications.

In some embodiments, a fluid comprising brackish water may be contacted with air in the second thermal exchange zone. Brackish water may comprise water with a total dissolved solids content of approximately 1,000 milligrams per liter to approximately 10,000 milligrams per liter. Brackish water may be obtained from one or more or any combination of the following: estuaries, or coastal aquifers, or certain rivers, or industrial processes, or any combination thereof. When brackish water is contacted with air at a temperature below the freezing point of the brackish water, heat may be transferred from the brackish water to the air, and at least a portion of the brackish water may freeze to form ice. The ice formed from brackish water may have a lower salt content than the original brackish water.

In some embodiments, a fluid comprising seawater may be contacted with air in the second thermal exchange zone. Seawater may comprise water with a total dissolved solids content of approximately 35,000 milligrams per liter. Seawater may be obtained from one or more or any combination of the following: oceans, or seas, or coastal waters, or any combination thereof. When seawater is contacted with air at a temperature below the freezing point of seawater, heat may be transferred from the seawater to the air, and at least a portion of the seawater may freeze to form ice. The ice formed from seawater may have a lower salt content than the original seawater, and the remaining liquid may have a higher salt content than the original seawater.

In some embodiments, a fluid comprising a liquid may be contacted with air in the second thermal exchange zone. The liquid may comprise water, or the liquid may comprise other liquids or liquid mixtures. The liquid contacted with air in the second thermal exchange zone may have different characteristics than the brine contacted with air in the first thermal exchange zone. The liquid may have a higher freezing point than the brine, may have a lower concentration of dissolved solids than the brine, may have different thermal properties than the brine, or may have any combination of such different characteristics.

In some embodiments, at least a portion of the air may contact the first thermal exchange zone before contacting the second thermal exchange zone. The sequential contacting of air with the first thermal exchange zone and then the second thermal exchange zone may allow staged heat transfer, may allow the air to be progressively warmed, may allow different products to be produced in each thermal exchange zone, or may provide any combination of such benefits. When air contacts the first thermal exchange zone before contacting the second thermal exchange zone, the air may be warmed in the first thermal exchange zone through heat transfer from the brine, and the warmed air may then contact the second thermal exchange zone where additional heat may be transferred from the water, freshwater, brackish water, seawater, or other liquid to the air.

In some embodiments, the sequential contacting of air with the first thermal exchange zone before the second thermal exchange zone may be achieved through the physical arrangement of the thermal exchange zones within the system. The first thermal exchange zone may be positioned upstream of the second thermal exchange zone in the direction of airflow, such that air flowing through the system may encounter the first thermal exchange zone before encountering the second thermal exchange zone. The first thermal exchange zone may be positioned at a lower elevation than the second thermal exchange zone, may be positioned closer to an air inlet than the second thermal exchange zone, or may be positioned in other configurations that may result in air contacting the first thermal exchange zone before the second thermal exchange zone.

In some embodiments, the sequential contacting of air with the first thermal exchange zone before the second thermal exchange zone may allow the coldest air to contact the brine in the first thermal exchange zone. Brine may have a lower freezing point than freshwater, brackish water, or seawater due to the freezing point depression caused by the higher concentration of dissolved salts. The lower freezing point of brine may allow heat transfer and freezing to occur at lower temperatures than would be possible with freshwater, brackish water, or seawater. By contacting the coldest air with the brine in the first thermal exchange zone, the system may take advantage of the lower freezing point of brine to achieve heat transfer and freezing at the lowest available temperatures.

In some embodiments, the air may be partially warmed after contacting the first thermal exchange zone, and the partially warmed air may then contact the second thermal exchange zone. The partially warmed air may still be at a temperature below the freezing point of the water, freshwater, brackish water, or seawater in the second thermal exchange zone, which may allow heat transfer and freezing to occur in the second thermal exchange zone. The temperature of the air after contacting the first thermal exchange zone may depend on the heat transfer rate in the first thermal exchange zone, the mass flow rate of air, the temperature of the brine, or other factors.

In some embodiments, the sequential contacting of air with the first thermal exchange zone before the second thermal exchange zone may allow the production of different products in each thermal exchange zone. The first thermal exchange zone may produce ice from brine, salt from brine, concentrated brine, or any combination thereof. The second thermal exchange zone may produce ice from water, freshwater, brackish water, or seawater. The products from each thermal exchange zone may be collected, processed, and employed separately, or the products may be combined for further processing.

In some embodiments, the sequential contacting of air with the first thermal exchange zone before the second thermal exchange zone may be employed in freeze desalination processes. Freeze desalination may involve the freezing of saline water to produce ice with reduced salt content, followed by separation of the ice from the remaining brine, and melting of the ice to produce freshwater. In a system with sequential thermal exchange zones, seawater may be contacted with air in the second thermal exchange zone to produce ice and brine, and the brine produced in the second thermal exchange zone may be further concentrated in the first thermal exchange zone where the coldest air may be available. The sequential processing may allow progressive concentration of the brine and progressive production of ice with reduced salt content.

In some embodiments, the first thermal exchange zone and the second thermal exchange zone may be physically separated within the system. The physical separation may allow independent control of operating conditions in each thermal exchange zone, may allow different fluid handling systems for each thermal exchange zone, may allow different product collection systems for each thermal exchange zone, or may provide any combination of such benefits. The physical separation may be achieved through partitions, walls, separate chambers, separate pools or basins, or other structural elements that may define distinct regions for each thermal exchange zone.

In some embodiments, the first thermal exchange zone and the second thermal exchange zone may be integrated within a common structure. The integration may allow efficient use of space, may allow shared airflow paths, may allow heat transfer between the thermal exchange zones, or may provide any combination of such benefits. The integration may be achieved through positioning the thermal exchange zones in adjacent regions of a common chamber, through positioning the thermal exchange zones at different elevations within a common tower or conduit, or through other configurations that may allow the thermal exchange zones to share common structural elements while maintaining distinct fluid handling and product collection systems.

In some embodiments, the airflow path through the first thermal exchange zone and the second thermal exchange zone may be configured to achieve desired heat transfer characteristics. The airflow path may be configured to provide adequate residence time for heat transfer in each thermal exchange zone, to provide adequate contact area between the air and the fluids in each thermal exchange zone, to minimize pressure losses along the airflow path, or to achieve any combination of such objectives. The airflow path may include transitions, ducts, channels, or other flow guidance elements that may direct the air from the first thermal exchange zone to the second thermal exchange zone.

In some embodiments, the fluid flow paths for the brine in the first thermal exchange zone and for the water, freshwater, brackish water, seawater, or other liquid in the second thermal exchange zone may be configured independently. The independent configuration of fluid flow paths may allow different flow rates, different spray patterns, different pool configurations, or other different characteristics for each thermal exchange zone. The independent configuration may allow optimization of each thermal exchange zone for the specific fluid being processed and the specific products being produced.

In some embodiments, the products from the first thermal exchange zone and the second thermal exchange zone may be collected and processed separately. Ice produced in the first thermal exchange zone from brine may be collected and processed separately from ice produced in the second thermal exchange zone from water, freshwater, brackish water, or seawater. The separate collection and processing may allow the products to be employed for different purposes, may allow different quality specifications to be achieved for each product stream, or may provide other benefits. Salt produced in the first thermal exchange zone may be collected and processed separately from ice and brine products.

In some embodiments, the products from the first thermal exchange zone and the second thermal exchange zone may be combined for further processing. Ice produced in the first thermal exchange zone and ice produced in the second thermal exchange zone may be combined and processed together. The combined ice may be melted to produce freshwater, may be stored for thermal storage, may be employed for other purposes, or may undergo any combination of such processing. Brine produced in the first thermal exchange zone may be combined with brine produced in the second thermal exchange zone for further concentration or for discharge.

In some embodiments, a system may comprise a first thermal exchange zone and a second thermal exchange zone. The first thermal exchange zone may comprise an air and fluid contactor configured to contact a fluid comprising a brine with air to produce a portion of a solid comprising ice, or a solid comprising a salt, or a liquid comprising a brine, or any combination thereof. The second thermal exchange zone may comprise an air and fluid contactor configured to contact a fluid comprising water, or freshwater, or brackish water, or seawater with air. The system may be configured such that at least a portion of the air contacts the first thermal exchange zone before contacting the second thermal exchange zone.

In some embodiments, a system may comprise a first thermal exchange zone and a second thermal exchange zone, wherein the first thermal exchange zone comprises an air and fluid contactor configured to contact a fluid comprising a brine with air to produce a portion of a solid comprising ice, or a solid comprising a salt, or a liquid comprising a brine, or any combination thereof, and wherein the second thermal exchange zone comprises an air and fluid contactor configured to contact a fluid comprising a liquid with air. The liquid in the second thermal exchange zone may comprise water, or freshwater, or brackish water, or seawater, or other liquids, or any combination thereof.

In some embodiments, the operating conditions of the first thermal exchange zone and the second thermal exchange zone may be controlled to achieve desired production rates and product qualities. Operating conditions that may be controlled may include one or more or any combination of the following: fluid flow rates, or fluid temperatures, or air flow rates, or air temperatures, or contact times, or spray patterns, or pool levels, or any combination thereof. The control of operating conditions may be performed manually, automatically, or through remote operation, and the control may be based on measurements, predictions, optimization algorithms, or any combination thereof.

In some embodiments, the first thermal exchange zone may be configured to operate with brine at various concentrations. The brine concentration may affect the freezing point of the brine, the products produced, the heat transfer characteristics, or other aspects of operation. The first thermal exchange zone may be configured to receive brine from various sources including one or more or any combination of the following: seawater concentration processes, or industrial processes, or desalination reject streams, or natural brine sources, or recirculated brine from the system, or any combination thereof.

In some embodiments, the second thermal exchange zone may be configured to operate with water, freshwater, brackish water, or seawater from various sources. The source of the fluid for the second thermal exchange zone may affect the composition of the fluid, the freezing point of the fluid, the products produced, or other aspects of operation. The second thermal exchange zone may be configured to receive fluid from one or more or any combination of the following: bodies of water, or water supply systems, or process water systems, or recirculated water systems, or any combination thereof.

In some embodiments, the heat released during freezing in the first thermal exchange zone and the second thermal exchange zone may contribute to warming the air and inducing upward airflow within an air conduit. The latent heat released during freezing of water in the brine in the first thermal exchange zone and the latent heat released during freezing of water, freshwater, brackish water, or seawater in the second thermal exchange zone may both contribute to the total heat transfer from fluids to air. The combined heat transfer from both thermal exchange zones may provide a greater total heat transfer than would be achieved with a single thermal exchange zone, which may result in greater air warming, greater buoyancy-induced airflow, and greater potential for power generation.

In some embodiments, the configuration of the first thermal exchange zone and the second thermal exchange zone may be optimized for specific applications. For freeze desalination applications, the configuration may be optimized to maximize freshwater production and to minimize energy consumption. For power generation applications, the configuration may be optimized to maximize heat transfer to air and to maximize airflow kinetic energy. For combined applications, the configuration may be optimized to balance multiple objectives including freshwater production, power generation, salt production, or other objectives.

In some embodiments, water-air contacting may employ spraying systems to disperse water into an airflow for heat transfer. Spraying systems may create water droplets that may be contacted with air, and the dispersion of water into droplets may increase the surface area available for heat transfer between the water and the air. Spraying systems may include one or more or any combination of the following: nozzle sprayers, or rotary sprayers, or air-assisted sprayers, or any combination thereof. The selection of spraying system type may depend on the desired droplet size, the desired spray pattern, the water flow rate, the air flow rate, the available pressure, the available power, or any combination of such factors.

In some embodiments, nozzle sprayers may be employed for water-air contacting. Nozzle sprayers may comprise devices that may force water through an orifice or opening to create a spray of water droplets. Nozzle sprayers may include one or more or any combination of the following types: pressure nozzles, or hydraulic nozzles, or swirl nozzles, or impingement nozzles, or fan nozzles, or cone nozzles, or flat spray nozzles, or full cone nozzles, or hollow cone nozzles, or any combination thereof. Pressure nozzles may create droplets by forcing water through an orifice at elevated pressure, and the droplet size may be related to the orifice size, the water pressure, the water flow rate, or any combination thereof. Swirl nozzles may impart a rotational motion to the water before the water exits the orifice, which may create a conical spray pattern. Impingement nozzles may direct water streams against a surface or against each other to break the water into droplets.

In some embodiments, the configuration of nozzle sprayers may be selected to achieve desired spray characteristics. Spray characteristics that may be controlled through nozzle configuration may include one or more or any combination of the following: droplet size, or droplet size distribution, or spray angle, or spray pattern, or spray velocity, or spray coverage, or any combination thereof. The orifice size of a nozzle may affect the droplet size and the flow rate, with smaller orifices generally producing smaller droplets at a given pressure. The orifice shape may affect the spray pattern, with different shapes producing flat sprays, cone sprays, or other patterns. The internal geometry of the nozzle may affect the velocity and direction of the water as the water exits the orifice.

In some embodiments, rotary sprayers may be employed for water-air contacting. Rotary sprayers may comprise devices that may use centrifugal force to create fine droplets from water. Rotary sprayers may include a rotating element, such as a disk, a cup, a bell, a wheel, or other rotating member, onto which water may be supplied. As the rotating element rotates, centrifugal force may cause the water to move outward toward the edge of the rotating element, and the water may be flung off the edge of the rotating element as droplets. The droplet size produced by rotary sprayers may be related to the rotational speed of the rotating element, the diameter of the rotating element, the water flow rate, the surface characteristics of the rotating element, or any combination thereof.

In some embodiments, rotary sprayers using centrifugal force may create fine droplets with controlled size distribution. Higher rotational speeds may produce smaller droplets due to the greater centrifugal force acting on the water. The edge configuration of the rotating element may affect the droplet formation, with serrated edges, grooved edges, or other edge configurations potentially producing different droplet characteristics than smooth edges. Rotary sprayers may provide uniform droplet size distributions, which may be beneficial for consistent heat transfer characteristics across the spray.

In some embodiments, the rotational speed of rotary sprayers may be controlled to achieve desired droplet sizes. The rotational speed may be controlled through one or more or any combination of the following: variable speed motors, or gear systems, or belt drives, or direct drive systems, or any combination thereof. The rotational speed may be adjusted based on operating conditions, desired droplet size, water flow rate, or other factors. Higher rotational speeds may be employed when smaller droplets are desired, and lower rotational speeds may be employed when larger droplets are desired.

In some embodiments, air-assisted sprayers may be employed for water-air contacting. Air-assisted sprayers may combine water and air streams for enhanced droplet formation and distribution. Air-assisted sprayers may use compressed air, pressurized air, or other air sources to atomize water into fine droplets. The air stream may interact with the water stream to break the water into smaller droplets than would be produced by the water pressure alone. Air-assisted sprayers may include one or more or any combination of the following types: internal mix sprayers, or external mix sprayers, or two-fluid nozzles, or pneumatic atomizers, or any combination thereof.

In some embodiments, internal mix air-assisted sprayers may combine water and air within the body of the sprayer before the mixture exits through an orifice. The mixing of water and air within the sprayer body may create a two-phase mixture that may be atomized as the mixture exits the orifice. Internal mix sprayers may produce fine droplets with relatively low air consumption. The droplet size produced by internal mix sprayers may be related to the air-to-water ratio, the mixing chamber design, the orifice size, or any combination thereof.

In some embodiments, external mix air-assisted sprayers may combine water and air outside the body of the sprayer. The water stream and the air stream may exit through separate orifices and may interact outside the sprayer to create droplets. External mix sprayers may allow independent control of the water flow rate and the air flow rate, which may provide flexibility in controlling droplet size and spray characteristics. External mix sprayers may be less susceptible to clogging than internal mix sprayers because the water and air passages may be separate.

In some embodiments, air-assisted sprayers may provide enhanced droplet formation through the shearing action of the air stream on the water stream. The high-velocity air stream may impinge on the water stream and may break the water into fine droplets through aerodynamic forces. The velocity difference between the air stream and the water stream may affect the droplet size, with greater velocity differences generally producing smaller droplets. The angle at which the air stream impinges on the water stream may also affect the droplet formation and the spray pattern.

In some embodiments, air-assisted sprayers may provide enhanced droplet distribution through the momentum of the air stream. The air stream may carry the water droplets and may distribute the droplets over a larger area than would be achieved by the water stream alone. The air stream may also provide additional mixing between the water droplets and the surrounding air, which may enhance heat transfer. The direction and velocity of the air stream may be controlled to achieve desired droplet distribution patterns.

In some embodiments, water droplet size may be controlled within specific ranges to optimize surface area for air contact while preventing undesired carryover or accumulation. Droplet size may affect the surface area available for heat transfer, the residence time of droplets in the air, the tendency of droplets to be carried by the airflow, the tendency of droplets to settle or accumulate, or any combination thereof. Smaller droplets may provide greater surface area per unit volume of water, which may enhance heat transfer rates. Larger droplets may be less susceptible to carryover by the airflow and may settle more readily for collection.

In some embodiments, water droplet size may be controlled within a range from approximately 0.01 micron to approximately 100,000,000 micron. In some embodiments, water droplet size may be controlled within a range from approximately 0.01 micron to approximately 0.1 micron. In some embodiments, water droplet size may be controlled within a range from approximately 0.1 micron to approximately 1 micron. In some embodiments, water droplet size may be controlled within a range from approximately 1 micron to approximately 10 micron. In some embodiments, water droplet size may be controlled within a range from approximately 10 micron to approximately 100 micron. In some embodiments, water droplet size may be controlled within a range from approximately 100 micron to approximately 1,000 micron. In some embodiments, water droplet size may be controlled within a range from approximately 1,000 micron to approximately 10,000 micron. In some embodiments, water droplet size may be controlled within a range from approximately 10,000 micron to approximately 100,000 micron. In some embodiments, water droplet size may be controlled within a range from approximately 100,000 micron to approximately 1,000,000 micron. In some embodiments, water droplet size may be controlled within a range from approximately 1,000,000 micron to approximately 10,000,000 micron. In some embodiments, water droplet size may be controlled within a range from approximately 10,000,000 micron to approximately 100,000,000 micron.

In some embodiments, droplet sizes in the range from approximately 10 micron to approximately 1,000 micron may provide a balance between surface area for heat transfer and resistance to carryover. Droplets in this size range may have sufficient surface area to achieve effective heat transfer while being large enough to resist being carried out of the system by the airflow. The specific droplet size within this range may be selected based on the airflow velocity, the desired heat transfer rate, the system geometry, or any combination of such factors.

In some embodiments, droplet sizes smaller than approximately 10 micron may provide very high surface area for heat transfer but may be more susceptible to carryover by the airflow. Very fine droplets may remain suspended in the airflow for extended periods and may be carried out of the system through air outlets. Mist eliminators, demisters, or other droplet separation devices may be employed to capture fine droplets and prevent carryover when small droplet sizes are employed.

In some embodiments, droplet sizes larger than approximately 1,000 micron may be less susceptible to carryover but may provide less surface area per unit volume of water for heat transfer. Larger droplets may settle more rapidly under the influence of gravity and may have shorter residence times in contact with the airflow. Larger droplets may be employed in applications where carryover prevention is a priority or where the airflow velocity is high.

In some embodiments, the droplet size may be controlled through adjustment of sprayer operating parameters. Operating parameters that may affect droplet size may include one or more or any combination of the following: water pressure, or water flow rate, or air pressure, or air flow rate, or nozzle orifice size, or rotational speed, or any combination thereof. Increasing water pressure in nozzle sprayers may generally decrease droplet size. Increasing rotational speed in rotary sprayers may generally decrease droplet size. Increasing the air-to-water ratio in air-assisted sprayers may generally decrease droplet size.

In some embodiments, the droplet size may be controlled through selection of sprayer type and configuration. Different sprayer types may produce different droplet size ranges, and the selection of sprayer type may be based on the desired droplet size range. Nozzle sprayers may produce droplet sizes ranging from approximately 50 micron to approximately 5,000 micron depending on the nozzle design and operating pressure. Rotary sprayers may produce droplet sizes ranging from approximately 10 micron to approximately 500 micron depending on the rotational speed and rotating element design. Air-assisted sprayers may produce droplet sizes ranging from approximately 1 micron to approximately 100 micron depending on the air pressure and air-to-water ratio.

In some embodiments, the droplet size distribution may be controlled in addition to the mean droplet size. Droplet size distribution may refer to the range of droplet sizes produced by a sprayer and the relative proportions of droplets at different sizes. A narrow droplet size distribution may provide more uniform heat transfer characteristics across the spray. A wide droplet size distribution may include both fine droplets for high surface area and coarse droplets for reduced carryover. The droplet size distribution may be controlled through sprayer design, operating parameters, or any combination thereof.

In some embodiments, multiple sprayers with different droplet size characteristics may be employed in combination. A first set of sprayers may produce fine droplets for high surface area heat transfer, and a second set of sprayers may produce coarse droplets for reduced carryover. The combination of sprayers with different characteristics may allow optimization of both heat transfer and carryover prevention. The relative flow rates through the different sprayers may be adjusted to achieve desired overall droplet size characteristics.

In some embodiments, the droplet size may be monitored during operation to verify that the desired droplet size is being achieved. Droplet size monitoring may employ one or more or any combination of the following: laser diffraction instruments, or phase Doppler analyzers, or imaging systems, or optical sensors, or any combination thereof. The monitored droplet size may be compared to a target droplet size, and the sprayer operating parameters may be adjusted to maintain the droplet size within a desired range.

In some embodiments, carryover prevention may be achieved through control of droplet size in combination with other measures. Other measures for carryover prevention may include one or more or any combination of the following: mist eliminators, or demisters, or drift eliminators, or baffles, or screens, or reduced airflow velocity in spray zones, or any combination thereof. The combination of controlled droplet size and carryover prevention devices may allow the use of smaller droplets for enhanced heat transfer while preventing the loss of water through carryover.

In some embodiments, accumulation prevention may be achieved through control of droplet size and spray pattern. Accumulation may refer to the buildup of water or ice in undesired locations within the system. Larger droplets may be more likely to accumulate on surfaces due to their greater momentum and reduced tendency to follow airflow streamlines. Smaller droplets may be more likely to follow airflow streamlines and may be less likely to impact and accumulate on surfaces. The spray pattern may be controlled to direct droplets away from surfaces where accumulation may be undesirable.

In some embodiments, the optimization of droplet size may consider the trade-offs between surface area, carryover, accumulation, and other factors. Smaller droplets may provide greater surface area for heat transfer but may be more susceptible to carryover. Larger droplets may be less susceptible to carryover but may provide less surface area and may be more likely to accumulate. The optimal droplet size may depend on the specific application, the system geometry, the airflow characteristics, the desired heat transfer rate, or any combination of such factors.

In some embodiments, spraying systems may be configured to operate in cold environments where freezing may occur. The spraying systems may be configured to prevent freezing within the sprayer components, to accommodate ice formation on sprayed surfaces, to operate despite the presence of ice, or any combination thereof. Sprayer components may be heated, may be insulated, may be constructed from materials that resist ice adhesion, or may be configured with geometries that minimize ice accumulation. The water supply to the sprayers may be maintained at temperatures above freezing to prevent freezing within supply lines.

In some embodiments, spraying systems may be configured for ease of maintenance. Maintenance considerations may include accessibility for inspection, ease of cleaning, ease of replacement of worn components, and resistance to clogging. Sprayer nozzles may be configured for easy removal and replacement. Strainers or filters may be provided upstream of sprayers to prevent clogging by debris. Sprayer components may be constructed from corrosion-resistant materials to extend service life.

In some embodiments, spraying systems may be configured with multiple sprayers arranged in arrays or patterns. The arrangement of sprayers may be configured to provide uniform coverage of the spray zone, to achieve desired spray overlap, to accommodate the geometry of the system, or to achieve any combination of such objectives. The spacing between sprayers may be selected based on the spray angle, the spray reach, the desired coverage, or any combination of such factors. The orientation of sprayers may be selected to direct spray in desired directions relative to the airflow.

In some embodiments, spraying systems may be configured with adjustable spray characteristics. The spray angle, spray direction, spray pattern, or spray flow rate may be adjustable to allow optimization of spray characteristics for different operating conditions. Adjustable sprayers may include one or more or any combination of the following: adjustable nozzles, or pivoting mounts, or variable orifice nozzles, or flow control valves, or any combination thereof. The adjustment of spray characteristics may be performed manually, automatically, or through remote operation.

In some embodiments, spraying systems may be configured to operate with various water sources. The water sources may include one or more or any combination of the following: freshwater, or seawater, or brackish water, or brine, or recirculated water, or any combination thereof. The sprayer design may be selected based on the characteristics of the water source, including the dissolved solids content, the suspended solids content, the corrosivity, or any combination thereof. Sprayers for use with seawater or brine may be constructed from corrosion-resistant materials such as stainless steel, titanium, or plastics.

In some embodiments, the water flow rate through spraying systems may be controlled to achieve desired heat transfer rates. The water flow rate may affect the total heat available for transfer to the air, the droplet density in the spray zone, the residence time of droplets in the air, or any combination thereof. The water flow rate may be controlled through one or more or any combination of the following: variable speed pumps, or flow control valves, or multiple sprayers that may be selectively activated, or any combination thereof. The water flow rate may be adjusted based on operating conditions, desired heat transfer rate, air temperature, or any combination of such factors.

In some embodiments, a system may employ a pool-based collection basin for water-air contacting. A pool-based collection basin may comprise a container, vessel, tank, or other structure configured to hold a volume of liquid water. The pool-based collection basin may be positioned within or adjacent to an air conduit, a tower, or other structure where air may flow over or through the pool. The pool-based collection basin may receive water from spraying systems, from direct water supply, from recirculated water, or from any combination of such sources. The pool-based collection basin may serve as a location for heat transfer between water and air, for collection of ice formed during heat transfer, for collection of brine produced during freezing, for collection of salt crystals precipitated from solution, or for any combination of such functions.

In some embodiments, the pool-based collection basin may contain liquid water at or above the freezing point of the water. The liquid water in the pool may be maintained at a temperature at or above the freezing point through heat input from incoming water, through heat released during freezing of a portion of the water, through controlled heat addition, or through any combination of such mechanisms. The maintenance of liquid water at or above the freezing point may allow the pool to remain in a liquid state rather than freezing solid, which may facilitate circulation, separation of products, and removal of ice and other materials from the pool.

In some embodiments, the pool-based collection basin may enable density-based separation of materials produced during heat transfer and freezing processes. Density-based separation may comprise the separation of materials based on differences in density, wherein materials with lower density may rise toward the surface of the pool and materials with higher density may sink toward the bottom of the pool. The density differences between ice, liquid water, brine, and salt crystals may allow these materials to separate into distinct layers or regions within the pool based on their respective densities.

In some embodiments, ice may float at or near the surface of the pool due to the lower density of ice compared to liquid water. Ice may have a density of approximately 917 kilograms per cubic meter, which may be lower than the density of liquid water at approximately 1,000 kilograms per cubic meter. The lower density of ice may cause ice formed during heat transfer to rise to the surface of the pool, where the ice may accumulate as a floating layer. The floating ice may be collected, removed, or otherwise processed from the surface of the pool.

In some embodiments, brine may form a middle layer within the pool. Brine may comprise liquid water with an elevated concentration of dissolved salts compared to the original water. When water freezes from a saline solution, dissolved salts may be excluded from the ice crystal structure and may remain in the liquid phase, resulting in an increase in the salt concentration of the remaining liquid. The brine may have a density greater than the density of freshwater or less concentrated saline water but may have a density less than the density of saturated brine or precipitated salt crystals. The intermediate density of brine may cause the brine to occupy a middle layer within the pool, below the floating ice and above any precipitated salt crystals.

In some embodiments, salt crystals may sink toward the bottom of the pool due to the higher density of salt crystals compared to liquid water and brine. Salt crystals may have densities ranging from approximately 2,000 kilograms per cubic meter to approximately 2,700 kilograms per cubic meter depending on the salt composition. The higher density of salt crystals may cause precipitated or crystallized salts to sink through the liquid in the pool and to accumulate at or near the bottom of the pool. The accumulated salt crystals may be collected, removed, or otherwise processed from the bottom of the pool.

In some embodiments, the density-based separation within the pool may allow continuous or semi-continuous collection of ice, brine, and salt crystals from different locations within the pool. Ice may be collected from the surface of the pool using skimmers, rakes, conveyors, augers, or other collection devices configured to operate at or near the surface. Brine may be withdrawn from the middle layer of the pool through outlets, pipes, or other withdrawal devices positioned at intermediate depths within the pool. Salt crystals may be collected from the bottom of the pool using scrapers, augers, pumps, or other collection devices configured to operate at or near the bottom.

In some embodiments, the pool-based collection basin may differ from a funnel basin in configuration and operation. A funnel basin may comprise a basin with sloped sides that may direct materials toward a central collection point. A pool-based collection basin may comprise a basin with a generally horizontal bottom and vertical or near-vertical sides, which may provide a volume of liquid water in which density-based separation may occur. The pool-based configuration may allow materials to separate based on density differences and may allow collection of different materials from different locations within the pool.

In some embodiments, submerged components within the pool may be protected from freezing due to the maintenance of liquid water at or above the freezing point within the pool. Submerged components may include one or more or any combination of the following: water jets, or spray nozzles, or circulation inlets, or circulation outlets, or sensors, or structural supports, or collection devices, or any combination thereof. The submerged components may be positioned below the surface of the liquid water in the pool, where the temperature of the surrounding liquid may be at or above the freezing point. The liquid water surrounding the submerged components may prevent ice from forming on or within the submerged components, which may maintain the operability of the submerged components and may prevent clogging or damage due to ice formation.

In some embodiments, water jets or spray nozzles may be positioned in a submerged configuration within the pool. The submerged positioning of water jets or spray nozzles may protect the water jets or spray nozzles from freezing by maintaining the water jets or spray nozzles in contact with liquid water at or above the freezing point. The water jets or spray nozzles may be configured to operate while submerged, directing water flow within the pool for circulation, for heat transfer enhancement, or for other purposes. The submerged water jets or spray nozzles may be retractable, allowing the water jets or spray nozzles to be lowered further into the pool to facilitate ice removal from the surface or to be raised for maintenance or other purposes.

In some embodiments, circulation inlets and outlets may be positioned in submerged locations within the pool. The submerged positioning of circulation inlets and outlets may protect the circulation inlets and outlets from freezing and may allow circulation of liquid water from within the pool. The circulation inlets may draw liquid water from the pool for circulation through pumps, heat exchangers, or other circulation equipment. The circulation outlets may return circulated water to the pool. The positioning of circulation inlets and outlets at submerged locations may ensure that liquid water rather than ice or air is drawn into the circulation system.

In some embodiments, sensors may be positioned in submerged locations within the pool. Sensors may include one or more or any combination of the following: temperature sensors, or salinity sensors, or level sensors, or flow sensors, or any combination thereof. The submerged positioning of sensors may protect the sensors from freezing and may allow the sensors to measure conditions within the liquid water in the pool. The sensor measurements may be used for monitoring, control, optimization, or other purposes.

In some embodiments, the protection of submerged components from freezing may be enhanced through the circulation of liquid water within the pool. Circulation may bring warmer water into contact with submerged components, may prevent stagnant regions where freezing may be more likely to occur, and may maintain uniform temperature distribution within the pool. The circulation may be provided by pumps, by water jets, by natural convection, or by any combination of such mechanisms.

In some embodiments, water circulation in the pool may prevent block freezing. Block freezing may comprise the freezing of a large mass of water into a solid block of ice, which may interfere with system operation, may damage equipment, may prevent collection of products, or may have other adverse effects. Water circulation may prevent block freezing by maintaining movement of the water within the pool, by distributing heat throughout the pool, by preventing the formation of stagnant cold regions, or by any combination of such mechanisms. The movement of water may disrupt the formation of large ice crystals and may promote the formation of smaller ice particles that may float to the surface rather than forming a solid block.

In some embodiments, water circulation in the pool may be controlled using variable-speed pumps. Variable-speed pumps may comprise pumps configured to operate at adjustable speeds, allowing the flow rate of water through the pump to be varied. Variable-speed pumps may be driven by variable-speed motors, may be controlled by variable frequency drives, or may employ other mechanisms for speed adjustment. The use of variable-speed pumps may allow the circulation flow rate to be adjusted based on operating conditions, which may provide flexibility in controlling heat transfer, freezing rates, and other system characteristics.

In some embodiments, the variable-speed pumps may be controlled with temperature feedback. Temperature feedback may comprise the use of temperature measurements as input to a control system that may adjust the pump speed based on the measured temperatures. Temperature sensors may be positioned within the pool, at circulation inlets, at circulation outlets, or at other locations where temperature measurements may be relevant to control of the circulation system. The temperature measurements may be transmitted to a control system, which may compare the measured temperatures to setpoints or targets and may adjust the pump speed to achieve desired temperature conditions.

In some embodiments, the control of variable-speed pumps with temperature feedback may employ a proportional-integral-derivative control loop. A proportional-integral-derivative control loop, which may also be referred to as a PID control loop, may comprise a control algorithm that may calculate a control output based on the error between a measured value and a setpoint. The proportional term of the PID control loop may produce a control output proportional to the current error. The integral term of the PID control loop may produce a control output proportional to the accumulated error over time. The derivative term of the PID control loop may produce a control output proportional to the rate of change of the error. The combination of proportional, integral, and derivative terms may provide responsive and stable control of the pump speed based on temperature feedback.

In some embodiments, the PID control loop may adjust the flow rate of water circulation to prevent excessive freezing. Excessive freezing may comprise freezing at a rate or to an extent that may interfere with system operation, may cause block freezing, may damage equipment, or may have other adverse effects. The PID control loop may monitor temperature within the pool or at other relevant locations and may increase the circulation flow rate when temperatures indicate that excessive freezing may be occurring or may be imminent. Increased circulation flow rate may distribute heat more effectively throughout the pool, may bring warmer water into contact with colder regions, and may prevent the formation of large ice masses.

In some embodiments, the PID control loop may adjust the flow rate of water circulation to optimize heat transfer. Heat transfer optimization may comprise adjusting the circulation flow rate to achieve desired heat transfer rates between the water and the air. The PID control loop may monitor temperature within the pool, at circulation inlets, at circulation outlets, or at other relevant locations and may adjust the circulation flow rate to maintain temperatures within desired ranges. The circulation flow rate may affect the temperature distribution within the pool, the residence time of water in contact with cold air, the rate of ice formation, or other factors related to heat transfer.

In some embodiments, the PID control loop may adjust the flow rate of water circulation based on real-time conditions. Real-time conditions may comprise current measurements of temperature, flow rate, ice production rate, air temperature, or other parameters that may be relevant to system operation. The PID control loop may receive real-time measurements from sensors, may calculate control outputs based on the real-time measurements, and may adjust the pump speed in real time to respond to changing conditions. The real-time adjustment of circulation flow rate may allow the system to respond to variations in air temperature, variations in water temperature, variations in heat transfer rate, or other variations in operating conditions.

In some embodiments, the temperature feedback for the PID control loop may be provided by multiple temperature sensors positioned at different locations within the pool. Multiple temperature sensors may provide information about the temperature distribution within the pool, which may allow the control system to detect temperature gradients, to identify regions where freezing may be occurring, or to monitor the effectiveness of circulation in distributing heat. The control system may use the temperature measurements from multiple sensors to calculate an average temperature, to identify minimum or maximum temperatures, to calculate temperature gradients, or to perform other calculations that may be relevant to control of the circulation system.

In some embodiments, the PID control loop may be configured with tuning parameters that may be adjusted to achieve desired control performance. Tuning parameters may include the proportional gain, the integral gain, and the derivative gain of the PID control loop. The tuning parameters may affect the responsiveness of the control system, the stability of the control system, the tendency of the control system to overshoot or undershoot setpoints, or other characteristics of control performance. The tuning parameters may be adjusted during commissioning, during operation, or at other times to optimize control performance for the specific characteristics of the system.

In some embodiments, the control of water circulation may be integrated with control of other system components. Other system components that may be controlled in coordination with water circulation may include one or more or any combination of the following: spraying systems, or airflow control elements, or turbines, or ice collection devices, or brine withdrawal systems, or salt collection devices, or any combination thereof. The integrated control may coordinate the operation of multiple system components to achieve overall system objectives, such as maximizing power generation, maximizing ice production, maintaining desired product quality, or achieving other objectives.

In some embodiments, the circulation system may include multiple pumps that may be operated independently or in coordination. Multiple pumps may provide redundancy, may allow different circulation patterns within the pool, may allow different flow rates in different regions of the pool, or may provide any combination of such capabilities. The multiple pumps may be controlled by a common control system or by separate control systems, and the control may be coordinated to achieve desired circulation characteristics throughout the pool.

In some embodiments, the circulation pattern within the pool may be configured to promote density-based separation of ice, brine, and salt crystals. The circulation pattern may be configured to avoid disrupting the stratification of materials based on density, to promote the movement of ice toward collection locations at the surface, to promote the movement of salt crystals toward collection locations at the bottom, or to achieve any combination of such objectives. The circulation inlets and outlets may be positioned and oriented to create circulation patterns that may support density-based separation while also preventing block freezing and maintaining uniform temperature distribution.

In some embodiments, the circulation flow rate may be varied over time based on operating conditions or operating objectives. During periods of high heat transfer rate, the circulation flow rate may be increased to distribute heat and to prevent excessive freezing. During periods of low heat transfer rate, the circulation flow rate may be decreased to reduce energy consumption. During ice collection operations, the circulation flow rate may be adjusted to facilitate ice movement toward collection devices. The variation of circulation flow rate over time may be controlled automatically by the PID control loop or other control systems, or may be controlled manually by operators.

In some embodiments, the pool-based collection basin may be configured with features to facilitate density-based separation and collection of products. Features may include one or more or any combination of the following: sloped surfaces to direct settled materials toward collection points, or weirs to control the level of floating ice, or baffles to separate regions of the pool, or outlets at different depths for withdrawal of materials from different layers, or any combination thereof. The configuration of such features may be selected based on the expected products, the desired separation efficiency, the collection methods to be employed, or any combination of such factors.

In some embodiments, the pool-based collection basin may be constructed from materials configured to withstand the operating conditions. Operating conditions may include exposure to cold temperatures, exposure to saline water or brine, exposure to ice, mechanical loads from ice or equipment, or any combination thereof. Construction materials may include one or more or any combination of the following: concrete, or steel, or stainless steel, or fiberglass, or plastic, or lined materials, or any combination thereof. The selection of construction materials may be based on durability, corrosion resistance, thermal properties, cost, or any combination of such factors.

In some embodiments, the pool-based collection basin may be insulated to reduce heat loss to the surroundings. Insulation may be applied to the sides, bottom, or other surfaces of the pool-based collection basin to reduce heat transfer from the liquid water in the pool to the surrounding environment. Reduced heat loss may help maintain the liquid water at or above the freezing point, may reduce the energy input required to maintain liquid conditions, and may improve the efficiency of the system. Insulation materials may include one or more or any combination of the following: foam insulation, or fiberglass insulation, or mineral wool insulation, or vacuum insulation, or any combination thereof.

In some embodiments, the pool-based collection basin may be covered or partially covered to reduce heat loss to the atmosphere above the pool. A cover may comprise a lid, a roof, a floating cover, or other structure that may reduce heat transfer from the surface of the pool to the atmosphere. The cover may be configured to allow air to flow over the pool surface for heat transfer while reducing heat loss during periods when heat transfer is not desired. The cover may be removable, retractable, or adjustable to allow access to the pool surface for ice collection or other operations.

In some embodiments, water-air contacting may employ submerged water jets positioned beneath the surface of a water pool. Submerged water jets may comprise nozzles, orifices, outlets, or other devices configured to direct water flow while positioned below the surface level of liquid water in a pool or basin. The submerged positioning of water jets may protect the water jets from exposure to cold air temperatures that may be below the freezing point of water, which may prevent ice formation on or within the water jet components. The liquid water surrounding the submerged water jets may maintain the water jets at temperatures at or above the freezing point of the liquid water, which may prevent freezing of water within the water jet passages and may prevent clogging of the water jets due to ice formation.

In some embodiments, submerged water jets may be configured to operate while positioned beneath the surface of the water pool. The submerged water jets may direct water flow within the pool for circulation, for mixing, for heat distribution, for promoting ice formation at the surface, or for any combination of such purposes. The water flow from submerged water jets may create currents within the pool that may distribute heat throughout the pool volume, may prevent stagnant regions where block freezing may occur, and may promote the movement of formed ice toward the surface of the pool where the ice may be collected.

In some embodiments, submerged water jets may be configured to retract deeper beneath the surface of the water pool. Retraction may comprise movement of the water jets to a lower position within the pool, further from the surface of the pool. The retraction of water jets may be achieved through one or more or any combination of the following: vertical movement of the water jets along guide rails or tracks, or telescoping mechanisms that may extend or contract, or pivoting mechanisms that may lower the water jets, or flexible conduits that may allow repositioning of the water jets, or any combination thereof. The retraction of water jets to a deeper position may increase the clearance between the water jets and the surface of the pool, which may facilitate ice removal operations at the surface of the pool.

In some embodiments, submerged water jets may be configured to extend upward toward the surface of the water pool. Extension may comprise movement of the water jets to a higher position within the pool, closer to the surface of the pool. The extension of water jets may be achieved through the same mechanisms employed for retraction, operated in the opposite direction. The extension of water jets toward the surface may position the water jets closer to the air-water interface where heat transfer may occur, which may enhance mixing and heat distribution in the region near the surface. The extension of water jets may also allow the water jets to direct water flow upward through the surface to create spray or fountain effects for enhanced air-water contact.

In some embodiments, the retraction and extension of submerged water jets may be controlled to facilitate ice removal while maintaining operation of the water jets. During ice removal operations, the water jets may be retracted to a deeper position to provide clearance for ice removal devices to operate at the surface of the pool. The retraction of the water jets may allow ice removal devices such as rakes, scrapers, skimmers, augers, or conveyors to move across the surface of the pool without interference from the water jets. The water jets may continue to operate while in the retracted position, maintaining circulation and heat distribution within the pool during ice removal operations.

In some embodiments, the water jets may be retracted in response to detection of ice accumulation at the surface of the pool. Ice accumulation may be detected through one or more or any combination of the following: visual observation, or level sensors, or temperature sensors, or ice thickness sensors, or imaging systems, or any combination thereof. When ice accumulation is detected, a control system may initiate retraction of the water jets to prepare for ice removal operations. The retraction may be performed automatically in response to sensor inputs, or the retraction may be initiated manually by an operator.

In some embodiments, the water jets may be extended after completion of ice removal operations. After ice has been removed from the surface of the pool, the water jets may be extended to a higher position to resume normal operation with the water jets positioned closer to the surface. The extension may be performed automatically after a predetermined time period, after detection that ice removal is complete, or in response to operator commands. The extension of the water jets after ice removal may restore the water jets to positions that may provide enhanced mixing and heat distribution near the surface.

In some embodiments, the retraction and extension of water jets may be performed while the water jets continue to operate. The water jets may continue to direct water flow during retraction, during extension, and at any position between the fully retracted position and the fully extended position. The continued operation of the water jets during retraction and extension may maintain circulation within the pool, may prevent block freezing, and may maintain heat distribution throughout the pool volume. The ability to operate the water jets at any position may provide flexibility in balancing the objectives of heat transfer, circulation, and ice removal.

In some embodiments, the mechanisms for retraction and extension of water jets may be configured to operate in cold environments. The mechanisms may be constructed from materials that may maintain function at low temperatures, may be protected from ice formation through submersion in liquid water, may be heated to prevent freezing, or may be configured with geometries that may resist ice accumulation. The mechanisms may include one or more or any combination of the following: linear actuators, or hydraulic cylinders, or pneumatic cylinders, or electric motors with lead screws, or cable and pulley systems, or any combination thereof.

In some embodiments, the water supply to the submerged water jets may be provided through flexible conduits that may accommodate the retraction and extension of the water jets. Flexible conduits may comprise hoses, bellows, flexible pipes, or other conduits that may bend or flex to accommodate movement of the water jets. The flexible conduits may be configured to maintain water flow to the water jets throughout the range of motion from the fully retracted position to the fully extended position. The flexible conduits may be constructed from materials that may maintain flexibility at low temperatures and may resist degradation from exposure to the water being conveyed.

In some embodiments, the water supply to the submerged water jets may be provided through telescoping conduits that may extend or contract with the water jets. Telescoping conduits may comprise nested tubes or pipes that may slide relative to each other to accommodate changes in length. The telescoping conduits may maintain a sealed water flow path while allowing the length of the conduit to change as the water jets retract or extend. Seals between the telescoping sections may prevent leakage of water from the conduits.

In some embodiments, multiple submerged water jets may be arranged in arrays or patterns within the pool. The multiple water jets may be configured to retract and extend together, or the multiple water jets may be configured to retract and extend independently. When the multiple water jets retract and extend together, a common mechanism may move all of the water jets simultaneously. When the multiple water jets retract and extend independently, separate mechanisms may move individual water jets or groups of water jets, which may allow different water jets to be at different positions within the pool.

In some embodiments, the positioning of submerged water jets at different depths within the pool may create circulation patterns that may promote density-based separation of ice, brine, and salt crystals. Water jets positioned at deeper locations may create upward currents that may carry warmer water toward the surface. Water jets positioned at shallower locations may create horizontal currents that may distribute water across the surface region. The combination of currents from water jets at different depths may create circulation patterns that may maintain liquid conditions throughout the pool while allowing ice to accumulate at the surface for collection.

In some embodiments, the submersion of water jets beneath the surface of the water pool may protect the water jets from freezing by maintaining the water jets in contact with liquid water at temperatures at or above the freezing point. The liquid water in the pool may be maintained at temperatures at or above the freezing point through heat input from incoming water, through heat released during freezing of a portion of the water at the surface, through circulation that may distribute heat throughout the pool, or through any combination of such mechanisms. The water jets, being submerged in the liquid water, may be maintained at temperatures similar to the temperature of the surrounding liquid water, which may prevent ice formation on or within the water jets.

In some embodiments, the submersion of water jets may prevent clogging of the water jets due to ice formation. Ice clogging may occur when ice forms within the passages of water jets, blocking or restricting water flow through the water jets. The submersion of water jets in liquid water at temperatures at or above the freezing point may prevent the conditions that may lead to ice formation within the water jet passages. The continuous flow of water through the water jets may also help prevent ice formation by maintaining movement of water through the passages.

In some embodiments, the submersion of water jets may facilitate ice removal over the pool surface by allowing ice removal devices to operate without interference from the water jets. When water jets are positioned above the surface of the pool, ice removal devices may need to navigate around the water jets, which may complicate ice removal operations and may leave areas of ice that cannot be reached by the ice removal devices. When water jets are submerged beneath the surface, the surface of the pool may be clear of obstructions, which may allow ice removal devices to sweep across the entire surface of the pool to collect ice.

In some embodiments, the retraction of water jets to deeper positions may further facilitate ice removal by increasing the clearance between the water jets and the surface of the pool. The increased clearance may allow ice removal devices to operate at greater depths below the surface, which may be beneficial when ice has accumulated to a significant thickness. The increased clearance may also reduce the risk of ice removal devices contacting and damaging the water jets during ice removal operations.

In some embodiments, ice removal devices may be configured to operate over the surface of the pool while the water jets are in a retracted position. Ice removal devices may include one or more or any combination of the following: rakes, or scrapers, or skimmers, or augers, or conveyors, or scoops, or paddles, or any combination thereof. The ice removal devices may be configured to move across the surface of the pool, to collect ice floating on the surface, and to transfer the collected ice to a receptacle, a conveyor, a chute, or other collection system. The ice removal devices may be operated manually, automatically, or through remote control.

In some embodiments, the ice removal devices may be configured to operate in coordination with the retraction and extension of the water jets. A control system may coordinate the operation of the ice removal devices and the water jets such that the water jets may be retracted before ice removal operations begin and may be extended after ice removal operations are complete. The coordination may ensure that the water jets are in appropriate positions during ice removal and may prevent conflicts between the operation of the ice removal devices and the operation of the water jets.

In some embodiments, the water jets may be configured with nozzles or orifices that may direct water flow in desired directions. The direction of water flow from the water jets may be configured to create desired circulation patterns within the pool, to direct water toward the surface for enhanced air-water contact, to direct water away from ice removal devices during ice removal operations, or to achieve any combination of such objectives. The nozzles or orifices may be fixed in orientation, or the nozzles or orifices may be adjustable to allow the direction of water flow to be changed.

In some embodiments, the flow rate through the submerged water jets may be controlled to achieve desired circulation and heat distribution characteristics. The flow rate may be controlled through one or more or any combination of the following: variable speed pumps, or flow control valves, or multiple water jets that may be selectively activated, or any combination thereof. The flow rate may be adjusted based on operating conditions, ice accumulation rate, temperature distribution within the pool, or any combination of such factors.

In some embodiments, the submerged water jets may be configured to create turbulence and mixing within the pool. Turbulence and mixing may enhance heat distribution throughout the pool, may prevent stratification of water at different temperatures, may promote the formation of small ice crystals rather than large ice masses, and may prevent block freezing. The configuration of the water jets, including the number of water jets, the positioning of the water jets, the direction of water flow from the water jets, and the flow rate through the water jets, may be selected to achieve desired levels of turbulence and mixing.

In some embodiments, the submerged water jets may be configured to direct water flow toward the surface of the pool to enhance air-water contact. Water directed toward the surface may create disturbances at the air-water interface, may increase the surface area of the interface, may create spray or droplets that may be contacted with air above the surface, or may achieve any combination of such effects. The enhanced air-water contact may increase the rate of heat transfer from the water to the air, which may increase the rate of ice formation and may increase the warming of the air for buoyancy-induced airflow.

In some embodiments, the submerged water jets may be configured to operate in conjunction with spray systems positioned above the surface of the pool. The spray systems may create water droplets that may be contacted with air above the pool, and the droplets may fall into the pool after heat transfer. The submerged water jets may circulate the water in the pool, may distribute heat from the incoming droplets throughout the pool, and may promote the movement of ice formed from the droplets toward collection locations. The combination of spray systems and submerged water jets may provide comprehensive water-air contacting and circulation within the system.

In some embodiments, the retractable and extendable configuration of the submerged water jets may allow the system to adapt to varying operating conditions. During periods of high ice production, the water jets may be retracted more frequently to allow ice removal operations. During periods of low ice production, the water jets may remain in extended positions for longer periods. The adaptability of the water jet positioning may allow the system to optimize operation for varying air temperatures, varying water temperatures, varying ice production rates, or varying other operating conditions.

In some embodiments, the submerged water jets may be constructed from materials configured to resist corrosion and degradation in the operating environment. The operating environment may include exposure to saline water, brine, cold temperatures, or any combination thereof. Construction materials may include one or more or any combination of the following: stainless steel, or titanium, or plastics, or composite materials, or coated materials, or any combination thereof. The selection of construction materials may be based on corrosion resistance, durability, cost, or any combination of such factors.

In some embodiments, the submerged water jets may be configured for ease of maintenance. Maintenance considerations may include accessibility for inspection, ease of cleaning, ease of replacement of worn components, and resistance to clogging. The water jets may be configured with removable nozzles or orifices that may be replaced without replacing the entire water jet assembly. Strainers or filters may be provided upstream of the water jets to prevent clogging by debris. The retraction and extension mechanisms may be configured for accessibility and ease of repair.

In some embodiments, ice removal may be accomplished using mechanical devices. Mechanical devices for ice removal may be configured to operate over a water pool surface where ice may float due to density differences between ice and liquid water. Ice may have a density of approximately 917 kilograms per cubic meter, which may be lower than the density of liquid water at approximately 1,000 kilograms per cubic meter. The lower density of ice relative to liquid water may cause ice formed during heat transfer processes to rise to the surface of a water pool, where the ice may accumulate as a floating layer. Mechanical ice removal devices may be configured to collect, move, or otherwise remove the floating ice from the surface of the water pool.

In some embodiments, mechanical devices for ice removal may include rakes. Rakes may comprise devices with multiple tines, teeth, or projections configured to engage with floating ice and to move the ice across the surface of the water pool. Rakes may be configured to sweep across the surface of the water pool in a linear motion, in an arcuate motion, or in other motion patterns. The tines, teeth, or projections of the rake may extend downward into the floating ice layer to engage with the ice, and the movement of the rake may push or pull the ice toward a collection location. Rakes may be operated manually, or rakes may be driven by motors, hydraulic actuators, pneumatic actuators, or other power sources.

In some embodiments, mechanical devices for ice removal may include augers. Augers may comprise helical screw devices configured to move ice along the axis of the auger through rotation of the helical screw. Augers may be positioned at or near the surface of the water pool, with the helical screw extending into the floating ice layer. Rotation of the auger may cause ice to be conveyed along the length of the auger toward a discharge location. Augers may be configured to operate horizontally across the surface of the water pool, or augers may be configured to operate at an incline to lift ice from the surface of the water pool to an elevated discharge location. Augers may be driven by electric motors, hydraulic motors, or other power sources.

In some embodiments, mechanical devices for ice removal may include rotating scoops. Rotating scoops may comprise devices with one or more scoop elements mounted on a rotating shaft or drum. The rotation of the shaft or drum may cause the scoop elements to pass through the floating ice layer, to collect ice in the scoop elements, and to lift the ice from the surface of the water pool. The collected ice may be discharged from the scoop elements as the scoop elements rotate to an elevated position, and the ice may fall or be directed into a receptacle, a conveyor, a chute, or other collection system. Rotating scoops may be configured to operate continuously, with the rotation of the shaft or drum providing continuous collection and discharge of ice.

In some embodiments, mechanical devices for ice removal may include conveyor belts. Conveyor belts may comprise continuous loop belts configured to move ice from the surface of the water pool to a collection location. Conveyor belts may be positioned with a lower portion of the belt at or below the surface of the water pool and an upper portion of the belt at an elevated discharge location. Ice floating on the surface of the water pool may be carried onto the lower portion of the conveyor belt, and the movement of the belt may transport the ice upward to the elevated discharge location. Conveyor belts may include cleats, paddles, or other features configured to engage with the ice and to prevent the ice from sliding back down the belt. Conveyor belts may be driven by electric motors or other power sources.

In some embodiments, mechanical devices for ice removal may include scrapers. Scrapers may comprise devices with a blade or edge configured to push ice across the surface of the water pool. Scrapers may be configured to move across the surface of the water pool in a linear motion, pushing ice ahead of the blade or edge toward a collection location. Scrapers may be configured to operate in a manner similar to a bulldozer blade, with the blade or edge positioned at or slightly below the surface of the water pool to engage with the floating ice layer. Scrapers may be operated manually, or scrapers may be driven by motors, hydraulic actuators, pneumatic actuators, or other power sources.

In some embodiments, mechanical ice removal devices may operate in combination with circulation currents within the water pool. Circulation currents may be generated by pumps, by water jets, by natural convection, or by other mechanisms. The circulation currents may be configured to direct floating ice toward collection zones where mechanical ice removal devices may be positioned. The movement of ice by circulation currents may reduce the area over which mechanical ice removal devices may need to operate, may concentrate ice in locations where collection may be more efficient, and may facilitate continuous ice removal operations. The circulation currents may be controlled to achieve desired ice movement patterns, and the control of circulation currents may be coordinated with the operation of mechanical ice removal devices.

In some embodiments, the water pool may include collection zones where ice may accumulate for removal by mechanical devices. Collection zones may comprise regions of the water pool where circulation currents may direct floating ice, where mechanical ice removal devices may be positioned, or where features of the pool geometry may cause ice to accumulate. Collection zones may be positioned at edges of the water pool, at corners of the water pool, at designated areas within the water pool, or at other locations where ice collection may be convenient. The positioning of collection zones may be selected based on the geometry of the water pool, the configuration of circulation currents, the positioning of mechanical ice removal devices, or any combination of such factors.

In some embodiments, ice collection may employ a shallow collection shelf or section within the water pool. A shallow collection shelf may comprise a region of the water pool with a reduced depth compared to other regions of the water pool. The shallow collection shelf may have a depth ranging from approximately 0.3 meters to approximately 0.5 meters. The reduced depth of the shallow collection shelf may allow floating ice to accumulate in a concentrated layer, may facilitate engagement of mechanical ice removal devices with the ice, and may reduce the volume of water that may need to be displaced during ice removal operations.

In some embodiments, the shallow collection shelf may be positioned at an edge of the water pool, at a corner of the water pool, or at another location where ice may be directed by circulation currents or by the geometry of the water pool. The shallow collection shelf may be configured with a sloped transition from the deeper regions of the water pool to the shallower depth of the collection shelf. The sloped transition may guide floating ice from the deeper regions onto the shallow collection shelf, where the ice may accumulate for removal.

In some embodiments, ice accumulated on the shallow collection shelf may be continuously moved by a rake. A rake may be configured to sweep across the shallow collection shelf, engaging with the accumulated ice and pushing or pulling the ice toward a discharge location. The rake may be configured to operate in a reciprocating motion, sweeping back and forth across the shallow collection shelf, or the rake may be configured to operate in a continuous motion, sweeping in one direction and returning to a starting position for another sweep. The continuous movement of ice by the rake may prevent excessive accumulation of ice on the shallow collection shelf and may provide a steady flow of ice to the discharge location.

In some embodiments, ice accumulated on the shallow collection shelf may be continuously moved by an auger. An auger may be positioned along the shallow collection shelf, with the helical screw extending into the accumulated ice layer. Rotation of the auger may cause ice to be conveyed along the length of the auger toward a discharge location. The auger may be configured to operate continuously, providing continuous movement of ice from the shallow collection shelf to the discharge location. The auger may be positioned horizontally along the shallow collection shelf, or the auger may be positioned at an incline to lift ice from the shallow collection shelf to an elevated discharge location.

In some embodiments, ice may be moved from the shallow collection shelf up a ramp to external handling. A ramp may comprise an inclined surface extending from the shallow collection shelf to an elevated location outside the water pool. Mechanical ice removal devices such as rakes, augers, conveyor belts, or scrapers may be configured to move ice up the ramp from the shallow collection shelf to the elevated location. The incline of the ramp may be selected to allow effective movement of ice while minimizing the power required to lift the ice. The ramp may be configured with a surface texture, cleats, or other features that may prevent ice from sliding back down the ramp during movement.

In some embodiments, ice may be moved from the shallow collection shelf through a sluice to external handling. A sluice may comprise a channel or trough configured to convey ice from the shallow collection shelf to an external location. The sluice may be configured with a downward slope that may allow ice to slide or flow through the sluice under the influence of gravity. Water may flow through the sluice along with the ice, and the water flow may assist in conveying the ice through the sluice. The sluice may discharge ice into a receptacle, a conveyor, a storage area, or other external handling system.

In some embodiments, the ramp or sluice may be configured to separate ice from water during the movement of ice to external handling. As ice moves up a ramp, water may drain back down the ramp into the water pool, leaving the ice with reduced water content at the elevated discharge location. As ice moves through a sluice, water may drain through openings in the sluice or may be separated from the ice at the discharge end of the sluice. The separation of water from ice during movement to external handling may reduce the water content of the collected ice, may reduce the weight of the collected ice, and may reduce the amount of water removed from the water pool during ice collection operations.

In some embodiments, external handling of ice removed from the water pool may include one or more or any combination of the following: storage, or transport, or further processing, or melting, or any combination thereof. Ice removed from the water pool may be stored in insulated containers, in cold storage facilities, or in outdoor storage areas where ambient temperatures may maintain the ice in a frozen state. Ice may be transported by trucks, by rail, by conveyor systems, or by other transport mechanisms to locations where the ice may be used or further processed. Ice may be further processed through washing, through size reduction, through compaction, or through other processing operations. Ice may be melted to produce liquid water for various uses.

In some embodiments, the mechanical ice removal devices may be configured to operate in cold environments where ambient temperatures may be below the freezing point of water. The mechanical ice removal devices may be constructed from materials that may maintain function at low temperatures, may be configured with geometries that may resist ice accumulation on the devices, may be heated to prevent freezing of moving parts, or may be configured with other features that may facilitate operation in cold environments. Bearings, seals, lubricants, and other components of the mechanical ice removal devices may be selected for low-temperature operation.

In some embodiments, the mechanical ice removal devices may be configured for ease of maintenance. Maintenance considerations may include accessibility for inspection, ease of cleaning, ease of replacement of worn components, and resistance to corrosion. The mechanical ice removal devices may be constructed from corrosion-resistant materials such as stainless steel, aluminum, or plastics. Wear components such as rake tines, auger flights, conveyor belt surfaces, or scraper blades may be configured for easy replacement. The mechanical ice removal devices may be positioned in locations that may be accessible for maintenance activities.

In some embodiments, the operation of mechanical ice removal devices may be controlled automatically, manually, or through remote operation. Automatic control may employ sensors to detect ice accumulation, timers to initiate ice removal operations at scheduled intervals, or control algorithms that may optimize ice removal based on operating conditions. Manual control may allow operators to initiate, adjust, or stop ice removal operations based on observation of conditions. Remote operation may allow operators at distant locations to control ice removal operations through communication links.

In some embodiments, the mechanical ice removal devices may be configured to operate continuously or intermittently. Continuous operation may provide steady removal of ice as the ice forms, which may prevent excessive accumulation of ice on the water pool surface. Intermittent operation may allow ice to accumulate to a desired thickness before removal, which may reduce the frequency of ice removal operations and may reduce wear on the mechanical ice removal devices. The selection of continuous or intermittent operation may depend on the rate of ice formation, the capacity of the mechanical ice removal devices, the requirements of downstream ice handling systems, or any combination of such factors.

In some embodiments, multiple mechanical ice removal devices may be employed in combination. A first mechanical ice removal device may move ice from the surface of the water pool to the shallow collection shelf, and a second mechanical ice removal device may move ice from the shallow collection shelf up a ramp or through a sluice to external handling. The combination of multiple mechanical ice removal devices may allow each device to be optimized for a specific function, may provide redundancy in case of device failure, and may increase the total ice removal capacity of the system.

In some embodiments, the shallow collection shelf may be configured with features to facilitate ice accumulation and removal. Features may include one or more or any combination of the following: sloped surfaces to guide ice toward collection points, or walls or barriers to contain ice within the collection shelf, or openings or channels to allow water to drain from the collection shelf, or any combination thereof. The configuration of such features may be selected based on the expected ice production rate, the configuration of mechanical ice removal devices, the geometry of the water pool, or any combination of such factors.

In some embodiments, the depth of the shallow collection shelf may be selected based on the characteristics of the ice to be collected and the configuration of the mechanical ice removal devices. A depth of approximately 0.3 meters may be suitable for collection of thin ice layers or ice particles, while a depth of approximately 0.5 meters may be suitable for collection of thicker ice accumulations. The depth may be selected to allow mechanical ice removal devices to engage effectively with the ice while minimizing the volume of water in the collection shelf.

In some embodiments, the circulation currents within the water pool may be configured to direct ice toward the shallow collection shelf. The circulation currents may be generated by water jets, by pumps, by the geometry of the water pool, or by any combination of such mechanisms. The direction and velocity of the circulation currents may be controlled to achieve desired ice movement patterns. The circulation currents may be configured to sweep ice from across the surface of the water pool toward the shallow collection shelf, where the ice may accumulate for removal by mechanical devices.

In some embodiments, the coordination of circulation currents and mechanical ice removal devices may be controlled by a control system. The control system may receive inputs from sensors that may detect ice accumulation, ice thickness, water temperature, circulation flow rate, or other parameters. The control system may adjust the circulation currents to direct ice toward the shallow collection shelf, may initiate operation of mechanical ice removal devices when ice accumulation reaches a threshold level, and may coordinate the operation of multiple system components to achieve efficient ice removal.

In some embodiments, anti-icing measures may be employed to prevent undesired ice formation on system components. Undesired ice formation may occur on components where ice accumulation may interfere with system operation, may damage equipment, may block flow passages, may impair the function of moving parts, or may have other adverse effects. Anti-icing measures may be configured to prevent ice formation on such components, to remove ice that may form on such components, or to reduce the adhesion of ice to such components to facilitate ice removal. Anti-icing measures may be employed on one or more or any combination of the following: pipes, or conduits, or valves, or nozzles, or spray systems, or water jets, or pumps, or sensors, or actuators, or structural members, or tower walls, or baffles, or pool edges, or basin surfaces, or any combination thereof.

In some embodiments, anti-icing measures may include heat tracing. Heat tracing may comprise the application of heat to system components to maintain the temperature of the components above the freezing point of water or other fluids that may be present. Heat tracing may prevent ice formation by maintaining component temperatures at levels where water may remain in a liquid state rather than freezing to form ice. Heat tracing may be applied to pipes, conduits, valves, nozzles, spray systems, water jets, pumps, sensors, actuators, or other components where ice formation may be undesirable.

In some embodiments, heat tracing may employ electrical heating elements. Electrical heating elements may comprise resistive heating cables, heating tapes, heating pads, heating jackets, or other devices that may convert electrical energy to heat through electrical resistance. Electrical heating elements may be attached to the exterior surfaces of components to be heated, may be wrapped around components, may be embedded within components, or may be positioned in other configurations that may allow heat to be transferred from the heating elements to the components. The electrical heating elements may be powered by electrical power from the grid, from on-site power generation, from batteries, or from other electrical power sources.

In some embodiments, heat tracing may employ fluid-based heating systems. Fluid-based heating systems may circulate a heated fluid through tubes, channels, or jackets positioned in thermal contact with components to be heated. The heated fluid may transfer heat to the components, maintaining the component temperatures above the freezing point. The heated fluid may comprise water, glycol solutions, oil, steam, or other fluids suitable for heat transfer. The fluid may be heated by boilers, heat exchangers, electric heaters, waste heat recovery systems, or other heat sources.

In some embodiments, heat tracing may be operated continuously. Continuous heat tracing may provide constant heat input to maintain component temperatures above the freezing point at all times during operation. Continuous heat tracing may be employed when ambient temperatures may be consistently below the freezing point, when the consequences of ice formation may be severe, or when the energy cost of continuous heating may be acceptable. Continuous heat tracing may provide reliable prevention of ice formation without the need for monitoring or control systems to detect conditions that may lead to ice formation.

In some embodiments, heat tracing may be operated periodically. Periodic heat tracing may provide heat input at scheduled intervals rather than continuously. Periodic heat tracing may be employed when ice formation may occur gradually and may be prevented by periodic heating cycles that may melt any ice that may have begun to form. The frequency and duration of periodic heating cycles may be selected based on the rate of ice formation, the ambient temperature, the thermal mass of the components being heated, or any combination of such factors. Periodic heat tracing may reduce energy consumption compared to continuous heat tracing while still providing effective prevention of ice accumulation.

In some embodiments, heat tracing may be operated on-demand. On-demand heat tracing may provide heat input in response to detected conditions that may indicate ice formation or conditions that may lead to ice formation. On-demand heat tracing may employ sensors to detect temperature, ice presence, flow restriction, or other indicators of ice formation. When sensors detect conditions indicating ice formation or the potential for ice formation, a control system may activate the heat tracing to provide heat input. On-demand heat tracing may reduce energy consumption compared to continuous or periodic heat tracing by providing heat only when conditions indicate that heating may be beneficial.

In some embodiments, on-demand heat tracing may employ temperature sensors to detect conditions that may lead to ice formation. Temperature sensors may be positioned on or near components where ice formation may be undesirable. When the temperature sensors detect temperatures approaching or below the freezing point, the control system may activate heat tracing to raise the temperature of the components above the freezing point. The temperature setpoint for activation of heat tracing may be selected to provide a margin above the freezing point to prevent ice formation before the freezing point is reached.

In some embodiments, on-demand heat tracing may employ ice detection sensors to detect the presence of ice on components. Ice detection sensors may employ one or more or any combination of the following detection methods: optical detection, or capacitive detection, or ultrasonic detection, or vibration-based detection, or any combination thereof. When ice detection sensors detect the presence of ice, the control system may activate heat tracing to melt the detected ice and to prevent further ice accumulation.

In some embodiments, on-demand heat tracing may employ flow sensors to detect flow restrictions that may indicate ice formation within pipes or conduits. Ice formation within pipes or conduits may restrict flow, which may be detected as a decrease in flow rate or an increase in pressure drop across the pipe or conduit. When flow sensors detect flow restrictions that may indicate ice formation, the control system may activate heat tracing to melt the ice and restore normal flow.

In some embodiments, anti-icing measures may include periodic brine injection. Periodic brine injection may comprise the introduction of brine into water flow paths at scheduled intervals or in response to detected conditions. Brine may comprise a solution of water and dissolved salts, and the presence of dissolved salts may depress the freezing point of the solution below the freezing point of pure water. The injection of brine into water flow paths may lower the freezing point of the water in the flow paths, which may prevent ice formation at temperatures where pure water would freeze.

In some embodiments, brine for injection may comprise sodium chloride brine, calcium chloride brine, magnesium chloride brine, potassium chloride brine, or brines comprising other salts or combinations of salts. The concentration of the brine may be selected to achieve a desired freezing point depression. Higher salt concentrations may provide greater freezing point depression but may also increase the corrosivity of the solution and may increase the cost of the brine. The brine concentration may be selected to balance freezing point depression against corrosivity, cost, and other factors.

In some embodiments, periodic brine injection may be performed at scheduled intervals. The intervals between brine injections may be selected based on the rate at which the brine may be diluted or flushed from the system, the ambient temperature, the risk of ice formation, or any combination of such factors. More frequent brine injections may be employed when ambient temperatures are lower or when the risk of ice formation is higher.

In some embodiments, periodic brine injection may be performed in response to detected conditions. Sensors may detect temperature, ice presence, flow restriction, or other indicators of ice formation or the potential for ice formation. When sensors detect conditions indicating the potential for ice formation, a control system may initiate brine injection to lower the freezing point of water in the system and prevent ice formation.

In some embodiments, anti-icing measures may include periodic antifreeze injection. Periodic antifreeze injection may comprise the introduction of antifreeze compounds into water flow paths at scheduled intervals or in response to detected conditions. Antifreeze compounds may comprise substances that may lower the freezing point of water when dissolved or mixed with water. Antifreeze compounds may include one or more or any combination of the following: ethylene glycol, or propylene glycol, or methanol, or ethanol, or glycerol, or any combination thereof.

In some embodiments, the selection of antifreeze compound may be based on the freezing point depression provided, the toxicity of the compound, the compatibility of the compound with system materials, the cost of the compound, or any combination of such factors. Propylene glycol may be selected for applications where toxicity may be a concern because propylene glycol may be less toxic than ethylene glycol. Ethylene glycol may be selected for applications where greater freezing point depression may be desired because ethylene glycol may provide greater freezing point depression per unit concentration than propylene glycol.

In some embodiments, periodic antifreeze injection may be performed at scheduled intervals or in response to detected conditions, similar to periodic brine injection. The concentration of antifreeze in the water may be controlled to achieve a desired freezing point while minimizing the amount of antifreeze used. The antifreeze may be recovered and recycled in some applications to reduce consumption and cost.

In some embodiments, anti-icing measures may include periodic steam injection. Periodic steam injection may comprise the introduction of steam into system components at scheduled intervals or in response to detected conditions. Steam may provide heat to system components, which may melt any ice that may have formed and may raise the temperature of the components above the freezing point. Steam injection may be particularly effective for clearing ice blockages from pipes, conduits, nozzles, or other flow passages where ice may have accumulated.

In some embodiments, steam for injection may be generated by boilers, steam generators, or other steam production equipment. The steam may be introduced into system components through injection ports, nozzles, or other injection devices positioned at locations where ice formation may be problematic. The steam may condense on cold surfaces, releasing latent heat that may melt ice and warm the surfaces.

In some embodiments, periodic steam injection may be performed at scheduled intervals to prevent ice accumulation. The intervals between steam injections may be selected based on the rate of ice formation, the ambient temperature, the thermal mass of the components being treated, or any combination of such factors. Steam injection may be performed more frequently when ambient temperatures are lower or when ice formation rates are higher.

In some embodiments, periodic steam injection may be performed in response to detected conditions. Sensors may detect ice presence, flow restriction, temperature, or other indicators of ice formation. When sensors detect conditions indicating ice formation, a control system may initiate steam injection to melt the ice and restore normal operation.

In some embodiments, anti-icing measures may include vibration mechanisms. Vibration mechanisms may comprise devices configured to impart vibration to system components to dislodge ice that may have formed on the components. Vibration may break the bond between ice and the component surface, causing the ice to detach and fall away from the component. Vibration mechanisms may be employed on pipes, conduits, structural members, tower walls, baffles, or other components where ice may accumulate.

In some embodiments, vibration mechanisms may employ mechanical vibrators. Mechanical vibrators may comprise rotating unbalanced masses, reciprocating masses, or other mechanisms that may generate vibration through mechanical motion. Mechanical vibrators may be attached to components to be vibrated, and the operation of the mechanical vibrators may transmit vibration to the components. The frequency and amplitude of vibration may be selected to effectively dislodge ice while avoiding damage to the components or other system elements.

In some embodiments, vibration mechanisms may employ pneumatic vibrators. Pneumatic vibrators may comprise devices that may generate vibration through the action of compressed air. Pneumatic vibrators may include piston vibrators, ball vibrators, turbine vibrators, or other types of pneumatic vibration devices. Pneumatic vibrators may be powered by compressed air from compressors or compressed air storage systems.

In some embodiments, vibration mechanisms may employ electromagnetic vibrators. Electromagnetic vibrators may comprise devices that may generate vibration through electromagnetic forces acting on a moving element. Electromagnetic vibrators may include solenoid-based vibrators, voice coil vibrators, or other types of electromagnetic vibration devices. Electromagnetic vibrators may be powered by electrical power and may be controlled to provide specific vibration frequencies and amplitudes.

In some embodiments, vibration mechanisms may be operated continuously, periodically, or on-demand. Continuous vibration may prevent ice from adhering to components by continuously disrupting ice formation. Periodic vibration may dislodge ice that may have accumulated during intervals between vibration cycles. On-demand vibration may be activated in response to detected ice accumulation or conditions that may indicate ice formation.

In some embodiments, anti-icing measures may include ultrasonic ice removal. Ultrasonic ice removal may comprise the application of ultrasonic energy to system components to dislodge ice that may have formed on the components. Ultrasonic energy may comprise sound waves at frequencies above the range of human hearing, typically above approximately 20 kilohertz. Ultrasonic energy may break the bond between ice and component surfaces through mechanical vibration at ultrasonic frequencies, through cavitation effects, or through other mechanisms.

In some embodiments, ultrasonic ice removal may employ ultrasonic transducers. Ultrasonic transducers may comprise devices that may convert electrical energy to ultrasonic mechanical vibration. Ultrasonic transducers may be attached to components to be treated, and the operation of the ultrasonic transducers may transmit ultrasonic energy to the components and to any ice that may have formed on the components. The ultrasonic energy may cause the ice to detach from the component surfaces.

In some embodiments, ultrasonic transducers may employ piezoelectric elements. Piezoelectric elements may comprise materials that may change shape in response to applied electrical voltage, and the application of alternating voltage at ultrasonic frequencies may cause the piezoelectric elements to vibrate at ultrasonic frequencies. The vibration of the piezoelectric elements may be transmitted to the components to which the transducers are attached.

In some embodiments, ultrasonic transducers may employ magnetostrictive elements. Magnetostrictive elements may comprise materials that may change shape in response to applied magnetic fields, and the application of alternating magnetic fields at ultrasonic frequencies may cause the magnetostrictive elements to vibrate at ultrasonic frequencies. The vibration of the magnetostrictive elements may be transmitted to the components to which the transducers are attached.

In some embodiments, ultrasonic ice removal may be operated continuously, periodically, or on-demand. Continuous ultrasonic operation may prevent ice from adhering to components by continuously disrupting ice formation at the component surfaces. Periodic ultrasonic operation may dislodge ice that may have accumulated during intervals between ultrasonic treatment cycles. On-demand ultrasonic operation may be activated in response to detected ice accumulation or conditions that may indicate ice formation.

In some embodiments, the frequency of ultrasonic energy may be selected to effectively dislodge ice while avoiding damage to system components. Different frequencies may be more effective for different ice thicknesses, different ice types, different component materials, or different component configurations. The frequency may be fixed, or the frequency may be variable to allow optimization for different conditions.

In some embodiments, anti-icing measures may include hydrophobic coatings on surfaces. Hydrophobic coatings may comprise coatings that may repel water and may reduce the adhesion of water to coated surfaces. Hydrophobic coatings may cause water droplets to bead up on coated surfaces rather than spreading across the surfaces, and the reduced contact between water and the surfaces may reduce the tendency of water to freeze on the surfaces. Hydrophobic coatings may also reduce the adhesion of ice that may form on coated surfaces, which may facilitate ice removal by gravity, by vibration, by airflow, or by other mechanisms.

In some embodiments, hydrophobic coatings may be applied to interior tower walls. Interior tower walls may be exposed to cold air and to water droplets or spray within the tower, and ice may tend to form on the interior tower walls when the wall temperature is below the freezing point. Hydrophobic coatings on the interior tower walls may reduce ice adhesion and may facilitate ice shedding from the walls. Ice that may form on hydrophobic-coated walls may be more easily dislodged by gravity, by vibration, by airflow, or by other mechanisms compared to ice on uncoated walls.

In some embodiments, hydrophobic coatings may be applied to baffles. Baffles within a tower or air conduit may be exposed to cold air and to water droplets or spray, and ice may tend to form on the baffles. Hydrophobic coatings on the baffles may reduce ice adhesion and may facilitate ice shedding from the baffles. The reduced ice accumulation on baffles may maintain the intended airflow characteristics within the tower or air conduit.

In some embodiments, hydrophobic coatings may be applied to pool edges. Pool edges may be exposed to cold air and to water splashing or spray from the pool, and ice may tend to form on the pool edges. Hydrophobic coatings on the pool edges may reduce ice adhesion and may facilitate ice removal from the pool edges. The reduced ice accumulation on pool edges may facilitate ice collection operations and may prevent ice from interfering with mechanical ice removal devices.

In some embodiments, hydrophobic coatings may be applied to basin surfaces. Basin surfaces may be exposed to cold air and to water within the basin, and ice may tend to form on the basin surfaces. Hydrophobic coatings on the basin surfaces may reduce ice adhesion and may facilitate ice shedding from the basin surfaces. The reduced ice adhesion may facilitate the movement of ice within the basin and may facilitate ice collection.

In some embodiments, anti-icing measures may include iceophobic coatings on surfaces. Iceophobic coatings may comprise coatings that may reduce the adhesion of ice to coated surfaces. Iceophobic coatings may be similar to hydrophobic coatings but may be specifically formulated or optimized to reduce ice adhesion rather than water adhesion. Iceophobic coatings may employ surface textures, surface chemistries, or other features that may reduce the bond strength between ice and the coated surface.

In some embodiments, iceophobic coatings may employ micro-scale or nano-scale surface textures. Surface textures at micro-scale or nanoscale may reduce the contact area between ice and the surface, which may reduce the total adhesion force between the ice and the surface. The reduced adhesion force may allow ice to be more easily dislodged by gravity, by vibration, by airflow, or by other mechanisms.

In some embodiments, iceophobic coatings may employ low surface energy materials. Low surface energy materials may include fluoropolymers, silicones, or other materials that may have low surface energy. The low surface energy may reduce the adhesion of ice to the coated surface. Iceophobic coatings employing low surface energy materials may be applied as thin films, as paints, as sprays, or in other forms.

In some embodiments, iceophobic coatings may be applied to the same surfaces as hydrophobic coatings, including interior tower walls, baffles, pool edges, basin surfaces, or other surfaces where ice accumulation may be undesirable. The selection of hydrophobic coatings, iceophobic coatings, or coatings with both hydrophobic and iceophobic properties may depend on the specific application, the expected ice formation conditions, the durability requirements, the cost, or any combination of such factors.

In some embodiments, hydrophobic or iceophobic coatings may be combined with other anti-icing measures. The coatings may reduce ice adhesion, and other anti-icing measures such as heat tracing, vibration, or ultrasonic treatment may dislodge ice that may form despite the reduced adhesion. The combination of coatings with other anti-icing measures may provide more effective ice prevention and removal than either approach alone.

In some embodiments, anti-icing measures may include higher pressure systems. Higher pressure systems may comprise systems configured to operate at elevated pressures that may prevent ice formation or may facilitate ice removal. Higher pressure may affect the freezing point of water, may affect the flow characteristics of water through system components, or may affect the ability of ice to accumulate within system components.

In some embodiments, higher pressure in water flow systems may increase the velocity of water flow through pipes, nozzles, and other components. Higher flow velocities may reduce the residence time of water in cold regions, which may reduce the opportunity for ice to form. Higher flow velocities may also provide greater shear forces that may dislodge ice that may begin to form on component surfaces.

In some embodiments, higher pressure may be employed in spray systems to produce finer droplets or to increase the velocity of spray. Finer droplets may have shorter residence times in cold air before contacting warmer surfaces or falling into pools, which may reduce the opportunity for droplets to freeze in flight. Higher spray velocities may provide greater momentum to droplets, which may reduce the tendency of droplets to be carried by airflow to locations where freezing may be problematic.

In some embodiments, higher pressure may be employed in steam injection systems to provide more effective ice removal. Higher pressure steam may have greater energy content and may provide more rapid heating of ice and frozen components. Higher pressure steam may also penetrate more effectively into ice blockages to melt ice from within the blockage.

In some embodiments, anti-icing measures may include sourcing water from deeper depths where the water may be warmer. In bodies of water such as lakes, rivers, or oceans, water temperature may vary with depth. In many bodies of water, water at greater depths may be warmer than water near the surface, particularly during cold weather when surface water may be cooled by contact with cold air. Sourcing water from deeper depths may provide water at temperatures further above the freezing point, which may reduce the tendency of the water to freeze during heat transfer processes and may reduce the risk of ice formation within system components.

In some embodiments, water intake structures may be positioned at depths where water temperatures may be warmer. The depth of the water intake may be selected based on the temperature profile of the body of water, which may vary seasonally and may vary based on the specific characteristics of the body of water. In stratified lakes, water below the thermocline may be at relatively stable temperatures that may be warmer than surface water during cold weather. In oceans, water at greater depths may be warmer than surface water in polar or sub-polar regions.

In some embodiments, the depth of water intake may be adjustable to allow water to be sourced from different depths based on conditions. Adjustable water intake systems may include intake structures that may be raised or lowered, multiple intake ports at different depths that may be selectively used, or other configurations that may allow the depth of water intake to be varied. The depth of water intake may be adjusted based on temperature measurements at different depths, based on seasonal patterns, or based on other factors.

In some embodiments, sourcing water from deeper depths may provide water with greater thermal energy content. Water at warmer temperatures may contain more sensible heat that may be transferred to cold air during heat transfer processes. The greater thermal energy content of warmer water may increase the total heat transfer from water to air, which may increase the warming of the air and may increase the buoyancy-induced airflow.

In some embodiments, sourcing water from deeper depths may reduce the energy required for anti-icing measures. When water is sourced at warmer temperatures, the water may be less likely to freeze within system components, which may reduce the need for heat tracing, brine injection, steam injection, or other anti-icing measures. The reduced need for anti-icing measures may reduce energy consumption and may reduce operating costs.

In some embodiments, multiple anti-icing measures may be employed in combination. The combination of multiple anti-icing measures may provide more effective ice prevention and removal than any single measure alone. The selection of anti-icing measures to be combined may depend on the specific application, the expected ice formation conditions, the characteristics of the system components, the available energy sources, the cost, or any combination of such factors.

In some embodiments, the operation of anti-icing measures may be controlled by a control system. The control system may receive inputs from sensors that may detect temperature, ice presence, flow restriction, or other parameters relevant to ice formation. The control system may activate, adjust, or deactivate anti-icing measures based on the sensor inputs to prevent ice formation, to remove ice that may have formed, or to optimize the energy consumption of anti-icing measures. The control system may employ control algorithms that may balance ice prevention effectiveness against energy consumption, may prioritize protection of components where ice formation may be most problematic, or may achieve other control objectives.

In some embodiments, the control system may coordinate the operation of multiple anti-icing measures. The control system may activate heat tracing when temperature sensors indicate temperatures approaching the freezing point, may activate vibration mechanisms when ice detection sensors indicate ice accumulation, may initiate brine injection when conditions indicate elevated risk of ice formation, or may coordinate other combinations of anti-icing measures based on detected conditions. The coordination of multiple anti-icing measures may provide comprehensive ice prevention and removal while optimizing energy consumption.

In some embodiments, anti-icing measures may be configured for specific system components based on the characteristics of the components and the expected ice formation conditions. Components with small flow passages, such as nozzles or valves, may be protected by heat tracing or by periodic brine injection to prevent ice blockages. Components with large surfaces, such as tower walls or baffles, may be protected by hydrophobic or iceophobic coatings to reduce ice adhesion and facilitate ice shedding. Components with moving parts, such as actuators or mechanical ice removal devices, may be protected by heat tracing or by vibration mechanisms to prevent ice from interfering with movement.

In some embodiments, the selection and configuration of anti-icing measures may be based on site-specific conditions. Sites with colder ambient temperatures may employ more extensive anti-icing measures than sites with milder temperatures. Sites with access to waste heat or steam may employ heat tracing or steam injection as primary anti-icing measures. Sites with limited energy availability may employ passive measures such as hydrophobic or iceophobic coatings as primary anti-icing measures. The selection and configuration of anti-icing measures may be optimized for the specific conditions and constraints of each site.

In some embodiments, a system may include sensors for monitoring ice conditions within the system. Sensors for monitoring ice conditions may be configured to detect, measure, or otherwise determine parameters related to ice formation, ice accumulation, ice thickness, ice level, or other ice-related characteristics. The sensors may provide data that may be used for monitoring system operation, for controlling system components, for triggering automated responses, for optimizing system performance, or for any combination of such purposes. The sensors may be positioned at various locations within the system where ice monitoring may be beneficial, including within water pools, at pool surfaces, on mechanical ice removal devices, within air conduits, on tower walls, or at other locations.

In some embodiments, a system may include sensors for ice level. Ice level sensors may be configured to detect or measure the level or height of ice accumulation at a surface of a water pool, within a collection zone, at a shallow collection shelf, or at other locations where ice may accumulate. Ice level may refer to the vertical position of the top surface of accumulated ice relative to a reference point, such as the surface of liquid water in a pool, the bottom of a pool, a fixed reference on a pool wall, or another reference. Ice level sensors may provide information about the amount of ice that has accumulated, which may be used to determine when ice removal operations may be initiated, when ice removal operations may be completed, or when other actions may be taken in response to ice accumulation.

In some embodiments, ice level sensors may employ float-based detection. Float-based ice level sensors may comprise floats that may rest on the surface of accumulated ice and may move vertically as the ice level changes. The vertical position of the float may be detected by position sensors, such as linear potentiometers, linear variable differential transformers, magnetostrictive sensors, or other position sensing devices. The detected position of the float may correspond to the ice level, and changes in the detected position may indicate changes in the ice level due to ice accumulation or ice removal.

In some embodiments, ice level sensors may employ ultrasonic detection. Ultrasonic ice level sensors may emit ultrasonic pulses toward the surface of accumulated ice and may detect the reflected pulses. The time between emission and detection of the pulses may be related to the distance between the sensor and the ice surface, which may be used to determine the ice level. Ultrasonic ice level sensors may be positioned above the ice surface, and the sensors may provide non-contact measurement of ice level without physical contact with the ice.

In some embodiments, ice level sensors may employ optical detection. Optical ice level sensors may emit light toward the surface of accumulated ice and may detect reflected light. The intensity, angle, or time-of-flight of the reflected light may be used to determine the ice level. Optical ice level sensors may employ laser light, infrared light, visible light, or other light sources. Optical ice level sensors may provide non-contact measurement of ice level.

In some embodiments, ice level sensors may employ capacitive detection. Capacitive ice level sensors may detect changes in capacitance that may occur as ice accumulates near the sensor. The presence of ice near the sensor may change the dielectric properties of the region near the sensor, which may change the capacitance measured by the sensor. Capacitive ice level sensors may be positioned at fixed locations, and the sensors may detect when ice has accumulated to the level of the sensor.

In some embodiments, ice level sensors may employ radar detection. Radar ice level sensors may emit radar pulses toward the surface of accumulated ice and may detect the reflected pulses. The time between emission and detection of the pulses may be related to the distance between the sensor and the ice surface, which may be used to determine the ice level. Radar ice level sensors may operate at microwave frequencies and may provide non-contact measurement of ice level.

In some embodiments, multiple ice level sensors may be positioned at different locations within a system. Multiple ice level sensors may provide information about ice level at different locations within a water pool, at different collection zones, at different positions along a shallow collection shelf, or at other locations. The data from multiple ice level sensors may be used to determine the distribution of ice accumulation across the system, to identify areas where ice accumulation may be greater or less than other areas, or to provide redundancy in case of sensor failure.

In some embodiments, a system may include sensors for ice thickness. Ice thickness sensors may be configured to detect or measure the thickness of ice that has formed on a surface, that is floating on a water pool, or that has accumulated in other configurations. Ice thickness may refer to the vertical dimension of ice measured from the bottom surface of the ice to the top surface of the ice. Ice thickness sensors may provide information about the amount of ice that has formed, which may be used to determine when ice removal operations may be initiated, to monitor the rate of ice formation, to optimize heat transfer processes, or for other purposes.

In some embodiments, ice thickness sensors may employ ultrasonic detection. Ultrasonic ice thickness sensors may emit ultrasonic pulses into ice and may detect reflections from the boundaries of the ice. The time between emission and detection of pulses reflected from the top and bottom surfaces of the ice may be used to determine the ice thickness. Ultrasonic ice thickness sensors may be positioned in contact with the ice, may be positioned in the water beneath floating ice, or may be positioned in other configurations that may allow ultrasonic pulses to propagate through the ice.

In some embodiments, ice thickness sensors may employ optical detection. Optical ice thickness sensors may emit light into ice and may detect light that has propagated through the ice. The attenuation, scattering, or time-of-flight of light propagating through the ice may be related to the ice thickness. Optical ice thickness sensors may employ laser light, infrared light, or other light sources. Optical ice thickness sensors may be positioned above the ice, below the ice, or at other locations.

In some embodiments, ice thickness sensors may employ electromagnetic detection. Electromagnetic ice thickness sensors may emit electromagnetic waves and may detect the interaction of the electromagnetic waves with ice. The reflection, transmission, or absorption of electromagnetic waves by ice may be related to the ice thickness. Electromagnetic ice thickness sensors may operate at radio frequencies, microwave frequencies, or other frequencies.

In some embodiments, ice thickness sensors may employ mechanical detection. Mechanical ice thickness sensors may comprise probes, pins, or other mechanical elements that may penetrate into ice or may contact the surfaces of ice. The depth of penetration or the positions of contact may be used to determine the ice thickness. Mechanical ice thickness sensors may provide direct measurement of ice thickness through physical contact with the ice.

In some embodiments, ice thickness sensors may be positioned at multiple locations within a system. Multiple ice thickness sensors may provide information about ice thickness at different locations within a water pool, at different positions across a floating ice layer, or at other locations. The data from multiple ice thickness sensors may be used to determine the distribution of ice thickness across the system, to identify areas where ice may be thicker or thinner than other areas, or to provide redundancy in case of sensor failure.

In some embodiments, a system may include sensors for torque on mechanical ice removal devices. Torque sensors may be configured to detect or measure the torque experienced by mechanical ice removal devices during operation. Mechanical ice removal devices such as rakes, augers, rotating scoops, conveyor belts, or scrapers may experience torque loads when engaging with ice, when moving ice, or when encountering resistance during ice removal operations. Torque sensors may provide information about the loads experienced by mechanical ice removal devices, which may be used to detect ice accumulation, to detect blockages or obstructions, to protect mechanical components from overload, to optimize ice removal operations, or for other purposes.

In some embodiments, torque sensors may be positioned on drive shafts of mechanical ice removal devices. Drive shafts may transmit rotational power from motors or other power sources to the working elements of mechanical ice removal devices, such as auger flights, rake tines, scoop elements, or conveyor belt drums. Torque sensors positioned on drive shafts may measure the torque transmitted through the drive shafts, which may be related to the resistance encountered by the mechanical ice removal devices during operation.

In some embodiments, torque sensors may employ strain gauge detection. Strain gauge torque sensors may comprise strain gauges bonded to a shaft or other structural element that may experience torsional strain when torque is applied. The strain gauges may detect the torsional strain, and the detected strain may be related to the applied torque. Strain gauge torque sensors may provide accurate measurement of torque and may be suitable for continuous monitoring of torque during operation.

In some embodiments, torque sensors may employ magnetoelastic detection. Magnetoelastic torque sensors may detect changes in magnetic properties of a shaft or other structural element that may occur when torque is applied. The application of torque may cause changes in the magnetic permeability of the material, which may be detected by magnetic sensors positioned near the shaft. Magnetoelastic torque sensors may provide non-contact measurement of torque.

In some embodiments, torque sensors may employ rotary transformer detection. Rotary transformer torque sensors may employ a rotary transformer to transmit signals from strain gauges or other sensors on a rotating shaft to stationary electronics. The rotary transformer may allow continuous measurement of torque on rotating shafts without the need for slip rings or other contact-based signal transmission methods.

In some embodiments, torque sensors may employ motor current detection. Motor current torque sensors may infer torque from the electrical current drawn by motors driving mechanical ice removal devices. The current drawn by a motor may be related to the torque produced by the motor, and increases in motor current may indicate increases in the torque load on the mechanical ice removal device. Motor current detection may provide an indirect measurement of torque without requiring sensors on the mechanical ice removal device itself.

In some embodiments, torque measurements from torque sensors may be used to detect conditions that may require action. Elevated torque may indicate that a mechanical ice removal device is encountering greater resistance than normal, which may be due to heavy ice accumulation, ice that has frozen to surfaces, blockages or obstructions, mechanical problems, or other conditions. The detection of elevated torque may trigger actions such as increasing the power to the mechanical ice removal device, activating de-icing measures, alerting operators, stopping the mechanical ice removal device to prevent damage, or other actions.

In some embodiments, torque thresholds may be established for triggering actions. A first torque threshold may be established at a level that may indicate normal heavy ice accumulation, and exceeding the first torque threshold may trigger increased power to the mechanical ice removal device or activation of de-icing measures. A second torque threshold may be established at a higher level that may indicate abnormal conditions such as blockages or mechanical problems, and exceeding the second torque threshold may trigger stopping of the mechanical ice removal device and alerting of operators. The torque thresholds may be configurable and may be adjusted based on operating experience, seasonal conditions, or other factors.

In some embodiments, a system may include automatic triggering of extraction systems when thresholds are exceeded. Extraction systems may comprise mechanical ice removal devices, conveyors, augers, or other systems configured to remove ice from water pools, collection zones, or other locations within the system. Automatic triggering may comprise the initiation of extraction system operation by a control system in response to sensor inputs indicating that thresholds have been exceeded. The automatic triggering may allow extraction systems to operate when conditions indicate that ice removal may be beneficial, without requiring manual initiation by operators.

In some embodiments, automatic triggering of extraction systems may be based on ice level thresholds. When ice level sensors detect that ice level has exceeded a threshold, a control system may automatically initiate operation of extraction systems to remove ice and reduce the ice level. The ice level threshold may be set at a level that may indicate sufficient ice accumulation to warrant removal, which may prevent excessive ice accumulation that may interfere with system operation, or that may optimize the efficiency of ice removal operations. The ice level threshold may be configurable and may be adjusted based on operating experience, seasonal conditions, or other factors.

In some embodiments, automatic triggering of extraction systems may be based on ice thickness thresholds. When ice thickness sensors detect that ice thickness has exceeded a threshold, a control system may automatically initiate operation of extraction systems to remove ice. The ice thickness threshold may be set at a thickness that may indicate sufficient ice formation to warrant removal, which may prevent ice from becoming too thick for effective removal by mechanical devices, or that may optimize the quality of ice produced. The ice thickness threshold may be configurable and may be adjusted based on operating experience, seasonal conditions, or other factors.

In some embodiments, automatic triggering of extraction systems may be based on time intervals. A control system may automatically initiate operation of extraction systems at scheduled time intervals, regardless of ice level or ice thickness measurements. Time-based triggering may provide regular ice removal that may prevent excessive ice accumulation, may provide predictable operation for downstream ice handling systems, or may simplify control system logic. Time-based triggering may be used in combination with threshold-based triggering, such that extraction systems may be triggered by either time intervals or threshold exceedance, whichever occurs first.

In some embodiments, automatic triggering of extraction systems may be based on combinations of conditions. A control system may automatically initiate operation of extraction systems when multiple conditions are satisfied, such as when ice level exceeds a threshold and ice thickness exceeds a threshold, or when ice level exceeds a threshold and a minimum time has elapsed since the previous extraction operation. The use of combinations of conditions may provide more sophisticated control of extraction system operation and may optimize ice removal for varying conditions.

In some embodiments, a system may include automatic triggering of de-icing cycles when thresholds are exceeded. De-icing cycles may comprise sequences of operations configured to remove ice from system components, to prevent ice accumulation on system components, or to restore normal operation of system components that may have been affected by ice. De-icing cycles may include activation of heat tracing, injection of steam, injection of brine or antifreeze, activation of vibration mechanisms, activation of ultrasonic ice removal, or other de-icing measures as described herein. Automatic triggering may comprise the initiation of de-icing cycles by a control system in response to sensor inputs indicating that thresholds have been exceeded.

In some embodiments, automatic triggering of de-icing cycles may be based on torque thresholds. When torque sensors on mechanical ice removal devices detect that torque has exceeded a threshold, a control system may automatically initiate a de-icing cycle to address the condition causing the elevated torque. The de-icing cycle may include activation of heat tracing on the mechanical ice removal device, injection of steam to melt ice that may be causing resistance, activation of vibration to dislodge ice, or other de-icing measures. The torque threshold may be set at a level that may indicate ice-related resistance that may be addressed by de-icing measures, and the threshold may be configurable.

In some embodiments, automatic triggering of de-icing cycles may be based on temperature thresholds. When temperature sensors detect that temperatures at system components have fallen below a threshold, a control system may automatically initiate a de-icing cycle to prevent ice formation on the components. The de-icing cycle may include activation of heat tracing to raise component temperatures above the freezing point, or other de-icing measures. The temperature threshold may be set at a level above the freezing point to provide a margin for preventing ice formation before the freezing point is reached.

In some embodiments, automatic triggering of de-icing cycles may be based on flow thresholds. When flow sensors detect that flow rates through pipes, nozzles, or other flow passages have fallen below a threshold, a control system may automatically initiate a de-icing cycle to address potential ice blockages. The de-icing cycle may include injection of steam to melt ice blockages, activation of heat tracing to prevent further ice formation, or other de-icing measures. The flow threshold may be set at a level that may indicate flow restriction due to ice formation.

In some embodiments, automatic triggering of de-icing cycles may be based on ice detection. When ice detection sensors detect the presence of ice on system components, a control system may automatically initiate a de-icing cycle to remove the detected ice. The de-icing cycle may include activation of heat tracing, vibration, ultrasonic treatment, or other de-icing measures appropriate for the component where ice has been detected.

In some embodiments, de-icing cycles may include sequences of multiple de-icing measures. A de-icing cycle may begin with activation of heat tracing to raise component temperatures, may continue with activation of vibration to dislodge ice that may have been loosened by heating, and may conclude with verification that ice has been removed through sensor measurements. The sequence of de-icing measures may be configured to provide effective ice removal while minimizing energy consumption and minimizing disruption to system operation.

In some embodiments, de-icing cycles may be configured with different intensities or durations based on the severity of the detected condition. A minor threshold exceedance may trigger a short de-icing cycle with moderate intensity de-icing measures. A major threshold exceedance may trigger a longer de-icing cycle with more intensive de-icing measures. The configuration of de-icing cycle intensity and duration based on condition severity may optimize the response to varying conditions.

In some embodiments, a control system may coordinate automatic triggering of extraction systems and de-icing cycles. The control system may receive inputs from ice level sensors, ice thickness sensors, torque sensors, temperature sensors, flow sensors, ice detection sensors, or other sensors. The control system may compare sensor inputs to thresholds and may initiate extraction system operation, de-icing cycles, or both based on the comparison results. The control system may coordinate the timing of extraction system operation and de-icing cycles to avoid conflicts and to optimize overall system operation.

In some embodiments, the control system may employ logic to determine appropriate responses to threshold exceedances. The logic may consider which thresholds have been exceeded, the magnitude of the exceedance, the rate of change of sensor values, the current operating state of the system, the availability of extraction systems and de-icing measures, or other factors. The logic may select the most appropriate response from among available options, such as initiating extraction system operation, initiating a de-icing cycle, alerting operators, adjusting operating parameters, or other responses.

In some embodiments, the control system may employ machine learning to optimize automatic triggering of extraction systems and de-icing cycles. Machine learning algorithms may analyze historical data from sensors and may identify patterns that may predict when extraction system operation or de-icing cycles may be beneficial. The machine learning algorithms may adjust thresholds, may adjust the timing of automatic triggering, may adjust the configuration of de-icing cycles, or may make other adjustments to optimize system performance based on learned patterns.

In some embodiments, the control system may provide alerts to operators when automatic triggering occurs. Alerts may be provided through one or more or any combination of the following: visual displays, or audible alarms, or text messages, or email notifications, or mobile application notifications, or any combination thereof. The alerts may inform operators that extraction system operation or de-icing cycles have been automatically initiated, may provide information about the conditions that triggered the automatic response, and may allow operators to monitor or override the automatic response if desired.

In some embodiments, operators may configure the thresholds and parameters for automatic triggering. Operators may adjust ice level thresholds, ice thickness thresholds, torque thresholds, temperature thresholds, flow thresholds, or other thresholds based on operating experience, seasonal conditions, or other factors. Operators may configure the de-icing cycle sequences, durations, and intensities. Operators may enable or disable automatic triggering for specific extraction systems or de-icing measures. The configurability of automatic triggering may allow the system to be optimized for site-specific conditions and operator preferences.

In some embodiments, the system may log data related to automatic triggering of extraction systems and de-icing cycles. Logged data may include sensor values at the time of triggering, the thresholds that were exceeded, the extraction systems or de-icing measures that were activated, the duration of the response, the sensor values after the response, or other relevant data. The logged data may be used for analysis of system performance, for optimization of thresholds and parameters, for troubleshooting, for reporting, or for other purposes.

In some embodiments, a system may include high-resolution temperature mapping. High-resolution temperature mapping may comprise the measurement of temperature at multiple locations throughout the system to create a detailed map or profile of temperature distribution. High-resolution temperature mapping may provide information about temperature variations within the system, which may be used for monitoring, control, optimization, troubleshooting, or other purposes. High-resolution temperature mapping may reveal temperature gradients, hot spots, cold spots, or other temperature features that may be relevant to system operation.

In some embodiments, high-resolution temperature mapping may employ digital temperature sensors. Digital temperature sensors may comprise temperature sensors that may produce digital output signals, which may be transmitted to a control system or data acquisition system for processing. Digital temperature sensors may include one or more or any combination of the following: digital thermometers, or digital thermocouples, or digital resistance temperature detectors, or digital thermistors, or integrated circuit temperature sensors, or any combination thereof. Digital temperature sensors may provide accurate temperature measurements with digital output that may be easily transmitted and processed.

In some embodiments, digital temperature sensors may be connected to a data acquisition system through wired connections. Wired connections may include one or more or any combination of the following: individual wires to each sensor, or multi-drop bus connections, or serial communication links, or Ethernet connections, or any combination thereof. Wired connections may provide reliable data transmission and may not be affected by wireless interference or signal propagation issues.

In some embodiments, digital temperature sensors may be connected to a data acquisition system through wireless connections. Wireless connections may include one or more or any combination of the following: radio frequency links, or WiFi connections, or Bluetooth connections, or Zigbee connections, or LoRa connections, or cellular connections, or any combination thereof. Wireless connections may simplify installation, may allow sensors to be positioned in locations where wired connections may be difficult, and may allow sensors to be repositioned without rewiring.

In some embodiments, digital temperature sensors may be positioned throughout a tower height. Sensors may be positioned at multiple elevations within a tower or air conduit to measure the temperature of air at different heights. The temperature measurements at different heights may reveal the temperature profile of air as the air rises through the tower, may indicate the effectiveness of heat transfer at different locations, may identify regions where additional heat transfer may be beneficial, or may provide other information relevant to system operation. The spacing between sensors along the tower height may be selected to provide desired resolution of the temperature profile.

In some embodiments, digital temperature sensors may be positioned across a pool surface. Sensors may be positioned at multiple locations across the surface of a water pool to measure the temperature of water or ice at different positions. The temperature measurements at different positions may reveal temperature variations across the pool surface, may indicate regions where heat transfer may be more or less effective, may identify regions where ice formation may be occurring, or may provide other information relevant to system operation. The spacing between sensors across the pool surface may be selected to provide desired resolution of the temperature distribution.

In some embodiments, digital temperature sensors may be positioned within fluid flow paths. Sensors may be positioned in pipes, conduits, nozzles, or other fluid flow paths to measure the temperature of fluid at different locations along the flow path. The temperature measurements along the flow path may reveal temperature changes as fluid flows through the system, may indicate heat transfer or heat loss at different locations, may identify regions where freezing may be occurring, or may provide other information relevant to system operation.

In some embodiments, digital temperature sensors may be positioned on or near system components. Sensors may be positioned on tower walls, on baffles, on mechanical ice removal devices, on heat exchangers, on pumps, on valves, or on other system components to measure the temperature of the components. The temperature measurements of components may indicate whether components are at risk of ice formation, may indicate the effectiveness of heat tracing or other anti-icing measures, may indicate thermal stress on components, or may provide other information relevant to system operation.

In some embodiments, high-resolution temperature mapping may employ thermal imaging. Thermal imaging may comprise the use of infrared cameras, thermal cameras, or other imaging devices that may detect infrared radiation emitted by objects and may produce images representing the temperature distribution across a field of view. Thermal imaging may provide temperature measurements across a large area without requiring individual sensors at each measurement point. Thermal imaging may reveal temperature patterns, gradients, and variations that may not be apparent from individual point measurements.

In some embodiments, thermal imaging may be employed to measure temperature distribution across a pool surface. A thermal imaging camera may be positioned above a pool surface and may capture images representing the temperature distribution across the pool surface. The thermal images may reveal regions of warmer water, regions of cooler water, regions where ice may be forming, or other temperature features. The thermal images may be captured continuously, periodically, or on demand.

In some embodiments, thermal imaging may be employed to measure temperature distribution on tower walls or other structures. A thermal imaging camera may be positioned to view tower walls, baffles, or other structures and may capture images representing the temperature distribution on the structures. The thermal images may reveal regions where ice may be forming, regions where heat tracing may be effective, regions where heat loss may be occurring, or other temperature features.

In some embodiments, thermal imaging may be employed to measure temperature distribution of air within a tower or air conduit. Thermal imaging of air may be achieved by imaging surfaces that may be in thermal equilibrium with the air, by imaging particles or droplets suspended in the air, or by other techniques. The thermal images may reveal temperature variations within the air, may indicate the effectiveness of heat transfer, may identify regions of stratification, or may provide other information relevant to system operation.

In some embodiments, thermal imaging cameras may be fixed in position to provide continuous monitoring of specific areas. Fixed thermal imaging cameras may be positioned to view pool surfaces, tower interiors, collection zones, or other areas of interest. The fixed cameras may provide continuous or periodic thermal images that may be analyzed for temperature trends, for detection of anomalies, or for other purposes.

In some embodiments, thermal imaging cameras may be movable to allow imaging of different areas. Movable thermal imaging cameras may be mounted on pan-tilt mechanisms, on robotic arms, on drones, or on other movable platforms. The movable cameras may be repositioned to view different areas of the system, which may allow a single camera to provide thermal imaging coverage of a larger area than a fixed camera.

In some embodiments, thermal imaging data may be processed to extract temperature measurements. Image processing algorithms may analyze thermal images to identify regions of interest, to calculate average temperatures, to identify maximum and minimum temperatures, to detect temperature gradients, or to extract other temperature-related information. The extracted temperature measurements may be logged, may be displayed to operators, may be used for control purposes, or may be used for other purposes.

In some embodiments, thermal imaging data may be combined with data from digital temperature sensors. The combination of thermal imaging data and point sensor data may provide comprehensive temperature information that may leverage the strengths of both measurement approaches. Thermal imaging may provide broad spatial coverage, while point sensors may provide accurate measurements at specific locations. The combined data may be used to calibrate thermal imaging measurements, to validate point sensor measurements, or to provide complementary information for monitoring and control.

In some embodiments, temperature measurements from high-resolution temperature mapping may be logged by a control system or data acquisition system. The logged temperature data may be stored in databases, data historians, data files, or other data storage systems. The logged data may be used for real-time monitoring, for historical analysis, for trend identification, for predictive modeling, for reporting, or for other purposes. The logging may be continuous, periodic, or event triggered.

In some embodiments, temperature measurements from high-resolution temperature mapping may be displayed to operators. Displays may include one or more or any combination of the following: numerical displays of temperature values, or graphical displays of temperature profiles, or color-coded displays of temperature distributions, or thermal images, or trend charts, or any combination thereof. The displays may allow operators to monitor temperature conditions throughout the system, to identify areas of concern, to verify the effectiveness of control actions, or to make decisions about system operation.

In some embodiments, temperature measurements from high-resolution temperature mapping may be used for control purposes. A control system may receive temperature measurements from digital sensors, from thermal imaging, or from both, and may use the temperature measurements as inputs for control algorithms. The control algorithms may adjust operating parameters such as water flow rates, air flow rates, heat tracing activation, de-icing cycle initiation, or other parameters based on the temperature measurements. The use of high-resolution temperature data for control may allow more precise and responsive control than would be possible with fewer temperature measurements.

In some embodiments, data from high-resolution temperature mapping may be used to optimize pump speeds. Pump speeds may affect the flow rate of fluid through the system, which may affect heat transfer rates, temperature distributions, and other system characteristics. A control system may analyze temperature data from high-resolution temperature mapping to identify regions where temperatures may be higher or lower than desired. The control system may adjust pump speeds to modify fluid flow rates, which may affect temperature distributions. For example, if temperature mapping reveals a region of the pool where temperatures are lower than desired, the control system may increase pump speed to increase circulation and bring warmer water to the region.

In some embodiments, data from high-resolution temperature mapping may be used to optimize water-air contacting. Water-air contacting may be affected by spray patterns, spray rates, pool levels, air flow rates, or other factors. A control system may analyze temperature data from high-resolution temperature mapping to identify regions where heat transfer may be more or less effective. The control system may adjust spray nozzle operation, pool circulation, air flow control elements, or other equipment to optimize water-air contacting based on the temperature data. For example, if temperature mapping reveals that air temperature is not increasing as expected in a particular region, the control system may increase spray rate in that region to enhance heat transfer.

In some embodiments, data from high-resolution temperature mapping may be used to optimize turbine operation. Turbine operation may be affected by air flow velocity, air temperature, air density, or other factors. A control system may analyze temperature data from high-resolution temperature mapping to determine the temperature of air approaching turbines, the temperature gradient along the tower height, or other temperature characteristics relevant to turbine operation. The control system may adjust turbine blade pitch, turbine speed, turbine loading, or other turbine parameters to optimize power generation based on the temperature data.

In some embodiments, data from high-resolution temperature mapping may be used to optimize shutters or other airflow control elements. Shutters may be adjusted to control airflow into, through, or out of the system. A control system may analyze temperature data from high-resolution temperature mapping to determine the temperature distribution within the system and may adjust shutter positions to optimize airflow distribution based on the temperature data. For example, if temperature mapping reveals that one side of the system has higher air temperatures than another side, the control system may adjust shutters to direct more airflow through the higher temperature region to maximize buoyancy-induced airflow.

In some embodiments, data from high-resolution temperature mapping may be used to detect anomalies. Anomalies may include unexpected temperature patterns, sudden temperature changes, temperatures outside expected ranges, or other temperature conditions that may indicate problems or unusual conditions. A control system may compare temperature data from high-resolution temperature mapping to expected patterns or to historical data and may identify anomalies that may warrant investigation or action. The detection of anomalies may trigger alerts to operators, may trigger automatic responses, or may trigger logging of additional data for analysis.

In some embodiments, data from high-resolution temperature mapping may be used for predictive purposes. Predictive algorithms may analyze temperature data to predict future temperature conditions, to predict ice formation, to predict system performance, or to make other predictions. The predictions may be used for proactive control actions, for scheduling of maintenance or ice removal operations, for optimization of system operation, or for other purposes. The predictive algorithms may employ statistical methods, machine learning methods, physical models, or other predictive techniques.

In some embodiments, the resolution of temperature mapping may be selected based on the requirements of the application. Higher resolution may provide more detailed temperature information but may require more sensors or more sophisticated thermal imaging equipment. Lower resolution may provide less detailed temperature information but may be less costly and may be sufficient for some applications. The resolution may be different in different regions of the system, with higher resolution in regions where detailed temperature information may be more valuable and lower resolution in regions where less detailed information may be sufficient.

In some embodiments, the frequency of temperature measurements may be selected based on the requirements of the application. More frequent measurements may provide more timely temperature information and may allow faster response to changing conditions. Less frequent measurements may reduce data volume and processing requirements. The measurement frequency may be different for different sensors or different regions of the system, with more frequent measurements in regions where rapid temperature changes may occur and less frequent measurements in regions where temperatures may be more stable.

In some embodiments, the accuracy of temperature measurements may be verified through calibration. Calibration may comprise the comparison of sensor measurements to reference standards and the adjustment of sensor readings to match the reference standards. Calibration may be performed during installation, periodically during operation, or when sensor accuracy may be in question. Calibration may ensure that temperature measurements from high-resolution temperature mapping are accurate and may be relied upon for monitoring, control, and optimization purposes.

In some embodiments, a process may further comprise converting kinetic energy from the airflow into electrical or mechanical power using a power generation unit fluidly connected to an air conduit. The power generation unit may be configured to extract energy from the moving air within the air conduit and to convert the extracted energy into a usable form such as electrical power or mechanical power. The power generation unit may be positioned within the air conduit, at an inlet of the air conduit, at an outlet of the air conduit, or at other locations where airflow may be present and where energy extraction may be performed.

In some embodiments, harnessing the airflow may comprise converting kinetic energy from the airflow into electrical or mechanical power using a power generation unit fluidly connected to the air conduit. The kinetic energy of the airflow may be related to the mass flow rate of the air and the velocity of the air, and the power generation unit may be configured to capture a portion of the kinetic energy and to convert the captured energy into electrical or mechanical power. The electrical power generated may be transmitted to an electrical grid, may be stored in energy storage systems, may be used to power on-site equipment, or may be employed for other purposes. The mechanical power generated may be employed to drive pumps, compressors, conveyors, or other mechanical equipment.

In some embodiments, the power generation unit may comprise an air turbine. An air turbine may comprise a device configured to extract energy from moving air through the rotation of blades, vanes, or other rotating elements. The moving air may impinge on the blades or vanes of the air turbine, causing the blades or vanes to rotate. The rotation of the blades or vanes may drive a shaft, which may be connected to a generator for electrical power generation or may be connected to mechanical equipment for mechanical power transmission. Air turbines may be configured in various types and configurations depending on the characteristics of the airflow, the desired power output, the operating conditions, or other factors.

In some embodiments, an air turbine may comprise a Wells turbine. A Wells turbine may comprise a type of air turbine that may be configured to rotate in the same direction regardless of the direction of airflow through the turbine. Wells turbines may employ symmetrical airfoil blades that may generate lift and cause rotation when air flows through the turbine in either direction. Wells turbines may be suitable for applications where airflow direction may vary or where bidirectional airflow may be present. The symmetrical blade design of Wells turbines may allow the turbine to operate without the need for blade pitch adjustment when airflow direction changes.

In some embodiments, an air turbine may comprise an impulse turbine. An impulse turbine may comprise a type of air turbine in which the kinetic energy of the airflow may be converted to rotational energy through the impulse of air jets impinging on turbine blades. In an impulse turbine, the pressure of the air may be converted to velocity in nozzles or guide vanes before the air impinges on the turbine blades. The turbine blades may be configured to redirect the air jets, and the change in momentum of the air may impart a force on the blades that may cause rotation. Impulse turbines may be suitable for applications with high-velocity airflow.

In some embodiments, an air turbine may comprise a radial turbine. A radial turbine may comprise a type of air turbine in which the airflow may enter or exit the turbine in a radial direction relative to the axis of rotation. Radial turbines may include radial inflow turbines, in which air may enter at the outer radius and may flow inward toward the axis, and radial outflow turbines, in which air may enter near the axis and may flow outward toward the outer radius. Radial turbines may be compact and may be suitable for applications where space constraints may limit the use of axial turbines.

In some embodiments, an air turbine may comprise a cross-flow turbine. A cross-flow turbine may comprise a type of air turbine in which the airflow may pass through the turbine blades twice, entering on one side of the turbine, passing through the interior, and exiting on the opposite side. Cross-flow turbines may employ a cylindrical rotor with blades arranged around the circumference. The airflow may enter through a portion of the circumference, may pass through the interior of the rotor, and may exit through another portion of the circumference. Cross-flow turbines may be suitable for applications with varying airflow directions and may provide consistent performance across a range of airflow angles.

In some embodiments, an air turbine may comprise an axial-flow turbine. An axial-flow turbine may comprise a type of air turbine in which the airflow may pass through the turbine in a direction substantially parallel to the axis of rotation. Axial-flow turbines may employ blades mounted on a rotor that may rotate about an axis aligned with the direction of airflow. The airflow may impinge on the blades, causing the rotor to rotate. Axial-flow turbines may be suitable for applications with unidirectional airflow and may provide high efficiency at design conditions. Axial-flow turbines may be configured with single stages or multiple stages depending on the pressure ratio and power requirements.

In some embodiments, an air turbine may comprise a Savonius turbine. A Savonius turbine may comprise a type of air turbine that may employ curved or semi-cylindrical blades arranged around a vertical or horizontal axis. Savonius turbines may operate based on differential drag on the blades, with the concave side of a blade experiencing greater drag than the convex side when facing the airflow. The differential drag may cause the turbine to rotate. Savonius turbines may be self-starting, may operate at low airflow velocities, and may be relatively simple in construction. Savonius turbines may be suitable for applications where simplicity and reliability may be prioritized over maximum efficiency.

In some embodiments, an air turbine may be configured with variable pitch blades. Variable pitch blades may comprise turbine blades that may be rotated about a blade axis to change the angle of the blades relative to the airflow. The pitch angle of the blades may affect the aerodynamic characteristics of the blades, the amount of energy extracted from the airflow, the rotational speed of the turbine, and other operating characteristics. Variable pitch blades may allow the turbine to be optimized for varying airflow conditions, to control the power output of the turbine, to prevent overspeed conditions, or to achieve other operational objectives.

In some embodiments, the pitch of variable pitch blades may be adjusted in response to airflow velocity. At lower airflow velocities, the blade pitch may be adjusted to maximize energy extraction from the available airflow. At higher airflow velocities, the blade pitch may be adjusted to limit energy extraction and to prevent the turbine from exceeding safe operating speeds. The adjustment of blade pitch in response to airflow velocity may allow the turbine to operate efficiently across a range of airflow conditions.

In some embodiments, the pitch of variable pitch blades may be adjusted in response to power demand. When power demand is high, the blade pitch may be adjusted to maximize power output from the turbine. When power demand is low, the blade pitch may be adjusted to reduce power output, which may reduce wear on the turbine and associated equipment. The adjustment of blade pitch in response to power demand may allow the turbine to match power generation to demand.

In some embodiments, the pitch of variable pitch blades may be adjusted by pitch actuators. Pitch actuators may comprise devices configured to rotate the blades about the blade axis to change the pitch angle. Pitch actuators may include one or more or any combination of the following: electric motors, or hydraulic cylinders, or pneumatic cylinders, or mechanical linkages, or any combination thereof. The pitch actuators may be controlled by a control system that may receive inputs from sensors measuring airflow velocity, turbine speed, power output, or other parameters, and may calculate the desired blade pitch based on the inputs.

In some embodiments, an air turbine may be configured with adjustable inlet guide vanes. Adjustable inlet guide vanes may comprise vanes positioned upstream of the turbine blades that may be adjusted to change the direction or velocity of airflow entering the turbine. The inlet guide vanes may direct the airflow onto the turbine blades at an optimal angle, may impart swirl to the airflow, may accelerate or decelerate the airflow, or may achieve other effects on the airflow characteristics. Adjustable inlet guide vanes may allow the turbine to be optimized for varying airflow conditions without adjusting the turbine blades themselves.

In some embodiments, the angle of adjustable inlet guide vanes may be adjusted in response to airflow conditions. At different airflow velocities or airflow directions, the optimal angle of the inlet guide vanes may be different. A control system may receive inputs from sensors measuring airflow conditions and may adjust the angle of the inlet guide vanes to optimize the airflow entering the turbine. The adjustment of inlet guide vane angle may improve turbine efficiency, may increase power output, may reduce turbine wear, or may achieve other benefits.

In some embodiments, adjustable inlet guide vanes may be actuated by guide vane actuators. Guide vane actuators may comprise devices configured to rotate the guide vanes to change the guide vane angle. Guide vane actuators may include one or more or any combination of the following: electric motors, or hydraulic cylinders, or pneumatic cylinders, or mechanical linkages, or any combination thereof. The guide vane actuators may be controlled by a control system that may coordinate the adjustment of multiple guide vanes to achieve desired airflow characteristics.

In some embodiments, an air turbine may be configured with an active braking system. An active braking system may comprise a system configured to slow or stop the rotation of the turbine in response to control signals. Active braking may be employed to prevent overspeed conditions, to stop the turbine for maintenance, to respond to emergency conditions, or for other purposes. Active braking systems may provide controlled deceleration of the turbine, which may reduce stress on turbine components compared to sudden stops.

In some embodiments, an active braking system may employ mechanical brakes. Mechanical brakes may comprise devices that may apply friction to a rotating component of the turbine to slow or stop rotation. Mechanical brakes may include one or more or any combination of the following: disc brakes, or drum brakes, or band brakes, or caliper brakes, or any combination thereof. Mechanical brakes may be actuated by hydraulic pressure, pneumatic pressure, electric actuators, or other actuation mechanisms. Mechanical brakes may provide reliable braking capability and may be capable of holding the turbine stationary when the brakes are engaged.

In some embodiments, an active braking system may employ aerodynamic braking. Aerodynamic braking may comprise the adjustment of turbine blade pitch or other aerodynamic surfaces to create drag that may slow the turbine rotation. Aerodynamic braking may be achieved by pitching the turbine blades to a feathered position where the blades may present minimal surface area to the airflow, or by pitching the blades to a position where the blades may create drag that opposes rotation. Aerodynamic braking may provide smooth deceleration and may reduce wear on mechanical brake components.

In some embodiments, an active braking system may employ electrical braking. Electrical braking may comprise the application of electrical loads or electrical resistance to the generator connected to the turbine, which may create a braking torque that may slow the turbine rotation. Electrical braking may be achieved by connecting the generator to resistive loads, by short-circuiting the generator windings, or by other electrical means. Electrical braking may provide controlled deceleration and may allow the braking energy to be dissipated as heat or to be recovered for other uses.

In some embodiments, an active braking system may employ a combination of braking methods. A combination of mechanical braking, aerodynamic braking, and electrical braking may provide redundancy and may allow different braking methods to be employed for different situations. Aerodynamic braking may be employed for routine speed control, electrical braking may be employed for controlled deceleration, and mechanical braking may be employed for emergency stops or for holding the turbine stationary. The combination of braking methods may provide comprehensive braking capability across a range of operating conditions.

In some embodiments, a system may employ multiple air turbines. Multiple air turbines may be arranged within an air conduit, at inlets of an air conduit, at outlets of an air conduit, or at other locations where airflow may be present. The use of multiple air turbines may increase the total power generation capacity of the system, may provide redundancy in case of turbine failure, may allow different turbines to be optimized for different airflow conditions, or may provide other benefits.

In some embodiments, a system may employ multiple vertically oriented air turbines. Vertically oriented air turbines may comprise air turbines with a vertical axis of rotation, such that the turbine blades may rotate in a horizontal plane. Vertically oriented air turbines may be suitable for capturing airflow from multiple directions without the need to reorient the turbine. Multiple vertically oriented air turbines may be arranged around a tower base, within a tower structure, or at other locations within the system.

In some embodiments, a system may employ multiple horizontal axis air turbines. Horizontal axis air turbines may comprise air turbines with a horizontal axis of rotation, such that the turbine blades may rotate in a vertical plane. Horizontal axis air turbines may be oriented to face the direction of airflow and may be suitable for capturing airflow from a specific direction. Multiple horizontal axis air turbines may be arranged around a tower base, within a tower structure, or at other locations within the system.

In some embodiments, multiple air turbines may be arranged around a tower base. The arrangement of multiple air turbines around the tower base may allow airflow entering the tower from different directions to be captured by different turbines. The turbines may be positioned at regular intervals around the perimeter of the tower base, or the turbines may be positioned at irregular intervals depending on the configuration of the system and the expected airflow patterns. The arrangement of turbines around the tower base may allow the system to capture airflow from multiple directions and may increase the total power generation capacity.

In some embodiments, the arrangement of multiple air turbines around a tower base may allow all turbines to contribute to power generation regardless of which shutters are open or closed. When shutters on one side of the tower are open and shutters on another side are closed to harness wind, airflow may enter through the open shutters and may flow through the interior of the tower base region before entering the central tower structure. The airflow may pass through or near multiple turbines positioned around the tower base, and the multiple turbines may extract energy from the airflow. The configuration may allow the system to harness wind energy through selective shutter operation while maintaining power generation from multiple turbines.

In some embodiments, the airflow path within the tower base region may be configured to allow air to flow freely between different turbines. The free flow of air between turbines may allow airflow entering through any open shutter to reach multiple turbines, which may maximize the utilization of the available airflow for power generation. The configuration may include open spaces, channels, or passages that may connect the regions around different turbines, allowing air to flow from one turbine region to another.

In some embodiments, the multiple air turbines arranged around the tower base may be independently controllable. Independent control may allow each turbine to be operated at different speeds, different power outputs, or different operating modes depending on the airflow conditions at each turbine location. Independent control may allow turbines in regions with higher airflow to operate at higher power outputs while turbines in regions with lower airflow may operate at lower power outputs or may be idled. The independent control of multiple turbines may optimize the total power generation from the available airflow.

In some embodiments, the multiple air turbines may be connected to a common electrical system. The common electrical system may collect the electrical power generated by the multiple turbines and may transmit the collected power to an electrical grid, to energy storage systems, to on-site loads, or to other destinations. The common electrical system may include power electronics that may condition the electrical power from the turbines, may synchronize the power from multiple turbines, or may perform other power management functions.

In some embodiments, the multiple air turbines may be connected to separate electrical systems. Separate electrical systems may allow the power from different turbines to be directed to different destinations, may provide redundancy in case of electrical system failure, or may allow different turbines to operate at different electrical characteristics. The separate electrical systems may be interconnected through switches or other devices that may allow power to be transferred between systems when desired.

In some embodiments, the selection of air turbine type may be based on the characteristics of the airflow within the system. Airflow characteristics that may influence turbine selection may include one or more or any combination of the following: airflow velocity, or airflow direction variability, or airflow turbulence, or airflow temperature, or airflow density, or any combination thereof. Different turbine types may be better suited for different airflow characteristics, and the selection of turbine type may optimize power generation for the expected airflow conditions.

In some embodiments, the selection of air turbine type may be based on the operating requirements of the system. Operating requirements that may influence turbine selection may include one or more or any combination of the following: desired power output, or desired efficiency, or desired reliability, or desired maintenance requirements, or desired cost, or any combination thereof. Different turbine types may offer different trade-offs among these operating requirements, and the selection of turbine type may balance the various requirements based on the priorities of the application.

In some embodiments, the air turbines may be configured for operation in cold environments. Cold environment operation may involve temperatures below the freezing point of water, and the air turbines may be configured to resist ice formation on turbine blades, to operate despite the presence of ice, to shed ice that may form, or to be protected by anti-icing measures. Turbine blades may be heated, may be treated with anti-icing coatings, or may be configured with geometries that may minimize ice accumulation. Bearings, seals, lubricants, and other turbine components may be selected for low-temperature operation.

In some embodiments, the air turbines may be configured for ease of maintenance. Maintenance considerations may include accessibility for inspection, ease of replacement of worn components, availability of replacement parts, and resistance to corrosion or degradation. The air turbines may be positioned in locations that may be accessible for maintenance activities, may be configured with modular components that may be replaced without replacing the entire turbine, or may be constructed from materials that may resist degradation in the operating environment.

In some embodiments, the air turbines may be configured with sensors for monitoring turbine operation. Sensors may measure one or more or any combination of the following: turbine rotational speed, or turbine power output, or turbine vibration, or turbine temperature, or blade pitch angle, or guide vane angle, or any combination thereof. The sensor measurements may be transmitted to a control system for monitoring, for control purposes, for predictive maintenance, or for other purposes. The sensors may provide data that may be used to optimize turbine operation, to detect anomalies that may indicate problems, or to schedule maintenance activities.

In some embodiments, the operation of air turbines may be controlled by a control system. The control system may receive inputs from sensors measuring airflow conditions, turbine operating parameters, power demand, or other relevant parameters. The control system may calculate control outputs for turbine blade pitch, inlet guide vane angle, braking system activation, or other controllable parameters. The control system may implement control algorithms that may optimize power generation, may protect the turbines from damage, may respond to changing conditions, or may achieve other control objectives.

In some embodiments, the control system may coordinate the operation of multiple air turbines. The coordination may include balancing the power output among multiple turbines, sequencing the startup or shutdown of multiple turbines, responding to the failure of one turbine by adjusting the operation of other turbines, or other coordination functions. The coordinated control of multiple turbines may optimize the total power generation from the system and may provide reliable operation despite variations in airflow conditions or turbine availability.

In some embodiments, the positioning of a power generation unit relative to a thermal exchange zone within an air conduit may be configured in various arrangements. The power generation unit may be positioned such that airflow first contacts the thermal exchange zone, then the power generation unit. Alternatively, the power generation unit may be positioned such that airflow first contacts the power generation unit, then the thermal exchange zone. The selection of positioning may depend on the desired airflow characteristics, the desired power generation characteristics, the configuration of the air conduit, or any combination of such factors.

In some embodiments, a process may comprise airflow first contacting a thermal exchange zone, then a power generation unit. In such a configuration, air may enter an air conduit at a first elevation, may pass through or over a thermal exchange zone where heat may be transferred from a fluid to the air, and may then pass through a power generation unit such as an air turbine. The air may be warmed by the heat transfer in the thermal exchange zone before reaching the power generation unit. The warming of the air may reduce the density of the air, which may increase the buoyancy-induced airflow velocity. The increased airflow velocity may provide greater kinetic energy for extraction by the power generation unit. The positioning of the thermal exchange zone upstream of the power generation unit may allow the power generation unit to operate with warmed air at increased velocity.

In some embodiments, a process may comprise airflow first contacting a power generation unit, then a thermal exchange zone. In such a configuration, air may enter an air conduit at a first elevation, may pass through a power generation unit such as an air turbine, and may then pass through or over a thermal exchange zone where heat may be transferred from a fluid to the air. The air may be at ambient temperature when passing through the power generation unit, and the air may be warmed after passing through the power generation unit. The positioning of the power generation unit upstream of the thermal exchange zone may allow the power generation unit to operate with air at ambient temperature and density. The thermal exchange zone positioned downstream of the power generation unit may warm the air after energy extraction, which may maintain the buoyancy-induced airflow through the air conduit.

In some embodiments, a power generation unit may be positioned upwind of a thermal exchange zone in an air conduit. The term upwind may refer to a position that is upstream in the direction of airflow within the air conduit. When the power generation unit is upwind of the thermal exchange zone, airflow may first contact the power generation unit before contacting the thermal exchange zone. The power generation unit positioned upwind of the thermal exchange zone may extract energy from the airflow before the airflow is warmed by heat transfer from the fluid. The airflow passing through the power generation unit may be at ambient temperature, and the airflow may be warmed by the thermal exchange zone after passing through the power generation unit.

In some embodiments, a power generation unit may be positioned downwind of a thermal exchange zone in an air conduit. The term downwind may refer to a position that is downstream in the direction of airflow within the air conduit. When the power generation unit is downwind of the thermal exchange zone, airflow may first contact the thermal exchange zone before contacting the power generation unit. The power generation unit positioned downwind of the thermal exchange zone may extract energy from airflow that has been warmed by heat transfer from the fluid. The warmed airflow may have increased velocity due to buoyancy effects, and the increased velocity may provide greater kinetic energy for extraction by the power generation unit.

In some embodiments, the selection of power generation unit positioning relative to the thermal exchange zone may involve trade-offs between different operating characteristics. Positioning the power generation unit downwind of the thermal exchange zone may allow the power generation unit to operate with warmed air at increased velocity, which may increase the kinetic energy available for extraction. Positioning the power generation unit upwind of the thermal exchange zone may allow the power generation unit to operate with air at ambient temperature, which may have higher density than warmed air. The higher density of ambient temperature air may provide greater mass flow rate through the power generation unit for a given volumetric flow rate. The selection of positioning may depend on the specific characteristics of the system, the desired power output, the airflow conditions, or any combination of such factors.

In some embodiments, air turbines may be placed at various elevations within an air conduit. Air turbines may be placed at a tower base, at a mid-elevation within a tower, or near the top of a tower. The elevation at which an air turbine is placed may affect the airflow characteristics at the turbine location, the temperature of the air at the turbine location, the velocity of the air at the turbine location, or any combination of such characteristics. The selection of turbine elevation may be based on the desired operating characteristics, the configuration of the air conduit, the positioning of thermal exchange zones, or any combination of such factors.

In some embodiments, air turbines may be placed at a tower base. Air turbines placed at the tower base may be positioned near the inlet of the air conduit, where air may enter the air conduit from the surrounding environment. Air turbines at the tower base may operate with air at or near ambient temperature if the turbines are positioned upwind of thermal exchange zones. Air turbines at the tower base may operate with warmed air if the turbines are positioned downwind of thermal exchange zones located at or near the tower base. The tower base may provide a location where the cross-sectional area of the air conduit may be larger, which may allow larger turbines or multiple turbines to be installed.

In some embodiments, air turbines may be placed at a mid-elevation within a tower. Air turbines placed at mid-elevation may be positioned between the inlet and the outlet of the air conduit. Air turbines at mid-elevation may operate with air that has been partially warmed by thermal exchange zones located below the mid-elevation. The airflow velocity at mid-elevation may be different from the airflow velocity at the tower base or near the tower top, and the selection of mid-elevation placement may be based on the airflow velocity profile within the tower. Mid-elevation placement may allow turbines to be positioned at locations where airflow characteristics may be favorable for power generation.

In some embodiments, air turbines may be placed near the top of a tower. Air turbines placed near the tower top may be positioned near the outlet of the air conduit, where air may exit the air conduit to the surrounding environment. Air turbines near the tower top may operate with air that has been warmed by thermal exchange zones located below. The airflow velocity near the tower top may be affected by the cumulative buoyancy effects along the height of the tower. Air turbines near the tower top may be positioned to extract energy from the airflow before the air exits the air conduit.

In some embodiments, a system may employ multi-stage approaches using multiple turbines in sequence to incrementally extract energy from the airflow. Multiple turbines may be positioned at different elevations within an air conduit, and the airflow may pass through the multiple turbines in sequence as the airflow moves through the air conduit. Each turbine in the sequence may extract a portion of the kinetic energy from the airflow, and the cumulative energy extraction from the multiple turbines may be greater than the energy extraction from a single turbine. The multi-stage approach may allow energy to be extracted at multiple points along the airflow path, which may optimize the total energy extraction from the available airflow.

In some embodiments, a first turbine may be positioned at a first elevation and a second turbine may be positioned at a second elevation that is higher than the first elevation. Airflow may pass through the first turbine, may continue upward through the air conduit, and may pass through the second turbine. The first turbine may extract a first portion of the kinetic energy from the airflow, and the second turbine may extract a second portion of the kinetic energy from the airflow. Thermal exchange zones may be positioned between the first turbine and the second turbine, which may warm the airflow and may restore or increase the airflow velocity between the turbine stages.

In some embodiments, a multi-stage approach may include three or more turbines positioned at different elevations within an air conduit. The multiple turbines may be positioned at the tower base, at one or more mid-elevations, and near the tower top. Thermal exchange zones may be positioned between successive turbine stages to warm the airflow and to maintain or increase the airflow velocity. The number of turbine stages and the positioning of the turbine stages may be selected based on the height of the air conduit, the desired power output, the configuration of thermal exchange zones, or any combination of such factors.

In some embodiments, flow-control mechanisms may be employed between turbine stages in a multi-stage approach. Flow-control mechanisms may include adjustable louvers, bypass channels, dampers, valves, or other devices configured to control the airflow between turbine stages. The flow-control mechanisms may allow the airflow to be directed to or away from specific turbine stages, may allow the airflow velocity to be controlled between stages, or may allow the airflow to bypass one or more turbine stages when desired.

In some embodiments, adjustable louvers may be positioned between turbine stages. Adjustable louvers may comprise assemblies of multiple angled slats or blades that may be adjusted to control the airflow passing through the louvers. The adjustable louvers may be positioned in the airflow path between a first turbine stage and a second turbine stage. The angle of the louver slats or blades may be adjusted to increase or decrease the airflow resistance, to direct the airflow in a desired direction, or to achieve other airflow control objectives. The adjustment of the louvers may allow the airflow distribution among turbine stages to be controlled.

In some embodiments, bypass channels may be provided between turbine stages. Bypass channels may comprise passages that may allow airflow to bypass one or more turbine stages. The bypass channels may be configured with dampers, valves, or other flow control devices that may be opened or closed to allow or prevent airflow through the bypass channels. When the bypass channels are open, a portion of the airflow may bypass a turbine stage, which may reduce the airflow through the turbine stage and may reduce the power extracted by the turbine stage. When the bypass channels are closed, the airflow may be directed through the turbine stages, which may maximize the power extraction. The bypass channels may be employed to control the power output of the system, to protect turbines from excessive airflow velocities, to allow maintenance of individual turbine stages while other stages continue to operate, or for other purposes.

In some embodiments, the flow-control mechanisms between turbine stages may be controlled by a control system. The control system may receive inputs from sensors measuring airflow velocity, turbine power output, turbine rotational speed, or other parameters. The control system may adjust the flow-control mechanisms to optimize the total power generation from the multi-stage turbine arrangement, to balance the power extraction among turbine stages, to respond to changing airflow conditions, or to achieve other control objectives. The control system may coordinate the adjustment of flow-control mechanisms with the operation of the turbines and with the operation of thermal exchange zones.

In some embodiments, the positioning of thermal exchange zones relative to turbine stages in a multi-stage approach may be configured to optimize power generation. Thermal exchange zones may be positioned upstream of each turbine stage to warm the airflow before the airflow reaches each turbine. The warming of the airflow may increase the airflow velocity due to buoyancy effects, which may increase the kinetic energy available for extraction by each turbine stage. Alternatively, thermal exchange zones may be positioned between turbine stages to restore the airflow velocity after energy extraction by a preceding turbine stage. The configuration of thermal exchange zones relative to turbine stages may be selected based on the desired power output, the available heat transfer capacity, the configuration of the air conduit, or any combination of such factors.

In some embodiments, a system may comprise a power generation unit fluidly connected to an airflow conduit, wherein the power generation unit may be configured to convert kinetic energy from the airflow into electrical or mechanical power. The power generation unit may be positioned such that airflow first contacts a thermal exchange zone, then the power generation unit. Alternatively, the power generation unit may be positioned such that airflow first contacts the power generation unit, then the thermal exchange zone. The system may be configured with the power generation unit upwind of the thermal exchange zone in the airflow conduit, or the system may be configured with the power generation unit downwind of the thermal exchange zone in the airflow conduit.

In some embodiments, a system may comprise multiple power generation units positioned at different elevations within an airflow conduit. The multiple power generation units may be configured in a multi-stage arrangement to incrementally extract energy from the airflow. The system may comprise flow-control mechanisms including adjustable louvers or bypass channels positioned between the power generation units. The flow-control mechanisms may be configured to control the airflow distribution among the power generation units, to allow airflow to bypass one or more power generation units, or to achieve other airflow control objectives.

In some embodiments, power generation capacity may be calculated based on tower height, tower diameter, and air temperature conditions. The power generation capacity of a buoyancy-driven airflow system may be related to the kinetic energy of the airflow through the air conduit, which may be related to the airflow velocity, the cross-sectional area of the air conduit, and the density of the air. The airflow velocity may be related to the buoyancy-induced pressure difference, which may be related to the density difference between warmed air inside the air conduit and cooler air outside the air conduit, and the height of the air conduit.

In some embodiments, the density difference between warm air and cold air may be calculated based on the temperatures of the warm air and the cold air. Air density may be inversely related to absolute temperature at constant pressure, and the density of air at a given temperature may be calculated using the ideal gas law or other equations of state. The density of air at standard atmospheric pressure may be approximately 1.225 kilograms per cubic meter at 15 degrees Celsius (288 Kelvin). At colder temperatures, the density of air may be higher, and at warmer temperatures, the density of air may be lower.

In some embodiments, the density of cold air at various temperatures may be calculated as follows. At negative 10 degrees Celsius (263 Kelvin), the density of air may be approximately 1.342 kilograms per cubic meter. At negative 20 degrees Celsius (253 Kelvin), the density of air may be approximately 1.395 kilograms per cubic meter. At negative 30 degrees Celsius (243 Kelvin), the density of air may be approximately 1.453 kilograms per cubic meter. At negative 40 degrees Celsius (233 Kelvin), the density of air may be approximately 1.515 kilograms per cubic meter. At negative 50 degrees Celsius (223 Kelvin), the density of air may be approximately 1.582 kilograms per cubic meter.

In some embodiments, the density of warmed air within an air conduit may be calculated based on the temperature of the warmed air. When cold air is warmed through heat transfer from water at or near the freezing point of water (approximately 0 degrees Celsius or 273 Kelvin), the warmed air may approach a temperature near the freezing point of water. For calculation purposes, the warmed air temperature may be assumed to be approximately 0 degrees Celsius (273 Kelvin), at which temperature the density of air may be approximately 1.293 kilograms per cubic meter.

In some embodiments, the density difference between cold ambient air and warmed air at approximately 0 degrees Celsius may be calculated for various ambient air temperatures. The following table presents example density differences for various ambient air temperatures:

| Ambient Air | Ambient Air | Ambient Air | Warmed Air | Density |
|---|---|---|---|---|
| Temperature | Temperature | Density | Density at 0° C. | Difference |
| (° C.) | (K) | (kg/m³) | (kg/m³) | (kg/m³) |
| −10 | 263 | 1.342 | 1.293 | 0.049 |
| −20 | 253 | 1.395 | 1.293 | 0.102 |
| −30 | 243 | 1.453 | 1.293 | 0.160 |
| −40 | 233 | 1.515 | 1.293 | 0.222 |
| −50 | 223 | 1.582 | 1.293 | 0.289 |

In some embodiments, the Carnot efficiency may be calculated for heat engines operating between a warm reservoir at the freezing point of water and a cold reservoir at the ambient air temperature. The Carnot efficiency may represent the theoretical maximum efficiency of a heat engine operating between two temperature reservoirs, and the Carnot efficiency may be calculated as the temperature difference between the reservoirs divided by the absolute temperature of the warm reservoir. The following table presents example Carnot efficiency calculations for various ambient air temperatures:

| | | Warm | | |
|---|---|---|---|---|
| Ambient Air | Ambient Air | Reservoir | Temperature | Carnot |
| Temperature | Temperature | Temperature | Difference | Efficiency |
| (° C.) | (K) | (K) | (K) | (%) |
| −10 | 263 | 273 | 10 | 3.66 |
| −20 | 253 | 273 | 20 | 7.33 |
| −30 | 243 | 273 | 30 | 10.99 |
| −40 | 233 | 273 | 40 | 14.65 |
| −50 | 223 | 273 | 50 | 18.32 |

In some embodiments, the buoyancy-induced pressure difference may be calculated based on the density difference between warmed air and cold air and the height of the air conduit. The buoyancy-induced pressure difference may be calculated as the product of the density difference, the gravitational acceleration (approximately 9.81 meters per second squared), and the height of the air conduit. The following table presents example buoyancy-induced pressure differences for various tower heights and ambient air temperatures:

| Tower | Ambient Air | Density | Buoyancy |
|---|---|---|---|
| Height | Temperature | Difference | Pressure |
| (m) | (° C.) | (kg/m³) | Difference (Pa) |
| 100 | −10 | 0.049 | 48.1 |
| 100 | −20 | 0.102 | 100.1 |
| 100 | −30 | 0.160 | 157.0 |
| 100 | −40 | 0.222 | 217.8 |
| 100 | −50 | 0.289 | 283.5 |
| 150 | −10 | 0.049 | 72.1 |
| 150 | −20 | 0.102 | 150.1 |
| 150 | −30 | 0.160 | 235.4 |
| 150 | −40 | 0.222 | 326.7 |
| 150 | −50 | 0.289 | 425.3 |
| 200 | −10 | 0.049 | 96.1 |
| 200 | −20 | 0.102 | 200.1 |
| 200 | −30 | 0.160 | 313.9 |
| 200 | −40 | 0.222 | 435.6 |
| 200 | −50 | 0.289 | 567.1 |
| 250 | −10 | 0.049 | 120.2 |
| 250 | −20 | 0.102 | 250.1 |
| 250 | −30 | 0.160 | 392.4 |
| 250 | −40 | 0.222 | 544.5 |
| 250 | −50 | 0.289 | 708.8 |
| 300 | −10 | 0.049 | 144.2 |
| 300 | −20 | 0.102 | 300.2 |
| 300 | −30 | 0.160 | 470.9 |
| 300 | −40 | 0.222 | 653.4 |
| 300 | −50 | 0.289 | 850.6 |

In some embodiments, the theoretical airflow velocity may be estimated based on the buoyancy-induced pressure difference. The airflow velocity may be related to the square root of the ratio of twice the pressure difference to the air density. The actual airflow velocity may be lower than the theoretical velocity due to flow resistance, entrance losses, exit losses, and other factors. For estimation purposes, an efficiency factor may be applied to account for such losses. The following table presents example theoretical airflow velocities for various tower heights and ambient air temperatures, assuming an efficiency factor of approximately 0.7:

| | Ambient | Buoyancy | | |
|---|---|---|---|---|
| Tower | Air | Pressure | Theoretical | Estimated |
| Height | Temperature | Difference | Velocity | Velocity |
| (m) | (° C.) | (Pa) | (m/s) | (m/s) |
| 100 | −20 | 100.1 | 12.5 | 8.7 |
| 100 | −30 | 157.0 | 15.6 | 10.9 |
| 100 | −40 | 217.8 | 18.4 | 12.9 |
| 100 | −50 | 283.5 | 21.0 | 14.7 |
| 150 | −20 | 150.1 | 15.3 | 10.7 |
| 150 | −30 | 235.4 | 19.1 | 13.4 |
| 150 | −40 | 326.7 | 22.5 | 15.8 |
| 150 | −50 | 425.3 | 25.7 | 18.0 |
| 200 | −20 | 200.1 | 17.6 | 12.3 |
| 200 | −30 | 313.9 | 22.1 | 15.5 |
| 200 | −40 | 435.6 | 26.0 | 18.2 |
| 200 | −50 | 567.1 | 29.7 | 20.8 |
| 250 | −20 | 250.1 | 19.7 | 13.8 |
| 250 | −30 | 392.4 | 24.7 | 17.3 |
| 250 | −40 | 544.5 | 29.1 | 20.4 |
| 250 | −50 | 708.8 | 33.2 | 23.2 |
| 300 | −20 | 300.2 | 21.6 | 15.1 |
| 300 | −30 | 470.9 | 27.0 | 18.9 |
| 300 | −40 | 653.4 | 31.9 | 22.3 |
| 300 | −50 | 850.6 | 36.4 | 25.5 |

In some embodiments, the cross-sectional area of an air conduit may be calculated based on the diameter of the air conduit. For a circular cross-section, the cross-sectional area may be calculated as pi times the square of the radius, or equivalently, pi times the square of the diameter divided by four. The following table presents example cross-sectional areas for various tower diameters:

| Tower | Cross-Sectional |
|---|---|
| Diameter (m) | Area (m²) |
| 60 | 2,827 |
| 70 | 3,848 |
| 80 | 5,027 |
| 90 | 6,362 |
| 100 | 7,854 |

In some embodiments, the volumetric airflow rate may be calculated as the product of the cross-sectional area and the airflow velocity. The mass airflow rate may be calculated as the product of the volumetric airflow rate and the air density. The kinetic power in the airflow may be calculated as one-half times the mass airflow rate times the square of the airflow velocity. The following table presents example kinetic power calculations for various tower heights, tower diameters, and ambient air temperatures, using the estimated actual velocities from the previous table and assuming the warmed air density of approximately 1.293 kilograms per cubic meter:

| | | Ambient | | | | Mass | |
|---|---|---|---|---|---|---|---|
| Tower | Tower | Air | Estimated | Cross- | Volumetric | Flow | Kinetic |
| Height | Diameter | Temperature | Velocity | Sectional | Flow Rate | Rate | Power |
| (m) | (m) | (° C.) | (m/s) | Area (m²) | (m³/s) | (kg/s) | (kW) |
| 100 | 60 | −30 | 10.9 | 2,827 | 30,814 | 39,843 | 2,367 |
| 100 | 80 | −30 | 10.9 | 5,027 | 54,794 | 70,849 | 4,208 |
| 100 | 100 | −30 | 10.9 | 7,854 | 85,609 | 110,692 | 6,575 |
| 150 | 60 | −30 | 13.4 | 2,827 | 37,882 | 48,981 | 4,399 |
| 150 | 80 | −30 | 13.4 | 5,027 | 67,362 | 87,101 | 7,822 |
| 150 | 100 | −30 | 13.4 | 7,854 | 105,244 | 136,080 | 12,222 |
| 200 | 60 | −30 | 15.5 | 2,827 | 43,819 | 56,658 | 6,808 |
| 200 | 80 | −30 | 15.5 | 5,027 | 77,919 | 100,749 | 12,105 |
| 200 | 100 | −30 | 15.5 | 7,854 | 121,737 | 157,406 | 18,914 |
| 250 | 60 | −30 | 17.3 | 2,827 | 48,907 | 63,237 | 9,466 |
| 250 | 80 | −30 | 17.3 | 5,027 | 86,967 | 112,448 | 16,831 |
| 250 | 100 | −30 | 17.3 | 7,854 | 135,874 | 175,685 | 26,299 |
| 300 | 60 | −30 | 18.9 | 2,827 | 53,430 | 69,085 | 12,336 |
| 300 | 80 | −30 | 18.9 | 5,027 | 95,010 | 122,848 | 21,933 |
| 300 | 100 | −30 | 18.9 | 7,854 | 148,441 | 191,934 | 34,270 |

In some embodiments, the kinetic power available in the airflow may vary with ambient air temperature. The following table presents example kinetic power calculations for a 200-meter tower height and 80-meter tower diameter at various ambient air temperatures:

| Tower | Tower | Ambient Air | Estimated | Kinetic |
|---|---|---|---|---|
| Height | Diameter | Temperature | Velocity | Power |
| (m) | (m) | (° C.) | (m/s) | (kW) |
| 200 | 80 | −10 | 8.7 | 2,139 |
| 200 | 80 | −20 | 12.3 | 6,055 |
| 200 | 80 | −30 | 15.5 | 12,105 |
| 200 | 80 | −40 | 18.2 | 19,609 |
| 200 | 80 | −50 | 20.8 | 29,241 |

In some embodiments, the enthalpy of fusion of water may be approximately 333.55 kilojoules per kilogram. The enthalpy of fusion may represent the heat released when liquid water freezes to form ice, and the enthalpy of fusion may be a substantial source of heat for warming air in buoyancy-driven airflow systems. The heat released during freezing of water may be transferred to the air, warming the air and reducing the density of the air to create buoyancy-induced airflow.

In some embodiments, the water requirements for power generation may be calculated based on the heat transfer required to warm the air and the enthalpy of fusion of water. The heat required to warm a given mass of air by a given temperature difference may be calculated as the product of the mass of air, the specific heat capacity of air (approximately 1.005 kilojoules per kilogram per degree Kelvin), and the temperature difference. The mass of water that may need to freeze to provide the required heat may be calculated by dividing the required heat by the enthalpy of fusion of water.

In some embodiments, the power generation capacity may be estimated for various tower configurations. The following table presents example power generation capacity estimates for tower heights ranging from 100 meters to 300 meters and tower diameters ranging from 60 meters to 100 meters, at an ambient air temperature of negative 30 degrees Celsius, assuming a turbine efficiency of approximately 40 percent for converting kinetic power to electrical power:

| | | | Estimated |
|---|---|---|---|
| | | | Electrical |
| | | | Power at 40% |
| | | | Air Turbine |
| | | | Efficiency |
| | | | Converting |
| | | | Air Kinetic |
| Tower | Tower | Kinetic | Power to |
| Height | Diameter | Power | Electricity |
| (m) | (m) | (kW) | (kW) |
| 100 | 60 | 2,367 | 947 |
| 100 | 80 | 4,208 | 1,683 |
| 100 | 100 | 6,575 | 2,630 |
| 150 | 60 | 4,399 | 1,760 |
| 150 | 80 | 7,822 | 3,129 |
| 150 | 100 | 12,222 | 4,889 |
| 200 | 60 | 6,808 | 2,723 |
| 200 | 80 | 12,105 | 4,842 |
| 200 | 100 | 18,914 | 7,566 |
| 250 | 60 | 9,466 | 3,786 |
| 250 | 80 | 16,831 | 6,732 |
| 250 | 100 | 26,299 | 10,520 |
| 300 | 60 | 12,336 | 4,934 |
| 300 | 80 | 21,933 | 8,773 |
| 300 | 100 | 34,270 | 13,708 |

In some embodiments, the power generation capacity may vary with ambient air temperature for a given tower configuration. The following table presents example electrical power generation estimates for a 200-meter tower height and 80-meter tower diameter at various ambient air temperatures:

| | | | | Estimated |
|---|---|---|---|---|
| | | | | Electrical |
| | | | | Power |
| | | Ambient | | at 40% |
| Tower | Tower | Air | Kinetic | Turbine |
| Height | Diameter | Temperature | Power | Efficiency |
| (m) | (m) | (° C.) | (kW) | (kW) |
| 200 | 80 | −10 | 2,139 | 856 |
| 200 | 80 | −20 | 6,055 | 2,422 |
| 200 | 80 | −30 | 12,105 | 4,842 |
| 200 | 80 | −40 | 19,609 | 7,844 |
| 200 | 80 | −50 | 29,241 | 11,696 |

Some of the following tables may show calculated electricity generated per ton of water frozen (kWh/kg) and electricity generated per 1,000 m³ of air (kWh/1,000 m³), relative to the elevation difference between an air inlet and air outlet (which may be shown as “Tower Height” in some tables). Each table may be shown for a different air temperature (such as −10 degrees Celsius, or −15 degrees Celsius, −20 degrees Celsius, or −25 degrees Celsius, or −30 degrees Celsius, or −35 degrees Celsius, or −40 degrees Celsius, or −45 degrees Celsius, or −50 degrees Celsius) and an fluid contacting with air temperature of between −2 degrees Celsius and 0 degrees Celsius, wherein the fluid containing with air comprises liquid water. These tables may be useful for determining, for example, in some embodiments, the flow rate of water required depending on the desired percentage or proportion of water freezing, or the water flow rate or water efficiency relative to the portion of water which may freeze. These tables may be useful for determining, for example, calculations involving harnessing or using the air, which may comprise but may not be limited to: direct air capture or evaporation or air circulation or dilution or air separation or power generation or any combination thereof. For example, in some embodiments, a system for direct air capture can determine the amount of power generated relative to the volume of airflow, the mass of airflow, and the mass of CO2, and determine the percentage or proportion of CO2 desorption that may be powered by a related power generation system and/or the potential capacity of a CO2 capture system integrated with the system, and/or may incorporate the energy consumption or energy demands their CO₂ capture absorbent or adsorbent or sorbent or contacting module or process to determine their specific sizing and capacity.

### Electricity Generated per Ton of Water or m3 of Air Cold Air Temperature: −10 Degrees Celsius.

| | Electricity Generated | Electricity |
|---|---|---|
| Tower | per Metric | Generated per |
| Height | Ton of Water | 1,000 m3 of Air |
| (m) | Frozen (kWh/kg) | (kWh/1,000 m3) |
| 100 | 0.289 | 0.009 |
| 125 | 0.366 | 0.011 |
| 150 | 0.444 | 0.013 |
| 175 | 0.522 | 0.016 |
| 200 | 0.599 | 0.018 |
| 250 | 0.755 | 0.023 |
| 300 | 0.910 | 0.027 |
| 400 | 1.221 | 0.037 |
| 500 | 1.531 | 0.046 |
| 600 | 1.842 | 0.055 |
| 700 | 2.153 | 0.065 |
| 800 | 2.463 | 0.074 |
| 900 | 2.774 | 0.083 |
| 1000 | 3.084 | 0.093 |

### Electricity Generated per Ton of Water or m3 of Air Cold Air Temperature: −15 Degrees Celsius

| | Electricity Generated | |
|---|---|---|
| Tower | per Metric | Electricity Generated |
| Height | Ton of Water | per 1,000 m3 of Air |
| (m) | Frozen (kWh/kg) | (kWh/1,000 m3) |
| 100 | 0.295 | 0.013 |
| 125 | 0.374 | 0.017 |
| 150 | 0.454 | 0.020 |
| 175 | 0.533 | 0.024 |
| 200 | 0.612 | 0.028 |
| 250 | 0.771 | 0.035 |
| 300 | 0.929 | 0.042 |
| 400 | 1.246 | 0.056 |
| 500 | 1.563 | 0.071 |
| 600 | 1.880 | 0.085 |
| 700 | 2.197 | 0.099 |
| 800 | 2.514 | 0.113 |
| 900 | 2.831 | 0.128 |
| 1000 | 3.148 | 0.142 |

### Electricity Generated per Ton of Water or m3 of Air Cold Air Temperature: −20 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.302 | 0.018 |
| 125 | 0.382 | 0.023 |
| 150 | 0.463 | 0.028 |
| 175 | 0.544 | 0.033 |
| 200 | 0.625 | 0.038 |
| 250 | 0.786 | 0.047 |
| 300 | 0.948 | 0.057 |
| 400 | 1.271 | 0.077 |
| 500 | 1.595 | 0.096 |
| 600 | 1.918 | 0.115 |
| 700 | 2.241 | 0.135 |
| 800 | 2.565 | 0.154 |
| 900 | 2.888 | 0.174 |
| 1000 | 3.211 | 0.193 |

### Electricity Generated per Ton of Water or m3 of Air Cold Air Temperature: −25 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.308 | 0.023 |
| 125 | 0.390 | 0.029 |
| 150 | 0.473 | 0.036 |
| 175 | 0.555 | 0.042 |
| 200 | 0.637 | 0.048 |
| 250 | 0.802 | 0.060 |
| 300 | 0.967 | 0.073 |
| 400 | 1.297 | 0.098 |
| 500 | 1.626 | 0.122 |
| 600 | 1.956 | 0.147 |
| 700 | 2.286 | 0.172 |
| 800 | 2.615 | 0.197 |
| 900 | 2.945 | 0.222 |
| 1000 | 3.275 | 0.246 |

### Electricity Generated per Ton of Water or m3 of Air Cold Air Temperature: −30 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.314 | 0.028 |
| 125 | 0.398 | 0.036 |
| 150 | 0.482 | 0.044 |
| 175 | 0.566 | 0.051 |
| 200 | 0.650 | 0.059 |
| 250 | 0.818 | 0.074 |
| 300 | 0.986 | 0.089 |
| 400 | 1.322 | 0.119 |
| 500 | 1.658 | 0.150 |
| 600 | 1.994 | 0.180 |
| 700 | 2.330 | 0.210 |
| 800 | 2.666 | 0.241 |
| 900 | 3.002 | 0.271 |
| 1000 | 3.338 | 0.301 |

### Electricity Generated per Ton of Water or m3 of Air Cold Air Temperature: −35 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.322 | 0.034 |
| 125 | 0.408 | 0.043 |
| 150 | 0.494 | 0.052 |
| 175 | 0.580 | 0.061 |
| 200 | 0.666 | 0.070 |
| 250 | 0.839 | 0.088 |
| 300 | 1.011 | 0.106 |
| 400 | 1.355 | 0.143 |
| 500 | 1.699 | 0.179 |
| 600 | 2.043 | 0.215 |
| 700 | 2.387 | 0.251 |
| 800 | 2.731 | 0.288 |
| 900 | 3.075 | 0.324 |
| 1000 | 3.420 | 0.360 |

### Electricity Generated per Ton of Water or m3 of Air Cold Air Temperature: −40 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.330 | 0.040 |
| 125 | 0.418 | 0.050 |
| 150 | 0.506 | 0.061 |
| 175 | 0.594 | 0.071 |
| 200 | 0.682 | 0.082 |
| 250 | 0.858 | 0.103 |
| 300 | 1.034 | 0.124 |
| 400 | 1.386 | 0.167 |
| 500 | 1.737 | 0.209 |
| 600 | 2.089 | 0.251 |
| 700 | 2.441 | 0.294 |
| 800 | 2.793 | 0.336 |
| 900 | 3.145 | 0.378 |
| 1000 | 3.497 | 0.421 |

### Electricity Generated per Ton of Water or m3 of Air Cold Air Temperature: −45 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.337 | 0.046 |
| 125 | 0.427 | 0.058 |
| 150 | 0.517 | 0.070 |
| 175 | 0.607 | 0.082 |
| 200 | 0.697 | 0.094 |
| 250 | 0.876 | 0.119 |
| 300 | 1.056 | 0.143 |
| 400 | 1.415 | 0.192 |
| 500 | 1.774 | 0.240 |
| 600 | 2.134 | 0.289 |
| 700 | 2.493 | 0.338 |
| 800 | 2.852 | 0.386 |
| 900 | 3.211 | 0.435 |
| 1000 | 3.571 | 0.483 |

### Electricity Generated per Ton of Water or m3 of Air Cold Air Temperature: −50 Degrees Celsius

| | Electricity Generated | |
|---|---|---|
| Tower | per Metric | Electricity Generated |
| Height | Ton of Water | per 1,000 m3 of Air |
| (m) | Frozen (kWh) | (kWh/1,000 m3) |
| 100 | 0.346 | 0.052 |
| 125 | 0.438 | 0.066 |
| 150 | 0.530 | 0.080 |
| 175 | 0.622 | 0.094 |
| 200 | 0.714 | 0.107 |
| 250 | 0.897 | 0.135 |
| 300 | 1.081 | 0.163 |
| 400 | 1.449 | 0.218 |
| 500 | 1.817 | 0.273 |
| 600 | 2.184 | 0.329 |
| 700 | 2.552 | 0.384 |
| 800 | 2.920 | 0.439 |
| 900 | 3.287 | 0.495 |
| 1000 | 3.655 | 0.550 |

Some of the following tables may show calculated power capacity of a system relative to the diameter of the airflow conduit, and the elevation difference between an air inlet and air outlet (which may be shown as “Tower Height” in some tables). Each table may be shown for a different air temperature (such as −10 degrees Celsius, or −15 degrees Celsius, −20 degrees Celsius, or −25 degrees Celsius, or −30 degrees Celsius, or −35 degrees Celsius, or −40 degrees Celsius, or −45 degrees Celsius, or −50 degrees Celsius) and an fluid contacting with air temperature of between −2 degrees Celsius and 0 degrees Celsius, wherein the fluid containing with air comprises liquid water. The tables may be useful for sizing and designing some embodiments herein, including for example systems and methods for power generation, or direct air capture, or any combination thereof. For example, if a project developer is interested in building a power generation system for a specific power application, such as powering a mine or ore processing facility or a data center, the project developer may use this table to determine the required sizing or dimensions of the airflow conduit and the number of airflow conduits and/or may be include relevant considerations which may include, but may not be limited to, one or more or any combination of the following: the power demands of their application, the climate and/or mean temperature and/or median temperature throughout the year, the construction techniques, the land consideration (for example: permafrost depth or ground compositions), ocean or water body considerations, logistics, and other considerations.

### Power Capacity (MW) by Diameter (m) and Height (m) (Cold Air Temp: −10 Degree Celsius)

Power Capacity (MW) by diameter (m) and height (m) (Cold Air Temp: −10 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.037 | 0.147 | 0.332 | 0.589 | 0.921 | 1.326 | 1.805 | 2.072 | 2.358 | 2.984 | 3.684 | 4.458 |
| 125 | 0.047 | 0.187 | 0.421 | 0.748 | 1.169 | 1.683 | 2.291 | 2.629 | 2.992 | 3.786 | 4.675 | 5.656 |
| 150 | 0.057 | 0.227 | 0.510 | 0.906 | 1.416 | 2.039 | 2.776 | 3.187 | 3.626 | 4.589 | 5.665 | 6.855 |
| 175 | 0.067 | 0.266 | 0.599 | 1.065 | 1.664 | 2.396 | 3.261 | 3.744 | 4.260 | 5.391 | 6.656 | 8.053 |
| 200 | 0.076 | 0.306 | 0.688 | 1.223 | 1.912 | 2.753 | 13.747 | 4.301 | 4.894 | 6.193 | 7.646 | 9.252 |
| 250 | 0.096 | 0.385 | 0.866 | 1.540 | 2.407 | 3.466 | 4.717 | 5.415 | 6.161 | 7.798 | 9.627 | 11.649 |
| 300 | 0.116 | 0.464 | 1.045 | 1.857 | 2.902 | 4.179 | 5.688 | 6.530 | 7.429 | 9.403 | 11.608 | 14.046 |
| 400 | 0.156 | 0.623 | 1.401 | 2.491 | 3.893 | 5.605 | 7.629 | 8.758 | 9.965 | 12.612 | 15.570 | 18.840 |
| 500 | 0.195 | 0.781 | 1.758 | 3.125 | 4.883 | 7.032 | 9.571 | 10.987 | 12.501 | 15.821 | 19.532 | 23.634 |
| 600 | 0.235 | 0.940 | 2.115 | 3.759 | 5.874 | 8.458 | 11.512 | 13.216 | 15.036 | 19.031 | 23.494 | 28.428 |
| 700 | 0.275 | 1.098 | 2.471 | 4.393 | 6.864 | 9.884 | 13.454 | 15.444 | 17.572 | 22.240 | 27.457 | 33.222 |
| 800 | 0.314 | 1.257 | 2.828 | 5.027 | 7.855 | 11.311 | 15.395 | 17.673 | 20.108 | 25.449 | 31.419 | 38.017 |
| 900 | 0.354 | 1.415 | 3.184 | 5.661 | 8.845 | 12.737 | 17.337 | 19.902 | 22.644 | 28.658 | 35.381 | 42.811 |
| 1000 | 0.393 | 1.574 | 3.541 | 6.295 | 9.836 | 14.163 | 19.278 | 22.130 | 25.179 | 31.868 | 39.343 | 47.605 |

### Power Capacity (MW) by Diameter (m) and Height (m) (Cold Air Temp: −15 Degree Celsius)

Power Capacity (MW) by diameter (m) and height (m) (Cold Air Temp: −15 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.056 | 0.226 | 0.508 | 0.904 | 1.412 | 2.033 | 2.767 | 3.177 | 3.614 | 4.574 | 5.647 | 6.833 |
| 125 | 0.072 | 0.287 | 0.645 | 1.146 | 1.791 | 2.579 | 3.510 | 4.029 | 4.585 | 5.802 | 7.163 | 8.668 |
| 150 | 0.087 | 0.347 | 0.781 | 1.389 | 2.170 | 3.125 | 4.253 | 4.882 | 5.555 | 7.030 | 8.680 | 10.502 |
| 175 | 0.102 | 0.408 | 0.918 | 1.631 | 2.549 | 3.670 | 4.996 | 5.735 | 6.525 | 8.258 | 10.196 | 12.337 |
| 200 | 0.117 | 0.468 | 1.054 | 1.874 | 2.928 | 4.216 | 5.739 | 6.588 | 7.496 | 9.487 | 11.712 | 14.171 |
| 250 | 0.147 | 0.590 | 1.327 | 2.359 | 3.686 | 5.308 | 7.225 | 8.293 | 9.436 | 11.943 | 14.744 | 17.840 |
| 300 | 0.178 | 0.711 | 1.600 | 2.844 | 4.444 | 6.399 | 8.710 | 9.999 | 11.377 | 14.399 | 17.776 | 21.509 |
| 400 | 0.238 | 0.954 | 2.146 | 3.814 | 5.960 | 8.583 | 11.682 | 13.410 | 15.258 | 19.311 | 23.841 | 28.847 |
| 500 | 0.299 | 1.196 | 2.691 | 4.785 | 7.476 | 10.766 | 14.653 | 16.822 | 19.139 | 24.223 | 29.905 | 36.185 |
| 600 | 0.360 | 1.439 | 3.237 | 5.755 | 8.992 | 12.949 | 17.625 | 20.233 | 23.020 | 29.135 | 35.969 | 43.523 |
| 700 | 0.420 | 1.681 | 3.783 | 6.725 | 10.508 | 15.132 | 20.597 | 23.644 | 126.902 | 34.047 | 42.034 | 50.861 |
| 800 | 0.481 | 1.924 | 4.329 | 7.696 | 12.025 | 17.315 | 23.568 | 27.055 | 30.783 | 38.960 | 48.098 | 58.199 |
| 900 | 0.542 | 2.167 | 4.875 | 8.666 | 13.541 | 19.499 | 26.540 | 30.467 | 134.664 | 43.872 | 54.163 | 65.537 |
| 1000 | 0.602 | 2.409 | 5.420 | 9.636 | 15.057 | 21.682 | 29.511 | 33.878 | 38.545 | 48.784 | 60.227 | 72.875 |

### Power Capacity (MW) by Diameter (m) and Height (m) (Cold Air Temp: −20 Degree Celsius)

Power Capacity (MW) by diameter (m) and height (m) (Cold Air Temp: −20 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.077 | 0.308 | 0.692 | 1.231 | 1.923 | 2.769 | 3.769 | 4.326 | 4.923 | 6.230 | 7.691 | 9.307 |
| 125 | 0.098 | 0.390 | 0.878 | 1.561 | 2.438 | 3.511 | 4.779 | 5.486 | 6.242 | 7.900 | 9.753 | 11.802 |
| 150 | 0.118 | 0.473 | 1.063 | 1.890 | 2.954 | 4.254 | 5.789 | 6.646 | 7.562 | 9.570 | 11.815 | 14.297 |
| 175 | 0.139 | 0.555 | 1.249 | 2.220 | 3.469 | 4.996 | 6.800 | 7.806 | 8.881 | 11.241 | 13.877 | 16.791 |
| 200 | 0.159 | 0.638 | 1.435 | 2.550 | 3.985 | 5.738 | 7.810 | 8.966 | 10.201 | 12.911 | 15.939 | 19.286 |
| 250 | 0.201 | 0.803 | 1.806 | 3.210 | 5.016 | 7.223 | 9.831 | 11.285 | 12.840 | 16.251 | 20.063 | 24.276 |
| 300 | 0.242 | 0.967 | 2.177 | 3.870 | 6.047 | 8.707 | 11.851 | 13.605 | 15.479 | 19.591 | 24.187 | 29.266 |
| 400 | 0.324 | 1.297 | 2.919 | 5.189 | 8.109 | 11.676 | 15.893 | 18.244 | 20.758 | 26.272 | 32.434 | 39.246 |
| 500 | 0.407 | 1.627 | 3.661 | 6.509 | 10.170 | 14.645 | 19.934 | 22.884 | 26.036 | 32.952 | 40.682 | 49.225 |
| 600 | 0.489 | 1.957 | 4.404 | 7.829 | 12.232 | 17.615 | 23.975 | 27.523 | 31.315 | 39.633 | 48.930 | 59.205 |
| 700 | 0.572 | 2.287 | 5.146 | 9.148 | 14.294 | 20.584 | 28.017 | 32.162 | 36.593 | 46.313 | 57.177 | 69.184 |
| 800 | 0.654 | 2.617 | 5.888 | 10.468 | 16.356 | 23.553 | 32.058 | 36.801 | 41.872 | 52.994 | 65.425 | 79.164 |
| 900 | 0.737 | 2.947 | 6.631 | 11.788 | 18.418 | 26.522 | 36.099 | 41.441 | 147.150 | 59.675 | 73.672 | 89.144 |
| 1000 | 0.819 | 3.277 | 7.373 | 13.107 | 20.480 | 29.491 | 40.141 | 46.080 | 52.429 | 66.355 | 81.920 | 99.123 |

### Power Capacity (MW) by Diameter (m) and Height (m) (Cold Air Temp: −25 Degree Celsius)

Power Capacity (MW) by diameter (m) and height (m) (Cold Air Temp: −25 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.098 | 0.393 | 0.883 | 1.571 | 2.454 | 3.534 | 4.810 | 5.522 | 6.283 | 7.951 | 9.817 | 11.878 |
| 125 | 0.124 | 0.498 | 1.120 | 1.991 | 3.111 | 4.480 | 6.098 | 7.000 | 7.964 | 10.080 | 12.444 | 15.058 |
| 150 | 0.151 | 0.603 | 1.357 | 2.412 | 3.768 | 5.426 | 7.385 | 8.478 | 9.646 | 12.209 | 15.072 | 18.238 |
| 175 | 0.177 | 0.708 | 1.593 | 2.832 | 4.425 | 6.372 | 8.673 | 9.956 | 11.328 | 14.337 | 17.700 | 21.417 |
| 200 | 0.203 | 0.813 | 1.830 | 3.253 | 5.082 | 7.318 | 9.961 | 11.435 | 13.010 | 16.466 | 20.328 | 24.597 |
| 250 | 0.256 | 1.023 | 2.303 | 4.093 | 6.396 | 9.210 | 12.536 | 14.391 | 16.374 | 20.723 | 25.584 | 30.957 |
| 300 | 0.308 | 1.234 | 2.776 | 4.934 | 7.710 | 11.102 | 15.112 | 17.347 | 19.737 | 24.980 | 30.840 | 37.316 |
| 400 | 0.414 | 1.654 | 3.722 | 6.616 | 10.338 | 14.887 | 20.262 | 23.260 | 26.465 | 33.495 | 41.351 | 50.035 |
| 500 | 0.519 | 2.075 | 4.668 | 8.298 | 12.966 | 18.671 | 25.413 | 29.173 | 33.192 | 42.009 | 51.863 | 62.754 |
| 600 | 0.624 | 2.495 | 5.614 | 9.980 | 15.594 | 22.455 | 30.564 | 35.086 | 39.920 | 50.524 | 62.375 | 75.474 |
| 700 | 0.729 | 2.915 | 6.560 | 11.662 | 18.222 | 26.239 | 35.714 | 40.999 | 46.647 | 59.038 | 72.886 | 88.193 |
| 800 | 0.834 | 3.336 | 7.506 | 13.344 | 20.850 | 30.023 | 40.865 | 46.911 | 53.375 | 67.552 | 83.398 | 100.912 |
| 900 | 0.939 | 3.756 | 8.452 | 15.026 | 23.477 | 33.808 | 46.016 | 52.824 | 60.102 | 176.067 | 93.910 | 113.631 |
| 1000 | 1.044 | 4.177 | 9.398 | 16.707 | 26.105 | 37.592 | 51.167 | 58.737 | 66.830 | 84.581 | 104.421 | 126.350 |

### Power Capacity (MW) by Diameter (m) and Height (m) (Cold Air Temp: −30 Degree Celsius)

Power Capacity (MW) by diameter (m) and height (m) (Cold Air Temp: −30 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.120 | 0.481 | 1.082 | 1.924 | 3.006 | 4.328 | 5.891 | 6.763 | 7.694 | 9.738 | 12.022 | 14.547 |
| 125 | 0.152 | 0.609 | 1.371 | 2.438 | 3.809 | 5.485 | 7.466 | 8.571 | 9.751 | 12.342 | 15.237 | 18.436 |
| 150 | 0.185 | 0.738 | 1.661 | 2.952 | 4.613 | 6.642 | 9.041 | 10.379 | 11.808 | 14.945 | 18.451 | 22.325 |
| 175 | 0.217 | 0.867 | 1.950 | 3.466 | 5.416 | 7.799 | 10.616 | 12.186 | 13.865 | 17.548 | 21.665 | 26.214 |
| 200 | 0.249 | 0.995 | 2.239 | 3.981 | 6.220 | 8.956 | 12.191 | 13.994 | 15.923 | 20.152 | 24.879 | 30.104 |
| 250 | 0.313 | 1.252 | 2.818 | 5.009 | 7.827 | 11.271 | 15.341 | :17.610 | 20.037 | 25.359 | 31.307 | 37.882 |
| 300 | 0.377 | 1.509 | 3.396 | 6.038 | 9.434 | 13.585 | 18.490 | 21.226 | 24.151 | 30.566 | 37.736 | 45.660 |
| 400 | 0.506 | 2.024 | 4.553 | 8.095 | 12.648 | 18.213 | 24.790 | 28.458 | 32.379 | 40.980 | 50.592 | 61.216 |
| 500 | 0.634 | 2.538 | 5.710 | 10.152 | 15.862 | 22.842 | 31.090 | 35.690 | 40.607 | 51.393 | 63.449 | 76.773 |
| 600 | 0.763 | 3.052 | 6.867 | 12.209 | 19.076 | 27.470 | 37.390 | 42.922 | 48.835 | 61.807 | 76.305 | 92.329 |
| 700 | 0.892 | 3.566 | 8.025 | 14.266 | 22.290 | 32.098 | 43.689 | 50.154 | 57.064 | 72.221 | 89.162 | 107.886 |
| 800 | 1.020 | 4.081 | 9.182 | 16.323 | 25.505 | 36.727 | 49.989 | 57.385 | 65.292 | 82.635 | 102.018 | 123.442 |
| 900 | 1.149 | 4.595 | 10.339 | 18.380 | 28.719 | 41.355 | 56.289 | 164.617 | 73.520 | 93.049 | 114.875 | 138.999 |
| 1000 | 1.277 | 5.109 | 11.496 | 20.437 | 31.933 | 45.983 | 62.588 | 71.849 | 81.748 | 103.463 | 127.732 | 154.555 |

### Power Capacity (MW) by Diameter (m) and Height (m) (Cold Air Temp: −35 Degree Celsius)

Power Capacity (MW) by diameter (m) and height (m) (Cold Air Temp: −35 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.144 | 0.576 | 1.295 | 2.302 | 3.597 | 5.180 | 7.051 | 8.094 | 9.210 | 11.656 | 14.390 | 17.412 |
| 125 | 0.182 | 0.729 | 1.641 | 2.917 | 4.558 | 6.563 | 8.933 | 10.255 | 11.668 | 14.767 | 18.231 | 22.059 |
| 150 | 0.221 | 10.883 | 1.986 | 3.531 | 5.518 | 7.946 | 10.815 | 12.415 | 14.126 | 17.878 | 22.072 | 26.707 |
| 175 | 0.259 | 1.036 | 2.332 | 4.146 | 6.478 | 9.328 | 12.697 | 14.576 | 16.584 | 20.989 | 25.912 | 31.354 |
| 200 | 0.298 | 1.190 | 2.678 | 4.761 | 7.438 | 10.711 | 14.579 | 16.736 | 19.042 | 24.100 | 29.753 | 36.001 |
| 250 | 0.374 | 1.497 | 3.369 | 5.990 | 9.359 | 13.477 | 18.343 | 21.057 | 23.958 | 30.322 | 37.435 | 45.296 |
| 300 | 0.451 | 1.805 | 4.060 | 7.219 | 11.279 | 16.242 | 22.107 | 25.378 | 28.874 | 36.544 | 45.116 | 54.591 |
| 400 | 0.605 | 2.419 | 5.443 | 9.677 | 15.120 | 21.773 | 29.635 | 34.020 | 38.707 | 48.988 | 60.480 | 73.180 |
| 500 | 0.758 | 3.034 | 6.826 | 12.135 | 18.961 | 27.303 | 37.163 | 42.662 | 48.539 | 61.433 | 75.843 | 91.770 |
| 600 | 0.912 | 3.648 | 8.209 | 14.593 | 22.801 | 32.834 | 44.691 | 51.303 | 58.372 | 73.877 | 91.206 | 110.359 |
| 700 | 1.066 | 4.263 | 9.591 | 17.051 | 26.642 | 38.365 | 52.219 | 59.945 | 68.204 | 86.321 | 106.569 | 128.949 |
| 800 | 1.219 | 4.877 | 10.974 | 19.509 | 30.483 | 43.896 | 59.747 | 68.587 | 78.037 | 98.765 | 121.932 | 147.538 |
| 900 | 1.373 | 5.492 | 12.357 | 21.967 | 134.324 | 49.426 | 67.275 | 77.229 | 87.869 | 111.209 | 137.296 | 166.128 |
| 1000 | 1.527 | 6.106 | 13.739 | 24.425 | 38.165 | 54.957 | 74.803 | 85.871 | 97.702 | 123.654 | 152.659 | 184.717 |

### Power Capacity (MW) by Diameter (m) and Height (m) (Cold Air Temp: −40 Degree Celsius)

Power Capacity (MW) by diameter (m) and height (m) (Cold Air Temp: −40 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.168 | 0.674 | 1.515 | 2.694 | 4.210 | 6.062 | 8.251 | 9.472 | 10.777 | 13.639 | 16.838 | 20.375 |
| 125 | 0.213 | 0.853 | 1.919 | 3.412 | 5.332 | 7.677 | 10.450 | 11.996 | 13.649 | 17.274 | 21.326 | 25.805 |
| 150 | 0.258 | 1.033 | 2.323 | 4.130 | 6.453 | 9.293 | 12.649 | 14.520 | 16.521 | 20.909 | 25.814 | 31.235 |
| 175 | 0.303 | 1.212 | 2.727 | 4.848 | 7.575 | 10.909 | 14.848 | 17.045 | 19.393 | 24.544 | 30.301 | 36.665 |
| 200 | 0.348 | 1.392 | 3.131 | 5.566 | 8.697 | 12.524 | 17.047 | 19.569 | 22.265 | 28.179 | 34.789 | 42.095 |
| 250 | 0.438 | 1.751 | 3.939 | 7.002 | 10.941 | 15.755 | 21.445 | 24.618 | 28.009 | 35.449 | 43.764 | 52.955 |
| 300 | 0.527 | 2.110 | 4.747 | 8.438 | 13.185 | 18.986 | 25.843 | 29.666 | 33.753 | 42.719 | 52.740 | 63.815 |
| 400 | 0.707 | 12.828 | 6.362 | 11.310 | 17.673 | 25.449 | 34.638 | 39.763 | 45.242 | 57.259 | 70.690 | 85.535 |
| 500 | 0.886 | 3.546 | 7.978 | 14.183 | 22.160 | 31.911 | 143.434 | 49.861 | 56.730 | 71.799 | 88.641 | 107.256 |
| 600 | 1.066 | 4.264 | 9.593 | 17.055 | 26.648 | 38.373 | 52.230 | 59.958 | 68.219 | 86.339 | 106.592 | 128.976 |
| 700 | 1.245 | 4.982 | 11.209 | 19.927 | 31.136 | 44.835 | 161.026 | 70.055 | 79.707 | 100.879 | 124.543 | 150.696 |
| 800 | 1.425 | 5.700 | 12.824 | 22.799 | 35.623 | 151.298 | 69.822 | 80.152 | 91.196 | 115.419 | 142.493 | 172.417 |
| 900 | 1.604 | 6.418 | 14.440 | 25.671 | 40.111 | 57.760 | 78.618 | 90.250 | 102.684 | 129.960 | 160.444 | 194.137 |
| 1000 | 1.784 | 7.136 | 16.056 | 28.543 | 44.599 | 64.222 | 87.413 | 100.347 | 114.173 | 144.500 | 178.395 | 215.857 |

### Power Capacity (MW) by Diameter (m) and Height (m) (Cold Air Temp: −45 Degree Celsius)

Power Capacity (MW) by diameter (m) and height (m) (Cold Air Temp: −45 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.194 | 10.775 | 1.743 | 3.099 | 4.842 | 6.972 | 9.490 | 10.894 | 12.395 | 15.688 | 19.368 | 23.435 |
| 125 | 0.245 | 0.981 | 2.207 | 3.924 | 6.131 | 8.828 | 12.016 | 13.794 | 15.694 | 19.863 | 24.523 | 29.672 |
| 150 | 0.297 | 1.187 | 2.671 | 4.748 | 7.419 | 10.684 | 14.542 | 16.693 | 18.993 | 24.039 | 29.677 | 35.909 |
| 175 | 0.348 | 1.393 | 3.135 | 5.573 | 8.708 | 12.540 | 17.068 | 19.593 | 22.292 | 28.214 | 34.832 | 42.147 |
| 200 | 0.400 | 1.599 | 3.599 | 6.398 | 9.997 | 14.395 | 19.594 | 22.493 | 25.592 | 32.389 | 39.987 | 48.384 |
| 250 | 0.503 | 2.012 | 4.527 | 8.047 | 12.574 | 18.107 | 24.645 | 28.292 | 32.190 | 40.740 | 50.296 | 60.859 |
| 300 | 0.606 | 2.424 | 5.455 | 9.697 | 15.151 | 21.818 | 29.697 | 34.091 | 38.788 | 49.091 | 60.606 | 73.333 |
| 400 | 0.812 | 3.249 | 7.310 | 12.996 | 20.306 | 29.241 | 39.800 | 45.689 | 51.984 | 65.792 | 81.225 | 98.282 |
| 500 | 1.018 | 4.074 | 9.166 | 16.295 | 25.461 | 36.664 | 49.903 | 57.287 | 65.180 | 82.494 | 101.844 | 123.231 |
| 600 | 1.225 | 4.899 | 11.022 | 19.594 | 30.616 | 44.087 | 60.007 | 68.885 | 78.376 | 99.195 | 122.463 | 148.180 |
| 700 | 1.431 | 5.723 | 12.877 | 22.893 | 35.770 | 51.509 | 70.110 | 80.484 | 91.572 | 115.896 | 143.082 | 173.129 |
| 800 | 1.637 | 6.548 | 14.733 | 26.192 | 40.925 | 58.932 | 80.213 | 92.082 | 104.769 | 132.598 | 163.701 | 198.078 |
| 900 | 1.843 | 7.373 | 16.589 | 29.491 | 46.080 | 66.355 | 90.317 | 103.680 | 117.965 | 149.299 | 184.320 | 223.027 |
| 1000 | 2.049 | 8.198 | 18.445 | 32.790 | 51.235 | 73.778 | 100.42 | 115.278 | 131.161 | 166.001 | 204.939 | 247.976 |

### Power Capacity (MW) by Diameter (m) and Height (m) (Cold Air Temp: −50 Degree Celsius)

Power Capacity (MW) by diameter (m) and height (m) (Cold Air Temp: −50 Degrees Celsius)

| Tower | | | | | | | | | | | | |
|---|---|---|---|---|---|---|---|---|---|---|---|---|
| Height | 10 m | 20 m | 30 m | 40 m | 50 m | 60 m | 70 m | 75 m | 80 m | 90 m | 100 m | 110 m |
| (m) | (MW) | (MW) | (MW) | (MW) | (MW) | (MW) | (MW) | (MW) | (MW) | (MW) | (MW) | (MW) |
| 100 | 0.221 | 0.882 | 1.985 | 3.529 | 5.515 | 7.941 | 10.809 | 12.408 | 14.118 | 17.868 | 22.059 | 26.691 |
| 125 | 0.279 | 1.117 | 2.513 | 4.467 | 6.980 | 10.052 | 13.681 | 15.706 | 17.869 | 22.616 | 27.921 | 33.784 |
| 150 | 0.338 | 1.351 | 3.040 | 5.405 | 8.446 | 12.162 | 16.554 | 19.003 | 21.621 | 27.364 | 33.783 | 40.878 |
| 175 | 0.396 | 1.586 | 3.568 | 6.343 | 9.911 | 14.272 | 19.426 | 22.301 | 25.373 | 32.113 | 39.646 | 47.971 |
| 200 | 0.455 | 1.820 | 4.096 | 7.281 | 11.377 | 16.383 | 22.299 | 25.598 | 29.125 | 36.861 | 45.508 | 55.065 |
| 250 | 0.572 | 2.289 | 5.151 | 9.157 | 14.308 | 120.604 | 28.044 | 32.193 | 36.629 | 46.358 | 57.232 | 69.251 |
| 300 | 0.690 | 2.758 | 6.206 | 11.033 | 17.239 | 24.825 | 33.789 | 38.788 | 44.132 | 55.855 | 68.957 | 83.438 |
| 400 | 0.924 | 3.696 | 8.317 | 14.785 | 23.102 | 133.266 | 45.279 | 51.978 | 59.140 | 74.849 | 92.406 | 111.811 |
| 500 | 1.159 | 4.634 | 10.427 | 18.537 | 28.964 | 41.708 | 56.769 | 65.169 | 74.147 | 93.843 | 115.855 | 140.185 |
| 600 | 1.393 | 5.572 | 12.537 | 22.289 | 34.826 | 50.150 | 68.259 | 78.359 | 89.155 | 112.836 | 139.304 | 168.558 |
| 700 | 1.628 | 6.510 | 14.648 | 26.041 | 40.688 | 58.591 | 79.749 | 91.549 | 104.162 | 131.830 | 162.753 | 196.932 |
| 800 | 1.862 | 7.448 | 16.758 | 29.792 | 46.551 | 167.033 | 91.239 | 104.739 | 119.170 | 150.824 | 186.202 | 225.305 |
| 900 | 2.097 | 8.386 | 18.869 | 33.544 | 52.413 | 75.475 | 102.72 | 117.929 | 134.177 | 169.818 | 209.651 | 253.678 |
| 1000 | 2.331 | 9.324 | 20.979 | 37.296 | 58.275 | 83.916 | 114.21 | 131.11 | 149.18 | 188.81 | 233.10 | 282.05 |

### Example Embodiment—Airflow Conduit with about 300 m Elevation Difference Comprising a Vertical Configuration Fluidly Coupled to a Generally Horizontal Segment; Modular Steel Construction; Guy-Wire Support; Water-Spray Freezing Heat Input; Anti-Icing and/or De-Icing; Ice and/or Residual Water Removal (Continuous and Batch); and Inlet/Outlet Shutters that May Operate Passively and May Selectively Transition to Active Control

Some embodiments may comprise a power generation system configured to generate electrical power and/or mechanical power from buoyancy-driven airflow created by contacting cold ambient air with liquid water under conditions such that at least a portion of the liquid water may freeze. In some embodiments, freezing may release latent heat of fusion to increase the temperature of at least a portion of the contacted air. In some embodiments, the contacted air may also gain moisture, such as by evaporation and/or entrained droplets, which may increase a water vapor partial pressure and may further reduce air density based at least in part on the lower molecular weight of water vapor relative to nitrogen and oxygen, thereby increasing buoyancy and draft through an airflow conduit.

### Example Airflow Conduit Configuration, Elevation Difference, Geometry, and Airflow Path

In some embodiments, the power generation system may comprise an airflow conduit having a air inlet positioned at a lower elevation and a air outlet positioned at a higher elevation. In an example embodiment, an elevation difference between the air inlet and the air outlet may be approximately 300 meters. In some embodiments, the elevation difference may be within a range of about 150 meters to about 800 meters, about 200 meters to about 500 meters, or about 250 meters to about 350 meters, and the selected elevation difference may be based at least in part on a desired pressure differential, available site topography, constructability constraints, turbine selection, desired mass flow of air, desired pressure drop, desired turbine operating point, structural constraints, site constraints, or economic considerations, or any combination thereof.

In some embodiments, the airflow conduit may at an angle of approximately 90 degrees relative to a generally horizontal plane. In some embodiments, the airflow conduit may comprise a vertical segment and a generally horizontal segment fluidly coupled to the vertical segment. In certain implementations, the vertical segment and the generally horizontal segment may be coupled via a bend or elbow having an included angle of about 90 degrees. In some embodiments, the included angle may be within a range of about 5 degrees to about 120 degrees. In some embodiments, the bend may comprise a turning radius which may be selected based in part on a target pressure loss, an allowable footprint, structural fabrication constraints, and location or site geography. In some embodiments, the bend region may comprise one or more internal flow conditioning features configured to manage pressure loss and flow separation, and to manage swirl entering downstream sections, where the internal flow conditioning features may comprise turning vanes, guide plates, flow straighteners, diffusers, bellmouth transitions, smooth-radius elbows, or combinations thereof.

In some embodiments, the airflow conduit may comprise an internal diameter of approximately 30 meters. In some embodiments, the internal diameter may be within a range of about 10 meters to about 80 meters, about 15 meters to about 60 meters, or about 25 meters to about 35 meters. In some embodiments, the airflow conduit may comprise a circular cross-section. In some embodiments, the airflow conduit may comprise a non-circular cross-section, including one or more or any combination of the following: an oval cross-section; a rounded-rectangle cross-section; a polygonal cross-section with rounded corners; and a cross-section with internal stiffeners and/or ribs configured to resist buckling under wind loading and to manage vibration modes.

In some embodiments, the airflow conduit may be configured to convey air upward responsive to buoyancy forces, such that a chimney effect may draw ambient air into the air inlet, convey the air through at least a portion of the airflow conduit, and discharge warmed air through the air outlet. In some embodiments, the airflow path may be configured to promote buoyancy-driven airflow based at least in part on heating of air in a thermal exchange zone. In some embodiments, the airflow path may further be configured to enable wind-assisted augmentation. For example, in some embodiments the system may employ outlet geometry that produces a low-pressure region responsive to wind passing across the outlet, and/or may employ inlet geometry that captures wind stagnation pressure.

### Example Air Inlet Structures, Air Outlet Structures, and Discharge/Inlet Conditioning

In some embodiments, the air inlet may comprise one or more inlet openings arranged around a circumference of a conduit base. In some embodiments, the air inlet may comprise a plenum region configured to distribute incoming ambient air into a conduit cross-section with reduced non-uniformity. In some embodiments, the air inlet may comprise an inlet plenum and/or a bellmouth configured to reduce inlet losses and to improve flow uniformity. In some embodiments, the air inlet may comprise inlet screens and/or debris deflectors configured to reduce ingestion of snow, debris, and/or other particulates.

In some embodiments, the air outlet may comprise a discharge structure configured to direct airflow upward, laterally, and/or at a selected discharge angle. In some embodiments, the discharge structure may comprise one or more or any combination of the following: a diffuser; a nozzle; a stack extension; and a flared outlet. In some embodiments, the air outlet may comprise a weather hood, an outlet louver set, an outlet damper assembly, and/or a diffuser configured to reduce exit losses and to reduce wind-driven backflow and/or wind-driven reverse flow.

### Example Structural Configuration and Construction of the Airflow Conduit

In some embodiments, the airflow conduit may comprise a modular structure comprising a plurality of prefabricated steel tube sections. In some embodiments, each prefabricated steel tube section may have a length which may be selected based in part on transportation constraints, lifting constraints, and on-site assembly constraints, such as a length of approximately 3 meters to approximately 50 meters, including approximately 6 meters to approximately 20 meters.

In some embodiments, the airflow conduit may be constructed from modular pre-fabricated steel tube sections and/or modular pre-fabricated steel pipe sections. In some embodiments, sections may be fabricated as rolled shells, spiral-welded shells, longitudinally welded shells, plate-assembled shells, multi-plate fabricated shells, or combinations thereof. In some embodiments, adjacent sections may be coupled to one another by one or more or any combination of the following: bolted flanges; welded joints; welded seams; bolted ring joints; hybrid bolted-welded joints; sleeved joints; gasketed slip joints; bell-and-spigot joints with seals; clamp collars; internal splice rings; external splice plates; and combinations thereof. In some embodiments, a joint region may comprise a seal configured to reduce air leakage and/or reduce ingress of external moisture, where the seal may comprise a compressible gasket, a sealant, a labyrinth seal, a lip seal, or any combination thereof. In some embodiments, seal selection may be based at least in part on temperature range, expected ice formation, expected differential pressure, maintenance accessibility, or combinations thereof.

In some embodiments, the airflow conduit may comprise expansion joints, sliding supports, sliding couplings, flexible couplings, or combinations thereof configured to accommodate thermal expansion and contraction and/or structural movement due to temperature gradients, wind loads, and operational transients.

In some embodiments, the prefabricated steel tube sections may comprise carbon steel, low-alloy steel, stainless steel, weathering steel, or any combination thereof. In some embodiments, at least a portion of interior surfaces and/or exterior surfaces may comprise a coating configured to reduce corrosion, reduce ice adhesion, reduce liquid wetting, reduce fouling, or any combination thereof. In some embodiments, coatings and/or surface treatments may comprise one or more or any combination of the following: epoxy coatings; polyurethane coatings; fluoropolymer coatings; ceramic coatings; ceramic-filled coatings; thermal-spray metallic coatings; ice-phobic surface treatments; hydrophobic surface treatments; stainless steel liners; polymer liners; and combinations thereof. In some embodiments, the airflow conduit may comprise drainage channels, gutters, drip edges, or combinations thereof configured to direct meltwater and/or spray runoff away from seams, joints, and mechanical interfaces to reduce freeze bonding and to maintain operability of seals and moving components.

In some embodiments, at least a portion of the airflow conduit may comprise external insulation configured to reduce heat loss from air flowing in the conduit to an external environment. In some embodiments, insulation may comprise mineral wool, foam insulation, vacuum insulated panels, aerogel blankets, multilayer insulation, or any combination thereof. In some embodiments, the airflow conduit may comprise an external cladding layer configured to protect insulation from wind, precipitation, ultraviolet exposure, and mechanical damage.

In some embodiments, the airflow conduit may comprise one or more access features configured to facilitate inspection and maintenance. For example, the airflow conduit may comprise a access door, a manway, a service platform, a internal ladder, a external ladder, a elevator or hoist system, removable panels, internal platforms, anchor points for safety lines, and service lighting, or any combination thereof. In some embodiments, internal access may be configured to support maintenance of sprayers, demisters and/or droplet eliminators, airflow control elements, sensors, turbines, augers, trap doors, and associated actuators and heaters.

### Example Support System Using Guy Wires and Foundations

In some embodiments, the airflow conduit may comprise a guyed structure supported at least in part by guy wires. In some embodiments, guy wires may be coupled to the airflow conduit at one or more elevations along a conduit height. In some embodiments, guy wires may be coupled to one or more collars and/or attachment bands coupled to the airflow conduit. In some embodiments, guy wire elevations may comprise approximately 0.2 to approximately 0.4 of conduit height, approximately 0.4 to approximately 0.7 of conduit height, approximately 0.7 to approximately 0.9 of conduit height, or combinations thereof. In some embodiments, multiple levels of guy wires may be employed, such as two levels, three levels, four levels, or more levels, and selection may be based at least in part on conduit height, wind loading, icing loads, allowable deflection, and site footprint constraints.

In some embodiments, guy wires may be distributed around a circumference of the airflow conduit, such as three, four, six, eight, twelve, or more guy wire lines at a given elevation. In some embodiments, a number and orientation of guy wires may be which may be selected based in part on wind loading directionality, icing loads, and site footprint constraints.

In some embodiments, guy wires may comprise galvanized steel strand, locked-coil cables, stainless steel cables, fiber-reinforced polymer tendons, or any combination thereof. In some embodiments, guy wires may be coupled to ground anchors comprising one or more or any combination of the following: rock anchors; helical anchors; grouted anchors; deadman anchors; driven piles; drilled shafts; reinforced concrete foundations; mat foundations; anchor foundations; or combinations thereof. In some embodiments, anchor design may be based at least in part on soil bearing characteristics, permafrost characteristics, groundwater characteristics, uplift loads, or combinations thereof.

In some embodiments, a guy wire may comprise an in-line tensioner configured to adjust guy wire tension. In some embodiments, the in-line tensioner may comprise turnbuckles, hydraulic tensioners, screw jacks, wedge sockets, or combinations thereof. In some embodiments, a guy wire may comprise a sensor configured to monitor tension, vibration, and/or ice accretion, where the sensor may comprise strain gauges, load pins, fiber optic sensors, accelerometers, load cells, or combinations thereof. In some embodiments, a control system may generate an alarm and/or may modify operating parameters responsive to measured guy wire tension, measured vibration, measured ice accretion, or combinations thereof.

In some embodiments, the airflow conduit may comprise a base structure configured to transfer vertical and lateral loads to the ground. In some embodiments, the base structure may comprise a foundation comprising one or more or any combination of the following: a mat foundation; a ring foundation; spread footings; pile foundations; micropiles; drilled shafts; anchor foundations; or combinations thereof. In some embodiments, the foundation may be configured with embedded anchor plates, cast-in-place bolts, post-installed anchors, or combinations thereof for coupling a lower tube section to the foundation. In some embodiments, a base region may comprise a skirt and/or transition section configured to distribute loads and to provide an interface for air inlet structures and water-handling structures. In some embodiments, the base support structure may comprise vibration isolation features configured to reduce transmission of turbine-induced vibration into conduit structure and/or the foundation.

### Example Thermal Exchange Zone Using Sprayed Water

In some embodiments, the system may comprise a thermal exchange zone configured to transfer heat from a fluid to air flowing through the airflow conduit to induce and/or augment upward airflow. In an example embodiment, the fluid may comprise liquid water at a temperature at or above the freezing point of water, such as about 0 degrees Celsius. In some embodiments, liquid water temperature may comprise approximately 0 degrees Celsius for freshwater, and/or may comprise a freezing-point temperature based at least in part on salinity for seawater and/or brackish water.

In some embodiments, the thermal exchange zone may be positioned near a base region of the airflow conduit such that ambient cold air entering the air inlet may contact the fluid and may be warmed prior to rising through the conduit. In some embodiments, the thermal exchange zone may comprise a spraying system configured to spray water into the airflow. In some embodiments, the spraying system may comprise one or more arrays of nozzles coupled to a water supply header and/or manifold.

In some embodiments, the spraying system may comprise one or more or any combination of the following: spray nozzles; atomizers; misters; foggers; shower manifolds; spray bars; nozzle arrays; rotating sprayers; and rotary atomizers. In some embodiments, nozzle type may comprise pressure nozzles, swirl nozzles, impingement nozzles, cone nozzles, flat fan nozzles, air-assisted nozzles, rotary atomizers, or any combination thereof. In some embodiments, nozzles may be which may be selected based in part on droplet size distribution, droplet momentum, expected carryover, expected icing, desired heat transfer rate, target contact time, target freezing fraction, and pressure-drop penalty.

In some embodiments, the spraying system may be configured to operate with multiple droplet regimes. For example, in some embodiments a first set of sprayers may be configured to produce relatively fine droplets to increase interfacial area for heat transfer, and a second set of sprayers may be configured to produce relatively coarse droplets to reduce drift and carryover. In some embodiments, droplet size and spray pattern may be which may be selected based in part on contact time in the conduit, a target freezing fraction, a target humidity increase, and a desired pressure loss.

In some embodiments, multiple spray zones may be distributed at different elevations and/or along different conduit segments, including along a vertical segment, along a generally horizontal segment, and/or near a bend between segments. In some embodiments, the system may selectively activate particular spray zones and/or spray stations responsive to measured temperature, measured humidity, measured turbine output, measured airflow velocity, measured pressure drop, or combinations thereof.

### Example Droplet Elimination and Water Return

In some embodiments, the system may comprise a mist eliminator and/or droplet separator positioned downstream of a spray region. In some embodiments, the mist eliminator and/or droplet separator may comprise chevron vanes, mesh pads, fiber beds, cyclonic separators, inertial separators, baffles, or any combination thereof. In some embodiments, droplet elimination components may be positioned upstream of a turbine, downstream of a turbine, and/or near the outlet. In some embodiments, a droplet separator may be configured to drain collected water back to a pool, sump, basin, and/or water collection structure.

### Example Water Supply, Basin Configuration, and Recirculation

In some embodiments, the system may comprise a liquid water supply system configured to provide liquid water to a sprayer array and/or spray manifold. In some embodiments, the liquid water may comprise freshwater, seawater, brackish water, meltwater, treated water, or any combination thereof. In some embodiments, at least a portion of the water supply may be drawn from a water body at least partially covered by ice, where water may be pumped from beneath an ice layer.

In some embodiments, the water supply may be provided from an external water source coupled to the system via a intake conduit and a pump. In some embodiments, the pump may comprise a centrifugal pump, an axial-flow pump, a mixed-flow pump, a positive displacement pump, or combinations thereof. In some embodiments, the system may comprise redundant pumps configured in parallel and/or as standby pumps to support reliability and maintenance. In some embodiments, a pump may be variable speed and may be controlled responsive to a of: ambient air temperature; airflow rate; desired power output; icing indicators; basin level; spray pressure; spray flow; or combinations thereof. In some embodiments, a variable speed drive may adjust pump speed responsive to measured spray pressure, measured spray flow rate, and/or a target power output.

In some embodiments, the system may comprise a water pool and/or basin at or near a base of the airflow conduit configured to collect sprayed water, melted ice, and liquid water returning from the spray region. In some embodiments, the basin may comprise a lined pond, a concrete basin, a steel tank, a polymer-lined excavation, or combinations thereof. In some embodiments, the basin may comprise a circulation pump configured to circulate water and manage temperature uniformity. In some embodiments, the basin may comprise a filter and/or strainer configured to reduce nozzle fouling. In some embodiments, the basin may comprise a overflow path configured to manage water balance. In some embodiments, at least a portion of water may be recirculated from the basin to the sprayers. In some embodiments, a basin and/or collection structure may comprise a sump configured to provide suction head for recirculation pumps.

In some embodiments, the basin may comprise an auger. In some embodiments, the basin may comprise a trap door, which may periodically open to remove ice or fluids or material. In some embodiments, ice or solids or fluids or materials may be transferred or removed into a transport vehicle, such as a truck or railcar or ship or conveyor belt or any combination thereof, and/or transported and/or deposited.

Example Ice Formation, Ice Management, and Anti-Icing and/or De-Icing Measures

In some embodiments, freezing of sprayed water may produce ice particles, snow-like agglomerates, slush, and/or adherent ice on internal surfaces. In some embodiments, at least a portion of sprayed water may freeze as heat transfers from the water to cold inlet air. In some embodiments, ice formation may occur on one or more components comprising internal conduit surfaces, sprayer structures, sprayer manifolds, nozzle bodies, nozzle mounts, spray bars, spray plates, drift eliminators, droplet eliminators, mist eliminators, basin edges, collection surfaces, shutter surfaces, shutter frames, shutter hinges, and internal structural members.

In some embodiments, the system may comprise anti-icing measures and/or de-icing measures configured to reduce ice accumulation in locations that could restrict airflow, restrict water flow, degrade turbine operation, and/or interfere with movement of flow control elements. In some embodiments, anti-icing and/or de-icing measures may be operated continuously, periodically, and/or in pulsed cycles responsive to sensor data and/or scheduling logic.

### Heated Flow Lines and Associated Insulation

In some embodiments, anti-icing measures may comprise heated flow lines for water supply. For example, a water supply line coupled to the sprayers may comprise heat tracing configured to maintain water temperature above freezing within the line. In some embodiments, heat tracing may comprise electrical resistance heating, electrical heating cables, resistive heating jackets, circulating heated fluid in a jacket, glycol tracing, fluid-based heating loops that circulate a heated working fluid, or combinations thereof. In some embodiments, insulation may be applied around heated flow lines to reduce heat loss.

In some embodiments, heated flow lines may be operated continuously during cold periods or may be operated periodically responsive to measured temperature, measured pressure drop, measured flow restriction, predicted icing risk based at least in part on ambient temperature, wind, humidity, or combinations thereof.

### Selectively Heated Spray and Flow-Contacting Surfaces

In some embodiments, anti-icing measures may comprise selectively heated spray surfaces. In some embodiments, a portion of a sprayer manifold, nozzle tip, nozzle body, nozzle mount, spray bar, spray plate, manifold junction, droplet eliminator edge, mist eliminator edge, and/or screen may comprise an integrated heater configured to provide localized heat to reduce ice adhesion and to reduce nozzle blockage and/or flow restriction.

In some embodiments, localized heaters may comprise cartridge heaters, surface heaters, radiant heaters, fluid-based heat exchange channels, or combinations thereof. In some embodiments, a controller may operate selectively heated spray surfaces continuously and/or intermittently based at least in part on measured nozzle differential pressure, measured spray pattern degradation, measured droplet size changes, measured spray pressure drop, measured differential pressure across a spray region, measured ice accumulation indicators, or combinations thereof.

Example Brine and/or Anti-Freeze Ice Prevention or Ice Reduction or Ice Dislodgement

In some embodiments, an anti-icing and deicing subsystem may comprise a brine and/or antifreeze fluid source fluidly, which may be coupled to a fluid pathway, and/or an applicator configured to deliver a freezing-point-depressant fluid to a target region where ice formation may be undesirable. For example, the target region may comprise one or more or any combination of the following: a pipe, a conduit, a valve, a pump, a strainer, a filter, a manifold, a sprayer supply line, a sprayer nozzle, a spray header, a atomizer, a misting device, a surface exposed to ambient conditions, a heat exchange surface, a basin wall, a basin edge, a collection surface, a structural member, or any combination thereof. In some embodiments, the brine or antifreeze solution may comprise an aqueous solution including dissolved salts, and/or the salts may include, but may not be limited to, one or more or any combination of the following: sodium chloride, calcium chloride, magnesium chloride, potassium chloride, sodium acetate, potassium acetate, calcium magnesium acetate, sodium formate, potassium formate, or any combination thereof. In some embodiments, the antifreeze solution may comprise one or more organic freezing point depressants and/or mixtures, including, but may not be limited to, one or more or any combination of the following: propylene glycol, ethylene glycol, glycerol, ethanol, methanol, urea, or any combination thereof. In some embodiments, the brine and/or antifreeze concentration may be selected to provide a desired freezing point depression at an anticipated ambient temperature range, such as a concentration of about 1 weight percent to about 35 weight percent dissolved salts for a brine, and/or about 5 volume percent to about 70 volume percent glycol for a glycol-water antifreeze, and/or any intermediate values and subranges thereof. In some embodiments, delivery of the brine and/or antifreeze may be performed by injecting the fluid into a carrier stream (for example, a water stream feeding sprayers), by circulating the fluid through a closed-loop heat-trace jacket or auxiliary loop coupled to the pipe or sprayer manifold, and/or by directly applying the fluid to external surfaces via a applicator comprising one or more or any combination of the following: spray nozzles, fan nozzles, cone nozzles, misters, drip lines, wicking media, film applicators, or any combination thereof. In some embodiments, the subsystem may further comprise a storage tank, a metering pump, a dosing valve, a check valve, a injection quill, a static mixer, a bypass loop, a drain or purge line, and/or a containment feature configured to manage the deicing fluid and/or runoff. In some embodiments, material selection and compatibility may be addressed by employing corrosion-resistant materials and/or coatings at wetted and/or exposed regions, including, but not limited to, stainless steels, nickel alloys, titanium, polymeric piping, composite piping, elastomers selected for glycol and/or salt compatibility, and/or protective coatings configured to reduce corrosion and/or reduce ice adhesion, and the subsystem may optionally include inhibitors and/or additives which may be selected based in part on compatibility with system materials and environmental constraints.

In some embodiments, application of brine and/or antifreeze for deicing and/or anti-icing may be performed sporadically, periodically, responsive to need, cycled, continuously, or any combination thereof, based at least in part on operating conditions and control objectives. For example, a control system may be coupled to a sensor and may be configured to initiate and/or modulate deicing fluid delivery responsive to one or more or any combination of the following: measured ambient temperature, measured surface temperature, measured fluid temperature, detected ice presence, detected frost accumulation, a measured pressure drop across a flow passage, a measured reduction in flow rate indicative of partial blockage, a measured change in sprayer pattern or nozzle discharge indicative of freezing, weather forecast data, operator input, or any combination thereof. In some embodiments, “sporadic” operation may comprise a discrete event-driven dosing action, such as injecting brine and/or antifreeze into a sprayer supply line for a short interval responsive to an ice detection signal and/or a near-freezing temperature threshold, followed by returning to a baseline operating fluid. In some embodiments, “periodic” operation may comprise scheduled dosing at defined intervals (for example, every about 10 minutes to about 8 hours, including intermediate values and subranges), wherein each dosing interval may have a duration of about 5 seconds to about 60 minutes, including intermediate values and subranges, and wherein the dosing frequency and duration may be adjusted based at least in part on ambient conditions, thermal mass of the protected components, and observed dilution or flushing of the deicing fluid. In some embodiments, “cycled” operation may comprise alternating between (i) a deicing phase in which brine and/or antifreeze may be delivered to maintain a depressed freezing point and/or melt incipient ice and (ii) a rinse and/or purge phase in which water and/or another process fluid may be delivered to manage concentration, manage residue, and/or manage corrosion risk, with the phases optionally coordinated with sprayer operation, pump speed, and/or valve sequencing. In some embodiments, “continuous” operation may comprise maintaining at least a baseline concentration of brine and/or antifreeze within a protected loop and/or continuously applying a thin film and/or intermittent fine spray of deicing fluid to exposed surfaces, such as nozzle tips, spray headers, external piping, basin edges, and/or other surfaces subject to freezing, wherein continuous operation may be selected for operating modes and/or sites where temperatures may remain below a selected threshold for extended periods. In some embodiments, the control system may further be configured to implement setpoint-based concentration control using a conductivity sensor (for brine), a refractometer and/or density sensor (for glycol or mixed solutions), and/or a mass flow measurement of injected deicing fluid, such that the effective freezing point of the protected fluid may be maintained within a selected range. In some embodiments, the deicing fluid may be captured and managed via a sump, drain network, and/or collection basin coupled to treatment and/or recycling equipment, including, but not limited to, filtration, separation, dilution control, reclaim of glycol, salt recovery, and/or controlled discharge, thereby supporting repeated use and/or reduced consumption in operating regimes where deicing actions may recur.

Example Compressed Air and/or Compressed Heated Air for Ice Dislodgement

In some embodiments, anti-icing measures may comprise use of compressed air and/or compressed heated air to dislodge ice and/or reduce ice accumulation. In some embodiments, the system may comprise a compressed air line coupled to a air-knife manifold, jet nozzle, and/or purge port positioned near sprayers, near shutters, near droplet eliminators and/or drift eliminators, near inlet screens, near inlet flow straighteners, near turning vanes, near guide plates, and/or near internal structural members.

In some embodiments, compressed heated air may be generated by heating compressed air using electrical heaters, waste heat sources, heat exchangers, burner-heated heat exchangers, combustion heaters, heat pumps, or combinations thereof. In some embodiments, compressed air and/or compressed heated air may be delivered in pulses responsive to detection of ice-caused flow restriction, responsive to scheduled de-icing cycles, responsive to detecting increased pressure drop across a droplet eliminator and/or drift eliminator, responsive to detecting reduced spray flow, responsive to detecting reduced airflow velocity, or combinations thereof. In some embodiments, air jets may be oriented to shear ice from edges, clear narrow passages, and reduce bridging between components.

### Example Additional Anti-Icing Measures

In some embodiments, anti-icing measures may further comprise surface treatments configured to reduce ice adhesion, geometric features configured to reduce ice bridging, and structural heating of selected regions. For example, in some embodiments the system may comprise a heated ring near an inlet opening, a heated lip near an outlet opening, or both, where heaters may be configured to maintain operability of moving flow control elements and seal interfaces.

Example Continuous Ice and/or Residual Water Removal Using an Auger

In some embodiments, the system may comprise continuous removal of ice and/or residual water using a auger. In some embodiments, the auger may comprise an Archimedes screw comprising a helical flight within a trough and/or tube, and the auger may be configured to convey ice, slush, and water from a collection region to a discharge region. In some embodiments, the collection region may be within a basin, on a shallow shelf within the basin, adjacent to a basin wall, within a dedicated ice collection channel, within a bottom trough, and/or within a sump region. In some embodiments, the system may comprise circulation currents, circulation pumps, water jets, or combinations thereof configured to direct floating ice toward an auger intake region.

In some embodiments, the auger may be oriented generally horizontally to sweep ice across a collection shelf. In some embodiments, the auger may be oriented at an incline to lift ice to an elevated discharge point. In some embodiments, the auger may be driven by an electric motor, a hydraulic motor, and/or a mechanical drive coupled to a generator and/or gearbox. In some embodiments, auger drive may be controlled responsive to measured torque, measured current draw, measured ice thickness, measured basin level, measured ice level, or combinations thereof. In some embodiments, the auger may comprise wear-resistant flight edges and may comprise bearings and lubricants selected for low-temperature operation.

In some embodiments, the auger discharge region may be coupled to a external handling subsystem. For example, discharged ice may be directed into a bin, a chute, a conveyor, a transport container, a storage area, or combinations thereof. In some embodiments, the system may comprise a drainage pathway configured to allow water drained from conveyed ice to return to the basin. In some embodiments, residual liquid water may be removed using drainage channels and sump pumps configured for low-temperature operation.

Example Batch Removal Capability Using a Trap Door and/or Mechanical Batch Removal Interface

In some embodiments, the system may comprise batch removal of accumulated ice using a trap door. In some embodiments, the trap door may be positioned at a basin floor, at a low point of an ice sump, at an outlet of an ice collection channel, at a discharge opening coupled to a chute, and/or at another collection region. In some embodiments, the trap door may comprise a hinged hatch, a sliding gate, a guillotine gate, a pivoting door, a rotary valve, a removable panel, a double-door airlock arrangement configured to reduce airflow loss during discharge, or combinations thereof. In some embodiments, the trap door may be configured to seal against air leakage and/or water leakage in a closed state, and to discharge ice to an external chute, containment area, collection pit, container, truck bay, external conveyor, or combinations thereof.

In some embodiments, the trap door may be actuated manually by personnel, and/or may be actuated by a actuator such as a hydraulic cylinder, a pneumatic cylinder, an electric linear actuator, a motor-driven linkage, or combinations thereof. In some embodiments, trap door actuation may be controlled responsive to an ice accumulation sensor, a level sensor, a torque sensor on an auger, a time schedule, pressure drop indicators, or combinations thereof. In some embodiments, batch removal may be employed for ice that may be challenging to remove with an auger, such as large consolidated blocks and/or ice containing debris.

In some embodiments, batch removal may additionally and/or alternatively be implemented using a mechanical batch removal interface. For example, in some embodiments a grapple, bucket, loader, crane, hoist, and/or other lifting or removal equipment may be used to extract ice through an access opening and/or hatch. In some embodiments, manual removal may be performed using tools selected for low-temperature operation and configured to remove localized accretions on spray manifolds, nozzle mounts, nozzle tips, spray bars, droplet eliminators, drift eliminators, shutter frames, shutter hinges, inlet screens, flow straighteners, and other internal structures. In some embodiments, a trap door region and/or access interface may comprise localized heating configured to facilitate opening and to reduce ice bonding.

Example Passive Shutters at the Air Inlet and Air Outlet with Selective Transition to Active Operation

In some embodiments, the system may comprise passive shutters located at both the air inlet and the air outlet. In some embodiments, the shutters may comprise louvers, flaps, backdraft dampers, multi-leaf shutter assemblies, panels, slats, or combinations thereof. In some embodiments, passive shutters may be configured to open responsive to a pressure differential across the shutter and to close responsive to reduced differential pressure and/or reverse flow tendencies. In some embodiments, passive shutters may be passively actuated responsive to pressure differential, responsive to wind forces, responsive to gravity, or combinations thereof.

In some embodiments, the passive shutters may be configured to selectively turn active by coupling a shutter element to an actuator configured to adjust position. In some embodiments, actuators may comprise electric motors with gearboxes, hydraulic cylinders, pneumatic cylinders, linear actuators, motor-driven linkages, or combinations thereof. In some embodiments, active control may be used to tune airflow rate, tune turbine operating point, manage start-up and shutdown transients, manage icing risk, reduce backdraft risk, increase inflow on a windward side responsive to wind direction, manage outlet discharge, and protect components during high winds.

In some embodiments, inlet shutters may open inward, meaning shutter leaves may pivot, translate, swing, and/or otherwise move toward an interior volume of an inlet plenum and/or airflow conduit. In some embodiments, inward-opening shutters may be configured as check-type structures configured to promote inflow and reduce outflow responsive to reverse pressure differentials. In some embodiments, inlet shutters may comprise tunable mechanical features such as adjustable stops, adjustable springs, adjustable spring preload, adjustable counterweights, adjustable dampers, adjustable hinge friction, or combinations thereof configured to set an opening pressure threshold and a degree of opening under a given pressure differential. In some embodiments, inlet shutters may be actively opened, actively closed, and/or actively modulated to achieve a selected inlet flow area responsive to operating conditions.

In some embodiments, outlet shutters may be configured to regulate discharge through an outlet opening and to reduce ingress of wind-driven air into the outlet opening. In some embodiments, outlet shutters may comprise adjustable louvers configured to modulate discharge direction and discharge flow area. In some embodiments, outlet shutters may be configured to reduce backflow, reduce snow ingress, reduce rain ingress, and reduce wind-driven pressure fluctuations within the airflow conduit. In some embodiments, shutter assemblies may include anti-icing and/or de-icing features such as heat tracing, localized heaters at hinge regions, heated hinge regions, heated frames, localized air purges, drainage channels configured to prevent freeze-up at seal interfaces, surface treatments configured to reduce ice adhesion, or combinations thereof.

In some embodiments, shutters may comprise position sensors configured to provide feedback for control. In some embodiments, position sensors may comprise limit switches, encoders, potentiometers, Hall-effect sensors, or combinations thereof. In some embodiments, a controller may coordinate shutter position with sprayer operation, heater operation, compressed air purge operation, and turbine operation to maintain desired airflow characteristics.

### Example Power Generation Unit, Turbine Configurations, and Electrical Integration

In some embodiments, the system may comprise a air turbine fluidly coupled to the airflow conduit and configured to extract energy from airflow driven through the conduit. In some embodiments, the air turbine may be positioned in a generally horizontal segment, near a base region of a vertical segment, near the air inlet, at an intermediate location, near the air outlet, within a lower region of the conduit, within a mid-height region of the conduit, or at any combination of such locations, where location may be selected based at least in part on accessibility, structural integration, pressure distribution, and maintenance constraints.

In some embodiments, the system may comprise a plurality of air turbines arranged in parallel ducts and/or series stages, such that a desired pressure drop and/or power extraction may be distributed among multiple turbines. In some embodiments, the turbine and generator architecture may be selected based at least in part on anticipated pressure differential and flow rate.

In some embodiments, the air turbine may comprise an axial-flow turbine, a radial inflow turbine, a radial-flow turbine, a mixed-flow turbine, an impulse turbine, a cross-flow turbine, a Wells-type turbine, or combinations thereof. In some embodiments, the turbine may comprise inlet guide vanes, outlet guide vanes, or both configured to condition flow and to manage swirl. In some embodiments, variable-speed operation may be employed. In some embodiments, turbine blade pitch may be fixed or variable. In some embodiments, variable blade pitch control may be responsive to measured airflow, measured airflow velocity, measured turbine rotational speed, measured generator load, measured generator power, and a desired operating point. In some embodiments, variable pitch control may be based at least in part on one or more constraints comprising structural loads, acoustic limits, and icing risk.

In some embodiments, the air turbine may be coupled to a generator configured to generate electrical power. In some embodiments, the generator may comprise a synchronous generator, an induction generator, a permanent-magnet generator, a doubly-fed induction generator, or combinations thereof. In some embodiments, the generator output may be conditioned by power electronics, including rectifiers, inverters, transformers, or combinations thereof, to provide grid-compatible power and/or to provide power suitable for local loads.

In some embodiments, electrical power may be used for on-site loads including pumps, valves, heaters, compressed air systems, sensors, control systems, lighting, communications equipment, or combinations thereof. In some embodiments, electrical power may be exported to an electrical grid. In some embodiments, electrical power may be stored in an energy storage system comprising batteries, flywheels, compressed air energy storage, or combinations thereof.

### Example Instrumentation, Control, and Operational Modes of Some Embodiments

In some embodiments, the system may comprise instrumentation and control configured to enable operation across varying ambient conditions. In some embodiments, instrumentation may include temperature sensors at multiple elevations, humidity sensors, barometric pressure sensors, differential pressure sensors across a turbine and/or across spray zones, airflow velocity sensors, turbine speed sensors, electrical output sensors, water flow meters, water temperature sensors, nozzle differential pressure sensors, spray pressure sensors, basin level sensors, auger torque sensors, auger current sensors, ice thickness sensors, ice level sensors, shutter position sensors, guy wire tension sensors, or combinations thereof.

In some embodiments, a controller may regulate one or more of spray rate, spray zoning, shutter position, turbine pitch, turbine speed, generator loading, auger speed, trap door actuation, heater duty cycles, compressed air purge cycles, or combinations thereof based at least in part on sensor inputs. In some embodiments, the system may be operated in multiple modes, including a start-up mode, a steady-state power generation mode, a de-icing mode, a reduced-output protective mode responsive to high winds, and a shutdown mode. In some embodiments, a control system may coordinate sprayer operation, shutter positions, turbine settings, auger operation, trap door scheduling, and anti-icing and/or de-icing cycles to maintain airflow and to manage ice formation while enabling power generation.

### Example Operational Performance for an Example Embodiment Comprising a 300 m Configuration

In an example embodiment with an airflow conduit having an elevation difference of about 300 meters between the air inlet and the air outlet, an internal diameter of about 30 meters, inlet air at an ambient temperature of about −30 degrees Celsius, and a water source at about 0 degrees Celsius in the thermal exchange zone, the system may generate about 3.4 megawatts of electrical power. In some embodiments, power output may be influenced by a of: ambient temperature; inlet humidity; wind speed; wind direction; water flow rate; droplet size distribution; turbine operating point; shutter configuration; pressure losses; freezing fraction; and operational setpoints.

### Example Embodiment—Hillside/Mountainside Airflow Conduit with about 600 m Elevation Difference at an Incline about 10°-45°; Modular Steel Pipe Construction; Thermosyphon Pylon Support; Water-Spray Freezing Heat Input; Anti-Icing and/or De-Icing; Ice and/or Residual Water Removal (Continuous and Batch); and Inlet/Outlet Shutters that May Operate Passively and May Selectively Transition to Active Control

Some embodiments may comprise a power generation system configured to generate electrical power from buoyancy-driven airflow created by contacting cold ambient air with liquid water within an airflow conduit disposed along a hillside or mountainside. In some embodiments, positioning the airflow conduit along a slope may reduce a required free-standing structural height while maintaining a desired elevation difference between an air inlet and an air outlet.

### Example Embodiment Hillside Conduit Configuration, Elevation Difference, Slope, and Diameter

In an example embodiment, an airflow conduit may have an elevation difference between an air inlet and an air outlet of about 600 meters. In some embodiments, an elevation difference may be within a range of about 300 meters to about 1,200 meters, about 400 meters to about 1,000 meters, or about 500 meters to about 800 meters. In some embodiments, the airflow conduit may be oriented at an angle relative to horizontal in a range of approximately 10 degrees to approximately 45 degrees. In some embodiments, the inclined configuration may be selected based at least in part on available terrain, construction logistics, desired elevation difference, structural support opportunities provided by the terrain, geotechnical stability, constructability, desired conduit length, curvature, or combinations thereof.

In some embodiments, the airflow conduit may have an internal diameter of approximately 30 meters. In some embodiments, the internal diameter may be within a range of about 10 meters to about 80 meters, about 15 meters to about 60 meters, or about 25 meters to about 35 meters. In some embodiments, the conduit may be circular or may comprise a non-circular cross-section which may be selected based in part on excavation constraints and support spacing constraints.

### Example Modular Assembly and Routing Along Terrain

In some embodiments, the airflow conduit may comprise multiple conduit segments coupled to follow terrain. In some embodiments, one or more bends may be provided to route around obstacles. In some embodiments, bend regions and/or transition regions may include internal flow conditioning features configured to manage pressure loss and flow separation, where such features may comprise turning vanes, flow straighteners, bellmouth inlets, diffusers, smooth-radius elbows, guide plates, or combinations thereof. In some embodiments, the conduit may include diffusers, contractions, and/or other area transitions configured to manage velocity profiles and pressure recovery. In some embodiments, transitions between different conduit slopes may be configured with gradual curvature to reduce separation and to maintain higher effective airflow velocity.

In some embodiments, the airflow conduit may be constructed from a modular assembly of prefabricated steel pipe sections. In some embodiments, each pipe section may comprise a cylindrical shell with stiffening rings, longitudinal stiffeners, or both, configured to resist external loads. In some embodiments, sections may be fabricated as rolled shells, spiral-welded shells, plate-assembled shells, or combinations thereof. In some embodiments, pipe sections may be transported to a site and assembled along a slope using cranes, winches, track-mounted equipment, or combinations thereof.

In some embodiments, joints between pipe sections may comprise flanged joints, bolted flanges, welded joints, gasketed slip joints, bell-and-spigot joints with seals, hybrid joints, or combinations thereof. In some embodiments, the conduit may comprise expansion joints and/or sliding couplings configured to accommodate thermal expansion and contraction along a conduit length due to temperature gradients.

Example Support by Thermosyphon Pylons Built into, for Example, a Hillside

In some embodiments, the airflow conduit may be supported by thermosyphon pylons built into a hillside. In some embodiments, each thermosyphon pylon may comprise a foundation element embedded into soil and/or rock and a support frame configured to support the conduit. In some embodiments, a thermosyphon pylon may comprise a structural pile and/or column coupled to the conduit and extending into the ground.

In some embodiments, a thermosyphon pylon may further comprise thermosyphon heat pipe configured to transfer heat from the ground to ambient air to maintain ground stability in cold regions, including cold-region soils and/or permafrost regions. In some embodiments, thermosyphon heat pipes may be passive and may operate based at least in part on phase change of a working fluid within a sealed tube. In some embodiments, the working fluid may comprise ammonia, carbon dioxide, hydrocarbons, refrigerants, or combinations thereof which may be selected based in part on expected temperature ranges. In some embodiments, thermosyphon heat pipes may include an evaporator section below grade and a condenser section above grade comprising fins configured to reject heat to ambient air.

In some embodiments, thermosyphon pylons may be arranged at intervals along a conduit length, where interval spacing may be selected based at least in part on conduit weight, wind loads, icing loads, snow loads, and terrain constraints. In some embodiments, each pylon may comprise a conduit support saddle configured to cradle the conduit and distribute loads. In some embodiments, a support saddle may comprise low-friction liners, sliding bearings, or combinations thereof configured to accommodate conduit movement due to thermal expansion.

In some embodiments, conduit supports may include saddles configured to distribute load and guides configured to restrain lateral motion. In some embodiments, a support may be a fixed anchor support while other supports may be sliding supports to permit axial expansion.

In some embodiments, lateral restraint may be provided by guide brackets, braces, anchors into rock, cross-bracing, guying, rock anchors, or combinations thereof, where lateral restraint may be configured to resist downhill sliding forces, wind-induced lateral forces, avalanche loads, snow load conditions, or combinations thereof. In some embodiments, thermosyphon pylons may provide a combination of structural support and thermal management of a foundation region such that a slope foundation may remain mechanically stable over seasonal cycles. In some embodiments, pylons may be configured with corrosion protection and/or ice protection features comprising coatings, sacrificial anodes, protective wraps, or combinations thereof.

### Example Air Inlet at Lower Elevation and Air Outlet at Higher Elevation

In some embodiments, an air inlet may be positioned near a base of a hillside or mountainside, and an air outlet may be positioned near a higher elevation region. In some embodiments, an inlet may comprise a structure configured to admit ambient air and to condition airflow entering a conduit. In some embodiments, the inlet may comprise inlet shutters, inlet screens, snow and debris deflectors, a turbine housing, or combinations thereof.

In some embodiments, an outlet may comprise an outlet hood, diffuser, discharge nozzle, or combinations thereof configured to direct airflow and manage discharge losses. In some embodiments, an outlet may further comprise outlet shutters configured to control discharge and reduce wind-driven reverse flow. In some embodiments, outlet shutters may be configured to reduce wind-driven pressure oscillations at higher elevation.

In some embodiments, an inclined conduit may be partially embedded in a hillside, partially covered by berms, and/or partially shielded by protective structures configured to reduce exposure to falling debris, rockslide impacts, snow drift accumulation, or combinations thereof. In some embodiments, protective barriers may be positioned upslope of the conduit and may comprise walls, berms, nets, fences, or combinations thereof configured to intercept debris.

Example Thermal Exchange Zone Using Water Spraying within the Inclined Conduit

In some embodiments, the system may comprise a thermal exchange zone configured to transfer heat from water to air within the inclined conduit. In some embodiments, the thermal exchange zone may be positioned near an inlet region such that cold air entering the inlet may contact sprayed water and may be warmed before traveling upslope through the conduit. In some embodiments, a water spraying system may be positioned at a lower region of the conduit and may comprise spray bars, nozzle arrays, water supply headers, manifolds, or combinations thereof configured to direct spray into moving airflow.

In some embodiments, the inclined geometry may influence water collection and drainage. For example, in some embodiments sprayed water may travel downslope along interior surfaces, may collect in channels at a lower side of the conduit, and/or may drain into a basin near the inlet. In some embodiments, the conduit may comprise internal gutters, drain troughs, collection channels, sloped internal floors, ledges, or combinations thereof configured to capture liquid water and melted ice and convey the water to a collection basin. In some embodiments, intermediate low points may be provided with sumps and/or ice collection bins configured to reduce accumulation that could reduce effective flow area. In some embodiments, a collection basin may comprise a sump configured to provide suction head for recirculation pumps.

In some embodiments, droplet size and spray pattern may be selected to manage carryover in the inclined conduit. For example, in some embodiments nozzle orientation may be configured to direct spray generally upward into airflow and/or generally transverse to airflow to increase residence time, while managing droplet impingement on surfaces. In some embodiments, drift eliminators and/or droplet eliminators may be installed downstream of a spray region and may be oriented to accommodate inclined flow.

### Example Water Transport Along Slope and Distributed Spray Stations

In some embodiments, the system may comprise a water supply and spray system configured to spray liquid water into the airflow conduit under conditions such that at least a portion of the liquid water freezes and warms the air. In some embodiments, water may be transported along a slope in insulated and/or heated flow lines supported by pylons and/or separate supports. In some embodiments, multiple spray stations may be distributed along a conduit length, and the system may activate particular stations responsive to measured temperature and humidity conditions along the conduit.

### Example Ice Mitigation Using Heated Lines, Selectively Heated Spray Surfaces, and Compressed Air or Compressed Heated Air

In some embodiments, the inclined conduit system may comprise anti-icing and/or de-icing features, including heated flow lines, selectively heated spray surfaces, compressed air, compressed heated air, or combinations thereof. In some embodiments, heating and purge cycles may be scheduled responsive to predicted icing risk based at least in part on ambient temperature, wind, humidity, or combinations thereof. In some embodiments, de-icing may be applied to nozzle tips, manifold junctions, droplet eliminators, drift eliminators, shutter hinge lines, or combinations thereof.

In some embodiments, compressed air injection may be configured to provide periodic clearing cycles responsive to sensor data. For example, in some embodiments a controller may initiate a compressed-air pulse responsive to detecting increased pressure drop across a drift eliminator and/or droplet eliminator, responsive to detecting reduced spray flow, responsive to detecting reduced airflow velocity, or combinations thereof. In some embodiments, compressed heated air may be used in de-icing cycles to provide both mechanical dislodgement and thermal softening of ice.

Example Removal of Material, Such as Solid or Liquid, an Example Comprising Continuous Removal Using an Auger and/or Batch Removal Using a Trap Door

In some embodiments, ice and/or residual water removal may be implemented using continuous means such as a auger positioned at a collection region. In some embodiments, multiple augers may be employed at multiple collection regions. In some embodiments, an auger may be positioned within a basin near the inlet, within an ice collection channel within the conduit, and/or within a dedicated ice sump. In some embodiments, circulation currents may be employed in a basin to direct ice toward an auger intake.

In some embodiments, batch removal may be implemented using one or more trap doors that discharge to chutes, bins, conveyors, containment areas, or combinations thereof located outside the conduit. In some embodiments, a trap door may be positioned at a basin floor, at a low point of an ice sump, and/or at an outlet of an ice collection channel. In some embodiments, batch removal may be employed for consolidated ice that may accumulate during high-freezing-rate conditions and/or during reduced auger operation.

In some embodiments, manual removal may be performed using access panels, service walkways, access doors, internal platforms, ladders, anchor points for safety lines, and service lighting configured for maintenance in cold environments. In some embodiments, manual removal may be applied to localized accretions on spray manifolds, droplet eliminators, drift eliminators, shutter frames, shutter hinges, and other internal structures.

Example Passive Shutters at Inlet and Outlet with Selective Active Control

In some embodiments, the inclined conduit system may comprise passive shutters on an air inlet and on an air outlet. In some embodiments, inlet shutters may open inward toward a conduit interior responsive to inflow. In some embodiments, inlet shutters may comprise tunable mechanical features such as adjustable counterweights, adjustable springs, adjustable stops, adjustable hinge friction, or combinations thereof to set a desired opening behavior. In some embodiments, inlet shutters may selectively transition to active control by employing actuators configured to open, close, and/or modulate shutters responsive to control commands.

In some embodiments, outlet shutters may comprise louvers and/or panels configured to regulate discharge and reduce wind-driven reverse flow. In some embodiments, outlet shutters may selectively transition to active control responsive to wind conditions, icing indicators, desired airflow control objectives, or combinations thereof. In some embodiments, shutter surfaces and hinge regions may comprise anti-icing measures including heat tracing, localized heaters, ice-adhesion-reducing coatings, localized air purges, drainage channels, or combinations thereof.

### Example Power Generation Unit and Example Operational Performance for the 600 m Hillside Configuration

In some embodiments, the inclined conduit system may comprise a power generation unit positioned to convert kinetic energy of airflow into electrical power. In some embodiments, the power generation unit may comprise a turbine coupled to a generator, where the turbine may be positioned at or near the inlet, within the conduit, at or near the outlet, or in a combination of locations.

In an example embodiment with an elevation difference of about 600 meters, an internal conduit diameter of about 30 meters, inlet air at an ambient temperature of about −30 degrees Celsius, and a water source at about 0 degrees Celsius in the thermal exchange zone, the system may generate about 6.87 megawatts of electrical power. In some embodiments, power output may vary based at least in part on conduit friction losses associated with the inclined length, conduit pressure losses, wind assistance at the outlet, shutter configuration, water spray rate, droplet size, freezing fraction, turbine efficiency, turbine operating point, and control setpoints.

In some embodiments, a control system may coordinate spray operation, shutter positions, turbine settings, auger operation, trap door scheduling, and de-icing cycles to maintain desired airflow and to manage ice formation while enabling power generation.

### Example Embodiment—Integrated Direct Air Capture (DAC) and Power Generation Using an Airflow Conduit (about 300 m Elevation Difference) with DAC Contactor Fluidly Coupled to Airflow (Including an in-Line, Bypass, and/or Slipstream Arrangement); Energy Balancing for CO₂ Regeneration; Optional Avoidance of Desorption Via CO₂-Enriched Byproducts; and Operational Examples Including Capture Fractions Based on Available Generated Power

Some embodiments may comprise a combined system configured for (i) power generation from buoyancy-driven airflow produced by contacting cold ambient air with liquid water under conditions in which at least a portion of the liquid water freezes and releases heat, and (ii) direct air capture (DAC) of carbon dioxide (CO₂) from at least a portion of the airflow associated with the power generation system. In some embodiments, the system may comprise a airflow conduit configured to convey air from a lower elevation to a higher elevation, a thermal exchange zone configured to transfer heat from a fluid to air to induce upward airflow, a power generation unit configured to convert airflow kinetic energy to electrical power, and a DAC contactor fluidly coupled to airflow associated with the airflow conduit.

Example Airflow Conduit and Thermal Exchange Consistent with a 300 m Elevation-Difference Configuration

In some embodiments, the combined system may comprise an airflow conduit having an elevation difference between an air inlet and an air outlet of approximately 300 meters. In some embodiments, the airflow conduit may comprise a vertical conduit. In some embodiments, the airflow conduit may comprise a vertical segment fluidly coupled to a generally horizontal segment via a bend having an included angle of about 90 degrees and/or within a range of about 60 degrees to about 120 degrees, with turning vanes, guide plates, and/or flow straighteners configured to manage pressure losses and swirl.

In an example embodiment, the airflow conduit may have an internal diameter of about 30 meters. In some embodiments, the airflow conduit may be constructed from prefabricated steel tube sections and may be supported at least in part by guy wires. In some embodiments, the airflow conduit may include a thermal exchange zone with water spraying, heated flow lines, selectively heated spray surfaces, compressed air and/or compressed heated air for ice dislodgement, continuous ice removal using an auger, batch removal using a trap door, and passive shutters at both inlet and outlet that may selectively transition to active control.

In some embodiments, a power generation unit may comprise a turbine coupled to a generator. In some embodiments, electrical power output may be used to support DAC operations including pumps, blowers, valves, actuators, control systems, and regeneration equipment.

Example DAC Contactor Integration with the Airflow Conduit (In-Line, Bypass, and Slipstream Configurations)

In some embodiments, a DAC portion may be integrated in the same airflow path used for power generation and/or may be fluidly coupled to the same airflow via ducting and controllable flow split mechanisms. In some embodiments, a DAC contactor may be configured to contact at least a portion of airflow with a CO₂ capture medium. In some embodiments, the DAC contactor may comprise an absorber, an adsorber, or a combination thereof.

In some embodiments, the DAC contactor may be fluidly coupled to airflow moving through the airflow conduit and may be positioned in-line within the airflow conduit, positioned at or near the air inlet, positioned at or near the air outlet, positioned in a bypass duct, positioned in a slipstream branch that receives a portion of the airflow, or positioned in a parallel duct coupled to the airflow conduit.

In some embodiments, a slipstream configuration may be employed in which a portion of the airflow through the airflow conduit may be directed toward the DAC contactor.

In some embodiments, a slipstream may be established using a diversion duct coupled to the airflow conduit and a flow control element configured to modulate a fraction of airflow entering the DAC contactor. In some embodiments, the flow control element may comprise a damper, a shutter, a valve, a louver bank, a variable-area nozzle, or combinations thereof. In some embodiments, air diverted through a DAC contactor may be returned to the airflow conduit downstream of a contactor section via a mixing section, and/or may be discharged separately through a dedicated exhaust and/or stack structure.

In some embodiments, the diverted fraction may be selected based at least in part on capture efficiency of the DAC contactor, available regeneration energy, an allowable pressure drop, desired net electrical power, desired net CO₂ capture, or any combination thereof. In some embodiments, the system may adjust a slipstream fraction responsive to measured contactor pressure drop, measured net power, measured sorbent loading, measured regeneration capacity, measured outlet CO₂ concentration, or combinations thereof.

### Example DAC Contactor Hardware and Capture Media

In some embodiments, DAC contactor hardware may comprise one or more or any combination of the following contactor types: packed beds; structured packing contactors; packed towers; structured packing modules; spray towers; tray columns; membrane contactors; rotating contactors; rotating packed beds; monolith modules; honeycomb modules; fiber-based contactors; structured laminates; moving-bed sorbent systems; and rotating-bed sorbent systems. In some embodiments, a DAC contactor may be configured to promote gas-liquid contact for absorption and/or gas-solid contact for adsorption while managing pressure drop. In some embodiments, pressure drop management may be selected based at least in part on preserving power generation by maintaining airflow velocity through a turbine.

In some embodiments, an absorber may comprise a liquid-phase absorbent configured to chemically bind and/or physically dissolve CO₂. In some embodiments, an absorbent may include one or more or any combination of the following: aqueous alkaline solutions comprising sodium hydroxide; aqueous alkaline solutions comprising potassium hydroxide; carbonate solutions; bicarbonate solutions; carbonate and/or bicarbonate solutions; amino acid salt solutions; amine solutions; blended absorbents; ionic liquids; and combinations thereof.

In some embodiments, an adsorber may comprise a solid-phase sorbent configured to capture CO₂ by adsorption. In some embodiments, a sorbent may include one or more or any combination of the following: solid amine sorbents on porous supports; amine-functionalized sorbents; alkali metal carbonates; alkali metal hydroxides supported on porous substrates; metal-organic framework materials; zeolites; activated carbon; functionalized activated carbon materials; polymeric sorbents; alkaline earth oxides; alkaline earth hydroxides; and ion-exchange resins configured for CO₂ capture.

### Example Energy Balancing for CO₂ Regeneration and Example Avoidance of Desorption

In some embodiments, the DAC system may include regeneration configured to produce a concentrated CO₂ stream. In some embodiments, regeneration may comprise thermal regeneration, steam stripping, vacuum regeneration, pressure swing, temperature swing, humidity swing, electrochemical regeneration, calcination, or any combination thereof. In some embodiments, electrical power generated by a power generation unit may be used to power regeneration equipment, including heaters, pumps, vacuum pumps, compressors, blowers, and control systems.

In some embodiments, if a total mass flow of CO₂ passing through the airflow conduit were captured at a high fraction by a DAC contactor and subsequently regenerated, energy required to desorb and recover the CO₂ may be greater than electrical power generated by airflow-based power generation, particularly in operational regimes where generated power provides a primary energy source for desorption. In some embodiments, the system may employ additional energy sources to support regeneration, which may enable capture and regeneration of a greater percentage of a CO₂ mass flow. In some embodiments, additional energy sources may comprise grid power, renewable electricity from external sources, combustion-based heat sources, waste heat sources, geothermal heat, solar thermal heat, heat recovered from compression, heat pumps, thermal energy storage, or combinations thereof, and selection may be based at least in part on site availability and desired net CO₂ removal objectives.

In some embodiments, desorption may be avoided or may not be required. For example, in some embodiments a DAC output may be a CO₂-enriched or CO₂-rich byproduct comprising a carbonate- and/or bicarbonate-containing salt and/or solution. In some embodiments, the byproduct may comprise sodium carbonate, sodium bicarbonate, or combinations thereof. In some embodiments, the byproduct may be stored, transported, used as an industrial feedstock, used for mineralization pathways, and/or used in other processes where a CO₂-enriched material may provide value.

### Example Use of Low-Absorption-Efficiency or Low-Pressure-Drop Designs Based on CO₂ Mass Flow Relative to Available Regeneration Energy

In some embodiments, a relatively large mass flow of CO₂ through an airflow conduit, compared to an amount of regeneration energy available from generated power, may enable operation with a DAC contactor configured for lower capture efficiency per pass. In some embodiments, a lower capture efficiency design may enable use of sorbents and/or absorbents with lower regeneration energy consumption, may enable use of contactor geometries with lower pressure drop, or may enable both, thereby supporting improved overall system energy efficiency.

In some embodiments, the system may prioritize maintaining higher airflow rates through a conduit and through a turbine by selecting DAC contactor designs with reduced pressure loss. For example, in some embodiments the system may employ larger flow cross-sections, lower face velocities, structured packing with low resistance, rotating contactors with enhanced mass transfer per pressure drop, or combinations thereof. In some embodiments, a slipstream arrangement may be selected to limit pressure drop imposed on a main airflow path by routing only a portion of airflow through a DAC contactor.

### Example Operational Calculations for Combined Power Generation and DAC Capture

In an example embodiment, an airflow conduit may have an elevation difference of about 300 meters between an air inlet and an air outlet and may be constructed as a vertical conduit and/or may be constructed on an elevated terrain feature that provides the same elevation difference. In this example embodiment, with ambient air at about −30 degrees Celsius, the system may generate about 3.4 megawatts of electrical power, corresponding to about 3.4 megawatt-hours of electrical energy over a one-hour period.

In some embodiments, an airflow mass passing through the conduit over one hour may be about 48,641 metric tons of air, and a corresponding CO₂ mass passing through the conduit over the same period may be about 21.89 tons of CO₂.

In one example, if regeneration energy is about 6 gigajoules per ton of CO₂ (about 1.67 megawatt-hours per ton of CO₂), and if generated electricity is applied to regeneration on an approximately one-to-one energy basis, the system may regenerate about 2.035 tons of CO₂ per hour using about 3.4 megawatt-hours of electrical energy. In this example, the regenerated CO₂ amount may correspond to about 9.30% of the CO₂ mass passing through the airflow conduit over the hour.

In some embodiments, the DAC contactor may capture only a portion of CO₂ from air that passes through it, and capture efficiency may influence a slipstream fraction. For example, in some embodiments, if a DAC contactor has a capture efficiency of about 70% for air that passes through the contactor, and if a target overall capture corresponding to available regeneration energy corresponds to about 9.30% of conduit CO₂ throughput, the system may direct about 13.29% of airflow through the conduit into the DAC contactor to achieve that target capture, where the slipstream fraction may be adjusted responsive to measured performance.

In another example, in some embodiments, if a DAC contactor has a capture efficiency of about 20% for air that passes through the contactor and regeneration energy is about 3 gigajoules per ton of CO₂ (about 0.83 megawatt-hours per ton of CO₂), about 3.4 megawatt-hours of electrical energy may regenerate about 4.09 tons of CO₂ per hour, which may correspond to about 18.60% of the CO₂ mass passing through the airflow conduit in that hour. In some embodiments, a slipstream fraction may be selected based at least in part on the 20% capture efficiency to provide sufficient contacted air to achieve that regenerated quantity, and the system may adjust the slipstream fraction responsive to real-time measurements of sorbent loading and regeneration capacity.

### Example Pressure Drop and Net Power Considerations

In some embodiments, direct air contacting for CO₂ capture may introduce pressure drop, and the pressure drop may reduce airflow velocity and may reduce power generation. In some embodiments, the system may manage this tradeoff by selecting a contactor type and geometry with reduced pressure loss, selecting a slipstream fraction that limits an amount of air routed through higher-resistance equipment, coordinating shutter positions to support desired pressure differentials, coordinating turbine operating point to maintain efficient operation under varying total system resistance, and coordinating bypass fractions around contactors.

In some embodiments, the combined system may mitigate pressure drop by increasing contactor frontal area, reducing face velocity, employing low-resistance structured packing and/or monoliths, operating multiple modules in parallel, maintaining a bypass fraction around a contactor, or combinations thereof. In some embodiments, the combined system may adjust a slipstream fraction responsive to measured pressure drop and measured net power, thereby maintaining a selected net output.

### Example Coordinated Controls and Cold-Environment Operability of DAC Equipment

In some embodiments, the combined system may comprise coordinated controls between power generation and DAC subsystems. In some embodiments, a controller may allocate generated electrical power between export and regeneration based at least in part on an export target, a CO₂ capture target, an electricity price signal, regeneration cycle requirements, or combinations thereof. In some embodiments, the controller may coordinate water spray rate, water temperature management, shutter positions, turbine operating point, slipstream diversion, and de-icing cycles to manage icing risk and maintain desired performance.

In some embodiments, DAC ducting and/or contactor housings may comprise insulation and/or heating configured to maintain operability of dampers, valves, and seals. In some embodiments, a DAC subsystem may include condensate and frost management features comprising drainage channels, heated edges, defrost cycles, warm-air purge cycles responsive to measured contactor pressure drop and measured humidity, or combinations thereof.

In some embodiments, a combined system may be operated to optimize a selected objective function comprising net electrical power export, net CO₂ captured and regenerated, net CO₂ converted to a CO₂-enriched byproduct, reliability under icing conditions, maintenance intervals, or any combination thereof. In some embodiments, control logic may adjust sprayer rate, water temperature management, shutter positions, turbine settings, DAC slipstream fraction, and regeneration duty responsive to measured ambient conditions and system operating constraints.

### Example Airflow Control Elements

In some embodiments, an “Air Flow Control Element” may comprise, for example, systems, methods, and devices for controlling airflow, which may include, but may not be limited to, preventing backpressure or backflow of air, or directing wind in a manner to facilitate or enhance air flow velocity within the air flow conduit, or directing or utilizing wind in a manner to facilitate or enhance power generation, or directing wind in a manner to facilitate or enhance power generation rather than inhibit or reduce power generation, or optimizing airflow characteristics to enhance or enable improved performance or power generation, or any combination thereof. In some embodiments, the “Air Flow Control Element” may be distinct from systems and methods for liquid, or solid, or any combination thereof removal or management, such as trap doors or angled surfaces used to remove liquid, solid, or any combination thereof. For example, in some embodiments, adjusting an Air Flow Control Element influences the airflow in an air conduit, irrespective of its influence on the removal of liquid, solid, or any combination thereof. For example, in some embodiments, adjusting systems and methods for liquid, or solid, or any combination thereof removal or management influences the removal of liquid, or solid, or any combination thereof, irrespective of its influence on the airflow.

The “Air Flow Control Element” may comprise systems, methods, and devices for controlling airflow, such as preventing backpressure or backflow of air, or directing wind in a manner to facilitate or enhance air flow velocity within the air flow conduit, or directing or utilizing wind in a manner to facilitate or enhance power generation, or directing wind in a manner to facilitate or enhance power generation rather than inhibit or reduce power generation, or optimizing airflow characteristics to enhance or enable improved performance or power generation, or any combination thereof. In some embodiments, the “Air Flow Control Element” may be distinct from systems and methods for liquid, or solid, or any combination thereof removal or management, such as trap doors or angled surfaces used to remove liquid, solid, or any combination thereof. Adjusting an Air Flow Control Element influences the airflow in an air conduit, irrespective of its influence on the removal of liquid, solid, or any combination thereof. Adjusting systems and methods for liquid, or solid, or any combination thereof removal or management influences the removal of liquid, or solid, or any combination thereof, irrespective of its influence on the airflow.

In some embodiments material and/or materials useful to make the airflow control element or elements are not particularly critical so long as it functions as described herein. To the extent that a material or materials are employed that do freeze to an extent that the function of the airflow control element is substantially impaired, then steps may be taken to mitigate and/or prevent the effects of such freezing. Accordingly, useful materials have a wide scope and may include, for example, synthetic or natural materials, metal or non-metal materials, polymeric materials, composite materials, or any combination thereof.

In some embodiments, it may be desirable for the materials of an airflow control element to maintain functional properties in low temperature climates or low temperature conditions, such as down to temperatures less than one or more or any combination of the following: 0° C., −10° C., or −20° C., or −30° C., or −40° C., or −50° C., or −60° C., or −70° C., or −80° C.

For example, in some embodiments, it may be desirable for the airflow control element, or other components herein, to be constructed from low air temperature resistant materials, which may include, but are not limited to, one or more or any combination of the following: low carbon steel, or high alloy steel, or copper, or cupronickel, or stainless steel, or aluminum alloys, or titanium alloys, or nickel based materials, or plastics, or PEEK, or UHMW, or polyamides, or UHMW Polyethylene (UHMWPE), or PEEK (Polyether Ether Ketone), or polyimides, or Thermoplastic Polyurethane (TPU), or polycarbonate, or impact modified polycarbonate, or LDPE, or HDPE, or composite materials, or fiberglass, or carbon fiber, or epoxy resins, or polyesters, or high performance synthetics.

Some embodiments may employ systems and methods for deicing, or ice prevention, or freeze prevention, or freeze reduction, or any combination thereof of the air flow control elements. For example, in some embodiments, some airflow control elements may comprise selectively heated surfaces or components or heat traced components, which may prevent freezing or may enable de-icing or de-locking or de-freezing. For example, some airflow control elements may be contacted with or sprayed with a deicing fluid, such as a low freezing point fluid such as brine or antifreeze, which may enable the removal of or dislodging of, or the prevention of, or any combination thereof freezing, or surface freezing, or locking up, or any combination thereof of an air control element. In some embodiments, materials, or surfaces, or coatings, or any combination thereof may be employed to prevent or minimize, for example, including, but not limited to, one or more or any combination of the following: ice or salt adhesion, or freezing up, or locking up, or corrosion, or degradation, or scaling, or fouling, or biofouling, or any combination thereof.

### Example Passive Air Flow Control Element

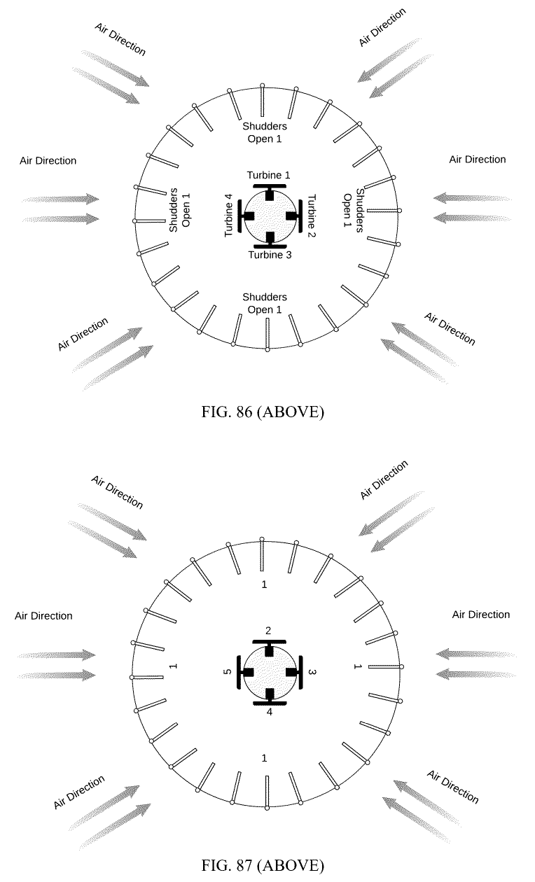

Some embodiments may employ a passive airflow control element. For example, in some embodiments, a passive airflow control element may comprise an airflow control element which may adjust in response changes in relevant conditions, such as air pressure differences, or air flow velocity, or airflow direction, or related stimuli, or any combination thereof, wherein the adjustment or adjusting may occur due to said changes in relevant conditions themselves, or may be powered by or in part powered by, or caused by or in-part caused by said changes in said relevant conditions. For example, in some embodiments, a passive airflow control element may comprise an inswing shutter. For example, in some embodiments, a passive airflow control element may comprise an inswing shutter which may be fluidly connected to the air inlet of an air conduit. For example, in some embodiments, a passive airflow control element may comprise an outswing shutter which may be fluidly connected to the air outlet of an air conduit. For example, in some embodiments, a passive airflow control element may comprise an inswing shutter, such as an inward rotating shutter, such as, for example, the inswing shutters which may be shown in FIG. 86-FIG. 91. For example, in some embodiments, an inswing shutter may be configured to naturally open and/or close based on the difference in localized pressure (or force) acting on the exterior side of the shutter and the localized pressure (or force) acting on the interior side of the shutter. For example, in some embodiments, if the air pressure acting on the exterior side of the shutter exceeds the air pressure acting on the interior side of the shutter, the shutter may at least partially open. For example, in some embodiments, if the air pressure acting on the interior side of the shutter exceeds the air pressure acting on the exterior side of the shutter, the shutter may at least close open. In some embodiments, a simplified practical analogy may comprise an interior door in a house with the windows open, wherein the interior door may close when air is flowing through a house and the airflow velocity or airflow vector is such that the air pressure on the interior side of the door exceeds the air pressure on the exterior side of the door (such as, for example, when wind is blowing from the inside of the room into the hallway); and wherein the interior door may open when air is flowing through a house and the airflow velocity or airflow vector is such that the air pressure on the exterior side of the door exceeds the air pressure on the interior side of the door (such as, for example, when wind is blowing from the hallway into the room).

### Example Active Air Flow Control Element

Some embodiments may employ an active airflow control element. In some embodiments, an active airflow control element may employ applied power, or instructions, or any combination thereof to adjust. For example, in some embodiments, an active air flow controller may comprise a mechanically actuated damper, which may be remotely operated, or autonomously operated, or any combination thereof. For example, in some embodiments, a mechanically actuated damper may adjust its angle or angle-of-attack in response to instructions or signals, which may be related to or may be independent of changes in relevant conditions, such as air pressure differences, or air flow velocity, or airflow direction, or related stimuli, or any combination thereof. In some embodiments, adjustments to a mechanically actuated damper may be pro-active, or predictive, or based on predicted information, or based on strategy or decisions, or based on signals, or any combination thereof. In some embodiments, the mechanism of an active adjustment of a mechanically actuated damper may be capable of occurring irrespective or independent of the current relevant conditions, conditions, such as air pressure differences, or air flow velocity, or airflow direction, or related stimuli, or any combination thereof.

### Example Hybrid Active and Passive Air Flow Control Element

Some embodiments may employ an airflow control element which may be active, or passive, or selectively active, or selectively passive, or functionally passive, or functionally active, or hybrid active-passive, or partially active, or partially passive, or any combination thereof.

For example, in some embodiments, an air flow control element may have an active mode and a passive mode. For example, in some embodiments, an airflow control element may comprise a shutter with a motorized hinge, wherein the motorized hinge may engage during active mode, and may disconnect or disengage during passive mode. For example, in some embodiments, if a serious adverse weather event, or a land slide, or avalanche, or any combination thereof were to be forecasted or to occur, it may be desirable to engage the active mode to close the shutters to prevent harm to the system. For example, in some embodiments, active mode may be employed to facilitate opening of the shutters at the air inlet when no or insufficient airflow is occurring. For example, in some embodiments, active mode may be employed to facilitate closing of the shutters at the air inlet when no wind or airflow no or insufficient occurring. For example, in some embodiments, active mode may be engaged in turbulent or inconsistent airflows where some passive modes may insufficiently respond. For example, in some embodiments, active mode may be employed if a shutter is damaged, or passive mode may not be operating as desired, or any combination thereof. In some embodiments, for example, a shutter may turn off active mode or disengage active mode and engage passive mode if there may be a loss in communication, or a loss in power to the active mode mechanism, or any combination thereof. For example, in some embodiments, active mode may be engaged to optimize airflow in a manner which may differ from airflow management in passive mode, such as, for example, responding to unusual airflow patterns, or responding to economic factors, or responding to power demand factors, or responding to carbon dioxide demand factors, or responding to changing in the operating state or condition of the system, or responding to factors which may be not be captured by or may be sufficiently or improperly captured by passive mode.

For example, in some embodiments, an air flow control element may have active elements and passive elements. For example, in some embodiments, an air flow control element may comprise a shutter, wherein position of the shutter on its hinges may be actively adjusted and/or the gap between the shutter and the shutter frame may be actively adjusted, while the opening and closing of the shutter may occur (adjust) passively.

For example, in some embodiments, an air flow control element may have active elements and passive elements. For example, in some embodiments, an air flow control element may comprise a shutter, wherein the locking or unlock of the shutter position may occur actively, while the opening and closing of the shutter may occur (adjust) passively.

### DAC Contactors or Collectors

In some embodiments, a CO₂ absorbents and/or adsorbents may comprise, for example, including, but not limited to, one or more or any combination of the following: a fluid absorbent, or amine, or ammonia, or aqueous ammonia, or Aqueous monoethanolamine (MEA), or aqueous diethanolamine (DEA), or aqueous methyldiethanolamine (MDEA), or aqueous piperazine (PZ), or piperazine-promoted MDEA (MDEA/PZ), or sterically hindered amines (e.g., AMP: 2-amino-2-methyl-1-propanol), or blended amine solvents (e.g., MEA/MDEA, AMP/PZ), or aqueous ammonia (chilled ammonia process solvent), or potassium carbonate solution (hot carbonate), or potassium carbonate promoted with piperazine, or sodium carbonate/bicarbonate solution, or amino-acid salt solutions (e.g., potassium glycinate, taurinate, sarcosinate), or ammonia-based carbonate/bicarbonate solutions, or ionic-liquid physical/chemical absorbents (task-specific ionic liquids for CO2), or deep eutectic solvents (CO2-philic DES), or Selexol-type dimethyl ethers of polyethylene glycol (DEPG) physical solvent, or Rectisol (cold methanol) physical solvent, or propylene carbonate physical solvent, or N-methyl-2-pyrrolidone (NMP) physical solvent, or Sulfinol (sulfolane+amine blend), or hot potassium carbonate with activators (e.g., vanadium-based promoters), or sodium hydroxide (NaOH) caustic scrubbing, or potassium hydroxide (KOH) caustic scrubbing, or calcium hydroxide (Ca(OH)2) lime slurry (carbonate looping absorption), or calcium oxide (CaO) sorbent (calcium looping), or magnesium oxide (MgO) sorbent, or magnesium hydroxide (Mg(OH)2) slurry, or limestone (CaCO3) as a precursor for carbonate looping systems, or sodium zirconate (Na2ZrO3) high-temperature chemisorbent, or lithium zirconate (Li2ZrO3) high-temperature chemisorbent, or lithium orthosilicate (Li4SiO4) high-temperature chemisorbent, or hydrotalcite-like layered double hydroxides (LDHs), or activated carbon (steam-activated), or impregnated activated carbon (amine-impregnated), or activated carbon molecular sieves, or biochar (engineered high-surface-area), or carbon nanotube-based sorbents, or graphene/graphene-oxide-based sorbents, or carbon-supported amine sorbents (polyethyleneimine on carbon), or zeolite 13X, or zeolite 5A, or zeolite 4A, or zeolite NaX, or zeolite NaY, or SAPO-34, or chabazite (CHA) zeolites, or high-silica zeolites (hydrophobic variants for wet flue gas), or alumina (γ-Al2O3) supports with amine functionalization, or silica gel (porous silica) with amine functionalization, or mesoporous silica (MCM-41) with grafted amines, or mesoporous silica (SBA-15) with grafted amines, or porous polymer resins (styrene-divinylbenzene) with amine functionality, or hypercrosslinked polymer sorbents, or polymeric amine resins (e.g., anion-exchange resins in carbonate/bicarbonate form), or polyethyleneimine (PEI) on porous supports (silica/alumina/carbon), or tetraethylenepentamine (TEPA) on porous supports, or aminopropyl-silane-grafted silica (APTES-silica), or supported piperazine sorbents, or metal-organic frameworks (MOFs) with open metal sites (e.g., Mg-MOF-74/CPO-27-Mg), or MOFs with amine-appended pores (e.g., diamine-appended M2 (dobpdc) families), or zeolitic imidazolate frameworks (ZIFs) tuned for CO2, or porous aromatic frameworks (PAFs), or covalent organic frameworks (COFs) with CO2-philic functional groups, or porous organic polymers (POPs) with amines, or Prussian blue analogues (porous coordination polymers), or silica-supported alkali carbonates (K2CO3/Na2CO3 on alumina/silica), or potassium carbonate on activated carbon (K2CO3/AC), or sodium carbonate on alumina (Na2CO3/Al2O3), or alkali-promoted hydrotalcites (K-promoted LDH), or amine-containing hydrogels (for humid flue gas), or facilitated-transport liquid absorbents with reversible CO2 carriers (amine carriers), or enzyme-enhanced absorption solvents (carbonic anhydrase with carbonate/amine solvents), or molten carbonate sorbents (high-temperature capture in molten salts), or carbonate/bicarbonate solid sorbents (NaHCO3/Na2CO3 cycling), or potassium bicarbonate/potassium carbonate cycling sorbents, or calcium silicate-based sorbents for CO2 mineralization-assisted capture, or serpentine/olivine-derived Mg-silicate mineral sorbents, or alkaline industrial residues (steel slag) used as reactive sorbents for CO2, or cement kiln dust as a reactive alkaline sorbent, or amine-functionalized cellulose (solid sorbent), or chitosan-based amine sorbents, or polymerized ionic liquid sorbents, or phase-change solvent absorbents (CO2-triggered biphasic solvents), or water-lean amine solvents (concentrated/low-water amine systems), or hindered diamine solvents (for lower regeneration energy), or carbonate-forming potassium salts of amino acids (hybrid absorption systems), or Aqueous potassium hydroxide (KOH) solution, or aqueous sodium hydroxide (NaOH) solution, or calcium hydroxide (slaked lime) slurry, or calcium oxide (quicklime) sorbent, or potassium carbonate (K2CO3) solution, or sodium carbonate (Na2CO3) solution, or aqueous amino acid salt solution (e.g., potassium glycinate), or aqueous carbonate-bicarbonate buffer solutions, or solid calcium hydroxide pellets/granules, or magnesium oxide (MgO) sorbent, or magnesium hydroxide (Mg(OH)2) slurry, or lithium hydroxide (LiOH) sorbent, or lithium carbonate-forming solids, or alkaline brines with enhanced carbonate chemistry, or amine-functionalized porous silica (grafted aminosilanes), or amine-impregnated mesoporous silica (PEI-on-silica), or amine-grafted SBA-15 silica, or amine-grafted MCM-41 silica, or amine-functionalized alumina (grafted amines), or amine-impregnated alumina, or amine-functionalized polymer resins (amine ion-exchange resins), or weak-base anion exchange resins (tertiary amine resins), or strong-base anion exchange resins (quaternary ammonium resins), or moisture-swing anion exchange polymers, or amine-functionalized cellulose fibers, or amine-functionalized nanocellulose aerogels, or amine-functionalized activated carbon, or polyethyleneimine (PEI)-impregnated porous supports, or poly(allylamine) (PAA)-based sorbents, or polyethylenimine-epoxy crosslinked amine sorbents, or diamine-grafted porous supports (e.g., ethylenediamine on silica), or polyamidoamine (PAMAM) dendrimer-based sorbents, or amino acid-functionalized solids (e.g., lysine-grafted supports), or metal-organic frameworks (MOFs) with open metal sites (e.g., Mg-MOF-74 family), or diamine-appended MOFs (cooperative insertion MOFs), or amine-functionalized MOFs (amine-grafted linkers), or zeolitic imidazolate frameworks (ZIFs), or hydrotalcite-like layered double hydroxides (LDHs), or potassium-promoted hydrotalcites, or alkaline-promoted alumina sorbents, or alkaline-promoted zirconia sorbents, or alkali metal carbonates supported on porous carriers (K2CO3-on-support), or sodium carbonate supported on porous carriers, or potassium carbonate on activated carbon, or potassium carbonate on alumina, or potassium carbonate on silica, or cesium carbonate supported sorbents, or sodium zirconate (Na2ZrO3) chemisorbents, or lithium zirconate (Li2ZrO3) chemisorbents, or lithium silicate (Li4SiO4) chemisorbents, or calcium looping sorbents (CaO/CaCO3 cycling solids), or dolomite-derived CaO sorbents, or limestone-derived CaO sorbents, or hydrated lime-derived Ca(OH)2 sorbents, or sodium aluminate-derived CO2-reactive solids, or potassium aluminate-derived CO2-reactive solids, or activated carbon (physisorbent) tuned for CO2 at low partial pressure, or microporous activated carbon fibers, or carbon molecular sieves, or nitrogen-doped porous carbons, or porous carbon aerogels, or graphene-based porous sorbents, or biochar with engineered microporosity, or zeolites (e.g., 13X), or low-silica zeolites with high cation density, or high-silica zeolites engineered for humidity tolerance, or cation-exchanged zeolites (Na+/K+/Ca2+ forms), or silica gel (physisorbent) used in dry air streams, or mesoporous silica (physisorbent) used with temperature/vacuum swing, or aluminosilicates/clays with engineered porosity, or metal oxides with basic sites (e.g., CeO2-based), or potassium-promoted metal oxides (K-promoted MgO), or sodium-promoted MgO sorbents, or calcium-promoted MgO sorbents, or mixed alkaline earth oxides (CaO—MgO), or sodium titanate CO2 sorbents, or lithium titanate CO2-reactive solids, or amine-based ionic liquids (task-specific ionic liquids), or carbonate-forming ionic liquids (ILs that bind CO2 as carbamate/carbonate), or supported ionic liquid phase (SILP) sorbents, or polymerized ionic liquids (PILs), or deep eutectic solvents with amines (DES-amine systems), or aqueous amine solvents adapted for DAC (MEA/MDEA/AMP blends), or sterically hindered amine solvents (e.g., AMP-based), or biphasic amine solvents (phase-change amines), or amino acid-based solvents (salt solutions), or potassium carbonate promoted with amines, or guanidine- or amidine-functionalized sorbents, or superbasic organic sorbents (protonated base/carbonate systems), or electro-swing redox-active CO2 sorbents (redox polymers that capture/release CO2), or quinone-functionalized electrodes/sorbents for electrochemical CO2 capture, or moisture-assisted “humidity swing” solid sorbents (anion-exchange polymer variants), or hybrid sorbents combining amines+physisorbents (amine-on-carbon/amine-on-silica composites).

In some embodiments, CO₂ absorption or adsorption efficiency may be less than, or greater than, or equal to, or any combination thereof one or more or any combination of the following: 0%, or 1%, or 2%, or 3%, or 4%, or 5%, or 6%, or 7%, or 8%, or 9%, or 10%, or 11%, or 12%, or 13%, or 14%, or 15%, or 16%, or 17%, or 18%, or 19%, or 20%, or 21%, or 22%, or 23%, or 24%, or 25%, or 26%, or 27%, or 28%, or 29%, or 30%, or 31%, or 32%, or 33%, or 34%, or 35%, or 36%, or 37%, or 38%, or 39%, or 40%, or 41%, or 42%, or 43%, or 44%, or 45%, or 46%, or 47%, or 48%, or 49%, or 50%, or 51%, or 52%, or 53%, or 54%, or 55%, or 56%, or 57%, or 58%, or 59%, or 60%, or 61%, or 62%, or 63%, or 64%, or 65%, or 66%, or 67%, or 68%, or 69%, or 70%, or 71%, or 72%, or 73%, or 74%, or 75%, or 76%, or 77%, or 78%, or 79%, or 80%, or 81%, or 82%, or 83%, or 84%, or 85%, or 86%, or 87%, or 88%, or 89%, or 90%, or 91%, or 92%, or 93%, or 94%, or 95%, or 96%, or 97%, or 98%, or 99%, or 100%.

In some embodiments, a proof-of-concept pilot system may be employed to validate the principles of buoyancy-driven airflow power generation. A proof-of-concept pilot may employ a tower height of approximately 100 feet (approximately 30 meters). The proof-of-concept pilot may employ a pipe with a diameter of approximately 12 inches (approximately 0.3 meters). The pipe may be suspended by a crane or a mast to achieve the desired height. The proof-of-concept pilot may be connected to an empty steel water tank positioned at or near the base of the pipe. The steel water tank may serve as a water-air contacting zone where water may be contacted with air to transfer heat from the water to the air.

In some embodiments, the proof-of-concept pilot may employ two water sprayers positioned within or adjacent to the steel water tank. The two water sprayers may be configured to spray water into the air within the tank, creating water droplets that may be contacted with the air. The water sprayers may be supplied with water from a water source, and the water may be at a temperature at or above the freezing point of water. The water sprayers may create a spray pattern that may maximize the contact between the water droplets and the air within the tank.

In some embodiments, the proof-of-concept pilot may include instrumentation for measuring air velocity. Air velocity may be measured within the pipe, at the inlet of the pipe, at the outlet of the pipe, or at other locations where airflow may be present. Air velocity measurements may be obtained using anemometers, pitot tubes, hot-wire anemometers, ultrasonic flow meters, or other velocity measurement devices. The air velocity measurements may be used to calculate the volumetric airflow rate, the mass airflow rate, and the kinetic energy of the airflow.

In some embodiments, the proof-of-concept pilot may include instrumentation for measuring water flow rate. Water flow rate may be measured in the water supply lines to the water sprayers, in the water collection system, or at other locations where water flow may be present. Water flow rate measurements may be obtained using flow meters, rotameters, ultrasonic flow meters, or other flow measurement devices. The water flow rate measurements may be used to calculate the heat transfer rate, the ice production rate, and the water consumption of the system.

In some embodiments, the proof-of-concept pilot may include instrumentation for measuring temperatures. Temperatures may be measured at various locations within the system, including the ambient air temperature, the inlet air temperature, the outlet air temperature, the water temperature, the temperature within the steel water tank, and other relevant temperatures. Temperature measurements may be obtained using thermocouples, resistance temperature detectors, thermistors, or other temperature measurement devices. The temperature measurements may be used to calculate the heat transfer rate, the temperature rise of the air, and the effectiveness of the water-air contacting.

In some embodiments, the proof-of-concept pilot may be operated at outdoor conditions with ambient air temperatures below negative 20 degrees Celsius. Operation at temperatures below negative 20 degrees Celsius may provide a temperature difference of at least 20 degrees Kelvin between the water at or near the freezing point and the ambient air. The temperature difference may create a density difference between the warmed air within the pipe and the cold ambient air outside the pipe, which may induce buoyancy-driven airflow through the pipe.

In some embodiments, the proof-of-concept pilot may be operated at various outdoor conditions to characterize the performance of the system across a range of ambient air temperatures. Measurements may be obtained at ambient air temperatures of negative 20 degrees Celsius, negative 25 degrees Celsius, negative 30 degrees Celsius, negative 35 degrees Celsius, negative 40 degrees Celsius, or other temperatures that may be available at the test location. The measurements at various temperatures may be used to validate the relationship between ambient air temperature and airflow velocity, to validate the heat transfer calculations, and to validate the power generation estimates.

In some embodiments, the proof-of-concept pilot may be used to validate the scaling relationships for larger systems. The measurements from the proof-of-concept pilot may be compared to theoretical predictions based on the principles of buoyancy-driven airflow. The comparison may be used to validate the theoretical models, to identify factors that may affect performance, and to refine the estimates for larger-scale systems. The proof-of-concept pilot may provide data that may be used to design and optimize full-scale power generation systems.

In some embodiments, the proof-of-concept pilot may be used to evaluate the performance of water-air contacting methods. The two water sprayers may be operated at various flow rates, spray patterns, and droplet sizes to evaluate the effect of these parameters on heat transfer and airflow. The measurements may be used to optimize the water-air contacting for maximum heat transfer efficiency, for minimum water consumption, for effective ice production, or for other objectives.

In some embodiments, the proof-of-concept pilot may be used to evaluate ice formation and collection. When water is sprayed into cold air, at least a portion of the water may freeze to form ice. The ice may accumulate within the steel water tank, may be carried by the airflow, or may be deposited on surfaces within the system. The proof-of-concept pilot may be used to observe ice formation patterns, to evaluate ice collection methods, and to assess the impact of ice formation on system operation.

In some embodiments, the proof-of-concept pilot may be used to evaluate the operation of the system under varying wind conditions. Wind may affect the airflow through the pipe, may affect the heat transfer in the water-air contacting zone, and may affect the overall performance of the system. The proof-of-concept pilot may be operated under calm conditions and under windy conditions to evaluate the effect of wind on system performance and to develop strategies for operating under varying wind conditions.

In some embodiments, a process may further comprise absorbing at least a portion of the carbon dioxide from the air using a CO2 absorber unit fluidly connected to an air conduit. The CO2 absorber unit may be configured to contact the airflow with CO2 absorbents, CO2 adsorbents, or any combination thereof to capture carbon dioxide from the air. The airflow generated through buoyancy-driven convection may provide the air movement for contacting air with the CO₂ absorbents or adsorbents, which may reduce or eliminate the energy consumption associated with fans or blowers in conventional direct air capture systems.

In some embodiments, harnessing the airflow may comprise absorbing at least a portion of the carbon dioxide from the air using a CO2 absorber unit fluidly connected to the air conduit. The airflow generated through heat transfer from a fluid to air may be directed through the CO2 absorber unit, and the CO2 absorber unit may capture carbon dioxide from the airflow as the air passes through or over the absorbents or adsorbents. The captured carbon dioxide may be sequestered, may be utilized in industrial processes, may be converted to products, or may be otherwise managed.

In some embodiments, the airflow generated by buoyancy-driven convection may be utilized for direct air capture of CO2. Direct air capture may comprise the capture of carbon dioxide directly from ambient air, which may have a carbon dioxide concentration of less than approximately 450 parts per million. The dilute concentration of carbon dioxide in ambient air may require large volumes of air to be contacted with absorbents or adsorbents to capture meaningful quantities of carbon dioxide. The airflow generated through heat transfer from a fluid to air may provide the air movement for contacting large volumes of air with CO2 capture materials without the energy consumption associated with mechanical fans or blowers.

In some embodiments, CO2 absorbents or adsorbents may be engineered to absorb CO2 at cold ambient air temperatures. Cold ambient air temperatures may comprise temperatures below the freezing point of water, such as temperatures below 0 degrees Celsius. At cold temperatures, the solubility of gases in liquids may be higher than at warmer temperatures, and the equilibrium for CO2 absorption or adsorption may be more favorable at cold temperatures. CO2 absorbents or adsorbents engineered for cold temperature operation may have reaction kinetics and equilibrium characteristics that may allow effective CO2 capture at temperatures below the freezing point of water.

In some embodiments, CO2 absorbents or adsorbents may be engineered to desorb CO2 at warmer temperatures. Warmer temperatures may comprise temperatures at or near the freezing point of water, such as temperatures of approximately 0 degrees Celsius to approximately 4 degrees Celsius. The temperature difference between cold ambient air and warmer water may provide a thermodynamic driving force for CO2 capture and regeneration. CO2 absorbents or adsorbents may be configured to absorb CO2 when contacted with cold air and to desorb CO2 when contacted with warmer water or when heated to temperatures at or near the freezing point of water.

In some embodiments, the temperature difference between cold ambient air and the freezing point of water may be leveraged for regeneration of CO2 absorbents or adsorbents. Regeneration may comprise the release of captured CO2 from the absorbent or adsorbent material, which may restore the capacity of the absorbent or adsorbent to capture additional CO2. The temperature difference between cold ambient air at temperatures below the freezing point and water at or near the freezing point may provide the thermal energy for regeneration. The regeneration may be achieved by contacting CO2-laden absorbents or adsorbents with water at or near the freezing point, by heating the absorbents or adsorbents using heat from water, or by other methods that may utilize the temperature difference.

In some embodiments, CO2 absorbents may comprise liquid absorbents that may absorb CO2 through chemical or physical absorption. Liquid absorbents may include one or more or any combination of the following: amine solutions, or carbonate solutions, or hydroxide solutions, or ionic liquids, or other liquid absorbents, or any combination thereof. The liquid absorbents may be contacted with cold air to absorb CO2, and the CO2-laden absorbents may be regenerated by heating to temperatures at or near the freezing point of water to release the captured CO2.

In some embodiments, CO2 adsorbents may comprise solid adsorbents that may adsorb CO2 through physical or chemical adsorption. Solid adsorbents may include one or more or any combination of the following: zeolites, or activated carbon, or metal-organic frameworks, or amine-functionalized materials, or alkali metal carbonates, or other solid adsorbents, or any combination thereof. The solid adsorbents may be contacted with cold air to adsorb CO2, and the CO2-laden adsorbents may be regenerated by heating to temperatures at or near the freezing point of water to release the captured CO2.

In some embodiments, the lower temperature of cold ambient air may enable the use of lower enthalpy of reaction absorbents or adsorbents for CO2 capture. Absorbents or adsorbents with lower enthalpy of reaction may require less energy for regeneration compared to absorbents or adsorbents with higher enthalpy of reaction. The lower temperature of cold ambient air may shift the equilibrium for CO2 absorption or adsorption to be more favorable, which may allow effective CO2 capture with absorbents or adsorbents that may have lower binding energy for CO2. The use of lower enthalpy of reaction absorbents or adsorbents may reduce the energy consumption and temperature requirements for regeneration.

In some embodiments, the regeneration of CO2 absorbents or adsorbents may utilize the temperature difference between liquid water and cold ambient air directly. The temperature difference may be used as a heat source for regeneration, with heat transferred from water at or near the freezing point to the CO2-laden absorbent or adsorbent to release the captured CO2. The direct use of the temperature difference for regeneration may reduce the energy consumption of the direct air capture process.

In some embodiments, the regeneration of CO2 absorbents or adsorbents may utilize the temperature difference between liquid water and cold ambient air indirectly. Power generated from the temperature difference may be used to power regeneration processes, such as electrochemical regeneration, electrical heating, mechanical compression, or other regeneration methods. The indirect use of the temperature difference through power generation may provide flexibility in the regeneration approach and may allow regeneration methods that may not be directly powered by thermal energy.

In some embodiments, a process may further comprise generating power using a portion of the airflow and using at least a portion of the power to desorb carbon dioxide from a CO2-laden material or CO2-laden solution. The power generated from the airflow may be electrical power generated by air turbines or other power generation equipment. The electrical power may be used to power regeneration equipment, heating elements, electrochemical cells, compressors, or other equipment that may be employed to desorb CO2 from CO2-laden materials or solutions.

In some embodiments, a process may further comprise generating power using a portion of the airflow and using at least a portion of the power to desorb carbon dioxide from a CO2-laden absorbent or CO2-laden adsorbent. The CO2-laden absorbent may comprise a liquid absorbent that has absorbed CO2 from the air. The CO2-laden adsorbent may comprise a solid adsorbent that has adsorbed CO2 from the air. The power generated from the airflow may be used to heat the CO2-laden absorbent or adsorbent, to reduce the pressure over the CO2-laden absorbent or adsorbent, to drive electrochemical processes that may release CO2, or to power other regeneration processes.

In some embodiments, the use of power generated from the airflow to power CO2 desorption may reduce the carbon footprint of direct air capture processes. The power generated from buoyancy-driven airflow may be renewable power that may not involve combustion of fossil fuels. The use of renewable power for CO2 desorption may result in net carbon removal from the atmosphere, with the captured CO2 representing a net reduction in atmospheric carbon dioxide.

In some embodiments, the CO2 absorber unit may be positioned within the air conduit, at an inlet of the air conduit, at an outlet of the air conduit, or at other locations where airflow may be present. The positioning of the CO2 absorber unit may be selected based on the airflow characteristics at different locations, the temperature of the air at different locations, the desired CO2 capture rate, or any combination of such factors. The CO2 absorber unit may be positioned upstream of thermal exchange zones to contact cold air with the absorbents or adsorbents, or the CO2 absorber unit may be positioned downstream of thermal exchange zones to contact warmed air with the absorbents or adsorbents.

In some embodiments, the CO2 absorber unit may comprise contactors configured to bring air into contact with CO2 absorbents or adsorbents. Contactors may include one or more or any combination of the following: packed beds, or structured packing, or spray towers, or tray columns, or membrane contactors, or rotating contactors, or any combination thereof. The contactors may be configured to maximize the contact area between the air and the absorbents or adsorbents, to minimize the pressure drop across the contactor, to facilitate regeneration of the absorbents or adsorbents, or to achieve other objectives.

In some embodiments, colder air temperatures may reduce the total volumetric airflow required per unit of CO2 captured compared to CO2 capture at warmer air temperatures. The higher density of air at lower temperatures may result in a greater mass of air per unit volume, which may result in a greater mass of CO2 per unit volume of air. The higher solubility of CO2 in absorbents at lower temperatures may also contribute to more effective CO2 capture per unit volume of air contacted.

In some embodiments, the CO2 captured from the air may be compressed for storage or transport. Compression of CO2 may be powered by electrical power generated from the airflow. The compressed CO2 may be stored in geological formations, may be used for enhanced oil recovery, may be converted to fuels or chemicals, or may be otherwise utilized or sequestered.

In some embodiments, the CO2 captured from the air may be converted to products. Products that may be produced from captured CO2 may include one or more or any combination of the following: synthetic fuels, or methanol, or ethanol, or formic acid, or carbonates, or polymers, or building materials, or any combination thereof. The conversion of CO2 to products may be powered by electrical power generated from the airflow.

In some embodiments, a system may comprise a CO2 absorber unit fluidly connected to an airflow conduit, wherein the CO2 absorber unit may be configured to absorb at least a portion of the carbon dioxide from the air. The system may further comprise a thermal exchange zone configured to transfer heat from a fluid to air, generating an upward airflow within the airflow conduit. The airflow generated by the thermal exchange zone may provide the air movement for the CO2 absorber unit, and the CO2 absorber unit may capture carbon dioxide from the airflow.

In some embodiments, a system may comprise means to harness the airflow, wherein the means to harness the airflow may comprise a CO2 absorber unit fluidly connected to the airflow conduit and configured to absorb at least a portion of the carbon dioxide from the air. The CO2 absorber unit may be one of multiple means to harness the airflow, and the system may also comprise power generation units, freeze-desalination units, or other means to harness the airflow in addition to the CO2 absorber unit.

In some embodiments, the integration of direct air capture with buoyancy-driven airflow power generation may provide synergies that may reduce the cost and energy consumption of both processes. The airflow generated for power generation may also provide the air movement for direct air capture, eliminating the need for separate fans or blowers for the direct air capture process. The power generated from the airflow may provide the energy for CO2 desorption and regeneration of absorbents or adsorbents. The temperature difference between cold ambient air and water at or near the freezing point may provide both the driving force for buoyancy-induced airflow and the thermodynamic driving force for CO2 capture and regeneration.

In some embodiments, a direct air capture unit or contactor may be positioned at various locations relative to a thermal exchange zone within a thermal power generation system. The direct air capture unit or contactor may comprise an absorbent, or an adsorbent, or both an absorbent and an adsorbent, which may absorb or adsorb carbon dioxide from the air or from airflow passing through the system. The positioning of the direct air capture unit or contactor relative to the thermal exchange zone may affect the performance characteristics of the carbon dioxide capture process, and different positioning configurations may provide different advantages depending on the operating conditions, the absorbent or adsorbent characteristics, or the system objectives.

In some embodiments, the direct air capture unit or contactor may be located after the thermal exchange zone, or the direct air capture unit or contactor may receive airflow after the airflow has passed through the thermal exchange zone. In such embodiments, the air contacting the direct air capture unit or contactor may be warmer than the ambient inlet air because the air may have absorbed heat from the fluid in the thermal exchange zone. The warmer air temperature may enable faster absorption or adsorption kinetics, which may increase the rate at which carbon dioxide may be captured from the airflow. Faster kinetics may allow for smaller contactor sizes, may reduce the residence time required for effective carbon dioxide capture, or may increase the throughput of the direct air capture system. In some embodiments, the warmer air may also reduce the viscosity of liquid absorbents, which may improve mass transfer characteristics and may enhance the overall efficiency of the carbon dioxide absorption process.

In some embodiments, the direct air capture unit or contactor may be located before the thermal exchange zone, or the direct air capture unit or contactor may receive airflow before the airflow contacts the thermal exchange zone. In such embodiments, the air contacting the direct air capture unit or contactor may be colder than the air that has passed through the thermal exchange zone. The colder air temperature may enable greater equilibrium carbon dioxide solubility in liquid absorbents, or may provide higher carbon dioxide absorption or adsorption capacity in absorbents or adsorbents. The thermodynamic equilibrium for carbon dioxide absorption or adsorption may be more favorable at lower temperatures, which may allow for more complete capture of carbon dioxide from the airflow. In some embodiments, colder air may also be more dense than warmer air, and the higher density may result in a higher mass of carbon dioxide per cubic meter of air. The higher carbon dioxide mass concentration per unit volume may increase the driving force for absorption or adsorption and may enhance the efficiency of the direct air capture process.

In some embodiments, the direct air capture unit or contactor may be located within the thermal exchange zone. In such embodiments, the direct air capture absorbent or adsorbent may comprise a portion of the heat source or thermal source for the thermal exchange zone. The absorbent or adsorbent may release heat during the absorption or adsorption of carbon dioxide, and this heat of absorption or adsorption may contribute to warming the air passing through the thermal exchange zone. The integration of the direct air capture function with the thermal exchange function may provide synergies that may reduce the overall system complexity, may reduce the footprint of the system, or may enhance the thermal efficiency of the combined processes. In some embodiments, the absorbent or adsorbent material may be configured to contact both the fluid and the air within the thermal exchange zone, which may facilitate heat transfer while simultaneously capturing carbon dioxide from the airflow.

In some embodiments, the direct air capture unit or contactor may be positioned at multiple locations relative to the thermal exchange zone. A first direct air capture unit or contactor may be positioned before the thermal exchange zone to take advantage of the colder air temperatures and higher carbon dioxide concentrations, and a second direct air capture unit or contactor may be positioned after the thermal exchange zone to take advantage of the faster kinetics associated with warmer air temperatures. The combination of multiple direct air capture units or contactors at different positions may optimize the overall carbon dioxide capture performance across a range of operating conditions.

In some embodiments, the positioning of the direct air capture unit or contactor relative to the thermal exchange zone may be adjustable or configurable. The system may comprise flow control elements, valves, dampers, or other mechanisms that may direct airflow to different direct air capture units or contactors based on operating conditions, ambient temperatures, carbon dioxide capture objectives, or other factors. The adjustable positioning may allow the system to optimize carbon dioxide capture performance under varying conditions.

In some embodiments, CO2 desorption may be electrochemical or may comprise electrochemical desorption. Electrochemical desorption may be used as an alternative to thermal desorption for releasing captured CO2 from absorbents or adsorbents. In some embodiments, electrochemical desorption may involve the application of electrical potential to drive the release of CO2 from CO2-laden materials. Electrochemical desorption may employ electrochemical cells, electrolytic processes, or other electrochemically-driven mechanisms to release captured CO2. The electrical power for electrochemical desorption may be provided by power generated from the buoyancy-driven airflow, which may allow the direct air capture process to operate using renewable power generated on-site.

In some embodiments, electrochemical desorption may offer advantages compared to thermal desorption. Electrochemical desorption may allow CO2 release at lower temperatures than thermal desorption, which may reduce thermal stress on absorbent or adsorbent materials. Electrochemical desorption may provide more precise control over the CO2 release rate through adjustment of the applied electrical potential or current. Electrochemical desorption may be more readily powered by electrical power generated from the airflow compared to thermal desorption, which may require heat sources.

In some embodiments, a system may employ both thermal desorption and electrochemical desorption. The system may switch between thermal desorption and electrochemical desorption based on operating conditions, power availability, regeneration requirements, or other factors. In some embodiments, thermal desorption and electrochemical desorption may be used in combination, with electrochemical processes assisting thermal regeneration or with thermal energy reducing the electrical energy requirements for electrochemical desorption.

In some embodiments, electrochemical desorption may employ pH swing mechanisms. Changes in pH induced by electrochemical processes may shift the equilibrium for CO2 absorption or adsorption, causing release of captured CO2. Electrochemical pH swing processes may be particularly suitable for liquid absorbents such as carbonate solutions or hydroxide solutions.

In some embodiments, the fluid may be sourced from various bodies of water. Bodies of water that may serve as fluid sources may include one or more or any combination of the following: oceans, or seas, or lakes, or rivers, or estuaries, or bays, or ponds, or streams, or any combination thereof. The selection of a body of water as a fluid source may depend on geographic location, proximity to the system, water availability, water temperature, water composition, regulatory considerations, or any combination of such factors.

In some embodiments, the fluid may be sourced from an ocean. Oceans may provide large volumes of water that may be available for heat transfer processes. Ocean water may have a salinity of approximately 35 parts per thousand, which may result in a freezing point of approximately negative 1.8 degrees Celsius to approximately negative 2 degrees Celsius. The lower freezing point of ocean water compared to freshwater may allow heat transfer to continue at temperatures below the freezing point of freshwater. Ocean water may be sourced from coastal locations, from offshore structures, from ships, or from other locations with access to ocean water.

In some embodiments, the fluid may be sourced from a sea. Seas may comprise bodies of saltwater that may be partially enclosed by land or that may be connected to oceans. Seas may have varying salinity levels depending on factors such as freshwater inflow, evaporation rates, and connection to oceans. The salinity of sea water may affect the freezing point of the water, with higher salinity resulting in lower freezing points. Sea water may be sourced from coastal locations adjacent to seas.

In some embodiments, the fluid may be sourced from a lake. Lakes may comprise bodies of freshwater or saline water that may be surrounded by land. Freshwater lakes may have a freezing point of approximately 0 degrees Celsius. Saline lakes may have freezing points below 0 degrees Celsius depending on the salinity. Lakes in cold climates may have ice cover during winter months, with liquid water present beneath the ice layer. The liquid water beneath ice cover may be at temperatures ranging from approximately 0 degrees Celsius to approximately 4 degrees Celsius for freshwater lakes.

In some embodiments, the fluid may be sourced from a river. Rivers may comprise flowing bodies of freshwater that may originate from precipitation, snowmelt, springs, or other sources. River water may be at various temperatures depending on the season, the geographic location, the source of the water, and other factors. Rivers in cold climates may have ice cover during winter months, with liquid water flowing beneath the ice. River water may be sourced from intake structures positioned in the river.

In some embodiments, the fluid may be sourced from an estuary. Estuaries may comprise bodies of water where freshwater from rivers mixes with saltwater from oceans or seas. Estuaries may have varying salinity levels depending on the location within the estuary, the tidal conditions, the freshwater inflow, and other factors. The salinity of estuary water may affect the freezing point of the water. Estuary water may be sourced from intake structures positioned in the estuary.

In some embodiments, the fluid may be sourced from a bay. Bays may comprise bodies of water that may be partially enclosed by land and may be connected to oceans, seas, or lakes. Bays may have varying salinity levels and temperatures depending on the connection to larger bodies of water, freshwater inflow, and other factors. Bay water may be sourced from intake structures positioned in the bay.

In some embodiments, the fluid may be sourced from a pond. Ponds may comprise small bodies of freshwater or saline water. Ponds may be natural or may be constructed for various purposes such as water storage, aquaculture, or industrial processes. Pond water may be at various temperatures depending on the size of the pond, the depth of the pond, the ambient conditions, and other factors. Pond water may be sourced from intake structures positioned in the pond.

In some embodiments, the fluid may be sourced from a stream. Streams may comprise small flowing bodies of freshwater. Stream water may be at various temperatures depending on the season, the geographic location, the source of the water, and other factors. Stream water may be sourced from intake structures positioned in the stream.

In some embodiments, the fluid may be sourced from an aquifer. Aquifers may comprise underground layers of rock, sand, or gravel that may contain water. Aquifer water may be at relatively stable temperatures that may be related to the depth of the aquifer and the geothermal gradient. Aquifer water may be accessed through wells that may be drilled into the aquifer. The temperature of aquifer water may be warmer than surface water temperatures during cold weather, which may provide a temperature advantage for heat transfer processes.

In some embodiments, the fluid may be sourced from subterranean water sources. Subterranean water sources may include aquifers, underground rivers, underground lakes, or other water sources located beneath the surface of the earth. Subterranean water may be at temperatures that may be influenced by the geothermal gradient, with deeper water sources generally being at warmer temperatures. Subterranean water may be accessed through wells, tunnels, or other access structures.

In some embodiments, the fluid may be sourced from geothermal sources. Geothermal sources may comprise sources of water that may be heated by geothermal energy from the earth. Geothermal sources may include one or more or any combination of the following: hot springs, or geothermal wells, or geothermal ponds, or geothermal brines, or any combination thereof. Water from geothermal sources may be at elevated temperatures compared to surface water or groundwater, which may provide additional sensible heat for transfer to air.

In some embodiments, the fluid may be sourced from hot springs. Hot springs may comprise natural springs where water heated by geothermal energy emerges at the surface. Hot spring water may be at temperatures ranging from slightly above ambient temperature to near boiling temperature depending on the geothermal conditions. Hot spring water may contain dissolved minerals that may have been leached from underground rock formations. A system may be positioned near or over a hot spring to utilize the geothermal heat from the hot spring water.

In some embodiments, the fluid may be sourced from geothermal wells. Geothermal wells may comprise wells drilled into geothermal reservoirs to access hot water or steam. Geothermal well water may be at temperatures ranging from approximately 50 degrees Celsius to over 200 degrees Celsius depending on the depth of the well and the geothermal conditions. A system may be positioned near a geothermal well to utilize the geothermal heat from the well water.

In some embodiments, the fluid may be sourced from geothermal ponds. Geothermal ponds may comprise ponds that may be fed by geothermal water or that may be located over geothermal heat sources. Geothermal pond water may be at elevated temperatures compared to non-geothermal ponds. A system may be positioned near or over a geothermal pond to utilize the geothermal heat from the pond water.

In some embodiments, a system may be positioned near or over a geothermal heat source to utilize sensible heat from geothermally heated water. The utilization of sensible heat from geothermally heated water may provide heat transfer to air without relying solely on the latent heat of freezing. Geothermally heated water at temperatures above the freezing point may transfer sensible heat to cold air as the water cools toward the freezing point. The sensible heat available from geothermally heated water may be greater than the sensible heat available from water at or near the freezing point due to the greater temperature difference between the geothermally heated water and the cold air.

In some embodiments, the combination of sensible heat from geothermally heated water and latent heat from freezing may provide greater total heat transfer than either heat source alone. Geothermally heated water may first transfer sensible heat to cold air as the water cools from the geothermal temperature toward the freezing point. Once the water reaches the freezing point, latent heat may be released as the water freezes. The combination of sensible heat and latent heat may increase the total heat transfer from the water to the air, which may increase the warming of the air and may increase the buoyancy-induced airflow.

In some embodiments, the fluid may be sourced from process water. Process water may comprise water that may be used in industrial processes, manufacturing processes, or other processes. Process water may be at various temperatures depending on the process in which the water is used. Process water that has been heated during industrial processes may be at elevated temperatures that may provide sensible heat for transfer to air.

In some embodiments, the fluid may be sourced from industrial process water. Industrial process water may comprise water used in industrial facilities for cooling, heating, cleaning, chemical reactions, or other purposes. Industrial process water may be at various temperatures depending on the industrial process. Industrial process water that has absorbed heat from industrial processes may be at elevated temperatures compared to ambient water sources.

In some embodiments, the fluid may be sourced from cooling water. Cooling water may comprise water used to remove heat from industrial equipment, power generation equipment, data centers, or other heat-generating systems. Cooling water that has absorbed heat from the systems being cooled may be at elevated temperatures compared to the water source. The elevated temperature of cooling water may provide sensible heat for transfer to air in heat transfer processes.

In some embodiments, the fluid may be sourced from heating water. Heating water may comprise water used in heating systems, district heating systems, or other systems where water is heated for distribution. Heating water may be at elevated temperatures for distribution to heating loads. Return water from heating systems may be at temperatures that may still be elevated compared to ambient water sources.

In some embodiments, the fluid may be sourced from wastewater. Wastewater may comprise water that has been used in residential, commercial, or industrial applications and may be discharged for treatment or disposal. Wastewater may be at various temperatures depending on the source of the wastewater. Wastewater from industrial processes, power plants, or other heat-generating facilities may be at elevated temperatures.

In some embodiments, the fluid may be sourced from produced water. Produced water may comprise water that may be brought to the surface during oil and gas production operations. Produced water may be at elevated temperatures due to the temperature of underground formations from which the water is produced. Produced water may contain dissolved salts, hydrocarbons, or other constituents that may affect the properties of the water.

In some embodiments, the fluid may be sourced from mining water. Mining water may comprise water used in mining operations or water that may be encountered during mining activities. Mining water may include water used for mineral processing, water pumped from underground mines, or water from tailings ponds. Mining water may be at various temperatures and may contain dissolved minerals or other constituents.

In some embodiments, the fluid may be sourced from desalination water. Desalination water may comprise water associated with desalination processes, including feedwater to desalination systems, concentrate or brine from desalination systems, or product water from desalination systems. Brine from desalination systems may have elevated salinity compared to the feedwater, which may result in a lower freezing point.

In some embodiments, the fluid may be sourced from recirculated water. Recirculated water may comprise water that has been used in a heat transfer process and may be returned for additional heat transfer. Recirculation of water may reduce the total water consumption of the system by reusing water that has been cooled or partially frozen. Recirculated water may be at temperatures that have been reduced by previous heat transfer, and the recirculated water may be further cooled or frozen in subsequent passes through the heat transfer zone.

In some embodiments, the fluid may be sourced from recirculated brine. Recirculated brine may comprise brine that has been used in a heat transfer process and may be returned for additional heat transfer. When seawater or brine is used in heat transfer processes and a portion of the water freezes, the remaining liquid may have increased salinity compared to the original water. The increased salinity may result in a lower freezing point, which may allow heat transfer to continue at lower temperatures. Recirculated brine may be further concentrated through additional freezing cycles.

In some embodiments, the fluid may comprise freshwater. Freshwater may have a total dissolved solids content of less than approximately 1,000 milligrams per liter. Freshwater may have a freezing point of approximately 0 degrees Celsius at standard atmospheric pressure. Freshwater may be sourced from lakes, rivers, streams, ponds, aquifers, precipitation, or other freshwater sources.

In some embodiments, the fluid may comprise seawater. Seawater may have a total dissolved solids content of approximately 35,000 milligrams per liter, with the dissolved solids comprising primarily sodium chloride and other salts. Seawater may have a freezing point of approximately negative 1.8 degrees Celsius to approximately negative 2 degrees Celsius depending on the salinity. Seawater may be sourced from oceans, seas, or other marine environments.

In some embodiments, the fluid may comprise brine. Brine may comprise water with a total dissolved solids content greater than approximately 35,000 milligrams per liter. Brine may have a freezing point that may be lower than the freezing point of seawater, with the freezing point depending on the concentration and composition of dissolved salts. Brine may be sourced from natural brine deposits, from desalination processes, from industrial processes, from geothermal sources, or from concentration of seawater or other saline water.

In some embodiments, the fluid may comprise a heat transfer fluid. Heat transfer fluids may comprise fluids that may be formulated or selected for heat transfer applications. Heat transfer fluids may include one or more or any combination of the following: water, or seawater, or brine, or antifreeze solutions, or glycol solutions, or oils, or ammonia, or carbon dioxide, or supercritical fluids, or refrigerants, or phase change fluids, or ionic solutions, or non-ionic solutions, or synthetic fluids, or natural fluids, or any combination thereof.

In some embodiments, the heat transfer fluid may comprise antifreeze solutions. Antifreeze solutions may comprise water mixed with antifreeze compounds such as ethylene glycol, propylene glycol, methanol, ethanol, or other compounds that may lower the freezing point of the solution. Antifreeze solutions may be used in applications where the fluid may be exposed to temperatures below the freezing point of water and where freezing of the fluid may be undesirable.

In some embodiments, the heat transfer fluid may comprise glycol solutions. Glycol solutions may comprise water mixed with ethylene glycol, propylene glycol, or other glycols. Glycol solutions may have freezing points below the freezing point of water, with the freezing point depending on the concentration of glycol. Glycol solutions may be used in heat transfer applications where freeze protection may be desired.

In some embodiments, the heat transfer fluid may comprise phase change fluids. Phase change fluids may comprise fluids that may undergo phase transitions at temperatures relevant to the heat transfer application. Phase change fluids may release latent heat during phase transitions, which may enhance heat transfer. Phase change fluids may include water, which may release latent heat during freezing, or other fluids that may undergo phase transitions at different temperatures.

In some embodiments, water intake structures may be positioned at depths where water temperature may be favorable for heat transfer. In bodies of water such as lakes, the temperature of water may vary with depth. In freshwater lakes, water density may be greatest at approximately 4 degrees Celsius, and water at this temperature may tend to sink to the bottom of the lake. During cold weather when surface water may be cooled to temperatures approaching the freezing point, water at greater depths may remain at approximately 4 degrees Celsius due to the density characteristics of freshwater.

In some embodiments, water intake may be positioned at deeper depths in a body of water where water may be at approximately 4 degrees Celsius. Positioning the water intake at deeper depths may provide water at a temperature of approximately 4 degrees Celsius, which may be warmer than surface water during cold weather. The warmer temperature of water from deeper depths may provide greater sensible heat for transfer to cold air compared to water from near the surface. The temperature difference between water at approximately 4 degrees Celsius and cold ambient air may be greater than the temperature difference between surface water near the freezing point and cold ambient air.

In some embodiments, positioning the water intake at deeper depths may increase the available heat per unit of water. Water at approximately 4 degrees Celsius may contain more sensible heat relative to the freezing point than water at temperatures closer to the freezing point. The sensible heat available from cooling water from approximately 4 degrees Celsius to the freezing point may be approximately 16.7 kilojoules per kilogram, based on the specific heat capacity of water of approximately 4.18 kilojoules per kilogram per degree Kelvin. The additional sensible heat from warmer water may increase the total heat transfer from the water to the air.

In some embodiments, positioning the water intake at deeper depths may help prevent freezing in intake systems. Water at approximately 4 degrees Celsius may be less likely to freeze in intake pipes, pumps, and other intake system components compared to water at temperatures closer to the freezing point. The reduced risk of freezing in intake systems may improve system reliability, may reduce the need for anti-icing measures in intake systems, and may reduce maintenance requirements.

In some embodiments, the depth of water intake may be selected based on the temperature profile of the body of water. The temperature profile may vary seasonally, with different temperature distributions during summer and winter months. During winter months in cold climates, the temperature profile of a freshwater lake may exhibit colder water near the surface and warmer water at greater depths, with the warmest water at approximately 4 degrees Celsius located near the bottom of the lake. The water intake may be positioned at a depth where the water temperature may be approximately 4 degrees Celsius or at a depth where the water temperature may be warmest.

In some embodiments, the depth of water intake may be adjustable to allow water to be sourced from different depths based on conditions. Adjustable water intake systems may include intake structures that may be raised or lowered, multiple intake ports at different depths that may be selectively used, or other configurations that may allow the depth of water intake to be varied. The depth of water intake may be adjusted based on temperature measurements at different depths, based on seasonal patterns, or based on other factors that may affect the optimal intake depth.

In some embodiments, temperature sensors may be positioned at multiple depths in a body of water to measure the temperature profile. The temperature measurements may be used to determine the optimal depth for water intake, to monitor changes in the temperature profile over time, and to adjust the water intake depth in response to changing conditions. The temperature sensors may be connected to a control system that may automatically adjust the water intake depth based on the temperature measurements.

In some embodiments, the water intake may be positioned at a depth where the water temperature may provide a balance between heat content and pumping requirements. Deeper water intake may provide warmer water with greater heat content, but deeper intake may also require greater pumping energy to lift the water to the surface. The optimal intake depth may balance the benefits of warmer water against the energy costs of pumping from greater depths.

In some embodiments, the fluid may be at various temperatures depending on the source and environmental conditions. The fluid temperature prior to heat transfer may range from approximately negative 10 degrees Celsius to approximately 100 degrees Celsius or more depending on the fluid source. In some cold climate applications, the fluid may be at temperatures ranging from approximately negative 2 degrees Celsius to approximately 10 degrees Celsius. In applications utilizing waste heat or geothermal sources, the fluid may be at temperatures ranging from approximately 0 degrees Celsius to approximately 100 degrees Celsius or more.

In some embodiments, seawater in arctic environments may be at temperatures different from the approximately 4 degrees Celsius temperature associated with maximum density freshwater. In some embodiments, seawater below ice cover in arctic or sub-arctic environments may range from approximately 1 degree Celsius to approximately negative 2 degrees Celsius depending on salinity, depth, currents, and other factors. In some arctic environments, seawater at deeper water depths may be cooler than 4 degrees Celsius due to the different density characteristics of saline water compared to freshwater. The temperature of seawater in arctic environments may vary based on proximity to ice, ocean currents, seasonal conditions, or any combination thereof.

In some embodiments, the fluid may have various concentrations of dissolved solids. The total dissolved solids content may range from less than approximately 100 milligrams per liter for highly purified water to greater than approximately 300,000 milligrams per liter for concentrated brines. Freshwater sources may have total dissolved solids content ranging from approximately 100 milligrams per liter to approximately 1,000 milligrams per liter. Brackish water may have total dissolved solids content ranging from approximately 1,000 milligrams per liter to approximately 10,000 milligrams per liter or 20,000 milligrams per liter, or 30,000 milligrams per liter. Seawater may have total dissolved solids content ranging from approximately 10,000 milligrams per liter to approximately 50,000 milligrams per liter depending on location. Concentrated brines may have total dissolved solids content ranging from approximately 30,000 milligrams per liter to approximately 300,000 milligrams per liter or more.

In some embodiments, the fluid may be sourced from power plant condenser water. Power plant condenser water may comprise cooling water that has absorbed heat from steam condensers in thermal power plants, nuclear power plants, combined cycle power plants, or other power generation facilities. Power plant condenser water may be at elevated temperatures ranging from approximately 0 degrees Celsius to approximately 50 degrees Celsius or more depending on the power plant design and operating conditions. The elevated temperature of power plant condenser water may provide substantial sensible heat for transfer to cold air in heat transfer processes.

In some embodiments, the fluid may be sourced from oil and gas cooling water. Oil and gas cooling water may comprise water used for cooling in oil refineries, natural gas processing facilities, petrochemical plants, liquefied natural gas facilities, or other oil and gas operations. Oil and gas cooling water may be at elevated temperatures after absorbing heat from process equipment, compressors, heat exchangers, or other heat-generating equipment. The temperature of oil and gas cooling water may range from approximately 0 degrees Celsius to approximately 60 degrees Celsius or more depending on the specific application and operating conditions.

In some embodiments, the fluid may be sourced from other industrial thermal discharge sources. Industrial thermal discharge sources may include one or more or any combination of the following: steel mills, or aluminum smelters, or chemical manufacturing facilities, or pulp and paper mills, or food processing facilities, or data center cooling systems, or any combination thereof. Industrial thermal discharge water may be at various elevated temperatures depending on the industrial process, and the elevated temperatures may provide sensible heat for transfer to cold air.

In some embodiments, the fluid prior to transferring heat from fluid to air may be at a temperature greater than negative 10 degrees Celsius. Fluids at temperatures greater than negative 10 degrees Celsius may include brines, antifreeze solutions, or other fluids with freezing points below negative 10 degrees Celsius that may remain in a liquid state at such temperatures. Fluids at temperatures greater than negative 10 degrees Celsius may also include fluids that may be partially frozen, forming liquid-solid mixtures where the liquid portion may be at a temperature greater than negative 10 degrees Celsius. The temperature of the fluid prior to heat transfer may affect the amount of sensible heat available for transfer to air, the potential for latent heat release through freezing, and the overall heat transfer characteristics of the process.

In some embodiments, the fluid prior to transferring heat from fluid to air may be at a temperature greater than negative 5 degrees Celsius. Fluids at temperatures greater than negative 5 degrees Celsius may include seawater, brines with moderate salt concentrations, or other fluids with freezing points between approximately negative 5 degrees Celsius and negative 2 degrees Celsius. Seawater with typical ocean salinity may have a freezing point of approximately negative 1.8 degrees Celsius to approximately negative 2 degrees Celsius, and seawater at temperatures greater than negative 5 degrees Celsius may be in a liquid state or may be a liquid-solid mixture depending on the specific temperature and salinity.

In some embodiments, the fluid prior to transferring heat from fluid to air may be at a temperature greater than negative 2 degrees Celsius. Fluids at temperatures greater than negative 2 degrees Celsius may include seawater at or above the freezing point of seawater, freshwater above the freezing point of freshwater, or brines at temperatures above the freezing points of the brines. A fluid at a temperature greater than negative 2 degrees Celsius and comprising seawater may be in a liquid state if the temperature is above the freezing point of the seawater, or the fluid may be a liquid-solid mixture if the temperature is at or near the freezing point and partial freezing has occurred.

In some embodiments, the fluid prior to transferring heat from fluid to air may be at a temperature greater than 0 degrees Celsius. Fluids at temperatures greater than 0 degrees Celsius may include freshwater above the freezing point, seawater above the freezing point, brines above the freezing points of the brines, or other aqueous fluids in a liquid state. Freshwater at temperatures greater than 0 degrees Celsius may be entirely in a liquid state, as the freezing point of freshwater at standard atmospheric pressure may be approximately 0 degrees Celsius. The sensible heat available from a fluid at a temperature greater than 0 degrees Celsius may include the heat that may be released as the fluid cools from the initial temperature to the freezing point of the fluid.

In some embodiments, the fluid prior to transferring heat from fluid to air may be at a temperature greater than 2 degrees Celsius. Fluids at temperatures greater than 2 degrees Celsius may provide additional sensible heat compared to fluids at temperatures closer to the freezing point. The sensible heat available from cooling a fluid from 2 degrees Celsius to the freezing point may be approximately 8.4 kilojoules per kilogram for freshwater, based on the specific heat capacity of water of approximately 4.18 kilojoules per kilogram per degree Kelvin and a temperature change of approximately 2 degrees Kelvin.

In some embodiments, the fluid prior to transferring heat from fluid to air may be at a temperature greater than 5 degrees Celsius. Fluids at temperatures greater than 5 degrees Celsius may provide sensible heat from cooling the fluid from the initial temperature to the freezing point. The sensible heat available from cooling freshwater from 5 degrees Celsius to the freezing point of approximately 0 degrees Celsius may be approximately 20.9 kilojoules per kilogram. Fluids at temperatures greater than 5 degrees Celsius may be sourced from bodies of water at depths where water temperatures may be warmer than surface temperatures, from geothermal sources, from industrial processes, or from other sources of warmer water.

In some embodiments, the fluid prior to transferring heat from fluid to air may be at a temperature greater than 7 degrees Celsius. Fluids at temperatures greater than 7 degrees Celsius may provide sensible heat from cooling the fluid from the initial temperature to the freezing point. The sensible heat available from cooling freshwater from 7 degrees Celsius to the freezing point of approximately 0 degrees Celsius may be approximately 29.3 kilojoules per kilogram.

In some embodiments, the fluid prior to transferring heat from fluid to air may be at a temperature greater than 10 degrees Celsius. Fluids at temperatures greater than 10 degrees Celsius may provide substantial sensible heat from cooling the fluid from the initial temperature to the freezing point. The sensible heat available from cooling freshwater from 10 degrees Celsius to the freezing point of approximately 0 degrees Celsius may be approximately 41.8 kilojoules per kilogram. Fluids at temperatures greater than 10 degrees Celsius may be sourced from geothermal sources, from industrial cooling water, from power plant condenser water, or from other sources of heated water.

In some embodiments, the fluid prior to transferring heat from fluid to air may be at a temperature greater than 15 degrees Celsius. Fluids at temperatures greater than 15 degrees Celsius may provide sensible heat from cooling the fluid from the initial temperature to the freezing point. The sensible heat available from cooling freshwater from 15 degrees Celsius to the freezing point of approximately 0 degrees Celsius may be approximately 62.7 kilojoules per kilogram. Fluids at temperatures greater than 15 degrees Celsius may be sourced from industrial processes, from geothermal sources, from power generation facilities, or from other sources of heated water.

In some embodiments, the fluid prior to transferring heat from fluid to air may be at a temperature greater than 20 degrees Celsius. Fluids at temperatures greater than 20 degrees Celsius may provide substantial sensible heat from cooling the fluid from the initial temperature to the freezing point. The sensible heat available from cooling freshwater from 20 degrees Celsius to the freezing point of approximately 0 degrees Celsius may be approximately 83.6 kilojoules per kilogram. Fluids at temperatures greater than 20 degrees Celsius may be sourced from industrial thermal discharge, from power plant cooling systems, from geothermal sources, from data center cooling systems, or from other sources of heated water. The combination of sensible heat from cooling the fluid from elevated temperatures to the freezing point and latent heat from freezing may provide substantial total heat transfer from the fluid to the air.

In some embodiments, the freezing point of the fluid may depend on the composition of the fluid. Freshwater may have a freezing point of approximately 0 degrees Celsius at standard atmospheric pressure. The freezing point of freshwater may be affected by dissolved gases, dissolved minerals, or other constituents, but for freshwater with low total dissolved solids content, the freezing point may be approximately 0 degrees Celsius. Freshwater sources such as lakes, rivers, streams, ponds, and aquifers may provide water with freezing points at or near 0 degrees Celsius.

In some embodiments, seawater may have a freezing point of approximately negative 2 degrees Celsius. The freezing point of seawater may vary depending on the salinity of the seawater, with higher salinity resulting in lower freezing points. Seawater with typical ocean salinity of approximately 35 parts per thousand may have a freezing point of approximately negative 1.8 degrees Celsius to approximately negative 2 degrees Celsius. Seawater from different ocean regions may have different salinities, and the freezing point may vary accordingly. Seawater from enclosed seas, estuaries, or coastal areas where freshwater mixing occurs may have lower salinity and higher freezing points than typical ocean water.

In some embodiments, brines may have freezing points that may be lower than the freezing point of seawater. The freezing point of a brine may depend on the concentration and composition of dissolved salts in the brine. Brines with higher salt concentrations may have lower freezing points than brines with lower salt concentrations. The freezing point depression of a brine may be related to the molality of dissolved solutes, with greater molality resulting in greater freezing point depression. Brines may be produced through concentration of seawater, through dissolution of salt deposits, through industrial processes, or through other mechanisms.

In some embodiments, sodium chloride brines may have freezing points ranging from approximately 0 degrees Celsius at low concentrations to approximately negative 21 degrees Celsius at the eutectic concentration of approximately 23.3 percent sodium chloride by weight. At concentrations below the eutectic concentration, cooling of sodium chloride brine may result in the formation of ice, with the remaining liquid becoming more concentrated. At the eutectic concentration, cooling may result in the simultaneous crystallization of ice and sodium chloride dihydrate.

In some embodiments, calcium chloride brines may have freezing points ranging from approximately 0 degrees Celsius at low concentrations to approximately negative 50 degrees Celsius at the eutectic concentration of approximately 30 percent calcium chloride by weight. Calcium chloride brines may provide lower freezing points than sodium chloride brines at comparable concentrations, which may allow heat transfer processes to operate at lower temperatures.

In some embodiments, magnesium chloride brines may have freezing points ranging from approximately 0 degrees Celsius at low concentrations to approximately negative 33 degrees Celsius at the eutectic concentration. Magnesium chloride may be present in seawater and may contribute to the freezing point depression of seawater and seawater-derived brines.

In some embodiments, potassium chloride brines may have freezing points ranging from approximately 0 degrees Celsius at low concentrations to approximately negative 11 degrees Celsius at the eutectic concentration. Potassium chloride may be present in some natural brines and may be used in industrial applications.

In some embodiments, brines may comprise mixtures of multiple salts. Natural brines, seawater, and industrial brines may contain multiple dissolved salts including sodium chloride, magnesium chloride, calcium chloride, potassium chloride, sodium sulfate, magnesium sulfate, and other salts. The freezing point of a multi-component brine may depend on the concentrations of all dissolved salts and may be different from the freezing point of a single-salt brine at the same total dissolved solids concentration.

In some embodiments, the fluid may comprise a liquid-solid mixture. A liquid-solid mixture may comprise a mixture of liquid and solid phases, where the solid phase may be suspended in the liquid phase, may be floating on the liquid phase, or may be settled at the bottom of the liquid phase. In the context of heat transfer from fluid to air, a liquid-solid mixture may comprise a mixture of liquid water and ice, a mixture of liquid brine and ice, a mixture of liquid brine and salt crystals, or other combinations of liquid and solid phases.

In some embodiments, a liquid-solid mixture comprising liquid water and ice may be referred to as an ice-water mixture, an ice slurry, or an ice-water slurry. Ice-water mixtures may be at temperatures at or near the freezing point of the liquid phase. For freshwater ice-water mixtures, the temperature may be at or near 0 degrees Celsius. For seawater or brine ice-water mixtures, the temperature may be at or near the freezing point of the liquid phase, which may be below 0 degrees Celsius depending on the salinity.

In some embodiments, a liquid-solid mixture may be employed as the fluid in heat transfer processes. The liquid-solid mixture may be contacted with air, and heat may be transferred from the liquid-solid mixture to the air. The heat transfer may include sensible heat from the liquid phase, latent heat from freezing of additional liquid, or any combination thereof. The presence of solid phase in the mixture may affect the flow characteristics of the mixture, the heat transfer characteristics, and the handling requirements.

In some embodiments, a liquid-solid mixture may be formed during heat transfer from fluid to air. When liquid water or liquid brine is contacted with cold air, at least a portion of the liquid may freeze to form ice, resulting in a liquid-solid mixture. The liquid-solid mixture may continue to transfer heat to the air through additional freezing of the liquid phase, through sensible heat transfer from the liquid phase, or through any combination thereof.

In some embodiments, the solid phase in a liquid-solid mixture may comprise ice. Ice may be formed through freezing of freshwater, seawater, brine, or other aqueous fluids. The ice may be in various forms including ice crystals, ice flakes, ice particles, ice chunks, frazil ice, or other ice forms. The form of the ice may depend on the freezing conditions, the composition of the liquid from which the ice was formed, the agitation of the liquid during freezing, or other factors.

In some embodiments, the solid phase in a liquid-solid mixture may comprise salt crystals. Salt crystals may be formed through crystallization of dissolved salts from brines or other saline solutions. Crystallization may occur when the concentration of dissolved salts exceeds the solubility limit, which may occur due to cooling, due to evaporation of water, or due to other factors. Salt crystals that may be formed may include sodium chloride crystals, magnesium chloride crystals, calcium chloride crystals, sodium sulfate crystals, or crystals of other salts depending on the composition of the brine.

In some embodiments, the solid phase in a liquid-solid mixture may comprise both ice and salt crystals. When a brine is cooled, ice may form first, which may increase the concentration of dissolved salts in the remaining liquid. As the concentration of dissolved salts increases, the solubility limit of one or more salts may be exceeded, resulting in crystallization of salt crystals. The liquid-solid mixture may then comprise liquid brine, ice, and salt crystals.

In some embodiments, the fluid may comprise a liquid-gas mixture. A liquid-gas mixture may comprise a mixture of liquid and gas phases, where the gas phase may be dissolved in the liquid phase, may be present as bubbles within the liquid phase, or may be present as a foam or froth on the surface of the liquid phase. In the context of heat transfer from fluid to air, a liquid-gas mixture may comprise water with dissolved gases, water with entrained air bubbles, or other combinations of liquid and gas phases.

In some embodiments, a liquid-gas mixture may be formed during heat transfer processes. When water is sprayed into air, air may become entrained in the water droplets or in the collected water, forming a liquid-gas mixture. When air is bubbled through water, the water may contain entrained air bubbles, forming a liquid-gas mixture. The presence of gas phase in the liquid may affect the density of the mixture, the flow characteristics, and the heat transfer characteristics.

In some embodiments, dissolved gases in water may affect the properties of the water. Dissolved gases may include oxygen, nitrogen, carbon dioxide, or other gases that may be present in the atmosphere or in the environment from which the water is sourced. The solubility of gases in water may increase as the temperature of the water decreases, and cold water may contain higher concentrations of dissolved gases than warm water. The presence of dissolved gases may affect the freezing behavior of the water, with dissolved gases potentially being released during freezing.

In some embodiments, the fluid may comprise a liquid-solid-gas mixture. A liquid-solid-gas mixture may comprise a mixture of liquid, solid, and gas phases. In the context of heat transfer from fluid to air, a liquid-solid-gas mixture may comprise water, ice, and entrained air; brine, ice, salt crystals, and entrained air; or other combinations of liquid, solid, and gas phases.

In some embodiments, a liquid-solid-gas mixture may be formed during heat transfer processes. When water containing entrained air is cooled and partially frozen, the resulting mixture may comprise liquid water, ice, and air bubbles, forming a liquid-solid-gas mixture. The presence of multiple phases may affect the flow characteristics, the heat transfer characteristics, and the handling requirements of the mixture.

In some embodiments, the proportion of liquid, solid, and gas phases in a liquid-solid-gas mixture may vary depending on the operating conditions. At higher temperatures, the proportion of liquid phase may be greater and the proportion of solid phase may be smaller. At lower temperatures, the proportion of solid phase may be greater and the proportion of liquid phase may be smaller. The proportion of gas phase may depend on the degree of aeration, the agitation of the mixture, and other factors.

In some embodiments, the fluid comprising water may be at a temperature greater than the freezing point of the fluid. When the fluid is at a temperature greater than the freezing point, the fluid may be entirely in a liquid state, or the fluid may be a liquid-solid mixture where the liquid phase is at a temperature at or above the freezing point. A fluid comprising water at a temperature greater than the freezing point of the fluid may transfer sensible heat to air as the fluid cools toward the freezing point, and may transfer latent heat to air if the fluid cools to the freezing point and at least a portion of the fluid freezes.

In some embodiments, the temperature of the fluid relative to the freezing point of the fluid may affect the heat transfer characteristics. When the fluid temperature is substantially above the freezing point, sensible heat transfer may dominate, and the fluid may be cooled without freezing. When the fluid temperature is at or near the freezing point, latent heat transfer may occur as the fluid freezes. The combination of sensible heat transfer and latent heat transfer may provide greater total heat transfer than either mechanism alone.

In some embodiments, the freezing point of the fluid may be controlled through adjustment of the fluid composition. Adding salts or other solutes to water may lower the freezing point of the resulting solution. The freezing point may be lowered to a desired level by adjusting the concentration of dissolved solutes. Controlling the freezing point may allow the heat transfer process to be optimized for specific operating conditions, may allow operation at lower temperatures without freezing in undesired locations, or may provide other operational benefits.

In some embodiments, the fluid may undergo partial freezing during heat transfer from fluid to air. Partial freezing may occur when the heat transfer rate is sufficient to cool at least a portion of the fluid to the freezing point and to remove the latent heat of fusion from at least a portion of the fluid, but not sufficient to freeze all of the fluid. The percentage of fluid that freezes may range from greater than 0 percent to less than 100 percent depending on the operating conditions, the heat transfer rate, the fluid flow rate, the contact time, and other factors.

In some embodiments, the fluid may remain entirely in a liquid state during heat transfer from fluid to air. The fluid may remain liquid when the heat transfer rate is insufficient to cool the fluid to the freezing point, when the fluid flow rate is high relative to the heat transfer rate, when the contact time between the fluid and the air is short, or when other factors prevent the fluid from reaching the freezing point. Heat transfer from a fluid that remains liquid may comprise sensible heat transfer.

In some embodiments, the fluid may undergo complete or near-complete freezing during heat transfer from fluid to air. Complete or near-complete freezing may occur when the heat transfer rate is high relative to the fluid flow rate, when the contact time between the fluid and the air is long, when the air temperature is substantially below the freezing point of the fluid, or when other factors promote extensive freezing. When greater than 90 percent of the fluid freezes, the heat transfer may be dominated by latent heat transfer, with the latent heat of fusion providing the majority of the heat transferred to the air.

In some embodiments, the fluid may comprise a heat transfer fluid. Heat transfer fluids may comprise fluids that may be formulated, selected, or configured for heat transfer applications. Heat transfer fluids may be employed to transfer thermal energy from one location to another, to absorb heat from a heat source, to release heat to a heat sink, or to perform other heat transfer functions. The selection of a heat transfer fluid may depend on the operating temperature range, the heat transfer requirements, the compatibility with system materials, the environmental considerations, the cost, or any combination of such factors.

In some embodiments, the heat transfer fluid may comprise water. Water may be employed as a heat transfer fluid due to the high specific heat capacity of water, the high enthalpy of fusion of water, the abundance of water in natural and anthropogenic systems, the non-toxic nature of water, the low cost of water, or any combination thereof. Water may have a specific heat capacity of approximately 4.18 kilojoules per kilogram per degree Kelvin, which may be higher than the specific heat capacity of many other common fluids. The high specific heat capacity of water may allow water to absorb or release substantial amounts of sensible heat with relatively small temperature changes. Water may have an enthalpy of fusion of approximately 333.55 kilojoules per kilogram, which may provide substantial latent heat release during freezing.

In some embodiments, the heat transfer fluid may comprise seawater. Seawater may be employed as a heat transfer fluid in coastal locations, offshore locations, or other locations with access to marine water sources. Seawater may have a salinity of approximately 35 parts per thousand, which may result in a freezing point of approximately negative 1.8 degrees Celsius to approximately negative 2 degrees Celsius. The lower freezing point of seawater compared to freshwater may allow heat transfer processes to operate at temperatures below the freezing point of freshwater. Seawater may contain dissolved salts including sodium chloride, magnesium chloride, calcium chloride, potassium chloride, sodium sulfate, magnesium sulfate, and other salts. The dissolved salts in seawater may affect the heat transfer characteristics, the freezing behavior, and the corrosion potential of the seawater.

In some embodiments, the heat transfer fluid may comprise brine. Brine may comprise water with elevated concentrations of dissolved salts compared to freshwater or seawater. Brine may have a freezing point that may be lower than the freezing point of seawater, with the freezing point depending on the concentration and composition of dissolved salts. Brines may be produced through concentration of seawater, through dissolution of salt deposits, through industrial processes, through freeze concentration, or through other mechanisms. Brines may be employed as heat transfer fluids in applications where operation at temperatures below the freezing point of freshwater or seawater may be desired.

In some embodiments, the heat transfer fluid may comprise antifreeze. Antifreeze may comprise compounds or solutions that may lower the freezing point of water or other fluids. Antifreeze solutions may be employed in heat transfer applications where the fluid may be exposed to temperatures below the freezing point of water and where freezing of the fluid may be undesirable. Antifreeze compounds may include one or more or any combination of the following: ethylene glycol, or propylene glycol, or methanol, or ethanol, or isopropanol, or calcium chloride, or magnesium chloride, or potassium acetate, or sodium chloride, or any combination thereof. The concentration of antifreeze compound in the solution may be selected to provide a desired freezing point depression.

In some embodiments, the heat transfer fluid may comprise glycol. Glycol solutions may comprise water mixed with ethylene glycol, propylene glycol, or other glycols. Ethylene glycol may be a common antifreeze compound that may provide freezing point depression when mixed with water. Propylene glycol may be employed as an alternative to ethylene glycol in applications where lower toxicity may be desired. Glycol solutions may have freezing points below the freezing point of water, with the freezing point depending on the concentration of glycol. A solution of approximately 50 percent ethylene glycol by volume in water may have a freezing point of approximately negative 37 degrees Celsius. A solution of approximately 50 percent propylene glycol by volume in water may have a freezing point of approximately negative 34 degrees Celsius. Glycol solutions may be employed in heat transfer applications where freeze protection may be desired.

In some embodiments, the heat transfer fluid may comprise fertilizer. Fertilizer solutions may comprise water with dissolved fertilizer compounds. Fertilizer compounds may include one or more or any combination of the following: urea, or ammonium nitrate, or ammonium sulfate, or potassium nitrate, or potassium chloride, or calcium nitrate, or magnesium sulfate, or phosphate compounds, or any combination thereof. Fertilizer solutions may have freezing points below the freezing point of pure water due to the freezing point depression caused by the dissolved fertilizer compounds. Fertilizer solutions may be employed as heat transfer fluids in agricultural applications where the heat transfer fluid may also serve as a source of nutrients for plants. The use of fertilizer solutions as heat transfer fluids may provide dual functionality, with the fluid serving both heat transfer and nutrient delivery purposes.

In some embodiments, the heat transfer fluid may comprise oil. Oil-based heat transfer fluids may comprise mineral oils, synthetic oils, silicone oils, or other oil-based fluids. Oil-based heat transfer fluids may have different properties compared to water-based heat transfer fluids, including different specific heat capacities, different viscosities, different freezing points, and different boiling points. Oil-based heat transfer fluids may be employed in applications where water-based fluids may be unsuitable, such as applications requiring operation at temperatures above the boiling point of water or applications where water may cause corrosion or other problems. Oil-based heat transfer fluids may have lower specific heat capacities than water, which may require higher flow rates to achieve comparable heat transfer rates.

In some embodiments, the heat transfer fluid may comprise ammonia. Ammonia may be employed as a heat transfer fluid or refrigerant in various applications. Ammonia may have a boiling point of approximately negative 33 degrees Celsius at atmospheric pressure, which may allow ammonia to be used as a refrigerant in low-temperature applications. Ammonia may have a high latent heat of vaporization, which may provide effective heat transfer during phase change. Ammonia may be employed in industrial refrigeration systems, in heat pump systems, or in other applications where the properties of ammonia may be advantageous. Ammonia may be toxic and may require appropriate safety measures in systems employing ammonia as a heat transfer fluid.

In some embodiments, the heat transfer fluid may comprise carbon dioxide. Carbon dioxide may be employed as a heat transfer fluid or refrigerant in various applications. Carbon dioxide may have a critical temperature of approximately 31 degrees Celsius and a critical pressure of approximately 7.4 megapascals. Below the critical point, carbon dioxide may exist as a liquid or gas depending on the temperature and pressure. Above the critical point, carbon dioxide may exist as a supercritical fluid. Carbon dioxide may be employed in transcritical refrigeration cycles, in heat pump systems, or in other applications. Carbon dioxide may be a natural refrigerant with low global warming potential compared to some synthetic refrigerants.

In some embodiments, the heat transfer fluid may comprise a supercritical fluid. A supercritical fluid may comprise a fluid at a temperature and pressure above the critical point of the fluid, where the distinction between liquid and gas phases may disappear. Supercritical fluids may have properties intermediate between liquids and gases, including liquid-like densities and gas-like viscosities. Supercritical fluids may be employed as heat transfer fluids in applications where the properties of supercritical fluids may be advantageous. Supercritical carbon dioxide may be employed as a heat transfer fluid in power generation cycles, in refrigeration systems, or in other applications. Supercritical water may be employed in supercritical water reactors or in other high-temperature applications.

In some embodiments, the heat transfer fluid may comprise a refrigerant. Refrigerants may comprise fluids that may be employed in refrigeration cycles, heat pump cycles, or other thermodynamic cycles to transfer heat. Refrigerants may undergo phase changes between liquid and vapor states during the refrigeration cycle, with heat being absorbed during evaporation and released during condensation. Refrigerants may include one or more or any combination of the following: hydrofluorocarbons, or hydrochlorofluorocarbons, or hydrofluoroolefins, or natural refrigerants such as ammonia or carbon dioxide or hydrocarbons, or any combination thereof. The selection of refrigerant may depend on the operating temperature range, the thermodynamic properties, the environmental impact, the safety considerations, or any combination of such factors.

In some embodiments, the heat transfer fluid may comprise a single-phase fluid. A single-phase fluid may comprise a fluid that may remain in a single phase, such as liquid or gas, throughout the heat transfer process. Single-phase heat transfer may involve sensible heat transfer, where heat is transferred through temperature changes in the fluid without phase change. Single-phase fluids may be employed in applications where phase change may be undesirable, where the operating conditions may not support phase change, or where the simplicity of single-phase operation may be preferred.

In some embodiments, the heat transfer fluid may comprise a two-phase fluid. A two-phase fluid may comprise a fluid that may exist in two phases simultaneously, such as liquid and gas, or liquid and solid. Two-phase heat transfer may involve latent heat transfer during phase change, which may provide high heat transfer rates at constant temperature. Two-phase fluids may be employed in applications where the high heat transfer rates associated with phase change may be advantageous, such as in boiling heat transfer, condensation heat transfer, or freezing heat transfer.

In some embodiments, the heat transfer fluid may comprise a three-phase fluid. A three-phase fluid may comprise a fluid that may exist in three phases simultaneously, such as solid, liquid, and gas. Three-phase systems may occur at or near the triple point of a substance, where solid, liquid, and gas phases may coexist in equilibrium. Three-phase fluids may also occur in systems where multiple components may be present, with different components existing in different phases. Three-phase heat transfer may involve complex interactions among the phases and may provide unique heat transfer characteristics.

In some embodiments, the heat transfer fluid may comprise a four-phase fluid. A four-phase fluid may comprise a fluid system that may include four distinct phases. Four-phase systems may occur in multi-component systems where different components may exist in different phases, or in systems where multiple solid phases, liquid phases, or gas phases may be present. Four-phase heat transfer may involve complex interactions among the phases.

In some embodiments, the heat transfer fluid may comprise a five-phase fluid. A five-phase fluid may comprise a fluid system that may include five distinct phases. Five-phase systems may occur in complex multi-component systems where multiple solid phases, liquid phases, or gas phases may be present simultaneously. Five-phase heat transfer may involve complex interactions among the phases.

In some embodiments, the heat transfer fluid may comprise a phase change fluid. A phase change fluid may comprise a fluid that may undergo phase transitions during the heat transfer process. Phase transitions may include one or more or any combination of the following: melting, or freezing, or boiling, or condensation, or sublimation, or deposition, or any combination thereof. Phase change fluids may provide high heat transfer rates due to the latent heat associated with phase transitions. The latent heat of phase change may allow large amounts of heat to be transferred at constant temperature, which may be advantageous in applications where temperature control may be desired.

In some embodiments, the heat transfer fluid may comprise a liquid-liquid phase change fluid. A liquid-liquid phase change fluid may comprise a fluid that may undergo phase transitions between two liquid phases. Liquid-liquid phase transitions may occur in certain mixtures or solutions where changes in temperature or composition may cause separation into two distinct liquid phases. Liquid-liquid phase change fluids may provide heat transfer characteristics that may differ from solid-liquid or liquid-gas phase change fluids.

In some embodiments, the heat transfer fluid may comprise a solid-liquid phase change fluid. A solid-liquid phase change fluid may comprise a fluid that may undergo phase transitions between solid and liquid phases. Solid-liquid phase transitions may include melting, where a solid transforms to a liquid, and freezing, where a liquid transforms to a solid. Water may be a common solid-liquid phase change fluid, with the freezing and melting of water providing latent heat transfer. The enthalpy of fusion of water may be approximately 333.55 kilojoules per kilogram, which may provide substantial heat transfer during freezing or melting. Other solid-liquid phase change fluids may include paraffin waxes, salt hydrates, fatty acids, or other materials that may undergo solid-liquid phase transitions at temperatures relevant to the application.

In some embodiments, the heat transfer fluid may comprise urea. Urea solutions may comprise water with dissolved urea. Urea may be a nitrogen-containing compound with the chemical formula CO(NH2)2. Urea solutions may have freezing points below the freezing point of pure water due to the freezing point depression caused by the dissolved urea. A solution of approximately 32.5 percent urea by weight in water may have a freezing point of approximately negative 11 degrees Celsius. Urea solutions may be employed as heat transfer fluids in applications where the properties of urea solutions may be advantageous. Urea solutions may also be employed in agricultural applications where the urea may serve as a nitrogen fertilizer.

In some embodiments, the heat transfer fluid may comprise an ionic solution. An ionic solution may comprise a solution containing dissolved ions. Ionic solutions may include salt solutions, acid solutions, base solutions, or other solutions containing dissolved ionic compounds. The dissolved ions in an ionic solution may affect the properties of the solution, including the freezing point, the boiling point, the electrical conductivity, and the heat transfer characteristics. Ionic solutions may provide freezing point depression, with the magnitude of the freezing point depression depending on the concentration and nature of the dissolved ions.

In some embodiments, the heat transfer fluid may comprise a non-ionic solution. A non-ionic solution may comprise a solution containing dissolved non-ionic compounds. Non-ionic solutions may include solutions of sugars, alcohols, glycols, or other non-ionic compounds in water or other solvents. The dissolved non-ionic compounds may affect the properties of the solution, including the freezing point, the boiling point, the viscosity, and the heat transfer characteristics. Non-ionic solutions may provide freezing point depression, with the magnitude of the freezing point depression depending on the concentration of the dissolved compounds.

In some embodiments, the heat transfer fluid may comprise a synthetic fluid. A synthetic fluid may comprise a fluid that may be manufactured or synthesized rather than obtained from natural sources. Synthetic fluids may be formulated to have specific properties that may be advantageous for heat transfer applications, such as specific freezing points, specific boiling points, specific viscosities, specific thermal conductivities, or specific chemical stabilities. Synthetic fluids may include synthetic oils, synthetic refrigerants, synthetic glycols, or other manufactured fluids. Synthetic fluids may be designed to meet specific performance requirements, to be compatible with specific materials, or to meet specific environmental or safety standards.

In some embodiments, the heat transfer fluid may comprise a natural fluid. A natural fluid may comprise a fluid that may be obtained from natural sources or that may occur naturally in the environment. Natural fluids may include water, seawater, natural brines, natural oils, natural gases, or other fluids that may be found in nature. Natural fluids may be employed as heat transfer fluids in applications where the use of natural materials may be preferred, where the cost of natural fluids may be lower than synthetic alternatives, or where the environmental impact of natural fluids may be lower than synthetic alternatives. Natural refrigerants such as ammonia, carbon dioxide, and hydrocarbons may be employed as alternatives to synthetic refrigerants in refrigeration and heat pump applications.

In some embodiments, the selection of heat transfer fluid may be based on the operating temperature range of the application. Different heat transfer fluids may have different freezing points, boiling points, and operating temperature ranges. Water may be suitable for applications operating between approximately 0 degrees Celsius and approximately 100 degrees Celsius at atmospheric pressure. Glycol solutions may be suitable for applications operating at temperatures below the freezing point of water. Oil-based heat transfer fluids may be suitable for applications operating at temperatures above the boiling point of water. Refrigerants may be suitable for applications operating at low temperatures where the refrigerant may undergo phase change.

In some embodiments, the selection of heat transfer fluid may be based on the heat transfer requirements of the application. Different heat transfer fluids may have different specific heat capacities, different latent heats, and different thermal conductivities. Fluids with higher specific heat capacities may be able to absorb or release more sensible heat per unit mass for a given temperature change. Fluids with higher latent heats may be able to absorb or release more heat during phase change. Fluids with higher thermal conductivities may provide higher heat transfer rates at heat transfer surfaces.

In some embodiments, the selection of heat transfer fluid may be based on compatibility with system materials. Different heat transfer fluids may have different corrosion potentials, different chemical reactivities, and different compatibilities with seals, gaskets, and other system components. The heat transfer fluid may be selected to be compatible with the materials of construction of the heat transfer system, including pipes, pumps, heat exchangers, tanks, and other components. Incompatible heat transfer fluids may cause corrosion, degradation, swelling, or other damage to system components.

In some embodiments, the selection of heat transfer fluid may be based on environmental considerations. Different heat transfer fluids may have different environmental impacts, including different global warming potentials, different ozone depletion potentials, different toxicities, and different biodegradabilities. Heat transfer fluids with lower environmental impacts may be preferred in applications where environmental considerations may be a priority. Natural refrigerants such as ammonia, carbon dioxide, and hydrocarbons may have lower global warming potentials than some synthetic refrigerants.

In some embodiments, the selection of heat transfer fluid may be based on safety considerations. Different heat transfer fluids may have different flammabilities, different toxicities, different pressures, and different handling requirements. Heat transfer fluids with lower safety risks may be preferred in applications where safety may be a priority. Propylene glycol may be preferred over ethylene glycol in applications where lower toxicity may be desired. Non-flammable refrigerants may be preferred in applications where flammability may be a concern.

In some embodiments, the selection of heat transfer fluid may be based on cost considerations. Different heat transfer fluids may have different costs, including different purchase costs, different operating costs, and different disposal costs. Water may be a low-cost heat transfer fluid that may be suitable for many applications. Specialized heat transfer fluids such as synthetic oils or specialty refrigerants may have higher costs but may provide performance advantages that may justify the higher costs in certain applications.

In some embodiments, the heat transfer fluid may comprise a mixture of multiple components. Multi-component heat transfer fluids may be formulated to achieve specific properties that may not be achievable with single-component fluids. Multi-component heat transfer fluids may include glycol-water mixtures, brine solutions, refrigerant blends, or other mixtures. The properties of multi-component heat transfer fluids may depend on the composition of the mixture, and the composition may be adjusted to achieve desired properties such as specific freezing points, specific viscosities, or specific heat transfer characteristics.

In some embodiments, the heat transfer fluid may be recirculated through the heat transfer system. Recirculation may allow the heat transfer fluid to be reused, which may reduce the consumption of heat transfer fluid and may reduce operating costs. Recirculated heat transfer fluid may be cooled or heated as the fluid passes through the heat transfer system, and the fluid may be returned to the heat source or heat sink for additional heat transfer. Recirculation systems may include pumps, pipes, tanks, and other components for circulating the heat transfer fluid.

In some embodiments, the heat transfer fluid may be treated or conditioned to maintain desired properties. Treatment or conditioning may include one or more or any combination of the following: filtration to remove particles, or chemical treatment to prevent corrosion, or chemical treatment to prevent biological growth, or adjustment of pH, or adjustment of concentration, or any combination thereof. Treatment or conditioning may maintain the performance of the heat transfer fluid over time and may extend the useful life of the heat transfer fluid.

In some embodiments, the heat transfer fluid may be monitored to detect changes in properties or to detect contamination. Monitoring may include one or more or any combination of the following: measurement of temperature, or measurement of pressure, or measurement of flow rate, or measurement of concentration, or measurement of pH, or measurement of conductivity, or measurement of viscosity, or any combination thereof. Monitoring may allow problems to be detected early and may allow corrective actions to be taken before significant damage or performance degradation may occur.

In some embodiments, a process may further comprise freeze-desalination. Freeze-desalination may comprise a desalination process in which saline water may be frozen to produce ice that may have a lower salt content than the original saline water. When saline water such as seawater or brine freezes, the ice crystals that form may exclude dissolved salts, resulting in ice that may be relatively pure compared to the original saline water. The remaining liquid after partial freezing may have an increased salt concentration compared to the original saline water, forming a concentrated brine. The ice may be separated from the concentrated brine, and the ice may be melted to produce freshwater or desalinated water. Freeze-desalination may be employed as an alternative to other desalination methods such as reverse osmosis, thermal distillation, or electrodialysis.

In some embodiments, freeze-desalination may be integrated with heat transfer processes that may transfer heat from a fluid to air. When seawater or brine is employed as the fluid in heat transfer processes and the fluid is contacted with cold air, at least a portion of the water in the seawater or brine may freeze to form ice. The freezing of water from seawater or brine may produce ice with reduced salt content and may produce a concentrated brine with increased salt content. The heat released during freezing may warm the air, which may induce buoyancy-driven airflow through an air conduit. The freeze-desalination process may thus be coupled with power generation or other applications that may harness the buoyancy-driven airflow.

In some embodiments, harnessing the airflow may comprise freeze-desalination. The airflow generated through heat transfer from a fluid to air may be harnessed for power generation, for carbon dioxide capture, or for other purposes, while the freezing of saline water that may occur during the heat transfer process may produce ice and concentrated brine that may be separated to produce freshwater through freeze-desalination. The integration of freeze-desalination with airflow harnessing may provide multiple products from a single process, including electrical power, freshwater, and concentrated brine or salt.

In some embodiments, a process may further comprise generating a brine, or salt, or any combination thereof. When saline water is cooled and at least a portion of the water freezes, the dissolved salts may become concentrated in the remaining liquid, producing a brine with a higher salt concentration than the original saline water. The brine may be further processed to produce salt crystals, or the brine may be used directly for various applications. The generation of brine or salt may be a byproduct of freeze-desalination processes, or the generation of brine or salt may be a primary objective of the process.

In some embodiments, harnessing the airflow may comprise generating a brine, or salt, or any combination thereof. The airflow generated through heat transfer from a fluid to air may be harnessed for power generation or other purposes, while the cooling and freezing of saline water that may occur during the heat transfer process may produce concentrated brine or salt. The brine or salt produced may be collected, processed, and employed for various applications including road de-icing, chemical feedstocks, food processing, water treatment, or other purposes.

In some embodiments, freeze-desalination may involve the freezing of seawater to produce ice and concentrated brine. Seawater may have a salinity of approximately 35 parts per thousand, which may correspond to a total dissolved solids content of approximately 35,000 milligrams per liter. When seawater freezes, the ice crystals that form may have a salt content that may be substantially lower than the salt content of the original seawater. The salt content of ice formed from seawater may depend on the freezing rate, the agitation of the water during freezing, the temperature, and other factors. Slower freezing rates may produce ice with lower salt content, while faster freezing rates may produce ice with higher salt content due to entrapment of brine within the ice structure.

In some embodiments, the ice formed during freeze-desalination may contain some residual salt. The residual salt in the ice may be present as brine inclusions, as salt crystals, or as salt adhering to the surface of the ice. The residual salt content of the ice may range from less than approximately 0.1 percent to greater than approximately 5 percent depending on the freezing conditions and the composition of the original saline water. Further processing of the ice may be employed to reduce the residual salt content and to produce freshwater with lower salt content.

In some embodiments, the concentrated brine remaining after partial freezing of seawater may have a salt concentration that may be higher than the salt concentration of the original seawater. The salt concentration of the concentrated brine may depend on the percentage of water that freezes, with higher percentages of freezing resulting in higher brine concentrations. When 50 percent of the water in seawater freezes, the remaining brine may have a salt concentration of approximately 70 parts per thousand, assuming complete exclusion of salt from the ice. When 75 percent of the water in seawater freezes, the remaining brine may have a salt concentration of approximately 140 parts per thousand.

In some embodiments, the concentrated brine may be further cooled to produce additional ice and further concentrated brine. As the brine concentration increases, the freezing point of the brine may decrease. The freezing point of sodium chloride brine may decrease as the salt concentration increases, reaching a minimum freezing point of approximately negative 21 degrees Celsius at the eutectic concentration of approximately 23.3 percent sodium chloride by weight. Continued cooling of brine below the eutectic temperature may result in the simultaneous crystallization of ice and salt crystals.

In some embodiments, salt crystals may be produced through cooling of concentrated brine. When brine is cooled to temperatures below the eutectic temperature, salt crystals may form along with ice. The salt crystals may comprise sodium chloride, sodium chloride dihydrate, or other salt forms depending on the temperature and the composition of the brine. The salt crystals may be separated from the ice and from the remaining liquid to produce a salt product.

In some embodiments, salt crystals may be produced through evaporation of brine. Brine may be exposed to air, and water may evaporate from the brine, increasing the salt concentration. As the salt concentration increases beyond the solubility limit, salt crystals may precipitate from the brine. Evaporative salt production may be employed in warm climates where solar energy may provide the heat for evaporation. In cold climates, the combination of freezing and evaporation may be employed to concentrate brine and to produce salt crystals.

In some embodiments, separation of ice, brine, and salt crystals may employ multi-stage processes. Multi-stage separation processes may include a first stage of density-based separation followed by additional processing stages. Density-based separation may exploit the differences in density among ice, brine, and salt crystals. Ice may have a density of approximately 917 kilograms per cubic meter, which may be lower than the density of liquid water or brine. Salt crystals may have densities that may be higher than the density of brine. The density differences may allow ice to float on brine and may allow salt crystals to sink in brine.

In some embodiments, density-based separation may be performed in pools or decanters. A pool or decanter may comprise a vessel or basin in which a mixture of ice, brine, and salt crystals may be allowed to separate based on density differences. Ice may float to the surface of the pool or decanter, brine may occupy the middle portion, and salt crystals may sink to the bottom. The separated phases may be removed from different locations within the pool or decanter. Ice may be skimmed or removed from the surface, brine may be drained from the middle, and salt crystals may be collected from the bottom.

In some embodiments, additional processing may follow density-based separation. Additional processing may include one or more or any combination of the following: rinsing, or centrifuging, or mixing with saturated brine, or other freeze desalination methods, or any combination thereof. Rinsing may involve washing the ice with freshwater or with low-salinity water to remove residual salt from the surface of the ice. Centrifuging may involve spinning the ice or the salt crystals to remove adhering liquid. Mixing with saturated brine may involve contacting the ice with brine to facilitate further separation or purification.

In some embodiments, rinsing of ice may reduce the residual salt content of the ice. Ice formed from seawater or brine may have salt adhering to the surface or entrapped within the ice structure. Rinsing the ice with freshwater may dissolve and remove surface salt, reducing the overall salt content of the ice. The rinse water may become saline and may be added to the brine stream for further processing or disposal. Multiple rinsing stages may be employed to achieve lower residual salt content in the ice.

In some embodiments, centrifuging may be employed to separate ice from brine or to separate salt crystals from brine. A centrifuge may comprise a device that may spin a mixture at high speed, generating centrifugal forces that may separate components based on density differences. When a mixture of ice and brine is centrifuged, the denser brine may be forced outward and may be separated from the less dense ice. When a mixture of salt crystals and brine is centrifuged, the denser salt crystals may be forced outward and may be separated from the brine. Centrifuging may provide more complete separation than gravity-based density separation alone.

In some embodiments, ice removal may involve mixing formed ice-salt crystal solids with saturated or supersaturated brine to facilitate density-based separation. When ice and salt crystals are formed together, such as when brine is cooled below the eutectic temperature, the ice and salt crystals may be mixed together and may be difficult to separate. Mixing the ice-salt crystal mixture with saturated or supersaturated brine may facilitate separation by providing a liquid medium in which the ice may float and the salt crystals may sink. The saturated or supersaturated brine may have a density that may be intermediate between the density of ice and the density of salt crystals, which may enhance the density-based separation.

In some embodiments, ice may float in saturated or supersaturated brine due to the lower density of ice compared to the brine. Ice may have a density of approximately 917 kilograms per cubic meter. Saturated sodium chloride brine at approximately 23 percent salt concentration may have a density of approximately 1,200 kilograms per cubic meter. The density difference may cause ice to float on the surface of the saturated brine, allowing the ice to be skimmed or removed from the surface.

In some embodiments, salt crystals may sink in saturated or supersaturated brine due to the higher density of salt crystals compared to the brine. Sodium chloride crystals may have a density of approximately 2,165 kilograms per cubic meter. The density of sodium chloride crystals may be substantially higher than the density of saturated brine, causing the salt crystals to sink to the bottom of the vessel. The salt crystals may be collected from the bottom of the vessel after the ice has been removed from the surface.

In some embodiments, centrifuge or decanter separation may follow mixing with saturated or supersaturated brine. After the ice-salt crystal mixture has been mixed with saturated or supersaturated brine and initial density-based separation has occurred, centrifuge or decanter separation may be employed to achieve more complete separation. A decanter centrifuge may comprise a device that may continuously separate solids from liquids based on density differences while the mixture flows through the device. The decanter centrifuge may separate ice from brine in one stage and may separate salt crystals from brine in another stage.

In some embodiments, the separated ice may be further processed to produce freshwater. The ice may be melted, and the resulting water may be collected as freshwater or desalinated water. The freshwater produced may have a salt content that may be substantially lower than the salt content of the original seawater or brine. The freshwater may be suitable for drinking water, irrigation, industrial processes, or other applications where low-salinity water may be desired.

In some embodiments, the separated ice may be further purified before melting. Further purification may include additional rinsing, additional centrifuging, or other processing to reduce the residual salt content of the ice. The further purification may produce ice with lower salt content, which may produce freshwater with lower salt content when the ice is melted.

In some embodiments, the separated brine may be further processed to produce salt or to be disposed of. Further processing of brine may include additional cooling to produce additional ice and further concentrated brine, evaporation to produce salt crystals, or other processing. The brine may be returned to a body of water, may be injected into underground formations, or may be otherwise disposed of in accordance with applicable regulations.

In some embodiments, the separated salt crystals may be further processed to produce a salt product. Further processing of salt crystals may include washing to remove residual brine, drying to remove moisture, grinding or sizing to produce desired particle sizes, or other processing. The salt product may be suitable for road de-icing, for chemical feedstocks, for food processing, for water treatment, or for other applications.

In some embodiments, sea salt production may be achieved through freeze-desalination processes. Sea salt may comprise salt produced from seawater, and sea salt may contain sodium chloride along with other minerals that may be present in seawater. Freeze-desalination may produce sea salt by freezing seawater to concentrate the dissolved salts, followed by further processing to crystallize and collect the salt. The sea salt produced through freeze-desalination may have a mineral composition that may reflect the mineral composition of the original seawater.

In some embodiments, sea salt production through freeze-desalination may be performed in cold climates where ambient temperatures may be below the freezing point of seawater. The cold ambient temperatures may provide the cooling for freezing the seawater without the need for mechanical refrigeration. The heat released during freezing may be transferred to the cold ambient air, and the warmed air may be harnessed for power generation or other purposes. The integration of sea salt production with power generation may provide multiple products from a single process.

In some embodiments, the production of brines and salts from seawater may involve multiple stages of freezing and separation. In a first stage, seawater may be partially frozen to produce ice and concentrated brine. The ice may be separated from the brine, and the brine may be further cooled in a second stage to produce additional ice and further concentrated brine. The process may be repeated through multiple stages until the brine reaches a desired concentration or until salt crystals begin to form. The multi-stage process may produce ice with progressively lower salt content and brine with progressively higher salt concentration.

In some embodiments, the production of brines and salts from seawater may involve eutectic freezing. Eutectic freezing may comprise the cooling of brine to the eutectic temperature, at which ice and salt crystals may form simultaneously. For sodium chloride brine, the eutectic temperature may be approximately negative 21 degrees Celsius, and the eutectic concentration may be approximately 23.3 percent sodium chloride by weight. At the eutectic point, the brine may solidify completely, forming a mixture of ice and salt crystals. The ice and salt crystals may be separated through density-based separation, centrifuging, or other separation methods.

In some embodiments, zero liquid discharge may be achieved through freezing brines and precipitating salts. Zero liquid discharge may comprise a process in which all liquid waste streams may be eliminated, with water being recovered and solids being produced for disposal or beneficial use. In freeze-desalination processes, zero liquid discharge may be achieved by freezing brine to produce ice and by precipitating salts from the concentrated brine. The ice may be melted to produce freshwater, and the precipitated salts may be collected as solid products. The process may eliminate the need to discharge liquid brine to the environment.

In some embodiments, zero liquid discharge through freezing may involve cooling brine to temperatures at which all dissolved salts may precipitate. Different salts may have different solubility characteristics, and the solubility of salts may generally decrease as temperature decreases. By cooling brine to sufficiently low temperatures, the solubility of dissolved salts may be reduced to the point where the salts may precipitate from solution. The precipitated salts may be collected, and the remaining liquid may be frozen to produce ice. The combination of salt precipitation and freezing may eliminate all liquid waste streams.

In some embodiments, zero liquid discharge through freezing may produce multiple salt products. Seawater and brines may contain multiple dissolved salts, and different salts may precipitate at different temperatures. By controlling the cooling rate and the temperature, different salts may be selectively precipitated and collected. Sodium sulfate may precipitate at temperatures above the precipitation temperature of sodium chloride, allowing sodium sulfate to be collected separately from sodium chloride. The selective precipitation of different salts may produce multiple salt products with different compositions.

In some embodiments, the salts produced through zero liquid discharge processes may be employed for various applications. Sodium chloride may be employed for road de-icing, for chemical manufacturing, for food processing, or for other applications. Sodium sulfate may be employed in detergent manufacturing, in glass manufacturing, in pulp and paper manufacturing, or for other applications. Magnesium chloride may be employed for dust control, for de-icing, for magnesium metal production, or for other applications. The production of multiple salt products may provide economic value and may offset the costs of the zero liquid discharge process.

In some embodiments, the brine produced through freeze-desalination may be employed for various applications. Concentrated brine may be employed for road de-icing, where the low freezing point of the brine may provide effective ice melting at low temperatures. Concentrated brine may be employed in chemical manufacturing as a source of dissolved salts. Concentrated brine may be employed in enhanced oil recovery, where the brine may be injected into oil reservoirs to displace oil. The brine may be employed in other applications where concentrated salt solutions may be useful.

In some embodiments, the freshwater produced through freeze-desalination may be employed for various applications. Freshwater may be employed for drinking water, for municipal water supply, for irrigation, for industrial processes, or for other applications where low-salinity water may be desired. The freshwater produced through freeze-desalination may have a salt content that may be lower than the salt content of the original seawater or brine, and the freshwater may meet water quality standards for the intended application.

In some embodiments, freeze-desalination may be combined with other desalination methods. Freeze-desalination may be employed as a pre-treatment step before reverse osmosis or other membrane-based desalination. The ice produced through freeze-desalination may be melted to produce water with reduced salt content, and the reduced-salinity water may be further desalinated through reverse osmosis. The combination of freeze-desalination and reverse osmosis may reduce the energy consumption of the overall desalination process by reducing the osmotic pressure that the reverse osmosis membranes may need to overcome.

In some embodiments, the ice produced through freeze-desalination may be further purified through melting and refreezing. The ice may be melted, and the resulting water may be refrozen under controlled conditions. The refreezing may produce ice with lower salt content than the original ice, as the salt may be further excluded during the refreezing process. Multiple cycles of melting and refreezing may produce ice with progressively lower salt content.

In some embodiments, the ice produced through freeze-desalination may be washed with a portion of the meltwater. A portion of the ice may be melted to produce meltwater, and the meltwater may be used to wash the remaining ice. The washing may remove residual salt from the surface of the ice, reducing the overall salt content of the ice. The wash water may become saline and may be added to the brine stream for further processing.

In some embodiments, the separation of ice from brine may be enhanced through the use of wash columns. A wash column may comprise a vertical column in which ice may rise through a countercurrent flow of wash water. As the ice rises through the wash column, residual brine may be washed from the surface of the ice by the descending wash water. The wash column may produce ice with lower salt content than gravity-based separation alone.

In some embodiments, the separation of ice from brine may be enhanced through the use of hydrocyclones. A hydrocyclone may comprise a device that may separate particles from liquids based on density differences using centrifugal forces generated by the swirling flow of the mixture. When a mixture of ice and brine is introduced into a hydrocyclone, the less dense ice may be directed toward the center of the hydrocyclone and may exit through an overflow, while the denser brine may be directed toward the wall of the hydrocyclone and may exit through an underflow. Hydrocyclones may provide continuous separation of ice from brine.

In some embodiments, the production of ice through freeze-desalination may be controlled to produce ice with desired characteristics. The freezing rate may be controlled to produce ice with lower or higher salt content. Slower freezing rates may produce ice with lower salt content, as the salt may have more time to diffuse away from the growing ice crystals. Faster freezing rates may produce ice with higher salt content, as brine may become entrapped within the ice structure. The agitation of the water during freezing may also affect the salt content of the ice, with greater agitation generally producing ice with lower salt content.

In some embodiments, the temperature of freezing may be controlled to produce ice with desired characteristics. Freezing at temperatures closer to the freezing point of the saline water may produce ice with lower salt content, as the freezing may proceed more slowly and the salt may have more time to be excluded from the ice. Freezing at temperatures substantially below the freezing point may produce ice with higher salt content, as the rapid freezing may entrap brine within the ice structure.

In some embodiments, nucleating agents may be employed to control ice crystal formation during freeze-desalination. Nucleating agents may comprise materials that may promote the formation of ice crystals by providing surfaces on which ice crystals may nucleate. The use of nucleating agents may allow ice crystal formation to be initiated at higher temperatures, may control the size and shape of ice crystals, or may otherwise affect the characteristics of the ice produced. Nucleating agents may include ice nucleating proteins, silver iodide, or other materials that may promote ice nucleation.

In some embodiments, the ice crystals produced during freeze-desalination may be in various forms. Ice crystal forms may include dendritic ice, which may have a branched structure; platelet ice, which may have a flat, plate-like structure; frazil ice, which may comprise small, disc-shaped ice crystals; or other ice forms. The form of the ice crystals may affect the ease of separation from brine, the salt content of the ice, and other characteristics. The ice crystal form may be controlled through the freezing conditions, including the temperature, the freezing rate, the agitation, and other factors.

In some embodiments, a system may comprise a freeze-desalination unit. The freeze-desalination unit may be configured to freeze saline water to produce ice and concentrated brine, and to separate the ice from the brine. The freeze-desalination unit may be fluidly connected to an airflow conduit, and the heat released during freezing may be transferred to air within the airflow conduit. The freeze-desalination unit may produce freshwater through melting of the separated ice, and may produce concentrated brine or salt as byproducts.

In some embodiments, a system may comprise a brine, or salt, or any combination thereof generation unit. The brine or salt generation unit may be configured to produce concentrated brine, salt crystals, or any combination thereof from saline water. The brine or salt generation unit may be fluidly connected to an airflow conduit, and the heat released during freezing or crystallization may be transferred to air within the airflow conduit. The brine or salt generation unit may produce brine or salt products that may be employed for various applications.

In some embodiments, the means to harness the airflow may comprise a freeze-desalination unit. The airflow generated through heat transfer from a fluid to air may be harnessed for power generation or other purposes, and the freeze-desalination unit may produce freshwater as an additional product. The integration of freeze-desalination with airflow harnessing may provide synergies that may reduce the overall cost of both power generation and freshwater production.

In some embodiments, the means to harness the airflow may comprise a brine, or salt, or any combination thereof generation unit. The airflow generated through heat transfer from a fluid to air may be harnessed for power generation or other purposes, and the brine or salt generation unit may produce brine or salt products as additional products. The integration of brine or salt production with airflow harnessing may provide multiple revenue streams from a single process.

In some embodiments, ice produced through heat transfer processes may be employed for various applications. Ice produced through the freezing of water during heat transfer from fluid to air may represent a product that may have value for multiple purposes. The ice may be collected, stored, transported, processed, or otherwise managed for the intended application. The applications for produced ice may include one or more or any combination of the following: adding ice to bodies of water, or thickening ice roads, or use as building material, or thermal storage, or water storage, or freeze desalination, or freshwater storage, or wildfire prevention or suppression, or albedo enhancement, or any combination thereof.

In some embodiments, ice produced through heat transfer processes may be added to a body of water. Bodies of water to which ice may be added may include one or more or any combination of the following: oceans, or seas, or lakes, or rivers, or bays, or estuaries, or ponds, or any combination thereof. The addition of ice to a body of water may increase the total ice mass in the body of water, may increase the thickness of existing ice cover, may extend the duration of ice cover, or may provide other benefits. The ice may be transported to the body of water by conveyor systems, by vehicles, by chutes, by pipelines, or by other transport mechanisms.

In some embodiments, ice produced through heat transfer processes may be added to bodies of water to increase sea ice mass. Sea ice may comprise ice that forms on the surface of oceans or seas. Sea ice may play a role in marine ecosystems, may affect ocean circulation, may influence weather patterns, and may affect albedo. The addition of produced ice to sea ice may increase the total mass of sea ice, which may provide benefits for marine ecosystems, may increase albedo, or may provide other environmental benefits. The produced ice may be deposited on existing sea ice, may be deposited in open water where sea ice formation may be desired, or may be deposited in other locations within marine environments.

In some embodiments, ice produced through heat transfer processes may be added to bodies of water to increase sea ice longevity. Sea ice longevity may refer to the duration for which sea ice may persist before melting. The addition of produced ice to sea ice may increase the thickness of the sea ice, which may increase the time required for the sea ice to melt. Thicker sea ice may persist longer into warm seasons than thinner sea ice. The increased longevity of sea ice may provide extended benefits for marine ecosystems, may provide extended albedo enhancement, or may provide other benefits.

In some embodiments, ice produced through heat transfer processes may be employed to thicken ice roads. Ice roads may comprise roads constructed on frozen bodies of water or on frozen ground, where the ice may provide a load-bearing surface for vehicles. Ice roads may be employed in cold climate regions to provide transportation routes during winter months. The load-bearing capacity of an ice road may be related to the thickness of the ice, with thicker ice being able to support heavier loads. The addition of produced ice to ice roads may increase the thickness of the ice, which may increase the load-bearing capacity of the ice road.

In some embodiments, ice produced through heat transfer processes may be employed to reinforce ice roads. Reinforcement of ice roads may comprise the addition of ice to strengthen the ice road structure, to repair damaged sections of ice roads, to extend the operational season of ice roads, or to provide other improvements to ice road performance. The produced ice may be deposited on the surface of the ice road, may be applied to the underside of the ice road, or may be applied to other locations to reinforce the ice road structure.

In some embodiments, ice produced through heat transfer processes may be employed to increase the longevity of ice roads. Ice road longevity may refer to the duration for which an ice road may remain operational before the ice melts or becomes too thin to support traffic. The addition of produced ice to ice roads may increase the thickness of the ice, which may extend the operational season of the ice road. Extended ice road longevity may allow transportation to continue later into the spring season, may allow transportation to begin earlier in the fall season, or may provide other benefits for ice road operations.

In some embodiments, ice produced through heat transfer processes may be employed as a building material. Ice may be employed as a building material for constructing structures in cold climate regions. Structures that may be constructed from ice may include one or more or any combination of the following: ice shelters, or ice hotels, or ice sculptures, or ice walls, or ice foundations, or ice reinforcement for other structures, or any combination thereof. The produced ice may be formed into blocks, may be sprayed to form layers, may be cast into molds, or may be otherwise processed for use as a building material.

In some embodiments, ice produced through heat transfer processes may be employed for thermal storage. Thermal storage may comprise the storage of thermal energy for later use. Ice may represent a form of thermal storage because the melting of ice may absorb heat, providing a cooling effect. The enthalpy of fusion of water may be approximately 333.55 kilojoules per kilogram, which may represent the cooling capacity that may be released when ice melts. Ice produced through heat transfer processes may be stored in insulated containers, in underground storage facilities, in above-ground storage facilities, or in other storage configurations for later use as a cooling source.

In some embodiments, ice produced through heat transfer processes may be employed for seasonal thermal storage. Seasonal thermal storage may comprise the storage of thermal energy from one season for use in another season. Ice produced during cold winter months may be stored and may be used to provide cooling during warm summer months. The seasonal thermal storage of ice may reduce the energy consumption associated with mechanical cooling during summer months, may provide cooling in locations where mechanical cooling may be unavailable, or may provide other benefits.

In some embodiments, ice produced through heat transfer processes may be employed for water storage. Water storage may comprise the storage of water for later use. Ice may represent a form of water storage because the ice may be melted to produce liquid water when water is needed. Ice produced through heat transfer processes may be stored in cold environments where the ice may remain frozen until water is needed. The ice may be melted through natural warming, through application of heat, or through other methods to produce liquid water for use.

In some embodiments, ice produced through heat transfer processes may be employed in freeze desalination. Freeze desalination may comprise a desalination process in which saline water may be frozen to produce ice that may have a lower salt content than the original saline water. Ice produced through heat transfer from seawater or brine to air may have reduced salt content compared to the original saline water. The ice may be separated from the remaining brine, and the ice may be melted to produce freshwater or desalinated water. The ice produced through heat transfer processes may serve as an intermediate product in freeze desalination processes.

In some embodiments, ice produced through heat transfer processes may be stored as freshwater. Freshwater storage may comprise the storage of freshwater for later use. Ice produced from freshwater sources or ice produced through freeze desalination may represent stored freshwater that may be released when the ice melts. The ice may be stored in cold environments where the ice may remain frozen until freshwater is needed. The stored ice may provide a reserve of freshwater for drinking water, for irrigation, for industrial processes, or for other applications where freshwater may be needed.

In some embodiments, ice produced through heat transfer processes may be distributed or strategically placed on land to prevent wildfires. Wildfire prevention may comprise actions taken to reduce the risk of wildfire ignition or to reduce the conditions that may allow wildfires to spread. Ice placed on land may provide moisture to vegetation, may reduce fuel dryness, may create barriers to fire spread, or may otherwise reduce wildfire risk. The ice may be placed in fire-prone regions before fire season, may be placed in areas where fire risk may be elevated, or may be placed in other locations where wildfire prevention may be desired.

In some embodiments, ice produced through heat transfer processes may be distributed or strategically placed on land to inhibit wildfires. Wildfire inhibition may comprise actions taken to slow the spread of wildfires or to reduce the intensity of wildfires. Ice placed on land may provide moisture that may slow fire spread, may create firebreaks that may inhibit fire progression, or may otherwise reduce the rate or intensity of wildfire spread. The ice may be placed in the path of advancing wildfires, may be placed around structures or areas to be protected, or may be placed in other locations where wildfire inhibition may be desired.

In some embodiments, ice produced through heat transfer processes may be distributed or strategically placed on land to suppress wildfires. Wildfire suppression may comprise actions taken to extinguish wildfires or to reduce active burning. Ice placed on burning areas may melt and may release water that may extinguish flames, may cool burning materials, or may otherwise contribute to fire suppression. The ice may be delivered to active fire areas by aircraft, by ground vehicles, by conveyor systems, or by other delivery mechanisms.

In some embodiments, ice produced through heat transfer processes may be employed to enhance albedo. Albedo may refer to the reflectivity of a surface, and surfaces with higher albedo may reflect more solar radiation than surfaces with lower albedo. Ice and snow may have higher albedo than liquid water, land surfaces, or other materials. The placement of ice on surfaces may increase the albedo of those surfaces, which may reduce solar heat absorption and may contribute to cooling effects. Enhanced albedo may be beneficial for climate management, for reducing heat island effects in urban areas, or for other purposes where increased reflectivity may be desired.

In some embodiments, ice produced through heat transfer processes may be placed on land surfaces to enhance albedo. Land surfaces that may receive ice for albedo enhancement may include one or more or any combination of the following: agricultural fields, or urban areas, or industrial areas, or natural landscapes, or any combination thereof. The ice placed on land surfaces may reflect solar radiation that would otherwise be absorbed by the land surface, which may reduce surface temperatures and may provide cooling effects.

In some embodiments, ice produced through heat transfer processes may be placed on water surfaces to enhance albedo. Water surfaces may have lower albedo than ice surfaces, and the placement of ice on water surfaces may increase the overall albedo of the water body. The increased albedo may reduce solar heat absorption by the water body, which may reduce water temperatures and may provide cooling effects. The ice placed on water surfaces may also contribute to sea ice mass and longevity as described herein.

In some embodiments, ice produced through heat transfer processes may be employed for multiple applications simultaneously or sequentially. Ice may first be employed for thermal storage, and when the ice melts, the resulting water may be employed for water storage or for other water applications. Ice may be employed for albedo enhancement, and when the ice melts, the resulting water may provide moisture for vegetation or may flow into water bodies. The multiple applications of produced ice may provide cumulative benefits and may increase the overall value of the ice production process.

In some embodiments, separated salt crystals and brine may be stored separately from ice. The separation of salt crystals and brine from ice may be performed through density-based separation, centrifuging, or other separation methods as described herein. The separated salt crystals may be stored in containers, in piles, in silos, or in other storage configurations. The separated brine may be stored in tanks, in ponds, in underground storage, or in other storage configurations. The separated ice may be stored in insulated containers, in cold storage facilities, or in other storage configurations that may maintain the ice in a frozen state.

In some embodiments, separated salt crystals and brine may be mixed with ice when cooling below 0 degrees Celsius may be desired. The mixing of salt or brine with ice may produce cooling to temperatures below the freezing point of pure water. When salt is mixed with ice, the salt may dissolve in the liquid water that may be present on the surface of the ice or that may form as the ice melts. The dissolution of salt in water may be an endothermic process that may absorb heat, and the presence of dissolved salt may lower the freezing point of the resulting solution. The combination of heat absorption during dissolution and freezing point depression may produce temperatures substantially below 0 degrees Celsius.

In some embodiments, the mixing of salt crystals with ice may produce ultra-cold temperatures. Ultra-cold temperatures may comprise temperatures substantially below the freezing point of pure water. When sodium chloride is mixed with ice, the resulting mixture may reach temperatures as low as approximately negative 21 degrees Celsius, which may correspond to the eutectic temperature of the sodium chloride-water system. When calcium chloride is mixed with ice, the resulting mixture may reach temperatures as low as approximately negative 50 degrees Celsius. The ultra-cold temperatures produced by mixing salt with ice may be substantially colder than the temperatures that may be achieved by melting pure ice alone.

In some embodiments, the mixing of brine with ice may produce ultra-cold temperatures. Brine may comprise water with dissolved salts, and the mixing of brine with ice may produce cooling effects similar to the mixing of salt crystals with ice. The brine may dissolve additional ice, and the dissolution process may absorb heat. The resulting mixture may reach temperatures below 0 degrees Celsius depending on the salt concentration of the brine and the ratio of brine to ice.

In some embodiments, the ultra-cold temperatures produced by mixing salt or brine with ice may be employed for enhanced thermal storage applications. Enhanced thermal storage may comprise thermal storage that may provide cooling to temperatures below the freezing point of pure water. The storage of ice separately from salt crystals or brine may allow the ultra-cold cooling capacity to be preserved until cooling may be needed. When cooling below 0 degrees Celsius may be desired, the stored ice may be mixed with the stored salt crystals or brine to produce the ultra-cold temperatures. The enhanced thermal storage may provide cooling capacity that may not be achievable with pure ice alone.

In some embodiments, the enhanced thermal storage using ice and salt or brine may be employed for various applications. Applications for enhanced thermal storage may include one or more or any combination of the following: food preservation at temperatures below the freezing point of water, or pharmaceutical storage at controlled low temperatures, or industrial cooling processes requiring temperatures below 0 degrees Celsius, or scientific applications requiring low temperatures, or any combination thereof. The enhanced thermal storage may provide low-temperature cooling without the need for mechanical refrigeration equipment.

In some embodiments, a mixture of ice and salt crystals or brine may be stored together for later use. The mixture may be stored at temperatures below the eutectic temperature of the salt-water system, at which temperature the mixture may remain solid. When cooling may be desired, the stored mixture may be allowed to warm, and the melting of the mixture may absorb heat and may provide cooling at temperatures below 0 degrees Celsius. The storage of the pre-mixed ice and salt or brine may simplify the deployment of the enhanced thermal storage, as the mixing step may have been completed prior to storage.

In some embodiments, the ratio of ice to salt or brine may be controlled to achieve desired cooling temperatures. Higher ratios of salt to ice may produce lower temperatures, while lower ratios of salt to ice may produce temperatures closer to 0 degrees Celsius. The ratio may be selected based on the cooling temperature requirements of the application. The ratio may be adjusted by varying the amount of salt crystals or brine mixed with a given amount of ice, or by varying the amount of ice mixed with a given amount of salt crystals or brine.

In some embodiments, the type of salt employed in the ice-salt mixture may be selected based on the desired cooling temperature. Different salts may have different eutectic temperatures with water, and the selection of salt type may determine the minimum temperature that may be achieved. Sodium chloride may provide cooling to approximately negative 21 degrees Celsius. Calcium chloride may provide cooling to approximately negative 50 degrees Celsius. Magnesium chloride may provide cooling to approximately negative 33 degrees Celsius. The salt type may be selected based on the temperature requirements of the application and the availability of the salt.

In some embodiments, the ice produced through heat transfer processes may be transported to locations where the ice may be employed for the applications described herein. Transportation of ice may be performed using one or more or any combination of the following: trucks, or rail cars, or ships, or barges, or aircraft, or conveyor systems, or pipelines for ice slurries, or any combination thereof. The transportation method may be selected based on the distance to be traveled, the quantity of ice to be transported, the urgency of delivery, the available infrastructure, or any combination of such factors.

In some embodiments, the ice produced through heat transfer processes may be processed before employment for the applications described herein. Processing of ice may include one or more or any combination of the following: crushing or grinding to produce desired particle sizes, or compacting to increase density, or forming into blocks or other shapes, or mixing with other materials, or any combination thereof. The processing may prepare the ice for the intended application and may facilitate handling, transportation, or deployment of the ice.

In some embodiments, the ice produced through heat transfer processes may be deployed using various methods depending on the application. For addition to bodies of water, the ice may be dumped from vessels, may be conveyed into the water, or may be allowed to slide into the water. For thickening ice roads, the ice may be spread on the ice road surface, may be sprayed as water that freezes on contact, or may be applied using other methods. For wildfire prevention or suppression, the ice may be dropped from aircraft, may be spread by ground vehicles, or may be deployed using other methods. The deployment method may be selected based on the application requirements, the available equipment, the site conditions, or any combination of such factors.

In some embodiments, a process may further comprise transferring a fluid from a fluid source at a third elevation to a thermal exchange zone at a first elevation, wherein the thermal exchange zone may be at a higher elevation than the fluid source. The fluid source may comprise a body of water, a storage tank, a reservoir, a well, or other source of fluid that may be located at a lower elevation than the thermal exchange zone. The transfer of fluid from the fluid source to the thermal exchange zone may be performed using pumps, gravity feed from an elevated intermediate storage, siphon systems, or other fluid transfer mechanisms. The energy required to lift the fluid from the third elevation to the first elevation may be provided by electrical power, mechanical power, or other energy sources.

In some embodiments, the third elevation may be lower than the first elevation by various amounts depending on the geographic configuration of the system. The elevation difference between the fluid source at the third elevation and the thermal exchange zone at the first elevation may range from approximately 1 meter to approximately 500 meters or more. In some embodiments, the elevation difference may be greater than approximately 5 meters, or greater than approximately 10 meters, or greater than approximately 20 meters, or greater than approximately 50 meters, or greater than approximately 100 meters, or greater than approximately 200 meters. The elevation difference may depend on the geographic features of the site, the configuration of the air conduit, the location of available water sources, or any combination of such factors.

In some embodiments, the fluid source may comprise a body of water located at a lower elevation than the thermal exchange zone. Bodies of water that may serve as fluid sources at lower elevations may include one or more or any combination of the following: oceans, or seas, or lakes, or rivers, or bays, or estuaries, or fjords, or any combination thereof. The thermal exchange zone may be positioned at a higher elevation on a hillside, a cliffside, a mountainside, or other elevated terrain feature. The fluid may be pumped from the body of water at the third elevation to the thermal exchange zone at the first elevation.

In some embodiments, a process may further comprise transferring at least a portion of the material comprising the fluid after a thermal exchange zone to a deposit location at a lower elevation than the thermal exchange zone. The material comprising the fluid after the thermal exchange zone may comprise liquid water, ice, brine, salt crystals, liquid-solid mixtures, or any combination thereof depending on the heat transfer that may have occurred in the thermal exchange zone. The deposit location may be at a lower elevation than the thermal exchange zone, and the transfer of material from the thermal exchange zone to the deposit location may involve movement of the material downward under the influence of gravity.

In some embodiments, the deposit location may be at the same elevation as the fluid source, may be near the fluid source, or may be at a different location that may be at a lower elevation than the thermal exchange zone. The deposit location may comprise a body of water, a storage facility, a processing facility, or other location where the material may be deposited. In some embodiments, at least a portion of the material comprising the fluid after the thermal exchange zone may be transferred to the fluid source or a location near the fluid source, wherein the location comprising the fluid source or the location near the fluid source may comprise a deposit location and the deposit location may be at an elevation lower than the elevation of the thermal exchange zone.

In some embodiments, the material comprising the fluid after the thermal exchange zone may comprise a solid. The solid may comprise ice that may have formed during heat transfer from the fluid to air in the thermal exchange zone. The ice may be transferred from the thermal exchange zone to the deposit location through various mechanisms including conveyor systems, chutes, slides, rail systems, cable systems, or other transport mechanisms. The transfer of solid material from the thermal exchange zone to the deposit location may involve the movement of the solid material downward under the influence of gravity.

In some embodiments, the material comprising the fluid after the thermal exchange zone may comprise a solid-liquid mixture. The solid-liquid mixture may comprise ice and liquid water, ice and brine, or other combinations of solid and liquid phases. The solid-liquid mixture may be transferred from the thermal exchange zone to the deposit location through pipelines, channels, chutes, or other transport mechanisms that may accommodate the flow of solid-liquid mixtures.

In some embodiments, the material comprising the fluid after the thermal exchange zone may comprise a brine. The brine may comprise concentrated saline water that may have been produced through partial freezing of seawater or other saline water in the thermal exchange zone. The brine may be transferred from the thermal exchange zone to the deposit location through pipelines, channels, or other transport mechanisms for liquid flow.

In some embodiments, the material comprising the fluid after the thermal exchange zone may comprise a solid-gas mixture. The solid-gas mixture may comprise ice particles or ice crystals suspended in air or other gas. The solid-gas mixture may be transferred from the thermal exchange zone to the deposit location through pneumatic transport systems, chutes, or other transport mechanisms.

In some embodiments, the material comprising the fluid after the thermal exchange zone may comprise a liquid-solid-gas mixture. The liquid-solid-gas mixture may comprise liquid water, ice, and entrained air or other gas. The liquid-solid-gas mixture may be transferred from the thermal exchange zone to the deposit location through pipelines, channels, or other transport mechanisms that may accommodate multi-phase flow.

In some embodiments, a process may further comprise harnessing at least a portion of the potential energy in the difference in elevation between the deposit location and the thermal exchange zone to generate power. The potential energy may be related to the mass of the material being transferred, the gravitational acceleration, and the elevation difference between the thermal exchange zone and the deposit location. The potential energy may be converted to kinetic energy as the material moves downward from the thermal exchange zone to the deposit location, and the kinetic energy may be harnessed to generate electrical power or mechanical power.

In some embodiments, a process may further comprise harnessing at least a portion of the potential energy in the difference in elevation between the thermal exchange zone and the deposit location to generate power. The elevation difference between the thermal exchange zone at the first elevation and the deposit location at a lower elevation may provide a hydraulic head or gravitational potential that may be harnessed for power generation. The power generated from the elevation difference may offset at least a portion of the power required to pump fluid from the fluid source to the thermal exchange zone.

In some embodiments, a process may further comprise recovering at least a portion of the potential energy in the difference in elevation between the thermal exchange zone and the deposit location and transferring the recovered energy to provide at least a portion of the energy required to move the fluid from the fluid source to the thermal exchange zone. The recovery of potential energy from the downward transfer of material may reduce the net energy consumption of the system by providing energy that may be used to lift fluid from the fluid source to the thermal exchange zone. The energy recovery may be performed through mechanical coupling, electrical coupling, hydraulic coupling, or other energy transfer mechanisms.

In some embodiments, a process may further comprise recovering at least a portion of energy from transferring the material comprising the fluid after the thermal exchange zone to the deposit location. The energy recovery may capture the kinetic energy or potential energy associated with the downward movement of the material from the thermal exchange zone to the deposit location. The recovered energy may be converted to electrical power, mechanical power, or other forms of energy that may be used within the system or may be exported from the system.

In some embodiments, at least a portion of energy may be recovered using a generator. A generator may comprise a device that may convert mechanical energy to electrical energy. The generator may be driven by a turbine, a wheel, a drum, or other rotating element that may be rotated by the movement of material from the thermal exchange zone to the deposit location. The generator may produce electrical power that may be used to power pumps, control systems, or other equipment within the system, or the electrical power may be exported to an electrical grid or other external load.

In some embodiments, at least a portion of energy may be recovered using a pulley system. A pulley system may comprise one or more pulleys with ropes, cables, or belts that may connect loads at different elevations. The pulley system may be configured such that the downward movement of material from the thermal exchange zone to the deposit location may lift fluid from the fluid source to the thermal exchange zone. The pulley system may provide direct mechanical coupling between the downward movement of material and the upward movement of fluid, which may reduce the electrical power required for pumping.

In some embodiments, the pulley system may comprise a counterweight arrangement. The material moving downward from the thermal exchange zone to the deposit location may serve as a counterweight that may assist in lifting fluid from the fluid source to the thermal exchange zone. The counterweight arrangement may balance at least a portion of the weight of the fluid being lifted, which may reduce the net force required to lift the fluid and may reduce the energy consumption of the pumping system.

In some embodiments, at least a portion of energy may be recovered using a conveyor belt. A conveyor belt may comprise a continuous belt that may move material from one location to another. The conveyor belt may be configured to transport material from the thermal exchange zone to the deposit location, and the downward movement of the material on the conveyor belt may drive the conveyor belt. The conveyor belt may be connected to a generator or to other equipment that may recover energy from the movement of the conveyor belt. In some embodiments, the conveyor belt may be configured as a regenerative system, where the downward movement of material on one portion of the conveyor belt may provide energy to lift material or fluid on another portion of the conveyor belt.

In some embodiments, at least a portion of energy may be recovered using an Archimedes screw. An Archimedes screw may comprise a helical screw within a cylindrical housing that may be used to move material along the axis of the screw. When an Archimedes screw is oriented with the axis at an angle to horizontal, the rotation of the screw may move material upward or downward along the axis. An Archimedes screw may be configured to transport material from the thermal exchange zone to the deposit location, and the downward movement of the material may drive the rotation of the screw. The rotation of the screw may be connected to a generator or to other equipment that may recover energy from the rotation.

In some embodiments, the Archimedes screw may be configured to operate in a regenerative mode. In regenerative mode, the downward movement of material through the Archimedes screw may generate power that may be used to drive another Archimedes screw that may lift fluid from the fluid source to the thermal exchange zone. The mechanical coupling between the two Archimedes screws may provide direct energy transfer without the need for electrical conversion.

In some embodiments, at least a portion of energy may be recovered using a mechanical exchanger. A mechanical exchanger may comprise a device that may transfer mechanical energy from one system to another. The mechanical exchanger may be configured to transfer energy from the downward movement of material from the thermal exchange zone to the deposit location to the upward movement of fluid from the fluid source to the thermal exchange zone. Mechanical exchangers may include gear systems, belt drives, chain drives, hydraulic couplings, or other mechanical power transmission devices.

In some embodiments, at least a portion of energy may be recovered using a pressure exchanger. A pressure exchanger may comprise a device that may transfer pressure energy from one fluid stream to another fluid stream. The pressure exchanger may be configured to transfer pressure energy from the material flowing downward from the thermal exchange zone to the deposit location to the fluid being pumped upward from the fluid source to the thermal exchange zone. Pressure exchangers may include rotary pressure exchangers, piston-type pressure exchangers, or other devices that may transfer pressure energy between fluid streams.

In some embodiments, the pressure exchanger may be employed when the material flowing from the thermal exchange zone to the deposit location comprises a liquid or a liquid-solid mixture that may be pressurized. The pressurized flow of material downward may transfer pressure energy to the fluid being pumped upward, which may reduce the energy required for pumping. The pressure exchanger may achieve high efficiency in transferring pressure energy between the fluid streams.

In some embodiments, the energy may be recovered as electricity. The recovered energy may be converted to electrical power through the use of generators, alternators, or other electrical power generation devices. The electrical power may be used to power pumps, control systems, lighting, heating, or other electrical loads within the system. The electrical power may also be exported to an electrical grid, may be stored in batteries or other energy storage systems, or may be used for other purposes.

In some embodiments, the energy recovery from elevation differences may be combined with power generation from buoyancy-driven airflow. The system may generate power from the airflow induced by heat transfer from fluid to air, and the system may also recover energy from the elevation difference between the thermal exchange zone and the deposit location. The combination of power generation from airflow and energy recovery from elevation differences may increase the total power output of the system and may improve the overall energy efficiency of the system.

In some embodiments, the energy recovery from elevation differences may reduce the net energy consumption of the system. The energy required to pump fluid from the fluid source to the thermal exchange zone may be partially offset by the energy recovered from transferring material from the thermal exchange zone to the deposit location. The net energy consumption may be the difference between the energy required for pumping and the energy recovered from the elevation difference. In some embodiments, the energy recovered from the elevation difference may exceed the energy required for pumping, resulting in net power generation from the fluid transfer operations.

In some embodiments, the efficiency of energy recovery from elevation differences may depend on the mass of material transferred, the elevation difference, and the efficiency of the energy recovery equipment. Higher mass flow rates of material from the thermal exchange zone to the deposit location may provide greater potential for energy recovery. Greater elevation differences may provide greater potential energy per unit mass of material. Higher efficiency energy recovery equipment may capture a greater fraction of the available potential energy.

In some embodiments, the mass of material transferred from the thermal exchange zone to the deposit location may be greater than the mass of fluid transferred from the fluid source to the thermal exchange zone. When water freezes in the thermal exchange zone, the mass of ice produced may be less than the mass of water that entered the thermal exchange zone if some water evaporates or is otherwise lost. However, when brine is produced through partial freezing of seawater, the total mass of ice and brine may be approximately equal to the mass of seawater that entered the thermal exchange zone. The mass balance may affect the potential for energy recovery from elevation differences.

In some embodiments, the density of material transferred from the thermal exchange zone to the deposit location may differ from the density of fluid transferred from the fluid source to the thermal exchange zone. Ice may have a density of approximately 917 kilograms per cubic meter, which may be lower than the density of liquid water at approximately 1,000 kilograms per cubic meter. Brine may have a density greater than the density of seawater due to the increased salt concentration. The density differences may affect the volume flow rates and the energy recovery characteristics.

In some embodiments, the configuration of the energy recovery system may be selected based on the type of material being transferred from the thermal exchange zone to the deposit location. For solid materials such as ice, conveyor belts, pulley systems, or Archimedes screws may be suitable for energy recovery. For liquid materials such as brine, pressure exchangers or hydraulic turbines may be suitable for energy recovery. For solid-liquid mixtures, systems that may accommodate multi-phase flow may be employed for energy recovery.

In some embodiments, the energy recovery system may be configured to operate continuously or intermittently depending on the operation of the thermal exchange zone. When the thermal exchange zone is operating and producing material, the energy recovery system may operate to recover energy from the transfer of material to the deposit location. When the thermal exchange zone is not operating, the energy recovery system may be idle or may be used for other purposes.

In some embodiments, the energy recovery system may be configured to operate in reverse to provide energy storage capability. During periods of excess power availability, the energy recovery system may be operated in reverse to lift material from the deposit location to the thermal exchange zone or to an intermediate storage location. The lifted material may represent stored potential energy that may be released later by allowing the material to flow back down to the deposit location while recovering energy. The reversible operation of the energy recovery system may provide energy storage capability that may be used to balance power supply and demand.

In some embodiments, an air conduit may comprise a collapsible structure. A collapsible structure may comprise a structure that may be reduced in size, height, or volume through folding, telescoping, deflating, or other mechanisms. The collapsible structure may be configured to be collapsed in response to various conditions or instructions, and the collapsible structure may be expanded to an operational configuration when conditions permit.

In some embodiments, the air conduit may be at least partially collapsed in response to instructions. Instructions may comprise commands, signals, or directives that may be issued by operators, control systems, or other sources. The instructions may be transmitted to actuators, motors, or other mechanisms that may effect the collapse of the air conduit. The instructions may be issued manually by human operators, may be issued automatically by control systems, or may be issued remotely through communication systems.

In some embodiments, the instructions to collapse the air conduit may be issued in response to operator decisions. Operators may decide to collapse the air conduit based on observations, forecasts, maintenance schedules, or other factors. The operators may issue instructions through control panels, computer interfaces, mobile devices, or other control mechanisms. The instructions may be transmitted to the air conduit through wired connections, wireless connections, or other communication pathways.

In some embodiments, the instructions to collapse the air conduit may be issued automatically by control systems. Control systems may monitor conditions, may compare conditions to thresholds or criteria, and may issue instructions to collapse the air conduit when conditions meet the criteria for collapse. The automatic issuance of instructions may provide rapid response to changing conditions and may reduce the need for continuous operator monitoring.

In some embodiments, the air conduit may be at least partially collapsed in response to conditions. Conditions may comprise environmental conditions, operational conditions, system conditions, or other factors that may affect the operation or safety of the air conduit. The air conduit may be configured to collapse automatically in response to certain conditions, or the air conduit may be collapsed by operators or control systems in response to detected or predicted conditions.

In some embodiments, conditions that may trigger collapse of the air conduit may include one or more or any combination of the following: wind conditions, or temperature conditions, or precipitation conditions, or ice accumulation, or structural conditions, or maintenance requirements, or emergency conditions, or any combination thereof. The air conduit may be configured to detect such conditions through sensors, to receive information about such conditions from external sources, or to respond to operator inputs regarding such conditions.

In some embodiments, the air conduit may be at least partially collapsed in response to current or predicted high wind conditions or hazardous conditions. High wind conditions may comprise wind velocities that may exceed safe operating limits for the air conduit, that may cause excessive structural loads on the air conduit, or that may otherwise pose risks to the air conduit or to personnel. Hazardous conditions may comprise conditions that may pose risks to the air conduit, to personnel, to equipment, or to the surrounding environment.

In some embodiments, high wind conditions may be detected through wind sensors, anemometers, or other wind measurement devices. The wind measurements may be compared to thresholds that may represent safe operating limits for the air conduit. When wind velocities exceed the thresholds, the air conduit may be collapsed to reduce the wind loads on the structure and to prevent damage. The thresholds may be set based on the structural capacity of the air conduit, the configuration of the air conduit, the materials of construction, or other factors.

In some embodiments, predicted high wind conditions may be obtained from weather forecasts, weather prediction models, or other sources of weather information. The predicted wind conditions may be compared to thresholds, and the air conduit may be collapsed in advance of the predicted high wind conditions. Collapsing the air conduit in advance of predicted high wind conditions may provide time for the collapse operation to be completed before the high winds arrive, which may reduce the risk of damage during the collapse operation.

In some embodiments, hazardous conditions may include one or more or any combination of the following: severe storms, or hurricanes, or typhoons, or tornadoes, or blizzards, or ice storms, or earthquakes, or tsunamis, or volcanic activity, or wildfires, or any combination thereof. The air conduit may be collapsed in response to current hazardous conditions or in response to predicted hazardous conditions to protect the air conduit and to reduce risks.

In some embodiments, the collapse of the air conduit may be partial or complete depending on the conditions and the configuration of the air conduit. Partial collapse may reduce the height of the air conduit, may reduce the cross-sectional area of the air conduit, or may otherwise reduce the exposure of the air conduit to wind or other hazards. Complete collapse may reduce the air conduit to a minimum configuration that may provide maximum protection from hazards.

In some embodiments, the air conduit may be configured to collapse through telescoping. A telescoping air conduit may comprise multiple sections that may slide within one another to reduce the overall height of the air conduit. The telescoping sections may be extended for normal operation and may be retracted for collapse. The telescoping mechanism may be powered by motors, hydraulic cylinders, pneumatic cylinders, or other actuators.

In some embodiments, the air conduit may be configured to collapse through folding. A folding air conduit may comprise sections that may be hinged together and that may fold to reduce the overall height or footprint of the air conduit. The folding sections may be unfolded for normal operation and may be folded for collapse. The folding mechanism may be powered by motors, hydraulic cylinders, cables, or other actuators.

In some embodiments, the air conduit may be configured to collapse through deflation. A deflatable air conduit may comprise an inflatable structure that may be inflated for normal operation and may be deflated for collapse. The inflatable structure may be supported by internal air pressure, and the removal of air pressure may cause the structure to collapse. The deflation may be performed by opening valves, by activating pumps, or by other mechanisms.

In some embodiments, the air conduit may be configured to collapse through lowering. A lowerable air conduit may comprise a structure that may be raised for normal operation and may be lowered for collapse. The lowering may be performed by cables, by hydraulic systems, by mechanical systems, or by other mechanisms. The lowered air conduit may rest on the ground, on a support structure, or in another protected position.

In some embodiments, the time required to collapse the air conduit may depend on the collapse mechanism, the size of the air conduit, and the power available for the collapse operation. Faster collapse times may be desirable when responding to rapidly developing hazardous conditions. The collapse mechanism may be designed to provide collapse times that may be appropriate for the expected hazard response requirements.

In some embodiments, the air conduit may be configured to be re-expanded after collapse. The re-expansion may be performed when conditions permit safe operation of the air conduit. The re-expansion may be performed through the reverse of the collapse mechanism, such as extending telescoping sections, unfolding folding sections, inflating deflatable sections, or raising lowerable sections. The re-expansion may be performed in response to instructions from operators or control systems.

In some embodiments, the collapse and re-expansion of the air conduit may be performed multiple times during the operational life of the air conduit. The air conduit may be collapsed in response to each occurrence of high wind conditions or hazardous conditions, and the air conduit may be re-expanded when conditions permit. The collapse and re-expansion mechanisms may be designed for repeated operation and may be maintained to ensure reliable operation.

In some embodiments, sensors may be employed to monitor the status of the air conduit during collapse and re-expansion operations. Sensors may detect the position of collapsible sections, the pressure in inflatable sections, the tension in cables, or other parameters that may indicate the status of the collapse or re-expansion operation. The sensor data may be used by control systems to verify that the collapse or re-expansion operation has been completed successfully.

In some embodiments, safety systems may be employed to protect personnel and equipment during collapse and re-expansion operations. Safety systems may include warning signals, barriers, interlocks, or other measures that may prevent personnel from entering hazardous areas during collapse or re-expansion operations. The safety systems may be activated automatically when collapse or re-expansion operations are initiated.

In some embodiments, an air conduit may be constructed from various materials depending on the structural requirements, the environmental conditions, the intended operational life, the cost considerations, or any combination of such factors. The selection of materials for the air conduit may affect the structural capacity, the durability, the thermal properties, the weight, the construction methods, and other characteristics of the air conduit. In some embodiments, a process may comprise an air conduit that is a material comprising a metal, a plastic, a composite, concrete, ice, an ice composite, or any combination thereof. In some embodiments, a system may comprise an airflow conduit that is a material comprising a metal, a plastic, a composite, concrete, ice, an ice composite, or any combination thereof.

In some embodiments, an air conduit may be a material comprising a metal. Metals that may be employed for air conduit construction may include one or more or any combination of the following: steel, or stainless steel, or aluminum, or copper, or titanium, or alloys thereof, or any combination thereof. Steel may provide high strength and stiffness, and steel may be employed for air conduits that may be subject to high structural loads. Stainless steel may provide corrosion resistance in addition to strength, and stainless steel may be employed in marine environments, in corrosive atmospheres, or in other environments where corrosion resistance may be desired. Aluminum may provide a lower weight than steel for a given structural capacity, and aluminum may be employed where weight reduction may be beneficial. Metal air conduits may be fabricated through welding, bolting, riveting, or other joining methods, and metal air conduits may be constructed from plates, sheets, tubes, structural shapes, or other metal forms.

In some embodiments, metal air conduits may be constructed from corrugated metal panels. Corrugated metal panels may comprise metal sheets that may have been formed into a corrugated pattern, which may provide increased stiffness and strength compared to flat sheets of the same thickness. Corrugated metal panels may be assembled into cylindrical or other shapes to form air conduits. The corrugations may be oriented vertically, horizontally, or at other angles depending on the structural requirements and the construction methods.

In some embodiments, metal air conduits may be constructed from metal lattice structures. Metal lattice structures may comprise frameworks of metal members that may be connected at nodes to form a three-dimensional structure. Lattice structures may provide high strength-to-weight ratios and may be employed for tall air conduits where weight reduction may be beneficial. The lattice structure may be clad with metal panels, fabric, or other materials to provide an enclosed flow path for air.

In some embodiments, an air conduit may be a material comprising a plastic. Plastics that may be employed for air conduit construction may include one or more or any combination of the following: polyethylene, or polypropylene, or polyvinyl chloride, or acrylonitrile butadiene styrene, or polycarbonate, or polyethylene terephthalate, or high-density polyethylene, or fiber-reinforced plastics, or any combination thereof. Plastic air conduits may provide corrosion resistance, may be lighter in weight than metal air conduits, and may be fabricated through molding, extrusion, welding, or other plastic fabrication methods. Plastic air conduits may be suitable for smaller air conduits, for temporary installations, for corrosive environments, or for other applications where the properties of plastics may be advantageous.

In some embodiments, plastic air conduits may be constructed from extruded plastic tubes or pipes. Extruded plastic tubes may be produced in various diameters and wall thicknesses, and multiple tubes may be joined together to form longer air conduits. The joints between tubes may be formed through welding, through mechanical couplings, through adhesive bonding, or through other joining methods.

In some embodiments, plastic air conduits may be constructed from molded plastic sections. Molded plastic sections may be produced in various shapes and sizes, and the sections may be assembled to form air conduits. The molded sections may include features such as flanges, ribs, or other structural elements that may facilitate assembly and may provide structural reinforcement.

In some embodiments, an air conduit may be a material comprising a composite. Composites that may be employed for air conduit construction may include one or more or any combination of the following: fiber-reinforced polymers, or glass fiber reinforced polymers, or carbon fiber reinforced polymers, or aramid fiber reinforced polymers, or natural fiber reinforced polymers, or metal matrix composites, or ceramic matrix composites, or any combination thereof. Composite materials may provide high strength-to-weight ratios, may be tailored to provide specific mechanical properties, and may be resistant to corrosion. Composite air conduits may be fabricated through filament winding, through layup processes, through pultrusion, through resin transfer molding, or through other composite fabrication methods.

In some embodiments, composite air conduits may be constructed from filament-wound tubes. Filament winding may comprise a process in which continuous fibers may be wound around a mandrel in a controlled pattern while being impregnated with resin. The wound fibers may be cured to form a rigid tube structure. Filament winding may produce tubes with high strength and stiffness, and the fiber orientation may be controlled to provide desired mechanical properties.

In some embodiments, composite air conduits may be constructed from pultruded sections. Pultrusion may comprise a process in which continuous fibers may be pulled through a resin bath and through a heated die to form a continuous profile. Pultruded sections may be produced in various shapes, including tubes, channels, angles, and other profiles. Pultruded sections may be assembled to form air conduits.

In some embodiments, an air conduit may be a material comprising concrete. Concrete may comprise a mixture of cement, aggregite, water, and optionally admixtures that may be cast into desired shapes and that may harden to form a rigid structure. Concrete air conduits may provide high compressive strength, may be durable, and may be constructed using established construction methods. Concrete air conduits may be reinforced with steel reinforcing bars, with prestressing tendons, with fiber reinforcement, or with other reinforcement to provide tensile strength and to control cracking.

In some embodiments, concrete air conduits may be constructed from cast-in-place concrete. Cast-in-place concrete may be placed into formwork at the construction site, and the concrete may be allowed to cure in place. Cast-in-place construction may allow complex shapes to be formed and may provide monolithic structures without joints. The formwork may be removed after the concrete has cured, or the formwork may be left in place as permanent formwork.

In some embodiments, concrete air conduits may be constructed from precast concrete sections. Precast concrete sections may be manufactured at a precast plant, transported to the construction site, and assembled to form the air conduit. Precast construction may provide quality control advantages, may reduce construction time at the site, and may allow construction to proceed in adverse weather conditions. The precast sections may be joined through grouting, through post-tensioning, through mechanical connections, or through other joining methods.

In some embodiments, concrete air conduits may be constructed using slip-form construction. Slip-form construction may comprise a process in which concrete may be continuously placed into a moving form that may travel upward as the concrete below hardens. Slip-form construction may be employed for tall, continuous structures such as towers, chimneys, and silos. Slip-form construction may provide rapid construction of tall concrete structures.

In some embodiments, an air conduit may be a material comprising ice. Ice may comprise frozen water that may be formed into structural elements for air conduit construction. Ice air conduits may be constructed in cold climate regions where ambient temperatures may be below the freezing point of water for extended periods. Ice air conduits may provide advantages including faster construction compared to conventional materials, lower material costs since water may be abundant and inexpensive, and the ability to construct temporary seasonal structures that may be rebuilt annually.

In some embodiments, ice air conduits may be constructed through spraying water in cold conditions. Water may be sprayed into cold air, and the water may freeze to form ice. The sprayed water may be directed onto forms, onto existing ice structures, or onto other surfaces to build up ice layers. The spraying may be performed in a rotating manner to build up tower walls, with the spray nozzles or the structure being rotated to provide uniform ice deposition around the circumference of the air conduit.

In some embodiments, ice air conduits may be constructed through additive manufacturing techniques. Additive manufacturing may comprise processes in which material may be added layer by layer to build up a three-dimensional structure. For ice air conduits, water may be deposited in controlled patterns and may be frozen to form each layer. The additive manufacturing process may allow complex shapes to be formed and may provide precise control over the geometry of the ice structure. The additive manufacturing of ice air conduits may enable mass-scale constructibility, as the process may be automated and may be scaled to produce large structures.

In some embodiments, ice air conduits may be constructed by flooding and freezing. Water may be flooded onto a surface or into a form, and the water may be allowed to freeze. Multiple flooding and freezing cycles may be performed to build up the thickness of the ice structure. The flooding and freezing process may be employed to construct ice walls, ice floors, or other ice structural elements.

In some embodiments, ice air conduits may be constructed from ice blocks. Ice blocks may be cut from natural ice formations, may be produced in ice-making facilities, or may be formed through other methods. The ice blocks may be stacked and may be bonded together with water that may freeze to form joints between the blocks. Ice block construction may be employed for smaller ice structures or for structures where the block construction method may be advantageous.

In some embodiments, ice air conduits may be temporary seasonal structures. The ice air conduits may be constructed during cold winter months when ambient temperatures may support ice formation and may maintain the ice in a frozen state. The ice air conduits may operate during the cold season and may melt when ambient temperatures rise above the freezing point of water. The ice air conduits may be rebuilt annually at the beginning of each cold season, and the annual rebuilding may allow improvements or modifications to be incorporated into each new construction.

In some embodiments, the annual rebuilding of ice air conduits may provide advantages including the ability to incorporate design improvements based on operational experience, the ability to relocate the air conduit if desired, and the elimination of long-term maintenance requirements since the structure may be replaced each year. The water from melted ice air conduits may be collected and may be reused for the next construction cycle.

In some embodiments, an air conduit may be a material comprising an ice composite. An ice composite may comprise ice that may be reinforced or modified with other materials to improve the mechanical properties of the ice. Ice composites may provide greater strength, greater toughness, or other improved properties compared to pure ice. Ice composite air conduits may be constructed using methods similar to those employed for pure ice air conduits, with the reinforcing materials being incorporated during the ice formation process.

In some embodiments, the ice composite may comprise pykrete. Pykrete may comprise a frozen mixture of water and sawdust, wood pulp, paper, or other cellulosic materials. Pykrete may have greater strength and toughness than pure ice, and pykrete may be more resistant to melting than pure ice. The cellulosic fibers in pykrete may provide reinforcement that may increase the tensile strength and the impact resistance of the frozen material. Pykrete may be formed by mixing water with sawdust or other cellulosic materials and freezing the mixture.

In some embodiments, the ice composite may comprise ice reinforced with synthetic fibers. Synthetic fibers that may be employed for ice reinforcement may include one or more or any combination of the following: glass fibers, or carbon fibers, or polymer fibers, or aramid fibers, or any combination thereof. The synthetic fibers may be mixed with water before freezing, may be placed in layers during ice formation, or may be incorporated through other methods. The synthetic fibers may provide reinforcement that may increase the strength and toughness of the ice composite.

In some embodiments, the ice composite may comprise ice reinforced with natural fibers. Natural fibers that may be employed for ice reinforcement may include one or more or any combination of the following: wood fibers, or plant fibers, or straw, or hay, or hemp fibers, or jute fibers, or any combination thereof. Natural fibers may be locally available in many cold climate regions and may provide a low-cost reinforcement option. The natural fibers may be mixed with water before freezing or may be incorporated through other methods.

In some embodiments, the ice composite may comprise ice with embedded structural elements. Structural elements that may be embedded in ice may include one or more or any combination of the following: ropes, or cables, or nets, or meshes, or rods, or tubes, or any combination thereof. The embedded structural elements may provide reinforcement, may provide connection points for other components, or may provide other functions. The structural elements may be positioned within forms before water is added, or the structural elements may be incorporated during the ice formation process.

In some embodiments, ice composite air conduits may provide advantages including faster construction compared to conventional materials, lower material costs, and the ability to construct temporary seasonal structures. The reinforcement in ice composites may allow thinner walls to be employed compared to pure ice, which may reduce the amount of water required for construction. The improved mechanical properties of ice composites may allow taller structures to be constructed or may allow structures to withstand greater loads.

In some embodiments, an air conduit may comprise a rigid material. A rigid material may comprise a material that may resist deformation under applied loads and that may maintain a fixed shape during operation. Rigid materials may provide structural stability, may resist wind loads, may maintain the cross-sectional shape of the air conduit, and may support the weight of the air conduit and any attached components. Rigid materials that may be employed for air conduit construction may include one or more or any combination of the following: metals, or concrete, or rigid plastics, or rigid composites, or ice, or ice composites, or any combination thereof.

In some embodiments, rigid air conduits may be self-supporting structures that may not require external support from cables, guy wires, or other tensioned elements. The rigidity of the material may provide the structural capacity to resist gravitational loads, wind loads, and other applied loads without external support. Rigid air conduits may be employed for permanent installations where long-term structural stability may be desired.

In some embodiments, an air conduit may comprise a semi-rigid material. A semi-rigid material may comprise a material that may have some flexibility but that may also provide structural support and may maintain a general shape during operation. Semi-rigid materials may deform under applied loads but may return to the original shape when the loads are removed, or semi-rigid materials may deform to a limited extent before resisting further deformation. Semi-rigid materials that may be employed for air conduit construction may include one or more or any combination of the following: semi-rigid plastics, or semi-rigid composites, or reinforced fabrics, or corrugated materials, or any combination thereof.

In some embodiments, semi-rigid air conduits may provide a balance between structural stability and flexibility. The semi-rigid material may allow the air conduit to accommodate some movement or deformation without damage, while still providing sufficient structural support for operation. Semi-rigid air conduits may be employed in applications where some flexibility may be beneficial, such as in seismic zones or in applications where thermal expansion and contraction may occur.

In some embodiments, an air conduit may comprise a flexible material. A flexible material may comprise a material that may deform readily under applied loads and that may not maintain a fixed shape without external support. Flexible materials may be employed for air conduits that may be supported by internal pressure, by external frameworks, or by other support mechanisms. Flexible materials that may be employed for air conduit construction may include one or more or any combination of the following: fabrics, or membranes, or films, or flexible plastics, or elastomers, or any combination thereof.

In some embodiments, flexible air conduits may be inflatable structures. Inflatable air conduits may comprise flexible membranes that may be inflated with air or other gas to provide structural support. The internal pressure may maintain the shape of the air conduit and may provide resistance to external loads. Inflatable air conduits may be deflated for storage or transport and may be inflated for operation. Inflatable air conduits may provide advantages including low weight, compact storage, rapid deployment, and the ability to be collapsed in response to hazardous conditions.

In some embodiments, flexible air conduits may be tensioned membrane structures. Tensioned membrane structures may comprise flexible membranes that may be stretched over frameworks or that may be tensioned by cables to provide structural form. The tension in the membrane may provide resistance to applied loads and may maintain the shape of the air conduit. Tensioned membrane structures may provide lightweight, architecturally expressive air conduits.

In some embodiments, an air conduit may comprise a combination of rigid materials, semi-rigid materials, and flexible materials. Different portions of the air conduit may be constructed from different materials depending on the structural requirements, the environmental conditions, and other factors. A lower portion of the air conduit may be constructed from rigid materials to provide a stable foundation, while an upper portion may be constructed from flexible materials to reduce weight and to allow the air conduit to be collapsed. Transitions between different materials may be designed to provide smooth load transfer and to accommodate differential movement.

In some embodiments, the selection of materials for the air conduit may be based on the intended operational life of the air conduit. Permanent air conduits that may be intended to operate for decades may be constructed from durable materials such as concrete, steel, or corrosion-resistant metals. Temporary air conduits that may be intended to operate for a single season may be constructed from ice, ice composites, or other materials that may be readily available and that may not require long-term durability. The material selection may balance the initial construction cost against the expected operational life and the maintenance requirements.

In some embodiments, the selection of materials for the air conduit may be based on the environmental conditions at the installation site. Air conduits in marine environments may be constructed from corrosion-resistant materials such as stainless steel, aluminum, or composites. Air conduits in cold climate regions may be constructed from materials that may perform well at low temperatures, such as metals, concrete, or ice. Air conduits in seismic zones may be constructed from materials that may accommodate seismic movements, such as ductile metals or flexible materials.

In some embodiments, the selection of materials for the air conduit may be based on the availability of materials and construction resources at the installation site. In remote locations, materials that may be locally available may be preferred to reduce transportation costs. In cold climate regions with abundant water resources, ice or ice composite construction may be preferred due to the availability of water and the cold temperatures that may support ice formation. In locations with established construction industries, conventional materials such as steel or concrete may be preferred due to the availability of skilled labor and construction equipment.

In some embodiments, the air conduit may be constructed using a combination of materials to optimize performance and cost. A structural framework may be constructed from steel or concrete, and the framework may be clad with lighter materials such as metal panels, plastic panels, or fabric. The structural framework may provide the primary load-bearing capacity, while the cladding may provide the enclosed flow path for air and may provide weather protection. The combination of materials may provide a cost-effective solution that may meet the structural and functional requirements of the air conduit.

In some embodiments, an air conduit may comprise a fixed structure. A fixed structure may comprise a structure that may be permanently installed at a location and that may not be intended to be moved during the operational life of the structure. Fixed structures may be anchored to foundations, may be attached to geographic features, or may be otherwise secured in place. Fixed structures may provide long-term operational capability at a specific location and may be designed for the environmental conditions and operational requirements of that location. Fixed air conduit structures may be constructed from durable materials such as concrete, steel, or other materials that may provide long-term structural performance. The foundations for fixed structures may be designed to transfer structural loads to the ground and may comprise spread footings, mat foundations, pile foundations, drilled shafts, or other foundation types depending on soil conditions and structural requirements. Fixed structures may be employed for permanent installations where the air conduit may be intended to operate for years or decades at the same location.

In some embodiments, a system may comprise an airflow conduit that comprises a fixed structure. The fixed structure may be configured to remain in place throughout the operational life of the system, and the fixed structure may be designed to withstand the environmental loads, operational loads, and other loads that may be expected at the installation location. The fixed structure may provide a stable platform for the thermal exchange zone, the flow control elements, the power generation units, and other components of the system.

In some embodiments, fixed air conduit structures may be integrated with other fixed infrastructure. The air conduit may be constructed as part of a building, a tower, a smokestack, a chimney, or other fixed structure. The integration with other fixed infrastructure may provide structural support for the air conduit, may reduce construction costs, or may provide other benefits. The fixed air conduit may share foundations, structural elements, or other components with the other fixed infrastructure.

In some embodiments, an air conduit may comprise a semi-mobile structure. A semi-mobile structure may comprise a structure that may be installed at a location for an extended period but that may be relocated to a different location when desired. Semi-mobile structures may be designed to be disassembled, transported, and reassembled at a new location. Semi-mobile structures may provide flexibility to relocate the air conduit in response to changing conditions, changing requirements, or other factors. Semi-mobile air conduit structures may be constructed from materials and using construction methods that may facilitate disassembly and reassembly, such as bolted connections, modular components, or prefabricated sections.

In some embodiments, a system may comprise an airflow conduit that comprises a semi-mobile structure. The semi-mobile structure may be configured to be relocated from a first location to a second location when relocation may be desired. The semi-mobile structure may be designed with connections, joints, and components that may be disassembled without damage and that may be reassembled at the new location. The semi-mobile structure may provide operational capability at each location where the structure may be installed.

In some embodiments, semi-mobile air conduit structures may be relocated in response to seasonal variations. The air conduit may be installed at a first location during a first season and may be relocated to a second location during a second season. The relocation may allow the air conduit to operate at locations where conditions may be favorable for heat transfer and power generation during different seasons. The semi-mobile structure may be designed to be relocated multiple times during the operational life of the structure.

In some embodiments, semi-mobile air conduit structures may be relocated in response to changes in water availability. The air conduit may be installed at a first location where water may be available, and the air conduit may be relocated to a second location when water availability at the first location may decrease or when water availability at the second location may increase. The relocation may allow the air conduit to operate at locations where water resources may be available for heat transfer processes.

In some embodiments, an air conduit may comprise a mobile structure. A mobile structure may comprise a structure that may be moved from one location to another without disassembly. Mobile structures may be mounted on wheels, tracks, skids, floats, or other mobility elements that may allow the structure to be transported while assembled. Mobile structures may provide rapid deployment capability and may allow the air conduit to be repositioned frequently in response to changing conditions or requirements. Mobile air conduit structures may be smaller in size than fixed or semi-mobile structures due to the constraints of transportation while assembled.

In some embodiments, a system may comprise an airflow conduit that comprises a mobile structure. The mobile structure may be configured to be moved from a first location to a second location while the structure remains assembled. The mobile structure may be mounted on a vehicle, a trailer, a barge, a ship, or other mobile platform that may transport the structure between locations. The mobile structure may be deployed for operation at each location and may be moved to a new location when desired.

In some embodiments, mobile air conduit structures may be mounted on wheeled vehicles. The wheeled vehicle may comprise a truck, a trailer, or other wheeled platform that may transport the air conduit on roads or other surfaces. The air conduit may be erected for operation at a location and may be lowered or collapsed for transport to a new location. The wheeled vehicle may provide rapid mobility on road networks.

In some embodiments, mobile air conduit structures may be mounted on tracked vehicles. The tracked vehicle may comprise a crawler, a tracked carrier, or other tracked platform that may transport the air conduit on unpaved surfaces, on ice, on snow, or on other surfaces where wheeled vehicles may not be suitable. The tracked vehicle may provide mobility in remote locations or in cold climate regions where road infrastructure may be limited.

In some embodiments, mobile air conduit structures may be mounted on floating platforms. The floating platform may comprise a barge, a ship, a pontoon, or other floating structure that may transport the air conduit on water. The air conduit may be operated while the floating platform is stationary or while the floating platform is in motion. The floating platform may provide mobility on oceans, seas, lakes, rivers, or other bodies of water.

In some embodiments, mobile air conduit structures may be mounted on skids. The skids may comprise runners or slides that may allow the air conduit to be dragged across surfaces. The skids may be suitable for movement on ice, on snow, or on other low-friction surfaces. The air conduit may be towed by vehicles, by winches, or by other towing mechanisms.

In some embodiments, an air conduit may comprise a modular structure. A modular structure may comprise a structure that may be assembled from standardized modules or components that may be manufactured separately and that may be combined to form the complete structure. Modular structures may provide flexibility in the size and configuration of the air conduit, may facilitate construction by allowing modules to be manufactured in controlled factory conditions, and may allow damaged modules to be replaced without replacing the entire structure. Modular air conduit structures may be assembled from modules that may be transported to the installation site and that may be connected together using standardized connections.

In some embodiments, a system may comprise an airflow conduit that comprises a modular structure. The modular structure may be configured to be assembled from a plurality of modules, and the number of modules may be selected based on the desired height, the desired cross-sectional area, or other requirements of the air conduit. The modules may be manufactured at a factory location and may be transported to the installation site for assembly. The modular structure may be expanded by adding additional modules or may be reduced by removing modules.

In some embodiments, modular air conduit structures may comprise vertical modules that may be stacked to form the height of the air conduit. Each vertical module may comprise a section of the air conduit wall, and the vertical modules may be connected end-to-end to form the complete height of the air conduit. The vertical modules may have standardized connection interfaces that may allow modules of different heights to be combined. The height of the air conduit may be adjusted by adding or removing vertical modules.

In some embodiments, modular air conduit structures may comprise circumferential modules that may be assembled to form the cross-section of the air conduit. Each circumferential module may comprise a segment of the air conduit wall, and the circumferential modules may be connected side-by-side to form the complete circumference of the air conduit. The circumferential modules may have standardized connection interfaces that may allow modules to be combined to form air conduits of different diameters. The cross-sectional area of the air conduit may be adjusted by using different numbers of circumferential modules or by using modules of different sizes.

In some embodiments, modular air conduit structures may comprise functional modules that may provide specific functions within the air conduit. Functional modules may include one or more or any combination of the following: inlet modules, or outlet modules, or thermal exchange modules, or turbine modules, or flow control modules, or access modules, or instrumentation modules, or any combination thereof. The functional modules may be integrated into the modular structure at appropriate locations to provide the desired functionality. The functional modules may be replaced or upgraded without replacing the entire air conduit structure.

In some embodiments, modular air conduit structures may be prefabricated. Prefabrication may comprise the manufacturing of modules at a factory location under controlled conditions, followed by transportation of the modules to the installation site for assembly. Prefabrication may provide quality control advantages, may reduce construction time at the installation site, and may allow construction to proceed in adverse weather conditions. The prefabricated modules may be transported by truck, by rail, by ship, by barge, or by other transportation modes depending on the size of the modules and the location of the installation site.

In some embodiments, an air conduit may comprise a collapsible structure. A collapsible structure may comprise a structure that may be reduced in size, height, or volume through folding, telescoping, deflating, retracting, or other mechanisms. The collapsible structure may be configured to be collapsed in response to various conditions or instructions, and the collapsible structure may be expanded to an operational configuration when conditions permit. Collapsible air conduit structures may provide protection from hazardous conditions by reducing the exposure of the structure to wind loads, ice loads, or other hazards when the structure is collapsed.

In some embodiments, a system may comprise an airflow conduit that comprises a collapsible structure. The collapsible structure may be configured to be collapsed from an operational configuration to a collapsed configuration, and the collapsible structure may be configured to be expanded from the collapsed configuration to the operational configuration. The collapsible structure may be collapsed in response to instructions, in response to conditions, or in response to current or predicted high wind conditions or hazardous conditions.

In some embodiments, collapsible air conduit structures may be collapsed through telescoping. A telescoping air conduit may comprise multiple sections that may slide within one another to reduce the overall height of the air conduit. The telescoping sections may be extended for normal operation and may be retracted for collapse. The telescoping mechanism may be powered by motors, hydraulic cylinders, pneumatic cylinders, cables, or other actuators. The telescoping sections may be guided by rails, tracks, or other guide elements that may maintain alignment during extension and retraction.

In some embodiments, collapsible air conduit structures may be collapsed through folding. A folding air conduit may comprise sections that may be hinged together and that may fold to reduce the overall height or footprint of the air conduit. The folding sections may be unfolded for normal operation and may be folded for collapse. The folding mechanism may be powered by motors, hydraulic cylinders, cables, or other actuators. The hinges may be designed to provide smooth folding motion and to support the weight of the sections during folding and unfolding.

In some embodiments, collapsible air conduit structures may be collapsed through deflation. A deflatable air conduit may comprise an inflatable structure that may be inflated for normal operation and may be deflated for collapse. The inflatable structure may be supported by internal air pressure, and the removal of air pressure may cause the structure to collapse. The deflation may be performed by opening valves, by activating pumps, or by other mechanisms. The deflated structure may be stored in a compact configuration until re-inflation may be desired.

In some embodiments, collapsible air conduit structures may be collapsed through lowering. A lowerable air conduit may comprise a structure that may be raised for normal operation and may be lowered for collapse. The lowering may be performed by cables, by hydraulic systems, by mechanical systems, or by other mechanisms. The lowered air conduit may rest on the ground, on a support structure, or in another protected position. The lowering mechanism may be designed to control the rate of lowering and to provide safe lowering under various conditions.

In some embodiments, the air conduit may be at least partially collapsed in response to instructions. Instructions may comprise commands, signals, or directives that may be issued by operators, control systems, or other sources. The instructions may be transmitted to actuators, motors, or other mechanisms that may effect the collapse of the air conduit. The instructions may be issued manually by human operators, may be issued automatically by control systems, or may be issued remotely through communication systems. The instructions may specify the degree of collapse, the rate of collapse, or other parameters of the collapse operation.

In some embodiments, the air conduit may be at least partially collapsed in response to conditions. Conditions may comprise environmental conditions, operational conditions, system conditions, or other factors that may affect the operation or safety of the air conduit. The air conduit may be configured to collapse automatically in response to certain conditions, or the air conduit may be collapsed by operators or control systems in response to detected or predicted conditions. Sensors may be employed to detect conditions, and control systems may compare detected conditions to thresholds or criteria to determine whether collapse may be warranted.

In some embodiments, the air conduit may be at least partially collapsed in response to current or predicted high wind conditions or hazardous conditions. High wind conditions may comprise wind velocities that may exceed safe operating limits for the air conduit, that may cause excessive structural loads on the air conduit, or that may otherwise pose risks to the air conduit or to personnel. Hazardous conditions may comprise conditions that may pose risks to the air conduit, to personnel, to equipment, or to the surrounding environment. The air conduit may be collapsed to reduce the wind loads on the structure and to prevent damage when high wind conditions or hazardous conditions may be present or may be predicted.

In some embodiments, high wind conditions may be detected through wind sensors, anemometers, or other wind measurement devices. The wind measurements may be compared to thresholds that may represent safe operating limits for the air conduit. When wind velocities exceed the thresholds, the air conduit may be collapsed to reduce the exposure of the structure to wind loads. The thresholds may be set based on the structural capacity of the air conduit, the configuration of the air conduit, the materials of construction, or other factors.

In some embodiments, predicted high wind conditions may be obtained from weather forecasts, weather prediction models, or other sources of weather information. The predicted wind conditions may be compared to thresholds, and the air conduit may be collapsed in advance of the predicted high wind conditions. Collapsing the air conduit in advance of predicted high wind conditions may provide time for the collapse operation to be completed before the high winds arrive, which may reduce the risk of damage during the collapse operation.

In some embodiments, hazardous conditions may include one or more or any combination of the following: severe storms, or hurricanes, or typhoons, or tornadoes, or blizzards, or ice storms, or earthquakes, or tsunamis, or volcanic activity, or wildfires, or lightning, or any combination thereof. The air conduit may be collapsed in response to current hazardous conditions or in response to predicted hazardous conditions to protect the air conduit and to reduce risks to personnel and equipment.

In some embodiments, an air conduit may comprise an expandable structure. An expandable structure may comprise a structure that may be increased in size, height, or volume through unfolding, extending, inflating, or other mechanisms. The expandable structure may be configured to be expanded from a compact configuration to an operational configuration. Expandable air conduit structures may be transported or stored in a compact configuration and may be expanded for operation at the installation site. Expandable structures may provide advantages including reduced transportation volume, rapid deployment, and the ability to adjust the size of the air conduit based on operational requirements.

In some embodiments, a system may comprise an airflow conduit that comprises an expandable structure. The expandable structure may be configured to be expanded from a compact configuration to an operational configuration, and the expandable structure may be configured to be contracted from the operational configuration to the compact configuration. The expandable structure may be expanded in response to instructions from operators or control systems, and the expandable structure may be contracted in response to instructions or conditions.

In some embodiments, expandable air conduit structures may be expanded through telescoping. A telescoping air conduit may comprise multiple sections that may slide relative to one another to increase the overall height of the air conduit. The telescoping sections may be retracted for transport or storage and may be extended for operation. The telescoping mechanism may be powered by motors, hydraulic cylinders, pneumatic cylinders, cables, or other actuators.

In some embodiments, expandable air conduit structures may be expanded through unfolding. An unfolding air conduit may comprise sections that may be hinged together and that may unfold to increase the overall height or footprint of the air conduit. The folding sections may be folded for transport or storage and may be unfolded for operation. The unfolding mechanism may be powered by motors, hydraulic cylinders, cables, springs, or other actuators.

In some embodiments, expandable air conduit structures may be expanded through inflation. An inflatable air conduit may comprise a flexible membrane that may be inflated with air or other gas to provide structural support and to achieve the operational configuration. The inflatable structure may be deflated for transport or storage and may be inflated for operation. The inflation may be performed by blowers, compressors, or other air supply equipment.

In some embodiments, expandable air conduit structures may be expanded through assembly of modular components. The modular components may be transported separately and may be assembled at the installation site to form the expanded air conduit. The assembly may involve connecting modules together using bolted connections, latching connections, or other connection mechanisms. The expanded air conduit may be disassembled into the modular components for transport to a new location or for storage.

In some embodiments, an air conduit may comprise an inflatable structure. An inflatable structure may comprise a structure that may be supported by internal air pressure or by pressure from another gas. The inflatable structure may comprise flexible membranes that may be inflated to provide structural form and rigidity. Inflatable air conduit structures may provide advantages including low weight, compact storage when deflated, rapid deployment through inflation, and the ability to be collapsed through deflation in response to hazardous conditions.

In some embodiments, a system may comprise an airflow conduit that comprises an inflatable structure. The inflatable structure may be configured to be inflated from a deflated configuration to an inflated operational configuration. The inflatable structure may be maintained in the inflated configuration by continuous air supply, by sealed chambers that may retain air pressure, or by other pressure maintenance mechanisms. The inflatable structure may be deflated for storage, for transport, or in response to hazardous conditions.

In some embodiments, inflatable air conduit structures may comprise single-wall inflatable membranes. The single-wall membrane may be inflated to form the shape of the air conduit, and the internal pressure may provide structural support. The single-wall membrane may be constructed from coated fabrics, polymer films, or other flexible materials that may be airtight and that may withstand the internal pressure.

In some embodiments, inflatable air conduit structures may comprise double-wall inflatable membranes. The double-wall membrane may comprise an inner wall and an outer wall with a pressurized space between the walls. The pressurized space may provide structural rigidity, and the inner wall may define the flow path for air through the air conduit. The double-wall construction may provide greater structural capacity than single-wall construction and may provide thermal insulation between the interior of the air conduit and the exterior environment.

In some embodiments, inflatable air conduit structures may comprise inflatable tubes or beams that may provide structural support for membrane panels. The inflatable tubes or beams may be inflated to provide a rigid framework, and the membrane panels may be attached to the framework to form the enclosed flow path for air. The inflatable tubes or beams may be arranged in various configurations to provide the desired structural form.

In some embodiments, an air conduit may comprise a temporary structure. A temporary structure may comprise a structure that may be intended to be in place for a limited period of time and that may be removed or replaced after the intended period of use. Temporary structures may be employed for seasonal operations, for construction projects, for emergency response, for testing and evaluation, or for other applications where permanent structures may not be warranted. Temporary air conduit structures may be constructed from materials and using methods that may facilitate rapid construction and removal, and temporary structures may not require the same level of durability as permanent structures.

In some embodiments, a system may comprise an airflow conduit that comprises a temporary structure. The temporary structure may be configured to be installed for a limited period of time and to be removed after the intended period of use. The temporary structure may be designed for rapid construction and removal, and the temporary structure may be reused at the same location in subsequent periods or may be relocated to different locations.

In some embodiments, temporary air conduit structures may be employed for seasonal operations. The temporary structure may be installed at the beginning of a season when conditions may be favorable for operation and may be removed at the end of the season when conditions may no longer be favorable. The temporary structure may be stored during the off-season and may be reinstalled at the beginning of the next favorable season. Seasonal temporary structures may be employed in cold climate regions where air conduits may operate during winter months when temperature differences between water and air may be greatest.

In some embodiments, temporary air conduit structures may be constructed from ice or ice composites. Ice air conduits may be constructed during cold winter months and may melt when ambient temperatures rise above the freezing point of water. The ice air conduits may be rebuilt annually at the beginning of each cold season. The annual rebuilding may allow improvements or modifications to be incorporated into each new construction, and the melting of the ice at the end of the season may eliminate the need for demolition or removal.

In some embodiments, temporary air conduit structures may be constructed from prefabricated components that may be assembled and disassembled rapidly. The prefabricated components may be transported to the installation site, assembled to form the air conduit, operated for the intended period, disassembled, and transported away from the site. The prefabricated components may be reused for multiple temporary installations.

In some embodiments, an air conduit may comprise a semi-permanent structure. A semi-permanent structure may comprise a structure that may be intended to be in place for an extended period of time but that may not be intended to be permanent. Semi-permanent structures may be employed for operations that may continue for multiple years but that may eventually be relocated or removed. Semi-permanent air conduit structures may be constructed from durable materials that may provide extended service life, but the structures may be designed to be disassembled or removed when the intended period of use may be completed.

In some embodiments, a system may comprise an airflow conduit that comprises a semi-permanent structure. The semi-permanent structure may be configured to be installed for an extended period of time, which may range from multiple years to multiple decades. The semi-permanent structure may be designed with consideration for eventual removal or relocation, and the semi-permanent structure may employ construction methods that may facilitate disassembly.

In some embodiments, semi-permanent air conduit structures may be employed for operations at locations where the long-term viability of operations may be uncertain. The semi-permanent structure may provide operational capability for an extended period while preserving the option to relocate or remove the structure if conditions may change. The semi-permanent structure may be constructed from materials that may provide durability for the expected period of use without the additional cost of materials that may provide durability for permanent installations.

In some embodiments, semi-permanent air conduit structures may be employed for operations that may be expected to continue until a resource may be depleted or until conditions may change. The semi-permanent structure may be designed for the expected duration of operations, and the structure may be removed when operations may be concluded. The removal of the semi-permanent structure may allow the site to be restored to a pre-construction condition or to be repurposed for other uses.

In some embodiments, the selection of structure type for an air conduit may be based on the intended operational life, the site conditions, the operational requirements, the cost considerations, or any combination of such factors. Fixed structures may be selected for permanent installations where long-term operational capability may be desired. Semi-mobile structures may be selected for installations where relocation may be anticipated. Mobile structures may be selected for applications requiring frequent repositioning. Modular structures may be selected for applications requiring flexibility in size or configuration. Collapsible structures may be selected for applications where protection from hazardous conditions may be desired. Expandable structures may be selected for applications requiring compact transport or storage. Inflatable structures may be selected for applications requiring rapid deployment and low weight. Temporary structures may be selected for seasonal or short-term operations. Semi-permanent structures may be selected for extended operations with eventual removal anticipated.

In some embodiments, an air conduit may comprise a retrofit of a pre-existing structure. A retrofit may comprise the modification, adaptation, conversion, or repurposing of an existing structure to serve as an air conduit for heat transfer processes, power generation, or other applications described herein. Retrofitting pre-existing structures may provide advantages including reduced construction costs compared to new construction, reduced construction time, utilization of existing foundations and structural elements, and repurposing of structures that may otherwise be underutilized or abandoned. Pre-existing structures that may be retrofitted to serve as air conduits may include one or more or any combination of the following: smokestacks, or chimneys, or buildings, or towers, or wind turbines, or oil and gas structures, or ships, or offshore structures, or any combination thereof.

In some embodiments, a process may comprise an air conduit that comprises a retrofit of a pre-existing structure. The pre-existing structure may be modified to provide an enclosed or partially enclosed passage through which air may flow from a lower elevation to a higher elevation. The retrofit may involve the installation of thermal exchange zones, flow control elements, power generation units, or other components within or adjacent to the pre-existing structure. The retrofit may involve modifications to the interior surfaces of the pre-existing structure to provide smooth flow paths for air, to reduce flow resistance, or to accommodate the installation of components.

In some embodiments, a system may comprise an airflow conduit that comprises a retrofit of a pre-existing structure. The pre-existing structure may be adapted to serve as the airflow conduit, and the system may further comprise a thermal exchange zone configured to transfer heat from a fluid to air, generating an upward airflow within the airflow conduit. The system may further comprise a flow control element fluidly connected to the airflow conduit, wherein the flow control element may be configured to adjust the airflow.

In some embodiments, the retrofit of a pre-existing structure may involve structural modifications to the pre-existing structure. Structural modifications may include one or more or any combination of the following: reinforcement of existing structural elements, or addition of new structural elements, or removal of obstructions within the structure, or modification of openings in the structure, or addition of new openings in the structure, or sealing of existing openings, or any combination thereof. The structural modifications may be designed to accommodate the loads associated with airflow, thermal exchange equipment, power generation equipment, or other components of the retrofitted system.

In some embodiments, the retrofit of a pre-existing structure may involve the installation of liners or coatings on interior surfaces of the pre-existing structure. Liners or coatings may be installed to provide smooth flow surfaces, to reduce flow resistance, to provide corrosion protection, to provide thermal insulation, or to achieve other objectives. Liners may comprise metal liners, plastic liners, composite liners, concrete liners, or other liner materials. Coatings may comprise paint coatings, epoxy coatings, polymer coatings, ceramic coatings, or other coating materials.

In some embodiments, the retrofit of a pre-existing structure may involve the installation of inlet structures at a lower elevation of the pre-existing structure. The inlet structures may provide openings through which air may enter the air conduit, and the inlet structures may be configured to direct airflow into the interior of the pre-existing structure. The inlet structures may include flow control elements such as shutters, dampers, louvers, or vanes that may be configured to adjust the airflow entering the air conduit.

In some embodiments, the retrofit of a pre-existing structure may involve the installation of outlet structures at a higher elevation of the pre-existing structure. The outlet structures may provide openings through which air may exit the air conduit, and the outlet structures may be configured to direct airflow out of the interior of the pre-existing structure. The outlet structures may include flow control elements, weather protection features, or other components.

In some embodiments, an air conduit may comprise a retrofit of a smokestack. A smokestack may comprise a tall vertical structure that may have been constructed to discharge exhaust gases, smoke, or other emissions from industrial processes, power generation facilities, or other sources. Smokestacks may be constructed from concrete, steel, brick, or other materials, and smokestacks may have heights ranging from approximately 10 meters to approximately 400 meters or more. Smokestacks may provide pre-existing vertical conduits that may be retrofitted to serve as air conduits for heat transfer processes and power generation.

In some embodiments, a process may comprise an air conduit that comprises a retrofit of a smokestack. The smokestack may be modified to receive air at a lower elevation, to transfer heat from a fluid to the air within or adjacent to the smokestack, and to discharge the warmed air at a higher elevation. The retrofit may involve the installation of air inlets at or near the base of the smokestack, the installation of thermal exchange equipment within or adjacent to the smokestack, and the installation of power generation equipment such as air turbines within the smokestack or at the inlet or outlet of the smokestack.

In some embodiments, a system may comprise an airflow conduit that comprises a retrofit of a smokestack. The smokestack may provide the vertical conduit through which warmed air may rise due to buoyancy effects. The system may further comprise a thermal exchange zone configured to transfer heat from a fluid to air, and the thermal exchange zone may be positioned within the smokestack, at the base of the smokestack, or adjacent to the smokestack. The system may further comprise flow control elements and power generation units that may be integrated with the retrofitted smokestack.

In some embodiments, smokestacks that may be retrofitted may include smokestacks from decommissioned power plants, from closed industrial facilities, from facilities that have converted to cleaner energy sources, or from other sources. The retrofit of decommissioned smokestacks may provide a productive use for structures that may otherwise be demolished or abandoned. The retrofit may extend the useful life of the smokestack structure and may provide economic benefits to the owners of the smokestack.

In some embodiments, smokestacks that may be retrofitted may include smokestacks from operating facilities. The retrofit may allow the smokestack to serve dual purposes, discharging exhaust gases during some periods and serving as an air conduit for heat transfer processes during other periods. Alternatively, the retrofit may involve the installation of a separate air conduit within the existing smokestack, with the air conduit being isolated from the exhaust gas flow path.

In some embodiments, the retrofit of a smokestack may involve the cleaning or remediation of interior surfaces of the smokestack. Smokestacks that have been used for exhaust gas discharge may have deposits, residues, or contamination on interior surfaces. The cleaning or remediation may remove such deposits, residues, or contamination to provide clean surfaces for the air conduit application. The cleaning or remediation may involve mechanical cleaning, chemical cleaning, abrasive blasting, or other cleaning methods.

In some embodiments, an air conduit may comprise a retrofit of a chimney. A chimney may comprise a vertical structure that may have been constructed to discharge combustion gases, smoke, or other emissions from heating systems, fireplaces, furnaces, boilers, or other combustion equipment. Chimneys may be constructed from brick, stone, concrete, metal, or other materials, and chimneys may have heights ranging from approximately 3 meters to approximately 100 meters or more. Chimneys may provide pre-existing vertical conduits that may be retrofitted to serve as air conduits for heat transfer processes and power generation.

In some embodiments, a process may comprise an air conduit that comprises a retrofit of a chimney. The chimney may be modified to receive air at a lower elevation, to transfer heat from a fluid to the air within or adjacent to the chimney, and to discharge the warmed air at a higher elevation. The retrofit may involve the installation of air inlets, thermal exchange equipment, flow control elements, and power generation equipment. The retrofit may be performed on chimneys of various sizes, from residential chimneys to industrial chimneys.

In some embodiments, a system may comprise an airflow conduit that comprises a retrofit of a chimney. The chimney may provide the vertical conduit through which warmed air may rise due to buoyancy effects. The system may further comprise a thermal exchange zone, flow control elements, and power generation units that may be integrated with the retrofitted chimney.

In some embodiments, chimneys that may be retrofitted may include chimneys from buildings that have converted from combustion-based heating to electric heating, heat pump heating, or other heating systems that may not require chimneys. The retrofit may provide a productive use for chimneys that may otherwise be unused. The retrofit may also include chimneys from demolished buildings where the chimney structure may remain standing, or chimneys from buildings undergoing renovation.

In some embodiments, the retrofit of a chimney may involve the installation of a liner within the existing chimney structure. The liner may provide a smooth flow surface for air, may provide structural reinforcement, or may provide isolation from the existing chimney materials. The liner may be constructed from metal, plastic, composite, or other materials, and the liner may be installed by lowering sections into the chimney from above or by assembling sections within the chimney.

In some embodiments, an air conduit may comprise a retrofit of a building. A building may comprise a structure that may have been constructed for residential, commercial, industrial, institutional, or other purposes. Buildings may have various heights, configurations, and construction types, and buildings may include interior spaces, stairwells, elevator shafts, atria, or other vertical passages that may be retrofitted to serve as air conduits. The retrofit of a building may involve the conversion of existing vertical passages within the building to serve as air conduits, or the retrofit may involve the construction of new air conduits within or adjacent to the building.

In some embodiments, a process may comprise an air conduit that comprises a retrofit of a building. The building may be modified to provide a vertical passage through which air may flow from a lower elevation to a higher elevation. The retrofit may involve the conversion of an existing stairwell, elevator shaft, atrium, or other vertical space within the building to serve as the air conduit. Alternatively, the retrofit may involve the construction of a new vertical conduit within the building or attached to the exterior of the building.

In some embodiments, a system may comprise an airflow conduit that comprises a retrofit of a building. The building may provide structural support for the airflow conduit, and the airflow conduit may be integrated with the building structure. The system may further comprise a thermal exchange zone, flow control elements, and power generation units that may be integrated with the retrofitted building.

In some embodiments, buildings that may be retrofitted may include abandoned buildings, underutilized buildings, buildings undergoing renovation, or buildings where the retrofit may provide additional functionality. The retrofit may provide a productive use for vertical spaces within buildings that may otherwise be unused or underutilized. The retrofit may also provide power generation capability for the building, which may reduce the building's reliance on external power sources.

In some embodiments, the retrofit of a building may involve the installation of air inlets at a lower level of the building and air outlets at a higher level of the building. The air inlets and outlets may be positioned in exterior walls, in roofs, or in other locations that may provide access to ambient air. The air inlets and outlets may include flow control elements that may be configured to adjust the airflow through the building.

In some embodiments, the retrofit of a building may involve the sealing of openings between the air conduit and occupied spaces within the building. The sealing may prevent air from the air conduit from entering occupied spaces and may prevent air from occupied spaces from entering the air conduit. The sealing may be achieved through the installation of walls, doors, dampers, or other barriers.

In some embodiments, an air conduit may comprise a retrofit of a tower. A tower may comprise a tall structure that may have been constructed for various purposes including communication, observation, water storage, cooling, or other functions. Towers may include communication towers, observation towers, water towers, cooling towers, transmission towers, or other tower types. Towers may be constructed from steel, concrete, wood, or other materials, and towers may have heights ranging from approximately 10 meters to approximately 600 meters or more. Towers may provide pre-existing vertical structures that may be retrofitted to serve as air conduits for heat transfer processes and power generation.

In some embodiments, a process may comprise an air conduit that comprises a retrofit of a tower. The tower may be modified to provide an enclosed or partially enclosed passage through which air may flow from a lower elevation to a higher elevation. The retrofit may involve the installation of enclosure panels, liners, or other elements to create the air conduit within or around the existing tower structure. The retrofit may also involve the installation of thermal exchange equipment, flow control elements, and power generation equipment.

In some embodiments, a system may comprise an airflow conduit that comprises a retrofit of a tower. The tower may provide structural support for the airflow conduit, and the airflow conduit may be integrated with or attached to the tower structure. The system may further comprise a thermal exchange zone, flow control elements, and power generation units that may be integrated with the retrofitted tower.

In some embodiments, communication towers may be retrofitted to serve as air conduits. Communication towers may include radio towers, television towers, cellular towers, microwave towers, or other towers that may support communication equipment. The retrofit may involve the installation of an air conduit around or within the communication tower structure while maintaining the communication function of the tower. The retrofit may provide an additional revenue stream for tower owners through power generation.

In some embodiments, cooling towers may be retrofitted to serve as air conduits for heat transfer processes described herein. Cooling towers may comprise structures that may have been constructed to reject heat from industrial processes, power plants, or other facilities. The retrofit may involve the modification of the cooling tower to transfer heat from a fluid comprising water to air using the methods described herein, and to harness the resulting airflow for power generation. The retrofit may involve the installation of thermal exchange equipment, flow control elements, and power generation equipment within or adjacent to the cooling tower.

In some embodiments, water towers may be retrofitted to serve as air conduits. Water towers may comprise elevated tanks that may store water for municipal water systems, fire protection systems, or other purposes. The retrofit may involve the installation of an air conduit within the support structure of the water tower, or the retrofit may involve the conversion of a decommissioned water tower to serve as an air conduit. The elevated position of water towers may provide a height advantage for the air conduit.

In some embodiments, an air conduit may comprise a retrofit of a wind turbine. A wind turbine may comprise a structure that may have been constructed to generate electrical power from wind energy. Wind turbines may include horizontal axis wind turbines, vertical axis wind turbines, or other wind turbine configurations. Wind turbines may comprise towers that support nacelles and rotors, and the towers may have heights ranging from approximately 30 meters to approximately 150 meters or more. Wind turbine towers may provide pre-existing vertical structures that may be retrofitted to serve as air conduits for heat transfer processes and power generation.

In some embodiments, a process may comprise an air conduit that comprises a retrofit of a wind turbine. The wind turbine tower may be modified to provide an enclosed passage through which air may flow from a lower elevation to a higher elevation. The retrofit may involve the installation of air inlets at or near the base of the tower, the installation of thermal exchange equipment within or adjacent to the tower, and the installation of air turbines or other power generation equipment within the tower. The retrofit may allow the wind turbine structure to generate power from both wind energy and from heat transfer processes.

In some embodiments, a system may comprise an airflow conduit that comprises a retrofit of a wind turbine. The wind turbine tower may provide the vertical conduit through which warmed air may rise due to buoyancy effects. The system may further comprise a thermal exchange zone, flow control elements, and power generation units that may be integrated with the retrofitted wind turbine.

In some embodiments, wind turbines that may be retrofitted may include decommissioned wind turbines, wind turbines at the end of their operational life, wind turbines in locations where wind resources may be insufficient for economical wind power generation, or wind turbines that may benefit from supplemental power generation capability. The retrofit may extend the useful life of wind turbine structures and may provide power generation capability in conditions where wind power generation may be limited.

In some embodiments, the retrofit of a wind turbine may involve the installation of an air conduit within the existing wind turbine tower. The wind turbine tower may be a tubular steel tower, a lattice tower, or a concrete tower, and the retrofit may be adapted to the specific tower type. The air conduit may be installed as a liner within the tower, or the existing tower interior may serve as the air conduit with modifications to provide air inlets and outlets.

In some embodiments, the retrofit of a wind turbine may allow the wind turbine to operate in a hybrid mode. In the hybrid mode, the wind turbine may generate power from wind energy when wind conditions may be favorable, and the wind turbine may generate power from heat transfer processes when wind conditions may be unfavorable or when additional power generation may be desired. The hybrid operation may increase the capacity factor of the wind turbine installation and may provide more consistent power generation.

In some embodiments, an air conduit may comprise a retrofit of an oil and gas structure. An oil and gas structure may comprise a structure that may have been constructed for the exploration, production, processing, storage, or transportation of oil, natural gas, or other hydrocarbons. Oil and gas structures may include drilling rigs, production platforms, processing facilities, storage tanks, pipelines, flare stacks, or other structures associated with oil and gas operations. Oil and gas structures may provide pre-existing structures that may be retrofitted to serve as air conduits for heat transfer processes and power generation.

In some embodiments, a process may comprise an air conduit that comprises a retrofit of an oil and gas structure. The oil and gas structure may be modified to provide a vertical passage through which air may flow from a lower elevation to a higher elevation. The retrofit may involve the conversion of existing vertical structures such as flare stacks, vent stacks, or derricks to serve as air conduits. The retrofit may also involve the installation of thermal exchange equipment, flow control elements, and power generation equipment.

In some embodiments, a system may comprise an airflow conduit that comprises a retrofit of an oil and gas structure. The oil and gas structure may provide structural support for the airflow conduit, and the airflow conduit may be integrated with or attached to the oil and gas structure. The system may further comprise a thermal exchange zone, flow control elements, and power generation units that may be integrated with the retrofitted oil and gas structure.

In some embodiments, oil and gas structures that may be retrofitted may include decommissioned structures, structures at depleted fields, structures undergoing repurposing, or structures where the retrofit may provide additional functionality. The retrofit may provide a productive use for oil and gas structures that may otherwise be decommissioned and removed. The retrofit may also provide power generation capability for oil and gas operations, which may reduce reliance on diesel generators or other power sources.

In some embodiments, flare stacks may be retrofitted to serve as air conduits. Flare stacks may comprise tall vertical structures that may have been constructed to burn excess gases from oil and gas operations. The retrofit may involve the conversion of the flare stack to serve as an air conduit when flaring may not be required, or the retrofit may involve the installation of a separate air conduit adjacent to or within the flare stack structure.

In some embodiments, drilling derricks may be retrofitted to serve as air conduits. Drilling derricks may comprise tall structures that may support drilling equipment during well drilling operations. After drilling operations may be completed, the derrick may be available for retrofit to serve as an air conduit. The retrofit may involve the installation of enclosure panels to create an enclosed air conduit within the derrick structure.

In some embodiments, an air conduit may comprise a retrofit of a ship. A ship may comprise a watercraft that may have been constructed for transportation, cargo handling, fishing, military operations, research, or other maritime purposes. Ships may include cargo ships, tankers, container ships, bulk carriers, passenger ships, fishing vessels, naval vessels, research vessels, or other ship types. Ships may have superstructures, masts, funnels, or other vertical elements that may be retrofitted to serve as air conduits for heat transfer processes and power generation.

In some embodiments, a process may comprise an air conduit that comprises a retrofit of a ship. The ship may be modified to include an air conduit that may extend from a lower elevation to a higher elevation on the ship. The retrofit may involve the installation of a new air conduit structure on the ship, or the retrofit may involve the conversion of existing vertical structures on the ship such as funnels, masts, or superstructure elements to serve as air conduits. The retrofit may also involve the installation of thermal exchange equipment, flow control elements, and power generation equipment.

In some embodiments, a system may comprise an airflow conduit that comprises a retrofit of a ship. The ship may provide a mobile platform for the airflow conduit, and the airflow conduit may be integrated with the ship structure. The system may further comprise a thermal exchange zone, flow control elements, and power generation units that may be integrated with the retrofitted ship. The ship may be positioned in locations where water resources and cold air may be available for heat transfer processes.

In some embodiments, ships that may be retrofitted may include decommissioned ships, ships undergoing conversion, ships that may benefit from supplemental power generation capability, or ships that may be repurposed for power generation operations. The retrofit may provide a productive use for ships that may otherwise be scrapped or laid up. The retrofit may also provide power generation capability for ships, which may reduce fuel consumption for onboard power generation.

In some embodiments, the retrofit of a ship may involve the installation of an air conduit in the funnel or exhaust stack of the ship. The funnel may provide a pre-existing vertical structure that may be modified to serve as an air conduit. The retrofit may involve the installation of air inlets, thermal exchange equipment, and power generation equipment within or adjacent to the funnel.

In some embodiments, the retrofit of a ship may involve the installation of a dedicated air conduit structure on the deck of the ship. The dedicated air conduit structure may be a tower, a tube, or other vertical structure that may be installed on the ship and that may provide the air conduit for heat transfer processes. The dedicated structure may be designed to be stable in marine conditions and may be configured to withstand ship motions.

In some embodiments, the retrofit of a ship may allow the ship to generate power while at anchor, while docked, or while underway. The ship may be positioned in locations where cold air and water resources may be available, and the retrofitted air conduit may generate power from heat transfer between the water and the cold air. The power generated may be used for onboard systems, may be stored in batteries, or may be transmitted to shore facilities.

In some embodiments, an air conduit may comprise a retrofit of an offshore structure. An offshore structure may comprise a structure that may have been constructed in a marine environment for oil and gas production, wind power generation, research, navigation, or other purposes. Offshore structures may include fixed platforms, jack-up platforms, semi-submersible platforms, tension leg platforms, spar platforms, floating production storage and offloading vessels, offshore wind turbine foundations, lighthouses, or other offshore structure types. Offshore structures may provide pre-existing structures in marine environments that may be retrofitted to serve as air conduits for heat transfer processes and power generation.

In some embodiments, a process or system may comprise providing an offshore structure. An offshore structure may be a structure located in a body of water away from the shoreline, and the offshore structure may support an air conduit, thermal exchange zones, power generation units, and other components of the system. Offshore structures may provide access to water sources for heat transfer operations, may be positioned in locations with favorable wind or temperature conditions, and may be connected to onshore facilities by cables, pipelines, or other connections. In some embodiments, offshore structures may be suitable for locations where land-based installations are not practical or where offshore positioning provides operational advantages.

In some embodiments, an offshore structure may comprise a ship-shaped structure. A ship-shaped structure may be a structure having a hull form similar to a ship, with a bow, a stern, and a length substantially greater than the beam. Ship-shaped structures may be self-propelled vessels capable of transit under their own power, or ship-shaped structures may be non-self-propelled barges or floating platforms that are towed or positioned by tugs or anchor systems. In some embodiments, a ship-shaped structure may provide a mobile or relocatable platform for the system, allowing the system to be moved to different locations based on seasonal conditions, operational requirements, or other factors.

In some embodiments, an offshore structure may comprise a gravity based structure. A gravity based structure may be a structure that rests on the seabed or lakebed and is held in place by the weight of the structure. Gravity based structures may be constructed from concrete, steel, or combinations thereof, and the mass of the structure may be sufficient to resist overturning, sliding, or uplift forces from waves, currents, ice, or wind. In some embodiments, a gravity based structure may be fabricated onshore or in a sheltered location and towed to the installation site, where the structure may be ballasted with water, sand, or other materials to increase the weight and stability of the structure on the seabed or lakebed.

In some embodiments, an offshore structure may comprise a piling based structure. A piling based structure may be a structure supported by piles driven into the seabed or lakebed. Piles may be steel tubes, concrete cylinders, or other elongated structural members that are driven, drilled, or jetted into the seabed or lakebed to provide foundation support. The piles may transfer loads from the structure to the underlying soil or rock, and the piles may resist vertical loads, horizontal loads, and overturning moments. In some embodiments, a piling based structure may comprise a jacket structure with a lattice framework supported by piles, or a piling based structure may comprise a monopile structure with a single large-diameter pile supporting a platform or tower.

In some embodiments, a process or system may comprise providing a pre-fabricated structure. A pre-fabricated structure may be a structure that is manufactured or assembled at a location remote from the installation site and transported to the installation site for installation. Pre-fabrication may allow construction to occur in controlled environments such as fabrication yards or factories, where weather conditions, equipment availability, and labor resources may be more favorable than at the installation site. In some embodiments, pre-fabricated structures may be transported to the installation site by barge, by ship, by truck, or by other transportation means. Pre-fabricated structures may be installed as complete units or may be assembled from pre-fabricated modules at the installation site.

In some embodiments, a process or system may comprise providing a floating structure. A floating structure may be a structure that is buoyant and floats on the surface of a body of water. Floating structures may be moored to the seabed or lakebed by anchor systems, may be dynamically positioned using thrusters, or may be allowed to drift within a defined area. In some embodiments, floating structures may rise and fall with changes in water level, may move in response to waves and currents, and may weathervane to align with wind or current directions. Floating structures may be suitable for locations with deep water where bottom-founded structures such as gravity based structures or piling based structures may not be practical or economical.

In some embodiments, a gravity based structure platform may be configured with dimensions suitable for supporting multiple towers. A gravity based structure platform may have dimensions of approximately 120 meters by 120 meters, or approximately 200 meters by 200 meters, or other dimensions selected based on the number of towers to be supported, the size of the towers, the equipment to be housed on the platform, and other operational requirements. In some embodiments, a gravity based structure platform with dimensions of approximately 120 meters by 120 meters may provide a deck area of approximately 14,400 square meters, which may accommodate multiple towers, thermal exchange zones, power generation equipment, water handling systems, ice handling systems, and support facilities. A gravity based structure platform with dimensions of approximately 200 meters by 200 meters may provide a deck area of approximately 40,000 square meters, which may accommodate a larger number of towers or larger towers, along with associated equipment and facilities.

In some embodiments, a gravity based structure platform may support multiple towers arranged in a grid pattern, a linear pattern, a clustered pattern, or another arrangement. The spacing between towers may be selected to provide adequate clearance for airflow, to allow access for maintenance and operations, and to distribute structural loads across the platform. In some embodiments, the gravity based structure platform may include foundations, pedestals, or mounting structures for each tower, and the foundations or mounting structures may be integrated with the platform structure or may be separate components attached to the platform deck.

In some embodiments, a ship-shaped vessel may be configured with dimensions suitable for supporting multiple towers. A ship-shaped vessel may have dimensions of approximately 360 meters in length by 60 meters in beam, or approximately 450 meters in length by 75 meters in beam, or other dimensions selected based on the number of towers to be supported, the size of the towers, the equipment to be housed on the vessel, and other operational requirements. In some embodiments, a ship-shaped vessel with dimensions of approximately 360 meters by 60 meters may provide a deck area of approximately 21,600 square meters, which may accommodate multiple towers arranged along the length of the vessel, along with thermal exchange zones, power generation equipment, water handling systems, ice handling systems, and support facilities. A ship-shaped vessel with dimensions of approximately 450 meters by 75 meters may provide a deck area of approximately 33,750 square meters, which may accommodate a larger number of towers or larger towers.

In some embodiments, a ship-shaped vessel may be an ice-classed vessel. An ice-classed vessel may be a vessel designed and constructed to operate in ice-covered waters. Ice-classed vessels may have strengthened hulls, reinforced bow sections, ice-resistant coatings, and propulsion systems capable of breaking through ice or maneuvering in ice-covered waters. Ice classification may be assigned by classification societies based on the vessel's ability to operate in ice of specified thickness and concentration. In some embodiments, an ice-classed ship-shaped vessel may be suitable for operation in sub-Arctic and Arctic waters where sea ice may be present during portions of the year. The ice-classed construction may allow the vessel to transit through ice to reach operating locations, to remain on station in ice-covered waters, and to withstand ice loads during operation.

In some embodiments, a ship-shaped vessel may support multiple towers arranged along the length of the vessel, across the beam of the vessel, or in a combination of arrangements. The towers may be positioned on the deck of the vessel, and the vessel structure may be reinforced to support the weight of the towers and to resist the loads imposed by wind, waves, and ice acting on the towers. In some embodiments, the ship-shaped vessel may include ballast systems that adjust the trim and stability of the vessel to compensate for the weight distribution of the towers and other equipment. The ship-shaped vessel may also include mooring systems, dynamic positioning systems, or propulsion systems that maintain the vessel's position and heading during operation.

In some embodiments, multiple towers may be arranged in a clustered configuration. A clustered configuration may be an arrangement where multiple towers are positioned in close proximity to each other, sharing common infrastructure, common water supply systems, common ice handling systems, or other common facilities. In some embodiments, a clustered configuration may reduce the total footprint of the installation, may reduce the length of piping and conduits connecting the towers to common facilities, and may allow sharing of equipment and personnel among the towers.

In some embodiments, multiple towers in a clustered configuration may each have a dedicated water-air contacting region. Each tower may have a thermal exchange zone positioned at or near the base of the tower, and each thermal exchange zone may receive water from a water supply system and may discharge ice and water to an ice handling system. The dedicated water-air contacting regions may allow each tower to operate independently, with water flow rates, spray patterns, and other operating parameters adjusted individually for each tower. In some embodiments, dedicated water-air contacting regions may provide operational flexibility, allowing individual towers to be taken out of service for maintenance while other towers continue to operate.

In some embodiments, multiple towers in a clustered configuration may share a common water-air contacting region. A common water-air contacting region may be a thermal exchange zone that serves multiple towers, with air from the common water-air contacting region flowing into two or more towers. The common water-air contacting region may be positioned centrally among the clustered towers, and air warmed by heat transfer from water in the common water-air contacting region may flow into the surrounding towers. In some embodiments, a common water-air contacting region may simplify the water supply and ice handling systems by consolidating water delivery and ice collection at a single location serving multiple towers.

In some embodiments, multiple towers in a clustered configuration may share a common basin. A common basin may be a pool or reservoir that receives water, ice, and brine from multiple towers or from a common water-air contacting region. The common basin may provide a collection volume where ice and liquid may accumulate and where separation of ice from liquid may occur. In some embodiments, the common basin may be positioned beneath or adjacent to the clustered towers, and ice and water from the thermal exchange zones may flow or fall into the common basin by gravity. The common basin may include ice removal systems, water circulation systems, and separation systems that serve all of the clustered towers.

In some embodiments, a clustered tower arrangement with a common water-air contacting region or common basin may provide economies of scale in equipment and operations. Water pumps, water treatment systems, ice conveyors, ice storage facilities, and other equipment may be sized to serve the combined capacity of the clustered towers rather than being duplicated for each individual tower. Personnel and maintenance resources may be shared among the clustered towers, reducing the total staffing and maintenance requirements for the installation. In some embodiments, the clustered arrangement may also provide redundancy, with multiple towers available to maintain power generation or other outputs if one or more towers are out of service.

In some embodiments, the arrangement of towers on a gravity based structure platform or ship-shaped vessel may be selected based on airflow considerations, structural considerations, and operational considerations. Towers may be spaced to avoid interference between the airflows of adjacent towers, to allow wind to reach all towers without obstruction, and to provide access for maintenance equipment and personnel. The structural design of the platform or vessel may distribute the loads from the towers to the foundation or hull, and the tower arrangement may be coordinated with the structural design to avoid overloading any portion of the platform or vessel. In some embodiments, the tower arrangement may also consider the routing of water supply lines, electrical cables, and other utilities that connect the towers to common facilities.

In some embodiments, the system may generate power in the Northern Hemisphere during winter and in the Southern Hemisphere during winter, with the process transported between hemispheres. The Northern Hemisphere and the Southern Hemisphere may experience opposite seasons, with winter occurring in the Northern Hemisphere from approximately December through February and winter occurring in the Southern Hemisphere from approximately June through August. In some embodiments, the system may operate in the Northern Hemisphere during Northern Hemisphere winter when cold temperatures enable efficient operation, and the system may operate in the Southern Hemisphere during Southern Hemisphere winter when cold temperatures enable efficient operation in the Southern Hemisphere.

In some embodiments, the process may be transported between hemispheres to enable year-round power generation by following winter conditions. Transporting the process between hemispheres may involve relocating mobile or semi-mobile system components from the Northern Hemisphere to the Southern Hemisphere at the end of Northern Hemisphere winter, and relocating the components from the Southern Hemisphere to the Northern Hemisphere at the end of Southern Hemisphere winter. In some embodiments, mobile system components may be mounted on ships, barges, or other vessels that may transit between hemispheres. Semi-mobile system components may be designed for disassembly, transport, and reassembly at different locations.

In some embodiments, ship-shaped vessels or floating platforms supporting the system may transit between the Northern Hemisphere and the Southern Hemisphere to follow winter conditions. A ship-shaped vessel may be self-propelled or may be towed by tugs, and the vessel may carry air conduits, thermal exchange zones, power generation units, and other system components. In some embodiments, the vessel may operate in Northern Hemisphere waters during Northern Hemisphere winter, generating power from the cold conditions available in sub-Arctic or Arctic regions. At the end of Northern Hemisphere winter, the vessel may transit to Southern Hemisphere waters, where the vessel may operate during Southern Hemisphere winter, generating power from the cold conditions available in sub-Antarctic or Antarctic regions.

In some embodiments, the hemispheric seasonal operation may enable the system to generate power for a greater portion of the year than would be possible by operating in a single hemisphere. Operating in a single hemisphere may limit power generation to the winter months when cold temperatures are available, with reduced or no power generation during summer months. In some embodiments, transporting the process between hemispheres may enable power generation during both Northern Hemisphere winter and Southern Hemisphere winter, potentially enabling power generation for approximately six months in each hemisphere and approaching year-round power generation.

In some embodiments, the power generated in each hemisphere may be delivered to local electrical grids, may be used to power onboard facilities or processes, or may be stored for later use. Power generated in the Northern Hemisphere may be delivered to Northern Hemisphere electrical grids through subsea cables, through connections at ports, or through other grid interconnection methods. Power generated in the Southern Hemisphere may be delivered to Southern Hemisphere electrical grids through similar interconnection methods. In some embodiments, power generated during hemispheric operation may be used to produce hydrogen, ammonia, or other energy carriers that may be transported and used at locations distant from the power generation site.

In some embodiments, the logistics of transporting the process between hemispheres may involve scheduling transit during transitional seasons when neither hemisphere has optimal operating conditions. Transit from the Northern Hemisphere to the Southern Hemisphere may occur during Northern Hemisphere spring and Southern Hemisphere autumn, when temperatures in both hemispheres may be moderate. Transit from the Southern Hemisphere to the Northern Hemisphere may occur during Southern Hemisphere spring and Northern Hemisphere autumn. In some embodiments, the transit time between hemispheres may range from several days to several weeks depending on the distance traveled and the speed of the vessel.

In some embodiments, fixed installations may be established in both the Northern Hemisphere and the Southern Hemisphere, with personnel, equipment, or operational resources transported between the installations rather than transporting the entire system. Fixed installations may include permanent or semi-permanent air conduits, thermal exchange zones, and power generation equipment at locations in each hemisphere. In some embodiments, personnel may relocate between Northern Hemisphere and Southern Hemisphere installations to operate the system during the respective winter seasons. Specialized equipment or consumable materials may be transported between installations as needed.

In some embodiments, the hemispheric seasonal operation may take advantage of the availability of cold climates in both hemispheres. The Northern Hemisphere may have sub-Arctic and Arctic regions including northern Canada, Alaska, Greenland, Scandinavia, and Siberia where cold winter temperatures may enable system operation. The Southern Hemisphere may have sub-Antarctic and Antarctic regions including southern South America, the Antarctic Peninsula, and Antarctic coastal areas where cold winter temperatures may enable system operation. In some embodiments, the selection of operating locations in each hemisphere may depend on the availability of water sources, the accessibility of the locations, the availability of grid interconnection or other power delivery infrastructure, and other operational factors.

In some embodiments, a process may comprise an air conduit that comprises a retrofit of an offshore structure. The offshore structure may be modified to include an air conduit that may extend from a lower elevation to a higher elevation on the structure. The retrofit may involve the installation of a new air conduit structure on the offshore structure, or the retrofit may involve the conversion of existing vertical elements of the offshore structure to serve as air conduits. The retrofit may also involve the installation of thermal exchange equipment, flow control elements, and power generation equipment.

In some embodiments, a system may comprise an airflow conduit that comprises a retrofit of an offshore structure. The offshore structure may provide a platform for the airflow conduit in a marine environment, and the airflow conduit may be integrated with the offshore structure. The system may further comprise a thermal exchange zone, flow control elements, and power generation units that may be integrated with the retrofitted offshore structure. The offshore location may provide access to seawater for heat transfer processes.

In some embodiments, offshore structures that may be retrofitted may include decommissioned oil and gas platforms, offshore wind turbine foundations, navigation structures, or other offshore structures. The retrofit may provide a productive use for offshore structures that may otherwise be decommissioned and removed. The retrofit may also provide power generation capability in offshore locations where power may be needed for offshore operations or where power may be transmitted to shore.

In some embodiments, decommissioned oil and gas platforms may be retrofitted to serve as air conduits. Decommissioned platforms may have existing infrastructure including structural elements, access systems, and utility systems that may facilitate the retrofit. The retrofit may involve the installation of air conduit structures on the platform deck, the conversion of existing vertical structures such as flare booms or derricks to serve as air conduits, or other modifications.

In some embodiments, offshore wind turbine foundations may be retrofitted to serve as air conduits. Offshore wind turbine foundations may include monopile foundations, jacket foundations, gravity-based foundations, or floating foundations. The retrofit may involve the installation of air conduit structures on the foundation, either in addition to or in place of wind turbine towers. The retrofit may allow offshore wind installations to generate power from both wind energy and from heat transfer processes.

In some embodiments, the retrofit of an offshore structure may involve the installation of thermal exchange equipment that may utilize seawater as the fluid for heat transfer. Seawater may be pumped from the surrounding marine environment to the thermal exchange zone, where heat may be transferred from the seawater to cold ambient air. The cooled seawater, ice, or brine produced through the heat transfer process may be returned to the marine environment or may be processed for other purposes.

In some embodiments, the retrofit of an offshore structure may involve considerations for marine environmental conditions. The retrofit may be designed to withstand wave loads, wind loads, current loads, ice loads, or other loads that may be present in the marine environment. The retrofit may also be designed to accommodate tidal variations, storm surges, or other changes in water level that may occur at the offshore location.

In some embodiments, the retrofit of pre-existing structures may involve regulatory considerations. The retrofit may require permits, approvals, or authorizations from regulatory agencies that may have jurisdiction over the pre-existing structure, the retrofit activities, or the operation of the retrofitted system. The regulatory considerations may vary depending on the type of pre-existing structure, the location of the structure, and the nature of the retrofit.

In some embodiments, the retrofit of pre-existing structures may involve economic considerations. The cost of the retrofit may be compared to the cost of new construction to determine the economic viability of the retrofit approach. The retrofit may provide cost savings compared to new construction due to the utilization of existing structural elements, foundations, and infrastructure. The retrofit may also provide revenue through power generation, which may offset the cost of the retrofit over time.

In some embodiments, the retrofit of pre-existing structures may involve technical considerations. The structural capacity of the pre-existing structure may be evaluated to determine whether the structure may support the loads associated with the retrofit. The condition of the pre-existing structure may be assessed to identify any repairs or reinforcement that may be required. The compatibility of the pre-existing structure with the retrofit components may be evaluated to ensure that the retrofit may be successfully integrated with the existing structure.

In some embodiments, a system may comprise an offshore structure. Offshore structures may be configured to operate in marine environments and may provide platforms for thermal power generation systems that may harness temperature differences between seawater and cold ambient air. Offshore structures may be positioned in locations where access to seawater, cold air temperatures, or any combination thereof may be available for heat transfer processes. Offshore structures may include one or more or any combination of the following: ship-shaped structures, or gravity-based structures, or piling-based structures, or pre-fabricated structures, or floating structures, or any combination thereof.

In some embodiments, a process may further comprise providing an offshore structure comprising a ship-shaped structure. A ship-shaped structure may comprise a structure that may have a hull form similar to that of a ship or vessel. Ship-shaped structures may be designed to accommodate wave loads, current loads, and wind loads in marine environments. Ship-shaped structures may be moored at a location, may be dynamically positioned, or may be capable of self-propulsion. Ship-shaped structures may provide deck space for thermal exchange equipment, air conduits, power generation equipment, and other system components. The ship-shaped configuration may provide stability in marine conditions and may allow the structure to weathervane, which may involve rotating about a mooring point to align with prevailing wind, wave, or current directions.

In some embodiments, a system may comprise an offshore structure comprising a ship-shaped structure. The ship-shaped structure may provide a platform for the airflow conduit, the thermal exchange zone, the flow control elements, and other components of the system. The ship-shaped structure may be configured to draw seawater from the surrounding marine environment for use in heat transfer processes. The ship-shaped structure may be configured to discharge cooled seawater, ice, brine, or other materials produced through heat transfer processes back to the marine environment or to storage facilities.

In some embodiments, ship-shaped structures may be purpose-built for thermal power generation applications. Purpose-built ship-shaped structures may be designed with hull forms, deck layouts, and structural configurations that may be optimized for the installation and operation of thermal power generation systems. Purpose-built ship-shaped structures may include integrated seawater intake systems, integrated thermal exchange zones, integrated air conduits, and integrated power generation equipment.

In some embodiments, ship-shaped structures may comprise converted vessels. Converted vessels may comprise ships or vessels that may have been originally constructed for other purposes and that may be converted to serve as platforms for thermal power generation systems. Converted vessels may include tankers, bulk carriers, container ships, offshore support vessels, or other vessel types that may be modified to accommodate thermal power generation equipment. The conversion may involve the installation of air conduits, thermal exchange equipment, power generation equipment, and other system components on the vessel.

In some embodiments, a process may further comprise providing an offshore structure comprising a gravity-based structure. A gravity-based structure may comprise a structure that may rely on the weight of the structure to maintain stability on the seabed. Gravity-based structures may be constructed from concrete, steel, or other materials, and gravity-based structures may be designed to resist overturning, sliding, and other failure modes through the weight of the structure and the resistance of the seabed. Gravity-based structures may be constructed onshore or in sheltered waters and may be towed to the installation site and lowered to the seabed.

In some embodiments, a system may comprise an offshore structure comprising a gravity-based structure. The gravity-based structure may provide a stable platform for the airflow conduit, the thermal exchange zone, the flow control elements, and other components of the system. The gravity-based structure may be configured to support the weight of the air conduit, the thermal exchange equipment, the power generation equipment, and other system components. The gravity-based structure may be configured to resist environmental loads including wave loads, current loads, wind loads, and ice loads.

In some embodiments, gravity-based structures may have various plan dimensions depending on the size of the thermal power generation system and the environmental conditions at the installation site. In some embodiments, a gravity-based structure may have plan dimensions of approximately 120 meters by approximately 120 meters. A gravity-based structure with plan dimensions of approximately 120 meters by approximately 120 meters may provide a deck area of approximately 14,400 square meters, which may accommodate multiple water pools, multiple air conduits, multiple turbines, and other system components. The 120 meter by 120 meter configuration may be suitable for installations where a moderate footprint may be desired.

In some embodiments, a gravity-based structure may have plan dimensions of approximately 200 meters by approximately 200 meters. A gravity-based structure with plan dimensions of approximately 200 meters by approximately 200 meters may provide a deck area of approximately 40,000 square meters, which may accommodate larger thermal power generation systems with greater power output capacity. The 200 meter by 200 meter configuration may be suitable for installations where a larger footprint may be accommodated and where greater power generation capacity may be desired.

In some embodiments, gravity-based structures may be configured with multiple water pools arranged on the deck of the structure. The water pools may be arranged in arrays, such as two-by-two arrays of four pools or other array configurations. The water pools may be configured to receive seawater from intake systems, to facilitate heat transfer between the seawater and cold ambient air, and to collect ice or cooled water produced through the heat transfer process. The arrangement of water pools on the gravity-based structure may be configured to maximize the water-air contact area while accommodating air conduits, turbines, and other system components.

In some embodiments, gravity-based structures may be constructed from reinforced concrete. Reinforced concrete gravity-based structures may provide durability, resistance to marine corrosion, and the ability to be constructed with complex geometries. The concrete may be reinforced with steel reinforcing bars, prestressing tendons, or other reinforcement to provide tensile strength and to control cracking. The concrete gravity-based structure may include ballast chambers that may be filled with water, sand, or other ballast materials to increase the weight of the structure and to enhance stability.

In some embodiments, gravity-based structures may be constructed from steel. Steel gravity-based structures may provide high strength-to-weight ratios and may be fabricated in shipyards or fabrication facilities. Steel gravity-based structures may include ballast tanks that may be filled with water or other ballast materials to provide the weight required for stability. Steel gravity-based structures may be coated or otherwise protected to resist marine corrosion.

In some embodiments, gravity-based structures may be designed for Arctic deployment. Gravity-based structures for Arctic deployment may be configured to resist ice loads, which may include loads from sea ice, ice ridges, icebergs, or other ice features. The gravity-based structure may have sloped surfaces that may cause ice to ride up and break rather than applying horizontal loads to the structure. The gravity-based structure may be designed with sufficient weight and seabed resistance to withstand the ice loads that may be expected at the installation site.

In some embodiments, a process may further comprise providing an offshore structure comprising a piling-based structure. A piling-based structure may comprise a structure that may be supported by piles driven into the seabed or drilled into the seabed. Piling-based structures may include jacket structures, tripod structures, monopile structures, or other structures that may transfer loads to the seabed through piles. Piling-based structures may be suitable for locations where soil conditions may support pile foundations and where water depths may be within the range suitable for piling-based construction.

In some embodiments, a system may comprise an offshore structure comprising a piling-based structure. The piling-based structure may provide a platform for the airflow conduit, the thermal exchange zone, the flow control elements, and other components of the system. The piling-based structure may be configured to transfer structural loads through the piles to the seabed. The piling-based structure may be configured to resist environmental loads including wave loads, current loads, wind loads, and ice loads through the structural capacity of the piles and the pile-soil interaction.

In some embodiments, piling-based structures may comprise jacket structures. Jacket structures may comprise three-dimensional frameworks of tubular steel members that may be supported by piles at the corners or legs of the framework. The jacket structure may provide a stable platform at the water surface or above the water surface, and the jacket structure may support the deck, the air conduit, the thermal exchange equipment, and other system components. Jacket structures may be fabricated onshore and may be transported to the installation site and installed by lifting or launching.

In some embodiments, piling-based structures may comprise monopile structures. Monopile structures may comprise single large-diameter piles that may be driven into the seabed and that may support a platform or tower above the water surface. Monopile structures may be suitable for moderate water depths and may provide a simple and cost-effective foundation solution. The monopile may support an air conduit, thermal exchange equipment, and other system components.

In some embodiments, piling-based structures may comprise tripod structures. Tripod structures may comprise three-legged frameworks that may be supported by piles at each leg. Tripod structures may provide stability through the triangular arrangement of the legs and may be suitable for locations where soil conditions may vary across the footprint of the structure.

In some embodiments, a process may further comprise providing a pre-fabricated structure. A pre-fabricated structure may comprise a structure that may be manufactured or assembled at a location remote from the installation site and that may be transported to the installation site for installation. Pre-fabricated structures may provide advantages including quality control during manufacturing, reduced construction time at the installation site, and the ability to construct in controlled conditions regardless of weather at the installation site. Pre-fabricated structures may be transported by ship, by barge, by heavy-lift vessel, or by other transportation means.

In some embodiments, a system may comprise a pre-fabricated structure. The pre-fabricated structure may comprise the airflow conduit, the thermal exchange zone, the flow control elements, the power generation units, or any combination thereof. The pre-fabricated structure may be manufactured at a shipyard, a fabrication facility, or other manufacturing location. The pre-fabricated structure may be transported to the installation site and may be installed on a foundation, on a floating platform, or in another configuration.

In some embodiments, pre-fabricated structures may comprise modular units that may be assembled at the installation site. The modular units may be manufactured separately and may be transported to the installation site, where the modular units may be connected together to form the complete structure. The modular approach may allow large structures to be constructed from smaller units that may be more easily transported.

In some embodiments, pre-fabricated structures may comprise integrated units that may include multiple system components. An integrated pre-fabricated unit may include the air conduit, the thermal exchange zone, the turbines, the flow control elements, and other components in a single transportable unit. The integrated unit may be installed at the installation site with minimal additional construction required.

In some embodiments, a process may further comprise providing a floating structure. A floating structure may comprise a structure that may be buoyant and that may float on the water surface. Floating structures may be moored to the seabed, may be dynamically positioned, or may be free-floating. Floating structures may be suitable for deep water locations where bottom-founded structures may not be economical, or for locations where the structure may need to be relocated. Floating structures may include ship-shaped structures, semi-submersible structures, spar structures, tension leg platforms, barge structures, or other floating structure types.

In some embodiments, a system may comprise a floating structure. The floating structure may provide a platform for the airflow conduit, the thermal exchange zone, the flow control elements, and other components of the system. The floating structure may be configured to maintain stability in marine conditions, including wave conditions, wind conditions, and current conditions. The floating structure may be configured to accommodate the motions that may occur due to wave action, including heave, pitch, roll, surge, sway, and yaw motions.

In some embodiments, floating structures may comprise semi-submersible structures. Semi-submersible structures may comprise structures with pontoons or columns that may be partially submerged below the water surface, with a deck supported above the water surface. The partial submersion of the pontoons or columns may reduce the wave-induced motions of the structure, which may provide a more stable platform for thermal power generation equipment. Semi-submersible structures may be moored or dynamically positioned.

In some embodiments, floating structures may comprise spar structures. Spar structures may comprise deep-draft floating structures with a large vertical extent below the water surface. The deep draft may provide stability and may reduce wave-induced motions. Spar structures may be moored to the seabed and may support thermal power generation equipment on a deck at or above the water surface.

In some embodiments, floating structures may comprise barge structures. Barge structures may comprise flat-bottomed floating structures that may provide large deck areas for equipment installation. Barge structures may be suitable for sheltered waters or for locations where wave conditions may be moderate. Barge structures may be moored or may be self-propelled.

In some embodiments, floating structures may be configured for relocation. The floating structure may be disconnected from moorings, may be towed or self-propelled to a new location, and may be reconnected to moorings or otherwise positioned at the new location. The ability to relocate may allow the floating structure to be moved to locations where conditions may be favorable for thermal power generation, or to be moved away from locations where hazardous conditions may be present.

In some embodiments, a system may be configured as a ship-based structure. A ship-based structure may comprise a vessel that may be capable of self-propulsion and that may be configured to support thermal power generation equipment. Ship-based structures may provide mobility, which may allow the structure to be repositioned to locations where conditions may be favorable for thermal power generation. Ship-based structures may be configured to operate while at anchor, while moored, while docked, or while underway.

In some embodiments, a system may be configured as an ice-classed vessel structure. An ice-classed vessel may comprise a vessel that may be designed and constructed to operate in ice-covered waters. Ice-classed vessels may have strengthened hulls, ice-breaking bow forms, protected propulsion systems, and other features that may allow the vessel to navigate through sea ice. Ice-classed vessels may be classified according to ice class notation systems that may indicate the ice conditions in which the vessel may operate.

In some embodiments, ice-classed vessel structures may be configured for Arctic deployment. Arctic deployment may involve operation in waters that may be covered with sea ice for at least a portion of the year. The ice-classed vessel may be configured to navigate through sea ice to reach locations where thermal power generation may be conducted. The ice-classed vessel may be configured to operate in ice-covered waters, to break through ice, or to maintain position in ice conditions.

In some embodiments, ice-classed vessel structures may comprise Arc7-class configurations. Arc7 may refer to an ice class notation that may indicate the ability to navigate in ice conditions of a specified severity. Arc7-class vessels may be designed to navigate independently in first-year ice with a thickness of up to approximately 1.4 meters during winter-spring navigation, and may be capable of navigating in ice with a thickness of up to approximately 2.1 meters with icebreaker assistance. Arc7-class vessels may have hull forms, structural reinforcement, propulsion systems, and other features that may be configured for operation in severe ice conditions.

In some embodiments, Arc7-class vessel configurations may comprise liquefied natural gas carrier configurations. Arc7-class liquefied natural gas carriers may be vessels that may have been designed to transport liquefied natural gas through ice-covered waters, such as the Northern Sea Route. Arc7-class liquefied natural gas carriers may have lengths of approximately 300 meters to approximately 450 meters, which may provide substantial deck area and hull volume for the installation of thermal power generation equipment. The large size of Arc7-class liquefied natural gas carriers may allow the installation of multiple air conduits, multiple thermal exchange zones, and multiple power generation units.

In some embodiments, Arc7-class liquefied natural gas carrier configurations may have lengths of approximately 300 meters. A vessel with a length of approximately 300 meters may provide a deck area and hull volume that may accommodate thermal power generation systems with substantial power output capacity. The 300 meter length may be within the range of existing Arc7-class liquefied natural gas carriers, which may allow existing vessel designs to be adapted for thermal power generation applications.

In some embodiments, Arc7-class liquefied natural gas carrier configurations may be capable of navigating through ice with a thickness of approximately 2.1 meters. The ability to navigate through ice with a thickness of approximately 2.1 meters may allow the vessel to operate in Arctic waters during winter months when sea ice may be present. The ice navigation capability may allow the vessel to reach locations where cold air temperatures may be available for thermal power generation, and may allow the vessel to operate in ice-covered waters where temperature differences between seawater and air may be substantial.

In some embodiments, Arc7-class vessel configurations may be converted from existing liquefied natural gas carriers. Existing Arc7-class liquefied natural gas carriers may be converted to thermal power generation vessels by removing or modifying the liquefied natural gas cargo systems and installing thermal power generation equipment. The conversion may utilize the existing hull, propulsion systems, and ice-class features of the liquefied natural gas carrier while adapting the vessel for thermal power generation operations.

In some embodiments, Arc7-class vessel configurations may be purpose-built for thermal power generation applications. Purpose-built Arc7-class thermal power generation vessels may be designed with hull forms, deck layouts, and system configurations that may be optimized for thermal power generation in Arctic conditions. Purpose-built vessels may include integrated seawater intake systems, integrated thermal exchange zones, integrated air conduits, and integrated power generation equipment.

In some embodiments, ice-classed vessel structures may be configured to utilize seawater from beneath sea ice for heat transfer processes. Seawater beneath sea ice may be at temperatures near or above the freezing point of seawater, which may be approximately negative 1.8 degrees Celsius to approximately negative 2 degrees Celsius. The ice-classed vessel may be configured to draw seawater from beneath the ice through intake systems that may extend through or beneath the ice layer. The seawater may be transferred to thermal exchange zones on the vessel, where heat may be transferred from the seawater to cold ambient air.

In some embodiments, ice-classed vessel structures may be configured to produce ice through heat transfer processes and to deposit the produced ice in the marine environment. The ice produced through heat transfer may be deposited on existing sea ice, may be deposited in open water areas, or may be stored on the vessel. The deposition of ice in the marine environment may contribute to sea ice enhancement, may increase albedo, or may provide other environmental benefits.

In some embodiments, ice-classed vessel structures may be configured to operate in conjunction with icebreakers. Icebreakers may be vessels that may be designed to break through sea ice and to create channels through which other vessels may navigate. The ice-classed thermal power generation vessel may follow an icebreaker through ice-covered waters to reach locations where thermal power generation may be conducted. The ice-classed vessel may also be configured to operate independently in ice conditions within the capability of the vessel's ice class.

In some embodiments, offshore structures may be configured with multiple air conduits. Multiple air conduits may be arranged on the offshore structure to increase the total power generation capacity of the system. The multiple air conduits may be arranged in arrays, in rows, or in other configurations depending on the layout of the offshore structure. Each air conduit may be associated with one or more thermal exchange zones, one or more turbines, and one or more flow control elements.

In some embodiments, offshore structures may be configured with seawater intake systems. Seawater intake systems may be configured to draw seawater from the surrounding marine environment and to transfer the seawater to thermal exchange zones on the offshore structure. Seawater intake systems may include intake screens, intake pipes, pumps, and other components. The seawater intake systems may be configured to minimize the entrainment of marine organisms and to comply with environmental regulations.

In some embodiments, offshore structures may be configured with discharge systems. Discharge systems may be configured to return cooled seawater, brine, or other materials to the marine environment after heat transfer processes. Discharge systems may include discharge pipes, diffusers, and other components. The discharge systems may be configured to promote mixing and dilution of discharged materials to minimize environmental impacts.

In some embodiments, offshore structures may be configured with ice handling systems. Ice handling systems may be configured to collect, transport, store, or discharge ice produced through heat transfer processes. Ice handling systems may include conveyors, chutes, storage bins, and other components. The ice handling systems may be configured to transfer ice from thermal exchange zones to storage areas, to discharge locations, or to processing equipment.

In some embodiments, offshore structures may be configured with power transmission systems. Power transmission systems may be configured to transmit electrical power generated by the thermal power generation system to shore facilities, to other offshore structures, or to onboard systems. Power transmission systems may include transformers, switchgear, cables, and other components. The power transmission systems may be configured to transmit power at voltages and frequencies that may be compatible with receiving systems.

In some embodiments, offshore structures may be configured with mooring systems. Mooring systems may be configured to maintain the position of the offshore structure at the installation site. Mooring systems may include anchors, mooring lines, buoys, and other components. The mooring systems may be configured to resist environmental loads including wave loads, current loads, wind loads, and ice loads while maintaining the offshore structure within acceptable position tolerances.

In some embodiments, offshore structures may be configured with dynamic positioning systems. Dynamic positioning systems may be configured to maintain the position of the offshore structure using thrusters or propulsion systems rather than mooring systems. Dynamic positioning systems may include thrusters, position reference systems, control systems, and other components. Dynamic positioning systems may allow the offshore structure to maintain position without anchors, which may be advantageous in deep water or in locations where anchoring may not be feasible.

In some embodiments, thermal power generation systems may operate using sensible heat from warm water rather than relying on latent heat released during freezing. Sensible heat transfer may occur when heat is transferred from a fluid to air without a phase change occurring in the fluid. When warm water at a temperature substantially above ambient air temperature contacts cooler air, sensible heat may be transferred from the water to the air, warming the air and reducing the density of the air. The warmed air may rise through an air conduit due to buoyancy forces, and the kinetic energy of the rising air may be harnessed for power generation. Sensible heat-based operating modes may be employed in locations where water temperatures may be elevated relative to ambient air temperatures, regardless of whether the ambient air temperature may be above or below the freezing point of water.

In some embodiments, warm water for sensible heat-based thermal power generation may be obtained from geothermal sources. Geothermal sources may provide water at temperatures substantially above ambient air temperatures due to heat from the Earth's interior. Geothermal sources that may provide warm water for thermal power generation may include one or more or any combination of the following: hot springs, or geothermal wells, or geothermal ponds, or geothermal pools, or geothermal reservoirs, or geothermal aquifers, or geothermal vents, or fumaroles, or geysers, or mud pots, or geothermal seeps, or enhanced geothermal systems, or geothermal heat exchangers, or ground source heat pump systems, or any combination thereof.

In some embodiments, hot springs may provide warm water for thermal power generation. Hot springs may comprise natural springs where groundwater heated by geothermal energy emerges at the surface. Hot spring water temperatures may range from approximately 25 degrees Celsius to approximately 100 degrees Celsius or higher, depending on the geothermal gradient, the depth of water circulation, and the local geology. Hot springs may be found in geologically active regions, near volcanic areas, along fault zones, or in other locations where geothermal heat may be accessible. The temperature difference between hot spring water and ambient air may provide a thermodynamic driving force for thermal power generation through sensible heat transfer.

In some embodiments, geothermal wells may provide warm water for thermal power generation. Geothermal wells may comprise wells drilled into geothermal reservoirs to access hot water or steam. Geothermal wells may produce water at temperatures ranging from approximately 50 degrees Celsius to approximately 350 degrees Celsius or higher, depending on the depth of the well and the characteristics of the geothermal reservoir. Geothermal wells may be production wells that extract hot water from the reservoir, or geothermal wells may be injection wells that return cooled water to the reservoir. Water from geothermal production wells may be directed to thermal exchange zones where heat may be transferred to air for thermal power generation.

In some embodiments, geothermal ponds may provide warm water for thermal power generation. Geothermal ponds may comprise natural or artificial ponds that may be heated by geothermal sources. Geothermal ponds may receive water from hot springs, from geothermal wells, from geothermal seeps, or from other geothermal sources. The water in geothermal ponds may be at elevated temperatures relative to ambient air temperatures, and the temperature difference may provide a thermodynamic driving force for thermal power generation. Geothermal ponds may also serve as thermal storage, accumulating heat during periods of high geothermal flow and releasing heat during periods of lower geothermal flow.

In some embodiments, geothermal reservoirs may provide warm water for thermal power generation. Geothermal reservoirs may comprise subsurface formations that may contain hot water, steam, or a mixture of hot water and steam. Geothermal reservoirs may be hydrothermal reservoirs where naturally occurring hot water may be present, or geothermal reservoirs may be enhanced geothermal systems where water may be injected into hot dry rock formations and recovered as heated water. Water from geothermal reservoirs may be extracted through wells and may be directed to thermal exchange zones for heat transfer to air.

In some embodiments, enhanced geothermal systems may provide warm water for thermal power generation. Enhanced geothermal systems may comprise engineered geothermal reservoirs where water may be injected into subsurface rock formations, heated by contact with hot rock, and recovered through production wells. Enhanced geothermal systems may be developed in locations where hot rock may be present at accessible depths but where natural permeability or natural fluid content may be insufficient for conventional geothermal production. The water recovered from enhanced geothermal systems may be at temperatures ranging from approximately 100 degrees Celsius to approximately 300 degrees Celsius or higher, depending on the depth and temperature of the rock formation.

In some embodiments, ground source heat pump systems may provide warm water for thermal power generation. Ground source heat pump systems may comprise systems that may exchange heat with the ground through buried pipes, wells, or other heat exchangers. In heating mode, ground source heat pump systems may extract heat from the ground and may produce warm water that may be at temperatures above ambient air temperatures. The warm water from ground source heat pump systems may be directed to thermal exchange zones where heat may be transferred to air for thermal power generation. Ground source heat pump systems may provide warm water at temperatures ranging from approximately 10 degrees Celsius to approximately 30 degrees Celsius, depending on ground temperatures and system design.

In some embodiments, the temperature of geothermal water may affect the power generation capacity of the thermal power generation system. Higher geothermal water temperatures may provide greater temperature differences relative to ambient air, which may result in greater buoyancy-induced pressure differences and greater airflow velocities through the air conduit. The power generation capacity may be related to the temperature difference between the geothermal water and the ambient air, the flow rate of geothermal water, the efficiency of heat transfer from the water to the air, and the efficiency of power extraction from the airflow.

In some embodiments, geothermal water at temperatures greater than approximately 30 degrees Celsius may be employed for thermal power generation. In some embodiments, geothermal water at temperatures greater than approximately 40 degrees Celsius may be employed for thermal power generation. In some embodiments, geothermal water at temperatures greater than approximately 50 degrees Celsius may be employed for thermal power generation. In some embodiments, geothermal water at temperatures greater than approximately 60 degrees Celsius may be employed for thermal power generation. In some embodiments, geothermal water at temperatures greater than approximately 70 degrees Celsius may be employed for thermal power generation. In some embodiments, geothermal water at temperatures greater than approximately 80 degrees Celsius may be employed for thermal power generation. In some embodiments, geothermal water at temperatures greater than approximately 90 degrees Celsius may be employed for thermal power generation. In some embodiments, geothermal water at temperatures greater than approximately 100 degrees Celsius may be employed for thermal power generation.

In some embodiments, warm water for sensible heat-based thermal power generation may be obtained from industrial waste heat sources. Industrial processes may generate waste heat that may be rejected to cooling water, and the heated cooling water may be at temperatures above ambient air temperatures. Industrial waste heat sources that may provide warm water for thermal power generation may include one or more or any combination of the following: power plant cooling water, or refinery cooling water, or chemical plant cooling water, or steel mill cooling water, or smelter cooling water, or foundry cooling water, or glass manufacturing cooling water, or cement plant cooling water, or paper mill cooling water, or food processing cooling water, or data center cooling water, or any combination thereof.

In some embodiments, power plant cooling water may provide warm water for thermal power generation. Thermal power plants, nuclear power plants, combined cycle power plants, and other power generation facilities may reject heat to cooling water systems. The cooling water discharged from power plants may be at temperatures ranging from approximately 25 degrees Celsius to approximately 45 degrees Celsius or higher, depending on the cooling system design and the ambient conditions. The temperature difference between power plant cooling water and ambient air may provide a thermodynamic driving force for thermal power generation through sensible heat transfer.

In some embodiments, data center cooling water may provide warm water for thermal power generation. Data centers may generate substantial heat from computing equipment, and the heat may be rejected to cooling water systems. Data center cooling water may be at temperatures ranging from approximately 25 degrees Celsius to approximately 50 degrees Celsius or higher, depending on the cooling system design and the heat load. The temperature difference between data center cooling water and ambient air may provide a thermodynamic driving force for thermal power generation.

In some embodiments, industrial process water may provide warm water for thermal power generation. Industrial processes including chemical reactions, distillation, drying, heating, and other operations may generate heat that may be transferred to process water or cooling water. The heated water from industrial processes may be at temperatures above ambient air temperatures, and the temperature difference may provide a thermodynamic driving force for thermal power generation.

In some embodiments, warm water for sensible heat-based thermal power generation may be obtained from solar-heated reservoirs. Solar-heated reservoirs may comprise bodies of water that may be heated by solar radiation. Solar-heated reservoirs may include one or more or any combination of the following: solar ponds, or solar-heated tanks, or solar-heated pools, or solar-heated lagoons, or naturally solar-heated lakes, or naturally solar-heated ponds, or any combination thereof.

In some embodiments, solar ponds may provide warm water for thermal power generation. Solar ponds may comprise bodies of water that may be configured to trap solar heat through the use of salinity gradients or other mechanisms. In a salinity gradient solar pond, a layer of high-salinity water at the bottom of the pond may be heated by solar radiation, and the salinity gradient may suppress convection and may prevent the heated water from rising and losing heat to the atmosphere. The bottom layer of a solar pond may reach temperatures of approximately 70 degrees Celsius to approximately 90 degrees Celsius or higher. The heated water from solar ponds may be extracted and directed to thermal exchange zones for heat transfer to air.

In some embodiments, solar-heated tanks may provide warm water for thermal power generation. Solar-heated tanks may comprise tanks that may be heated by solar collectors, by direct solar radiation, or by other solar heating mechanisms. Solar collectors may include flat plate collectors, evacuated tube collectors, concentrating collectors, or other collector types that may absorb solar radiation and transfer heat to water. The heated water from solar-heated tanks may be at temperatures ranging from approximately 40 degrees Celsius to approximately 95 degrees Celsius or higher, depending on the solar collector type and the solar radiation intensity.

In some embodiments, naturally solar-heated bodies of water may provide warm water for thermal power generation. Lakes, ponds, and other bodies of water may be heated by solar radiation, and the surface layers of such bodies of water may be at temperatures above ambient air temperatures during certain periods. The temperature difference between solar-heated surface water and cooler ambient air may provide a thermodynamic driving force for thermal power generation, particularly during evening hours or nighttime when ambient air temperatures may decrease while water temperatures may remain elevated due to the thermal mass of the water.

In some embodiments, thermal power generation systems may be positioned near geothermal heat sources to minimize the distance over which warm water may be transported. Positioning the thermal power generation system near the geothermal heat source may reduce heat losses during water transport, may reduce pumping energy requirements, and may reduce infrastructure costs associated with water transport pipelines. The proximity to the geothermal heat source may allow the warm water to arrive at the thermal exchange zone at temperatures close to the source temperature.

In some embodiments, thermal power generation systems may be positioned over geothermal heat sources. Positioning the thermal power generation system over the geothermal heat source may allow warm water to be drawn directly from the source without horizontal transport. The air conduit may be positioned directly above a hot spring, a geothermal pond, a geothermal well, or another geothermal source. The thermal exchange zone may be positioned at or near the geothermal source, and the warmed air may rise through the air conduit positioned above the thermal exchange zone.

In some embodiments, an air conduit may be positioned over a hot spring. The hot spring may provide a continuous supply of warm water at the base of the air conduit. The warm water from the hot spring may contact air at the base of the air conduit, transferring heat to the air and warming the air. The warmed air may rise through the air conduit due to buoyancy forces, and the kinetic energy of the rising air may be harnessed for power generation. The positioning of the air conduit over the hot spring may allow the system to utilize the natural flow of warm water from the hot spring without pumping.

In some embodiments, an air conduit may be positioned over a geothermal pond. The geothermal pond may serve as a thermal exchange zone where warm water may contact air. The air conduit may be positioned above the geothermal pond, and air may enter the base of the air conduit, contact the warm water in the geothermal pond, be warmed through heat transfer, and rise through the air conduit. The geothermal pond may receive warm water from hot springs, geothermal wells, or other geothermal sources, and the geothermal pond may serve as a buffer that may moderate variations in geothermal water flow or temperature.

In some embodiments, an air conduit may be positioned over a geothermal well. The geothermal well may produce warm water that may be directed to a thermal exchange zone at the base of the air conduit. The thermal exchange zone may comprise a pool, a basin, a spray system, or other water-air contacting arrangement. The warm water from the geothermal well may contact air in the thermal exchange zone, transferring heat to the air. The warmed air may rise through the air conduit positioned above the thermal exchange zone.

In some embodiments, thermal power generation systems utilizing geothermal heat sources may operate continuously. Geothermal heat sources may provide a continuous supply of warm water, which may allow the thermal power generation system to operate without interruption. The continuous operation may provide baseload power generation capability, which may be valuable for grid stability and for applications requiring reliable power supply.

In some embodiments, thermal power generation systems utilizing geothermal heat sources may operate with varying power output. The power output may vary based on ambient air temperature, geothermal water temperature, geothermal water flow rate, or other factors. When ambient air temperatures may be lower, the temperature difference between the geothermal water and the air may be greater, which may result in greater buoyancy-induced airflow and greater power output. When ambient air temperatures may be higher, the temperature difference may be smaller, which may result in lower power output.

In some embodiments, thermal power generation systems utilizing industrial waste heat may operate in coordination with industrial processes. The thermal power generation system may receive warm water from industrial cooling systems during periods when the industrial processes may be operating. The power output of the thermal power generation system may vary based on the operating schedule of the industrial processes and the amount of waste heat available. The thermal power generation system may provide a beneficial use for industrial waste heat that may otherwise be rejected to the environment.

In some embodiments, thermal power generation systems utilizing solar-heated water may operate with diurnal variations. Solar heating may be greatest during daylight hours, and the temperature of solar-heated water may be highest during afternoon hours. The thermal power generation system may produce greater power output during periods when solar-heated water temperatures may be highest. Thermal storage may be employed to extend the operating period of the thermal power generation system into evening hours or nighttime when solar heating may not be available.

In some embodiments, thermal power generation systems utilizing warm water may be combined with thermal power generation systems utilizing cold water and freezing. A single system may be configured to operate in a warm water mode when warm water sources may be available and to operate in a cold water freezing mode when cold ambient air temperatures may be available. The dual-mode capability may allow the system to generate power under a wider range of conditions and may increase the capacity factor of the system.

In some embodiments, geothermal water may contain dissolved minerals, gases, or other constituents that may affect the design and operation of the thermal power generation system. Geothermal water may contain dissolved silica, calcium carbonate, hydrogen sulfide, carbon dioxide, or other constituents that may precipitate, scale, corrode, or otherwise affect system components. The thermal power generation system may include treatment systems, materials selection, or operating procedures that may address the characteristics of the geothermal water.

In some embodiments, geothermal water that has been cooled through heat transfer to air may be returned to the geothermal reservoir. Returning cooled water to the geothermal reservoir may maintain reservoir pressure, may provide water for reheating, and may reduce the consumption of geothermal water. The return of cooled water may be accomplished through injection wells that may be separate from production wells, or the return may be accomplished through the same wells used for production.

In some embodiments, thermal power generation systems utilizing geothermal heat sources may be integrated with other geothermal applications. Other geothermal applications may include one or more or any combination of the following: geothermal power generation using steam turbines, or geothermal power generation using binary cycle systems, or geothermal heating, or geothermal cooling, or geothermal aquaculture, or geothermal greenhouse heating, or geothermal spa facilities, or any combination thereof. The thermal power generation system described herein may utilize geothermal water that may have been partially cooled through other geothermal applications, or the thermal power generation system may provide pre-cooling of geothermal water before the water may be used in other applications.

In some embodiments, thermal power generation systems utilizing warm water may be positioned at locations where both warm water sources and favorable air conditions may be present. Favorable air conditions may include lower ambient air temperatures, lower humidity, higher wind speeds, or other conditions that may enhance heat transfer from warm water to air or that may enhance the buoyancy-induced airflow through the air conduit. The selection of location may balance the availability of warm water sources against the favorability of air conditions.

In some embodiments, thermal power generation systems utilizing warm water may employ direct contact heat exchange between the warm water and the air. Direct contact heat exchange may involve spraying warm water into the air, passing air over pools of warm water, passing air through water curtains, or other methods that may bring the warm water into direct physical contact with the air. Direct contact heat exchange may provide high heat transfer rates and may be suitable for warm water sources that may not contain constituents that may be harmful if released to the atmosphere.

In some embodiments, thermal power generation systems utilizing warm water may employ indirect heat exchange between the warm water and the air. Indirect heat exchange may involve transferring heat from the warm water to the air through heat exchanger surfaces without direct contact between the water and the air. Indirect heat exchange may be employed when the warm water may contain constituents that may be harmful if released to the atmosphere, when the warm water may be at high pressure, or when separation of the water and air streams may be desired for other reasons.

In some embodiments, the flow rate of warm water through the thermal exchange zone may be controlled to optimize power generation. Higher warm water flow rates may provide greater heat transfer to the air, which may result in greater buoyancy-induced airflow and greater power output. The warm water flow rate may be controlled based on the available warm water supply, the ambient air temperature, the desired power output, or other factors. Control systems may adjust the warm water flow rate to maintain desired operating conditions or to optimize power generation.

In some embodiments, the temperature of warm water entering the thermal exchange zone may be controlled to optimize power generation. The warm water temperature may be controlled through blending of water from different sources, through heat exchange with other fluids, through thermal storage, or through other methods. Higher warm water temperatures may provide greater temperature differences relative to ambient air, which may result in greater power output. The warm water temperature may be controlled based on the available warm water sources, the ambient air temperature, the desired power output, or other factors.

In some embodiments, thermal power generation systems utilizing warm water from geothermal sources may provide renewable power generation. Geothermal energy may be considered a renewable energy source because the heat from the Earth's interior may be continuously replenished through radioactive decay and residual heat from planetary formation. Thermal power generation utilizing geothermal warm water may provide power generation without combustion of fossil fuels and may have low greenhouse gas emissions compared to fossil fuel-based power generation.

In some embodiments, thermal power generation systems utilizing warm water from industrial waste heat may provide power generation from energy that may otherwise be wasted. The utilization of industrial waste heat for power generation may improve the overall energy efficiency of industrial processes and may reduce the environmental impact of waste heat rejection. The power generated from industrial waste heat may offset power consumption from other sources and may reduce the carbon footprint of industrial operations.

In some embodiments, thermal power generation systems utilizing warm water from solar-heated sources may provide renewable power generation. Solar energy may be considered a renewable energy source because solar radiation may be continuously available. Thermal power generation utilizing solar-heated water may provide power generation without combustion of fossil fuels. The combination of solar heating and thermal power generation may provide a pathway for converting solar energy to electrical power.

In some embodiments, a system may employ structured media or packing material to enhance contact between water and air in a thermal exchange zone. Structured media or packing material may be positioned above a water pool, within an air conduit, or at other locations where water-air contact may occur. The structured media or packing material may provide surfaces over which water may flow, drip, or spread, which may increase the contact area between the water and the air. Increased contact area may enhance heat transfer from the water to the air, which may result in greater warming of the air and greater buoyancy-induced airflow through the air conduit.

In some embodiments, structured media may comprise PVC curtains. PVC curtains may comprise sheets, strips, or panels of polyvinyl chloride material that may be suspended or mounted in the path of airflow. Water may flow over the surfaces of the PVC curtains, may drip from the PVC curtains, or may spread across the PVC curtains to form thin films. The thin films of water on the PVC curtain surfaces may provide large surface areas for heat transfer to air passing over or through the PVC curtains. PVC curtains may be arranged in arrays, in banks, or in other configurations that may maximize water-air contact while allowing airflow to pass through the thermal exchange zone.

In some embodiments, structured media may comprise modular plastic mesh. Modular plastic mesh may comprise interconnected plastic elements that may form a three-dimensional structure with open passages for airflow and surfaces for water distribution. Water may flow over the surfaces of the modular plastic mesh, may drip through the mesh structure, or may spread across the mesh elements. The modular plastic mesh may provide a large surface area per unit volume, which may enhance heat transfer between the water and the air. Modular plastic mesh may be assembled from standardized modules, which may allow the size and configuration of the structured media to be adjusted based on the requirements of the thermal exchange zone.

In some embodiments, structured media or packing material may be positioned above a water pool. Water may be distributed over the structured media or packing material through spray nozzles, distribution troughs, drip systems, or other water distribution mechanisms. The water may flow downward through the structured media or packing material under the influence of gravity, contacting air that may flow upward, horizontally, or in other directions through the structured media or packing material. The water that has passed through the structured media or packing material may be collected in the water pool below, where the water may be recirculated, stored, or otherwise processed.

In some embodiments, structured media or packing material may increase the contact area between water and air compared to a water pool alone. The structured media or packing material may provide surface areas that may be many times greater than the surface area of the water pool. The increased contact area may allow greater heat transfer to occur within a given volume, which may allow the thermal exchange zone to be more compact or may allow greater heat transfer capacity within a given footprint.

In some embodiments, structured media or packing material may increase the residence time of water in contact with air. As water flows over or through the structured media or packing material, the water may travel a longer path than if the water were simply sprayed into the air or deposited directly into a pool. The longer path may result in longer contact time between the water and the air, which may allow greater heat transfer to occur per unit mass of water.

In some embodiments, structured media or packing material may promote the formation of thin water films. Thin water films may have high surface area to volume ratios, which may enhance heat transfer. The structured media or packing material may be configured with surface textures, surface treatments, or geometries that may promote the spreading of water into thin films rather than the formation of thick streams or droplets.

In some embodiments, structured media or packing material may be constructed from materials that may be resistant to degradation in the operating environment. Materials that may be employed for structured media or packing material may include one or more or any combination of the following: polyvinyl chloride, or polypropylene, or polyethylene, or high-density polyethylene, or polyvinylidene fluoride, or fiberglass reinforced plastic, or stainless steel, or aluminum, or other corrosion-resistant metals, or ceramic materials, or any combination thereof. The selection of material may depend on the temperature of the water, the composition of the water, the ambient temperature, the expected service life, or other factors.

In some embodiments, structured media or packing material may be configured to minimize pressure drop across the thermal exchange zone. Pressure drop may reduce the airflow velocity through the air conduit, which may reduce the power available for extraction from the airflow. Structured media or packing material may be configured with open geometries, smooth surfaces, or other features that may allow air to flow through with minimal resistance. The balance between increased contact area and increased pressure drop may be considered in the design of the structured media or packing material.

In some embodiments, ice may form on structured media or packing material when water contacts cold air at temperatures below the freezing point of the water. Ice formation on the structured media or packing material may reduce the effective surface area for water-air contact, may block airflow passages, may increase pressure drop, or may otherwise reduce the performance of the thermal exchange zone. Systems and methods may be employed to prevent ice buildup on the structured media or packing material or to remove ice that may have formed.

In some embodiments, defrost cycles may be employed to remove ice from structured media or packing material. A defrost cycle may comprise a period during which conditions may be adjusted to promote melting of ice that may have accumulated on the structured media or packing material. Defrost cycles may involve one or more or any combination of the following: increasing the temperature of water flowing over the structured media or packing material, or increasing the flow rate of water to provide greater heat input, or reducing or stopping airflow through the thermal exchange zone to reduce heat removal, or applying heated air to the structured media or packing material, or applying heated fluids to the structured media or packing material, or activating heating elements associated with the structured media or packing material, or any combination thereof.

In some embodiments, defrost cycles may be initiated based on time schedules. The defrost cycles may be initiated at regular intervals, such as every hour, every two hours, every four hours, or at other intervals that may be selected based on operating conditions and ice accumulation rates. Time-based defrost cycles may provide predictable defrosting regardless of actual ice accumulation.

In some embodiments, defrost cycles may be initiated based on detected conditions. Sensors may be employed to detect ice accumulation, pressure drop across the structured media or packing material, airflow velocity, temperature, or other parameters that may indicate ice buildup. When detected conditions may indicate that ice accumulation may have reached a threshold level, a defrost cycle may be initiated. Condition-based defrost cycles may provide defrosting when needed while avoiding unnecessary defrost cycles when ice accumulation may be minimal.

In some embodiments, defrost cycles may be initiated based on predicted conditions. Predictive models may be employed to estimate ice accumulation based on operating parameters, ambient conditions, historical data, or other inputs. When predicted ice accumulation may reach a threshold level, a defrost cycle may be initiated. Predictive defrost cycles may allow defrosting to be scheduled in advance, which may allow coordination with other system operations.

In some embodiments, anti-icing coatings may be applied to structured media or packing material to prevent ice buildup. Anti-icing coatings may comprise materials that may reduce the adhesion of ice to surfaces, that may lower the freezing point of water on surfaces, or that may otherwise inhibit ice formation or accumulation. Anti-icing coatings may include one or more or any combination of the following: hydrophobic coatings, or superhydrophobic coatings, or icephobic coatings, or low surface energy coatings, or fluoropolymer coatings, or silicone-based coatings, or nanostructured coatings, or any combination thereof.

In some embodiments, hydrophobic coatings may be applied to structured media or packing material. Hydrophobic coatings may repel water, which may cause water to bead up and roll off surfaces rather than spreading and adhering. The reduced adhesion of water to hydrophobic surfaces may reduce the tendency for ice to form and adhere to the surfaces. Hydrophobic coatings may be applied through spraying, dipping, vapor deposition, or other coating methods.

In some embodiments, superhydrophobic coatings may be applied to structured media or packing material. Superhydrophobic coatings may have water contact angles greater than approximately 150 degrees, which may cause water droplets to roll off surfaces with minimal contact. Superhydrophobic coatings may be created through the combination of low surface energy materials and micro-scale or nano-scale surface textures. The superhydrophobic properties may reduce ice adhesion and may allow ice that forms to be more easily removed.

In some embodiments, icephobic coatings may be applied to structured media or packing material. Icephobic coatings may be specifically formulated to reduce ice adhesion to surfaces. Icephobic coatings may comprise materials that may have low ice adhesion strength, that may deform to release ice, or that may have other properties that may facilitate ice removal. Icephobic coatings may allow ice that forms on surfaces to be removed by gravity, by airflow, by vibration, or by other mechanisms with reduced force compared to uncoated surfaces.

In some embodiments, low surface energy coatings may be applied to structured media or packing material. Low surface energy coatings may comprise materials such as fluoropolymers, silicones, or other materials that may have low surface energy. Low surface energy may reduce the adhesion of water and ice to surfaces, which may reduce ice accumulation and may facilitate ice removal.

In some embodiments, anti-icing coatings may be applied to structured media or packing material during manufacturing. The anti-icing coating may be applied as a surface treatment, as a co-extruded layer, or as an integral component of the structured media or packing material. Anti-icing coatings applied during manufacturing may provide durable protection that may last for the service life of the structured media or packing material.

In some embodiments, anti-icing coatings may be applied to structured media or packing material in the field. Field-applied anti-icing coatings may be applied during installation, during maintenance, or at other times. Field-applied coatings may allow existing structured media or packing material to be treated with anti-icing coatings, and field-applied coatings may be renewed periodically to maintain anti-icing performance.

In some embodiments, vibration cycles may be employed to remove ice from structured media or packing material. Vibration may be applied to the structured media or packing material to dislodge ice that may have formed on surfaces. The vibration may cause ice to crack, to break free from surfaces, or to fall from the structured media or packing material. Vibration cycles may be employed alone or in combination with defrost cycles or anti-icing coatings.

In some embodiments, vibration may be applied to structured media or packing material through mechanical vibrators. Mechanical vibrators may comprise motors with eccentric weights, pneumatic vibrators, electromagnetic vibrators, or other vibration-generating devices. The mechanical vibrators may be attached to the structured media or packing material, to support structures for the structured media or packing material, or to other components that may transmit vibration to the structured media or packing material.

In some embodiments, vibration may be applied to structured media or packing material through acoustic devices. Acoustic devices may generate sound waves or pressure waves that may cause vibration of the structured media or packing material. The acoustic devices may operate at frequencies that may be effective for dislodging ice while minimizing energy consumption and avoiding damage to the structured media or packing material.

In some embodiments, vibration cycles may be initiated based on time schedules, based on detected conditions, or based on predicted conditions. The initiation of vibration cycles may be coordinated with defrost cycles, with changes in operating conditions, or with other system operations. The duration and intensity of vibration cycles may be adjusted based on the amount of ice accumulation, the type of structured media or packing material, or other factors.

In some embodiments, the combination of defrost cycles, anti-icing coatings, and vibration cycles may provide effective ice management for structured media or packing material. The combination may allow each ice management method to be employed at levels that may be less intensive than if a single method were employed alone, which may reduce energy consumption, may reduce wear on components, and may extend the service life of the structured media or packing material.

In some embodiments, structured media or packing material may be configured for easy removal and replacement. The structured media or packing material may be mounted in frames, in cassettes, or in other removable assemblies that may be extracted from the thermal exchange zone for cleaning, maintenance, or replacement. The removable configuration may allow ice that may be difficult to remove in place to be removed by extracting the structured media or packing material and allowing the ice to melt in a separate location.

In some embodiments, structured media or packing material may be configured in multiple sections or zones. Different sections or zones may be operated independently, which may allow defrost cycles or vibration cycles to be applied to one section while other sections may continue to operate. The sectioned configuration may allow continuous operation of the thermal exchange zone while ice management activities may be performed on individual sections.

In some embodiments, the geometry of structured media or packing material may be selected to facilitate ice removal. Geometries that may facilitate ice removal may include one or more or any combination of the following: vertical surfaces that may allow ice to slide downward, or smooth surfaces that may reduce ice adhesion, or open geometries that may allow ice fragments to fall through, or tapered geometries that may prevent ice bridging, or any combination thereof. The selection of geometry may balance the objectives of maximizing water-air contact area and facilitating ice removal.

In some embodiments, structured media or packing material may be heated to prevent ice formation or to remove ice. Heating may be provided through one or more or any combination of the following: electric heating elements embedded in or attached to the structured media or packing material, or circulation of heated fluids through passages in the structured media or packing material, or radiant heating from external heat sources, or any combination thereof. The heating may be applied continuously at low levels to prevent ice formation, or the heating may be applied intermittently at higher levels during defrost cycles.

In some embodiments, the water distributed over structured media or packing material may contain additives that may reduce ice formation or ice adhesion. Additives may include one or more or any combination of the following: freezing point depressants, or surfactants, or anti-icing agents, or any combination thereof. The additives may reduce the freezing point of the water, may reduce the adhesion of ice to surfaces, or may otherwise inhibit ice formation or accumulation on the structured media or packing material.

In some embodiments, power generated from the airflow may be used for production of various industrial products or processes. Power generated may be used for production of hydrogen through electrolysis of water. Power generated may be used for production of ammonia through processes such as the Haber-Bosch process. Power generated may be used for production of synthesis gas through gasification or reforming processes. Power generated may be used for production of urea, ammonium nitrate, or nitrogen fertilizers. Power generated may be used for production of aluminum through electrolytic reduction of alumina. Power generated may be used for production of magnesium through electrolytic or thermal reduction processes. Power generated may be used for production of silicon through carbothermic reduction or other processes. Power generated may be used for metal refining operations. Power generated may be used for CO₂ conversion processes that transform captured carbon dioxide into useful products. Power generated may be used for water desalination through reverse osmosis, electrodialysis, or other desalination processes. Power generated may be used for liquefying gases such as natural gas, nitrogen, oxygen, or hydrogen. Power generated may be used for producing hydrocarbons through Fischer-Tropsch synthesis or other hydrocarbon synthesis processes.

In some embodiments, power generated by thermal power generation systems may be used to produce synthetic fuels. Synthetic fuels may comprise fuels that may be produced through chemical processes rather than through extraction of naturally occurring fossil fuels. Synthetic fuels that may be produced using power from thermal power generation systems may include one or more or any combination of the following: hydrogen, or ammonia, or methanol, or liquefied natural gas, or jet fuel, or diesel, or synthetic gasoline, or dimethyl ether, or Fischer-Tropsch fuels, or any combination thereof. The production of synthetic fuels using power from thermal power generation systems may provide a pathway for converting thermal energy from temperature differences between water and air into storable and transportable chemical energy.

In some embodiments, hydrogen may be produced using power generated by thermal power generation systems. Hydrogen production may be accomplished through electrolysis of water, wherein electrical power may be used to split water molecules into hydrogen and oxygen. Electrolysis systems that may be employed for hydrogen production may include one or more or any combination of the following: alkaline electrolyzers, or proton exchange membrane electrolyzers, or solid oxide electrolyzers, or anion exchange membrane electrolyzers, or any combination thereof. The electrical power required for electrolysis may be provided by generators driven by air turbines in the thermal power generation system. The hydrogen produced may be stored as compressed gas, as liquefied hydrogen, or in chemical carriers such as ammonia or liquid organic hydrogen carriers.

In some embodiments, ammonia may be produced using power generated by thermal power generation systems. Ammonia production may be accomplished through the Haber-Bosch process or through electrochemical synthesis. In the Haber-Bosch process, hydrogen and nitrogen may be combined at elevated temperatures and pressures in the presence of a catalyst to produce ammonia. The hydrogen for ammonia production may be produced through electrolysis using power from the thermal power generation system, and the nitrogen may be obtained from air through air separation processes that may also be powered by the thermal power generation system. Electrochemical ammonia synthesis may directly produce ammonia from water and nitrogen using electrical power. Ammonia may serve as a hydrogen carrier, as a fuel, or as a feedstock for fertilizer production.

In some embodiments, methanol may be produced using power generated by thermal power generation systems. Methanol production may be accomplished through the reaction of hydrogen with carbon dioxide or carbon monoxide. The hydrogen for methanol production may be produced through electrolysis using power from the thermal power generation system. The carbon dioxide for methanol production may be obtained from direct air capture systems, from industrial sources, from biomass, or from other carbon dioxide sources. Direct air capture systems may be powered by the thermal power generation system, and the airflow generated by the thermal power generation system may be directed through direct air capture contactors to capture carbon dioxide from the air. Methanol may serve as a fuel, as a chemical feedstock, or as a hydrogen carrier.

In some embodiments, liquefied natural gas may be produced using power generated by thermal power generation systems. Liquefied natural gas production may involve the liquefaction of natural gas through cooling to temperatures below approximately negative 162 degrees Celsius. The refrigeration systems required for natural gas liquefaction may be powered by the thermal power generation system. Natural gas for liquefaction may be obtained from natural gas pipelines, from natural gas wells, from biogas sources, or from synthetic natural gas production. Synthetic natural gas may be produced through the methanation of hydrogen and carbon dioxide, wherein the hydrogen may be produced through electrolysis using power from the thermal power generation system.

In some embodiments, jet fuel may be produced using power generated by thermal power generation systems. Jet fuel production may be accomplished through Fischer-Tropsch synthesis, through alcohol-to-jet processes, through hydroprocessing of renewable feedstocks, or through other synthetic fuel production pathways. Fischer-Tropsch synthesis may involve the reaction of hydrogen and carbon monoxide to produce hydrocarbon chains that may be refined into jet fuel. The hydrogen for Fischer-Tropsch synthesis may be produced through electrolysis using power from the thermal power generation system. The carbon monoxide may be produced through the reverse water-gas shift reaction of hydrogen and carbon dioxide, or through gasification of biomass or other carbon-containing feedstocks. Alcohol-to-jet processes may convert methanol or ethanol into jet fuel through dehydration, oligomerization, and hydrogenation reactions.

In some embodiments, diesel may be produced using power generated by thermal power generation systems. Diesel production may be accomplished through Fischer-Tropsch synthesis, through hydroprocessing of renewable feedstocks, or through other synthetic fuel production pathways. Fischer-Tropsch synthesis may produce hydrocarbon chains that may be refined into diesel fuel. The hydrogen required for Fischer-Tropsch synthesis and for hydroprocessing may be produced through electrolysis using power from the thermal power generation system. Synthetic diesel may have properties similar to petroleum-derived diesel and may be used in existing diesel engines without modification.

In some embodiments, synthetic fuel production may be conducted in remote Arctic locations. Remote Arctic locations may have access to cold ambient air temperatures that may provide temperature differences relative to liquid water for thermal power generation. Remote Arctic locations may also have limited access to electrical grid connections, which may make on-site power generation advantageous for synthetic fuel production. The combination of thermal power generation and synthetic fuel production in remote Arctic locations may allow the energy from temperature differences between water and air to be converted into transportable chemical energy in the form of synthetic fuels.

In some embodiments, synthetic fuel production facilities in remote Arctic locations may operate seasonally. The thermal power generation system may operate during winter months when cold ambient air temperatures may be available, and the synthetic fuel production facility may produce synthetic fuels during the operating season. The synthetic fuels produced may be stored on-site until transportation may be available. Transportation from remote Arctic locations may be limited to certain periods when ice conditions may allow ship access, when ice roads may be passable, or when other transportation modes may be available.

In some embodiments, synthetic fuels produced in remote Arctic locations may be stored in storage facilities. Storage facilities for synthetic fuels may include one or more or any combination of the following: pressurized tanks for compressed hydrogen, or cryogenic tanks for liquefied hydrogen, or atmospheric tanks for ammonia, or atmospheric tanks for methanol, or cryogenic tanks for liquefied natural gas, or atmospheric tanks for jet fuel, or atmospheric tanks for diesel, or underground storage caverns, or any combination thereof. The storage facilities may be sized to accommodate the synthetic fuel production during the operating season and to hold the produced fuels until transportation may be available.

In some embodiments, synthetic fuels produced in remote Arctic locations may be transported when transportation access may be available. Transportation of synthetic fuels from remote Arctic locations may be accomplished through one or more or any combination of the following: tanker ships, or ice-classed tanker ships, or barges, or tank trucks, or rail tank cars, or pipelines, or any combination thereof. The transportation mode may depend on the type of synthetic fuel, the quantity of synthetic fuel, the distance to markets, the available infrastructure, and the seasonal accessibility of the remote location.

In some embodiments, hydrogen produced in remote Arctic locations may be transported as compressed hydrogen, as liquefied hydrogen, or as a chemical carrier. Compressed hydrogen may be transported in high-pressure tube trailers or in compressed gas cylinders. Liquefied hydrogen may be transported in cryogenic tanker ships or in cryogenic tank trucks. Chemical carriers for hydrogen may include ammonia, methanol, liquid organic hydrogen carriers, or other compounds that may be converted back to hydrogen at the destination. The selection of hydrogen transport mode may depend on the distance to markets, the quantity of hydrogen, the available infrastructure, and the end-use application.

In some embodiments, ammonia produced in remote Arctic locations may be transported in refrigerated tanker ships, in pressurized tanker ships, or in tank trucks. Ammonia may be stored and transported as a liquid at atmospheric pressure and temperatures below approximately negative 33 degrees Celsius, or as a liquid under pressure at ambient temperatures. Ammonia may be transported to markets where the ammonia may be used as a fuel, as a hydrogen carrier, or as a feedstock for fertilizer production.

In some embodiments, methanol produced in remote Arctic locations may be transported in tanker ships, in barges, or in tank trucks. Methanol may be stored and transported as a liquid at atmospheric pressure and ambient temperatures. Methanol may be transported to markets where the methanol may be used as a fuel, as a chemical feedstock, or as a hydrogen carrier.

In some embodiments, liquefied natural gas produced in remote Arctic locations may be transported in cryogenic tanker ships. Liquefied natural gas tanker ships may be equipped with cryogenic cargo containment systems that may maintain the liquefied natural gas at temperatures below approximately negative 162 degrees Celsius. Ice-classed liquefied natural gas tanker ships may be employed to transport liquefied natural gas from remote Arctic locations where ice conditions may be present.

In some embodiments, jet fuel produced in remote Arctic locations may be transported in tanker ships, in barges, or in tank trucks. Jet fuel may be stored and transported as a liquid at atmospheric pressure and ambient temperatures. Jet fuel may be transported to airports, to fuel distribution terminals, or to other destinations where the jet fuel may be used for aviation.

In some embodiments, diesel produced in remote Arctic locations may be transported in tanker ships, in barges, or in tank trucks. Diesel may be stored and transported as a liquid at atmospheric pressure and ambient temperatures. Diesel may be transported to fuel distribution terminals, to industrial facilities, or to other destinations where the diesel may be used for transportation, for power generation, or for other applications.

In some embodiments, the production of synthetic fuels in remote Arctic locations may provide economic benefits. The thermal power generation system may convert the temperature difference between water and cold air into electrical power at low cost, and the electrical power may be used to produce synthetic fuels that may have higher value than the electrical power. The synthetic fuels may be transported to markets where the fuels may command prices that may provide economic returns on the investment in the thermal power generation system and the synthetic fuel production facility.

In some embodiments, the production of synthetic fuels in remote Arctic locations may provide environmental benefits. The synthetic fuels may be produced using renewable energy from the temperature difference between water and air, which may reduce the carbon footprint of the synthetic fuels compared to fossil fuel-derived fuels. When carbon dioxide for synthetic fuel production may be obtained from direct air capture, the synthetic fuels may be carbon-neutral or may have negative carbon emissions on a lifecycle basis.

In some embodiments, synthetic fuel production facilities in remote Arctic locations may be integrated with other operations. Other operations that may be integrated with synthetic fuel production may include one or more or any combination of the following: ice production for sea ice enhancement, or freshwater production through freeze desalination, or salt production, or mineral extraction, or direct air capture of carbon dioxide, or any combination thereof. The integration of multiple operations may improve the overall economics of the facility and may provide multiple revenue streams.

In some embodiments, synthetic fuel production facilities in remote Arctic locations may be configured for autonomous or semi-autonomous operation. Autonomous or semi-autonomous operation may reduce the need for personnel to be present at the remote location, which may reduce operating costs and may improve safety. Control systems may monitor and control the thermal power generation system, the synthetic fuel production processes, the storage systems, and other facility components. Remote monitoring and control may allow operators at distant locations to supervise facility operations and to intervene when needed.

In some embodiments, synthetic fuel production facilities in remote Arctic locations may be configured for modular construction. Modular construction may involve the fabrication of facility components at manufacturing locations and the transportation of the fabricated modules to the remote Arctic location for assembly. Modular construction may reduce construction time at the remote location, may improve quality control, and may allow construction to proceed in controlled conditions regardless of weather at the remote location.

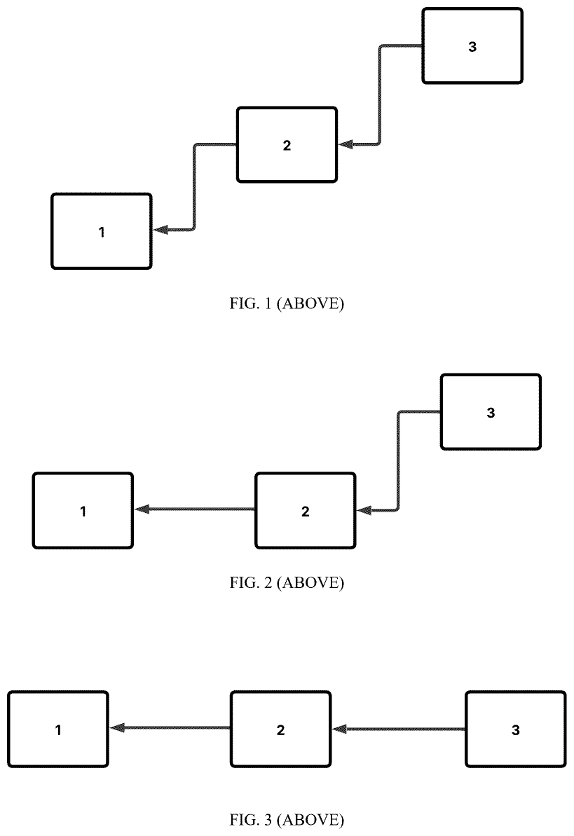

In some embodiments, FIG. 1 and FIG. 2 may comprise schematic flow diagrams illustrating the transfer of materials between system components at different elevations within a thermal power generation system. FIG. 1 and FIG. 2 may depict three rectangular boxes labeled 1, 2, and 3 arranged in a descending diagonal pattern, connected by lines with directional arrows indicating flow direction. Box 3 may be positioned at a higher elevation, box 2 may be located at an intermediate elevation, and box 1 may be positioned at a lower elevation. Connecting lines with arrows may extend from box 3 toward box 2, and from box 2 toward box 1. In some embodiments, box 3 may represent a water source at a higher elevation than the thermal power generation system represented by box 2, which in turn may be at a higher elevation than the deposit or disposal location represented by box 1. The descending elevation arrangement from element 3 to element 2 to element 1 may enable potential power recovery or power generation from the transfer of fluid comprising water from the higher elevation water source to the lower elevation thermal power generation system, and may subsequently enable additional power recovery or power generation from the transfer of cooled water or water derivative materials from the thermal power generation system to the still lower elevation deposit or disposal location.

In some embodiments, FIG. 3 may comprise a schematic diagram showing three rectangular boxes labeled with the numbers 1, 2, and 3 from left to right, connected by arrows indicating a directional flow from right to left. An arrow may point from box 3 toward box 2, and another arrow may point from box 2 toward box 1. All three boxes may be positioned at approximately the same horizontal elevation, suggesting that the components they represent may be located at similar heights relative to one another. In some embodiments, a fluid comprising water may be transferred from a source represented by box 3 to a thermal power generation system represented by box 2, which may generate power from the temperature difference between the fluid and adjacent air. The cooled water or water derivative may then be transferred from the thermal power generation system to a deposit or disposal location represented by box 1. The substantially equal elevation of all three components may indicate that the transfer of fluid and materials between the source, the thermal power generation system, and the disposal location may be accomplished with relatively minimal energy consumption.

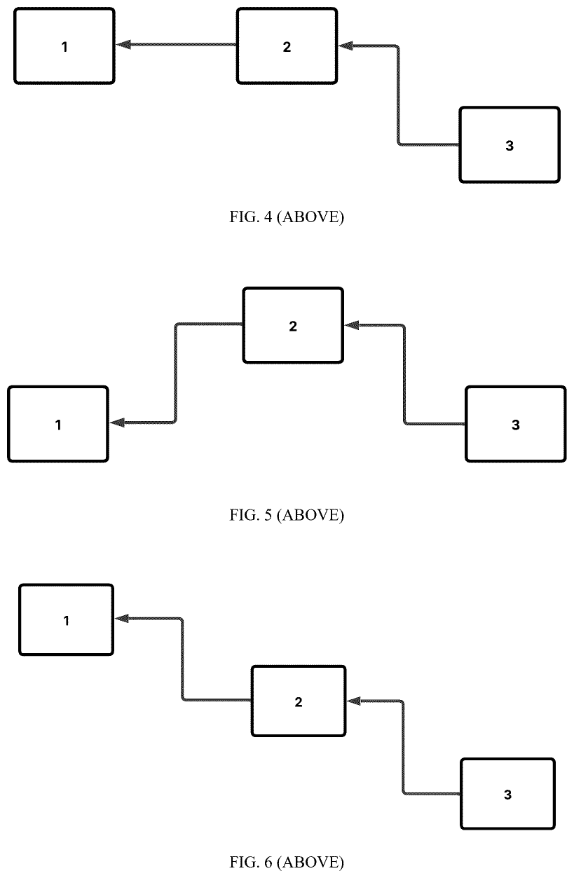

In some embodiments, FIG. 4 may comprise a schematic flow diagram illustrating the transfer of fluid comprising water between three system components at different elevations. Three rectangular boxes labeled 1, 2, and 3 may be arranged with connecting arrows showing the direction of flow between them. Box 3, positioned on the right side at a lower elevation, may represent the water source. An arrow may extend upward and to the left from box 3, connecting to box 2, which may be positioned at a higher elevation in the center of the diagram. Box 2 may represent the thermal power generation system that generates power from the temperature difference between the water and adjacent air. A second arrow may extend from box 2 to box 1, which may be positioned on the left side at an elevation higher than box 2. Box 1 may represent the deposit or disposal location for the cooled water or water derivative. The stepped arrangement of the boxes may illustrate a configuration where power consumption may be required to transfer water from the lower elevation source at position 3 to the higher elevation thermal power generation system at position 2.

In some embodiments, FIG. 5 may comprise a schematic flow diagram illustrating the transfer of fluid comprising water between three system components at different elevations. The diagram may show three rectangular boxes labeled with numbers 1, 2, and 3, connected by directional arrows indicating flow paths. Box 3, positioned on the right side at a lower elevation, may represent the water source. Box 2, positioned at the top center at a higher elevation, may represent the thermal power generation system. Box 1, positioned on the left side at a lower elevation than box 2, may represent the deposit or disposal location for cooled water or water derivative. The arrows may show fluid flow from the water source upward to the thermal power generation system, and then from the thermal power generation system downward to the deposit or disposal location.

In some embodiments, FIG. 6 may comprise a schematic flow diagram illustrating the transfer of materials between three system components at different elevations. Three rectangular boxes may be shown, labeled with numbers 1, 2, and 3, arranged in a descending diagonal pattern from upper left to lower right. Box 1 may be positioned at a higher elevation in the upper left portion of the diagram, box 2 may be located at an intermediate elevation in the center, and box 3 may be positioned at a lower elevation in the lower right. Connecting lines with directional arrows may link the boxes, showing the flow path between components.

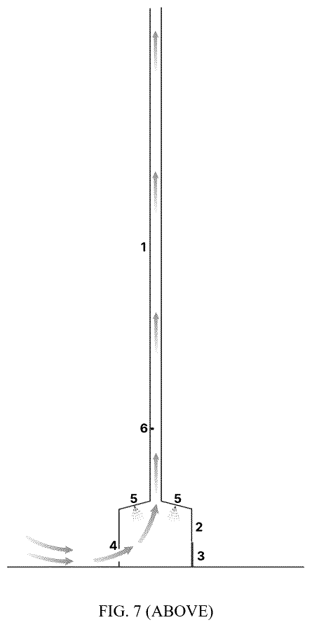

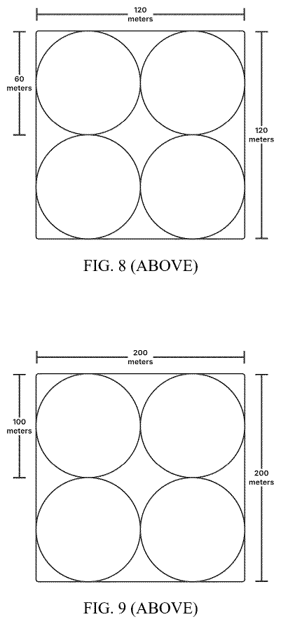

In some embodiments, FIG. 7 may comprise a side elevation view of an updraft tower system configured for power generation from thermal energy transfer between water and air. The system may comprise a substantially vertical tower structure labeled as element 1, which may extend upward from a base region. Element 3 may represent a ground or base surface level. Element 2 may indicate a structural housing or enclosure positioned at the base of the tower. Elements labeled 5 on either side of the base structure may represent spray nozzles or water distribution components configured to introduce water into the air stream. Element 6 may denote a region within the tower where upward airflow occurs, as may be indicated by upward-pointing arrows shown along the vertical extent of the tower interior. Element 4 may represent incoming ambient air flow, depicted by curved arrows entering the base region.

In some embodiments, FIG. 8 may comprise a top-down schematic view of a rectangular area measuring approximately 120 meters in width and approximately 120 meters in height, with an additional dimension of approximately 60 meters indicated on the left side. Within the rectangular boundary, four identical circles may be arranged in a two-by-two grid pattern. The circles may be positioned symmetrically within the rectangular enclosure. In some embodiments, the configuration may represent a layout for multiple water pools, basins, or water-air contacting zones arranged within a defined footprint for a thermal power generation system.

In some embodiments, FIG. 9 may comprise a top-down schematic view of a square area measuring approximately 200 meters by approximately 200 meters, with an additional dimension of approximately 100 meters indicated on the left side. Within the square boundary, four identical circles may be arranged in a two-by-two grid pattern. The circles may be positioned symmetrically within the square enclosure. In some embodiments, the configuration may represent a layout for multiple water pools, basins, or water-air contacting zones arranged within a defined operational area of a thermal power generation system.

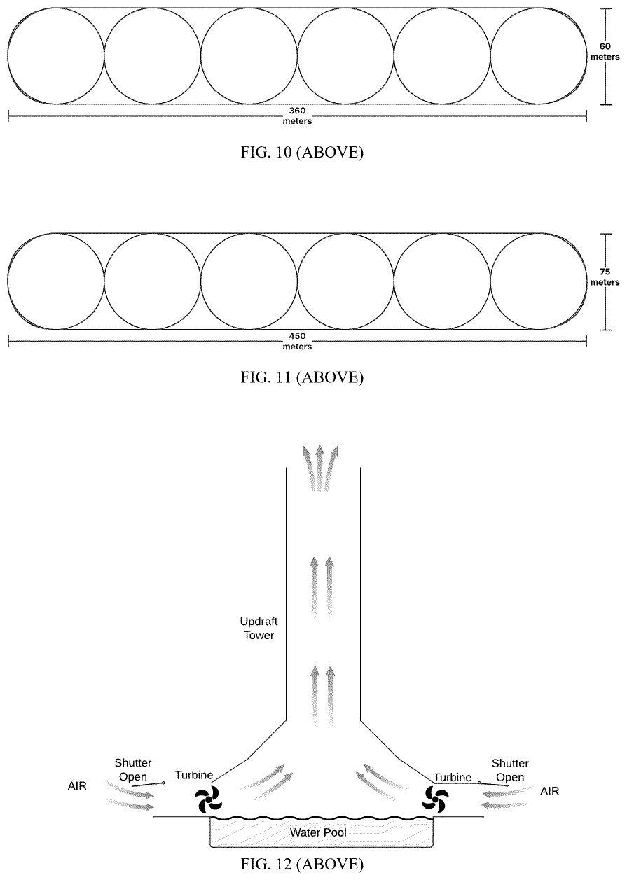

In some embodiments, FIG. 10 may comprise a rectangular arrangement of six circles positioned in a horizontal row within an elongated enclosure. FIG. 10 may comprise an offshore or ship-shaped system or structure. The overall structure may span approximately 360 meters in length and approximately 60 meters in height. Each circle may appear to be tangent to its adjacent circles and to the top and bottom boundaries of the rectangular enclosure. In some embodiments, the arrangement may represent a cross-sectional view of cylindrical structures, such as towers or conduits, positioned within a defined spatial envelope.

In some embodiments, FIG. 11 may comprise a schematic top-down view of a rectangular enclosure containing six circular elements arranged in a single horizontal row. FIG. 11 may comprise an offshore or ship-shaped system or structure. The overall structure may have a total length of approximately 450 meters and a width of approximately 75 meters. The six circles may appear to be identical in size and may be positioned in close proximity to one another. In some embodiments, the configuration may represent a top-down view of multiple updraft towers, water pools, water-air contacting zones, or thermal exchange zones arranged in a linear array within a contained facility footprint.

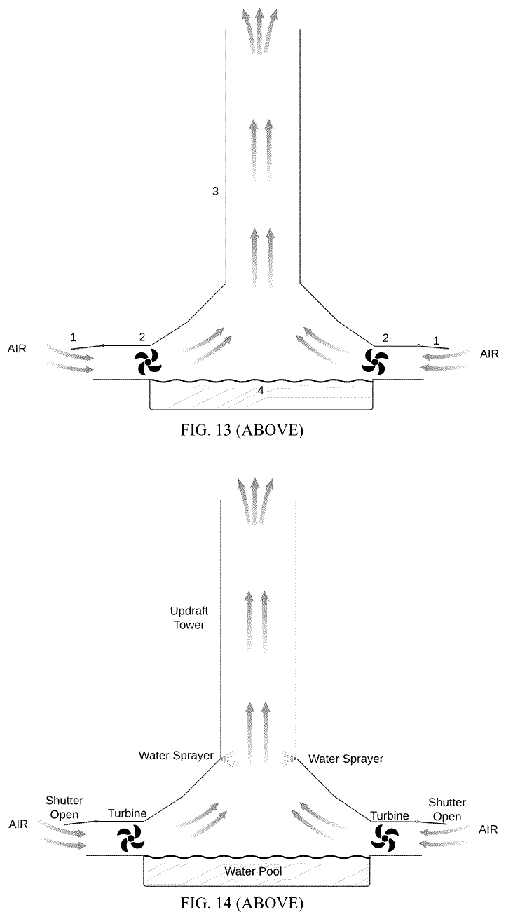

In some embodiments, FIG. 12 and FIG. 13 may comprise cross-sectional schematic views of an updraft tower system configured for power generation from the temperature difference between water and air. The central vertical structure may be labeled as the Updraft Tower or element 3, shown with blue arrows indicating the upward flow of air through its interior. At the base of the tower on both the left and right sides, there may be openings labeled Shutter Open or element 1, which may represent adjustable flow control elements that permit ambient air to enter the system. Adjacent to each shutter opening may be a Turbine or element 2, depicted as a fan-like symbol with curved blades, positioned to capture kinetic energy from the incoming airflow. At the bottom center of the structure, beneath the tower interior, may be a Water Pool or element 4 shown as a rectangular basin containing water.

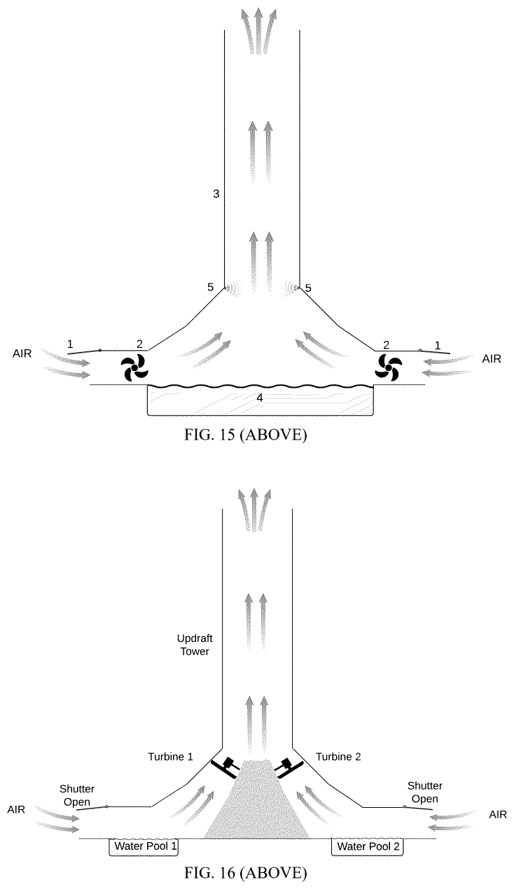

In some embodiments, FIG. 14 and FIG. 15 may comprise cross-sectional schematic views of an updraft tower system configured for power generation from the temperature difference between water and air. The central vertical structure may be labeled as the Updraft Tower or element 4, shown with upward-pointing blue arrows indicating the direction of rising warm air flow through the tower interior. At the base of the tower, the system may include a Water Pool or element 4 positioned centrally. On either side of the tower base, symmetrically arranged components may include Water Sprayers or elements 7 and 8 that direct water into contact with incoming air. The air inlet configuration may show Shutters in the Open position or element 1 on both the left and right sides of the base structure. Turbines or elements 2 and 3 may be positioned at each air inlet location between the open shutters and the central water contacting zone.

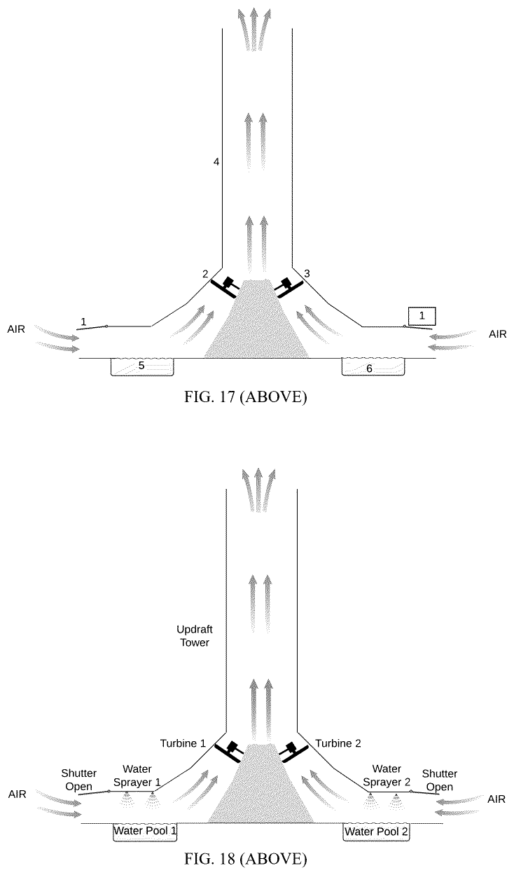

In some embodiments, FIG. 16 and FIG. 17 may comprise cross-sectional side views of an updraft tower power generation system configured with water pools positioned before the air contacts the turbines. The central vertical structure may be labeled as the Updraft Tower or element 4, shown with upward-pointing blue arrows indicating the direction of rising warm air flow through the tower interior. At the base of the tower, two turbines may be positioned symmetrically, labeled as Turbine 1 and Turbine 2 or elements 2 and 3. Below and to the sides of the turbines may be two water pools labeled Water Pool 1 and Water Pool 2 or elements 5 and 6. On either side of the structure, open shutters or element 1 may be shown with horizontal arrows indicating ambient air entering the system.

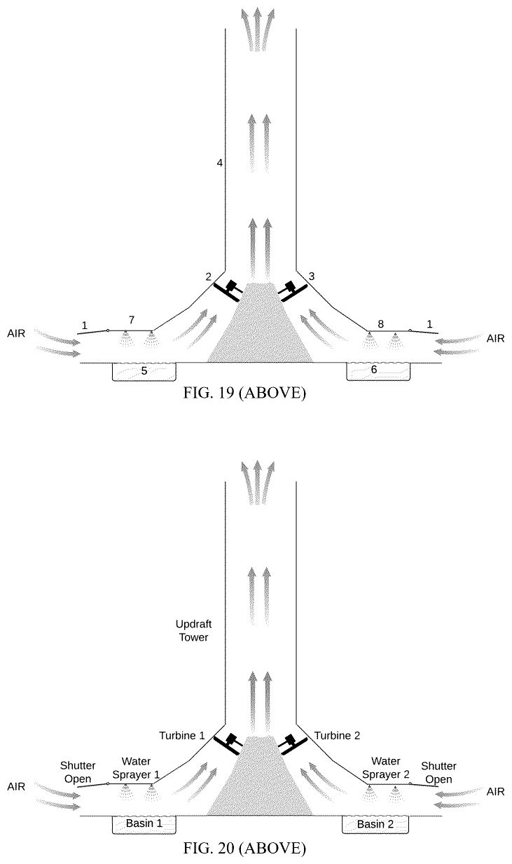

In some embodiments, FIG. 18 and FIG. 19 may comprise cross-sectional side views of an updraft tower power generation system configured with water-air contacting zones positioned before the air passes through the turbines. The system may show a central vertical updraft tower or element 4 with upward-pointing arrows indicating the direction of rising warm air flow. At the base of the tower, two turbines labeled Turbine 1 and Turbine 2 or elements 2 and 3 may be positioned on opposite sides. Below each turbine, water sprayers designated as Water Sprayer 1 and Water Sprayer 2 or elements 7 and 8 may be shown directing water into the airflow path. Beneath the water sprayers may be two water pools or basins labeled as elements 9 and 10 or Water Pool 1 and Water Pool 2. On the outer edges of the system, open shutters or element 1 may be shown on both the left and right sides.

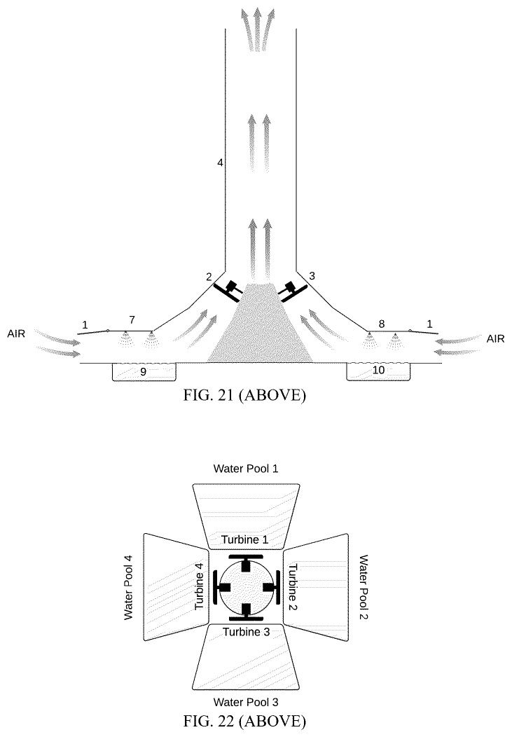

In some embodiments, FIG. 20 and FIG. 21 may comprise cross-sectional side views of an updraft tower system configured for power generation from the temperature difference between water and air. At the center of the illustration may be a vertically oriented updraft tower or element 4 with multiple upward-pointing arrows indicating the direction of rising warm air flow through the tower interior. At the base of the tower, two turbines may be positioned symmetrically on either side, labeled as Turbine 1 and Turbine 2 or elements 2 and 3. On each side of the base structure, the system may include adjustable shutters shown in an open position or element 1. Between the shutters and the turbines, water sprayers may be positioned on each side, labeled as Water Sprayer 1 and Water Sprayer 2 or elements 7 and 8. Below the water sprayers, two basins may be shown at the base of the system, labeled as Basin 1 and Basin 2 or elements 9 and 10.

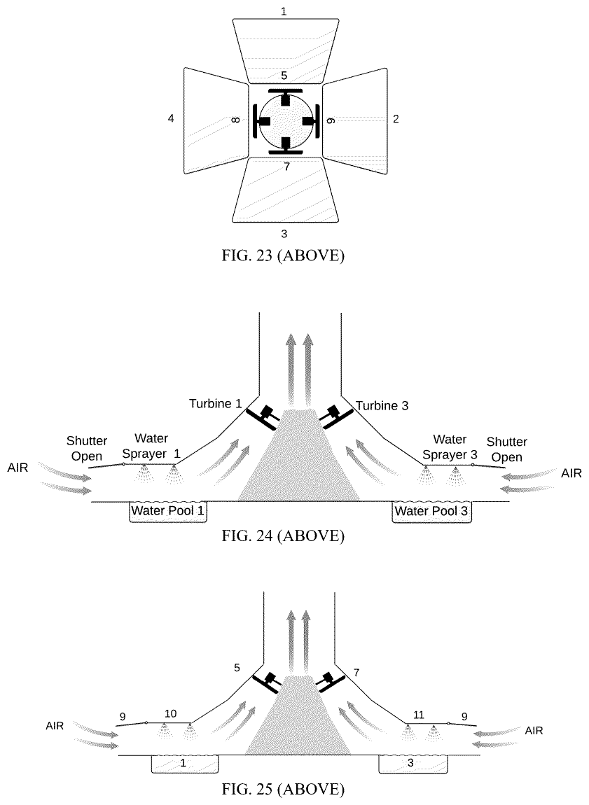

In some embodiments, FIG. 22 and FIG. 23 may comprise top-down schematic views of an updraft tower power generation system configuration. At the center of the diagram may be a circular structure containing turbines, labeled as Turbine 1 through Turbine 4 or element 5, arranged in a cross pattern. Surrounding the central turbine assembly may be four trapezoidal water pools positioned at the cardinal directions, labeled Water Pool 1 through Water Pool 4 or elements 1 through 4. Each water pool may be shown in a light blue color and may taper inward toward the central turbine structure. Between the water pools and the central turbine, smaller rectangular elements may be visible, labeled as elements 5, 7, 8, and 9, which may represent shutters or flow control elements.

In some embodiments, FIG. 24 and FIG. 25 may comprise horizontal cross-sectional or side views of an updraft tower power generation system configured for operation with adjustable shutters on both sides. The system may show a symmetrical arrangement with air inlets on the left and right sides, each equipped with a shutter in the open position or element 9. Adjacent to each shutter may be a water sprayer, labeled Water Sprayer 1 and Water Sprayer 3 or elements 10 and 11. Blue curved arrows on both sides may indicate the direction of ambient air entering the system through the open shutters. The central portion of the system may contain air turbines. Below the water sprayers may be water pools or basins labeled as elements 1 and 3.

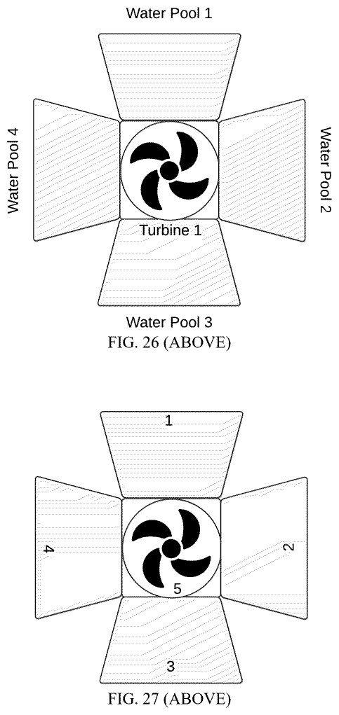

In some embodiments, FIG. 26 and FIG. 27 may comprise top-down schematic views of an updraft tower system configuration showing a central turbine surrounded by four water pools arranged in a cross pattern. At the center of the image may be Turbine 1 or element 5, depicted as a circular element containing a fan or turbine blade symbol. Surrounding the central turbine may be four trapezoidal-shaped water pools labeled Water Pool 1 through Water Pool 4 or elements 1 through 4, each oriented with its narrower end pointing toward the central turbine and its wider end facing outward.

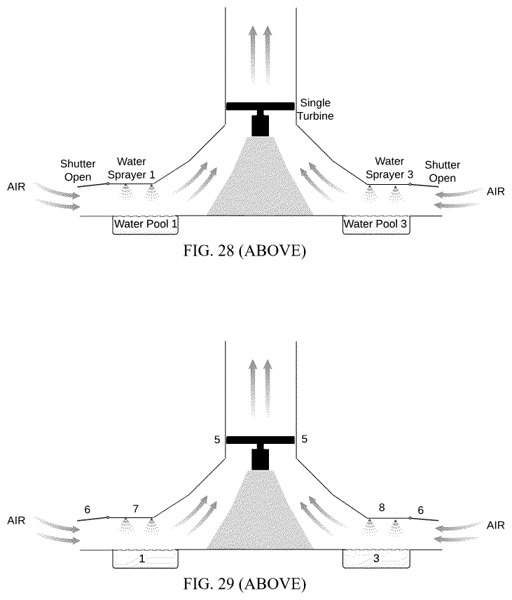

In some embodiments, FIG. 28 and FIG. 29 may comprise cross-sectional side views of an updraft tower power generation system configured with a single turbine positioned at the top center of the structure. The system may show air entering from both the left and right sides through open shutters or element 6, indicated by curved arrows showing the airflow direction moving inward toward the center of the structure. On each side of the base, there may be water pools labeled as Water Pool 1 and Water Pool 3 or elements 1 and 3. Above each water pool, water sprayers may be positioned, labeled as Water Sprayer 1 and Water Sprayer 3 or elements 7 and 8. At the top of the tower, a single turbine or element 5 may be positioned to capture the kinetic energy of the rising warm air.

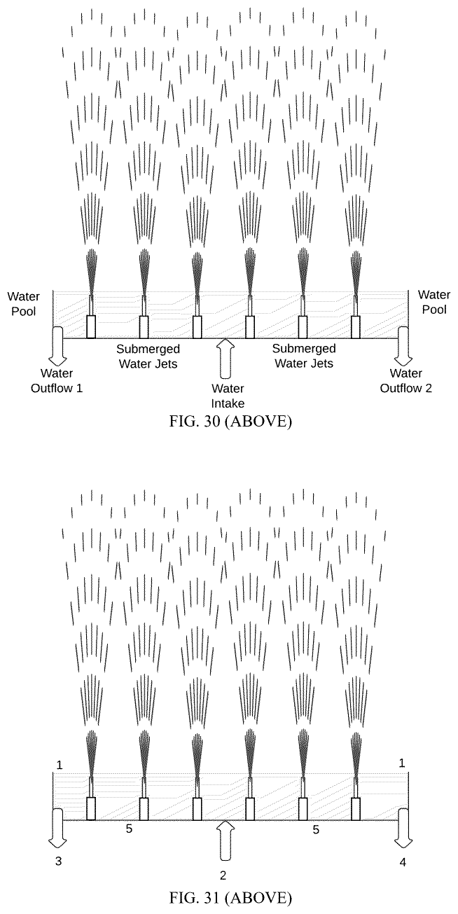

In some embodiments, FIG. 30 may comprise a water pool system with submerged water jets configured for water-air contacting in a thermal power generation application. The illustration may show a cross-sectional side view of a rectangular water pool containing multiple submerged water jets arranged in a row along the bottom portion of the pool. Each water jet may be shown projecting water upward in a fan-shaped spray pattern. The pool may be labeled as Water Pool on both the left and right sides. Below the pool, the system may include a central Water Intake positioned in the middle bottom of the pool, and two Water Outflow points labeled as Water Outflow 1 on the left side and Water Outflow 2 on the right side.

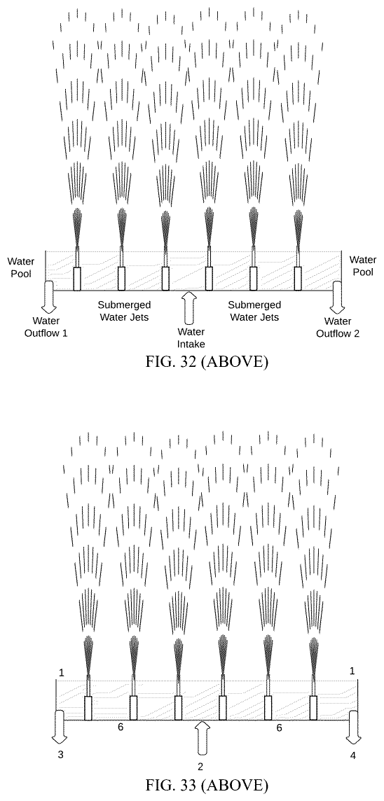

In some embodiments, FIG. 31 and FIG. 32 may comprise schematic views of a water distribution and spray system configured for air-water contacting in a thermal power generation application. The system may comprise a horizontal basin or conduit labeled as element 1, which may extend across the width of the figure and may contain water. Multiple water spray nozzles labeled as element 5 may be positioned along the length of the basin. Each spray nozzle may produce an upward-directed spray pattern that disperses water droplets into the air above the basin. Element 2 may be indicated by an upward-pointing arrow at the center bottom of the basin, suggesting a water inlet or supply flow. Elements 3 and 4 may be shown as downward-pointing arrows at the left and right ends of the basin respectively, indicating water outflow or drainage paths.

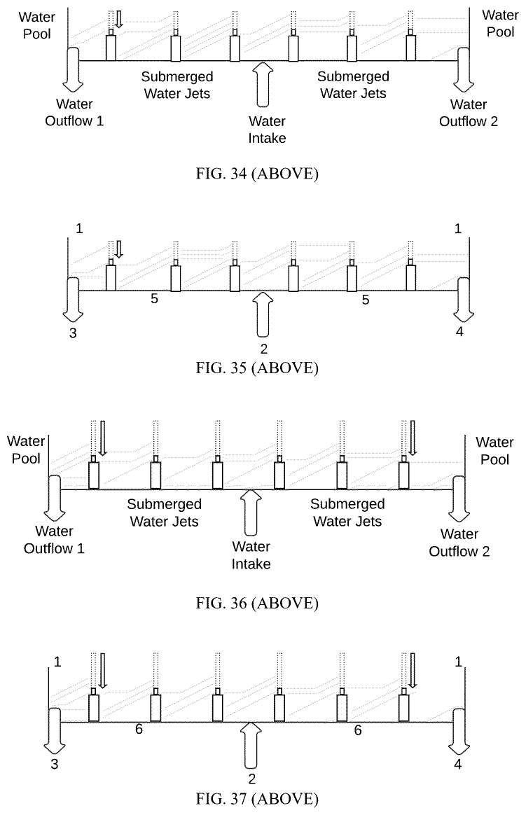

In some embodiments, FIG. 33 and FIG. 34 may comprise schematic views of a water pool system configured for ice removal operations with submerged water jets. The system may show a rectangular water pool containing submerged water jets positioned along the bottom portion of the pool. The pool may include a Water Intake or element 2 located at the center bottom, which may draw water into the circulation system. On either side of the pool, water outflow points may be positioned, with Water Outflow 1 or element 3 on the left side and Water Outflow 2 or element 4 on the right side. The submerged water jets may be depicted as vertical elements extending upward from a horizontal pipe or manifold beneath the water surface, labeled as element 5 or element 6.

In some embodiments, FIG. 35 and FIG. 36 may comprise schematic views of a horizontal elongated structure representing a thermal power generation system or water transfer conduit. The structure may be shown as a light blue rectangular bar extending horizontally across the image. At the top surface of the structure, there may be vertical elements with dashed lines, labeled as element 5, which may represent water sprayers or nozzles arranged in a symmetrical pattern. At the left end of the structure, there may be a downward-pointing arrow labeled as element 3, indicating a flow direction or outlet. At the right end, there may be a similar downward-pointing arrow labeled as element 4. In the center bottom of the structure, there may be an upward-pointing arrow labeled as element 2, suggesting an inlet or input flow. The two ends of the top surface may be marked with the number 1.

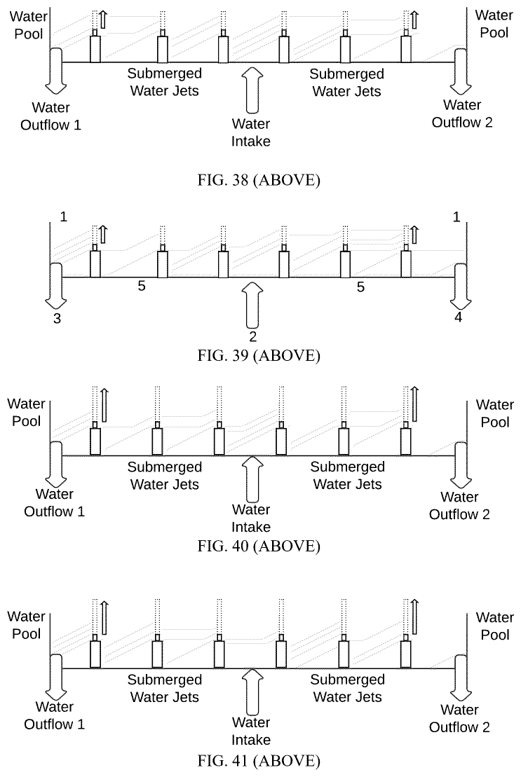

In some embodiments, FIG. 37 and FIG. 38 may comprise schematic views of a thermal power generation system showing the transfer of fluid comprising water between different elevations. The diagram may illustrate a horizontal elongated structure representing a thermal exchange zone or basin. At the left end, a large downward-pointing arrow labeled element 3 may indicate a water source or fluid inlet. At the right end, a large downward-pointing arrow labeled element 4 may indicate a deposit or disposal location. In the center bottom of the structure, an upward-pointing arrow labeled element 2 may represent the thermal power generation system. Along the top surface of the structure, there may be multiple small rectangular elements with upward-pointing dashed arrows labeled element 1 at both ends and element 5 in the middle sections, which may represent water sprayers or fluid distribution elements.

In some embodiments, FIG. 39 and FIG. 40 may comprise schematic views of a thermal power generation system showing the transfer of fluids between different elevations. The diagram may illustrate a horizontal elongated structure shown in light blue shading, representing a thermal exchange zone or basin. At the left end, a large downward-pointing arrow labeled element 3 may indicate a water source or fluid inlet at a lower elevation. At the right end, a large downward-pointing arrow labeled element 4 may indicate a deposit or disposal location. In the center bottom of the structure, an upward-pointing arrow labeled element 2 may represent the thermal power generation system. Along the top surface of the structure, there may be multiple small rectangular elements with upward-pointing dashed arrows labeled element 1 at both ends and element 5 in the middle sections.

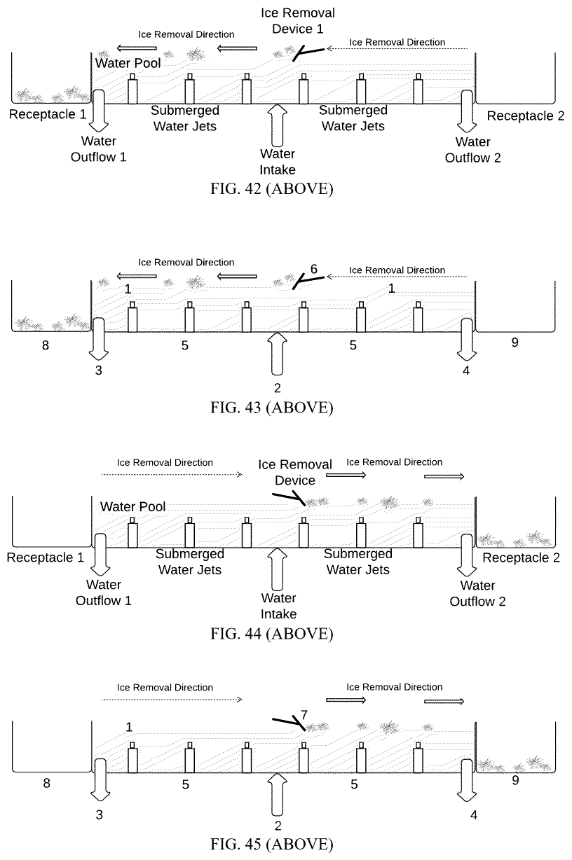

In some embodiments, FIG. 41 may comprise a schematic top-down view of a water pool system configured for water circulation and ice management within a thermal power generation system. The water pool may be shown as a horizontal elongated rectangular basin with water flowing through it. At the center of the pool, a water intake may be positioned, indicated by a downward-pointing arrow showing water being drawn into the system. On either side of the central water intake, multiple submerged water jets may be arranged in a linear configuration. At each end of the water pool, water outflow points may be shown, labeled as Water Outflow 1 on the left side and Water Outflow 2 on the right side.

In some embodiments, FIG. 42 and FIG. 43 may comprise schematic views of an ice removal and water circulation system for a water pool used in a thermal power generation system. The diagram may show a rectangular water pool with an ice removal direction indicated by dashed arrows pointing from the center toward both the left and right sides of the pool. At the center top of the pool may be an ice removal device or element 6 represented by a hatched rectangular element. On either side of the pool may be receptacles labeled Receptacle 1 or element 8 on the left and Receptacle 2 or element 9 on the right. The pool may contain multiple submerged water jets or element 5 arranged in two groups on either side of a central water intake or element 2. Water outflow points may be positioned at the lower corners of the pool, with Water Outflow 1 or element 3 on the left side and Water Outflow 2 or element 4 on the right side.

In some embodiments, FIG. 44 and FIG. 45 may comprise schematic views of an ice removal system for a water basin or pool used in a thermal power generation system. The diagram may show a rectangular basin represented by a light blue shaded area in the center, with ice accumulation indicated by irregular crystalline shapes. Two directional indicators labeled Ice Removal Direction may appear at the top of the image, with arrows pointing in opposite directions from the center toward the outer edges. The basin may contain multiple small rectangular elements labeled with element 5, which may represent water jets or spray nozzles. On the left side, element 8 may indicate a component at the basin edge, while elements 3 and 4 may mark receptacles or collection points at the lower corners of the basin. Element 2 with an upward-pointing arrow at the bottom center may indicate a water intake or circulation point.

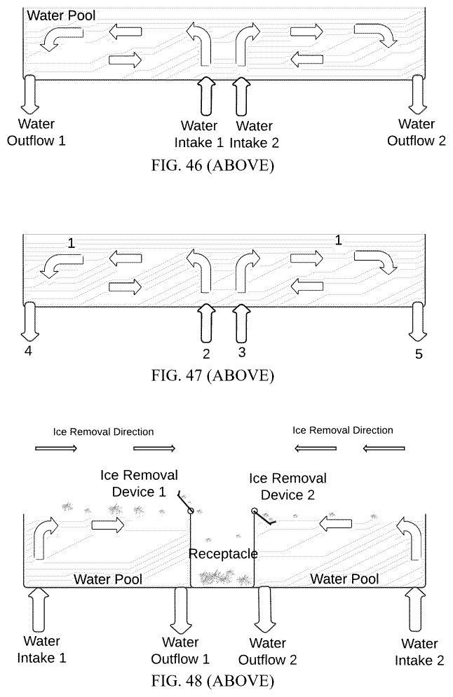

In some embodiments, FIG. 46 and FIG. 47 may comprise top-down schematic views of a water pool configuration showing water circulation and flow patterns within the system. The rectangular water pool may be shown in light blue and may contain multiple curved arrows indicating the direction of water movement and circulation within the pool. Two water intake points labeled Water Intake 1 and Water Intake 2 or elements 2 and 3 may be positioned at the bottom center of the pool, indicated by upward-pointing gray arrows. Two water outflow points labeled Water Outflow 1 and Water Outflow 2 or elements 4 and 5 may be positioned at the left and right sides of the pool respectively, indicated by downward-pointing gray arrows. Element 1 may indicate the water pool regions.

In some embodiments, FIG. 48 and FIG. 49 may comprise top-down schematic views of a dual water pool ice removal system with a central receptacle positioned between two symmetrical water pools. Each water pool may be shown as a rectangular basin with light blue shading representing the water contained within, labeled as element 1. The system may include ice removal devices positioned above each pool, labeled as Ice Removal Device 1 and Ice Removal Device 2 or elements 6 and 7. Arrows above each ice removal device may indicate the ice removal direction. The receptacle or element 8 may be positioned centrally between the two pools to receive ice removed from both sides. Each water pool may have associated water intake and outflow connections, with Water Intake 1 and Water Intake 2 or elements 2 and 3, and Water Outflow 1 and Water Outflow 2 or elements 4 and 5.

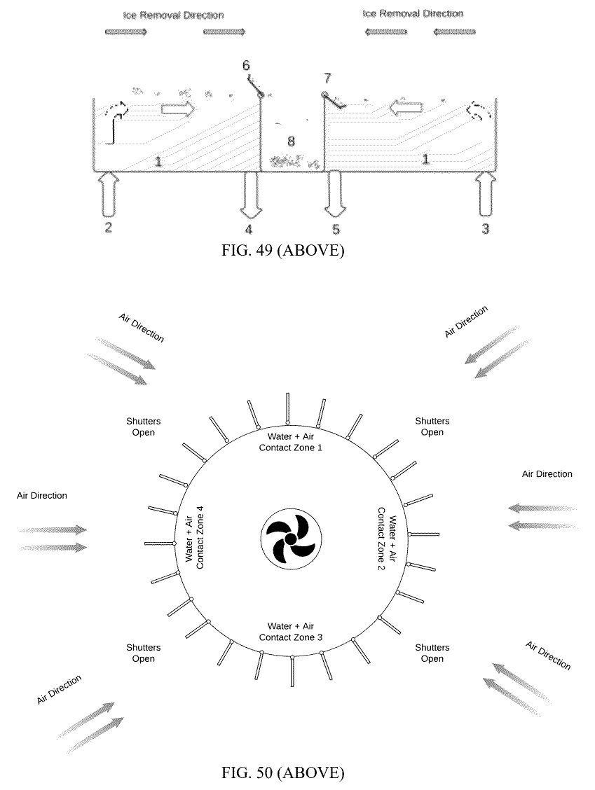

In some embodiments, FIG. 50 and FIG. 51 may comprise top-down schematic views of an updraft tower system configured for thermal power generation, showing the arrangement of shutters, water-air contact zones, and a central turbine. The circular structure may be divided into four distinct water plus air contact zones labeled as Contact Zone 1 through Contact Zone 4 or elements 1 through 4, positioned at the top, right, bottom, and left quadrants respectively. At the center of the configuration may be a turbine or element 5 represented by a air turbine symbol. Around the perimeter of the structure, multiple shutters may be shown in the open position, indicated by short radial lines extending outward from the circular boundary. Blue arrows labeled Air Direction may be positioned at multiple locations around the exterior of the structure, pointing inward from all directions.

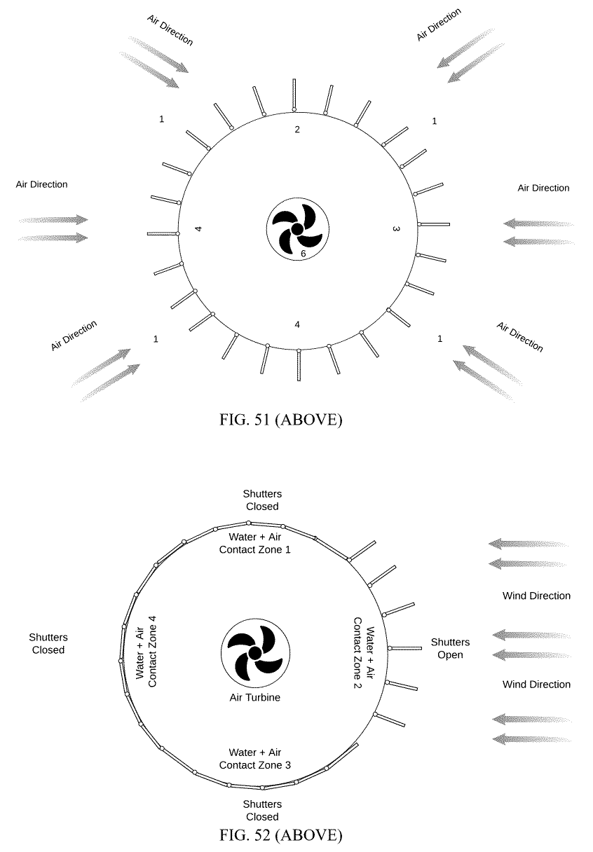

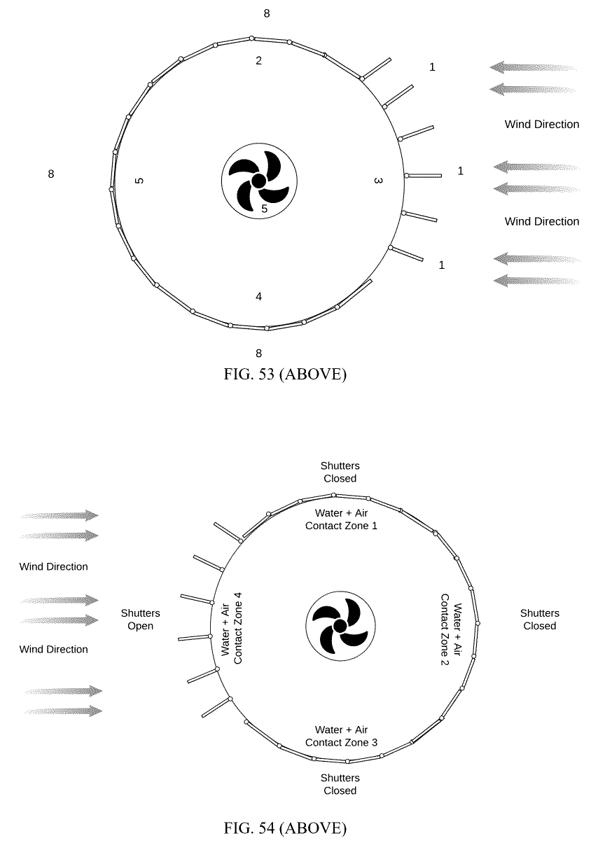

In some embodiments, FIG. 52 and FIG. 53 may comprise top-down schematic views of an updraft tower system configured for power generation, showing the arrangement of shutters, water-air contact zones, and an air turbine. The circular structure may feature a central air turbine or element 5 or 6 represented by a air turbine symbol, surrounded by four water-air contact zones labeled as Contact Zone 1 through Contact Zone 4 or elements 2 through 5. The perimeter of the structure may include multiple shutter elements represented by short lines extending outward from the circular boundary. The shutters on the top, bottom, and left sides may be shown in a closed configuration or element 8, while the shutters on the right side may be depicted in an open configuration or element 1. Blue arrows on the right side of the image may indicate the wind direction flowing from right to left toward the structure.

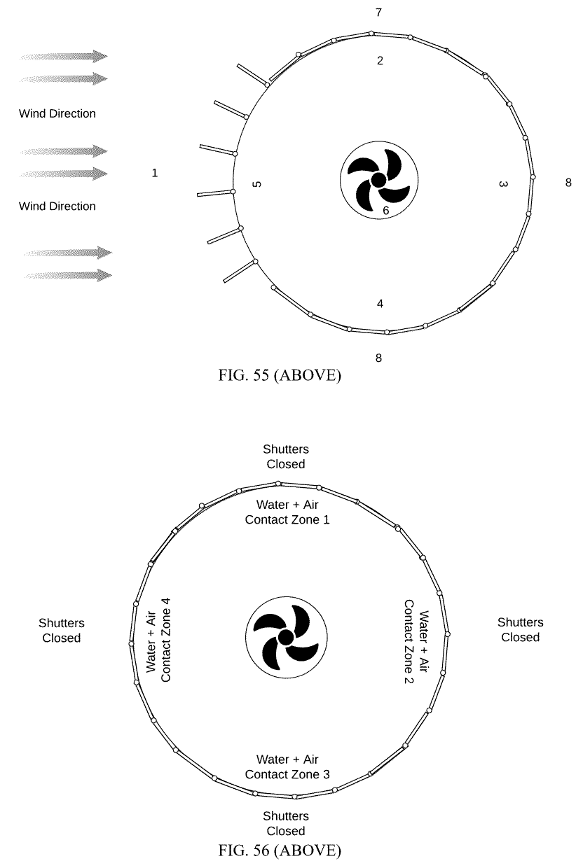

In some embodiments, FIG. 54 and FIG. 55 may comprise top-down schematic views of an updraft tower system configured for power generation, illustrating the operational state where wind may be approaching from the left side of the diagram. The circular structure may feature a central turbine or element 6 represented by a air turbine symbol at the core, surrounded by four distinct water and air contact zones labeled as Contact Zone 1 through Contact Zone 4 or elements 2 through 5. The perimeter of the circular structure may include multiple shutter positions indicated by short lines extending outward from the circumference. On the left side of the diagram, where the wind direction arrows may indicate incoming airflow, the shutters may be shown in an open configuration or element 1. The top, right, and bottom portions of the perimeter may display shutters in a closed configuration or element 10, as indicated by the labels. The wind direction may be depicted by horizontal blue arrows pointing from left to right toward the structure.

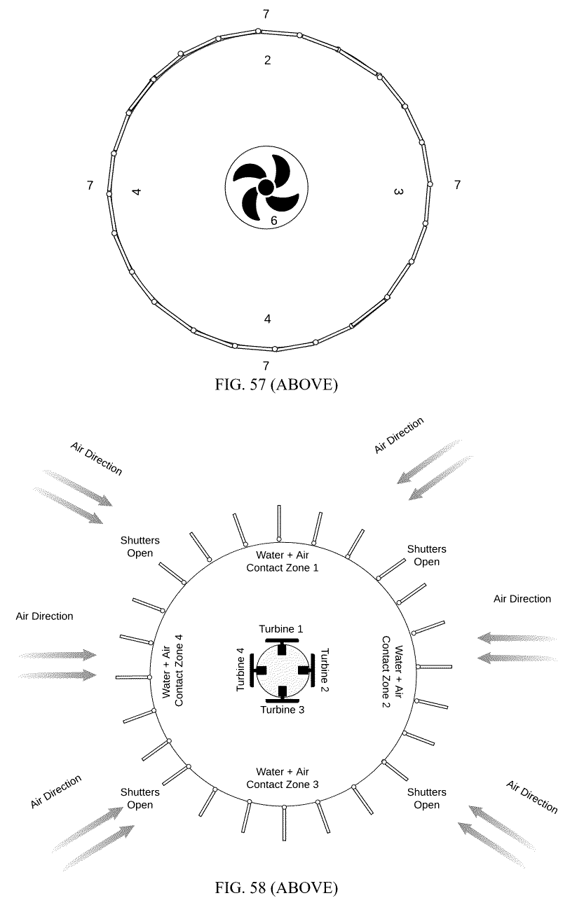

In some embodiments, FIG. 56 and FIG. 57 may comprise top-down schematic views of an updraft tower system configured with all shutters in the closed position. The diagram may show a circular arrangement with a central turbine or element 6 represented by a airflow turbine symbol at the core, surrounded by four water and air contact zones labeled as Water plus Air Contact Zone 1 through Water plus Air Contact Zone 4 or elements 2 through 5, positioned at the top, right, bottom, and left quadrants respectively. The outer perimeter of the circular structure may be depicted with a dotted or segmented line indicating the boundary of the system. At each of the four cardinal positions corresponding to the contact zones, the label Shutters Closed or element 7 or element 10 may appear outside the circular boundary, indicating that air inlet shutters around the perimeter may be in their closed state.

In some embodiments, FIG. 58 and FIG. 59 may comprise top-down schematic views of an updraft tower system configured for power generation from the temperature difference between water and air. The circular structure may feature a central region containing four turbines arranged in a cross pattern, labeled as Turbine 1 through Turbine 4 or elements 6 through 9, positioned around a central hub. Surrounding the turbines may be four Water plus Air Contact Zones, numbered 1 through 4 or elements 2 through 5, which may occupy the annular space between the central turbine assembly and the outer perimeter of the structure. The outer perimeter may be defined by a ring of short radial elements representing shutters in the open position, allowing ambient air to enter the system from all directions. Blue arrows positioned around the exterior of the structure may indicate air direction flowing inward from multiple angles.

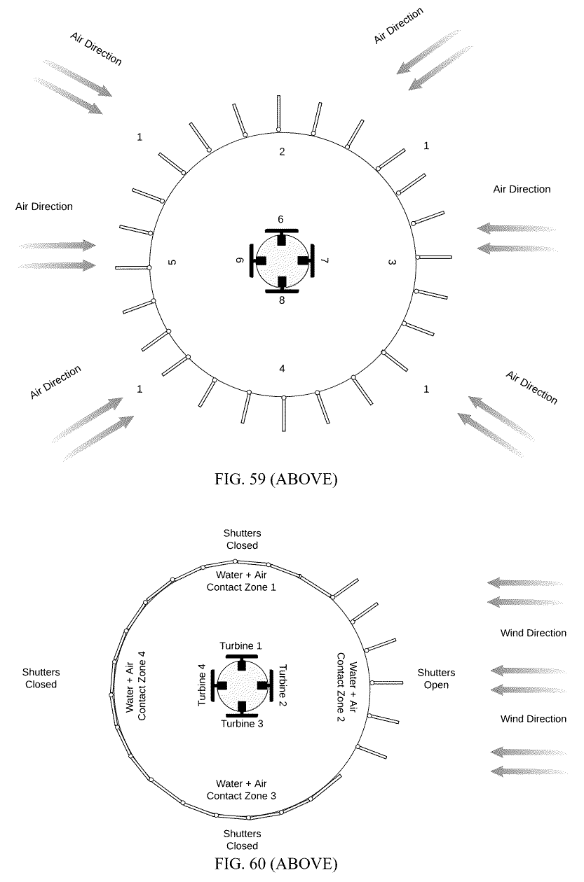

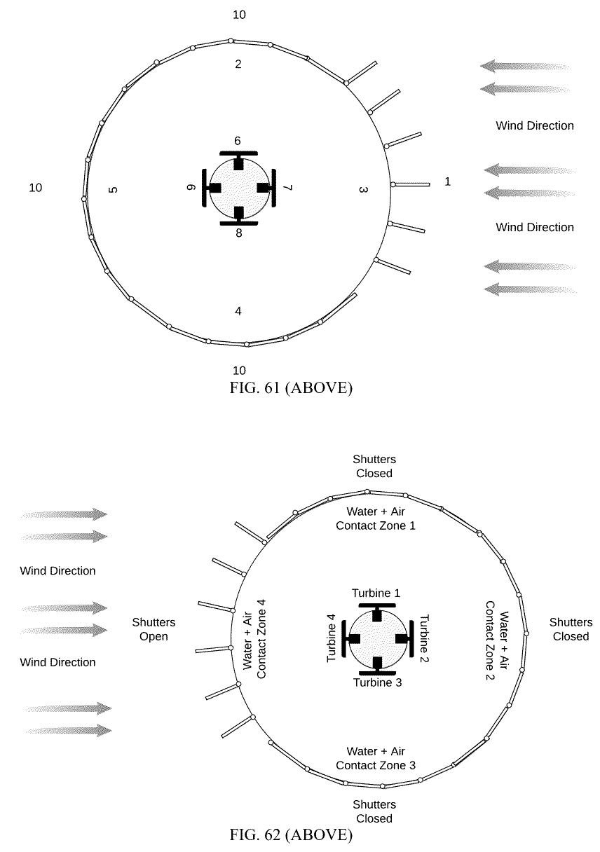

In some embodiments, FIG. 60 and FIG. 61 may comprise top-down schematic views of an updraft tower system configured for power generation, showing the arrangement of shutters, water-air contact zones, and turbines. The circular structure may feature a central region containing four turbines labeled Turbine 1 through Turbine 4 or elements 6 through 9, arranged in a cross pattern around a central hub. Surrounding the turbines may be four water and air contact zones labeled Water plus Air Contact Zone 1 through Water plus Air Contact Zone 4 or elements 2 through 5. The outer perimeter may include multiple shutter positions indicated by short perpendicular lines extending outward from the circular boundary. The shutters on the top, left, and bottom sides of the structure may be labeled as Shutters Closed or element 10, while the shutters on the right side may be labeled as Shutters Open or element 1. Blue arrows on the right side of the image may indicate the wind direction flowing from right to left toward the open shutters.

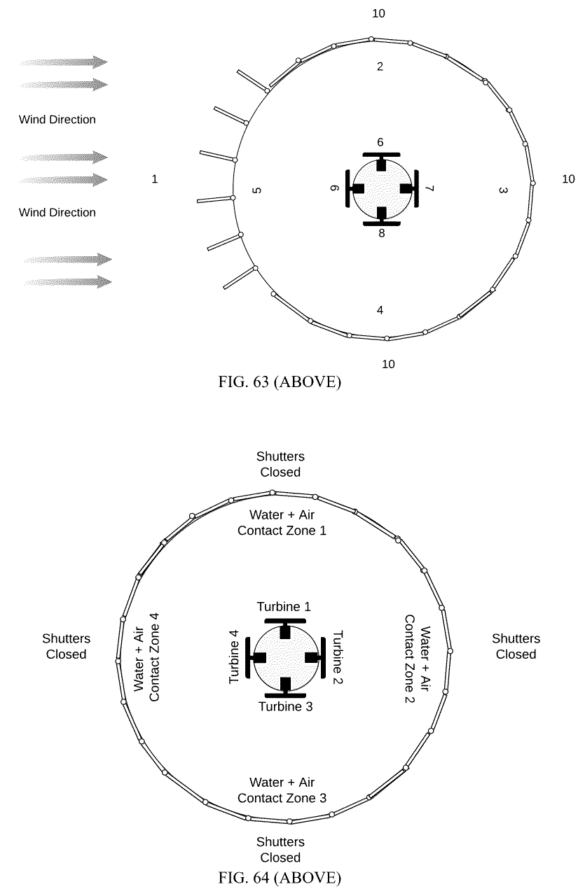

In some embodiments, FIG. 62 and FIG. 63 may comprise top-down schematic views of an updraft tower system configured for power generation from the temperature difference between water and air. The circular structure may feature a central region containing four turbines arranged in a cross pattern, labeled as Turbine 1 through Turbine 4 or elements 6 through 9. Surrounding the turbine assembly may be four water and air contact zones, designated as Water plus Air Contact Zone 1 through Water plus Air Contact Zone 4 or elements 2 through 5. The outer perimeter of the circular system may be equipped with adjustable shutters. The image may depict a wind condition scenario where wind may be flowing from the left side of the diagram, as indicated by the blue horizontal arrows labeled Wind Direction. The shutters on the left side of the structure, which may represent the windward side, may be shown in an open configuration or element 1 or element 5, allowing air to enter the system. The shutters on the remaining three sides of the structure may be labeled as Shutters Closed or element 10.

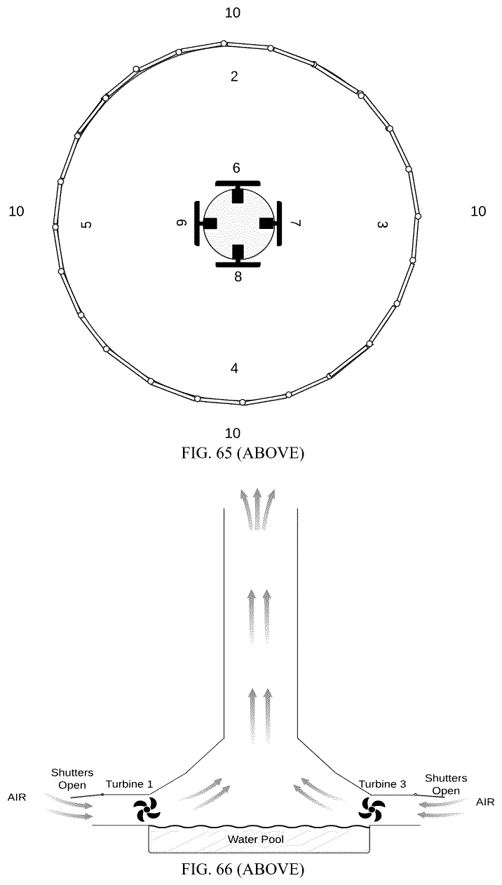

In some embodiments, FIG. 64 and FIG. 65 may comprise top-down schematic views of an updraft tower system configured for power generation, showing a circular arrangement with multiple water-air contact zones and turbines. At the center of the diagram may be a circular structure containing four turbines labeled Turbine 1 through Turbine 4 or elements 6 through 9, arranged in a cross pattern around a central hub. Surrounding the central turbine assembly may be four water plus air contact zones, designated as Water plus Air Contact Zone 1 through Water plus Air Contact Zone 4 or elements 2 through 5. The outer perimeter of the circular structure may feature a series of small circles connected by lines, representing the boundary of the system. At each cardinal direction along the outer perimeter, the label Shutters Closed or element 10 may appear, indicating that all four sets of shutters positioned at the top, right, bottom, and left sides of the structure may be in a closed configuration.

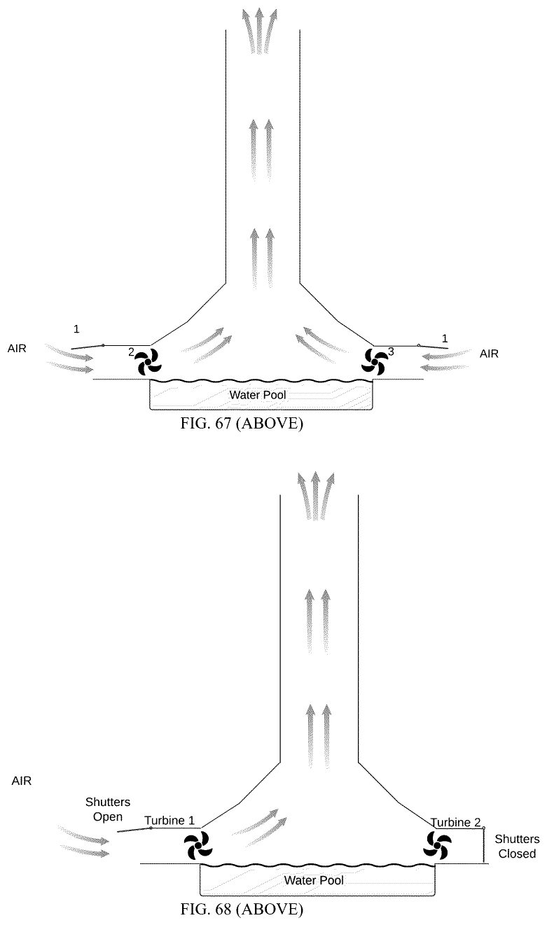

In some embodiments, FIG. 66 and FIG. 67 may comprise cross-sectional side views of an updraft tower system configured for power generation from the temperature difference between water and air. The system may show a central vertical tower structure with upward-pointing arrows indicating the direction of rising warm air flow through and exiting the top of the tower. At the base of the tower, the system may include two air turbines labeled as Turbine 1 and Turbine 2 or elements 2 and 3, each represented by fan blade symbols. Adjacent to each turbine on the outer edges may be shutters shown in an open position, with arrows labeled AIR or element 1 indicating ambient air entering the system horizontally from both the left and right sides through these open shutters. Below the turbines and centrally positioned at the base of the structure may be a water pool or element 4, depicted as a rectangular basin containing water shown with a wavy surface pattern.

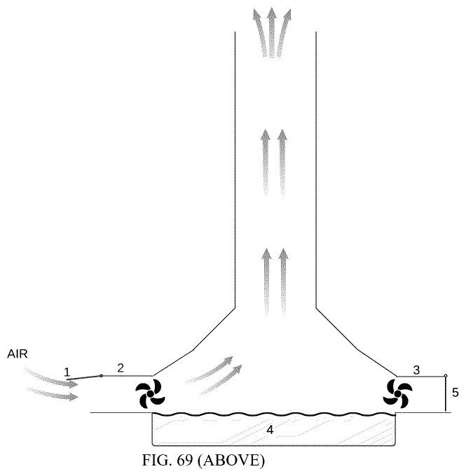

In some embodiments, FIG. 68 and FIG. 69 may comprise side views of an updraft tower power generation system with airflow control elements. The system may show a vertical tower structure with upward-pointing arrows indicating the direction of rising air through the tower interior. At the base of the tower, there may be a water pool or element 4 represented by a rectangular container with wavy lines indicating the water surface. On the left side of the base, there may be open shutters labeled as Shutters Open or element 1, through which blue arrows may indicate ambient air entering the system. A first turbine designated as Turbine 1 or element 2 may be positioned adjacent to the open shutters on the left side. On the right side of the base, the shutters may be shown in a closed position labeled as Shutters Closed or element 5, with a second turbine designated as Turbine 2 or element 3 positioned near these closed shutters.

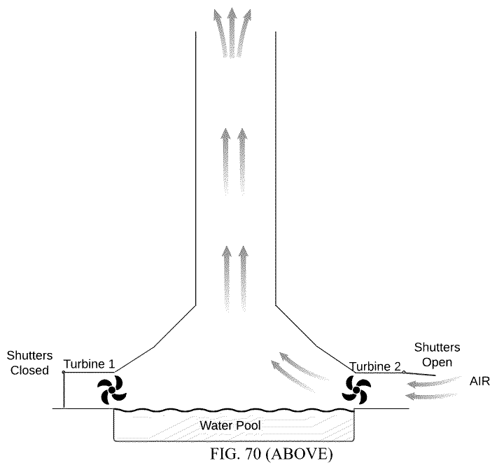

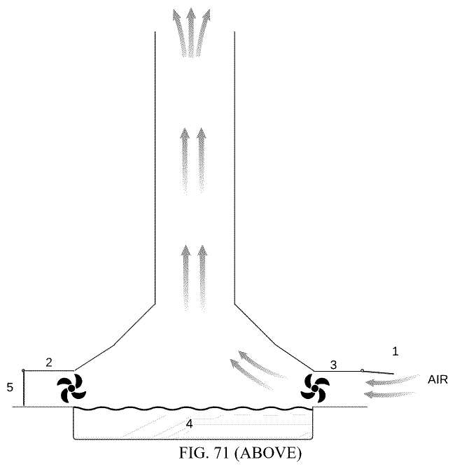

In some embodiments, FIG. 70 and FIG. 71 may comprise cross-sectional side views of an updraft tower system configured for power generation from the temperature difference between water and air. The system may show a substantially vertical tower structure with an open interior that may permit air to rise from a base region toward an upper outlet, indicated by upward-pointing arrows at the top of the tower. At the base of the tower, there may be a thermal exchange zone comprising water sprayers or elements 2 and 3, which may be positioned on opposite sides of a central conical or tapered region. Below the water sprayers, two water basins or pools labeled as elements 4 and 5 may be shown. Air may enter the system from the left side as indicated by curved arrows labeled with element 1 and the word AIR.

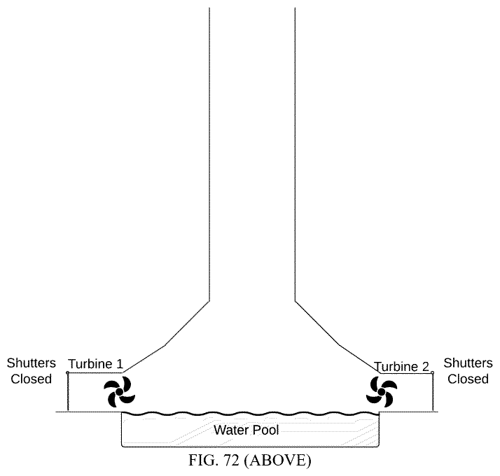

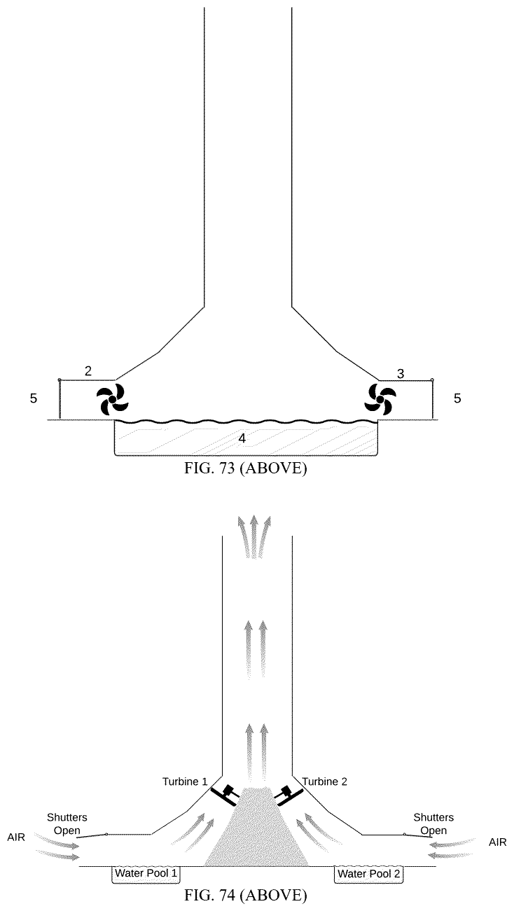

In some embodiments, FIG. 72 and FIG. 73 may comprise cross-sectional side views of an updraft tower system configured for power generation, showing the tower in an operational state where the shutters on both sides may be closed. The illustration may show a central vertical tower or conduit that may extend upward from a wider base section. At the base of the tower, two turbines may be positioned symmetrically on either side, labeled as Turbine 1 and Turbine 2 or elements 2 and 3. Below the turbines and spanning the width of the base structure may be a water pool or element 4, shown as a light blue shaded rectangular region. On the outer edges of the base structure, shutters may be shown in the closed position on both the left and right sides, as indicated by the labels reading Shutters Closed or element 5.

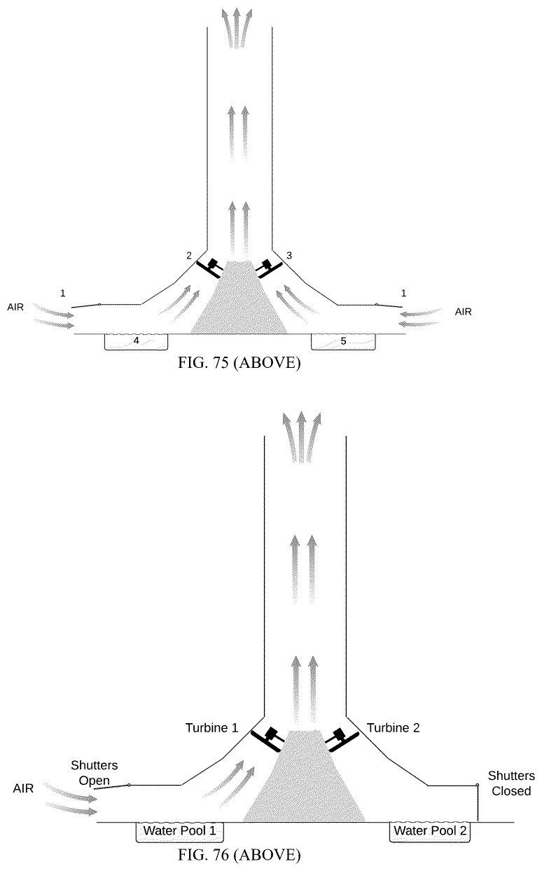

In some embodiments, FIG. 74 and FIG. 75 may comprise cross-sectional side views of an updraft tower system configured for power generation from the temperature difference between water and air. The structure may show a central vertical tower with upward-pointing blue arrows indicating the direction of rising warm air flow through and exiting the top of the tower. At the base of the tower, two air turbines labeled as Turbine 1 and Turbine 2 or elements 2 and 3 may be positioned on opposite sides, oriented to capture the incoming horizontal airflow before it enters the central tower region. Below each turbine, there may be water pools labeled as Water Pool 1 and Water Pool 2 or elements 4 and 5. On both the left and right sides of the structure, shutters may be shown in an open position or element 1, allowing ambient air to enter the system horizontally as indicated by the blue arrows pointing inward from both directions.

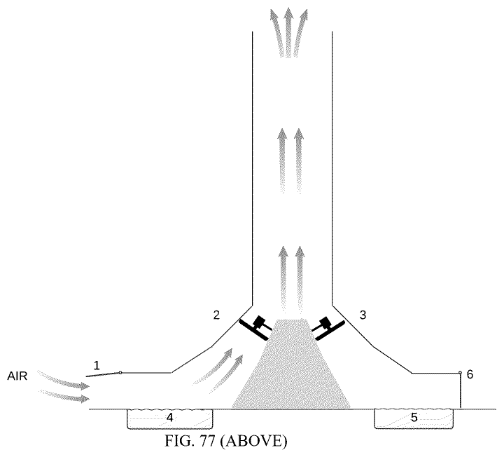

In some embodiments, FIG. 76 and FIG. 77 may comprise side views of an updraft tower power generation system configured with shutters and turbines for harnessing airflow generated by heat transfer between water and air. On the left side of the image, a shutter may be shown in the open position or element 1, allowing ambient air labeled as AIR to enter the system through the base. The air may flow inward past the open shutter and over Water Pool 1 or element 4, which may be positioned at the base of the structure. Two turbines, labeled Turbine 1 and Turbine 2 or elements 2 and 3, may be positioned symmetrically on either side of a central vertical tower or conduit. On the right side of the image, a shutter may be shown in the closed position or element 5, preventing air from entering or exiting through that side. Water Pool 2 or element 6 may be positioned at the base on the right side.

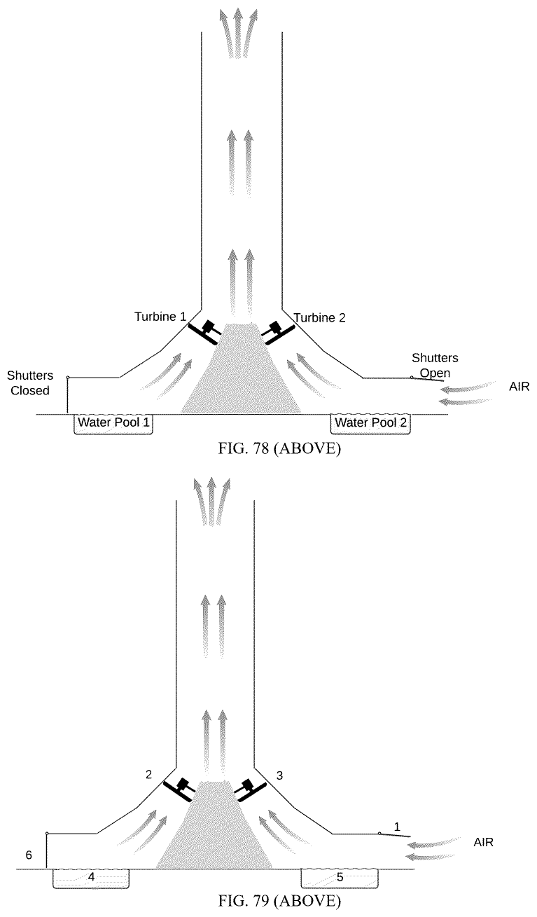

In some embodiments, FIG. 78 and FIG. 79 may comprise cross-sectional side views of an updraft tower system for power generation from the temperature difference between water and air. The system may show a central vertical tower structure with two turbines labeled as Turbine 1 and Turbine 2 or elements 2 and 3 positioned at the base of the tower on opposite sides. Below each turbine may be a water pool, with Water Pool 1 or element 4 on the left side and Water Pool 2 or element 5 on the right side. The left side of the system may show shutters in a closed position or element 6, while the right side may show shutters in an open position or element 1, allowing ambient air to enter the system as indicated by curved blue arrows flowing inward from the right.

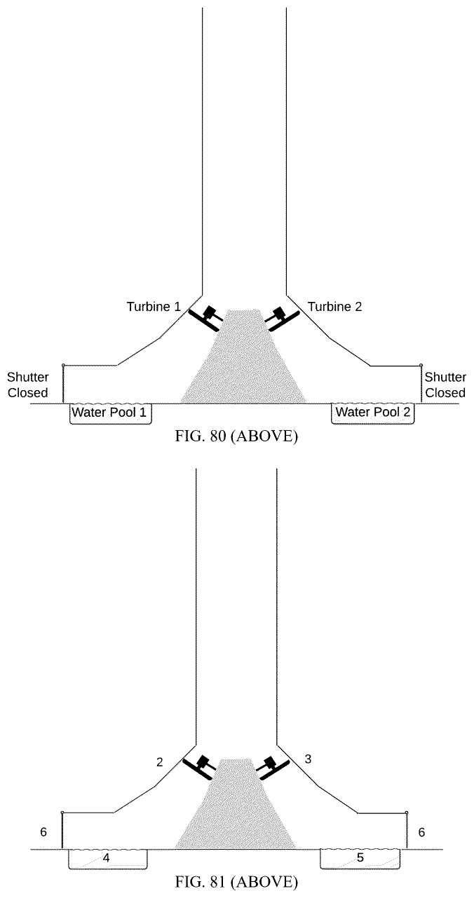

In some embodiments, FIG. 80 and FIG. 81 may comprise cross-sectional side views of an updraft tower system configured for power generation, showing the tower in an operational state where shutters on both sides may be closed. The illustration may show a vertically oriented tower structure with two turbines labeled as Turbine 1 and Turbine 2 or elements 2 and 3 positioned symmetrically at the base of the tower, angled inward toward a central converging section. Below each turbine, there may be a water pool designated as Water Pool 1 or element 4 on the left side and Water Pool 2 or element 5 on the right side. The shutters on both the left and right sides of the structure may be shown in a closed position, as indicated by the labels reading Shutter Closed or element 6.

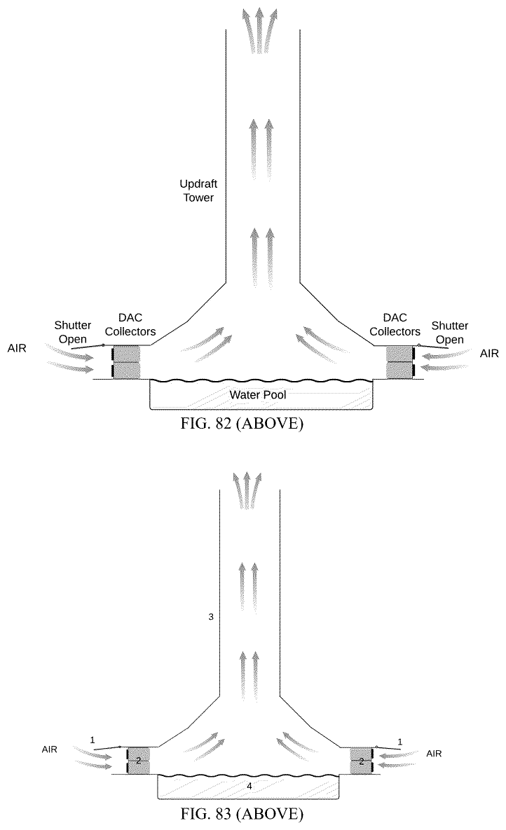

In some embodiments, FIG. 82 and FIG. 83 may comprise cross-sectional schematic views of an updraft tower system configured for power generation with integrated direct air capture collectors. The central structure may comprise a vertically oriented updraft tower or element 3 with upward-pointing arrows indicating the direction of rising air flow through the tower interior. At the base of the tower, a water pool or element 4 may be shown, which may serve as the thermal exchange zone where heat may be transferred from the water to the incoming air. On both the left and right sides of the tower base, the system may include shutters in an open position that may permit ambient air to enter the system, as indicated by horizontal arrows labeled AIR or element 1. Adjacent to each shutter opening may be DAC collectors or element 2, which may be direct air capture contactors positioned to interact with the incoming airflow.

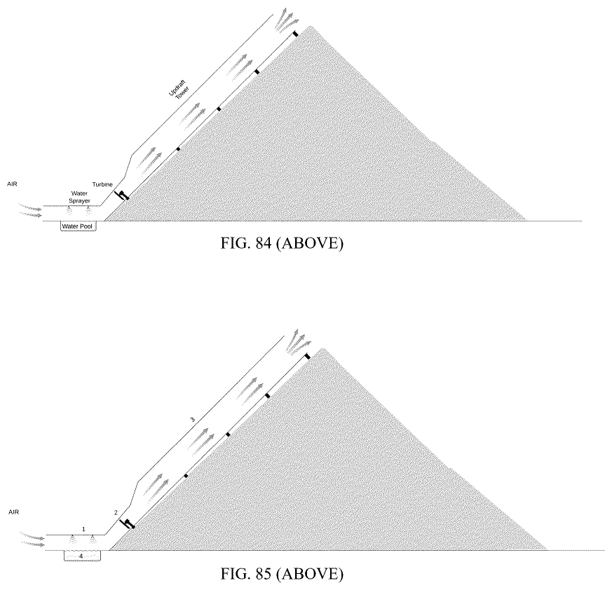

In some embodiments, FIG. 84 and FIG. 85 may comprise illustrations of a hillside or mountainside embodiment, depicting a system configured to generate airflow by transferring heat from a fluid to air within an inclined air conduit. The diagram may show a triangular cross-section representing a hillside or mountainside geographic feature, with an elongated air conduit or element 3 extending along the slope from a lower elevation at the base to a higher elevation near the apex. At the lower portion of the system, ambient air may enter through an inlet region or element 1 where a turbine or element 2 may be positioned to harness airflow energy. Adjacent to the turbine may be a water sprayer configured to contact the incoming air with water, facilitating heat transfer from the fluid to the air. A water pool or element 4 may be shown at the base of the system, serving as a collection basin for water and potentially ice formed during the heat exchange process. The air conduit, labeled as an updraft tower, may extend upward along the inclined surface of the hillside, channeling the warmed air from the first elevation at the base to a second elevation at the upper outlet. Multiple blue arrows along the length of the inclined conduit may indicate the direction of airflow moving upward through the system.

In some embodiments, FIG. 86 and FIG. 87 may comprise top-down schematic views of a circular airflow management system configured to capture wind energy from multiple directions simultaneously. The diagram may depict a central hub containing four turbines arranged in a cross pattern, labeled as Turbine 1, Turbine 2, Turbine 3, and Turbine 4 or elements 6, 7, 8, and 9, positioned at the core of the structure. Surrounding the central turbine assembly may be a circular arrangement of flow control elements, specifically shutters, which may be shown in an open configuration around the entire perimeter. The shutters may be depicted as angled vanes or louvers arranged radially around the circumference, with labels indicating Shutters Open or element 1 at four cardinal positions corresponding to the top, bottom, left, and right sides of the structure. Blue arrows positioned around the exterior of the circular structure may indicate ambient air direction approaching from all sides, demonstrating that the system may be designed to receive airflow from any wind direction. The arrows may be labeled Air Direction and may show wind vectors approaching from eight different directions, including the four cardinal directions and four diagonal directions. In some embodiments, the regions between the outer shutter ring and the central turbine assembly may comprise water plus air contact zones or elements 2, 3, 4, and 5, positioned in quadrants between the peripheral shutters and the central power generation components.

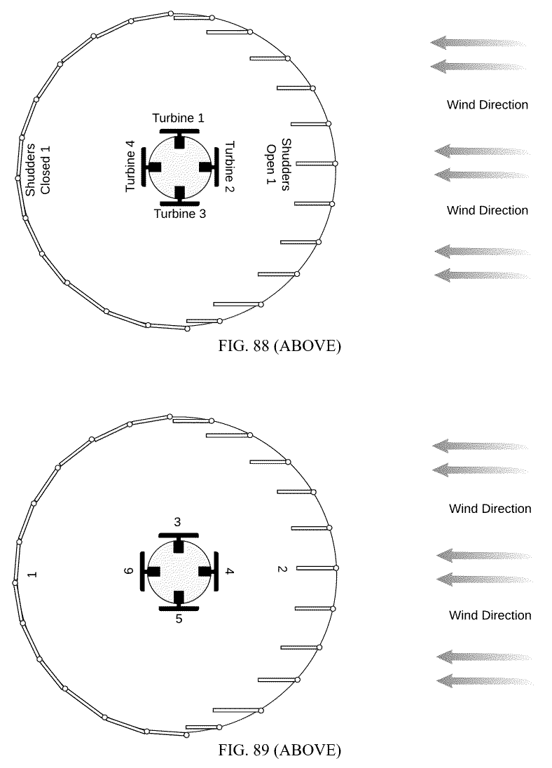

In some embodiments, FIG. 88 and FIG. 89 may comprise top-down schematic views of a circular updraft tower system configured for wind-enhanced operation. The circular structure may feature a perimeter defined by flow control elements in the form of shutters, with the left side labeled as Shutters Closed or element 10 and the right side labeled as Shutters Open or element 1. Blue arrows on the right side of the image may indicate the wind direction flowing from right to left toward the structure. At the center of the circular configuration, four turbines may be arranged in a cross pattern, labeled as Turbine 1 at the top or element 6, Turbine 2 on the right or element 7, Turbine 3 at the bottom or element 8, and Turbine 4 on the left or element 9. The shutters may be depicted as angled elements around the circumference of the structure, with those on the windward side shown in an open position to permit airflow entry, while those on the leeward side may be shown closed to prevent backdraft and optimize airflow through the system. In some embodiments, water plus air contact zones or elements 2, 3, 4, and 5 may be positioned between the outer shutter perimeter and the central turbine assembly.

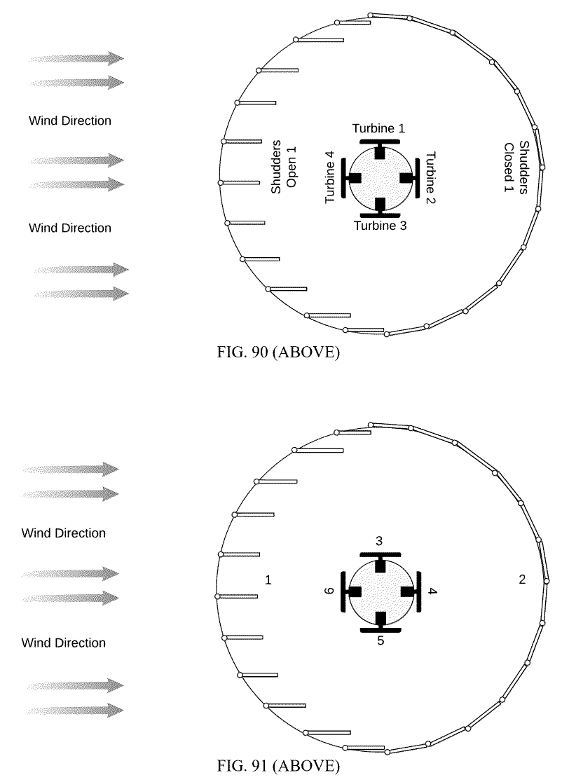

In some embodiments, FIG. 90 and FIG. 91 may comprise top-down schematic views of an updraft tower system configured to harness wind energy through selective shutter operation. The diagram may depict a circular structure with a central turbine arrangement comprising four turbines labeled Turbine 1, Turbine 2, Turbine 3, and Turbine 4 or elements 6, 7, 8, and 9, positioned in a cross configuration at the center of the structure. The perimeter of the circular structure may feature multiple flow control elements in the form of shutters arranged radially around the circumference. The left side of the structure, labeled as Shutters Open or element 1, may show shutters in an open configuration indicated by angled line segments representing the open shutter positions. The right side of the structure, labeled as Shutters Closed or element 10, may show shutters in a closed configuration. Blue horizontal arrows on the left side of the figure may indicate the wind direction flowing from left to right. In some embodiments, water plus air contact zones or elements 2, 3, 4, and 5 may occupy the annular space between the central turbine assembly and the outer perimeter of the structure.

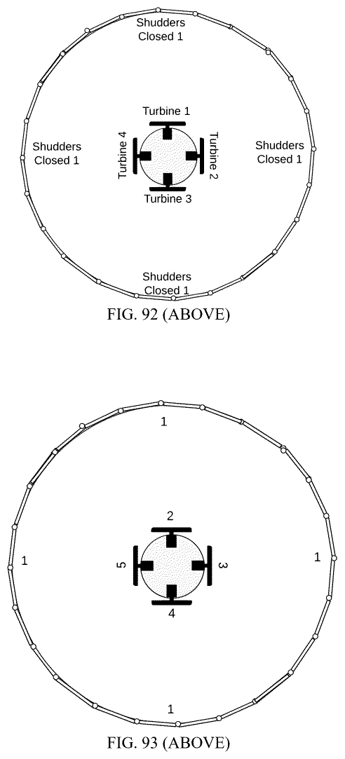

In some embodiments, FIG. 92 and FIG. 93 may comprise top-down schematic views of an updraft tower system configured with flow control elements in a closed position around the entire perimeter. The circular structure may feature a central region containing four turbines arranged in a cross pattern, labeled as Turbine 1, Turbine 2, Turbine 3, and Turbine 4 or elements 6, 7, 8, and 9, positioned at the cardinal directions within the tower core. The turbines may be depicted with directional blade indicators showing their rotational orientation. Surrounding the central turbine assembly may be a circular boundary representing the tower cross-section. The outer perimeter of the system may be defined by a ring of individual shutter elements, shown as small rectangular segments arranged circumferentially around the entire structure. Each of the four cardinal directions may display the label Shutters Closed or element 10 indicating that all flow control elements may be in their closed configuration. In some embodiments, water plus air contact zones or elements 2, 3, 4, and 5 may be positioned between the outer shutter ring and the central turbine area.

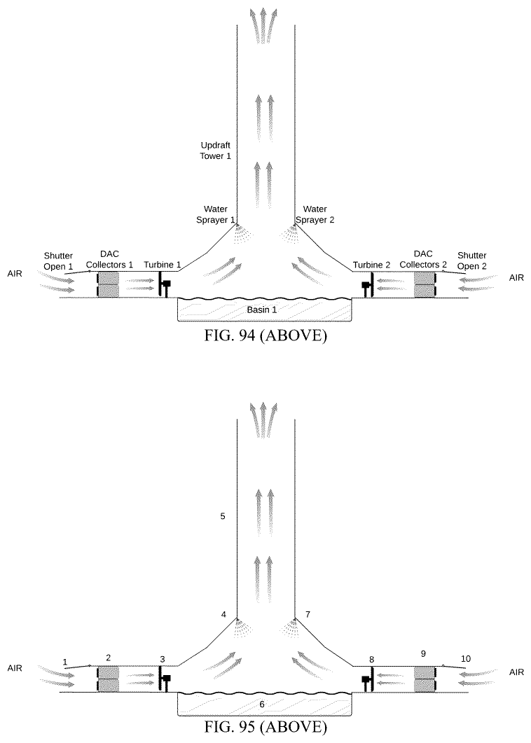

In some embodiments, FIG. 94 and FIG. 95 may comprise cross-sectional side views of an updraft tower system configured for power generation and direct air capture operations. The system may feature a central vertical updraft tower or element 5 with upward-pointing arrows indicating the direction of airflow rising through the tower structure. At the base of the tower, a basin or element 6 may be positioned centrally to collect fluid. On either side of the tower base, symmetrical arrangements of system components may be shown. Each side may include a shutter in an open position at the outermost location, labeled as Shutter Open 1 or element 1 on the left and Shutter Open 2 or element 10 on the right, through which ambient air may enter the system as indicated by horizontal arrows labeled AIR. Adjacent to each shutter and positioned inward may be DAC Collectors, labeled as DAC Collectors 1 or element 2 on the left side and DAC Collectors 2 or element 9 on the right side, which may be direct air capture contactors configured to absorb carbon dioxide from the air passing through the system. Between the DAC collectors and the central tower structure may be turbines, designated as Turbine 1 or element 3 on the left side and Turbine 2 or element 8 on the right side, which may be configured to convert kinetic energy from the airflow into electrical or mechanical power. Water Sprayer 1 or element 4 and Water Sprayer 2 or element 7 may be positioned on the left and right sides respectively, located above the basin area and configured to spray water into the airflow path for thermal exchange purposes.

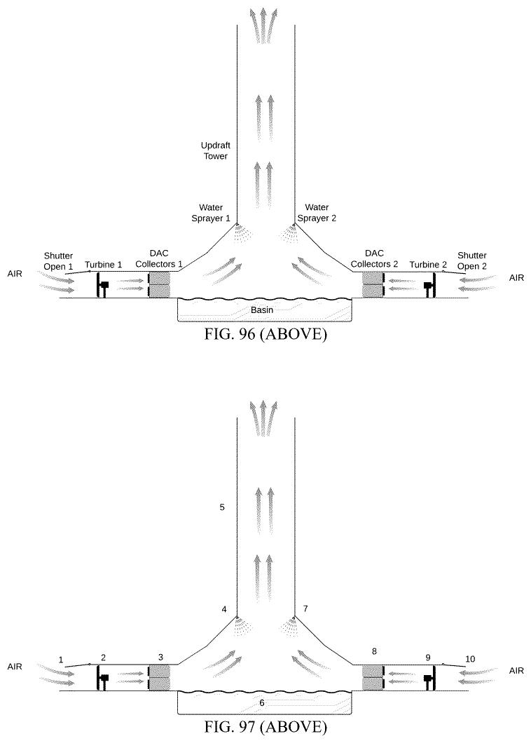

In some embodiments, FIG. 96 and FIG. 97 may comprise cross-sectional side views of an updraft tower system configured for power generation with integrated direct air capture collectors. The system may feature a central vertical updraft tower or element 5 with upward-pointing arrows indicating the direction of airflow rising through the tower structure. At the base of the tower, a basin or element 6 may be positioned centrally to collect fluid. On either side of the tower base, symmetrical arrangements of system components may be shown. Each side may include a shutter in an open position at the outermost location, labeled as Shutter Open 1 or element 1 on the left and Shutter Open 2 or element 10 on the right, through which ambient air may enter the system as indicated by horizontal arrows labeled AIR. Adjacent to each shutter and positioned inward may be turbines, designated as Turbine 1 or element 2 on the left side and Turbine 2 or element 9 on the right side, which may be configured to convert kinetic energy from the airflow into electrical or mechanical power. Between the turbines and the central tower structure may be DAC Collectors, labeled as DAC Collectors 1 or element 3 on the left side and DAC Collectors 2 or element 8 on the right side, which may be direct air capture contactors configured to absorb carbon dioxide from the air passing through the system. Water Sprayer 1 or element 4 and Water Sprayer 2 or element 7 may be positioned on the left and right sides respectively, located above the basin area and configured to spray water into the airflow path for thermal exchange purposes. The water sprayers may disperse fluid that contacts the incoming air, transferring heat from the relatively warmer fluid to the colder ambient air, which may warm the air and reduce its density, thereby generating the upward airflow through the tower.

In some embodiments, a flow control element may comprise any passive, active, mechanical, electromechanical, fluidic, or structural component or assembly that may be configured to permit, restrict, modulate, regulate, adjust, redirect, direct, obstruct, prevent, facilitate, or any combination thereof the flow of a fluid. The fluid may comprise air, water, brine, ice-water mixtures, or other fluids that may be present in thermal power generation systems. Flow control elements may be positioned at air inlets, at air outlets, within air conduits, near thermal exchange zones, or at other locations where control of fluid flow may be desired.

In some embodiments, a flow control element may be configured to control fluid flow through or across an opening, a passageway, a conduit, a duct, an aperture, a channel, or a region. The opening, passageway, conduit, duct, aperture, channel, or region may be part of an air conduit, a thermal exchange zone, an inlet structure, an outlet structure, or another component of a thermal power generation system. The flow control element may be sized and configured to match the dimensions of the opening, passageway, conduit, duct, aperture, channel, or region where the flow control element may be installed.

In some embodiments, a flow control element may operate in a binary mode. In binary mode, the flow control element may be in one of two states, such as fully open or fully closed. The binary mode may provide simple control of fluid flow, wherein the flow control element may either permit fluid flow or prevent fluid flow. Binary mode operation may be suitable for applications where intermediate flow rates may not be required or where simple on-off control may be sufficient.

In some embodiments, a flow control element may operate in a discrete mode. In discrete mode, the flow control element may be in one of a plurality of discrete states, such as fully closed, partially open, or fully open. The discrete states may correspond to specific positions of movable components of the flow control element. Discrete mode operation may provide a limited number of flow rate settings, which may be suitable for applications where a small number of operating conditions may be anticipated.

In some embodiments, a flow control element may operate in a staged mode. In staged mode, the flow control element may comprise multiple stages or sections that may be opened or closed independently or in sequence. The staged configuration may allow the total flow area to be adjusted in increments corresponding to the number of stages. Staged mode operation may provide finer control of flow rate than binary mode while maintaining the simplicity of discrete position control for each stage.

In some embodiments, a flow control element may operate in a proportional mode. In proportional mode, the flow control element may be adjusted to any position within a continuous range between fully closed and fully open. The proportional mode may allow the flow rate to be adjusted continuously to match desired operating conditions. Proportional mode operation may be suitable for applications where precise control of flow rate may be desired or where operating conditions may vary continuously.

In some embodiments, a flow control element may operate in a continuous mode. In continuous mode, the flow control element may be adjusted continuously in response to changing conditions or control signals. The continuous mode may involve ongoing adjustment of the flow control element position to maintain desired flow characteristics. Continuous mode operation may be suitable for applications where conditions may change frequently or where dynamic response to changing conditions may be desired.

In some embodiments, a flow control element may operate in an adaptive mode. In adaptive mode, the flow control element may adjust the operating characteristics based at least in part on learned behavior, historical data, or feedback from system performance. The adaptive mode may involve control algorithms that may modify control parameters based at least in part on observed system response. Adaptive mode operation may improve system performance over time as the control system may learn the characteristics of the system and the operating environment.

In some embodiments, a flow control element may operate in a dynamic mode. In dynamic mode, the flow control element may respond to rapidly changing conditions, such as wind gusts, pressure fluctuations, or other transient events. The dynamic mode may involve rapid adjustment of the flow control element position to maintain desired flow characteristics during transient conditions. Dynamic mode operation may be suitable for applications where conditions may change rapidly or where stability of flow characteristics may be desired during transient events.

In some embodiments, a flow control element may operate in a dynamically variable mode. In dynamically variable mode, the flow control element may continuously vary the operating characteristics in response to changing conditions. The dynamically variable mode may combine aspects of continuous mode and dynamic mode, providing ongoing adjustment with rapid response to changing conditions. Dynamically variable mode operation may be suitable for applications where both steady-state optimization and transient response may be desired.

In some embodiments, a flow control element may be manually actuated. Manual actuation may involve physical manipulation of the flow control element by an operator. Manual actuation may be accomplished through handles, levers, wheels, cranks, or other manual control mechanisms. Manually actuated flow control elements may be suitable for applications where infrequent adjustment may be required or where automated control systems may not be available.

In some embodiments, a flow control element may be automatically actuated. Automatic actuation may involve actuation of the flow control element by a control system without direct physical manipulation by an operator. Automatic actuation may be accomplished through electric motors, pneumatic actuators, hydraulic actuators, or other powered actuation mechanisms. Automatically actuated flow control elements may be suitable for applications where frequent adjustment may be required, where remote operation may be desired, or where rapid response to changing conditions may be needed.

In some embodiments, a flow control element may be automatic. An automatic flow control element may adjust the position or operating characteristics based at least in part on control signals from a control system. The control system may receive inputs from sensors, from predictive models, from operator commands, or from other sources, and the control system may generate control signals to adjust the flow control element. Automatic flow control elements may provide consistent and repeatable control of fluid flow.

In some embodiments, a flow control element may be active. An active flow control element may require external power or external control signals to operate. Active flow control elements may include motorized dampers, powered shutters, actuated valves, or other flow control elements that may be driven by external power sources. Active flow control elements may provide precise control of fluid flow and may be integrated with automated control systems.

In some embodiments, a flow control element may be passive. A passive flow control element may operate without external power or external control signals. Passive flow control elements may respond to conditions such as pressure, temperature, flow velocity, wind, gravity, or ice formation. Passive flow control elements may include check valves, pressure-actuated dampers, temperature-actuated vents, or other flow control elements that may be actuated by the conditions of the fluid or the environment. Passive flow control elements may provide automatic response to conditions without the need for external power or control systems.

In some embodiments, a flow control element may be responsive. A responsive flow control element may adjust the position or operating characteristics in response to detected conditions. The detected conditions may include one or more or any combination of the following: pressure, or temperature, or flow velocity, or wind direction, or wind speed, or humidity, or ice formation, or any combination thereof. Responsive flow control elements may include sensors or sensing mechanisms that may detect conditions and may trigger adjustment of the flow control element.

In some embodiments, a flow control element may be environmentally responsive. An environmentally responsive flow control element may adjust the position or operating characteristics in response to environmental conditions. Environmental conditions may include ambient temperature, wind conditions, precipitation, ice formation, solar radiation, or other conditions of the external environment. Environmentally responsive flow control elements may be configured to optimize system performance based at least in part on the prevailing environmental conditions.

In some embodiments, a flow control element may be self-actuating. A self-actuating flow control element may be actuated by the fluid flow or by conditions associated with the fluid flow. Self-actuating flow control elements may include check valves that may open or close based at least in part on pressure differential, or flaps that may be deflected by airflow, or other flow control elements that may be actuated by the fluid. Self-actuating flow control elements may provide automatic response to flow conditions without external power or control signals.

In some embodiments, a flow control element may be actuating. An actuating flow control element may cause movement or adjustment of other components in addition to controlling fluid flow. The actuating flow control element may be mechanically linked to other components, may generate control signals for other components, or may otherwise cause adjustment of other components responsive to the position or state of the flow control element.

In some embodiments, a flow control element may operate in response to pressure. Pressure-responsive flow control elements may adjust the position or operating characteristics based at least in part on the pressure of the fluid, the pressure differential across the flow control element, or the pressure at a reference location. Pressure-responsive operation may be achieved through diaphragms, bellows, pistons, or other pressure-sensing mechanisms that may be coupled to the movable components of the flow control element.

In some embodiments, a flow control element may operate in response to temperature. Temperature-responsive flow control elements may adjust the position or operating characteristics based at least in part on the temperature of the fluid, the temperature of the environment, or the temperature at a reference location. Temperature-responsive operation may be achieved through bimetallic elements, shape memory alloys, wax motors, or other temperature-sensing mechanisms that may be coupled to the movable components of the flow control element.

In some embodiments, a flow control element may operate in response to flow velocity. Flow velocity-responsive flow control elements may adjust the position or operating characteristics based at least in part on the velocity of the fluid flow. Flow velocity-responsive operation may be achieved through vanes, paddles, or other elements that may be deflected by the fluid flow and that may be coupled to the movable components of the flow control element.

In some embodiments, a flow control element may operate in response to wind. Wind-responsive flow control elements may adjust the position or operating characteristics based at least in part on the wind direction, wind speed, or other wind characteristics. Wind-responsive operation may be achieved through wind vanes, anemometers, or other wind-sensing mechanisms that may be coupled to the movable components of the flow control element or that may provide signals to a control system.

In some embodiments, a flow control element may operate in response to gravity. Gravity-responsive flow control elements may adjust the position or operating characteristics based at least in part on gravitational forces. Gravity-responsive operation may be achieved through weighted elements that may move under the influence of gravity, or through counterweighted mechanisms that may balance gravitational forces against other forces.

In some embodiments, a flow control element may operate in response to ice formation. Ice formation-responsive flow control elements may adjust the position or operating characteristics based at least in part on the presence, thickness, or weight of ice. Ice formation-responsive operation may be achieved through ice sensors, weight sensors, or other mechanisms that may detect ice formation and that may trigger adjustment of the flow control element.

In some embodiments, a flow control element may operate in response to control signals. Control signal-responsive flow control elements may adjust the position or operating characteristics based at least in part on electrical signals, pneumatic signals, hydraulic signals, or other control signals from a control system. Control signal-responsive operation may allow the flow control element to be integrated with automated control systems and to be adjusted based at least in part on inputs from sensors, predictive models, operator commands, or other sources.

In some embodiments, a flow control element may comprise one or more movable portions. Movable portions may include components that may translate, rotate, pivot, slide, swing, or otherwise move to adjust the flow area or flow path. The movable portions may be supported by bearings, hinges, tracks, guides, or other support mechanisms that may allow the movable portions to move while maintaining alignment and sealing.

In some embodiments, a flow control element may comprise one or more deformable portions. Deformable portions may include components that may bend, flex, stretch, compress, or otherwise deform to adjust the flow area or flow path. Deformable portions may be constructed from flexible materials, elastic materials, or other materials that may undergo deformation without failure. The deformation of the deformable portions may be caused by pressure, by mechanical forces, by thermal expansion, or by other mechanisms.

In some embodiments, a flow control element may be fixed. A fixed flow control element may have a position or configuration that may not be adjusted during operation. Fixed flow control elements may include fixed baffles, fixed vanes, fixed screens, or other flow control elements that may direct or condition fluid flow without adjustment. Fixed flow control elements may be suitable for applications where the desired flow characteristics may not change during operation.

In some embodiments, a flow control element may be selectively engageable. A selectively engageable flow control element may be engaged or disengaged to control fluid flow. When engaged, the flow control element may restrict, redirect, or otherwise control fluid flow. When disengaged, the flow control element may allow fluid flow to pass without restriction or redirection. Selectively engageable flow control elements may include retractable baffles, deployable screens, or other flow control elements that may be moved into or out of the flow path.

In some embodiments, a flow control element may comprise one or more plates. Plates may comprise flat or curved members that may be positioned to block, redirect, or otherwise control fluid flow. Plates may be hinged, pivoting, sliding, or otherwise movable to allow the position or orientation of the plates to be adjusted. Plates may be solid or may have openings, perforations, or other features that may allow partial fluid flow through the plates.

In some embodiments, a flow control element may comprise one or more vanes. Vanes may comprise elongated members that may extend into the flow path and may be configured to direct or deflect fluid flow. Vanes may be arranged in arrays or banks, and the spacing between vanes may affect the flow characteristics. Vanes may be fixed in position, or vanes may be rotatable or pivotable to allow the angle of the vanes to be adjusted.

In some embodiments, a flow control element may comprise one or more louvers. Louvers may comprise arrays of slats or blades that may be arranged in parallel and that may be tilted to control the amount of fluid flow through the louver assembly. The slats or blades of a louver may be linked together so that all slats or blades may tilt together, or the slats or blades may be independently adjustable. Louvers may provide graduated control of fluid flow by adjusting the tilt angle of the slats or blades.

In some embodiments, a flow control element may comprise one or more shutters. Shutters may comprise panels or assemblies that may be opened, closed, or otherwise adjusted to control exposure of an opening or region to fluid flow. Shutters may operate in binary mode, wherein the shutters may be fully open or fully closed, or shutters may operate in staged or proportional modes, wherein the shutters may be partially open. Shutters may include single panels or multiple panels, and the panels may be hinged, sliding, folding, or otherwise movable.

In some embodiments, a flow control element may comprise one or more dampers. Dampers may comprise flow control elements configured to control fluid flow by partial, proportional, or complete obstruction or regulation. Dampers may be positioned within ducts, conduits, or other enclosed flow paths, or dampers may be positioned at openings or other locations where fluid flow may be controlled. Dampers may include blade dampers, butterfly dampers, louver dampers, or other damper configurations.

In some embodiments, a flow control element may comprise one or more valves. Valves may comprise flow control elements configured to control fluid flow through pipes, tubes, or other conduits. Valves may include gate valves, globe valves, ball valves, butterfly valves, check valves, or other valve types. Valves may be manually operated, automatically operated, or self-actuating depending on the valve type and the application.

In some embodiments, a flow control element may comprise one or more flaps. Flaps may comprise hinged or pivoting members that may swing to open or close a flow path. Flaps may be actuated by pressure differential, by mechanical linkages, by actuators, or by other mechanisms. Flaps may include check flaps that may open in one direction and close in the opposite direction, or flaps may be bidirectional.

In some embodiments, a flow control element may comprise one or more baffles. Baffles may comprise members that may be positioned within a flow path to redirect, distribute, or otherwise condition fluid flow. Baffles may be fixed or adjustable, and baffles may have various shapes and configurations depending on the desired flow characteristics. Baffles may be used to promote mixing, to reduce turbulence, to distribute flow, or to achieve other flow conditioning objectives.

In some embodiments, a flow control element may comprise one or more diaphragms. Diaphragms may comprise flexible membranes that may deflect in response to pressure differential or mechanical forces. The deflection of the diaphragm may open or close a flow path, or the deflection may modulate the flow area. Diaphragms may be constructed from rubber, elastomers, plastics, metals, or other materials that may undergo repeated deflection without failure.

In some embodiments, a flow control element may comprise one or more membranes. Membranes may comprise thin sheets or films that may be positioned to control fluid flow. Membranes may be permeable, allowing some fluid components to pass while blocking others, or membranes may be impermeable, blocking all fluid flow when in position. Membranes may be fixed or movable, and membranes may be tensioned, supported, or otherwise configured to maintain the desired position and shape.

In some embodiments, a flow control element may comprise one or more iris mechanisms. Iris mechanisms may comprise assemblies of overlapping blades or leaves that may be adjusted to vary the size of a central opening. The blades or leaves of an iris mechanism may be linked together so that adjustment of one blade or leaf may cause all blades or leaves to move together. Iris mechanisms may provide proportional control of flow area through a circular or approximately circular opening.

In some embodiments, a flow control element may comprise one or more sliding members. Sliding members may comprise components that may translate along a linear path to open or close a flow path. Sliding members may include sliding gates, sliding panels, sliding doors, or other components that may move along tracks, guides, or other linear support mechanisms. Sliding members may provide proportional control of flow area by adjusting the position of the sliding member along the linear path.

In some embodiments, a flow control element may comprise one or more rotating members. Rotating members may comprise components that may rotate about an axis to open or close a flow path or to redirect fluid flow. Rotating members may include rotating discs, rotating drums, rotating vanes, or other components that may rotate about a fixed axis. Rotating members may provide proportional control of flow area or flow direction by adjusting the rotational position of the rotating member.

In some embodiments, a flow control element may comprise one or more inflatable members. Inflatable members may comprise components that may be inflated with air, gas, or liquid to expand and block or restrict a flow path, or that may be deflated to open or enlarge a flow path. Inflatable members may include inflatable bladders, inflatable tubes, inflatable seals, or other components that may change size or shape through inflation or deflation. Inflatable members may provide proportional control of flow area by adjusting the inflation pressure or volume.

In some embodiments, a flow control element may comprise one or more phase-change elements. Phase-change elements may comprise components that may change phase in response to temperature changes, and the phase change may cause a change in size, shape, or position that may affect fluid flow. Phase-change elements may include wax motors, shape memory alloys, or other materials that may undergo phase transitions at temperatures relevant to the operating environment. Phase-change elements may provide temperature-responsive control of fluid flow without external power or control signals.

In some embodiments, a flow control element may comprise one or more semirigid elements. Semirigid elements may comprise components that may have some flexibility while maintaining a general shape or configuration. Semirigid elements may deflect under load while returning to the original shape when the load may be removed. Semirigid elements may be constructed from plastics, composites, thin metals, or other materials that may provide a balance between rigidity and flexibility.

In some embodiments, a flow control element may comprise one or more rigid elements. Rigid elements may comprise components that may maintain shape and position under applied loads without significant deflection. Rigid elements may be constructed from metals, thick plastics, composites, concrete, or other materials that may provide high stiffness. Rigid elements may be suitable for applications where precise positioning may be required or where high loads may be applied.

In some embodiments, a flow control element may comprise one or more soft elements. Soft elements may comprise components that may be easily deformed under applied loads. Soft elements may be constructed from rubber, foam, fabric, or other materials that may provide low stiffness. Soft elements may be suitable for applications where sealing may be required, where impact absorption may be desired, or where conformance to irregular surfaces may be needed.

In some embodiments, a flow control element may comprise one or more flexible elements. Flexible elements may comprise components that may bend, flex, or otherwise deform under applied loads and that may return to the original shape when the load may be removed. Flexible elements may be constructed from thin metals, plastics, elastomers, fabrics, or other materials that may undergo repeated flexing without failure. Flexible elements may be suitable for applications where movement or deformation may be required during operation.

In some embodiments, a flow control element may comprise one or more flexibles. Flexibles may comprise flexible components or assemblies that may be used to control fluid flow. Flexibles may include flexible curtains, flexible membranes, flexible tubes, or other flexible components that may be positioned to control fluid flow through openings, passages, or other flow paths. Flexibles may be configured to be deployed, retracted, tensioned, or otherwise adjusted to control the amount or direction of fluid flow.

In some embodiments, a flow control element may comprise one or more curtains. Curtains may comprise flexible sheets or panels that may hang or be suspended across a flow path. Curtains may be constructed from fabric, plastic film, rubber, or other flexible materials. Curtains may be raised, lowered, gathered, or otherwise adjusted to control the amount of fluid flow through the opening. Curtains may provide a simple and cost-effective means of flow control in applications where precise control may not be required.

In some embodiments, a flow control element may comprise one or more screens. Screens may comprise mesh, perforated sheets, or other materials with openings that may allow fluid to pass while providing some resistance to flow. Screens may be fixed or movable, and screens may be configured to filter particles, to distribute flow, to reduce turbulence, or to achieve other flow conditioning objectives. The size and density of openings in the screen may affect the flow resistance and filtering characteristics.

In some embodiments, a flow control element may comprise one or more grilles. Grilles may comprise arrays of bars, slats, or other members that may be arranged to allow fluid flow while providing structural support, protection, or aesthetic appearance. Grilles may be fixed or adjustable, and the spacing and orientation of the grille members may affect the flow characteristics. Grilles may be positioned at inlets, outlets, or other locations where flow control and protection may be desired.

In some embodiments, a flow control element may comprise one or more diffusers. Diffusers may comprise components configured to spread or distribute fluid flow across a larger area. Diffusers may include perforated plates, porous materials, or shaped passages that may cause fluid to spread as it passes through the diffuser. Diffusers may be employed to reduce flow velocity, to promote uniform distribution, or to achieve other flow conditioning objectives.

In some embodiments, a flow control element may comprise one or more nozzles. Nozzles may comprise components configured to accelerate, direct, or shape fluid flow. Nozzles may include converging passages that may increase flow velocity, diverging passages that may decrease flow velocity, or shaped passages that may direct flow in a particular direction or pattern. Nozzles may be fixed or adjustable, and the geometry of the nozzle may be selected based on the desired flow characteristics.

In some embodiments, a flow control element may comprise one or more orifices. Orifices may comprise openings or restrictions in a flow path that may control the flow rate or pressure drop. Orifices may be fixed or adjustable, and the size and shape of the orifice may be selected based on the desired flow characteristics. Orifices may be employed to meter flow, to create pressure drops, or to achieve other flow control objectives.

In some embodiments, a flow control element may comprise one or more weirs. Weirs may comprise barriers or obstructions positioned in a flow path that may control the level or flow rate of a liquid. Weirs may be fixed or adjustable, and the height and shape of the weir may affect the flow characteristics. Weirs may be employed in water pools, basins, or channels to control water level, to distribute flow, or to facilitate ice removal.

In some embodiments, a flow control element may comprise one or more gates. Gates may comprise movable barriers that may be raised, lowered, or otherwise adjusted to control fluid flow through an opening. Gates may include sluice gates, slide gates, radial gates, or other gate configurations. Gates may be manually operated, automatically operated, or self-actuating depending on the gate type and the application.

In some embodiments, a flow control element may be constructed from materials selected based on the operating environment. Materials for flow control elements may include one or more or any combination of the following: stainless steel, or aluminum, or carbon steel, or galvanized steel, or copper, or brass, or bronze, or titanium, or nickel alloys, or polyvinyl chloride, or polypropylene, or polyethylene, or high-density polyethylene, or polyvinylidene fluoride, or fiberglass reinforced plastic, or carbon fiber composites, or concrete, or wood, or rubber, or elastomers, or fabric, or any combination thereof. The selection of material may depend on factors including corrosion resistance, temperature resistance, strength, stiffness, weight, cost, or any combination thereof.

In some embodiments, a flow control element may include sealing features. Sealing features may be configured to prevent or reduce fluid leakage around the flow control element when the flow control element is in a closed or partially closed position. Sealing features may include gaskets, O-rings, lip seals, compression seals, inflatable seals, or other sealing mechanisms. The sealing features may be constructed from rubber, elastomers, plastics, metals, or other materials that may provide effective sealing under the operating conditions.

In some embodiments, a flow control element may include heating features. Heating features may be configured to prevent ice formation on the flow control element, to remove ice that may have formed, or to maintain the flow control element at a temperature suitable for operation. Heating features may include electric heating elements, circulating heated fluids, radiant heaters, or other heating mechanisms. Heating features may be particularly relevant for flow control elements employed in cold climate applications where ice formation may affect operation.

In some embodiments, a flow control element may include position indicators. Position indicators may be configured to indicate the current position or state of the flow control element. Position indicators may include visual indicators, mechanical indicators, electrical position sensors, or other indication mechanisms. Position indicators may provide information to operators or control systems regarding the current configuration of the flow control element.

In some embodiments, a flow control element may include limit switches or position sensors. Limit switches or position sensors may be configured to detect when the flow control element has reached a particular position, such as fully open, fully closed, or an intermediate position. The signals from limit switches or position sensors may be used by control systems to verify that the flow control element has reached the commanded position, to prevent over-travel, or to provide feedback for closed-loop control.

In some embodiments, a damper may comprise any flow control element configured to control fluid flow by partial, proportional, or complete obstruction or regulation. A damper may not be limited to internal duct-mounted devices, continuously variable mechanisms, or any particular actuation, geometry, sealing approach, or operating environment. A damper may function in binary mode, in discrete mode, or in continuously variable mode. In binary mode, a damper may be in one of two states, such as fully open or fully closed. In discrete mode, a damper may be in one of a plurality of discrete states corresponding to specific positions. In continuously variable mode, a damper may be adjusted to any position within a continuous range between fully closed and fully open.

In some embodiments, a damper may be externally located or internally located. An externally located damper may be positioned at an exterior surface of a structure, at an inlet opening, at an outlet opening, or at another location exposed to the external environment. An internally located damper may be positioned within a duct, within a conduit, within an air passage, or at another location within the interior of a structure or system. The location of a damper may be selected based at least in part on the flow control objectives, the accessibility for maintenance, the environmental exposure, or other factors.

In some embodiments, a damper may be used to open, close, or modulate a flow path. Opening a flow path may allow fluid to flow through the flow path with reduced or minimal restriction. Closing a flow path may prevent or substantially reduce fluid flow through the flow path. Modulating a flow path may adjust the flow area or flow resistance to achieve a desired flow rate or flow characteristic intermediate between fully open and fully closed conditions.

In some embodiments, the term damper may be used interchangeably with the term flow control element. The use of the term damper may not imply any narrowing relative to the definition of flow control element provided herein. A damper may comprise any of the components, configurations, operating modes, actuation mechanisms, or other features described herein with respect to flow control elements.

In some embodiments, a shutter may comprise any flow control element configured to open, close, or otherwise control exposure of an opening or region to fluid flow. A shutter may not be limited to binary operation, environmental exposure control, architectural applications, or externally mounted structures. A shutter may operate in binary mode, in staged mode, or in continuously adjustable mode. In binary mode, a shutter may be in one of two states, such as fully open or fully closed. In staged mode, a shutter may be in one of a plurality of discrete states, wherein each state may correspond to a different degree of opening. In continuously adjustable mode, a shutter may be adjusted to any position within a continuous range between fully closed and fully open.

In some embodiments, a shutter may include a single movable member or multiple movable members. A single movable member may comprise a panel, a door, a flap, or another component that may be moved to open or close an opening. Multiple movable members may comprise an array of panels, an array of louvers, an array of slats, or other components that may be moved together or independently to control the exposure of an opening to fluid flow. The movable members of a shutter may be hinged, pivoting, sliding, folding, rolling, or otherwise configured for movement.

In some embodiments, a shutter may be actively actuated or passively actuated. An actively actuated shutter may be moved by an actuator, a motor, a pneumatic cylinder, a hydraulic cylinder, or another powered mechanism. A passively actuated shutter may be moved by pressure differential, by wind forces, by gravity, by thermal expansion, or by another mechanism that may not require external power. A shutter may also be manually actuated, wherein an operator may physically move the shutter to the desired position.

In some embodiments, a shutter may be actuated in response to environmental inputs or control inputs. Environmental inputs may include wind direction, wind speed, ambient temperature, ambient pressure, precipitation, ice formation, solar radiation, or other environmental conditions. Control inputs may include signals from a control system, commands from an operator, outputs from sensors, outputs from predictive models, or other control signals. A shutter may be configured to adjust position or configuration in response to environmental inputs, control inputs, or any combination thereof.

In some embodiments, the term shutter may be used interchangeably with the term flow control element. The use of the term shutter may not imply any narrowing relative to the definition of flow control element provided herein. A shutter may comprise any of the components, configurations, operating modes, actuation mechanisms, or other features described herein with respect to flow control elements.

In some embodiments, the terms damper and shutter may be used interchangeably with each other and with the term flow control element. The selection of terminology may depend on the context, the industry convention, or the preference of the user, and the selection of one term over another may not imply any limitation on the scope or configuration of the flow control element. A component referred to as a damper may have the same or similar features as a component referred to as a shutter, and both may have the same or similar features as a component referred to as a flow control element.

In some embodiments, a thermal exchange zone may comprise a portion of a process or a region of a system where heat may be transferred between a fluid and air. The thermal exchange zone may be configured to facilitate heat transfer from a fluid at a first temperature to air at a second temperature, wherein the first temperature may be different from the second temperature. Heat transfer within the thermal exchange zone may occur through direct contact between the fluid and the air, through indirect contact via heat exchanger surfaces, or through any combination thereof.

In some embodiments, a thermal exchange zone may comprise a region where a fluid comprising water may be contacted with air. The contact between the water and the air may allow heat to be transferred from the water to the air when the water may be at a higher temperature than the air, or from the air to the water when the air may be at a higher temperature than the water. The thermal exchange zone may be configured to maximize the contact area between the water and the air, to maximize the residence time of the water in contact with the air, or to otherwise enhance heat transfer between the water and the air.

In some embodiments, a thermal exchange zone may comprise one or more water pools, one or more water basins, one or more water sprayers, one or more water curtains, one or more water films, one or more heat exchangers, or any combination thereof. Water pools and water basins may provide surfaces over which air may flow, allowing heat transfer between the water in the pool or basin and the air flowing over the surface. Water sprayers may disperse water into droplets that may be contacted with air, providing large surface areas for heat transfer. Water curtains and water films may provide thin layers of water through which air may pass or over which air may flow. Heat exchangers may provide surfaces through which heat may be transferred from water to air without direct contact between the water and the air.

In some embodiments, a thermal exchange zone may be configured to transfer sensible heat from a fluid to air. Sensible heat transfer may occur when heat is transferred from the fluid to the air without a phase change occurring in the fluid. Sensible heat transfer may result in cooling of the fluid and warming of the air. The amount of sensible heat transferred may be related to the specific heat capacity of the fluid, the mass of fluid involved in the heat transfer, and the temperature change of the fluid.

In some embodiments, a thermal exchange zone may be configured to transfer latent heat from a fluid to air. Latent heat transfer may occur when a phase change occurs in the fluid during heat transfer. When a liquid freezes to form a solid, latent heat may be released, and the released latent heat may be transferred to the air. The amount of latent heat transferred may be related to the enthalpy of fusion of the fluid and the mass of fluid that undergoes the phase change.

In some embodiments, a thermal exchange zone may be configured to transfer both sensible heat and latent heat from a fluid to air. When a fluid at a temperature above the freezing point of the fluid contacts air at a temperature below the freezing point of the fluid, sensible heat may first be transferred as the fluid cools toward the freezing point, and latent heat may then be transferred as at least a portion of the fluid freezes. The combination of sensible heat transfer and latent heat transfer may provide greater total heat transfer than sensible heat transfer alone.

In some embodiments, a thermal exchange zone may comprise an air plus fluid contactor. An air plus fluid contactor may comprise any device, structure, or region configured to bring air into contact with a fluid for the purpose of heat transfer, mass transfer, or any combination thereof. An air plus fluid contactor may include spray chambers, packed towers, tray columns, wetted wall columns, or other contacting devices. The air plus fluid contactor may be configured to maximize contact between the air and the fluid while minimizing pressure drop and energy consumption.

In some embodiments, a thermal exchange zone may be positioned at various locations within a thermal power generation system. The thermal exchange zone may be positioned at or near the base of an air conduit, within an air conduit, at or near an inlet of an air conduit, or at other locations where heat transfer from a fluid to air may be desired. The position of the thermal exchange zone may affect the airflow characteristics through the system, the temperature of the air at various locations within the system, and the performance of power generation equipment.

In some embodiments, a thermal exchange zone may be positioned such that air contacts the thermal exchange zone before contacting a power generation unit. In such configurations, the air may be warmed by heat transfer from the fluid in the thermal exchange zone, and the warmed air may then flow through the power generation unit. The warming of the air may reduce the density of the air, which may create buoyancy forces that may drive the air through the power generation unit and through an air conduit.

In some embodiments, a thermal exchange zone may be positioned such that air contacts a power generation unit before contacting the thermal exchange zone. In such configurations, the air may flow through the power generation unit before being warmed by heat transfer from the fluid in the thermal exchange zone. The warming of the air after passing through the power generation unit may create buoyancy forces that may draw air through the power generation unit and through an air conduit.

In some embodiments, a system may comprise multiple thermal exchange zones. A first thermal exchange zone may be configured to transfer heat from a first fluid to air, and a second thermal exchange zone may be configured to transfer heat from a second fluid to air. The first fluid and the second fluid may have different compositions, different temperatures, different flow rates, or other different characteristics. The multiple thermal exchange zones may be arranged in series, in parallel, or in other configurations depending on the desired heat transfer characteristics and system performance.

In some embodiments, a first thermal exchange zone may comprise an air plus fluid contactor wherein a fluid comprising a brine may be contacted with air. The contact between the brine and the air may result in the production of a solid comprising ice, a solid comprising a salt, a liquid comprising a brine, or any combination thereof. The brine may have a freezing point that may be lower than the freezing point of freshwater due to the presence of dissolved salts. When the brine contacts air at a temperature below the freezing point of the brine, at least a portion of the water in the brine may freeze to form ice, and the remaining liquid may become more concentrated in dissolved salts.

In some embodiments, a second thermal exchange zone may comprise an air plus fluid contactor wherein a fluid comprising water, freshwater, brackish water, or seawater may be contacted with air. The contact between the water and the air may result in heat transfer from the water to the air, which may warm the air and may cool the water. When the air temperature may be below the freezing point of the water, at least a portion of the water may freeze to form ice.

In some embodiments, at least a portion of the air may contact a first thermal exchange zone before contacting a second thermal exchange zone. The air may be partially warmed by heat transfer in the first thermal exchange zone, and the partially warmed air may then contact the second thermal exchange zone where additional heat transfer may occur. The sequential arrangement of thermal exchange zones may allow different fluids to be processed in different zones, may allow different operating conditions in different zones, or may provide other operational flexibility.

In some embodiments, an air turbine may comprise a system configured to convert motion of air into power. The power may comprise mechanical work, electrical power, or any combination thereof. An air turbine may harness the kinetic energy of moving air and may convert the kinetic energy into rotational mechanical energy, which may then be converted into electrical energy through a generator or may be used directly as mechanical power.

In some embodiments, an air turbine may also be referred to as a pneumatic turbine. The terms air turbine and pneumatic turbine may be used interchangeably to refer to a system configured to convert motion of air into power. The selection of terminology may depend on the context, the industry convention, or the preference of the user, and the selection of one term over another may not imply any limitation on the scope or configuration of the turbine.

In some embodiments, an air turbine may comprise rotating blades. The rotating blades may be configured to interact with moving air such that the kinetic energy of the moving air may be transferred to the rotating blades, causing the blades to rotate. The rotating blades may be mounted on a hub, a rotor, or another rotating assembly that may be supported by bearings and that may be connected to power conversion equipment. The rotating blades may have airfoil cross-sections, flat cross-sections, curved cross-sections, or other cross-sectional shapes that may be configured to extract energy from the moving air.

In some embodiments, the rotating blades of an air turbine may be connected to a gearbox. The gearbox may be configured to change the rotational speed between the rotating blades and a generator or other power conversion equipment. The gearbox may increase the rotational speed when the rotating blades may rotate at a lower speed than the optimal speed for the generator, or the gearbox may decrease the rotational speed when the rotating blades may rotate at a higher speed than the optimal speed for the generator. The gearbox may comprise gears, shafts, bearings, housings, and other components configured to transmit rotational power while changing the rotational speed.

In some embodiments, the rotating blades of an air turbine may be connected to a generator. The generator may be configured to convert rotational mechanical energy into electrical energy. The generator may comprise a rotor, a stator, windings, magnets, and other components configured to generate electrical power from rotational motion. The generator may be a synchronous generator, an asynchronous generator, a permanent magnet generator, or another type of generator depending on the application requirements.

In some embodiments, an air turbine may be connected to a generator through a gearbox. The gearbox may be positioned between the rotating blades and the generator, and the gearbox may transmit rotational power from the rotating blades to the generator while changing the rotational speed. The combination of the air turbine, the gearbox, and the generator may form a power generation unit configured to convert the kinetic energy of moving air into electrical power.

In some embodiments, an air turbine may be directly connected to a generator without a gearbox. Direct connection may be employed when the rotational speed of the rotating blades may be compatible with the optimal speed of the generator, or when variable speed generators may be employed that may operate efficiently over a range of rotational speeds. Direct connection may reduce mechanical complexity, may reduce maintenance requirements, and may improve efficiency by eliminating losses in the gearbox.

In some embodiments, an air turbine may comprise a horizontal axis configuration. In a horizontal axis configuration, the axis of rotation of the rotating blades may be oriented horizontally or substantially horizontally. Horizontal axis air turbines may be positioned such that the axis of rotation may be aligned with the direction of airflow, and the rotating blades may rotate in a plane that may be perpendicular to the direction of airflow. Horizontal axis air turbines may be suitable for applications where airflow may be predominantly in a single direction.

In some embodiments, an air turbine may comprise a vertical axis configuration. In a vertical axis configuration, the axis of rotation of the rotating blades may be oriented vertically or substantially vertically. Vertical axis air turbines may be configured to accept airflow from any horizontal direction without requiring reorientation of the turbine. Vertical axis air turbines may be suitable for applications where airflow direction may vary or where the turbine may be positioned in a location where horizontal axis orientation may not be practical.

In some embodiments, an air turbine may be positioned within an air conduit. Positioning the air turbine within the air conduit may allow the turbine to capture the kinetic energy of air flowing through the conduit. The air conduit may concentrate the airflow and may increase the airflow velocity at the location of the turbine, which may increase the power available for extraction. The air turbine may be sized to match the cross-sectional area of the air conduit, or the air conduit may include a contraction or expansion to match the turbine size.

In some embodiments, an air turbine may be positioned at an inlet of an air conduit. Positioning the air turbine at the inlet may allow the turbine to capture the kinetic energy of air entering the conduit. The air may pass through the turbine before being warmed by heat transfer from a fluid, and the buoyancy of the warmed air may draw air through the turbine and into the conduit.

In some embodiments, an air turbine may be positioned at an outlet of an air conduit. Positioning the air turbine at the outlet may allow the turbine to capture the kinetic energy of air exiting the conduit. The air may be warmed by heat transfer from a fluid before passing through the turbine, and the warmed air may have increased velocity due to the buoyancy-induced pressure difference across the conduit.

In some embodiments, multiple air turbines may be positioned within a thermal power generation system. The multiple air turbines may be arranged in series along the airflow path, in parallel across the airflow path, or in other configurations. Multiple air turbines arranged in series may each extract a portion of the kinetic energy from the airflow, with the total power extraction being the sum of the power extracted by each turbine. Multiple air turbines arranged in parallel may each receive a portion of the total airflow, with the total power extraction being the sum of the power extracted by each turbine.

In some embodiments, an air turbine may be configured with variable pitch blades. Variable pitch blades may be configured to rotate about the longitudinal axis of the blade to change the angle of attack of the blade relative to the airflow. Adjusting the pitch of the blades may allow the turbine to operate efficiently over a range of airflow velocities, may allow the power extraction to be controlled, and may allow the turbine to be protected from damage during high airflow velocity conditions.

In some embodiments, an air turbine may be configured with fixed pitch blades. Fixed pitch blades may have a blade angle that may not be adjusted during operation. Fixed pitch blades may be simpler and may have lower maintenance requirements than variable pitch blades. Fixed pitch blades may be suitable for applications where the airflow velocity may be relatively constant or where the simplicity of fixed pitch blades may outweigh the performance benefits of variable pitch blades.

In some embodiments, an air turbine may include a nacelle. The nacelle may comprise an enclosure that may house the gearbox, the generator, control systems, and other components of the air turbine. The nacelle may be positioned behind the rotating blades in a horizontal axis configuration, or the nacelle may be positioned at the top or bottom of the turbine in a vertical axis configuration. The nacelle may provide protection for the enclosed components from environmental conditions.

In some embodiments, an air turbine may include a yaw system. The yaw system may be configured to rotate the turbine about a vertical axis to align the turbine with the direction of airflow. The yaw system may be employed in horizontal axis turbines to maintain alignment with changing airflow directions. The yaw system may be actively controlled based on wind direction sensors, or the yaw system may be passively controlled through aerodynamic forces.

In some embodiments, an air turbine may include a braking system. The braking system may be configured to slow or stop the rotation of the rotating blades. The braking system may be employed during maintenance, during emergency conditions, during high airflow velocity conditions, or during other situations where stopping or slowing the turbine may be desired. The braking system may comprise mechanical brakes, aerodynamic brakes, electrical braking, or any combination thereof.

In some embodiments, an air turbine may be configured to operate over a range of airflow velocities. The air turbine may have a cut-in velocity below which the turbine may not generate power, a rated velocity at which the turbine may generate rated power, and a cut-out velocity above which the turbine may be shut down to prevent damage. The cut-in velocity, rated velocity, and cut-out velocity may be selected based on the expected airflow conditions and the design of the turbine.

In some embodiments, an air turbine may be configured to generate power at airflow velocities that may be lower than typical wind turbine operating velocities. The airflow through an air conduit in a thermal power generation system may have velocities that may be lower than typical wind velocities, and the air turbine may be designed to operate efficiently at such lower velocities. Design features that may allow efficient operation at lower velocities may include larger blade diameters, lower tip speed ratios, optimized blade profiles, or other features.

In some embodiments, the power output of an air turbine may be related to the cube of the airflow velocity. The power available in moving air may be proportional to the cube of the velocity, meaning that doubling the airflow velocity may increase the available power by a factor of eight. The relationship between power and velocity may make airflow velocity an important factor in the design and operation of thermal power generation systems.

In some embodiments, the power output of an air turbine may be related to the swept area of the rotating blades. The swept area may be the area through which the rotating blades may pass during rotation. For a horizontal axis turbine, the swept area may be the area of a circle with a diameter equal to the blade diameter. For a vertical axis turbine, the swept area may depend on the turbine configuration. Larger swept areas may allow greater power extraction from the airflow.

In some embodiments, an air turbine may have a power coefficient that may represent the fraction of the available power in the airflow that may be extracted by the turbine. The theoretical maximum power coefficient may be approximately 0.593, which may be referred to as the Betz limit. Practical air turbines may have power coefficients that may be lower than the Betz limit due to aerodynamic losses, mechanical losses, and other factors. The power coefficient may vary with airflow velocity, blade pitch, and other operating parameters.

In some embodiments, cold air may comprise air at a temperature that may be lower than the temperature of warm air. Cold air may comprise air that may be at a temperature lower than a reference temperature, lower than the temperature of a fluid, lower than the temperature of a heat source, or lower than the temperature of air that may have been warmed through heat transfer. Cold air may comprise fresh air, outside air, ambient air, atmospheric air, or air from other sources that may not have been warmed through contact with a heat source within a thermal power generation system.

In some embodiments, cold air may comprise air at a temperature below the freezing point of water. When cold air may be at a temperature below the freezing point of water, the cold air may be capable of absorbing heat from liquid water and may be capable of inducing freezing of at least a portion of the water. Cold air at temperatures below the freezing point of water may be present in cold climate regions, in Arctic regions, in sub-Arctic regions, in high altitude regions, or in other locations where ambient air temperatures may fall below the freezing point of water. The freezing point of freshwater may be approximately 0 degrees Celsius at standard atmospheric pressure, and the freezing point of seawater or brine may be lower than the freezing point of freshwater due to the presence of dissolved salts.

In some embodiments, cold air may comprise air at a temperature below approximately negative 5 degrees Celsius, or below approximately negative 10 degrees Celsius, or below approximately negative 15 degrees Celsius, or below approximately negative 20 degrees Celsius, or below approximately negative 25 degrees Celsius, or below approximately negative 30 degrees Celsius, or below approximately negative 35 degrees Celsius, or below approximately negative 40 degrees Celsius, or below approximately negative 45 degrees Celsius, or below approximately negative 50 degrees Celsius, or any combination thereof. Colder air temperatures may provide greater temperature differences relative to liquid water, which may result in greater heat transfer rates, greater buoyancy-induced airflow, and greater power generation potential.

In some embodiments, cold air may comprise outside air. Outside air may comprise air from the external environment that may be drawn into a thermal power generation system through air inlets, through openings, through shutters, or through other entry points. Outside air may have temperature, humidity, pressure, and composition characteristics that may vary based on geographic location, season, time of day, weather conditions, or other factors. Outside air may be the source of cold air for thermal power generation systems that may operate by transferring heat from a fluid to the cold air.

In some embodiments, cold air may comprise fresh air. Fresh air may comprise air that may not have been recirculated through a thermal power generation system, air that may not have been previously heated by contact with a heat source, or air that may be drawn from the external environment. Fresh air may have characteristics that may be representative of the ambient conditions at the location of the thermal power generation system.

In some embodiments, cold air may comprise air that may enter a thermal power generation system at an air inlet. The air inlet may be positioned at a lower elevation of an air conduit, at the base of a tower, at a peripheral location around a thermal exchange zone, or at other locations where cold air may be drawn into the system. The cold air entering through the air inlet may be at ambient temperature, which may be the temperature of the external environment at the location of the air inlet.

In some embodiments, warm air may comprise air at a temperature that may be higher than the temperature of cold air. Warm air may comprise air that may have been heated, air that may have absorbed heat from a heat source, air that may have contacted a fluid at a temperature higher than the temperature of the air, or air that may have undergone a temperature increase through heat transfer. Warm air may have a temperature that may be higher than the temperature of the air prior to heat transfer.

In some embodiments, warm air may comprise air that may have been warmed through contact with a heat source. The heat source may comprise a fluid, a liquid, water, a solid-liquid mixture, a phase change material, a heat exchanger surface, or another source of thermal energy. Contact between the air and the heat source may allow heat to be transferred from the heat source to the air, which may increase the temperature of the air. The contact may be direct contact, wherein the air may physically contact the heat source, or the contact may be indirect contact, wherein heat may be transferred through an intervening surface or medium.

In some embodiments, warm air may comprise air that may have absorbed sensible heat from a fluid. Sensible heat transfer may occur when heat is transferred from a fluid to air without a phase change occurring in the fluid. The absorption of sensible heat may increase the temperature of the air, and the temperature increase may be related to the amount of heat transferred, the mass of air, and the specific heat capacity of air.

In some embodiments, warm air may comprise air that may have absorbed latent heat from a fluid. Latent heat transfer may occur when a phase change occurs in the fluid during heat transfer. When a liquid freezes to form a solid, latent heat may be released, and the released latent heat may be absorbed by the air. The absorption of latent heat may increase the temperature of the air, and the temperature increase may be related to the amount of latent heat released and the mass of air.

In some embodiments, warm air may comprise air that may have absorbed both sensible heat and latent heat from a fluid. When a fluid at a temperature above the freezing point of the fluid contacts air at a temperature below the freezing point of the fluid, sensible heat may first be transferred as the fluid cools toward the freezing point, and latent heat may then be released as at least a portion of the fluid freezes. The air may absorb both the sensible heat and the latent heat, resulting in a temperature increase that may be greater than if only sensible heat were transferred.

In some embodiments, warm air may have a lower density than cold air at the same pressure. The density of air may be inversely related to the temperature of the air at constant pressure, such that air at a higher temperature may have a lower density than air at a lower temperature. The density difference between warm air and cold air may create buoyancy forces that may cause the warm air to rise relative to the cold air.

In some embodiments, warm air may comprise air at a temperature above approximately-5 degrees Celsius above approximately 0 degrees Celsius, or above approximately 5 degrees Celsius, or above approximately 10 degrees Celsius, or above approximately 15 degrees Celsius, or above approximately 20 degrees Celsius, or above approximately 25 degrees Celsius, or above approximately 30 degrees Celsius, or above approximately 40 degrees Celsius, or above approximately 50 degrees Celsius, or any combination thereof. The temperature of warm air may depend on the temperature of the heat source, the amount of heat transferred, the mass of air, and other factors.

In some embodiments, warm air may comprise air that may exit a thermal exchange zone after heat transfer from a fluid. The warm air exiting the thermal exchange zone may have a temperature that may be higher than the temperature of the cold air entering the thermal exchange zone. The temperature difference between the warm air and the cold air may be related to the amount of heat transferred in the thermal exchange zone.

In some embodiments, a tower may comprise a structure configured to guide airflow in a vertical direction. A tower may provide an enclosed or partially enclosed passage through which air may flow from a lower elevation to a higher elevation. The tower may be oriented vertically or substantially vertically, and the tower may extend from a base at a lower elevation to a top at a higher elevation. The tower may be configured to facilitate the chimney effect by providing a vertical distance over which buoyancy-induced pressure differences may develop.

In some embodiments, a tower may comprise a structure that may extend upward from a base or foundation. The tower may have a height that may range from approximately 1 meter to approximately 1000 meters or more. The tower may have a cross-sectional area that may be constant along the height of the tower, or the cross-sectional area may vary along the height of the tower. The tower may have a circular cross-section, a rectangular cross-section, a polygonal cross-section, or another cross-sectional shape.

In some embodiments, a tower may comprise a chimney, a stack, a flue, a duct, a conduit, a tube, a pipe, or another structure that may provide a passage for vertical airflow. The tower may be constructed from metals, concrete, plastics, composites, masonry, ice, ice composites, or other materials. The tower may be a freestanding structure, a guyed structure, a structure supported by a geographic feature, or a structure integrated with other buildings or facilities.

In some embodiments, a tower may comprise an updraft tower. An updraft tower may be a tower configured to facilitate upward airflow due to buoyancy forces. The updraft tower may be positioned such that warm air may enter the tower at a lower elevation and may exit the tower at a higher elevation. The buoyancy of the warm air relative to cooler surrounding air may drive the upward airflow through the updraft tower.

In some embodiments, a tower may comprise a solar updraft tower, a thermal updraft tower, or another type of tower configured to generate upward airflow through thermal effects. A solar updraft tower may generate upward airflow by heating air through solar radiation. A thermal updraft tower may generate upward airflow by heating air through heat transfer from a fluid or another heat source. The principles of updraft tower operation may be applied to thermal power generation systems that may transfer heat from a fluid to air.

In some embodiments, a tower may be configured to contain or direct airflow. The walls of the tower may prevent air from escaping laterally and may direct the air to flow vertically through the tower. The tower may include inlet openings at or near the base where air may enter, and the tower may include outlet openings at or near the top where air may exit. The tower may be configured to minimize flow resistance and to maximize the conversion of buoyancy-induced pressure difference into airflow velocity.

In some embodiments, a tower may be configured to house or support other components of a thermal power generation system. The tower may house air turbines, generators, heat exchangers, flow control elements, sensors, control systems, or other components. The tower may provide structural support for components that may be positioned within the tower or attached to the tower. The tower may provide protection for components from environmental conditions.

In some embodiments, an updraft may comprise airflow from a lower elevation to a higher elevation. An updraft may be airflow that moves in an upward direction, rising from a position at a lower elevation to a position at a higher elevation. An updraft may be induced by buoyancy forces, by pressure differences, by mechanical means, or by other mechanisms that may cause air to move upward.

In some embodiments, an updraft may be induced by buoyancy forces. Buoyancy forces may arise when air at a lower density may be surrounded by air at a higher density. The lower density air may experience an upward force relative to the higher density air, and the lower density air may rise. When air is warmed through heat transfer from a fluid, the warmed air may have a lower density than surrounding cooler air, and the warmed air may rise as an updraft.

In some embodiments, an updraft may be induced by the chimney effect. The chimney effect may occur when air inside a vertical or inclined conduit may be warmer than air outside the conduit. The warmer air inside the conduit may have a lower density than the cooler air outside the conduit, and the density difference may create a pressure difference that may drive airflow through the conduit. The airflow may enter the conduit at a lower elevation and may exit the conduit at a higher elevation, constituting an updraft.

In some embodiments, an updraft may be characterized by airflow velocity, airflow rate, temperature, pressure, or other parameters. The airflow velocity of an updraft may range from approximately 0.1 meters per second to approximately 50 meters per second or more. The airflow rate of an updraft may range from approximately 1 cubic meter per second to approximately 10,000 cubic meters per second or more. The temperature of an updraft may be higher than the temperature of surrounding air due to heat transfer from a fluid.

In some embodiments, an updraft may be sustained as long as heat may continue to be transferred to the air. Continuous heat transfer may maintain the temperature difference between the air in the updraft and the surrounding air, which may maintain the buoyancy forces that may drive the updraft. The sustained updraft may provide a continuous source of kinetic energy that may be harnessed for power generation or other purposes.

In some embodiments, an updraft may flow through an air conduit, a tower, a chimney, a duct, or another structure that may guide the upward airflow. The structure may provide an enclosed or partially enclosed passage that may direct the updraft from a lower elevation to a higher elevation. The structure may be configured to minimize flow resistance and to maximize the airflow velocity of the updraft.

In some embodiments, an updraft may be harnessed for power generation. Air turbines may be positioned in the path of the updraft to extract kinetic energy from the moving air. The kinetic energy extracted by the air turbines may be converted to electrical power through generators. The power generated from the updraft may be transmitted to an electrical grid, may be stored in energy storage systems, may be used to power on-site equipment, or may be employed for other purposes.

In some embodiments, an updraft may be harnessed for air movement applications. The updraft may provide air movement for ventilation, for cooling, for drying, for direct air capture of carbon dioxide, or for other applications that may benefit from controlled airflow. The updraft may provide air movement without the need for fans or blowers, which may reduce energy consumption and may simplify system design.

In some embodiments, the terms cold air, warm air, tower, and updraft may be used in combination to describe thermal power generation systems. Cold air may enter a tower at a lower elevation, may be warmed through heat transfer from a fluid, and may rise as an updraft through the tower to exit at a higher elevation. The updraft may be harnessed for power generation or other purposes. The combination of cold air, heat transfer, warm air, tower, and updraft may form the basis for thermal power generation from temperature differences between fluids and air.

In some embodiments, an air flow conduit may comprise any structure, passage, channel, pathway, enclosure, or region configured to permit, guide, direct, contain, facilitate, or otherwise accommodate the movement of air from a first location to a second location. An air flow conduit may be configured to enable air to move between locations at different elevations, at different pressures, at different temperatures, or at different positions within a system. The air flow conduit may provide a defined flow path through which air may travel in response to buoyancy forces, pressure differences, mechanical forces, wind forces, or any combination thereof.

In some embodiments, an air flow conduit may comprise an enclosed passage, a partially enclosed passage, an open passage, or any combination thereof. An enclosed passage may substantially surround the airflow on all sides, preventing or reducing lateral escape of air from the flow path. A partially enclosed passage may surround the airflow on some sides while leaving other sides open or partially open. An open passage may guide airflow through structural features, terrain features, or other elements that may influence the direction of air movement.

In some embodiments, an air flow conduit may comprise one or more or any combination of the following: a tower, or a chimney, or a stack, or a flue, or a duct, or a tube, or a pipe, or a channel, or a tunnel, or a shaft, or a passage, or a corridor, or a conduit, or a plenum, or a manifold, or a header, or a riser, or a downcomer, or a penstock, or a culvert, or a gallery, or a drift, or an adit, or a bore, or a well, or a casing, or a liner, or a sleeve, or any combination thereof.

In some embodiments, an air flow conduit may be oriented vertically, substantially vertically, inclined at an angle relative to vertical, inclined at an angle relative to horizontal, horizontally, or at any orientation that may permit air to flow from a first elevation to a second elevation. The orientation of the air flow conduit may be constant along the length of the conduit, or the orientation may vary along the length of the conduit. An air flow conduit may comprise straight sections, curved sections, angled sections, or any combination thereof.

In some embodiments, an air flow conduit may have a cross-sectional shape that may be circular, elliptical, oval, rectangular, square, triangular, polygonal, irregular, or any other shape. The cross-sectional area of the air flow conduit may be constant along the length of the conduit, or the cross-sectional area may vary along the length of the conduit. The air flow conduit may comprise converging sections where the cross-sectional area decreases in the direction of airflow, diverging sections where the cross-sectional area increases in the direction of airflow, or any combination thereof.

In some embodiments, an air flow conduit may be constructed from one or more or any combination of the following materials: metals, or steel, or stainless steel, or aluminum, or copper, or titanium, or alloys, or concrete, or reinforced concrete, or prestressed concrete, or masonry, or brick, or stone, or plastics, or polymers, or polyvinyl chloride, or polyethylene, or polypropylene, or fiberglass, or composites, or carbon fiber composites, or glass fiber composites, or wood, or timber, or fabric, or membrane materials, or ice, or ice composites, or pykrete, or frozen materials, or earthen materials, or excavated materials, or natural materials, or any combination thereof.

In some embodiments, an air flow conduit may comprise a freestanding structure, a guyed structure, a supported structure, a suspended structure, a cantilevered structure, a braced structure, or any combination thereof. The air flow conduit may be supported by foundations, by piles, by anchors, by cables, by guy wires, by adjacent structures, by geographic features, by terrain, or by any combination thereof.

In some embodiments, an air flow conduit may be at least partially formed by, supported by, or integrated with a geographic feature. Geographic features that may form, support, or integrate with an air flow conduit may include one or more or any combination of the following: hills, or mountains, or cliffs, or ridges, or valleys, or canyons, or escarpments, or bluffs, or mesas, or plateaus, or glaciers, or hillsides, or mountainsides, or cliffsides, or slopes, or inclines, or terrain features, or natural formations, or any combination thereof. The air flow conduit may be built on a geographic feature, built against a geographic feature, built within a geographic feature, or built through a geographic feature.

In some embodiments, an air flow conduit may comprise a tunnel, a bore, an excavation, a cavity, or a passage formed within a geographic feature. The tunnel or excavation may extend from an inlet at a first elevation to an outlet at a second elevation, providing a passage for airflow through the geographic feature. The interior surfaces of the tunnel or excavation may be lined, coated, reinforced, or otherwise treated to provide desired flow characteristics, structural support, or environmental protection.

In some embodiments, an air flow conduit may comprise a retrofit of a pre-existing structure. Pre-existing structures that may be retrofitted to serve as air flow conduits may include one or more or any combination of the following: smokestacks, or chimneys, or industrial stacks, or cooling towers, or ventilation shafts, or elevator shafts, or stairwells, or buildings, or silos, or tanks, or towers, or wind turbine towers, or communication towers, or transmission towers, or oil and gas structures, or drilling rigs, or platforms, or ships, or vessels, or offshore structures, or any combination thereof.

In some embodiments, an air flow conduit may comprise a rigid structure, a semi-rigid structure, a flexible structure, or any combination thereof. A rigid air flow conduit may maintain a substantially fixed shape under normal operating conditions. A semi-rigid air flow conduit may have some flexibility while maintaining a general configuration. A flexible air flow conduit may be capable of deformation, movement, or reconfiguration in response to forces, conditions, or operational requirements.

In some embodiments, an air flow conduit may comprise a fixed structure, a semi-mobile structure, a mobile structure, a modular structure, a collapsible structure, an expandable structure, an inflatable structure, a deployable structure, a retractable structure, a temporary structure, a semi-permanent structure, a permanent structure, or any combination thereof.

In some embodiments, an air flow conduit may comprise one or more air inlets and one or more air outlets. The air inlets may be positioned at a first elevation, and the air outlets may be positioned at a second elevation, wherein the first elevation may be lower than the second elevation. The air inlets and air outlets may be configured with flow control elements, shutters, dampers, louvers, valves, doors, or other elements that may permit, restrict, or regulate airflow through the inlets and outlets.

In some embodiments, an air flow conduit may be configured to house, contain, support, or integrate with other system components. Components that may be housed within, attached to, or integrated with an air flow conduit may include one or more or any combination of the following: air turbines, or power generation units, or generators, or heat exchangers, or thermal exchange zones, or fluid contactors, or water sprayers, or water pools, or flow control elements, or sensors, or control systems, or direct air capture contactors, or carbon dioxide absorbers, or any combination thereof.

In some embodiments, thermal power generation systems may operate across a range of air temperatures, water temperatures, freezing points, and temperature differences. The operating conditions may affect the heat transfer rate, the buoyancy-induced airflow, the power generation capacity, the ice production rate, and other system performance parameters. The selection of operating conditions may depend on the geographic location, the season, the time of day, the weather conditions, the available water sources, the intended applications, or any combination thereof.

In some embodiments, the air temperature may be at or below approximately positive 50 degrees Celsius. In some embodiments, the air temperature may be at or below approximately positive 45 degrees Celsius. In some embodiments, the air temperature may be at or below approximately positive 40 degrees Celsius. In some embodiments, the air temperature may be at or below approximately positive 35 degrees Celsius. In some embodiments, the air temperature may be at or below approximately positive 30 degrees Celsius. In some embodiments, the air temperature may be at or below approximately positive 25 degrees Celsius. In some embodiments, the air temperature may be at or below approximately positive 20 degrees Celsius. In some embodiments, the air temperature may be at or below approximately positive 15 degrees Celsius. In some embodiments, the air temperature may be at or below approximately positive 10 degrees Celsius. In some embodiments, the air temperature may be at or below approximately positive 5 degrees Celsius.

In some embodiments, the air temperature may be at or below approximately positive 4 degrees Celsius. In some embodiments, the air temperature may be at or below approximately positive 3 degrees Celsius. In some embodiments, the air temperature may be at or below approximately positive 2 degrees Celsius. In some embodiments, the air temperature may be at or below approximately positive 1 degree Celsius. In some embodiments, the air temperature may be at or below approximately 0 degrees Celsius. In some embodiments, the air temperature may be at or below approximately negative 1 degree Celsius. In some embodiments, the air temperature may be at or below approximately negative 2 degrees Celsius. In some embodiments, the air temperature may be at or below approximately negative 3 degrees Celsius. In some embodiments, the air temperature may be at or below approximately negative 4 degrees Celsius. In some embodiments, the air temperature may be at or below approximately negative 5 degrees Celsius.

In some embodiments, the air temperature may be at or below approximately negative 6 degrees Celsius. In some embodiments, the air temperature may be at or below approximately negative 7 degrees Celsius. In some embodiments, the air temperature may be at or below approximately negative 8 degrees Celsius. In some embodiments, the air temperature may be at or below approximately negative 9 degrees Celsius. In some embodiments, the air temperature may be at or below approximately negative 10 degrees Celsius. In some embodiments, the air temperature may be at or below approximately negative 11 degrees Celsius. In some embodiments, the air temperature may be at or below approximately negative 12 degrees Celsius. In some embodiments, the air temperature may be at or below approximately negative 13 degrees Celsius. In some embodiments, the air temperature may be at or below approximately negative 14 degrees Celsius. In some embodiments, the air temperature may be at or below approximately negative 15 degrees Celsius.

In some embodiments, the air temperature may be at or below approximately negative 20 degrees Celsius. In some embodiments, the air temperature may be at or below approximately negative 25 degrees Celsius. In some embodiments, the air temperature may be at or below approximately negative 30 degrees Celsius. In some embodiments, the air temperature may be at or below approximately negative 35 degrees Celsius. In some embodiments, the air temperature may be at or below approximately negative 40 degrees Celsius. In some embodiments, the air temperature may be at or below approximately negative 45 degrees Celsius. In some embodiments, the air temperature may be at or below approximately negative 50 degrees Celsius. In some embodiments, the air temperature may be at or below approximately negative 55 degrees Celsius. In some embodiments, the air temperature may be at or below approximately negative 60 degrees Celsius. In some embodiments, the air temperature may be at or below approximately negative 65 degrees Celsius. In some embodiments, the air temperature may be at or below approximately negative 70 degrees Celsius. In some embodiments, the air temperature may be at or below approximately negative 75 degrees Celsius. In some embodiments, the air temperature may be at or below approximately negative 80 degrees Celsius.

In some embodiments, the air temperature may be within a range. In some embodiments, the air temperature may be within a range from approximately positive 50 degrees Celsius to approximately positive 40 degrees Celsius. In some embodiments, the air temperature may be within a range from approximately positive 40 degrees Celsius to approximately positive 30 degrees Celsius. In some embodiments, the air temperature may be within a range from approximately positive 30 degrees Celsius to approximately positive 20 degrees Celsius. In some embodiments, the air temperature may be within a range from approximately positive 20 degrees Celsius to approximately positive 10 degrees Celsius. In some embodiments, the air temperature may be within a range from approximately positive 10 degrees Celsius to approximately 0 degrees Celsius. In some embodiments, the air temperature may be within a range from approximately 0 degrees Celsius to approximately negative 10 degrees Celsius. In some embodiments, the air temperature may be within a range from approximately negative 10 degrees Celsius to approximately negative 20 degrees Celsius. In some embodiments, the air temperature may be within a range from approximately negative 20 degrees Celsius to approximately negative 30 degrees Celsius. In some embodiments, the air temperature may be within a range from approximately negative 30 degrees Celsius to approximately negative 40 degrees Celsius. In some embodiments, the air temperature may be within a range from approximately negative 40 degrees Celsius to approximately negative 50 degrees Celsius. In some embodiments, the air temperature may be within a range from approximately negative 50 degrees Celsius to approximately negative 60 degrees Celsius. In some embodiments, the air temperature may be within a range from approximately negative 60 degrees Celsius to approximately negative 70 degrees Celsius. In some embodiments, the air temperature may be within a range from approximately negative 70 degrees Celsius to approximately negative 80 degrees Celsius.

In some embodiments, the water temperature may be at or above approximately negative 10 degrees Celsius. In some embodiments, the water temperature may be at or above approximately negative 9 degrees Celsius. In some embodiments, the water temperature may be at or above approximately negative 8 degrees Celsius. In some embodiments, the water temperature may be at or above approximately negative 7 degrees Celsius. In some embodiments, the water temperature may be at or above approximately negative 6 degrees Celsius. In some embodiments, the water temperature may be at or above approximately negative 5 degrees Celsius. In some embodiments, the water temperature may be at or above approximately negative 4 degrees Celsius. In some embodiments, the water temperature may be at or above approximately negative 3 degrees Celsius. In some embodiments, the water temperature may be at or above approximately negative 2 degrees Celsius. In some embodiments, the water temperature may be at or above approximately negative 1 degree Celsius.

In some embodiments, the water temperature may be at or above approximately 0 degrees Celsius. In some embodiments, the water temperature may be at or above approximately positive 1 degree Celsius. In some embodiments, the water temperature may be at or above approximately positive 2 degrees Celsius. In some embodiments, the water temperature may be at or above approximately positive 3 degrees Celsius. In some embodiments, the water temperature may be at or above approximately positive 4 degrees Celsius. In some embodiments, the water temperature may be at or above approximately positive 5 degrees Celsius. In some embodiments, the water temperature may be at or above approximately positive 6 degrees Celsius. In some embodiments, the water temperature may be at or above approximately positive 7 degrees Celsius. In some embodiments, the water temperature may be at or above approximately positive 8 degrees Celsius. In some embodiments, the water temperature may be at or above approximately positive 9 degrees Celsius. In some embodiments, the water temperature may be at or above approximately positive 10 degrees Celsius.

In some embodiments, the water temperature may be at or above approximately positive 11 degrees Celsius. In some embodiments, the water temperature may be at or above approximately positive 12 degrees Celsius. In some embodiments, the water temperature may be at or above approximately positive 13 degrees Celsius. In some embodiments, the water temperature may be at or above approximately positive 14 degrees Celsius. In some embodiments, the water temperature may be at or above approximately positive 15 degrees Celsius. In some embodiments, the water temperature may be at or above approximately positive 20 degrees Celsius. In some embodiments, the water temperature may be at or above approximately positive 25 degrees Celsius. In some embodiments, the water temperature may be at or above approximately positive 30 degrees Celsius. In some embodiments, the water temperature may be at or above approximately positive 35 degrees Celsius. In some embodiments, the water temperature may be at or above approximately positive 40 degrees Celsius. In some embodiments, the water temperature may be at or above approximately positive 45 degrees Celsius. In some embodiments, the water temperature may be at or above approximately positive 50 degrees Celsius.

In some embodiments, the water temperature may be within a range. In some embodiments, the water temperature may be within a range from approximately negative 10 degrees Celsius to approximately negative 5 degrees Celsius. In some embodiments, the water temperature may be within a range from approximately negative 5 degrees Celsius to approximately 0 degrees Celsius. In some embodiments, the water temperature may be within a range from approximately 0 degrees Celsius to approximately positive 5 degrees Celsius. In some embodiments, the water temperature may be within a range from approximately positive 5 degrees Celsius to approximately positive 10 degrees Celsius. In some embodiments, the water temperature may be within a range from approximately positive 10 degrees Celsius to approximately positive 15 degrees Celsius. In some embodiments, the water temperature may be within a range from approximately positive 15 degrees Celsius to approximately positive 20 degrees Celsius. In some embodiments, the water temperature may be within a range from approximately positive 20 degrees Celsius to approximately positive 25 degrees Celsius. In some embodiments, the water temperature may be within a range from approximately positive 25 degrees Celsius to approximately positive 30 degrees Celsius. In some embodiments, the water temperature may be within a range from approximately positive 30 degrees Celsius to approximately positive 35 degrees Celsius. In some embodiments, the water temperature may be within a range from approximately positive 35 degrees Celsius to approximately positive 40 degrees Celsius. In some embodiments, the water temperature may be within a range from approximately positive 40 degrees Celsius to approximately positive 45 degrees Celsius. In some embodiments, the water temperature may be within a range from approximately positive 45 degrees Celsius to approximately positive 50 degrees Celsius.

In some embodiments, the freezing point of the fluid may vary depending on the composition of the fluid. Freshwater may have a freezing point of approximately 0 degrees Celsius at standard atmospheric pressure. Seawater may have a freezing point that may be lower than the freezing point of freshwater due to the presence of dissolved salts. Brine may have a freezing point that may be lower than the freezing point of seawater depending on the concentration and composition of dissolved salts. The freezing point depression may be related to the molality of dissolved solutes in the fluid.

In some embodiments, the freezing point of the fluid may be at or above approximately positive 10 degrees Celsius. In some embodiments, the freezing point of the fluid may be at or above approximately positive 9 degrees Celsius. In some embodiments, the freezing point of the fluid may be at or above approximately positive 8 degrees Celsius. In some embodiments, the freezing point of the fluid may be at or above approximately positive 7 degrees Celsius. In some embodiments, the freezing point of the fluid may be at or above approximately positive 6 degrees Celsius. In some embodiments, the freezing point of the fluid may be at or above approximately positive 5 degrees Celsius. In some embodiments, the freezing point of the fluid may be at or above approximately positive 4 degrees Celsius. In some embodiments, the freezing point of the fluid may be at or above approximately positive 3 degrees Celsius. In some embodiments, the freezing point of the fluid may be at or above approximately positive 2 degrees Celsius. In some embodiments, the freezing point of the fluid may be at or above approximately positive 1 degree Celsius.

In some embodiments, the freezing point of the fluid may be at or above approximately 0 degrees Celsius. In some embodiments, the freezing point of the fluid may be at or above approximately negative 1 degree Celsius. In some embodiments, the freezing point of the fluid may be at or above approximately negative 2 degrees Celsius. In some embodiments, the freezing point of the fluid may be at or above approximately negative 3 degrees Celsius. In some embodiments, the freezing point of the fluid may be at or above approximately negative 4 degrees Celsius. In some embodiments, the freezing point of the fluid may be at or above approximately negative 5 degrees Celsius. In some embodiments, the freezing point of the fluid may be at or above approximately negative 6 degrees Celsius. In some embodiments, the freezing point of the fluid may be at or above approximately negative 7 degrees Celsius. In some embodiments, the freezing point of the fluid may be at or above approximately negative 8 degrees Celsius. In some embodiments, the freezing point of the fluid may be at or above approximately negative 9 degrees Celsius. In some embodiments, the freezing point of the fluid may be at or above approximately negative 10 degrees Celsius.

In some embodiments, the freezing point of the fluid may be at or above approximately negative 11 degrees Celsius. In some embodiments, the freezing point of the fluid may be at or above approximately negative 12 degrees Celsius. In some embodiments, the freezing point of the fluid may be at or above approximately negative 13 degrees Celsius. In some embodiments, the freezing point of the fluid may be at or above approximately negative 14 degrees Celsius. In some embodiments, the freezing point of the fluid may be at or above approximately negative 15 degrees Celsius. In some embodiments, the freezing point of the fluid may be at or above approximately negative 20 degrees Celsius. In some embodiments, the freezing point of the fluid may be at or above approximately negative 25 degrees Celsius. In some embodiments, the freezing point of the fluid may be at or above approximately negative 30 degrees Celsius. In some embodiments, the freezing point of the fluid may be at or above approximately negative 35 degrees Celsius. In some embodiments, the freezing point of the fluid may be at or above approximately negative 40 degrees Celsius. In some embodiments, the freezing point of the fluid may be at or above approximately negative 45 degrees Celsius. In some embodiments, the freezing point of the fluid may be at or above approximately negative 50 degrees Celsius. In some embodiments, the freezing point of the fluid may be at or above approximately negative 55 degrees Celsius. In some embodiments, the freezing point of the fluid may be at or above approximately negative 60 degrees Celsius. In some embodiments, the freezing point of the fluid may be at or above approximately negative 65 degrees Celsius. In some embodiments, the freezing point of the fluid may be at or above approximately negative 70 degrees Celsius. In some embodiments, the freezing point of the fluid may be at or above approximately negative 75 degrees Celsius. In some embodiments, the freezing point of the fluid may be at or above approximately negative 80 degrees Celsius.

In some embodiments, the freezing point of the fluid may be within a range. In some embodiments, the freezing point of the fluid may be within a range from approximately positive 10 degrees Celsius to approximately positive 5 degrees Celsius. In some embodiments, the freezing point of the fluid may be within a range from approximately positive 5 degrees Celsius to approximately 0 degrees Celsius. In some embodiments, the freezing point of the fluid may be within a range from approximately 0 degrees Celsius to approximately negative 5 degrees Celsius. In some embodiments, the freezing point of the fluid may be within a range from approximately negative 5 degrees Celsius to approximately negative 10 degrees Celsius. In some embodiments, the freezing point of the fluid may be within a range from approximately negative 10 degrees Celsius to approximately negative 15 degrees Celsius. In some embodiments, the freezing point of the fluid may be within a range from approximately negative 15 degrees Celsius to approximately negative 20 degrees Celsius. In some embodiments, the freezing point of the fluid may be within a range from approximately negative 20 degrees Celsius to approximately negative 30 degrees Celsius. In some embodiments, the freezing point of the fluid may be within a range from approximately negative 30 degrees Celsius to approximately negative 40 degrees Celsius. In some embodiments, the freezing point of the fluid may be within a range from approximately negative 40 degrees Celsius to approximately negative 50 degrees Celsius. In some embodiments, the freezing point of the fluid may be within a range from approximately negative 50 degrees Celsius to approximately negative 60 degrees Celsius. In some embodiments, the freezing point of the fluid may be within a range from approximately negative 60 degrees Celsius to approximately negative 70 degrees Celsius. In some embodiments, the freezing point of the fluid may be within a range from approximately negative 70 degrees Celsius to approximately negative 80 degrees Celsius.

In some embodiments, the temperature difference between the fluid and the air may affect the heat transfer rate, the buoyancy-induced airflow, and the power generation capacity. Greater temperature differences may result in greater heat transfer rates, greater buoyancy forces, greater airflow velocities, and greater power generation potential. The temperature difference may be calculated as the difference between the temperature of the fluid and the temperature of the air, or as the difference between the freezing point of the fluid and the temperature of the air.

In some embodiments, the temperature difference between the fluid and the air may be at or above approximately 1 degree Celsius. In some embodiments, the temperature difference between the fluid and the air may be at or above approximately 2 degrees Celsius. In some embodiments, the temperature difference between the fluid and the air may be at or above approximately 3 degrees Celsius. In some embodiments, the temperature difference between the fluid and the air may be at or above approximately 4 degrees Celsius. In some embodiments, the temperature difference between the fluid and the air may be at or above approximately 5 degrees Celsius. In some embodiments, the temperature difference between the fluid and the air may be at or above approximately 6 degrees Celsius. In some embodiments, the temperature difference between the fluid and the air may be at or above approximately 7 degrees Celsius. In some embodiments, the temperature difference between the fluid and the air may be at or above approximately 8 degrees Celsius. In some embodiments, the temperature difference between the fluid and the air may be at or above approximately 9 degrees Celsius. In some embodiments, the temperature difference between the fluid and the air may be at or above approximately 10 degrees Celsius.

In some embodiments, the temperature difference between the fluid and the air may be at or above approximately 11 degrees Celsius. In some embodiments, the temperature difference between the fluid and the air may be at or above approximately 12 degrees Celsius. In some embodiments, the temperature difference between the fluid and the air may be at or above approximately 13 degrees Celsius. In some embodiments, the temperature difference between the fluid and the air may be at or above approximately 14 degrees Celsius. In some embodiments, the temperature difference between the fluid and the air may be at or above approximately 15 degrees Celsius. In some embodiments, the temperature difference between the fluid and the air may be at or above approximately 20 degrees Celsius. In some embodiments, the temperature difference between the fluid and the air may be at or above approximately 25 degrees Celsius. In some embodiments, the temperature difference between the fluid and the air may be at or above approximately 30 degrees Celsius. In some embodiments, the temperature difference between the fluid and the air may be at or above approximately 35 degrees Celsius. In some embodiments, the temperature difference between the fluid and the air may be at or above approximately 40 degrees Celsius. In some embodiments, the temperature difference between the fluid and the air may be at or above approximately 45 degrees Celsius. In some embodiments, the temperature difference between the fluid and the air may be at or above approximately 50 degrees Celsius. In some embodiments, the temperature difference between the fluid and the air may be at or above approximately 55 degrees Celsius. In some embodiments, the temperature difference between the fluid and the air may be at or above approximately 60 degrees Celsius. In some embodiments, the temperature difference between the fluid and the air may be at or above approximately 65 degrees Celsius. In some embodiments, the temperature difference between the fluid and the air may be at or above approximately 70 degrees Celsius. In some embodiments, the temperature difference between the fluid and the air may be at or above approximately 75 degrees Celsius. In some embodiments, the temperature difference between the fluid and the air may be at or above approximately 80 degrees Celsius. In some embodiments, the temperature difference between the fluid and the air may be at or above approximately 85 degrees Celsius. In some embodiments, the temperature difference between the fluid and the air may be at or above approximately 90 degrees Celsius. In some embodiments, the temperature difference between the fluid and the air may be at or above approximately 95 degrees Celsius. In some embodiments, the temperature difference between the fluid and the air may be at or above approximately 100 degrees Celsius. In some embodiments, the temperature difference between the fluid and the air may be at or above approximately 110 degrees Celsius. In some embodiments, the temperature difference between the fluid and the air may be at or above approximately 120 degrees Celsius. In some embodiments, the temperature difference between the fluid and the air may be at or above approximately 130 degrees Celsius.

In some embodiments, the temperature difference between the fluid and the air may be within a range. In some embodiments, the temperature difference between the fluid and the air may be within a range from approximately 1 degree Celsius to approximately 5 degrees Celsius. In some embodiments, the temperature difference between the fluid and the air may be within a range from approximately 5 degrees Celsius to approximately 10 degrees Celsius. In some embodiments, the temperature difference between the fluid and the air may be within a range from approximately 10 degrees Celsius to approximately 15 degrees Celsius. In some embodiments, the temperature difference between the fluid and the air may be within a range from approximately 15 degrees Celsius to approximately 20 degrees Celsius. In some embodiments, the temperature difference between the fluid and the air may be within a range from approximately 20 degrees Celsius to approximately 25 degrees Celsius. In some embodiments, the temperature difference between the fluid and the air may be within a range from approximately 25 degrees Celsius to approximately 30 degrees Celsius. In some embodiments, the temperature difference between the fluid and the air may be within a range from approximately 30 degrees Celsius to approximately 40 degrees Celsius. In some embodiments, the temperature difference between the fluid and the air may be within a range from approximately 40 degrees Celsius to approximately 50 degrees Celsius. In some embodiments, the temperature difference between the fluid and the air may be within a range from approximately 50 degrees Celsius to approximately 60 degrees Celsius. In some embodiments, the temperature difference between the fluid and the air may be within a range from approximately 60 degrees Celsius to approximately 70 degrees Celsius. In some embodiments, the temperature difference between the fluid and the air may be within a range from approximately 70 degrees Celsius to approximately 80 degrees Celsius. In some embodiments, the temperature difference between the fluid and the air may be within a range from approximately 80 degrees Celsius to approximately 90 degrees Celsius. In some embodiments, the temperature difference between the fluid and the air may be within a range from approximately 90 degrees Celsius to approximately 100 degrees Celsius. In some embodiments, the temperature difference between the fluid and the air may be within a range from approximately 100 degrees Celsius to approximately 130 degrees Celsius.

In some embodiments, the temperature difference between the freezing point of the fluid and the air temperature may affect the rate of ice formation and the latent heat release. When the air temperature may be below the freezing point of the fluid, at least a portion of the fluid may freeze, and latent heat may be released. Greater temperature differences between the freezing point and the air temperature may result in faster ice formation rates and greater latent heat release rates.

In some embodiments, the temperature difference between the freezing point of the fluid and the air temperature may be at or above approximately 1 degree Celsius. In some embodiments, the temperature difference between the freezing point of the fluid and the air temperature may be at or above approximately 2 degrees Celsius. In some embodiments, the temperature difference between the freezing point of the fluid and the air temperature may be at or above approximately 3 degrees Celsius. In some embodiments, the temperature difference between the freezing point of the fluid and the air temperature may be at or above approximately 4 degrees Celsius. In some embodiments, the temperature difference between the freezing point of the fluid and the air temperature may be at or above approximately 5 degrees Celsius. In some embodiments, the temperature difference between the freezing point of the fluid and the air temperature may be at or above approximately 6 degrees Celsius. In some embodiments, the temperature difference between the freezing point of the fluid and the air temperature may be at or above approximately 7 degrees Celsius. In some embodiments, the temperature difference between the freezing point of the fluid and the air temperature may be at or above approximately 8 degrees Celsius. In some embodiments, the temperature difference between the freezing point of the fluid and the air temperature may be at or above approximately 9 degrees Celsius.

In some embodiments, the temperature difference between the freezing point of the fluid and the air temperature may be at or above approximately 10 degrees Celsius. In some embodiments, the temperature difference between the freezing point of the fluid and the air temperature may be at or above approximately 11 degrees Celsius. In some embodiments, the temperature difference between the freezing point of the fluid and the air temperature may be at or above approximately 12 degrees Celsius. In some embodiments, the temperature difference between the freezing point of the fluid and the air temperature may be at or above approximately 13 degrees Celsius. In some embodiments, the temperature difference between the freezing point of the fluid and the air temperature may be at or above approximately 14 degrees Celsius. In some embodiments, the temperature difference between the freezing point of the fluid and the air temperature may be at or above approximately 15 degrees Celsius. In some embodiments, the temperature difference between the freezing point of the fluid and the air temperature may be at or above approximately 20 degrees Celsius. In some embodiments, the temperature difference between the freezing point of the fluid and the air temperature may be at or above approximately 25 degrees Celsius. In some embodiments, the temperature difference between the freezing point of the fluid and the air temperature may be at or above approximately 30 degrees Celsius. In some embodiments, the temperature difference between the freezing point of the fluid and the air temperature may be at or above approximately 35 degrees Celsius. In some embodiments, the temperature difference between the freezing point of the fluid and the air temperature may be at or above approximately 40 degrees Celsius. In some embodiments, the temperature difference between the freezing point of the fluid and the air temperature may be at or above approximately 45 degrees Celsius. In some embodiments, the temperature difference between the freezing point of the fluid and the air temperature may be at or above approximately 50 degrees Celsius. In some embodiments, the temperature difference between the freezing point of the fluid and the air temperature may be at or above approximately 55 degrees Celsius. In some embodiments, the temperature difference between the freezing point of the fluid and the air temperature may be at or above approximately 60 degrees Celsius. In some embodiments, the temperature difference between the freezing point of the fluid and the air temperature may be at or above approximately 65 degrees Celsius. In some embodiments, the temperature difference between the freezing point of the fluid and the air temperature may be at or above approximately 70 degrees Celsius. In some embodiments, the temperature difference between the freezing point of the fluid and the air temperature may be at or above approximately 75 degrees Celsius. In some embodiments, the temperature difference between the freezing point of the fluid and the air temperature may be at or above approximately 80 degrees Celsius.

In some embodiments, the temperature difference between the freezing point of the fluid and the air temperature may be within a range. In some embodiments, the temperature difference between the freezing point of the fluid and the air temperature may be within a range from approximately 1 degree Celsius to approximately 5 degrees Celsius. In some embodiments, the temperature difference between the freezing point of the fluid and the air temperature may be within a range from approximately 5 degrees Celsius to approximately 10 degrees Celsius. In some embodiments, the temperature difference between the freezing point of the fluid and the air temperature may be within a range from approximately 10 degrees Celsius to approximately 15 degrees Celsius. In some embodiments, the temperature difference between the freezing point of the fluid and the air temperature may be within a range from approximately 15 degrees Celsius to approximately 20 degrees Celsius. In some embodiments, the temperature difference between the freezing point of the fluid and the air temperature may be within a range from approximately 20 degrees Celsius to approximately 30 degrees Celsius. In some embodiments, the temperature difference between the freezing point of the fluid and the air temperature may be within a range from approximately 30 degrees Celsius to approximately 40 degrees Celsius. In some embodiments, the temperature difference between the freezing point of the fluid and the air temperature may be within a range from approximately 40 degrees Celsius to approximately 50 degrees Celsius. In some embodiments, the temperature difference between the freezing point of the fluid and the air temperature may be within a range from approximately 50 degrees Celsius to approximately 60 degrees Celsius. In some embodiments, the temperature difference between the freezing point of the fluid and the air temperature may be within a range from approximately 60 degrees Celsius to approximately 70 degrees Celsius. In some embodiments, the temperature difference between the freezing point of the fluid and the air temperature may be within a range from approximately 70 degrees Celsius to approximately 80 degrees Celsius.

In some embodiments, the temperature of the warmed air after heat transfer from the fluid may be higher than the temperature of the inlet air. In some embodiments, the temperature increase of the air may be at or above approximately 1 degree Celsius. In some embodiments, the temperature increase of the air may be at or above approximately 2 degrees Celsius. In some embodiments, the temperature increase of the air may be at or above approximately 5 degrees Celsius. In some embodiments, the temperature increase of the air may be at or above approximately 10 degrees Celsius. In some embodiments, the temperature increase of the air may be at or above approximately 15 degrees Celsius. In some embodiments, the temperature increase of the air may be at or above approximately 20 degrees Celsius. In some embodiments, the temperature increase of the air may be at or above approximately 25 degrees Celsius. In some embodiments, the temperature increase of the air may be at or above approximately 30 degrees Celsius. In some embodiments, the temperature increase of the air may be at or above approximately 40 degrees Celsius. In some embodiments, the temperature increase of the air may be at or above approximately 50 degrees Celsius.

In some embodiments, the outlet air temperature may be within a range. In some embodiments, the outlet air temperature may be within a range from approximately negative 50 degrees Celsius to approximately negative 40 degrees Celsius. In some embodiments, the outlet air temperature may be within a range from approximately negative 40 degrees Celsius to approximately negative 30 degrees Celsius. In some embodiments, the outlet air temperature may be within a range from approximately negative 30 degrees Celsius to approximately negative 20 degrees Celsius. In some embodiments, the outlet air temperature may be within a range from approximately negative 20 degrees Celsius to approximately negative 10 degrees Celsius. In some embodiments, the outlet air temperature may be within a range from approximately negative 10 degrees Celsius to approximately 0 degrees Celsius. In some embodiments, the outlet air temperature may be within a range from approximately 0 degrees Celsius to approximately positive 10 degrees Celsius. In some embodiments, the outlet air temperature may be within a range from approximately positive 10 degrees Celsius to approximately positive 20 degrees Celsius. In some embodiments, the outlet air temperature may be within a range from approximately positive 20 degrees Celsius to approximately positive 30 degrees Celsius.

In some embodiments, thermal power generation systems may be configured with various dimensional parameters. The dimensional parameters may affect the heat transfer rate, the buoyancy-induced airflow, the power generation capacity, the ice production rate, the structural requirements, the construction costs, and other system performance and economic parameters. The selection of dimensional parameters may depend on the geographic location, the available space, the available water sources, the intended power generation capacity, the structural constraints, the economic considerations, or any combination thereof.

In some embodiments, the tower height may be at or above approximately 10 meters. In some embodiments, the tower height may be at or above approximately 15 meters. In some embodiments, the tower height may be at or above approximately 20 meters. In some embodiments, the tower height may be at or above approximately 25 meters. In some embodiments, the tower height may be at or above approximately 30 meters. In some embodiments, the tower height may be at or above approximately 35 meters. In some embodiments, the tower height may be at or above approximately 40 meters. In some embodiments, the tower height may be at or above approximately 45 meters. In some embodiments, the tower height may be at or above approximately 50 meters. In some embodiments, the tower height may be at or above approximately 55 meters. In some embodiments, the tower height may be at or above approximately 60 meters. In some embodiments, the tower height may be at or above approximately 65 meters. In some embodiments, the tower height may be at or above approximately 70 meters. In some embodiments, the tower height may be at or above approximately 75 meters. In some embodiments, the tower height may be at or above approximately 80 meters. In some embodiments, the tower height may be at or above approximately 85 meters. In some embodiments, the tower height may be at or above approximately 90 meters. In some embodiments, the tower height may be at or above approximately 95 meters. In some embodiments, the tower height may be at or above approximately 100 meters.

In some embodiments, the tower height may be at or above approximately 110 meters. In some embodiments, the tower height may be at or above approximately 120 meters. In some embodiments, the tower height may be at or above approximately 130 meters. In some embodiments, the tower height may be at or above approximately 140 meters. In some embodiments, the tower height may be at or above approximately 150 meters. In some embodiments, the tower height may be at or above approximately 160 meters. In some embodiments, the tower height may be at or above approximately 170 meters. In some embodiments, the tower height may be at or above approximately 180 meters. In some embodiments, the tower height may be at or above approximately 190 meters. In some embodiments, the tower height may be at or above approximately 200 meters. In some embodiments, the tower height may be at or above approximately 225 meters. In some embodiments, the tower height may be at or above approximately 250 meters. In some embodiments, the tower height may be at or above approximately 275 meters. In some embodiments, the tower height may be at or above approximately 300 meters. In some embodiments, the tower height may be at or above approximately 325 meters. In some embodiments, the tower height may be at or above approximately 350 meters. In some embodiments, the tower height may be at or above approximately 375 meters. In some embodiments, the tower height may be at or above approximately 400 meters. In some embodiments, the tower height may be at or above approximately 425 meters. In some embodiments, the tower height may be at or above approximately 450 meters. In some embodiments, the tower height may be at or above approximately 475 meters. In some embodiments, the tower height may be at or above approximately 500 meters.

In some embodiments, the tower height may be within a range. In some embodiments, the tower height may be within a range from approximately 10 meters to approximately 25 meters. In some embodiments, the tower height may be within a range from approximately 25 meters to approximately 50 meters. In some embodiments, the tower height may be within a range from approximately 50 meters to approximately 75 meters. In some embodiments, the tower height may be within a range from approximately 75 meters to approximately 100 meters. In some embodiments, the tower height may be within a range from approximately 100 meters to approximately 150 meters. In some embodiments, the tower height may be within a range from approximately 150 meters to approximately 200 meters. In some embodiments, the tower height may be within a range from approximately 200 meters to approximately 250 meters. In some embodiments, the tower height may be within a range from approximately 250 meters to approximately 300 meters. In some embodiments, the tower height may be within a range from approximately 300 meters to approximately 350 meters. In some embodiments, the tower height may be within a range from approximately 350 meters to approximately 400 meters. In some embodiments, the tower height may be within a range from approximately 400 meters to approximately 450 meters. In some embodiments, the tower height may be within a range from approximately 450 meters to approximately 500 meters.

In some embodiments, the tower diameter may be at or above approximately 1 meter. In some embodiments, the tower diameter may be at or above approximately 2 meters. In some embodiments, the tower diameter may be at or above approximately 3 meters. In some embodiments, the tower diameter may be at or above approximately 4 meters. In some embodiments, the tower diameter may be at or above approximately 5 meters. In some embodiments, the tower diameter may be at or above approximately 6 meters. In some embodiments, the tower diameter may be at or above approximately 7 meters. In some embodiments, the tower diameter may be at or above approximately 8 meters. In some embodiments, the tower diameter may be at or above approximately 9 meters. In some embodiments, the tower diameter may be at or above approximately 10 meters. In some embodiments, the tower diameter may be at or above approximately 12 meters. In some embodiments, the tower diameter may be at or above approximately 14 meters. In some embodiments, the tower diameter may be at or above approximately 16 meters. In some embodiments, the tower diameter may be at or above approximately 18 meters. In some embodiments, the tower diameter may be at or above approximately 20 meters. In some embodiments, the tower diameter may be at or above approximately 25 meters. In some embodiments, the tower diameter may be at or above approximately 30 meters. In some embodiments, the tower diameter may be at or above approximately 35 meters. In some embodiments, the tower diameter may be at or above approximately 40 meters. In some embodiments, the tower diameter may be at or above approximately 45 meters. In some embodiments, the tower diameter may be at or above approximately 50 meters.

In some embodiments, the tower diameter may be at or above approximately 55 meters. In some embodiments, the tower diameter may be at or above approximately 60 meters. In some embodiments, the tower diameter may be at or above approximately 65 meters. In some embodiments, the tower diameter may be at or above approximately 70 meters. In some embodiments, the tower diameter may be at or above approximately 75 meters. In some embodiments, the tower diameter may be at or above approximately 80 meters. In some embodiments, the tower diameter may be at or above approximately 85 meters. In some embodiments, the tower diameter may be at or above approximately 90 meters. In some embodiments, the tower diameter may be at or above approximately 95 meters. In some embodiments, the tower diameter may be at or above approximately 100 meters. In some embodiments, the tower diameter may be at or above approximately 110 meters. In some embodiments, the tower diameter may be at or above approximately 120 meters. In some embodiments, the tower diameter may be at or above approximately 130 meters. In some embodiments, the tower diameter may be at or above approximately 140 meters. In some embodiments, the tower diameter may be at or above approximately 150 meters. In some embodiments, the tower diameter may be at or above approximately 160 meters. In some embodiments, the tower diameter may be at or above approximately 170 meters. In some embodiments, the tower diameter may be at or above approximately 180 meters. In some embodiments, the tower diameter may be at or above approximately 190 meters. In some embodiments, the tower diameter may be at or above approximately 200 meters.

In some embodiments, the tower diameter may be within a range. In some embodiments, the tower diameter may be within a range from approximately 1 meter to approximately 5 meters. In some embodiments, the tower diameter may be within a range from approximately 5 meters to approximately 10 meters. In some embodiments, the tower diameter may be within a range from approximately 10 meters to approximately 20 meters. In some embodiments, the tower diameter may be within a range from approximately 20 meters to approximately 30 meters. In some embodiments, the tower diameter may be within a range from approximately 30 meters to approximately 40 meters. In some embodiments, the tower diameter may be within a range from approximately 40 meters to approximately 50 meters. In some embodiments, the tower diameter may be within a range from approximately 50 meters to approximately 75 meters. In some embodiments, the tower diameter may be within a range from approximately 75 meters to approximately 100 meters. In some embodiments, the tower diameter may be within a range from approximately 100 meters to approximately 125 meters. In some embodiments, the tower diameter may be within a range from approximately 125 meters to approximately 150 meters. In some embodiments, the tower diameter may be within a range from approximately 150 meters to approximately 175 meters. In some embodiments, the tower diameter may be within a range from approximately 175 meters to approximately 200 meters.

In some embodiments, the pipe diameter may be at or above approximately 0.1 meters. In some embodiments, the pipe diameter may be at or above approximately 0.2 meters. In some embodiments, the pipe diameter may be at or above approximately 0.3 meters. In some embodiments, the pipe diameter may be at or above approximately 0.4 meters. In some embodiments, the pipe diameter may be at or above approximately 0.5 meters. In some embodiments, the pipe diameter may be at or above approximately 0.6 meters. In some embodiments, the pipe diameter may be at or above approximately 0.7 meters. In some embodiments, the pipe diameter may be at or above approximately 0.8 meters. In some embodiments, the pipe diameter may be at or above approximately 0.9 meters. In some embodiments, the pipe diameter may be at or above approximately 1 meter. In some embodiments, the pipe diameter may be at or above approximately 1.5 meters. In some embodiments, the pipe diameter may be at or above approximately 2 meters. In some embodiments, the pipe diameter may be at or above approximately 2.5 meters. In some embodiments, the pipe diameter may be at or above approximately 3 meters. In some embodiments, the pipe diameter may be at or above approximately 3.5 meters. In some embodiments, the pipe diameter may be at or above approximately 4 meters. In some embodiments, the pipe diameter may be at or above approximately 4.5 meters. In some embodiments, the pipe diameter may be at or above approximately 5 meters. In some embodiments, the pipe diameter may be at or above approximately 6 meters. In some embodiments, the pipe diameter may be at or above approximately 7 meters. In some embodiments, the pipe diameter may be at or above approximately 8 meters. In some embodiments, the pipe diameter may be at or above approximately 9 meters. In some embodiments, the pipe diameter may be at or above approximately 10 meters.

In some embodiments, the pipe diameter may be at or above approximately 12 meters. In some embodiments, the pipe diameter may be at or above approximately 14 meters. In some embodiments, the pipe diameter may be at or above approximately 16 meters. In some embodiments, the pipe diameter may be at or above approximately 18 meters. In some embodiments, the pipe diameter may be at or above approximately 20 meters. In some embodiments, the pipe diameter may be at or above approximately 25 meters. In some embodiments, the pipe diameter may be at or above approximately 30 meters. In some embodiments, the pipe diameter may be at or above approximately 35 meters. In some embodiments, the pipe diameter may be at or above approximately 40 meters. In some embodiments, the pipe diameter may be at or above approximately 45 meters. In some embodiments, the pipe diameter may be at or above approximately 50 meters.

In some embodiments, the pipe diameter may be within a range. In some embodiments, the pipe diameter may be within a range from approximately 0.1 meters to approximately 0.5 meters. In some embodiments, the pipe diameter may be within a range from approximately 0.5 meters to approximately 1 meter. In some embodiments, the pipe diameter may be within a range from approximately 1 meter to approximately 2 meters. In some embodiments, the pipe diameter may be within a range from approximately 2 meters to approximately 3 meters. In some embodiments, the pipe diameter may be within a range from approximately 3 meters to approximately 5 meters. In some embodiments, the pipe diameter may be within a range from approximately 5 meters to approximately 10 meters. In some embodiments, the pipe diameter may be within a range from approximately 10 meters to approximately 15 meters. In some embodiments, the pipe diameter may be within a range from approximately 15 meters to approximately 20 meters. In some embodiments, the pipe diameter may be within a range from approximately 20 meters to approximately 30 meters. In some embodiments, the pipe diameter may be within a range from approximately 30 meters to approximately 40 meters. In some embodiments, the pipe diameter may be within a range from approximately 40 meters to approximately 50 meters.

In some embodiments, the pool depth may be at or above approximately 0.001 meters. In some embodiments, the pool depth may be at or above approximately 0.002 meters. In some embodiments, the pool depth may be at or above approximately 0.005 meters. In some embodiments, the pool depth may be at or above approximately 0.01 meters. In some embodiments, the pool depth may be at or above approximately 0.02 meters. In some embodiments, the pool depth may be at or above approximately 0.05 meters. In some embodiments, the pool depth may be at or above approximately 0.1 meters. In some embodiments, the pool depth may be at or above approximately 0.15 meters. In some embodiments, the pool depth may be at or above approximately 0.2 meters. In some embodiments, the pool depth may be at or above approximately 0.25 meters. In some embodiments, the pool depth may be at or above approximately 0.3 meters. In some embodiments, the pool depth may be at or above approximately 0.35 meters. In some embodiments, the pool depth may be at or above approximately 0.4 meters. In some embodiments, the pool depth may be at or above approximately 0.45 meters. In some embodiments, the pool depth may be at or above approximately 0.5 meters. In some embodiments, the pool depth may be at or above approximately 0.6 meters. In some embodiments, the pool depth may be at or above approximately 0.7 meters. In some embodiments, the pool depth may be at or above approximately 0.8 meters. In some embodiments, the pool depth may be at or above approximately 0.9 meters. In some embodiments, the pool depth may be at or above approximately 1 meter.

In some embodiments, the pool depth may be at or above approximately 1.5 meters. In some embodiments, the pool depth may be at or above approximately 2 meters. In some embodiments, the pool depth may be at or above approximately 2.5 meters. In some embodiments, the pool depth may be at or above approximately 3 meters. In some embodiments, the pool depth may be at or above approximately 3.5 meters. In some embodiments, the pool depth may be at or above approximately 4 meters. In some embodiments, the pool depth may be at or above approximately 4.5 meters. In some embodiments, the pool depth may be at or above approximately 5 meters. In some embodiments, the pool depth may be at or above approximately 6 meters. In some embodiments, the pool depth may be at or above approximately 7 meters. In some embodiments, the pool depth may be at or above approximately 8 meters. In some embodiments, the pool depth may be at or above approximately 9 meters. In some embodiments, the pool depth may be at or above approximately 10 meters. In some embodiments, the pool depth may be at or above approximately 12 meters. In some embodiments, the pool depth may be at or above approximately 14 meters. In some embodiments, the pool depth may be at or above approximately 16 meters. In some embodiments, the pool depth may be at or above approximately 18 meters. In some embodiments, the pool depth may be at or above approximately 20 meters. In some embodiments, the pool depth may be at or above approximately 25 meters. In some embodiments, the pool depth may be at or above approximately 30 meters. In some embodiments, the pool depth may be at or above approximately 35 meters. In some embodiments, the pool depth may be at or above approximately 40 meters. In some embodiments, the pool depth may be at or above approximately 45 meters. In some embodiments, the pool depth may be at or above approximately 50 meters. In some embodiments, the pool depth may be at or above approximately 60 meters. In some embodiments, the pool depth may be at or above approximately 70 meters. In some embodiments, the pool depth may be at or above approximately 80 meters. In some embodiments, the pool depth may be at or above approximately 90 meters. In some embodiments, the pool depth may be at or above approximately 100 meters.

In some embodiments, the pool depth may be within a range. In some embodiments, the pool depth may be within a range from approximately 0.001 meters to approximately 0.01 meters. In some embodiments, the pool depth may be within a range from approximately 0.01 meters to approximately 0.1 meters. In some embodiments, the pool depth may be within a range from approximately 0.1 meters to approximately 0.5 meters. In some embodiments, the pool depth may be within a range from approximately 0.5 meters to approximately 1 meter. In some embodiments, the pool depth may be within a range from approximately 1 meter to approximately 2 meters. In some embodiments, the pool depth may be within a range from approximately 2 meters to approximately 5 meters. In some embodiments, the pool depth may be within a range from approximately 5 meters to approximately 10 meters. In some embodiments, the pool depth may be within a range from approximately 10 meters to approximately 20 meters. In some embodiments, the pool depth may be within a range from approximately 20 meters to approximately 30 meters. In some embodiments, the pool depth may be within a range from approximately 30 meters to approximately 50 meters. In some embodiments, the pool depth may be within a range from approximately 50 meters to approximately 75 meters. In some embodiments, the pool depth may be within a range from approximately 75 meters to approximately 100 meters.

In some embodiments, the slope angle of an air conduit built on or within a hillside, mountainside, or cliffside may be at or above approximately 5 degrees relative to horizontal. In some embodiments, the slope angle may be at or above approximately 6 degrees relative to horizontal. In some embodiments, the slope angle may be at or above approximately 7 degrees relative to horizontal. In some embodiments, the slope angle may be at or above approximately 8 degrees relative to horizontal. In some embodiments, the slope angle may be at or above approximately 9 degrees relative to horizontal. In some embodiments, the slope angle may be at or above approximately 10 degrees relative to horizontal. In some embodiments, the slope angle may be at or above approximately 12 degrees relative to horizontal. In some embodiments, the slope angle may be at or above approximately 14 degrees relative to horizontal. In some embodiments, the slope angle may be at or above approximately 16 degrees relative to horizontal. In some embodiments, the slope angle may be at or above approximately 18 degrees relative to horizontal. In some embodiments, the slope angle may be at or above approximately 20 degrees relative to horizontal. In some embodiments, the slope angle may be at or above approximately 22 degrees relative to horizontal. In some embodiments, the slope angle may be at or above approximately 24 degrees relative to horizontal. In some embodiments, the slope angle may be at or above approximately 26 degrees relative to horizontal. In some embodiments, the slope angle may be at or above approximately 28 degrees relative to horizontal. In some embodiments, the slope angle may be at or above approximately 30 degrees relative to horizontal.

In some embodiments, the slope angle may be at or above approximately 32 degrees relative to horizontal. In some embodiments, the slope angle may be at or above approximately 34 degrees relative to horizontal. In some embodiments, the slope angle may be at or above approximately 36 degrees relative to horizontal. In some embodiments, the slope angle may be at or above approximately 38 degrees relative to horizontal. In some embodiments, the slope angle may be at or above approximately 40 degrees relative to horizontal. In some embodiments, the slope angle may be at or above approximately 42 degrees relative to horizontal. In some embodiments, the slope angle may be at or above approximately 44 degrees relative to horizontal. In some embodiments, the slope angle may be at or above approximately 45 degrees relative to horizontal. In some embodiments, the slope angle may be at or above approximately 48 degrees relative to horizontal. In some embodiments, the slope angle may be at or above approximately 50 degrees relative to horizontal. In some embodiments, the slope angle may be at or above approximately 55 degrees relative to horizontal. In some embodiments, the slope angle may be at or above approximately 60 degrees relative to horizontal. In some embodiments, the slope angle may be at or above approximately 65 degrees relative to horizontal. In some embodiments, the slope angle may be at or above approximately 70 degrees relative to horizontal. In some embodiments, the slope angle may be at or above approximately 75 degrees relative to horizontal. In some embodiments, the slope angle may be at or above approximately 80 degrees relative to horizontal. In some embodiments, the slope angle may be at or above approximately 85 degrees relative to horizontal. In some embodiments, the slope angle may be at or above approximately 90 degrees relative to horizontal.

In some embodiments, the slope angle may be within a range. In some embodiments, the slope angle may be within a range from approximately 5 degrees to approximately 10 degrees relative to horizontal. In some embodiments, the slope angle may be within a range from approximately 10 degrees to approximately 15 degrees relative to horizontal. In some embodiments, the slope angle may be within a range from approximately 15 degrees to approximately 20 degrees relative to horizontal. In some embodiments, the slope angle may be within a range from approximately 20 degrees to approximately 25 degrees relative to horizontal. In some embodiments, the slope angle may be within a range from approximately 25 degrees to approximately 30 degrees relative to horizontal. In some embodiments, the slope angle may be within a range from approximately 30 degrees to approximately 35 degrees relative to horizontal. In some embodiments, the slope angle may be within a range from approximately 35 degrees to approximately 40 degrees relative to horizontal. In some embodiments, the slope angle may be within a range from approximately 40 degrees to approximately 45 degrees relative to horizontal. In some embodiments, the slope angle may be within a range from approximately 45 degrees to approximately 50 degrees relative to horizontal. In some embodiments, the slope angle may be within a range from approximately 50 degrees to approximately 60 degrees relative to horizontal. In some embodiments, the slope angle may be within a range from approximately 60 degrees to approximately 70 degrees relative to horizontal. In some embodiments, the slope angle may be within a range from approximately 70 degrees to approximately 80 degrees relative to horizontal. In some embodiments, the slope angle may be within a range from approximately 80 degrees to approximately 90 degrees relative to horizontal.

In some embodiments, the water droplet size produced by water sprayers may be at or above approximately 0.01 microns. In some embodiments, the water droplet size may be at or above approximately 0.05 microns. In some embodiments, the water droplet size may be at or above approximately 0.1 microns. In some embodiments, the water droplet size may be at or above approximately 0.5 microns. In some embodiments, the water droplet size may be at or above approximately 1 micron. In some embodiments, the water droplet size may be at or above approximately 2 microns. In some embodiments, the water droplet size may be at or above approximately 5 microns. In some embodiments, the water droplet size may be at or above approximately 10 microns. In some embodiments, the water droplet size may be at or above approximately 20 microns. In some embodiments, the water droplet size may be at or above approximately 50 microns. In some embodiments, the water droplet size may be at or above approximately 100 microns. In some embodiments, the water droplet size may be at or above approximately 200 microns. In some embodiments, the water droplet size may be at or above approximately 500 microns. In some embodiments, the water droplet size may be at or above approximately 1,000 microns. In some embodiments, the water droplet size may be at or above approximately 2,000 microns. In some embodiments, the water droplet size may be at or above approximately 5,000 microns. In some embodiments, the water droplet size may be at or above approximately 10,000 microns.

In some embodiments, the water droplet size may be at or above approximately 20,000 microns. In some embodiments, the water droplet size may be at or above approximately 50,000 microns. In some embodiments, the water droplet size may be at or above approximately 100,000 microns. In some embodiments, the water droplet size may be at or above approximately 200,000 microns. In some embodiments, the water droplet size may be at or above approximately 500,000 microns. In some embodiments, the water droplet size may be at or above approximately 1,000,000 microns. In some embodiments, the water droplet size may be at or above approximately 2,000,000 microns. In some embodiments, the water droplet size may be at or above approximately 5,000,000 microns. In some embodiments, the water droplet size may be at or above approximately 10,000,000 microns. In some embodiments, the water droplet size may be at or above approximately 20,000,000 microns. In some embodiments, the water droplet size may be at or above approximately 50,000,000 microns. In some embodiments, the water droplet size may be at or above approximately 100,000,000 microns.

In some embodiments, the water droplet size may be at or below approximately 100,000,000 microns. In some embodiments, the water droplet size may be at or below approximately 50,000,000 microns. In some embodiments, the water droplet size may be at or below approximately 20,000,000 microns. In some embodiments, the water droplet size may be at or below approximately 10,000,000 microns. In some embodiments, the water droplet size may be at or below approximately 5,000,000 microns.

In some embodiments, the water droplet size may be at or below approximately 2,000,000 microns. In some embodiments, the water droplet size may be at or below approximately 1,000,000 microns. In some embodiments, the water droplet size may be at or below approximately 500,000 microns. In some embodiments, the water droplet size may be at or below approximately 200,000 microns. In some embodiments, the water droplet size may be at or below approximately 100,000 microns. In some embodiments, the water droplet size may be at or below approximately 50,000 microns. In some embodiments, the water droplet size may be at or below approximately 20,000 microns. In some embodiments, the water droplet size may be at or below approximately 10,000 microns. In some embodiments, the water droplet size may be at or below approximately 5,000 microns. In some embodiments, the water droplet size may be at or below approximately 2,000 microns. In some embodiments, the water droplet size may be at or below approximately 1,000 microns. In some embodiments, the water droplet size may be at or below approximately 500 microns. In some embodiments, the water droplet size may be at or below approximately 200 microns. In some embodiments, the water droplet size may be at or below approximately 100 microns. In some embodiments, the water droplet size may be at or below approximately 50 microns. In some embodiments, the water droplet size may be at or below approximately 20 microns. In some embodiments, the water droplet size may be at or below approximately 10 microns. In some embodiments, the water droplet size may be at or below approximately 5 microns. In some embodiments, the water droplet size may be at or below approximately 1 micron. In some embodiments, the water droplet size may be at or below approximately 0.5 microns. In some embodiments, the water droplet size may be at or below approximately 0.1 microns. In some embodiments, the water droplet size may be at or below approximately 0.05 microns. In some embodiments, the water droplet size may be at or below approximately 0.01 microns.

In some embodiments, the water droplet size may be within a range. In some embodiments, the water droplet size may be within a range from approximately 0.01 microns to approximately 0.1 microns. In some embodiments, the water droplet size may be within a range from approximately 0.1 microns to approximately 1 micron. In some embodiments, the water droplet size may be within a range from approximately 1 micron to approximately 10 microns. In some embodiments, the water droplet size may be within a range from approximately 10 microns to approximately 100 microns. In some embodiments, the water droplet size may be within a range from approximately 100 microns to approximately 500 microns. In some embodiments, the water droplet size may be within a range from approximately 500 microns to approximately 1,000 microns. In some embodiments, the water droplet size may be within a range from approximately 1,000 microns to approximately 5,000 microns. In some embodiments, the water droplet size may be within a range from approximately 5,000 microns to approximately 10,000 microns. In some embodiments, the water droplet size may be within a range from approximately 10,000 microns to approximately 50,000 microns. In some embodiments, the water droplet size may be within a range from approximately 50,000 microns to approximately 100,000 microns. In some embodiments, the water droplet size may be within a range from approximately 100,000 microns to approximately 500,000 microns. In some embodiments, the water droplet size may be within a range from approximately 500,000 microns to approximately 1,000,000 microns. In some embodiments, the water droplet size may be within a range from approximately 1,000,000 microns to approximately 10,000,000 microns. In some embodiments, the water droplet size may be within a range from approximately 10,000,000 microns to approximately 100,000,000 microns.

In some embodiments, the water flow rate through the thermal exchange zone may be at or above approximately 0.1 liters per second. In some embodiments, the water flow rate may be at or above approximately 0.5 liters per second. In some embodiments, the water flow rate may be at or above approximately 1 liter per second. In some embodiments, the water flow rate may be at or above approximately 5 liters per second. In some embodiments, the water flow rate may be at or above approximately 10 liters per second. In some embodiments, the water flow rate may be at or above approximately 50 liters per second. In some embodiments, the water flow rate may be at or above approximately 100 liters per second. In some embodiments, the water flow rate may be at or above approximately 500 liters per second. In some embodiments, the water flow rate may be at or above approximately 1,000 liters per second. In some embodiments, the water flow rate may be at or above approximately 5,000 liters per second. In some embodiments, the water flow rate may be at or above approximately 10,000 liters per second.

In some embodiments, the airflow velocity through the air conduit may be at or above approximately 0.1 meters per second. In some embodiments, the airflow velocity may be at or above approximately 0.5 meters per second. In some embodiments, the airflow velocity may be at or above approximately 1 meter per second. In some embodiments, the airflow velocity may be at or above approximately 2 meters per second. In some embodiments, the airflow velocity may be at or above approximately 5 meters per second. In some embodiments, the airflow velocity may be at or above approximately 10 meters per second. In some embodiments, the airflow velocity may be at or above approximately 15 meters per second. In some embodiments, the airflow velocity may be at or above approximately 20 meters per second. In some embodiments, the airflow velocity may be at or above approximately 25 meters per second. In some embodiments, the airflow velocity may be at or above approximately 30 meters per second. In some embodiments, the airflow velocity may be at or above approximately 40 meters per second. In some embodiments, the airflow velocity may be at or above approximately 50 meters per second.

In some embodiments, the airflow velocity may be within a range. In some embodiments, the airflow velocity may be within a range from approximately 0.1 meters per second to approximately 1 meter per second. In some embodiments, the airflow velocity may be within a range from approximately 1 meter per second to approximately 5 meters per second. In some embodiments, the airflow velocity may be within a range from approximately 5 meters per second to approximately 10 meters per second. In some embodiments, the airflow velocity may be within a range from approximately 10 meters per second to approximately 20 meters per second. In some embodiments, the airflow velocity may be within a range from approximately 20 meters per second to approximately 30 meters per second. In some embodiments, the airflow velocity may be within a range from approximately 30 meters per second to approximately 50 meters per second.

In some embodiments, the percentage of water that freezes during heat transfer may be at or above approximately 0.01 percent. In some embodiments, the percentage of water that freezes may be at or above approximately 0.1 percent. In some embodiments, the percentage of water that freezes may be at or above approximately 0.5 percent. In some embodiments, the percentage of water that freezes may be at or above approximately 1 percent. In some embodiments, the percentage of water that freezes may be at or above approximately 5 percent. In some embodiments, the percentage of water that freezes may be at or above approximately 10 percent. In some embodiments, the percentage of water that freezes may be at or above approximately 15 percent. In some embodiments, the percentage of water that freezes may be at or above approximately 20 percent. In some embodiments, the percentage of water that freezes may be at or above approximately 25 percent. In some embodiments, the percentage of water that freezes may be at or above approximately 30 percent. In some embodiments, the percentage of water that freezes may be at or above approximately 40 percent. In some embodiments, the percentage of water that freezes may be at or above approximately 50 percent. In some embodiments, the percentage of water that freezes may be at or above approximately 60 percent. In some embodiments, the percentage of water that freezes may be at or above approximately 70 percent. In some embodiments, the percentage of water that freezes may be at or above approximately 80 percent. In some embodiments, the percentage of water that freezes may be at or above approximately 90 percent. In some embodiments, the percentage of water that freezes may be at or above approximately 95 percent. In some embodiments, the percentage of water that freezes may be at or above approximately 99 percent.

In some embodiments, thermal power generation systems may employ various types of turbines for converting kinetic energy from airflow into electrical or mechanical power. Turbine types that may be employed may include one or more or any combination of the following: Wells turbines, or impulse turbines, or radial turbines, or cross-flow turbines, or axial-flow turbines, or Savonius turbines, or Darrieus turbines, or Gorlov turbines, or Francis turbines, or Kaplan turbines, or Pelton turbines, or propeller turbines, or ducted turbines, or shrouded turbines, or diffuser-augmented turbines, or contra-rotating turbines, or variable-pitch turbines, or fixed-pitch turbines, or horizontal axis turbines, or vertical axis turbines, or mixed-flow turbines, or any combination thereof.

In some embodiments, Wells turbines may be employed in thermal power generation systems. Wells turbines may comprise self-rectifying turbines that may rotate in the same direction regardless of the direction of airflow. Wells turbines may be configured with symmetrical airfoil blades that may generate torque from airflow in either direction. Wells turbines may be suitable for applications where airflow direction may vary or where bidirectional airflow may occur.

In some embodiments, impulse turbines may be employed in thermal power generation systems. Impulse turbines may operate by extracting kinetic energy from high-velocity air jets that may impinge on turbine blades. Impulse turbines may be configured with bucket-shaped or cup-shaped blades that may redirect the airflow and may extract momentum from the air. Impulse turbines may be suitable for applications with high-velocity airflow and may provide high efficiency at design conditions.

In some embodiments, radial turbines may be employed in thermal power generation systems. Radial turbines may be configured with airflow entering or exiting in a radial direction relative to the axis of rotation. Radial inflow turbines may receive airflow from the periphery and may discharge airflow near the axis. Radial outflow turbines may receive airflow near the axis and may discharge airflow at the periphery. Radial turbines may be compact and may be suitable for applications with space constraints.

In some embodiments, cross-flow turbines may be employed in thermal power generation systems. Cross-flow turbines may be configured with airflow passing through the turbine rotor in a direction perpendicular to the axis of rotation. Cross-flow turbines may comprise drum-shaped rotors with blades arranged around the circumference. Cross-flow turbines may accept airflow from a wide range of directions and may be suitable for applications where airflow direction may vary.

In some embodiments, axial-flow turbines may be employed in thermal power generation systems. Axial-flow turbines may be configured with airflow passing through the turbine in a direction parallel to the axis of rotation. Axial-flow turbines may comprise rotors with blades extending radially from a central hub, and the blades may be configured to extract energy from the axial airflow. Axial-flow turbines may be suitable for applications with high volumetric airflow rates and may provide high efficiency at design conditions.

In some embodiments, Savonius turbines may be employed in thermal power generation systems. Savonius turbines may comprise vertical axis turbines with S-shaped or scoop-shaped blades that may rotate due to differential drag forces on the blades. Savonius turbines may be self-starting and may operate at low airflow velocities. Savonius turbines may be simple in construction and may be suitable for applications where simplicity and reliability may be prioritized.

In some embodiments, Darrieus turbines may be employed in thermal power generation systems. Darrieus turbines may comprise vertical axis turbines with curved or straight blades that may rotate due to lift forces generated by the airflow over the blades. Darrieus turbines may operate at higher rotational speeds than Savonius turbines and may provide higher efficiency at design conditions. Darrieus turbines may require external starting mechanisms in some configurations.

In some embodiments, Gorlov turbines may be employed in thermal power generation systems. Gorlov turbines may comprise vertical axis turbines with helically twisted blades that may provide smoother torque output than straight-bladed vertical axis turbines. Gorlov turbines may be self-starting and may operate efficiently over a range of airflow velocities.

In some embodiments, ducted turbines may be employed in thermal power generation systems. Ducted turbines may be enclosed within a duct or shroud that may accelerate the airflow through the turbine rotor. The duct may be configured to increase the airflow velocity at the turbine rotor, which may increase the power extraction from the airflow. Ducted turbines may provide higher power output than unducted turbines of similar rotor diameter.

In some embodiments, diffuser-augmented turbines may be employed in thermal power generation systems. Diffuser-augmented turbines may be configured with a diffuser downstream of the turbine rotor that may reduce the pressure downstream of the rotor and may increase the airflow velocity through the rotor. The diffuser may expand the airflow cross-sectional area downstream of the rotor, which may reduce the downstream pressure and may enhance the pressure drop across the rotor.

In some embodiments, contra-rotating turbines may be employed in thermal power generation systems. Contra-rotating turbines may comprise two rotors that may rotate in opposite directions on the same axis. Contra-rotating turbines may extract more energy from the airflow than single-rotor turbines and may reduce the swirl in the airflow downstream of the turbine.

In some embodiments, variable-pitch turbines may be employed in thermal power generation systems. Variable-pitch turbines may be configured with blades that may be rotated about their longitudinal axes to change the blade pitch angle. Variable pitch may allow the turbine to operate efficiently over a range of airflow velocities and may allow the turbine to be feathered or shut down in high wind conditions.

In some embodiments, fixed-pitch turbines may be employed in thermal power generation systems. Fixed-pitch turbines may be configured with blades that may have a fixed pitch angle that may not be adjusted during operation. Fixed-pitch turbines may be simpler in construction than variable-pitch turbines and may be suitable for applications where the airflow velocity may be relatively constant.

In some embodiments, horizontal axis turbines may be employed in thermal power generation systems. Horizontal axis turbines may be configured with the axis of rotation oriented horizontally or substantially horizontally. Horizontal axis turbines may be positioned within an air conduit with the axis of rotation aligned with the direction of airflow. Horizontal axis turbines may be suitable for applications where the airflow direction may be consistent and may be aligned with the turbine axis.

In some embodiments, vertical axis turbines may be employed in thermal power generation systems. Vertical axis turbines may be configured with the axis of rotation oriented vertically or substantially vertically. Vertical axis turbines may accept airflow from any horizontal direction and may be suitable for applications where the airflow direction may vary. Vertical axis turbines may be positioned at the base of an air conduit, at the top of an air conduit, or at other locations within a thermal power generation system.

In some embodiments, mixed-flow turbines may be employed in thermal power generation systems. Mixed-flow turbines may be configured with airflow entering in one direction and exiting in a different direction that may be neither purely axial nor purely radial. Mixed-flow turbines may combine characteristics of axial-flow and radial-flow turbines and may be suitable for applications with specific flow path requirements.

In some embodiments, turbines may be configured with various blade materials. Blade materials may include one or more or any combination of the following: metals, or steel, or stainless steel, or aluminum, or titanium, or alloys, or composites, or carbon fiber composites, or glass fiber composites, or fiberglass, or plastics, or polymers, or wood, or laminated wood, or any combination thereof. The selection of blade materials may depend on the operating conditions, the blade size, the rotational speed, the structural requirements, the cost considerations, or any combination thereof.

In some embodiments, turbines may be configured with various numbers of blades. The number of blades may range from one blade to twenty or more blades. In some embodiments, the turbine may have two blades. In some embodiments, the turbine may have three blades. In some embodiments, the turbine may have four blades. In some embodiments, the turbine may have five blades. In some embodiments, the turbine may have six blades. In some embodiments, the turbine may have eight blades. In some embodiments, the turbine may have ten blades. In some embodiments, the turbine may have twelve blades. The selection of the number of blades may depend on the desired rotational speed, the torque characteristics, the starting characteristics, the noise characteristics, or any combination thereof.

In some embodiments, turbines may be coupled to generators for converting mechanical power to electrical power. Generator types that may be employed may include one or more or any combination of the following: synchronous generators, or asynchronous generators, or induction generators, or permanent magnet generators, or wound rotor generators, or doubly-fed induction generators, or direct-drive generators, or geared generators, or variable-speed generators, or constant-speed generators, or any combination thereof.

In some embodiments, thermal power generation systems may employ various building materials for construction of air conduits, towers, structures, and other components. Building materials that may be employed may include one or more or any combination of the following: metals, or plastics, or concrete, or composites, or ice, or ice composites, or any combination thereof.

In some embodiments, metals may be employed as building materials for thermal power generation systems. Metals that may be employed may include one or more or any combination of the following: steel, or carbon steel, or stainless steel, or galvanized steel, or weathering steel, or aluminum, or aluminum alloys, or copper, or copper alloys, or titanium, or titanium alloys, or nickel alloys, or zinc, or zinc alloys, or iron, or cast iron, or wrought iron, or any combination thereof. Metals may provide high strength, high stiffness, durability, and resistance to environmental conditions. Metals may be formed into structural shapes including plates, sheets, tubes, pipes, beams, channels, angles, or other shapes through rolling, extrusion, casting, forging, or other forming processes.

In some embodiments, steel may be employed as a building material for thermal power generation systems. Steel may comprise iron alloyed with carbon and may include other alloying elements. Carbon steel may contain carbon as the primary alloying element. Stainless steel may contain chromium and may provide corrosion resistance. Galvanized steel may be coated with zinc to provide corrosion protection. Weathering steel may form a protective oxide layer that may provide corrosion resistance without coatings. Steel may be employed for structural members, towers, pipes, tanks, supports, foundations, or other components.

In some embodiments, aluminum may be employed as a building material for thermal power generation systems. Aluminum may provide a high strength-to-weight ratio, corrosion resistance, and ease of fabrication. Aluminum alloys may include alloying elements such as copper, magnesium, manganese, silicon, or zinc to provide enhanced properties. Aluminum may be employed for structural members, cladding, ducting, heat exchangers, or other components where low weight or corrosion resistance may be beneficial.

In some embodiments, plastics may be employed as building materials for thermal power generation systems. Plastics that may be employed may include one or more or any combination of the following: polyethylene, or high-density polyethylene, or low-density polyethylene, or polypropylene, or polyvinyl chloride, or acrylonitrile butadiene styrene, or polycarbonate, or acrylic, or nylon, or polyester, or polyurethane, or polystyrene, or polytetrafluoroethylene, or fiberglass-reinforced plastic, or any combination thereof. Plastics may provide corrosion resistance, low weight, ease of fabrication, and low cost. Plastics may be employed for pipes, ducts, tanks, liners, coatings, or other components.

In some embodiments, polyethylene may be employed as a building material for thermal power generation systems. Polyethylene may be a thermoplastic polymer that may be formed into pipes, tanks, liners, or other shapes. High-density polyethylene may provide higher strength and stiffness than low-density polyethylene. Polyethylene may provide chemical resistance, low friction, and flexibility at low temperatures.

In some embodiments, polyvinyl chloride may be employed as a building material for thermal power generation systems. Polyvinyl chloride may be a thermoplastic polymer that may be formed into pipes, ducts, fittings, or other shapes. Polyvinyl chloride may provide chemical resistance, durability, and low cost. Polyvinyl chloride may be rigid or may be plasticized to provide flexibility.

In some embodiments, fiberglass-reinforced plastic may be employed as a building material for thermal power generation systems. Fiberglass-reinforced plastic may comprise a polymer matrix reinforced with glass fibers. Fiberglass-reinforced plastic may provide high strength, corrosion resistance, and design flexibility. Fiberglass-reinforced plastic may be employed for tanks, pipes, ducts, structural members, or other components.

In some embodiments, concrete may be employed as a building material for thermal power generation systems. Concrete types that may be employed may include one or more or any combination of the following: Portland cement concrete, or reinforced concrete, or prestressed concrete, or post-tensioned concrete, or precast concrete, or cast-in-place concrete, or shotcrete, or fiber-reinforced concrete, or lightweight concrete, or high-strength concrete, or self-consolidating concrete, or pervious concrete, or any combination thereof. Concrete may provide high compressive strength, durability, fire resistance, and thermal mass. Concrete may be employed for foundations, towers, walls, floors, tanks, or other components.

In some embodiments, reinforced concrete may be employed as a building material for thermal power generation systems. Reinforced concrete may comprise concrete with embedded steel reinforcement that may provide tensile strength. The steel reinforcement may comprise reinforcing bars, welded wire fabric, or other reinforcement configurations. Reinforced concrete may be employed for structural members that may be subjected to bending, tension, or combined loading.

In some embodiments, prestressed concrete may be employed as a building material for thermal power generation systems. Prestressed concrete may comprise concrete with embedded steel tendons that may be tensioned before or after the concrete hardens. The prestressing may induce compressive stresses in the concrete that may offset tensile stresses from applied loads. Prestressed concrete may allow longer spans, thinner sections, and reduced cracking compared to reinforced concrete.

In some embodiments, precast concrete may be employed as a building material for thermal power generation systems. Precast concrete may comprise concrete elements that may be cast in a factory or casting yard and may be transported to the construction site for installation. Precast concrete may provide quality control, reduced construction time, and design flexibility. Precast concrete elements may include panels, beams, columns, pipes, tanks, or other shapes.

In some embodiments, composites may be employed as building materials for thermal power generation systems. Composites that may be employed may include one or more or any combination of the following: fiber-reinforced polymers, or carbon fiber composites, or glass fiber composites, or aramid fiber composites, or basalt fiber composites, or natural fiber composites, or metal matrix composites, or ceramic matrix composites, or sandwich composites, or laminated composites, or any combination thereof. Composites may provide high strength-to-weight ratios, corrosion resistance, design flexibility, and tailored properties.

In some embodiments, carbon fiber composites may be employed as building materials for thermal power generation systems. Carbon fiber composites may comprise a polymer matrix reinforced with carbon fibers. Carbon fiber composites may provide high strength, high stiffness, low weight, and fatigue resistance. Carbon fiber composites may be employed for turbine blades, structural members, or other components where high performance may be beneficial.

In some embodiments, glass fiber composites may be employed as building materials for thermal power generation systems. Glass fiber composites may comprise a polymer matrix reinforced with glass fibers. Glass fiber composites may provide high strength, corrosion resistance, and lower cost than carbon fiber composites. Glass fiber composites may be employed for tanks, pipes, ducts, structural members, turbine blades, or other components.

In some embodiments, sandwich composites may be employed as building materials for thermal power generation systems. Sandwich composites may comprise two face sheets bonded to a core material. The face sheets may be made of metal, composite, or other materials. The core may be made of foam, honeycomb, balsa wood, or other lightweight materials. Sandwich composites may provide high stiffness-to-weight ratios and may be employed for panels, walls, floors, or other components.

In some embodiments, ice may be employed as a building material for thermal power generation systems. Ice may be formed from freshwater, seawater, or other water sources. Ice may provide structural support in cold climate environments where temperatures may remain below the freezing point of water for extended periods. Ice may be employed for walls, floors, foundations, or other structural elements in cold climate applications. Ice structures may be formed by spraying water, by flooding and freezing, by block placement, or by other methods.

In some embodiments, ice composites may be employed as building materials for thermal power generation systems. Ice composites may comprise ice reinforced with fibers, particles, or other materials that may enhance the mechanical properties of the ice. Ice composites may include one or more or any combination of the following: pykrete, or fiber-reinforced ice, or sawdust-reinforced ice, or wood chip-reinforced ice, or paper-reinforced ice, or straw-reinforced ice, or aggregate-reinforced ice, or any combination thereof. Ice composites may provide higher strength, higher toughness, and slower melting rates than unreinforced ice.

In some embodiments, pykrete may be employed as a building material for thermal power generation systems. Pykrete may comprise ice reinforced with wood pulp, sawdust, or other cellulosic materials. Pykrete may provide higher strength and slower melting rates than unreinforced ice. Pykrete may be employed for structural elements, walls, foundations, or other components in cold climate applications.

In some embodiments, fiber-reinforced ice may be employed as a building material for thermal power generation systems. Fiber-reinforced ice may comprise ice reinforced with natural fibers, synthetic fibers, or other fibrous materials. The fibers may provide tensile reinforcement that may enhance the strength and toughness of the ice. Fiber-reinforced ice may be employed for structural elements in cold climate applications.

In some embodiments, thermal power generation systems may employ various types of water-air s for transferring heat from water to air. Water-air contactor types that may be employed may include one or more or any combination of the following: spray contactors, or pool contactors, or film contactors, or packed bed contactors, or tray contactors, or bubble contactors, or jet contactors, or cascade contactors, or fountain contactors, or mist contactors, or fog contactors, or any combination thereof.

In some embodiments, water-air contacting may be conducted using countercurrent flow, wherein water flows in an opposing direction to the air. In countercurrent flow configurations, the coldest air may contact the coldest water or ice, and the warmest water may contact the warmest air, which may enhance heat transfer efficiency by maintaining a temperature gradient along the flow path. In some embodiments, water-air contacting may be conducted using parallel flow, wherein water flows in the same direction as the airflow. In parallel flow configurations, the coldest air may initially contact the warmest water, which may result in rapid initial heat transfer that diminishes along the flow path as the temperature difference decreases. In some embodiments, water-air contacting may be conducted using perpendicular flow, wherein water flows perpendicular to the airflow. Perpendicular flow configurations may provide intermediate heat transfer characteristics between countercurrent and parallel flow arrangements. The air may be contacted with the fluid, such as a fluid comprising water, in a countercurrent, cocurrent, or crossflow arrangement.

In some embodiments, spray contactors may be employed for water-air heat transfer. Spray contactors may comprise nozzles, atomizers, or other spray devices that may disperse water into droplets that may be contacted with air. Spray contactors may provide high surface area for heat transfer and may allow control of droplet size, spray pattern, and spray rate. Spray contactors may be positioned above water pools, within air conduits, at air inlets, or at other locations within thermal power generation systems.

In some embodiments, pool contactors may be employed for water-air heat transfer. Pool contactors may comprise basins, tanks, ponds, or other containers that may hold water and may allow air to flow over the water surface. Pool contactors may provide a stable water surface for heat transfer and may allow ice to form and accumulate on the water surface. Pool contactors may be positioned at the base of air conduits, adjacent to air conduits, or at other locations within thermal power generation systems.

In some embodiments, film contactors may be employed for water-air heat transfer. Film contactors may comprise surfaces over which water may flow as a thin film while air may flow over the water film. Film contactors may provide high surface area for heat transfer in a compact configuration. Film contactors may comprise vertical surfaces, inclined surfaces, horizontal surfaces, or surfaces with other orientations.

In some embodiments, packed bed contactors may be employed for water-air heat transfer. Packed bed contactors may comprise beds of packing material through which water and air may flow in countercurrent, cocurrent, or crosscurrent configurations. The packing material may provide surface area for heat transfer and may promote mixing between the water and air. Packing materials may include random packing, structured packing, or other packing configurations.

In some embodiments, tray contactors may be employed for water-air heat transfer. Tray contactors may comprise horizontal trays with openings through which air may flow while water may flow across the trays. Tray contactors may provide staged contact between water and air and may allow control of the contact time and contact area. Tray types may include sieve trays, bubble cap trays, valve trays, or other tray configurations.

In some embodiments, bubble contactors may be employed for water-air heat transfer. Bubble contactors may comprise devices that may introduce air as bubbles into a body of water. The bubbles may rise through the water and may transfer heat from the water to the air within the bubbles. Bubble contactors may provide intimate contact between water and air and may promote mixing within the water.

In some embodiments, jet contactors may be employed for water-air heat transfer. Jet contactors may comprise devices that may produce high-velocity jets of water that may be contacted with air. The jets may break up into droplets that may provide surface area for heat transfer. Jet contactors may be positioned to direct water jets into air streams, into air conduits, or into other regions where heat transfer may occur.

In some embodiments, cascade contactors may be employed for water-air heat transfer. Cascade contactors may comprise series of steps, weirs, or other structures over which water may flow in a cascading manner while air may flow over the cascading water. Cascade contactors may provide turbulent mixing and may enhance heat transfer between the water and air.

In some embodiments, fountain contactors may be employed for water-air heat transfer. Fountain contactors may comprise devices that may project water upward into the air as fountains or plumes. The water may break up into droplets that may be contacted with air as the water rises and falls. Fountain contactors may provide visual appeal in addition to heat transfer functionality.

In some embodiments, mist contactors may be employed for water-air heat transfer. Mist contactors may comprise devices that may produce fine water droplets that may be suspended in the air as a mist. The mist may provide high surface area for heat transfer and may allow extended contact time between the water droplets and the air. Mist contactors may employ ultrasonic atomizers, high-pressure nozzles, or other mist generation devices.

In some embodiments, fog contactors may be employed for water-air heat transfer. Fog contactors may comprise devices that may produce very fine water droplets that may remain suspended in the air as fog. Fog contactors may provide very high surface area for heat transfer and may allow the water droplets to be carried with the airflow through the system.

In some embodiments, thermal power generation systems may employ various types of heat exchangers for transferring heat between fluids. Heat exchanger types that may be employed may include one or more or any combination of the following: shell and tube heat exchangers, or plate heat exchangers, or finned tube heat exchangers, or air-cooled heat exchangers, or spiral heat exchangers, or double pipe heat exchangers, or printed circuit heat exchangers, or plate-fin heat exchangers, or tube-fin heat exchangers, or regenerative heat exchangers, or recuperative heat exchangers, or direct contact heat exchangers, or indirect contact heat exchangers, or any combination thereof.

In some embodiments, shell and tube heat exchangers may be employed in thermal power generation systems. Shell and tube heat exchangers may comprise a shell containing a bundle of tubes through which one fluid may flow while another fluid may flow around the tubes within the shell. Shell and tube heat exchangers may provide high heat transfer capacity, may accommodate high pressures, and may be suitable for a wide range of applications.

In some embodiments, plate heat exchangers may be employed in thermal power generation systems. Plate heat exchangers may comprise a series of plates with channels for fluid flow arranged in an alternating pattern. Plate heat exchangers may provide high heat transfer coefficients in a compact configuration. Plate heat exchangers may be gasketed, brazed, or welded depending on the application requirements.

In some embodiments, finned tube heat exchangers may be employed in thermal power generation systems. Finned tube heat exchangers may comprise tubes with fins attached to the exterior surfaces of the tubes to increase the surface area for heat transfer to air or other gases. Finned tube heat exchangers may be employed for air-cooled applications where heat may be transferred from a liquid flowing through the tubes to air flowing over the finned surfaces. The fins may be configured as circular fins, plate fins, spiral fins, or other fin configurations depending on the application requirements.

In some embodiments, air-cooled heat exchangers may be employed in thermal power generation systems. Air-cooled heat exchangers may comprise heat exchangers that may use ambient air as the cooling medium. Air-cooled heat exchangers may include finned tube bundles, fans or natural convection for air movement, and structural supports. Air-cooled heat exchangers may be employed where water availability may be limited or where water-based cooling may not be practical.

In some embodiments, spiral heat exchangers may be employed in thermal power generation systems. Spiral heat exchangers may comprise two spiral channels formed by rolling two parallel plates around a central core. The fluids may flow in countercurrent directions through the spiral channels. Spiral heat exchangers may provide compact configurations and may be suitable for applications involving fluids with suspended solids or high viscosity.

In some embodiments, double pipe heat exchangers may be employed in thermal power generation systems. Double pipe heat exchangers may comprise an inner pipe positioned within an outer pipe, with one fluid flowing through the inner pipe and another fluid flowing through the annular space between the pipes. Double pipe heat exchangers may be simple in construction and may be suitable for small-scale applications or for applications requiring easy maintenance access.

In some embodiments, printed circuit heat exchangers may be employed in thermal power generation systems. Printed circuit heat exchangers may comprise stacked plates with fluid channels formed by chemical etching or other microfabrication techniques. Printed circuit heat exchangers may provide very high surface area density and may be suitable for applications requiring compact configurations or high heat transfer rates.

In some embodiments, plate-fin heat exchangers may be employed in thermal power generation systems. Plate-fin heat exchangers may comprise alternating layers of flat plates and corrugated fins that may form flow passages for multiple fluid streams. Plate-fin heat exchangers may provide high surface area density and may be suitable for applications involving multiple fluid streams or requiring compact configurations.

In some embodiments, tube-fin heat exchangers may be employed in thermal power generation systems. Tube-fin heat exchangers may comprise tubes with fins attached to the exterior surfaces, similar to finned tube heat exchangers. Tube-fin heat exchangers may be configured for crossflow, counterflow, or parallel flow arrangements depending on the application requirements.

In some embodiments, regenerative heat exchangers may be employed in thermal power generation systems. Regenerative heat exchangers may comprise heat exchangers in which heat may be stored in a thermal mass during one period and may be released during another period. Regenerative heat exchangers may include rotary regenerators, fixed bed regenerators, or other regenerator configurations. Regenerative heat exchangers may be employed for applications involving periodic or cyclic heat transfer processes.

In some embodiments, recuperative heat exchangers may be employed in thermal power generation systems. Recuperative heat exchangers may comprise heat exchangers in which heat may be transferred continuously from one fluid stream to another through a separating wall. Recuperative heat exchangers may include shell and tube, plate, finned tube, or other heat exchanger configurations that may provide continuous heat transfer between fluid streams.

In some embodiments, direct contact heat exchangers may be employed in thermal power generation systems. Direct contact heat exchangers may comprise heat exchangers in which the fluids may come into direct physical contact without an intervening solid surface. Direct contact heat exchangers may include spray chambers, packed columns, tray columns, or other configurations where fluids may mix directly. Direct contact heat exchangers may provide high heat transfer rates and may be suitable for applications where mixing of the fluids may be acceptable.

In some embodiments, indirect contact heat exchangers may be employed in thermal power generation systems. Indirect contact heat exchangers may comprise heat exchangers in which heat may be transferred through a solid surface that may separate the fluids. Indirect contact heat exchangers may prevent mixing of the fluids and may be suitable for applications where fluid separation may be required.

In some embodiments, thermal power generation systems may employ various fluid types and sources for heat transfer operations. Fluid types that may be employed may include one or more or any combination of the following: freshwater, or seawater, or brackish water, or brine, or geothermal fluids, or industrial process water, or cooling water, or wastewater, or produced water, or any combination thereof. The selection of fluid type may depend on the geographic location, the availability of fluid sources, the intended application, the freezing point requirements, or any combination thereof.

In some embodiments, freshwater may be employed as a heat transfer fluid in thermal power generation systems. Freshwater may be obtained from lakes, rivers, streams, aquifers, reservoirs, or other freshwater sources. Freshwater may have a freezing point of approximately 0 degrees Celsius at standard atmospheric pressure and may have a high specific heat capacity and high enthalpy of fusion.

In some embodiments, seawater may be employed as a heat transfer fluid in thermal power generation systems. Seawater may be obtained from oceans, seas, coastal waters, or other marine sources. Seawater may have a freezing point that may be lower than the freezing point of freshwater due to the presence of dissolved salts. Seawater may provide opportunities for mineral extraction, salt production, or freeze desalination in addition to power generation.

In some embodiments, brine may be employed as a heat transfer fluid in thermal power generation systems. Brine may comprise water with elevated concentrations of dissolved salts. Brine may be obtained from natural sources, from industrial processes, from desalination operations, or from other sources. Brine may have a freezing point that may be lower than the freezing point of seawater depending on the salt concentration.

In some embodiments, geothermal fluids may be employed as heat transfer fluids in thermal power generation systems. Geothermal fluids may comprise water or brine that may be heated by geothermal energy sources. Geothermal fluids may be obtained from geothermal wells, hot springs, or other geothermal sources. Geothermal fluids may provide elevated temperatures that may enhance heat transfer to air.

In some embodiments, industrial process water may be employed as a heat transfer fluid in thermal power generation systems. Industrial process water may comprise water that may be used in or produced by industrial processes. Industrial process water may include cooling water from power plants, process water from manufacturing facilities, or other industrial water streams. Industrial process water may be at elevated temperatures that may provide opportunities for heat recovery and power generation.

In some embodiments, thermal power generation systems may employ various fluid types for heat transfer operations. Fluid types that may be employed may include one or more or any combination of the following: freshwater, or seawater, or brine, or brackish water, or produced water, or geothermal brine, or process water, or cooling water, or heating water, or wastewater, or effluent water, or recirculated water, or recirculated brine, or desalination water, or mining water, or extractive water, or saline water, or any combination thereof.

In some embodiments, freshwater may be employed as a heat transfer fluid in thermal power generation systems. Freshwater may comprise water with a total dissolved solids content of less than approximately 1,000 milligrams per liter. Freshwater may have a freezing point of approximately 0 degrees Celsius at standard atmospheric pressure. Freshwater may be obtained from various sources and may be employed in heat transfer processes where a freezing point near 0 degrees Celsius may be acceptable or desirable.

In some embodiments, seawater may be employed as a heat transfer fluid in thermal power generation systems. Seawater may comprise water with a total dissolved solids content of approximately 20,000-40,000 milligrams per liter. Seawater may have a freezing point of approximately negative 1.8 degrees Celsius to approximately negative 2 degrees Celsius depending on salinity. Seawater may be obtained from oceans, seas, coastal waters, or other marine environments. Seawater may provide opportunities for freeze desalination, salt production, mineral extraction, or other processes in addition to power generation.

In some embodiments, brine may be employed as a heat transfer fluid in thermal power generation systems. Brine may comprise water with a total dissolved solids content greater than approximately 35,000 milligrams per liter. Brine may have a freezing point that may be lower than the freezing point of seawater depending on the concentration and composition of dissolved salts. Brine may be obtained from natural sources, from industrial processes, from desalination operations, from evaporation ponds, or from other sources. Brine may provide opportunities for salt production, mineral extraction, or other processes in addition to power generation.

In some embodiments, brackish water may be employed as a heat transfer fluid in thermal power generation systems. Brackish water may have a freezing point that may be lower than the freezing point of freshwater but higher than the freezing point of seawater. Brackish water may be obtained from estuaries, coastal aquifers, inland saline water bodies, or other sources where freshwater and saltwater may mix.

In some embodiments, produced water may be employed as a heat transfer fluid in thermal power generation systems. Produced water may comprise water that may be brought to the surface during oil and gas extraction operations. Produced water may contain dissolved salts, hydrocarbons, naturally occurring radioactive materials, or other constituents depending on the geological formation from which the produced water may be extracted. Produced water may be at elevated temperatures due to geothermal heating within the subsurface formation. Produced water may provide opportunities for heat recovery and power generation while also providing a disposal pathway for the produced water.

In some embodiments, geothermal brine may be employed as a heat transfer fluid in thermal power generation systems. Geothermal brine may comprise water or brine that may be heated by geothermal energy sources within the earth. Geothermal brine may be obtained from geothermal wells, hot springs, geysers, or other geothermal sources. Geothermal brine may contain elevated concentrations of dissolved minerals including silica, lithium, boron, arsenic, or other elements depending on the geothermal reservoir characteristics. In some embodiments, geothermal brine may be at temperatures ranging from approximately 0 degrees Celsius to approximately 350 degrees Celsius or higher depending on the geothermal resource. Geothermal brine may provide opportunities for mineral extraction in addition to power generation.

In some embodiments, process water may be employed as a heat transfer fluid in thermal power generation systems. Process water may comprise water that may be used in or produced by industrial processes. Process water may include water used in manufacturing, chemical processing, food processing, beverage production, pharmaceutical manufacturing, pulp and paper production, textile manufacturing, or other industrial operations. Process water may be at elevated temperatures due to heat absorption during industrial processes. Process water may provide opportunities for heat recovery and power generation while also providing cooling for industrial processes.

In some embodiments, cooling water may be employed as a heat transfer fluid in thermal power generation systems. Cooling water may comprise water that may be used to remove heat from industrial equipment, power generation equipment, or other heat-generating systems. Cooling water may be at elevated temperatures after absorbing heat from the equipment being cooled. Cooling water may be obtained from once-through cooling systems, recirculating cooling systems, or other cooling water systems. Cooling water may provide opportunities for heat recovery and power generation from waste heat that may otherwise be rejected to the environment.

In some embodiments, heating water may be employed as a heat transfer fluid in thermal power generation systems. Heating water may comprise water that may be used to deliver heat to buildings, industrial processes, or other heat-consuming systems. Heating water may be at elevated temperatures to provide the desired heating effect. Heating water may be obtained from district heating systems, building heating systems, industrial heating systems, or other heating water systems.

In some embodiments, wastewater may be employed as a heat transfer fluid in thermal power generation systems. Wastewater may comprise water that may have been used for domestic, commercial, or industrial purposes and may contain dissolved or suspended contaminants. Wastewater may be at elevated temperatures due to heat input from the activities that generated the wastewater. Wastewater may be obtained from municipal wastewater systems, industrial wastewater systems, or other wastewater sources. Wastewater may provide opportunities for heat recovery and power generation while also providing treatment or disposal pathways for the wastewater.

In some embodiments, effluent water may be employed as a heat transfer fluid in thermal power generation systems. Effluent water may comprise water that may be discharged from treatment facilities, industrial processes, or other sources. Effluent water may be at elevated temperatures due to heat input during the processes that generated the effluent. Effluent water may be obtained from wastewater treatment plants, industrial treatment facilities, power plant discharge systems, or other effluent sources.

In some embodiments, recirculated water may be employed as a heat transfer fluid in thermal power generation systems. Recirculated water may comprise water that may be circulated through a thermal power generation system multiple times. Recirculated water may be cooled or partially frozen during each pass through the heat transfer zone, and the water may be returned to the heat transfer zone for additional heat transfer. Recirculation may reduce the total water consumption of the system and may allow the water to be progressively cooled or frozen over multiple passes.

In some embodiments, recirculated brine may be employed as a heat transfer fluid in thermal power generation systems. Recirculated brine may comprise brine that may be circulated through a thermal power generation system multiple times. As water may freeze from the brine during heat transfer, the concentration of dissolved salts in the remaining liquid may increase, producing a more concentrated brine. The recirculated brine may have a progressively lower freezing point as the salt concentration increases with each pass through the system.

In some embodiments, desalination water may be employed as a heat transfer fluid in thermal power generation systems. Desalination water may comprise water that may be produced by desalination processes or water that may be used as feedwater for desalination processes. Desalination water may include seawater, brackish water, or other saline water that may be processed to produce freshwater. Thermal power generation systems may be integrated with desalination systems to provide freeze desalination, to provide power for reverse osmosis or other desalination processes, or to provide other synergies between power generation and desalination.

In some embodiments, mining water may be employed as a heat transfer fluid in thermal power generation systems. Mining water may comprise water that may be used in or produced by mining operations. Mining water may include pit water, process water, tailings water, or other water streams associated with mining activities. Mining water may contain dissolved minerals, suspended solids, or other constituents depending on the mining operation and the ore being processed. Mining water may provide opportunities for heat recovery, mineral extraction, or water treatment in addition to power generation.

In some embodiments, extractive water may be employed as a heat transfer fluid in thermal power generation systems. Extractive water may comprise water that may be used in or produced by extraction operations including oil and gas extraction, mineral extraction, or other extractive industries. Extractive water may be at elevated temperatures due to geothermal heating or due to heat input during extraction processes. Extractive water may contain dissolved minerals, hydrocarbons, or other constituents depending on the extraction operation.

In some embodiments, saline water may be employed as a heat transfer fluid in thermal power generation systems. Saline water may comprise water with elevated concentrations of dissolved salts. Saline water may include seawater, brine, brackish water, or other water with salt content above that of freshwater. Saline water may have a freezing point that may be lower than the freezing point of freshwater, and the freezing point depression may be related to the concentration of dissolved salts.

In some embodiments, thermal power generation systems may employ heat transfer fluids that may comprise materials other than water or in addition to water. Heat transfer fluids that may be employed may include one or more or any combination of the following: water, or seawater, or brine, or antifreeze, or glycol, or fertilizer, or oil, or ammonia, or carbon dioxide, or supercritical fluid, or refrigerant, or single phase fluid, or two-phase fluid, or three-phase fluid, or four-phase fluid, or five-phase fluid, or phase change fluid, or liquid-liquid phase change fluid, or solid-liquid phase change fluid, or urea, or ionic solution, or non-ionic solution, or synthetic fluid, or natural fluid, or any combination thereof.

In some embodiments, antifreeze may be employed as a heat transfer fluid or as an additive to a heat transfer fluid in thermal power generation systems. Antifreeze may comprise substances that may lower the freezing point of water or other liquids. Antifreeze compounds may include one or more or any combination of the following: ethylene glycol, or propylene glycol, or methanol, or ethanol, or isopropanol, or calcium chloride, or magnesium chloride, or sodium chloride, or potassium chloride, or urea, or glycerol, or any combination thereof. Antifreeze may be employed to prevent freezing of heat transfer fluids in portions of the system where freezing may be undesirable, or to lower the freezing point of the heat transfer fluid to enable operation at lower temperatures.

In some embodiments, glycol may be employed as a heat transfer fluid or as an additive to a heat transfer fluid in thermal power generation systems. Glycol compounds that may be employed may include one or more or any combination of the following: ethylene glycol, or propylene glycol, or diethylene glycol, or triethylene glycol, or polyethylene glycol, or any combination thereof. Glycol may lower the freezing point of water and may provide freeze protection for heat transfer systems. Glycol-water mixtures may have freezing points that may depend on the glycol concentration, with higher glycol concentrations providing lower freezing points.

In some embodiments, ethylene glycol may be employed as a heat transfer fluid component in thermal power generation systems. Ethylene glycol may have a freezing point of approximately negative 13 degrees Celsius in pure form. Ethylene glycol-water mixtures may have freezing points ranging from approximately 0 degrees Celsius at low ethylene glycol concentrations to approximately negative 55 degrees Celsius at high ethylene glycol concentrations. Ethylene glycol may provide effective freeze protection but may be toxic and may require careful handling and containment.

In some embodiments, propylene glycol may be employed as a heat transfer fluid component in thermal power generation systems. Propylene glycol may have a freezing point of approximately negative 59 degrees Celsius in pure form. Propylene glycol-water mixtures may have freezing points ranging from approximately 0 degrees Celsius at low propylene glycol concentrations to approximately negative 50 degrees Celsius at high propylene glycol concentrations. Propylene glycol may be less toxic than ethylene glycol and may be suitable for applications where toxicity may be a concern.

In some embodiments, oil may be employed as a heat transfer fluid in thermal power generation systems. Oils that may be employed may include one or more or any combination of the following: mineral oil, or synthetic oil, or silicone oil, or vegetable oil, or thermal oil, or heat transfer oil, or any combination thereof. Oils may provide heat transfer at temperatures above or below the operating range of water-based heat transfer fluids. Oils may have lower specific heat capacities than water but may provide advantages in certain temperature ranges or applications.

In some embodiments, ammonia may be employed as a heat transfer fluid in thermal power generation systems. Ammonia may have a boiling point of approximately negative 33 degrees Celsius at standard atmospheric pressure and may be employed as a refrigerant or heat transfer fluid in low-temperature applications. Ammonia may provide high heat transfer coefficients and may be employed in vapor compression cycles, absorption cycles, or other thermodynamic cycles. Ammonia may be toxic and may require careful handling and containment.

In some embodiments, carbon dioxide may be employed as a heat transfer fluid in thermal power generation systems. Carbon dioxide may be employed as a refrigerant or heat transfer fluid in transcritical or supercritical cycles. Carbon dioxide may have a critical temperature of approximately 31 degrees Celsius and a critical pressure of approximately 7.4 megapascals. Supercritical carbon dioxide may provide high heat transfer coefficients and may be employed in power generation cycles or heat pump cycles.

In some embodiments, supercritical fluids may be employed as heat transfer fluids in thermal power generation systems. Supercritical fluids may comprise fluids at temperatures and pressures above the critical point, where the distinction between liquid and gas phases may disappear. Supercritical fluids may include supercritical carbon dioxide, supercritical water, supercritical ammonia, or other supercritical fluids. Supercritical fluids may provide unique heat transfer and thermodynamic properties that may be advantageous for certain applications.

In some embodiments, refrigerants may be employed as heat transfer fluids in thermal power generation systems. Refrigerants that may be employed may include one or more or any combination of the following: hydrofluorocarbons, or hydrochlorofluorocarbons, or hydrofluoroolefins, or natural refrigerants, or ammonia, or carbon dioxide, or hydrocarbons, or propane, or butane, or isobutane, or any combination thereof. Refrigerants may be employed in vapor compression cycles, organic Rankine cycles, or other thermodynamic cycles for power generation or heat pumping.

In some embodiments, single phase fluids may be employed as heat transfer fluids in thermal power generation systems. Single phase fluids may remain in a single phase throughout the heat transfer process, such as remaining in the liquid phase or remaining in the gas phase. Single phase heat transfer may involve sensible heat transfer without phase change. Single phase fluids may provide predictable heat transfer characteristics and may simplify system design.

In some embodiments, two-phase fluids may be employed as heat transfer fluids in thermal power generation systems. Two-phase fluids may comprise fluids that may exist in two phases simultaneously, such as liquid and gas phases or liquid and solid phases. Two-phase heat transfer may involve latent heat transfer associated with phase change in addition to sensible heat transfer. Two-phase fluids may provide enhanced heat transfer rates due to the latent heat associated with phase change.

In some embodiments, three-phase fluids may be employed as heat transfer fluids in thermal power generation systems. Three-phase fluids may comprise fluids that may exist in three phases simultaneously, such as solid, liquid, and gas phases. Three-phase systems may occur during freezing processes where ice, liquid water, and water vapor may coexist. Three-phase systems may occur during freezing of saline water where ice, liquid brine, and precipitated salt crystals may be present simultaneously. Three-phase heat transfer may involve multiple latent heat contributions from different phase transitions occurring concurrently.

In some embodiments, four-phase fluids may be employed as heat transfer fluids in thermal power generation systems. Four-phase fluids may comprise fluids or mixtures that may exist in four phases simultaneously under certain conditions. Four-phase systems may occur in complex mixtures where multiple solid phases, liquid phases, or gas phases may coexist. Four-phase heat transfer may involve multiple simultaneous phase transitions and may provide complex thermal behavior.

In some embodiments, five-phase fluids may be employed as heat transfer fluids in thermal power generation systems. Five-phase fluids may comprise fluids or mixtures that may exist in five phases simultaneously under certain conditions. Five-phase systems may occur in highly complex mixtures with multiple components that may undergo different phase transitions at different temperatures or pressures.

In some embodiments, phase change fluids may be employed as heat transfer fluids in thermal power generation systems. Phase change fluids may comprise fluids that may undergo phase transitions at temperatures relevant to the heat transfer application. Phase change fluids may include water, which may freeze to form ice, or other materials that may undergo solid-liquid, liquid-gas, or solid-gas phase transitions. The latent heat associated with phase change may enhance heat transfer rates and may provide thermal storage capabilities.

In some embodiments, liquid-liquid phase change fluids may be employed as heat transfer fluids in thermal power generation systems. Liquid-liquid phase change fluids may comprise fluids that may undergo transitions between different liquid phases, such as transitions between miscible and immiscible states or transitions between different liquid crystal phases. Liquid-liquid phase transitions may release or absorb heat and may provide unique thermal management capabilities.

In some embodiments, solid-liquid phase change fluids may be employed as heat transfer fluids in thermal power generation systems. Solid-liquid phase change fluids may comprise fluids that may undergo freezing or melting transitions. Water may be a solid-liquid phase change fluid that may freeze to form ice and may release latent heat during freezing. Other solid-liquid phase change materials may include paraffins, salt hydrates, fatty acids, or other materials with suitable melting points for the intended application.

In some embodiments, urea may be employed as a heat transfer fluid component or additive in thermal power generation systems. Urea may lower the freezing point of water when dissolved in water. Urea solutions may be employed as antifreeze fluids or may be employed in applications where urea may provide additional benefits such as fertilizer production or emissions control.

In some embodiments, ionic solutions may be employed as heat transfer fluids in thermal power generation systems. Ionic solutions may comprise solutions containing dissolved ions, such as salt solutions, acid solutions, base solutions, or other electrolyte solutions. Ionic solutions may have freezing points that may be depressed relative to pure water due to the presence of dissolved ions. Ionic solutions may provide electrical conductivity and may be employed in applications where electrochemical processes may be integrated with thermal power generation.

In some embodiments, non-ionic solutions may be employed as heat transfer fluids in thermal power generation systems. Non-ionic solutions may comprise solutions containing dissolved non-ionic solutes, such as sugar solutions, alcohol solutions, or solutions of other non-ionic compounds. Non-ionic solutions may have freezing points that may be depressed relative to pure water due to the colligative properties of the dissolved solutes.

In some embodiments, synthetic fluids may be employed as heat transfer fluids in thermal power generation systems. Synthetic fluids may comprise fluids that may be manufactured or synthesized rather than obtained from natural sources. Synthetic fluids may include synthetic oils, synthetic refrigerants, synthetic heat transfer fluids, or other engineered fluids designed for specific thermal properties or performance characteristics.

In some embodiments, natural fluids may be employed as heat transfer fluids in thermal power generation systems. Natural fluids may comprise fluids that may be obtained from natural sources without substantial chemical modification. Natural fluids may include water, seawater, geothermal brines, natural oils, or other fluids derived from natural sources. Natural fluids may provide environmental benefits and may be readily available in certain geographic locations.

In some embodiments, fertilizer solutions may be employed as heat transfer fluids in thermal power generation systems. Fertilizer solutions may comprise water with dissolved fertilizer compounds such as ammonium nitrate, urea, potassium chloride, or other agricultural nutrients. Fertilizer solutions may have depressed freezing points and may provide dual-purpose functionality where the heat transfer fluid may subsequently be employed for agricultural applications.

In some embodiments, slurries may be employed as heat transfer fluids in thermal power generation systems. Slurries may comprise mixtures of solid particles suspended in a liquid carrier. Slurries may include ice slurries, mineral slurries, or other particle-laden fluids. Ice slurries may provide enhanced heat transfer due to the latent heat of the ice particles and may be employed for thermal storage or cooling applications.

In some embodiments, emulsions may be employed as heat transfer fluids in thermal power generation systems. Emulsions may comprise mixtures of two or more immiscible liquids where one liquid may be dispersed as droplets within another liquid. Emulsions may include oil-in-water emulsions, water-in-oil emulsions, or more complex multiple emulsions. Emulsions may provide unique thermal properties and may be employed in specialized heat transfer applications.

In some embodiments, nanofluids may be employed as heat transfer fluids in thermal power generation systems. Nanofluids may comprise base fluids with suspended nanoparticles that may enhance thermal conductivity and heat transfer characteristics. Nanoparticles that may be employed may include metal nanoparticles, metal oxide nanoparticles, carbon nanotubes, graphene, or other nanoscale materials. Nanofluids may provide enhanced heat transfer coefficients compared to base fluids alone.

The following are incorporated by reference:
U.S. Pat. No. 11,118,846
Pritam Das, V. P. Chandramohan, A review on solar updraft tower plant technology: Thermodynamic analysis, worldwide status, recent advances, major challenges and opportunities, Sustainable Energy Technologies and Assessments, Volume 52, Part A, 2022, 102091, ISSN 2213-1388.
A review of direct air capture (DAC): scaling up commercial technologies and innovating for the future, Noah McQueen et al 2021 Prog. Energy 3 032001.
A life cycle assessment of greenhouse gas emissions from direct air capture and Fischer-Tropsch fuel production, Sustainable Energy Fuels, 2020, 4, 3129-3142.
Direct Air Capture of CO₂ with Chemicals: A Technology Assessment for the APS Panel on Public Affairs, Apr. 15, 2011, https://carbonengineering.com/wp-content/uploads/2019/11/APS_DAC_Report-FINAL_Original.pdf.

A number of implementations have been described. Nevertheless, it will be understood that various modifications may be made without departing from the spirit and scope of the disclosure. Accordingly, other implementations are within the scope of the following claims.

### Embodiments

1. A process comprising:
transferring at least a portion of heat from a fluid comprising heat to air;
wherein at least a portion of said air is moving from a first elevation to a second elevation through an air conduit, wherein the first elevation is lower than the second elevation; and
adjusting the moving air using an airflow control element.
2. The process of any preceding embodiment, wherein the fluid comprises a liquid, or a solid-liquid mixture, or a phase change fluid, or any combination thereof.
3. The process of any preceding embodiment, wherein said moving air at a first temperature is contacted with the fluid to form air at a second temperature, wherein said second temperature is warmer than said first temperature, and wherein the air at the second temperature is less dense than the air at the first temperature.
4. The process of any preceding embodiment, wherein the air moving from the first elevation to the second elevation is due to at least the lower density of the air at the second temperature than the air at the first temperature.
5. The process of any preceding embodiment, wherein the fluid comprises water selected from freshwater, or seawater, or brine, or any combination thereof.
6. The process of any preceding embodiment, wherein the airflow control element comprises a windward side air inlet and a leeward side air inlet and wherein adjusting the moving air through the air conduit using the airflow control element comprises at least partially opening the windward side air inlet and at least partially closing the leeward side air inlet.
7. The process of any preceding embodiment, wherein adjusting the moving air through the air conduit using the airflow control element further comprises at least partially closing the windward side air outlet and at least partially opening the leeward side air outlet.
8. The process of any preceding embodiment, further comprising converting kinetic energy from the moving air into electrical or mechanical power using a power generation unit fluidly connected to the air conduit.
9. The process of any preceding embodiment, wherein the adjusting of the moving air using the airflow control element is in response to one or more conditions selected from: wind properties, wind direction, wind velocity, changes in wind direction, air temperature, localized pressure, exterior pressure, interior pressure, air pressure, air force, airflow vectors, air humidity, air composition, fluid temperature, system conditions, operating conditions, operating state, presence or absence of blockages, predicted weather, current weather, measured weather, past conditions, current conditions, future conditions, predictive modeling, past measurements, current measurements, power demand, fluid availability, power cost, economic considerations, practical considerations, operational constraints, system demands, downstream demand, product produced, system optimizations, or any combination thereof.
10. The process of any preceding embodiment, further comprising contacting at least a portion of the moving air with a CO₂ absorbent, or an adsorbent, or a combination thereof.
11. The process of any preceding embodiment, wherein the airflow control element comprises fins, or panels, or blades, or air foils, or mesh, or valves, or doors, or flexible materials, or solid materials, or liquid, or flaps, or rigid materials, or semi-rigid materials, or shutters, or dampers, or louvers, or vanes, or any combination thereof.
12. The process of any preceding embodiment, wherein the adjusting is passive adjusting.
13. The process of any preceding embodiment, wherein the adjusting is in response to one or more changes in relevant conditions; and wherein the adjusting is at least partially powered by a change in relevant conditions.
14. The process of any preceding embodiment, wherein one or more changes in relevant conditions comprise one or more of the following: air pressure difference, or air flow velocity, or airflow direction, or related stimuli, or any combination thereof.
15. The process of any preceding embodiment, wherein said airflow control element comprises an inswing shutter; and wherein the inswing shutter may be configured to naturally open or close based on a difference in a localized pressure acting on an exterior side of the shutter and a localized pressure acting on an interior side of the shutter.
16. The process of any preceding embodiment, wherein the adjusting is active adjusting.
17. A system comprising:
an airflow conduit having an air inlet at a first elevation and an air outlet at a second elevation, wherein the first elevation is lower than the second elevation;
a thermal exchange zone configured to transfer heat from a fluid to air, generating an upward airflow within the airflow conduit; and
a CO₂ contactor fluidly connected to the airflow conduit configured to absorb or adsorb carbon dioxide from air.
18. The system of any preceding embodiment, further comprising a power generation unit fluidly connected to the airflow conduit and configured to convert kinetic energy from airflow into electrical power, mechanical power, or both.
19. The system of any preceding embodiment, wherein the CO₂ contactor comprises a liquid CO₂ absorption, or a solid-liquid mixture CO₂ absorption unit, or a solid CO₂ adsorption unit, or any combination thereof.
20. The system of any preceding embodiment, wherein at least a portion of the power generated by the power generation unit is employed to power desorption of CO₂ captured by the contactor.

1. A process comprising:
transferring at least a portion of heat from a fluid comprising heat to air;
wherein at least a portion of said air is moving from a first elevation to a second elevation through an air conduit, wherein the first elevation is lower than the second elevation; and
adjusting the moving air using an airflow control element.

2. The process of claim 1, wherein the fluid comprises a liquid, or a solid-liquid mixture, or a phase change fluid, or any combination thereof.

3. The process of claim 1, wherein said moving air at a first temperature is contacted with the fluid to form air at a second temperature, wherein said second temperature is warmer than said first temperature, and wherein the air at the second temperature is less dense than the air at the first temperature.

4. The process of claim 3, wherein the air moving from the first elevation to the second elevation is due to at least the lower density of the air at the second temperature than the air at the first temperature.

5. The process of claim 1, wherein the fluid comprises water selected from freshwater, or seawater, or brine, or any combination thereof.

6. The process of claim 1, wherein the airflow control element comprises a windward side air inlet and a leeward side air inlet and wherein adjusting the moving air through the air conduit using the airflow control element comprises at least partially opening the windward side air inlet and at least partially closing the leeward side air inlet.

7. The process of claim 6, wherein adjusting the moving air through the air conduit using the airflow control element further comprises at least partially closing the windward side air outlet and at least partially opening the leeward side air outlet.

8. The process of claim 1, further comprising converting kinetic energy from the moving air into electrical or mechanical power using a power generation unit fluidly connected to the air conduit.

9. The process of claim 1, wherein the adjusting of the moving air using the airflow control element is in response to one or more conditions selected from: wind properties, wind direction, wind velocity, changes in wind direction, air temperature, localized pressure, exterior pressure, interior pressure, air pressure, air force, airflow vectors, air humidity, air composition, fluid temperature, system conditions, operating conditions, operating state, presence or absence of blockages, predicted weather, current weather, measured weather, past conditions, current conditions, future conditions, predictive modeling, past measurements, current measurements, power demand, fluid availability, power cost, economic considerations, practical considerations, operational constraints, system demands, downstream demand, product produced, system optimizations, or any combination thereof.

10. The process of claim 1, further comprising contacting at least a portion of the moving air with a CO₂ absorbent, or an adsorbent, or a combination thereof.

11. The process of claim 1, wherein the airflow control element comprises fins, or panels, or blades, or air foils, or mesh, or valves, or doors, or flexible materials, or solid materials, or liquid, or flaps, or rigid materials, or semi-rigid materials, or shutters, or dampers, or louvers, or vanes, or any combination thereof.

12. The process of claim 1, wherein the adjusting is passive adjusting.

13. The process of claim 12, wherein the adjusting is in response to one or more changes in relevant conditions; and wherein the adjusting is at least partially powered by a change in relevant conditions.

14. The process of claim 13, wherein one or more changes in relevant conditions comprise one or more of the following: air pressure difference, or air flow velocity, or airflow direction, or related stimuli, or any combination thereof.

15. The process of claim 12, wherein said airflow control element comprises an inswing shutter; and wherein the inswing shutter may be configured to naturally open or close based on a difference in a localized pressure acting on an exterior side of the shutter and a localized pressure acting on an interior side of the shutter.

16. The process of claim 1, wherein the adjusting is active adjusting.

17. A system comprising:
an airflow conduit having an air inlet at a first elevation and an air outlet at a second elevation, wherein the first elevation is lower than the second elevation;
a thermal exchange zone configured to transfer heat from a fluid to air, generating an upward airflow within the airflow conduit; and
a CO₂ contactor fluidly connected to the airflow conduit configured to absorb or adsorb carbon dioxide from air.

18. The system of claim 17, further comprising a power generation unit fluidly connected to the airflow conduit and configured to convert kinetic energy from airflow into electrical power, mechanical power, or both.

19. The system of claim 17, wherein the CO₂ contactor comprises a liquid CO₂ absorption, or a solid-liquid mixture CO₂ absorption unit, or a solid CO₂ adsorption unit, or any combination thereof.

20. The system of claim 18, wherein at least a portion of the power generated by the power generation unit is employed to power desorption of CO₂ captured by the contactor.
